(19) United States
(12) Patent Application Publication
(10) Pub. No.: US 2025/0282621 A1
(43) Pub. Date: Sep. 11, 2025

(54) CARBON NANOTUBE COMPOSITE COMPRISING MECHANICAL L IGANDS

(71) Applicant: Nanocore APS, Bagsværd (DK)

(72) Inventors: Henrik Pedersen, Bagsværd (DK); Marta González Sánchez, København K (DK); Alejandro López Moreno, Madrid (ES); Julia Villalva Fernández, Madrid (ES); Maria de Lourdes Gonzalez-Juarez, København K (DK); Matthew David Eaton, Madrid (ES); Emilio Manuel Pérez Álvarez, Madrid (ES); Mikkel Dybro Lundorf, Roskilde (DK); Ion Isasti Iribar, København K (DK); Silvia Miranda Alcázar, København K (DK); Marisol Rivas Caramés, København K (DK); Alicia Naranjo Chacón, København K (DK); Wanzheng Zhang, Shanghai (CN); Wei Xu, Heilongjiang (CN); Sofia Mena Hernando, Madrid (ES)

(21) Appl. No.: 18/574,958

(22) PCT Filed: Jun. 28, 2022
(86) PCT No.: PCT/EP2022/067728

§ 371 Date: Dec. 28, 2023

(30) Foreign Application Priority Data
Jul. 2, 2021 (EP) 21382590.4

(51) Int. Cl. C01B 32/158

(52) U.S. Cl. CPC C01B 32/158; C01B 2202/36; C01P 2002/01; C01P 2002/82; C01P 2002/84; C01P 2002/86; C01P 2002/90; C01P 2004/03; C01P 2004/04; C01P 2004/133; C01P 2004/90

(57) ABSTRACT

A composite material comprising carbon nanotubes is described, wherein said composite material does not comprise any carbon nanotube aggregates having a smallest dimension larger than 1 mm. The efficiency of dispersion and anchoring as well as processing capability of the commercially relevant carbon nanotube composites are significantly improved.

### INTRODUCTION

### Technical Field

Composite materials, in particular materials where the strength of the material is of importance.

### BACKGROUND

Nanocomposite materials comprising mechanical ligands and precursor-mechanical ligands, complexed to the filler molecules and covalently or non-covalently linked to the matrix molecules, can improve the beneficial characteristics of nanocomposites when employing fillers such as carbon nanotubes, boron nitride nanotubes, and graphene.

The approach dramatically improves both the dispersion and anchoring of the fillers in the nanocomposites, and thereby improves characteristics such as strength significantly. However, challenges remain, in particular with regard to i) improve the efficiency of dispersion of the fillers at high concentration, ii) minimize the time required to disperse the fillers, iii) disperse a high proportion of the different types of fillers present in current commercially available filler products, and iv) improve processing capability of such nanocomposites.

For carbon nanotubes these issues are particularly relevant. It is therefore of interest to identify approaches that can disperse and anchor a major proportion of the carbon nanotubes present in today's commercial products, thereby improving the efficiency of dispersion and anchoring as well as processing capability of the commercially relevant carbon nanotube composites.

It has been difficult to make carbon nanotube composites of high strength, although carbon nanotubes are very strong themselves. This is in part because the carbon nanotubes are difficult to anchor efficiently in the composite material. Here, it is described how mechanical bonding of the carbon nanotubes improves the dispersion of the nanotubes as well as their anchoring in the composite.

### SUMMARY OF THE INVENTION

What is provided is a method for effectively dispersing nanotubes, in particular carbon nanotubes in solvents as well as in composites. It is shown how the method irreversibly improves the dispersion, but also, how dispersion may first be effectuated and then the nanotubes be left unmarked (pristine) from the method, yet with only rather small nanotube aggregates left in the composite.

What is thus provided is a general process for the production of a SE1-ML complex, comprising the following steps:
Step Y1. Provide a SE1, where the SE1 is a nanotube;
Step Y2. Provide a precursor-ML, where the precursor-ML is a Ushape comprising two chemical moieties with affinity for the nanotube;
to obtain a nanotube-Ushape complex;
where Steps Y1-Y2 may be performed in any order.

A composite material comprising nanotubes is also provided, wherein said composite material does not comprise any nanotube aggregates having a smallest dimension larger than 1 mm.

What is further provided is a means for the efficient anchoring of nanotubes, in particular carbon nanotubes, in composite materials.

What is thus provided is a general process for the production of a SE1-ML-SE2 complex, comprising the following steps:
Step 1a. Provide a SE1;
Step 1b. Provide a precursor-ML;
Step 1c. Optionally, provide a catalyst;
Step 1d. Provide a SE2;
to generate a SE1-ML-SE2 structure.

What is further provided is a means for applying the invention to industrial production of products made from composite materials, including minimizing the presence of nanotube aggregates at high nanotube concentration; and improving the dispersion of commercial preparations of nanotubes, comprising many different nanotube species.

The composite material preferably does not comprise any nanotube aggregates having a smallest dimension larger than 1 mm, such as larger than 0.1 mm, such as larger than 0.01 mm, such as larger than 1 μm, such as larger than 0.1 μm, such as larger than 0.01 μm, such as larger than 2 nm.

Further provided is a composite material, having a volume of more than 50 nm³ and comprising more than 0.01 w/w % nanotubes.

Further provided is a composite material, having a volume of more than 50 nm³ and comprising more than 0.01 w/w % nanotubes, such as 0.01-0.1 w/w %, or 0.1-1 w/w %, or 2-3 w/w %, or 4-5 w/w %, or 5-10 w/w %, or 10-15 w/w %, or 15-20 w/w %, or 20-25 w/w %, or 25-30 w/w %, or 30-35 w/w %, or 35-40 w/w %, or 40-50 w/w %, or 50-60 w/w %, or 60-70 w/w %, or 60-80 w/w %, or 80-99.99 w/w %.

Further provided is a composite material, wherein the composite material has a mass of more than 10⁻¹⁵ g, such as more than 10⁻¹⁴ g, such as more than 10⁻¹³ g, such as more than 10⁻¹¹ g, such as more than 10⁻¹⁰ g, such as more than 10⁻⁹ g, such as more than 10⁻⁸ g, such as more than 10⁻⁷ g, such as more than 10⁻⁶ g, such as more than 10⁻⁵ g, such as more than 10⁻⁴ g, such as more than 10⁻³ g, such as more than 10⁻² g, such as more than 0.1 g, such as more than 1 g, such as more than 10 g, such as more than 100 g, such as more than 1 kg, such as more than 10 kg, such as more than 100 kg, such as more than 1000 kg, such as more than 10,000 kg; and/or
wherein the nanotube concentration is 0.01-0.1 w/w %, or 0.1-1 w/w %, or 2-3 w/w %, or 4-5 w/w %, or 5-10 w/w %, or 10-15 w/w %, or 15-20 w/w %, or 20-25 w/w %, or 25-30 w/w %, or 30-35 w/w %, or 35-40 w/w %, or 40-50 w/w %, or 50-60 w/w %, or 60-70 w/w %, or 60-80 w/w %, or 80-99.99 w/w %; and/or
where the nanotubes have an average length of at least 10 nm, such as at least 20 nm, such as at least 50 nm, such as at least 100 nm, such as at least 300 nm, such as at least 500 nm, such as at least 1 μm, or such as at least 20 μm.

Further provided is a composite material, having a volume of at least 100 nm³, such as at least 300 nm³, such as at least 1000 nm³, such as at least 10000 nm³, such as at least 100000 nm³, such as at least 100000 nm³, such as at least 1000000 nm³, such as at least 10000000 nm³, such as at least 100000000 nm³, such as at least 1000000000 nm³, such as at least 10 μm³, such as at least 100 μm³, such as at least 1000 μm³, such as at least 10000 μm³, such as at least 100000 μm³, such as at least 1000000 μm³, such as at least 10000000 μm³, such as at least 100000000 μm³, such as at least 1 mm³, or such as at least 10 mm³.

Further provided is a composite material, said composite material comprising at least a first and at least a second carbon nanotube, where the outer diameter of the second nanotube is more than 0.1 nm greater than the outer diameter of the first nanotube, and wherein said first and said second nanotubes are each complexed with mechanical ligands.

Further provided is a composite material, said composite material further comprising at least a third carbon nanotube, where the outer diameter of the third nanotube is more than 0.1 nm greater than the outer diameter of the second nanotube, and wherein said first, second and said third nanotubes are each complexed with mechanical ligands.

Further provided is a composite material, said composite material further comprising at least a fourth carbon nanotube, where the outer diameter of the fourth nanotube is more than 0.1 nm greater than the outer diameter of the third nanotube, and wherein said first, second, third and fourth nanotubes are complexed with mechanical ligands.

Further provided is a composite material, said composite material further comprising at least a fifth carbon nanotube, where the outer diameter of the fifth nanotube is more than 0.1 nm greater than the outer diameter of the fourth nanotube, and wherein said first, second, third, fourth and fifth nanotubes are complexed with mechanical ligands.

Further provided is a composite material, said composite material further comprising at least a sixth carbon nanotube, where the outer diameter of the sixth nanotube is more than 0.1 nm greater than the outer diameter of the fifth nanotube, and wherein said first, second, third, fourth, fifth and sixth nanotubes are complexed with mechanical ligands.

Further provided is a composite material, said composite material further comprising at least a seventh carbon nanotube, where the outer diameter of the seventh nanotube is more than 0.1 nm greater than the outer diameter of the sixth nanotube, and wherein said first, second, third, fourth, fifth, sixth and seventh nanotubes are complexed with mechanical ligands.

Further provided is a composite material, said composite material further comprising at least a eighth carbon nanotube, where the outer diameter of the eighth nanotube is more than 0.1 nm greater than the outer diameter of the seventh nanotube, and wherein said first, second, third, fourth, fifth, sixth, seventh and eighth nanotubes are complexed with mechanical ligands.

Further provided is a composite material, said composite material further comprising at least a ninth carbon nanotube, where the outer diameter of the ninth nanotube is more than 0.1 nm greater than the outer diameter of the eighth nanotube, and wherein said first, second, third, fourth, fifth, sixth, seventh, eighth and ninth nanotubes are complexed with mechanical ligands.

Further provided is a composite material, said composite material further comprising at least a tenth carbon nanotube, where the outer diameter of the tenth nanotube is more than 0.1 nm greater than the outer diameter of the ninth nanotube, and wherein said first, second, third, fourth, fifth, sixth, seventh, eighth, ninth and tenth nanotubes are complexed with mechanical ligands.

Further provided is a composite material, wherein a nanotube is complexed to a mechanical ligand that is a closed ring structure, and where the mechanical ligand comprises any of the following chemical moieties: hydroxyl, thiol, phenyl or other aromatic moiety.

Further provided is a composite material, comprising a nanotube and a closed ring molecule where the outer diameter of the nanotube is between 0.3 and 0.6 nm, and the closed ring molecule comprises 10-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 0.6 and 0.7 nm, and the closed ring molecule comprises 15-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 0.7 and 0.8 nm, and the closed ring molecule comprises 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 0.8 and 0.9 nm, and the closed ring molecule comprises 25-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 1.0 and 1.2 nm, and the closed ring molecule comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 1.2 and 1.4 nm, and the closed ring molecule comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 1.4 and 1.7 nm, and the closed ring molecule comprises 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 1.7 and 2.0 nm, and the closed ring molecule comprises 50-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 2.0 and 2.5 nm, and the closed ring molecule comprises 60-70 atoms, or 71-80 atoms, or 81-90 atoms, or 91-100 atoms, 101-150 atoms, or 151-500 atoms, or 501-5000 atoms.

In the composite material described herein, the composite material may additionally comprise a polymer chosen from: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

Further provided is a composite material, wherein at least one of said one or more mechanical ligands is bonded to a polymer chain, preferably a polymer chosen from: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In one aspect of the composite material, the nanotubes are selected from carbon nanotube, multiwall, single-wall, or double-wall nanotubes, or mixtures thereof.

In a further aspect of the composite material, said composite material does not comprise any nanotube aggregates having a smallest dimension larger than 0.1 μm, wherein the nanotube concentration is 10-15 w/w %; and wherein the composite material has a volume of at least 1 μm³.

Suitably, said composite material does not comprise any nanotube aggregates having a smallest dimension larger than 0.1 μm, wherein the nanotube concentration is 15-25 w/w %; and wherein the composite material has a volume of at least 1 μm³.

In a further aspect, said composite material does not comprise any nanotube aggregates having a smallest dimension larger than 0.1 μm, wherein the nanotube concentration is 25-40 w/w %; and wherein the composite material has a volume of at least 1 μm³.

In a further aspect, said composite material does not comprise any nanotube aggregates having a smallest dimension larger than 0.1 μm, wherein the nanotube concentration is 40-70 w/w %; and wherein the composite material has a volume of at least 1 μm³.

In a further aspect, said composite material does not comprise any nanotube aggregates having a smallest dimension larger than 0.1 μm, wherein the nanotube concentration is 70-99.99 w/w %; and wherein the composite material has a volume of at least 1 μm³.

In a further aspect, said composite material does not comprise any nanotube aggregates having a smallest dimension larger than 0.1 μm, wherein the nanotube concentration is 10-25 w/w %; and wherein the composite material has a volume of at least 1 μm³.

In a further aspect, said composite material does not comprise any nanotube aggregates having a smallest dimension larger than 0.1 μm, wherein the nanotube concentration is 10-25 w/w %; and wherein the composite material has a volume of at least 10 μm³.

In a further aspect, said composite material does not comprise any nanotube aggregates having a smallest dimension larger than 0.1 μm, wherein the nanotube concentration is 10-25 w/w %; and wherein the composite material has a volume of at least 100 μm³.

In a further aspect, said composite material does not comprise any nanotube aggregates having a smallest dimension larger than 0.01 μm, wherein the nanotube concentration is 10-25 w/w %; and wherein the composite material has a volume of at least 10 μm³.

The present technology also provides an ML-nanotube complex, comprising at least two mechanical ligands (ML) complexed to a single nanotube, and wherein said at least two mechanical ligands are covalently linked to one another. Further details of the mechanical ligand (ML) are provided in the following.

### LEGENDS TO THE FIGURES

FIG. 1. SE1-ML complexes. Various SE1-ML complexes are shown.

FIG. 2. SE1-ML-SE2 complexes. Various SE1-ML-SE2 complexes are shown.

FIG. 3. Formation of mechanical ligands (MLs). The formation of MLs from precursor-MLs is shown.

FIG. 4. ROMP synthesis of ‘Poly[N-(4-Tosylatebutyl)]-cis-5-norbornene-exo-2,3-dicarboximide’ (compound A1, synthesized in example A1).

FIG. 5. 1H NMR of ‘Poly[N-(4-Tosylatebutyl)]-cis-5-norbornene-exo-2,3-dicarboximide’ (compound A1, synthesized in example A1).

FIG. 6. Synthesis of ‘Poly[N-(4-azidobutyl)]-cis-5-norbornene-exo-2,3-dicarboximide’ (compound A2, synthesized in example A3).

FIG. 7a. 1H NMR of ‘Poly[N-(4-azidobutyl)]-cis-5-norbornene-exo-2,3-dicarboximide’ (compound A2, synthesized in example A3).

FIG. 7b. FT-IR spectrum of ‘Poly[N-(4-azidobutyl)]-cis-5-norbornene-exo-2,3-dicarboximide’ (compound A2, synthesized in example A3).

FIG. 8. End-group (1H NMR) analysis of ‘Poly[N-(4-azidobutyl)]-cis-5-norbornene-exo-2,3-dicarboximide’ (compound A2, synthesized in example A3)

FIG. 9. Synthesis of ‘Poly[N-(4-triazole-Pyrene_Ushape-(butyl)]-cis-5-norbornene-exo-2,3-dicarboximide’ (compound A3, synthesized in example A6).

FIG. 10. Comparative Infrared Spectra. Black: Pyrene_Ushape terminal alkyne, blue: ‘Poly[N-(4-azidobutyl)]-cis-5-norbornene-exo-2,3-dicarboximide’ (compound A2, synthesized in example A3) and red: ‘Poly[N-(4-triazole-Pyrene_Ushape-(butyl)]-cis-5-norbornene-exo-2,3-dicarboximide’ (compound A3, synthesized in example A6).

FIG. 11a. 1H NMR of ‘Poly[N-(4-triazole-Pyrene_Ushape-(butyl)]-cis-5-norbornene-exo-2,3-dicarboximide’ (compound A3, synthesized in example A6).

FIG. 11b. UV-Vis. spectrum of ‘Poly[N-(4-triazole-Pyrene_Ushape-(butyl)]-cis-5-norbornene-exo-2,3-dicarboximide’ (compound A3, synthesized in example A6).

FIG. 12. Nanoindentation measurement of ‘Poly[N-(4-triazole-Pyrene_Ushape-(butyl)]-cis-5-norbornene-exo-2,3-dicarboximide’ (compound A3, synthesized in example A6).

FIG. 13. 1H NMR of ‘Poly[N-(4-Tosylatebutyl)]-cis-5-norbornene-exo-2,3-dicarboximide’ (compound A4, synthesized in example A11).

FIG. 14a. 1H NMR of ‘Poly[N-(4-azidobutyl)]-cis-5-norbornene-exo-2,3-dicarboximide’ (compound A5, synthesized in example A13).

FIG. 14b. FT-IR spectrum of ‘Poly[N-(4-azidobutyl)]-cis-5-norbornene-exo-2,3-dicarboximide’ (compound A5, synthesized in example A13).

FIG. 15. End-group (1H NMR) analysis of ‘Poly[N-(4-azidobutyl)]-cis-5-norbornene-exo-2,3-dicarboximide’ (compound A5, synthesized in example A13).

FIG. 16. Comparative Infrared Spectra. Black: Pyrene_Ushape terminal alkyne, blue: ‘Poly[N-(4-azidobutyl)]-cis-5-norbornene-exo-2,3-dicarboximide’ (compound A5, synthesized in example A13) and red: ‘Poly[N-(4-triazole-Pyrene_Ushape-(butyl)]-cis-5-norbornene-exo-2,3-dicarboximide’ (compound A6, synthesized in example A16).

FIG. 17a. 1H NMR of ‘Poly[N-(4-triazole-Pyrene_Ushape-(butyl)]-cis-5-norbornene-exo-2,3-dicarboximide’ (compound A6, synthesized in example A16).

FIG. 17b. UV-Vis. spectrum of ‘Poly[N-(4-triazole-Pyrene_Ushape-(butyl)]-cis-5-norbornene-exo-2,3-dicarboximide’ (compound A6, synthesized in example A16).

FIG. 18a. Synthesis of ‘SWNT-polyUshape’ composite (compound A8) with ‘Poly[N-(4-triazole-Pyrene_Ushape-(butyl)]-cis-5-norbornene-exo-2,3-dicarboximide’ (compound A3, from example A6).

FIG. 18b. Optical Microscopy photo of compound A8

FIG. 19. Raman spectra of ‘SWNT-polyUshape’ composite (compound A8), measured at 785 nm and 532 nm

FIG. 20. Raman studies for a ‘2D versus G band’ comparison of ‘SWNT-polyUshape’ composite (compound A8) and non-modified 6,5_SWNTs (compound A7) from example A19.

FIG. 21. Average comparison of G and 2D band of ‘SWNT-polyUshape’ composite (compound A8) and non-modified 6,5_SWNTs (compound A7) from example A19

FIG. 22. UV.Vis_NIR spectra (focused in the in the pyrene region) comparison between a) ‘Poly[N-(4-triazole-Pyrene_Ushape-(butyl)]-cis-5-norbornene-exo-2,3-dicarboximide’ (compound A3, from example A6) in black colour, b) ‘SWNT-polyUshape’ composite (compound A8) after step 8 in blue colour and c) ‘SWNT-polyUshape’ composite (compound A8) after step 11 in red colour

FIG. 23. UV.Vis_NIR spectra (focused in the in the nanotube region) comparison between ‘SWNT-polyUshape’ composite (compound A8) in red colour and 6,5_SWNTs (compound A7) from example A19 in blue colour

FIG. 24. AFM of ‘SWNT-polyUshape’ composite (compound A8)

FIG. 25. SEM of ‘SWNT-polyUshape’ composite (compound A8)

FIG. 26. SEM-in-lens of ‘SWNT-polyUshape’ composite (compound A8)

FIG. 27. TEM of ‘SWNT-polyUshape’ composite (compound A8).

FIG. 28. HRTEM of ‘SWNT-polyUshape’ composite (compound A8)

FIG. 29. Raman studies for a ‘2D versus G band’ comparison of composites obtained in examples A20 (compound A8 in red) and A24 (in blue)

FIG. 30. Raman spectra comparison of a) compound A9 in blue line (example A27), b) compound A8 in red line (example A20) and c) compound A7 in black line (example A19), measured at 785 nm.

FIG. 31. Raman studies for a ‘2D versus G band’ comparison of a) compound A9 in green (example A27), b) compound A8 in red (example A20), c) compound A7 in orange (example A19) and d) compound obtained from ‘control’ experiment in blue

FIG. 32. Average comparison of G and 2D band of a) compound A9 (example A27), b) compound A8 (example A20) and c) compound A7 (example A19), measured at 785 nm.

FIG. 33. UV.Vis_NIR comparison spectra of ‘SWNT-polyUshape Supramolecular’ composite (compound A9) in blue, ‘SWNT-polyUshape’ composite (compound A8) in red and ‘Poly[N-(4-triazole-Pyrene_Ushape-(butyl)]-cis-5-norbornene-exo-2,3-dicarboximide’ (compound A3, from example A6) in grey.

FIG. 34. HRTEM of ‘SWNT-polyUshape Supramolecular’ composite (compound A9)

FIG. 35. Raman Spectroscopy of ‘SWNT-polyUshape’ composite in red line (compound A10) and non-modified 6,5_SWNTs (compound A7) in black line, measured at 785 nm. Note: Both spectra are the average from 30 different measurements

FIG. 36. Raman studies for a ‘2D versus G band’ comparison of ‘SWNT-polyUshape’ composite (compound A10) and non-modified 6,5_SWNTs (compound A7)

FIG. 37. Nanoindentation measurements of compound A8

FIG. 38. Synthesis of pyrene precursor-ML

FIG. 39a-39b. Synthesis of Boc-diamine-carrying precursor-ML

FIG. 39c. Analytical data for “Boc-diamine-carrying precursor-ML of Example B2”

FIG. 40a. Preparation of macrocyclic molecule comprising bisphenol A (BPA)-motifs or bromo groups.

FIG. 40b. Structure of macrocyclic molecule around a single-walled carbon nanotube

FIG. 40c. Synthesis of bisphenol A (BPA) precursor-ML

FIG. 40d. Analytical data for bisphenol A (BPA) precursor-ML and macrocyclic molecule

FIG. 40e. Preparation of macrocyclic molecule comprising tert-butoxycarbonyl (Boc)-protected amino groups

FIG. 40f. Structure of macrocyclic molecule comprising tert-butoxycarbonyl (Boc)-protected amino groups, wrapped around a single-walled carbon nanotube

FIG. 40g. Preparation of macrocyclic molecule comprising amino groups

FIG. 40h. Structure of macrocyclic molecule comprising amino groups, wrapped around a single-walled carbon nanotube

FIG. 40i. Synthesis of bisphenol A (BPA) precursor-ML comprising amino groups

FIG. 40j. Analytical data for bisphenol A (BPA) precursor-ML and macrocyclic molecule comprising amino groups.

FIG. 41. Different nanofillers used to prepare viscous suspensions of 10 (w/w) % PMMA polymer

FIG. 42. Electrospun fibers of PMMA polymer (A) and PMMA with different nanofillers based on SWNT (B-D). No Macroscopic differences were observed

FIG. 43. Rectangular shaped PMMA fibers composite sample of dimensions of 1×4 cm placed at DMA Q800, TA instruments

FIG. 44. SEM pictures of PMMA polymer fibers (A) and PMMA with different nanofillers based on SWNT (B-D).

FIG. 45. Diameter distributions for PMMA fibers estimated from SEM pictures

FIG. 46. Fiber area density distribution for PMMA electrospun fibers

FIG. 47. Representative stress/strain curves of PMMA (grey) and its composites with SWNTs (black), “SWNT-SL of example H1” (blue) and “SWNT-ML of example B4” (red)

FIG. 48. Representative stress/strain curves of PMMA (grey) and its composites with SWNTs (black), “SWNT-SL of example H1” (blue) and “SWNT-ML of example B4” (red).

FIG. 49. Measured mechanical properties observed for PMMA polymer fibers and PMMA with different nanofillers based on SWNT. A. Young's Modulus. B. Tensile Strength C. Strain (%).

FIG. 50. Different nanofillers used to prepare viscous suspensions of 25 (w/w) % PSU polymer

FIG. 51. Electrospun fibers of PSU polymer (A) and PSU with different nanofillers based on SWNT (B-D). No Macroscopic differences were observed

FIG. 52. SEM pictures of PSU polymer fibers (A) and PSU with different nanofillers based on SWNT (B-D).

FIG. 53. Diameter distributions for PSU fibers estimated from SEM pictures

FIG. 54. Fiber area density distribution for PSU electrospun fibers

FIG. 55. Representative Stress-Strain curves of PSU (grey) and its composites with SWNTs (black), “SWNT-SL of example H1” (blue); “SWNT-ML of example B4” (red).

FIG. 56. Representative stress/strain curves of PSU (grey) and its composites with SWNTs (black), “SWNT-SL of example H1” (blue); “SWNT-ML of example B4” (red).

FIG. 57. Measured mechanical properties observed for PSU polymer fibers and PSU with different nanofillers based on SWNT (B-D). A. Young's Modulus. B. Tensile Strength C. Strain (%).

FIG. 58. Synthetic scheme of “Pyrene U-Shape of Example AA1”, such as compound AA1, following the procedure described in Example DD6.

FIG. 59. Synthetic scheme of “Alkene U-Shape of Example AA2”, such as compound AA2, following the procedure described in Example EE1.

FIG. 60. Synthetic scheme of “Ester U-Shape of Example AA3”, such as compound AA3, following the procedure described in Example EE2.

FIG. 61. Synthetic scheme of “Acid U-Shape of Example AA4”, such as compound AA4, following the procedure described in Example EE3.

FIG. 62. Synthetic scheme of “Fluorenone U-Shape of Example AA5”, including synthetic steps for the synthesis of compound AA5 and AA6, following the procedure described in Example AA5.

FIG. 63. Synthetic scheme of “Chain U-Shape of Example AA6”, such as compound AA7, following the procedure described in Example AA6.

FIG. 64. Synthetic scheme of “Glycol U-Shape of Example AA7”, such as compound AA8, following the procedure described in Example AA7.

FIG. 65. Synthetic scheme of “Fully glycol U-Shape of Example AA8”, including synthetic steps for the synthesis of compound AA9, AA10 and AA11, following the procedure described in Example AA8.

FIG. 66. Synthetic scheme of “DER U-Shape of Example AA9”, including synthetic steps for the synthesis of compound AA12 and AA13, following the procedure described in Example AA9.

FIG. 67. Synthetic scheme of “Methyl alcohol U-Shape of Example AA10”, such as compound AA14, following the procedure described in Example AA10.

FIG. 68. Results of mechanical tensile test for the different PMMA-composites were summarized in table on FIG. 68.

FIG. 69. Results of mechanical tensile test for the different PVC-composites were summarized in table on FIG. 69.

FIG. 70. Results of mechanical tensile test for the different LDPE-composites were summarized in table on FIG. 70.

FIG. 71. Mixture of 0.1% ester MINTs and PMMA powder after ball milling (left) and custom-made single-screw extruder (right) TC1 and TC2 correspond to heating zones. Nozzle diameter 2.5 mm.

FIG. 72. “Example CC 1”. Polymer formation.

FIG. 73. “Example CC 2”. Polymer formation.

FIG. 74. “Example CC 3”. Polymer formation.

FIG. 75. “Example CC 4”. Polymer formation.

FIG. 76. “Example CC 6”. Polymer formation.

FIG. 77. “Example CC 7”. Conversion of terminal functionality.

FIG. 78. “Example CC 8”. Conversion of terminal functionality.

FIG. 79. “Example CC 9”. Polymer formation.

FIG. 80. “Example CC 10”. Conversion of terminal functionality.

FIG. 81. “Example CC 12” and “Example CC 13”. Click chemistry.

FIG. 82. “Example CC19, 1”. ATRP's initiator MINTs.

FIG. 83. “Example CC19, 2.” ATRP PMMA grafting.

FIG. 84. “Example CC 20.” ATRP PMMA grafting.

FIG. 85. “Example CC21”. ROP PCL-MINTs composite.

FIG. 86. “Example CC 22”. Amide bond formation.

FIG. 87. Scheme of achievement of “Polyethoxy monoalkylated of Example DD4”. In the first line, the reactions start on commercial pyrene which is modified to obtain Compound DD1: “2,7-diBpinpyrene of Example DD1”. This one became reagent in the next reaction and Compound DD2 (“2,7-Dihidroxypyrene of Example DD2”) is obtained. On the other hand, in the second line the Compound DD3 (“3-(2-(2-(2-chloroethoxy) ethoxy) ethoxy) prop-1-ene of Example DD3”) is formed by the addition of allyl bromide to a solution of NaH and 2-(2-(2-chloroethoxy) ethoxy) ethanol. Finally, in the bottom part Compound DD2 (“2,7-Dihidroxypyrene of Example DD2”) react with compound DD3DD3 (“3-(2-(2-(2-chloroethoxy) ethoxy) ethoxy) prop-1-ene of Example DD3”) giving Compound DD4 (“Polyethoxy monoalkylated of Example DD4”). After that, compound DD4 reacts with α, α′-dibromo-o-xylene resulting in Compound DD5 (“Polyethoxy U-Shape of Example DD5”).

FIG. 88. Schematic representation of the synthesis of Compound DD7 (“Pyrene U-Shape of Example DD6”) from Compound DD6 (monoalkylated pyrene). In this case, Compound DD6 is dissolved in a mixture of Butanone and water in a basic media. After that, α, α′-dibromo-o-xylene was added to the reaction and this was stirred overnight. Giving as a result Compound DD7 (“Pyrene U-Shape of Example DD6”).

FIG. 89. This figure shows the structure of U shapes described in Examples EE1-EE8.

FIG. 90. This figure shows the structures of macrocycles after Ring-closing Metathesis for the formation of MINTs described in Examples EE9-EE14

FIG. 91. This figure shows PS-amide MINTs (EE15a-c) a) after milling and heating at 200° C. for 2 h; b) dissolved in chloroform (0.25 mg/mL). c) AFM micrograph of drop-casting showing high concentration of individualized SWNT

FIG. 92. Schematic of dogbone mold used to make dogbone shaped samples for tensile mechanical testing. Dimensions are in mm.

FIG. 93. Average tensile modulus data of the Pyrene SWNT-ML-PP dogbones prepared in Example FF4 with standard deviation.

FIG. 94. Average tensile modulus data of the Pyrene SWNT-ML-HDPE dogbones prepared per Example FF8 with standard deviation.

FIG. 95. Average tensile modulus data of the Pyrene SWNT-ML-LDPE dogbones prepared in Example FF9 with standard deviation.

FIG. 96. Films of Example FF11. (Left) 50% Carboxylic Acid SWNT-ML-PVA Film of Example FF11 and (right) 50% SWNT-PVA Film of Example FF11.

FIG. 97. Average tensile modulus data of the 1.0 wt % Amino SWNT-ML-Epoxy dogbones prepared in Example FF12 with standard deviation. Compared to neat epoxy and 1.0% SWNT-epoxy.

FIG. 98. Indentation measurements. (left) Indentation force-displacement curves for neat PS—NH2 (blue) and PS-AMIDE-MINTs of Example EE15C (red). (center) Reduced modulus values for PS—NH2 and PS-AMIDE-MINTs of Example EE15C calculated from indentation curves. (right) Indentation hardness values for PS—NH2 and PS-AMIDE-MINTs of Example EE15C calculated from indentation curves.

FIG. 99. AFM Indentation measurements. (left) AFM Indentation force-displacement curves for PS-reference (blue), neat PS—NH2 (orange) and PS-AMIDE-MINTs of Example EE15C (green). The JKR model fit for each curve is shown as a dashed line. (center) Reduced modulus values for PS-reference (blue), neat PS—NH2 (orange) and PS-AMIDE-MINTs of Example EE15C (green) calculated from indentation curves using the JKR model. (right) Histogram of reduced modulus values for PS-reference (blue), neat PS—NH2 (orange) and PS-AMIDE-MINTs of Example EE15C (green) calculated from indentation curves using the JKR model.

FIG. 100: Synthesis of mono- and di-alkylated pyrene.

FIG. 101: Synthesis of Diamino-Boc U-Shape GG2f.

FIG. 102: Several alternatives for Diamino-Boc U-Shape Synthesis. a. Another synthetic route of Diamino-Boc U-Shape GG2e. b. Different conditions to prepare the Diamino-Boc spacer GG2e. c. Synthesis of a similar Diamino-Boc U-Shape using succinic anhydride.

FIG. 103: The pyridine U-shape's synthesis

FIG. 104: Synthesis of Thiol U-Shape.

FIG. 105: Synthesis of Amido U-Shape GG6d. a. Synthesis of Amido U-Shape GG6d b. Alternative route to obtain the Amido U-Shape GG6d.

FIG. 106: Graphs of tensile test measurements to 0.1% Pyridine-Mints-PMMA composites

FIG. 107. Synthesis of a ROMP-U-shape derivative containing less U-shape units.

FIG. 107 shows Compound HH-1 “ROMP-OTs derivate of Example HH11”

FIG. 107 shows Compound HH-2 “ROMP-N3 derivate of Example HH11”

FIG. 107 shows Compound HH-3, alkyne U-shape.

FIG. 107 shows Compound HH-4 “ROMP-U-shape derivate of Example HH11”

FIG. 108. Synthesis of a ROMP-U-shape derivative containing free acid groups.

FIG. 108 shows Compound HH-5, “ROMP-OTs-acid derivate of Example HH13”

FIG. 108 shows Compound HH-6, “ROMP-N3-acid derivate of Example HH13”

FIG. 108 shows Compound HH-7, “ROMP-U-shape-acid derivate of Example HH13”

FIG. 109. In situ polymerization of Nylon in the presence of ROMP polymer-coated carbon nanotubes having free terminal acyl chloride groups.

FIG. 109 shows Compound HH-8, “ROMP polymer-coated SWNTs having free terminal acyl chloride groups of Example HH15”

FIG. 109 shows Compound HH-9, “Nylon 6,6 reinforced with ROMP polymer-coated SWNTs of Example HH16”

FIG. 110. Mechanochemical synthesis of nanotube-ML complexes using a mortar.

FIG. 110 shows Compound HH-10

FIG. 111. Mechanochemical synthesis of nanotube-ML complexes using a ball mill.

FIG. 111 shows ethylene glycol pyrene precursor-ML (Compound HH-11).

FIG. 112. Sequential mechanochemical synthesis of nanotube-ML complexes using a ball mill.

FIG. 112 shows dialkylated pyrene precursor-ML (Compound HH-12)

FIG. 113. Flow mechanochemical synthesis of nanotube-ML complexes

FIG. 113 shows diamino precursor-ML (Compound HH-13)

FIG. 114. Mechanochemical preparation of LDPE composites reinforced with SWNT-ML

FIG. 114 shows pyrene precursor-ML (Compound HH-14)

FIG. 115. Schematic of the processing of Commercial thermoset polyurethane (ALEXIT® BladeRep LEP 9) composites with diamino-boc MINTs

FIG. 116. Photograph of the ALEXIT® BladeRep LEP 9 composite with diaino-boc MINTs

FIG. 117 Thermoplastic polyurethane polymerization scheme

FIG. 118 General formulation of thermoplastic polyurethane

FIG. 119a. Different sequences of events leading to polymer composites

FIG. 119b. Different sequences of events leading to ROMP polymer-carbon nanotube composite materials

FIG. 119c. Sequence 1, reaction used to generate polystyrene-coated tuball SWNTs

FIG. 119d. Sequence 2, reaction used to generate polyaminoacid-coated SWNTs.

FIG. 119e. Sequence 3A, reaction used to generate polyurethane-coated Tuball SWNTs.

FIG. 119f. Sequence 3B, reaction used to generate polyvinylchloride-coated SWNTs

FIG. 119g. Sequence 3C, reaction used to generate epoxy-coated DWNTs

FIG. 119h. Sequence 4, reaction used to generate polypropylene-coated SWNTs

FIG. 120a. Connecting polymer and ML by amide-bond formation

FIG. 120b. Connecting polymer and ML by amide-bond formation

FIG. 120c. Connecting polymer and ML by amide-bond formation

FIG. 121. Connecting polymer and ML by nucleophilic substitution

FIG. 122. ROMP polymer-coated SWNT representations

FIG. 123. Metathesis of double bonds, leading to attachment of polymers to the ROMP polymer-coated nanotubes or leading to crosslinking of the ROMP polymer-coated nanotubes.

FIG. 124. A fishing rod made from sized SWNTs to which is added linear polyethylene chains comprising at least two double bonds.

FIG. 125. A gear made from ROMP polymer-coated SWNTs that become cross-linked by linkers comprising aromatic chains and two double bonds.

FIG. 126. A suitcase made from ROMP polymer-coated SWNTs to which is attached polystyrene without crosslinking separate SWNTs

FIG. 127. Introduction of functional groups, by using linkers carrying the desired functionalities.

FIG. 128. A roofing membrane made from ROMP polymer-coated SWNTs to which is added polypropylene by a Ziegler-Natta catalytic polymerization

FIG. 129. A fishing line made from sized SWNTs to which is added polystyrene chains comprising one thiol, as well as polystyrene chains not carrying any thiols that can react with double bonds, and where the majority of the polystyrene chains do not become covalently linked to the sized SWNT until after processing (here extrusion).

FIG. 130. A tire made from ROMP polymer-coated SWNTs to which is covalently linked cis-1,4-Polybutadiene

FIG. 131. Vulcanization of modified SWNTs carrying double bonds

FIG. 132. In situ polymerization leading to materials with thermoplastic or thermoset characteristics

FIG. 133. General structure for azo compounds-based radical initiators

FIG. 134. In situ polymerization involving azo compounds as initiators

FIG. 135. SWNT carrying polystyrene

FIG. 136. General structures generated by in situ polymerisation involving azo compounds as initiators

FIG. 137. General structure for alkoxyamine and nitroxide-based radical initiators

FIG. 138. SWNT-ML-polymer-TEMPO

FIG. 139. SWNT-ML-polymer-polystyrene and SWNT-ML-polymer-polyisoprene

FIG. 140. SWNT-ML-polymer-polystyrene

FIG. 141. General structure for organic peroxides-based radical initiators

FIG. 142. SWNT carrying polystyrene

FIG. 143. In situ polymerisation involving ATRP initiators such as alkyl halides, to produce e.g., polystyrene-SWNT composite

FIG. 144. General structures generated by in situ polymerisation involving ATRP initiators

FIG. 145. SWNT-ML-polymer-RAFT initiator

FIG. 146. General structures generated by in situ polymerisation involving RAFT initiators

FIG. 147. In situ polymerisation involving organic photoinitiators

FIG. 148. In situ polymerisation involving initiators that only react with one reactive group of a monomer that is asymmetric in the sense that it comprises two different reactive groups, both of which are involved in the polymerization process.

FIG. 149. Ring-closing of a macrocycle around Tuball SWNTs

FIG. 150. TGA analysis of “SWNT-ML composite of Example JJ36”

FIG. 151. AC-HRTEM analysis of “SWNT-ML composite of Example JJ36”

FIG. 152. Processing methodologies

FIG. 153a. Bidentate compound carrying two MLs

FIG. 153b. Pultrusion using drawn CNT forests, CNT thread or other types of CNT fibers and -lines

FIG. 154a. Precursor-ML carrying protonated amines, binding to a carbon nanotube

FIG. 154b. Precursor-ML carrying polar groups, binding to a carbon nanotube.

FIG. 155. Recycling a thermoset-nanotube composite

FIG. 156. Two approaches for making CNT-reinforced Kevlar.

FIG. 157. Synthesis scheme for compound (ZZ-3)

FIG. 158. Synthesis scheme for compound (ZZ-4)

FIG. 159. Compound (ZZ-4) complexed to a nanotube

FIG. 160. Synthesis scheme for compound (ZZ-6)

FIG. 161. Synthesis scheme for compound (ZZ-7)

FIG. 162. Compound (ZZ7) complexed to a nanotube

FIG. 163. Synthesis scheme for compound (ZZ-14)

FIG. 164. Synthesis scheme for compound (ZZ-15)

FIG. 165. Compound (ZZ-15) complexed to a nanotube

FIG. 166. Synthesis scheme for compound (ZZ-19)

FIG. 167. Synthesis scheme for compound (ZZ-20)

FIG. 168. Compound (ZZ-20) complexed to a nanotube

### DETAILED DESCRIPTION OF THE INVENTION

### General Components and Processes.

### General Process.

In a preferred embodiment of the invention, a SE1-precursor-ML complex is formed by the following steps:
Step X1. Provide a SE1;
Step X2. Provide a precursor-ML;
to obtain a SE1-precursor-ML complex;
where Steps X1-X2 may be performed in any order.

In a preferred embodiment of the invention, SE1 is a nanotube, carbon nanotube, graphene, SWNT, MWNT, or nanowire, and the precursor-ML is a chemical structure comprising one or two or more chemical moieties with affinity for the SE1, e.g. a Ushape or another chemical entity comprising at least one ligand moiety with affinity for the SE1.

In another preferred embodiment of the invention, a nanotube-Ushape complex is formed by the following steps:
Step Y1. Provide a SE1, where the SE1 is a nanotube;
Step Y2. Provide a precursor-ML, where the precursor-ML is a Ushape comprising two chemical moieties with affinity for the nanotube;
to obtain a nanotube-Ushape complex;
where Steps Y1-Y2 may be performed in any order.

In another preferred embodiment of the invention, a nanotube-closed ring complex is formed by the following steps:
Step Z1. Provide a SE1, where the SE1 is a nanotube;
Step Z2. Provide a precursor-ML, where the precursor-ML is a Ushape comprising two chemical moieties with affinity for the nanotube;
Step Z3. Optionally, add a catalyst or a further reagent;
where Steps Z1-Z3 may be performed in any order;
to obtain a nanotube-ML complex where the ML is a closed ring around the nanotube;

In a preferred embodiment of the invention, a number of precursor-MLs are added in Step Z2, and all or some of these are converted to MLs, in the form of closed rings.

The MLs added in Step Z2 may all be the same or different.

The complex obtained following Step Z3 may comprise only MLs (e.g. closed rings), or may obtain on each nanotube one or more precursor-MLs (e.g. U shapes) and one or more MLs (e.g. closed rings).

The presence of precursor-MLs (e.g. U shapes) in the final complex may be attractive in cases where a high conductivity of the final composite is desired; the presence of MLs (e.g. closed rings) may be attractive where a practically irreversible mechanical bonding is desired.

Process for making CMUs and composite materials.

### General Process.

In a preferred embodiment of the invention, a composite material is produced by the following steps:
Step 1a. Provide a SE1;
Step 1b. Provide a precursor-ML;
Step 1c. Optionally, provide a catalyst;
Step 1d. Provide a SE2;
to generate a SE1-ML-SE2 structure.

Steps 1a, 1b, 1c, and 1d may be performed in any order.

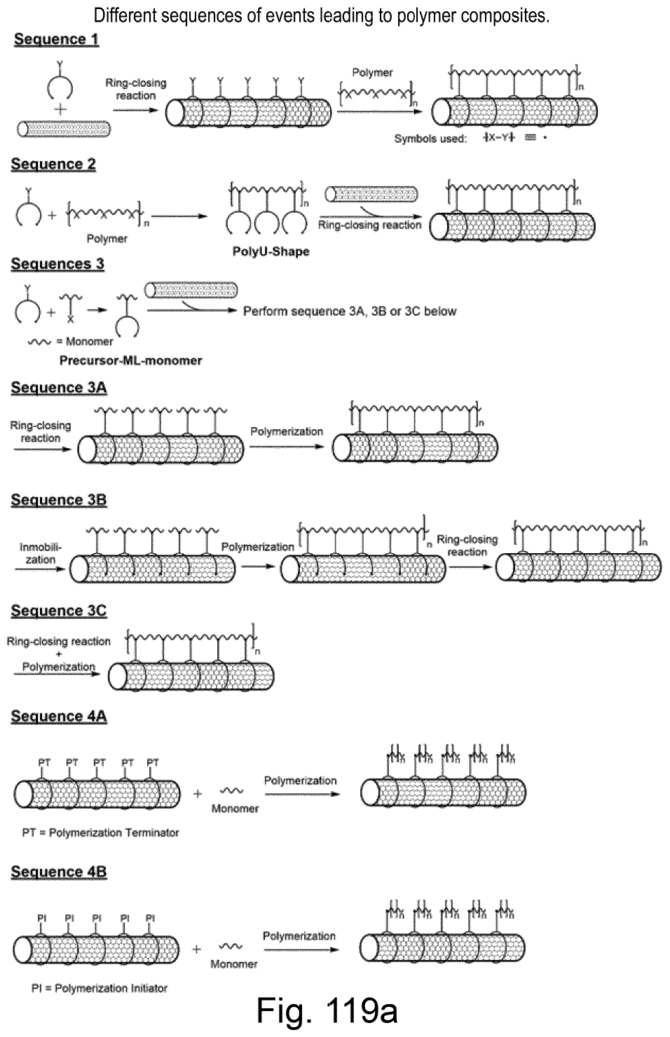

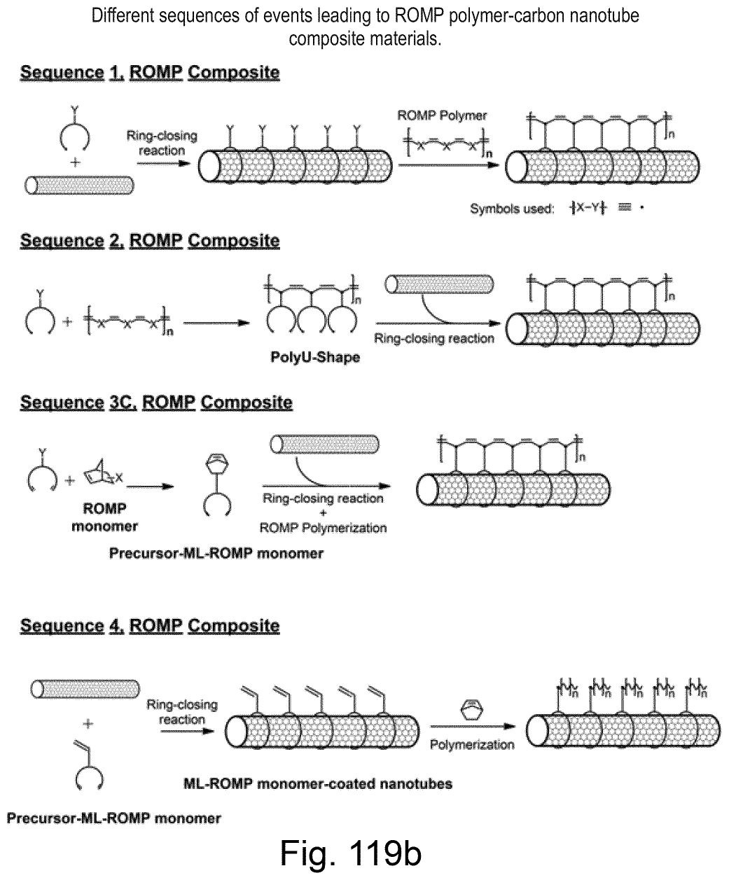

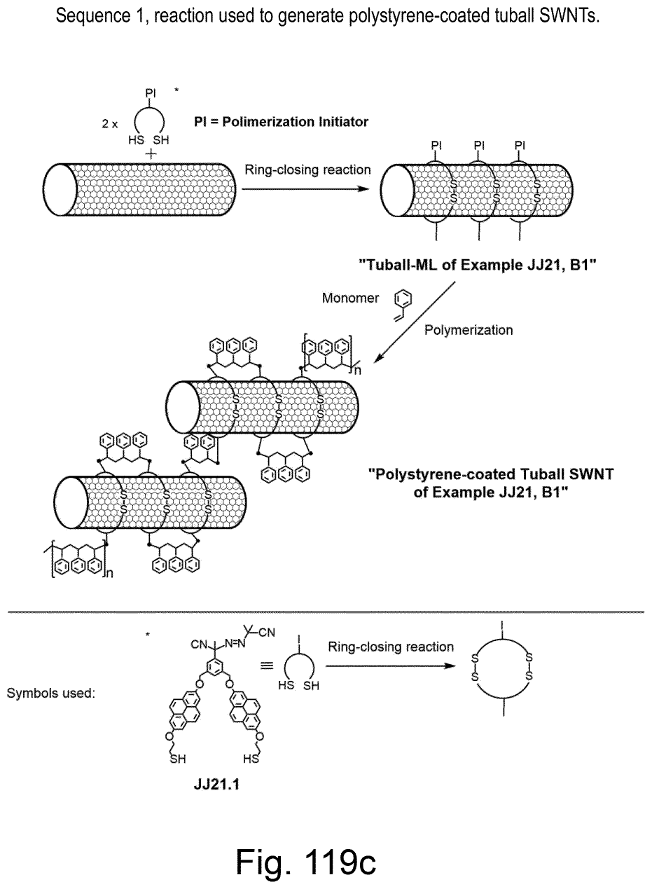

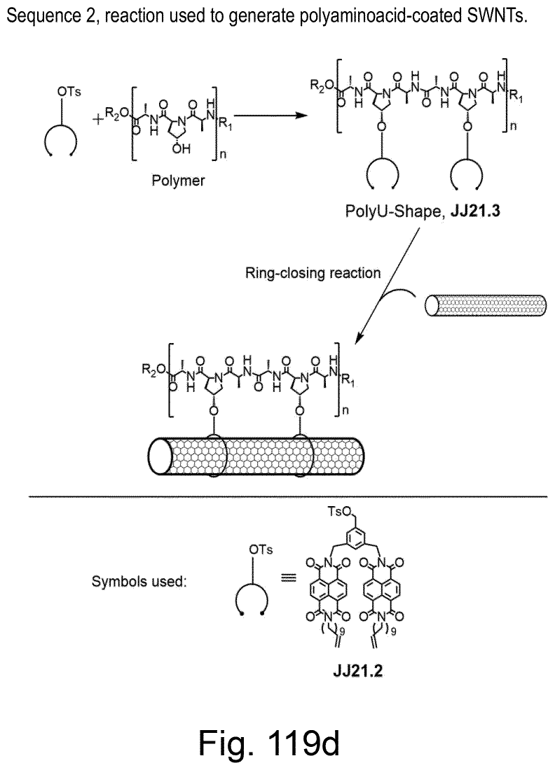

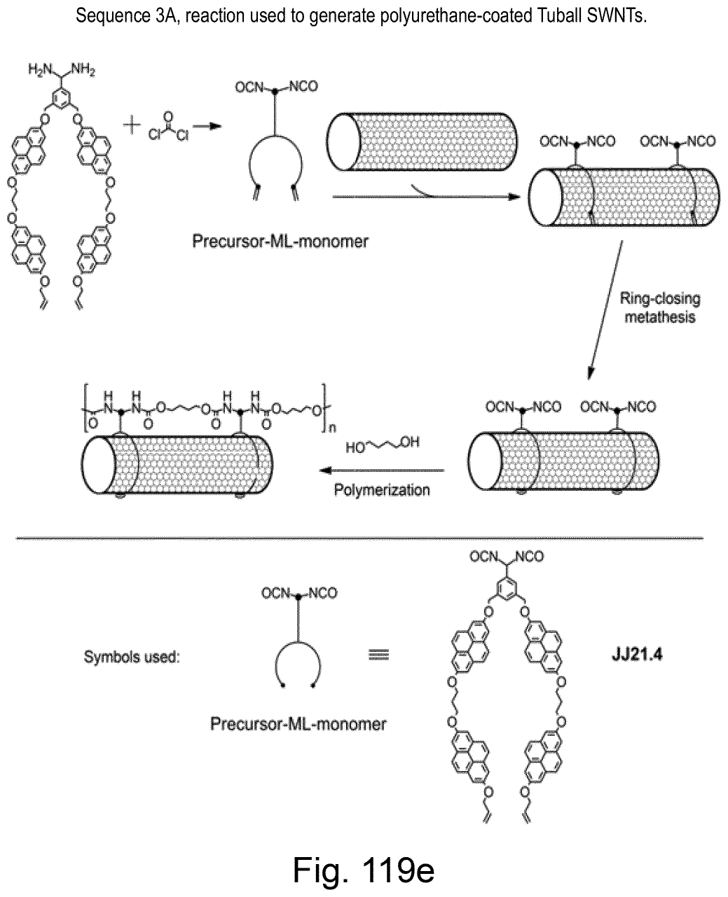

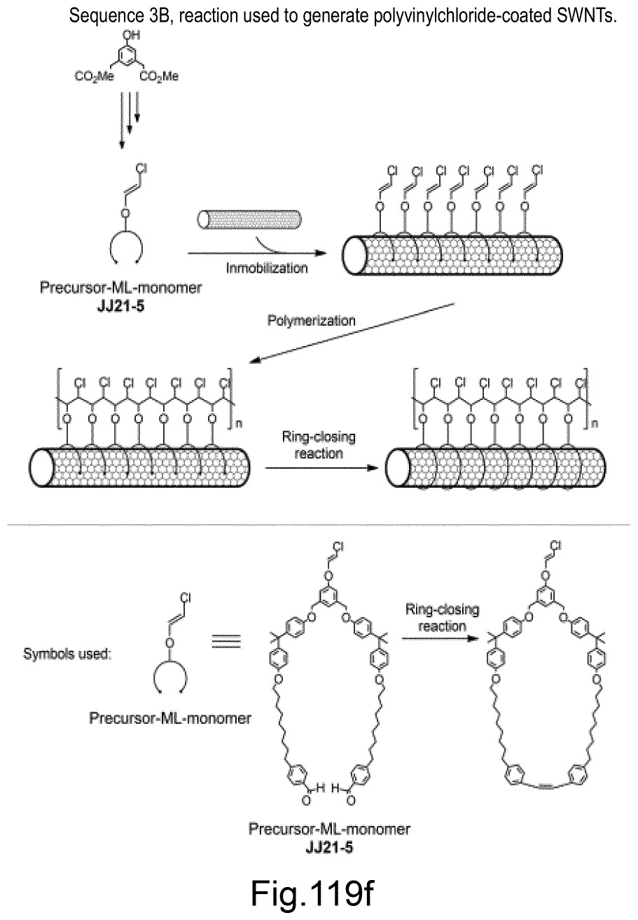

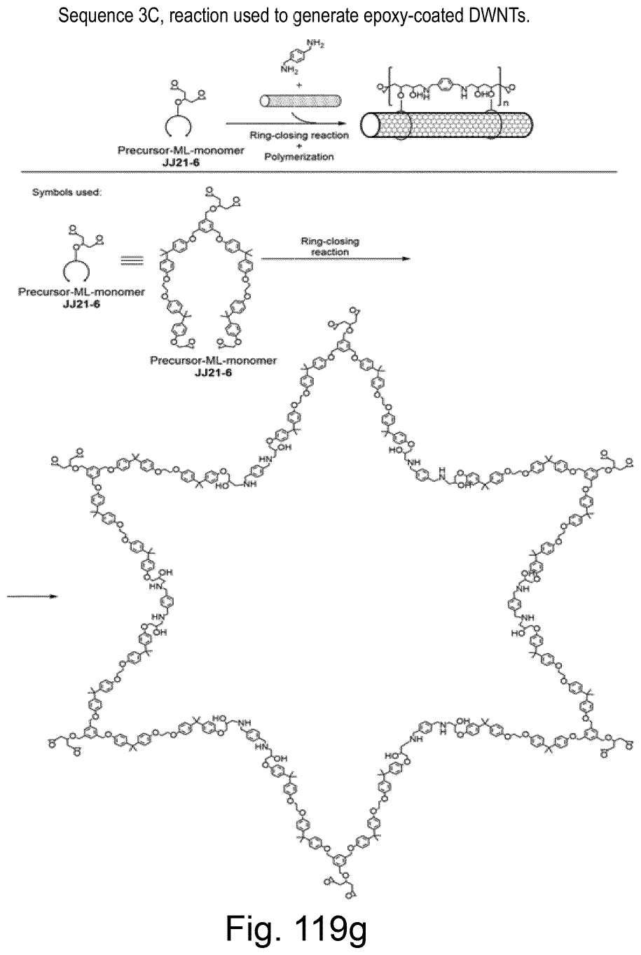

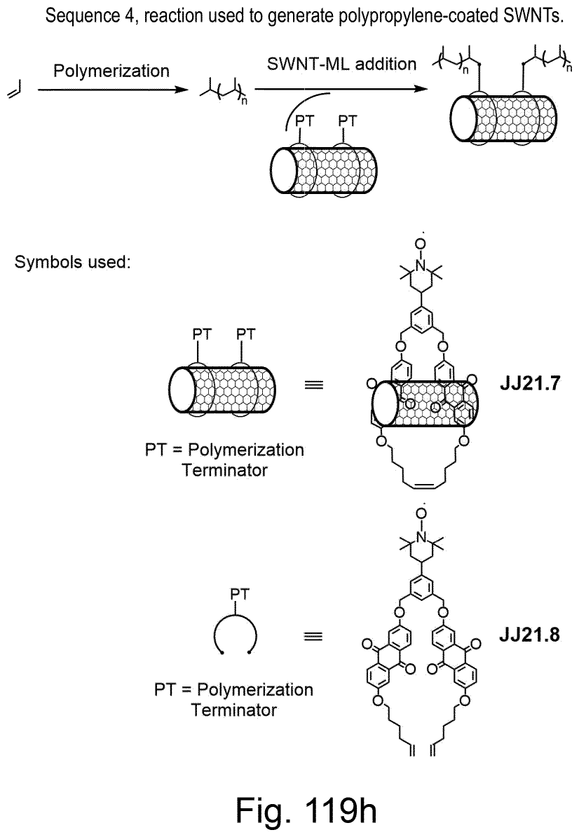

Example 0 and FIG. 119a exemplify different variations of the general process, where the individual steps are performed in different order.

In a preferred embodiment of the invention, SE1 is a nanotube, the precursor-ML comprises at least one ligand moiety with affinity for the nanotube and comprising two reactive groups that can react to allow ring-closing of the Ushape around the nanotube, thereby forming the ML, and the SE2 is a polymer that may optionally be capable of reacting with a functional group of the ML, thereby covalently linking the SE2 to the ML.

SE2 may be a small molecule (e.g. a monomer, capable of reacting with other monomers to form a polymer) or may be a larger molecule (e.g. a polymer). Thus, in the Step 1d the SE2 that is provided may be a monomer which upon the polymerization reaction with other monomers becomes a polymer. Therefore, over time the SE2 may change from being a monomer to being a polymer.

In a similar way, the SE1 provided in the Step 1a may be initially provided in the form of a building block which then upon reaction with other building blocks ends up being a larger structure (e.g. a nanotube, graphene, polymer or mineral). Therefore, over time the SE1 may change from being a smaller chemical structure (a building block) to being a larger chemical structure (an extended chemical structure like e.g. a nanotube).

In a preferred embodiment SE2 is a polymer that is covalently linked to the precursor-ML in the first reaction of the process, as indicated by the following steps:
Step 2a. Provide a precursor-ML;
Step 2b. Provide a polymer and react polymer with precursor-ML to form a covalent bond between polymer and precursor-ML;
Step 2c. Provide a SE1 and allow precursor-ML to associate with SE1;
Step 2d. Provide a catalyst that is capable of mediating reaction of two functional groups of the precursor-ML, thereby forming the ML, mechanically bound to SE1;
to generate a SE1-ML-polymer structure.

FIG. 119a describes the production of composite materials comprising nanotubes (as SE1) and polymer (as SE2). These sequences of events and the general approach of producing composite materials apply, however, to all kinds of SE1 and SE2, and therefore generally describe the production of polymer-, ceramics- and metal composites, and any other kind of composite materials. For non-polymer composites, the applicable SE2 can simply replace “polymer” in the various schemes of FIG. 119a.

Moreover, the 8 different sequences of events, depicted in FIG. 119a, may be combined in any way.

Sequence 1 of FIG. 119a describes the initial binding of precursor-ML (in the figure: a Ushape) to a SE1 (in the figure: a nanotube), followed by formation of the SE1-ML complex, and finally addition of SE2 (in the figure: a polymer) and reaction between SE2 and ML to form the final product, SE1-ML-SE2. Thus, in a preferred embodiment of the invention, the following steps are performed:
Step 3a. Provide a precursor-ML;
Step 3b. Provide a SE1, to form a SE1-precursor ML complex;
Step 3c. The precursor-ML is turned into a ML, mechanically bound to the SE1, optionally by the addition of catalyst and/or reagent(s);
Step 3d. Provide a SE2 and covalently or non-covalently link it to the ML, optionally by the addition of catalyst and/or reagent(s);
to form a SE1-ML-SE2 structure.

Sequence 2 of FIG. 119a describes the initial formation of a poly-precursor-ML (in the figure: poly-Ushape) by reaction of multiple precursor-MLs with one SE2 (in the figure: polymer), followed by addition of SE1 (in the figure: nanotube) and ring-closing around SE1, to form a SE1-ML-SE2 structure. Accordingly, this sequence of events can be described by the following process steps:
Step 4a. Provide a precursor-ML;
Step 4b. Provide a SE2, and attach one or more precursor-ML to SE2;
Step 4c. Provide a SE1, and allow complexation to form a SE1-precursor-ML-SE2 complex;
Step 4d. Convert the precursor-ML to a ML, mechanically bound to SE1;
to form a SE1-ML-SE2 complex.

Sequence 3A of FIG. 119a describes the initial mixing of precursor-ML (in the figure: Ushape) and a portion of SE2 (in the figure: monomer), to generate the structure precursor-ML-portion of SE2 (in the figure: Ushape-monomer structure), and then SE1 (in the figure: nanotube) is added, precursor-ML-portion of SE2 is turned into ML-portion of SE2 structure, and finally the portions of SE2 are reacted to form SE2, and thereby generating a SE1-ML-SE2 structure. In this context, “the portion of SE2” is itself a SE2, as well as the full-size SE2 that is produced upon reaction of multiple “portions of SE2”. Accordingly, the following steps are performed:
Step 5a. Provide a precursor-ML and a portion of SE2, and associate or react the two components to form a precursor-ML-portion of SE2 structure;
Step 5b. Provide a SE1 and allow SE1-precursor-ML complex formation;
Step 5c. Turn the precursor-ML into a ML, to form a SE1-ML-portion of SE2 structure;
Step 5d. Allow reaction of the portions of SE2 with each other;
to form a SE1-ML-SE2 structure.

Sequence 3B of FIG. 119a describes the initial mixing of precursor-ML (in the figure: Ushape) and a portion of SE2 (in the figure: monomer), to generate the structure precursor-ML-portion of SE2 (in the figure: Ushape-monomer structure), and then SE1 (in the figure: nanotube) is added, to form the complex SE1-precursor-ML-portion of SE2, then the portions of SE2 are reacted to form the complex SE1-precursor-ML-SE2, and finally the precursor-ML is turned into ML, thereby generating the SE1-ML-SE2 structure. In this context, “the portion of SE2” is itself a SE2, as well as the full-size SE2 that is produced upon reaction of multiple “portions of SE2”. Accordingly, the following steps are involved:
Step 6a. Provide a precursor-ML and a portion of SE2, and associate or react the two components to form a precursor-ML-portion of SE2 structure;
Step 6b. Provide a SE1 and allow SE1-precursor-ML-portion of SE2 complex formation;
Step 6c. Allow reaction between portions of SE2, attached to precursor-MLs, to form the SE1-precursor-ML-SE2 structure;
Step 6d. Convert the precursor-ML into a ML;
to form a SE1-ML-SE2 complex.

Sequence 3C of FIG. 119a describes the initial mixing of precursor-ML (in the figure: Ushape) and a portion of SE2 (in the figure: monomer), to generate the structure precursor-ML-portion of SE2 (in the figure: Ushape-monomer structure), and then SE1 (in the figure: nanotube) is added, followed by complexation, conversion of precursor-ML into ML (in the figure: ring closing) and SE2 formation (in the figure: polymerization), thereby generating the SE1-ML-SE2 structure. In this context, “the portion of SE2” is itself a SE2, as well as the full-size SE2 that is produced upon reaction of multiple “portions of SE2”. Accordingly, the following steps are performed:
Step 7a. Provide a precursor-ML and a portion of SE2, and associate or react the two components to form a precursor-ML-portion of SE2 structure;
Step 7b. Provide a SE1 and allow SE1-precursor-ML-portion of SE2 complex formation;
Step 7c. Allow conversion of the precursor-ML to a ML and formation of a SE2 from portions of SE2;
to form a SE1-ML-SE2 complex.

Sequence 4A of FIG. 119a describes how precursor-MLs (in the figure: U shapes) carrying a polymerization terminator moiety (PT) is first complexed to a SE1 (in the figure: nanotube) and then the precursor ML is converted to a ML (in the figure: closed ring) mechanically bound to the SE1, then portions of SE2 (in the figure: monomers) are added, and following the association of the portions of SE2 (in the figure: the polymerization of the monomers to form the polymer), the SE2 is attached to the ML through the PT, by way of the last reaction of the polymerization terminating on the polymerization terminator, to form a SE1-ML-SE2 structure. In this context, “the portion of SE2” is itself a SE2, as well as the full-size SE2 that is produced upon reaction of multiple “portions of SE2”. Accordingly, Sequence 4A can be summarized by the following steps:
Step 8a. A SE1, a precursor-ML carrying a polymerization terminator (PT), and optionally a catalyst capable of mediating the conversion of precursor-ML into ML, and a monomer is provided, leading to formation of the SE1-ML complex, where the ML carries a polymerization terminator moiety (PT).
Step 8b. Optionally, a catalyst is provided;
Step 8c. Polymerization proceeds to form a polymer in solution;
Step 8d. The growing polymer eventually terminates its polymerization on the polymerization terminator, thereby forming a SE1-ML-SE2 structure in which one ML is attached to one polymer.

Sequence 4B of FIG. 119a describes how precursor-MLs (in the figure: U shapes) carrying a reactive group (PT) is first complexed to a SE1 (in the figure: nanotube) and then the precursor ML is converted to a ML (in the figure: closed ring) mechanically bound to the SE1, and portions of SE2 (in the figure: monomers) are added, and following the association of the portions of SE2 (in the figure: the polymerization of the monomers to form the polymer, which in this case carries a reactive group capable of reaction with PT), then the SE2 is attached to the ML, through a reaction between PT and the one reactive group of the polymer, to form a SE1-ML-SE2 structure. In this context, “the portion of SE2” is itself a SE2, as well as the full-size SE2 that is produced upon reaction of multiple “portions of SE2”. Accordingly, Sequence 4A can be summarized by the following steps:
Step 9a. A SE1, a precursor-ML carrying a reactive group (PT), and optionally a catalyst capable of mediating the conversion of precursor-ML into ML, and monomers are provided, leading to formation of the SE1-ML complex, where the ML carries a reactive group (PT).
Step 9b. Optionally, a catalyst is provided;
Step 9c. Polymerization proceeds to form a polymer in solution, where the polymer carries one reactive group capable of reacting with the other reactive group (PT);
Step 9d. Optionally, a catalyst and/or reagent(s) are provided;
Step 9e. The reactive group of the polymer is brought to react with the reactive group (PT) of the ML;
to form a SE1-ML-SE2 structure.

In some instances, it is desirable to first form the SE1-ML complex, e.g. in order to disperse the SE1 more efficiently, and then dissociate the SE1-ML complex to obtain SE1 in its “free” form (not complexed to ML), as this may allow the efficient dispersion of SE1 without the ML complexed. As an example, it might increase the electrical conductivity or heat conductivity of a composite material comprising SE1-ML complexes if the ML is dissociated from the SE1. Thus, in a preferred embodiment the following steps are performed in order to obtain well-dispersed, non-ML-complexed SE1 in a composite:
Step 10a. Provide a SE1;
Step 10b. Provide a precursor-ML;
Step 10c. Provide a catalyst and/or conditions allowing the precursor-ML to become a ML, complexed to the SE1;
Step 10d. Provide a SE2;
to generate a composite material comprising a SE1-ML-SE2 structure;
Step 10e. Dissociate the SE1-ML complex into a SE1 and a ML;
to obtain a composite material comprising ML, SE2, and non-ML-complexed SE1.

In a variation of the scheme immediately above, SE1 is a carbon nanotube, the precursor-ML is a UShape carrying two reactive groups, capable of reacting with each other and thereby turn the Ushape into a closed ring around the carbon nanotube (whereby the precursor-ML becomes a ML). Thus, in a preferred embodiment of the invention, the following steps are performed:
Step 11a. Provide a carbon nanotube;
Step 11b. Provide a Ushape carrying two reactive groups, capable of reacting with each other to turn the Ushape into a closed ring structure, wrapped around the carbon nanotube, where the two reactive groups may both be double bonds, and where part of the Ushape (and hence part of the closed ring structure) comprises a cleavable moiety, such as a polypeptide;
Step 11c. Provide a catalyst, e.g. Grubb's second generation catalyst, under conditions allowing the catalyst to mediate the transformation of Ushape into closed ring around the carbon nanotube, thereby generating carbon nanotube-closed ring complexes;
Step 11d. Provide a polymer, e.g. nylon or other polyamide, polypropylene, polyethylene (HDPE or LDPE), PVC, polyurethane, polycarbonate, or polystyrene, and mix, to obtain a mixture of well-dispersed carbon nanotube-closed ring complexes in a matrix of polymer;
Step 11e. Add a cleaving agent capable of cleaving the closed ring, to open the closed ring, e.g. if the cleavable moiety of the Ushape is a polypeptide, then a protease is added capable of cleaving the polypeptide; and allow the cleaving agent to cleave the cleavable moiety, to obtain non-ML-complexed carbon nanotube in a matrix of polymer.

Depending on the efficiency with which the rings are removed from the carbon nanotube, the composite resulting from Step 11e may be more or less electrically conductive or heat conductive.

A composite material is provided which comprises nanotubes, wherein said composite material does not comprise any nanotube aggregates having a smallest dimension larger than 1 mm.

A ML-nanotube complex is also provided, comprising at least two mechanical ligands (ML) complexed to a single nanotube, and wherein said at least two mechanical ligands are covalently linked to one another.

A Mechanical Ligand (ML) is capable of forming a mechanical bond with a structural entity, such as a nanotube, particularly a carbon nanotube (CNT). The ligand optionally changes the characteristics of the structural entity upon binding to it.

A mechanical bond is a bond between a mechanical ligand (ML) and a structural entity (SE) where at least one intramolecular covalent bond in either the SE or one intramolecular covalent bond in the ML must be broken in order to bring the structural entity and the mechanical ligand apart.

However, for a complex of an SE and an ML where the SE and/or ML has an aspect ratio of more than 100 (one hundred), a Mechanical Bond shall mean a bond between said ML and said SE where at least one intramolecular covalent bond in the SE or in the ML must be broken in order to bring the SE and the ML apart in a direction other than the direction of the largest dimension of said SE and/or said ML that has an aspect ratio of more than 100. An intramolecular covalent bond shall mean a covalent bond between atoms within a given molecule (i.e. within the SE or within the ML, but not between the SE and ML).

The following is an example of such a mechanical bond between MLs and SEs that keep the SE and the ML interlocked as a consequence of their topology: The ML is e.g. a closed ring such as a peptide, wrapped around a nanotube that has an aspect ratio larger than 100. The ends of the peptide have been covalently linked so that the peptide forms a continuous string of covalently linked atoms around the nanotube. The nanotube is a cylindrical structure with an aspect ratio of more than 100, which means that its length (along the cylindrical axis) is more than 100 times larger than its diameter (the diameter of the cylindrical structure). Theoretically, the ML (the closed ring peptide) and the SE (the nanotube) could be brought apart by moving the ML up or down the length of the nanotube (i.e. in the direction of the largest dimension of the nanotube), without breaking an intramolecular covalent bond of the closed ring peptide (the ML) or of the nanotube (the SE). However, it is impossible to bring the closed ring peptide and the nanotube apart in a direction other than the direction of the largest dimension of the nanotube (which has an aspect ratio of more than 100) without breaking an intramolecular covalent bond in the closed ring peptide or the nanotube, and therefore the closed ring peptide and the nanotube forms a mechanical bond between them.

MLs of the present invention may be used to increase the solubility or dispersion of structural entities, and are particularly useful when the structural entity has low solubility or dispersion in a given solvent or composite material. Addition of the ML, and the formation of a mechanical bond between the ligand and the structural entity may then increase solubility, particularly if the ML carries chemical moieties that increase solubility or dispersion of the SE to which it is bound, in the solvent or matrix that surrounds it.

MLs of the present invention may also be used to preferentially disperse subgroups of structural entities. As an example, if a mechanical ligand is more likely to become attached to a nanotube of a certain chirality, relative to another nanotube of a different chirality, it will preferentially disperse this nanotube, provided that the ML carries chemical moieties that increase the solubility or dispersion of the nanotube that it binds.

ML-promoted solubilization or dispersion thus provides a means to obtain a better dispersion of e.g additives in composite materials. Thus, addition of a ML that binds the structural entity, to the additive stock solution, or to the polymerization reaction that generates the composite material, or at any other step of composite material production, can improve solubilization or dispersion of the additive during the process and/or in the final composite material.

CNTs (carbon nanotubes) may be difficult to disperse in solvents used in composite material production processes. Addition of CNT-binding MLs during production of e.g. CNT-reinforced polymers may often improve dispersion and/or solubilization, leading to a better distribution of the CNT in the final composite.

What is further provided is the preparation, structure and use of a complex comprising a structural entity (SE) and a ML, where the characteristics of the structural entity when bound by the ML is different from the characteristics of the structural entity when not bound by the ML, or alternatively, the characteristics of said complex is different from the characteristics of the structural entity (SE) and the ML.

The ML-structural entity complex may comprise one or more ligands and one or more structural entities, and thus can be described by the formula

SEₒ-MLₚ

where SE is a structural entity, and
ML is a chemical moiety capable of mechanically binding to the SE, and
o and p are integers larger than zero.

Characteristics of the structural entity that may be perturbed, modified, increased or decreased, include any one or more of the following characteristics: Size of SE, Conductivity of SE, Density of SE, Specific density of SE, Strength of SE (e.g. Young's Modulus, tensile strength, other types of strength), Melting point of SE, Elongation at break of SE. For any of these characteristics of an SE, and in each characteristic's entire range, further characteristics of the SE that may be modified upon mechanical binding of the ML include any one or more of the following: stiffness, electrical conductivity, thermal conductivity, color, fluorescence, luminescence, UV protective capability, abrasion resistance, ductility, elasticity, flexibility, energy storage capability (including energy storage as heat or kinetic energy), information storage capability, hydrophilicity, hydrophobicity, polarity, aproticity, and charge, as well as the following characteristics where the unit of measure is indicated after each characteristic: Arc Resistance, see; Impact Strength, Charpy, J/cm; Impact Strength, Izod Notched, J/cm; Impact Strength, Izod Unnotched, J/cm; Impact Strength, Charpy Notched Low Temp, J/cm; Impact Strength, Izod Notched Low Temp, J/cm; Impact Strength, Charpy Unnotched Low Temp, J/cm; Impact Strength, Charpy Unnotched, J/cm; Linear Mold Shrinkage, cm/cm; Maximum Service Temperature, Air; Melt Flow, g/10 min; Melting Point; Modulus of Elasticity, GPa; Moisture Absorption at Equilibrium, %; Oxygen Transmission, cc-mm/m; Poisson's Ratio; Processing Temperature; Surface Resistance, ohm; Tensile Strength, Ultimate, MPa; Tensile Strength, Yield, MPa; Thermal Conductivity, W/m-K; UL RTI, Electrical; UL RTI, Mechanical with Impact; UL RTI, Mechanical without Impact; Vicat Softening Point; Water Absorption, %; Coefficient of Friction; Comparative Tracking Index, V; Compressive Yield Strength, MPa; CTE, linear 20; Deflection Temperature at 0.46 MPa; Deflection Temperature at 1.8 MPa; Density, g/cc; Dielectric Constant; Dielectric Constant, Low Frequency; Dielectric Strength, kV/mm; Dissipation Factor; Dissipation Factor, Low Frequency; Electrical Resistivity, ohm-cm; Elongation @ break, %; Flammability, UL94; Flexural Modulus, GPa; Flexural Yield Strength, MPa; Glass Temperature; Hardness, Barcol; Hardness, Rockwell E; Hardness, Rockwell M; Hardness, Rockwell R; Hardness, Shore A; Hardness, Shore D; Heat Capacity, J/g.

Depending on the application, an SE with a low, medium, or high degree of each of these characteristics is preferable in the present invention.

In a preferred embodiment, the characteristic of the SE that is modified by the binding of the ML is the strength (e.g. tensile strength, Young's modulus, elongation at break). Particularly preferred embodiments involve SE-ligand complexes where the strength of the SE is increased upon attachment to the ML. The term “reinforced structural entity” will be used in the present invention to describe a complex of a structural entity and a ML in which the strength of the SE is increased compared to the strength of the SE when not bound by the ML.

In a preferred embodiment the reinforced structural entity is a component of a composite material unit (CMU) where said CMU may further be a component of a composite material.

The reinforced structural entity, as well as the structural entity itself, in this case may be termed a filler or additive.

In another preferred embodiment the characteristic of the SE that is modified by the binding of the ML is the conductivity. Particularly preferred embodiments involve SE-ML complexes where the conductivity of the SE is increased upon binding of the ML. Such ML-structural entity complexes where the conductivity of the structural entity has been perturbed by the binding of a ML may be useful as sensor molecules in various electronic circuits. In some cases, it is preferred that the conductivity of the SE is decreased upon binding of the ML. This is commonly the case when the SE-ML complex is part of a sensor molecule or sensor apparatus.

In a preferred embodiment, the ML-SE complex consists of a structural entity (SE) to which is attached a number of MLs. The characteristics of the SE-ML complex changes as more MLs are bound. In some applications, a high number of MLs is desired. This may for example be the case where the SE-ML complex is used in a nanosensor context, where the ML is further attached to e.g. a receptor molecule that binds to the analyte in question, leading to a change in conductivity of the SE, which can be followed as a change in read-out of the sensor. The more MLs that are bound to the SE, the more receptor molecules can be immobilized on the SE-ML complex, and the more the read-out will change as the analyte or more analytes bind to the nanosensor.

Thus, depending on the context, the number of MLs bound per structural entity is preferably greater than 1, such as greater than 2, such as greater than 5, such as greater than 10, such as greater than 20, such as greater than 50, such as greater than 100, such as greater than 200, such as greater than 500, such as greater than 1000, such as greater than 104, such as greater than 10⁵, such as greater than 10⁶, such as greater than 10⁷, such as greater than 10⁸, such as greater than 10⁹.

In other cases, a smaller number of MLs bound to the SE is preferred. As an example, if the SE-ML complex is part of a composition of CMUs, such as part of a composite material, the ML may interfere with the polymerization- or processing process that generates the composite material, wherefore it may be preferable to use a smaller number of MLs bound to an SE. Thus, depending on the context, the number of MLs attached to a structural entity is preferably less than 10⁹, such as less than 10⁸, such as less than 10⁷, such as less than 10⁶, such as less than 10⁵, such as less than 10⁴, such as less than 10³, such as less than 10², such as less than 10, such as less than 2.

Thus, the preferred number of MLs per structural entity is often a compromise and depends on the context, and may be in the range of 1 to 2, or 2 to 10, or 10 to 100, or 100 to 1000, or 103 to 104, or 104 to 105, or 105 to 106, or 106 to 107, or 107 to 108, or 108 to 109.

As described above and below, the optimal number of MLs bound to a structural entity varies depending on the context of its use and the process of its generation.

In a preferred embodiment of said preferred embodiment, the SE is a nanotube, eg. a carbon nanotube, or a graphene molecule, bound by more than 1 ML, more preferably by more than 10 MLs, more preferably by more than 100 MLs, more preferably by more than 1000 MLs, more preferably by more than 10 000 MLs, more preferably by more than 100 000 MLs, even more preferably by more than 1 000 000 MLs. In a preferred embodiment of said preferred embodiment, the SE is a carbon nanotube, other nanotube or graphene molecule, bound by less than 10⁹ MLs, such as less than 10⁸ MLs, less than 10⁷ MLs, less than 10⁶ MLs, less than 10⁵ MLs, less than 10⁴ MLs, less than 10³ MLs, less than 10² MLs, less than 10 MLs, less than 2 MLs.

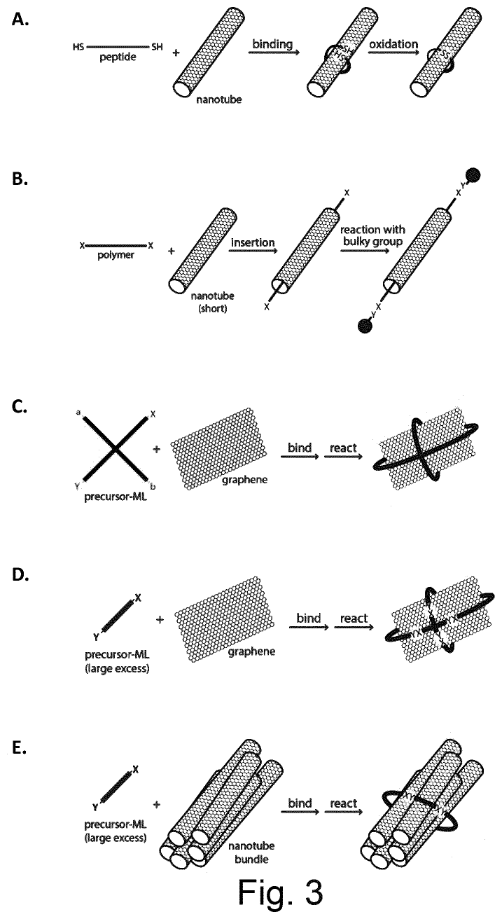

The final chemical structure of the ML may be generated prior to association with the SE, or may be generated during or upon association with the SE. See (FIG. 3) for examples of MLs that are generated during or upon association with an SE.

For MLs whose final structure is generated during or upon association with the SE, the affinity of the precursor-ML (ie. the chemical entity that binds to the SE, but is not yet capable of forming a mechanical bond—such as eg. a linear peptide binding to a carbon nanotube) for the SE, is an important characteristic of a ML. Thus, with a higher affinity of the precursor-ML for SE, a certain number of MLs, bound to SE, may be achieved with a lower amount of precursor-MLs added. Thus, in a preferred embodiment, the precursor-MLs have a dissociation constant for the SE, such as the carbon nanotube, other nanotube, or the graphene, respectively, of less than 10⁻² M, more preferably less than 10⁻³ M, more preferably less than 10⁻⁴ M, more preferably less than 10⁻⁵ M, more preferably less than 10⁻⁶ M, more preferably less than 10⁻⁷ M, more preferably less than 10⁻⁸ M, more preferably less than 10⁻⁹ M, more preferably less than 10⁻¹⁰ M, more preferably less than 10⁻¹² M, more preferably less than 10⁻¹⁴ M, more preferably less than 10⁻¹⁶ M, more preferably less than 10⁻¹⁸ M, more preferably less than 10⁻²⁰ M, more preferably less than 10⁻²⁵ M, more preferably less than 10⁻³⁰ M, more preferably less than 10⁻³⁵ M, more preferably less than 10⁻⁴⁰ M, more preferably less than 10⁻⁵⁰ M.

In other contexts, it is preferable that the affinity of the precursor-ML is low. For example, if the relevant characteristics of the SE (such as conductivity of a carbon nanotube) is negatively affected by strong binding of a ML, it is preferable that the ML (and precursor-ML) binds with low affinity to the SE. Thus, in a preferred embodiment, the precursor-MLs have a dissociation constant for the SE, such as the carbon nanotube, other nanotube, or the graphene, respectively, of more than 10⁻⁵⁰ M, more preferably more than 10⁻⁴⁰ M, more preferably more than 10⁻³⁵ M, more preferably more than 10⁻³⁰ M, more preferably more than 10⁻²⁵ M, more preferably more than 10⁻²⁰ M, more preferably more than 10⁻¹⁸ M, more preferably more than 10⁻¹⁶ M, more preferably more than 10⁻¹⁴ M, more preferably more than 10⁻¹² M, more preferably more than 10⁻¹⁰ M, more preferably more than 10⁻⁹ M, more preferably more than 10⁻⁸ M, more preferably more than 10⁻⁷ M, more preferably more than 10⁻⁶ M, more preferably more than 10⁻⁵ M, more preferably more than 10⁻⁴ M, more preferably more than 10⁻³ M, more preferably more than 10⁻² M.

In a preferred embodiment of said preferred embodiment, the SE is a carbon nanotube or graphene molecule, bound by more than 1 ML, more preferably by more than 10 MLs, more preferably by more than 100 MLs, more preferably by more than 1000 MLs, more preferably by more than 10 000 MLs, more preferably by more than 100 000 MLs, even more preferably by more than 1 000 000 MLs, where the individual precursor MLs, corresponding to said MLs have a dissociation constant for the carbon nanotube or the graphene, respectively, of more than 10⁻⁵⁰ M, more preferably more than 10⁻⁴⁰ M, more preferably more than 10⁻³⁵ M, more preferably more than 10⁻³⁰ M, more preferably more than 10⁻²⁵ M, more preferably more than 10⁻²⁰ M, more preferably more than 10⁻¹⁸ M, more preferably more than 10⁻¹⁶ M, more preferably more than 10⁻¹⁴ M, more preferably more than 10⁻¹² M, more preferably more than 10⁻¹⁰ M, more preferably more than 10⁻⁹ M, more preferably more than 10⁻⁸ M, more preferably more than 10⁻⁷ M, more preferably more than 10⁻⁶ M, more preferably more than 10⁻⁵ M, more preferably more than 10⁻⁴ M, more preferably more than 10⁻³ M, more preferably more than 10⁻² M.

In a preferred embodiment of said preferred embodiment, the SE is a carbon nanotube or graphene molecule, bound by less than 10⁹ MLs, such as less than 10⁸ MLs, less than 10⁷ MLs, less than 10⁶ MLs, less than 10⁵ MLs, less than 10⁴ MLs, less than 10³ MLs, less than 10² MLs, less than 10 MLs, less than 2 MLs, where the individual pre-cursor MLs, corresponding to said MLs have a dissociation constant for the carbon nanotube or the graphene, respectively, of more than 10⁻⁵⁰ M, more preferably more than 10⁻⁴⁰ M, more preferably more than 10⁻³⁵ M, more preferably more than 10⁻³⁰ M, more preferably more than 10⁻²⁵ M, more preferably more than 10⁻²⁰ M, more preferably more than 10⁻¹⁸ M, more preferably more than 10⁻¹⁶ M, more preferably more than 10⁻¹⁴ M, more preferably more than 10⁻¹² M, more preferably more than 10⁻¹⁰ M, more preferably more than 10⁻⁹ M, more preferably more than 10⁻⁸ M, more preferably more than 10⁻⁷ M, more preferably more than 10⁻⁶ M, more preferably more than 10⁻⁵ M, more preferably more than 10⁻⁴ M, more preferably more than 10⁻³ M, more preferably more than 10⁻² M.

In a preferred embodiment of said preferred embodiment, the SE is a carbon nanotube, other nanotube, or graphene molecule, bound by 1 to 10, or 10 to 10², or 10² to 10³, or 10³ to 10⁴, or 10⁴ to 10⁵, or 10⁵ to 10⁶, or 10⁶ to 10⁷, or 10⁷ to 10⁸, or 10⁸ to 10⁹ MLs, where the individual precursor MLs, corresponding to said MLs, have a dissociation constant for the carbon nanotube or the graphene, respectively, of 10⁻⁵⁰ to 10⁻³⁰ M, or 10⁻³⁰ to 10⁻²⁰ M, or 10⁻²⁰ to 10⁻¹⁰ M, or 10⁻¹⁰ to 10⁻⁹ M, or 10⁻⁹ to 10⁻⁸ M, or 10⁻⁸ to 10⁻⁷ M, or 10⁻⁷ to 10⁻⁶ M, or 10⁻⁶ to 10-5 M, or 10⁻⁵ to 10⁻⁴ M, or 10⁻⁴ to 10⁻³ M, or 10⁻³ to 10⁻² M.

What is further provided in this invention is a structure of, and a process for preparing, a Linker Unit (LU) of the following composition:

ML-LinkerL-Ligand2

where
ML is chemical entity that is capable of forming a mechanical bond with a structural entity, LinkerL is a chemical bond or entity that links ML and Ligand2,
Ligand2 is a chemical entity that is capable of binding covalently or non-covalently to a structural entity, or alternatively, is capable of forming a mechanical bond with a structural entity,
and optionally, where
a structural entity, SE1, is bound to ML, and
a structural entity, SE2, is bound to Ligand2,
thereby forming a composite material unit (CMU) of the following composition:

SE1-ML-LinkerL-Ligand2-SE2

where
SE1 is a Structural Entity,
ML is chemical entity that is mechanically bound to SE1,
LinkerL is a chemical bond or entity that links ML and Ligand2,
Ligand2 is a chemical entity that is attached to SE2,
SE2 is a Structural Entity,

The LU thus may be used to link two structural entities. The LU as described in the present invention is capable of efficiently linking two or more structural entities.

A structural entity SE is a chemical or physical entity. A structural entity may be an atom (e.g. an ion), a molecule (e.g. a nylon polymer or a CNT), or part of a surface/material (e.g. metal).

SE1 can be identical to SE2; SE1 can be of the same type as SE2, e.g. can both be nanotubes; SE1 can be of a different type than SE2, e.g. SE1 may be a nanotube and SE2 may be a plastic polymer. SE1 binds an ML; SE2 may also bind an ML or may not bind an ML.

The CMU may be used in the preparation of composite materials with improved or novel characteristics. The CMU as described in the present invention links different parts of the composite material in an efficient manner. The link may either be covalent or non-covalent.

What is further claimed is a composition, and the process of preparing a composition, comprising two or more CMUs. The two or more CMUs may be identical, essentially identical or different.

CMUs can be the sole constituents of composite materials, or further components may be added to form composite materials with unique characteristics.

Preferred embodiments include compositions comprising CMUs and a matrix such as a metal, a ceramic or a polymer.

The various components of the Composite Material Unit (CMU) are described below.

### Guidelines for Using the Present Invention.

When using the present invention to make composite materials, the characteristics sought for the composite material must first be defined. Then an appropriate matrix material and additive can be chosen, e.g. from Group 1: Polymers, or Group 2: Polymers and plastics, or Group 3: Additives. As an example, if light-weight material with high strength is sought, one may choose a light-weight polymer material (e.g. polypropylene) as one of the structural entities (SE1), and an additive with high strength (e.g. a carbon nanotube) as the other structural entity (SE2).
Then it must be decided which ligands should be used. For good anchoring of the additive in the matrix one may choose to use a covalent bond as ligand between the polymer (SE2) and the linker. An appropriate covalent bond can be chosen from Group 6: Reactive groups and covalent bonds formed upon reactions, or Group 7: Covalent bond-forming chemical reactions, or Group 8: Covalent bonds. Thus, reactive groups on the polymer units must be present or introduced, for reaction with the linker unit. Alternatively, some or all of the polymer units must be covalently linked to the linker prior to the polymerization of the polymer matrix. In the example in which a CNT is chosen as additive, it would be appropriate to use a mechanical ligand, and thereby obtain a mechanical bond between the CNT (SE1) and the linker. In the design of a mechanical ligand, a SE1-binding moiety can be chosen from Group 4: Chemical motifs and the SEs they bind, or Group 5: Chemical motifs and the SEs they bind, or Group 10; CNT-binding moieties. The linker may be chosen from Group 9. Linkers. If a low degradability of the composite material is desired, ligands (ML and Ligand2) should be chosen to not comprise easily cleavable bonds such as amide bonds, and also, the ligands preferably should not comprise natural amino acids.
Once the principal components (structural entities, ligands, and linkers) of the composite material have been defined, the formation of the CMU and composite material in general can be performed, by adding the appropriate catalysts, reagents and components in appropriate amount and order.
In the above example a composite material consisting of polypropylene (matrix material) and carbon nanotube (additive, providing strength), held together by a linker comprising a covalent ligand (covalent bond between linker and polypropylene) and a mechanical ligand (bound to carbon nanotube), will have been produced.

Further considerations may have to be taken into account when designing the process for producing the composite material:
Solubility of the SEs is also an important parameter to consider. If the SE, that here functions as the additive, is soluble in both the solvent employed during the polymerization reaction and in the polymer itself, the SE will become evenly distributed in the composite material. However, sometimes a less soluble SE may be an advantage, as a decreased solubility might mediate interaction between SEs of the same kind, which may sometimes be an advantage, e.g. for efficient load transfer where efficient interaction is mediated by direct interactions between SEs of the same kind.
When making composites comprising tube-like structures such as nanotubes with mechanical ligands in the form of rings around them, it is often desirable that the nature of the ring, i.e. its charge, polarity, content of various elements, etc., is similar to the nature of the structural entities that are in the composite. As an example, if one wishes to make a CNT-polyamide composite, it is desirable that the mechanical ligand har polyamide-like features. Thus, it is desirable that the mechanical ligand is itself a polyamide, and that the ring does not carry too many undesired chemical moieties. One such undesired chemical moiety could be a nanotube binding domain of the precursor-ML. Thus, it is desirable if means are applied that leads to a minimization or elimination of the content of such undesired chemical moieties in the final composites.

### MLs and SeE

### Structural Entity (SE).

A structural entity SE is a chemical or physical entity. A structural entity is typically used to anchor the CMU in place in the larger structure of the composite material, or alternatively, is used to modify the characteristics of the composite material, e.g. by modifying the strength or flexibility of the composite material. A structural entity may also provide alternative characteristics such as conductivity, heat absorption, energy storage, etc. Finally, an SE can be a CMU.

When an SE is added to a composite material, e.g. to increase the strength of the composite material, it is in most cases an additive that makes it more expensive to produce the composite material and therefore makes the final composite material more expensive. Thus, depending on the context, the amount of SE added per composite material product is preferably less than 10⁹ kg, such as less than 10⁸ kg, such as less than 10⁷ kg, such as less than 10⁶ kg, such as less than 10⁵ kg, such as less than 10⁴ kg, such as less than 10³ kg, such as less than 100 kg, such as less than 10 kg, such as less than 1 kg, such as less than 0.1 kg, such as less than 0.01 kg, such as less than 10⁻³ kg, such as less than 10⁻⁴ kg, such as less than 10⁻⁵ kg, such as less than 10⁻⁶ kg, such as less than 10⁻⁷ kg, such as less than 10⁻⁸ kg, such as less than 10⁻⁹ kg, such as less than 10⁻¹⁰ kg, such as less than 10⁻¹¹ kg, such as less than 10⁻¹² kg.

In other cases, the SE added to the composite material is an additive that makes it cheaper to produce the composite material and therefore makes the final composite material less expensive. Thus, depending on the context, the amount of SE added is preferably greater than 10⁻¹² kg, such as greater than 10⁻¹¹ kg, such as greater than 10⁻¹⁰ kg, such as greater than 10⁻⁹ kg, such as greater than 10⁻⁸ kg, such as greater than 10⁻⁷ kg, such as greater than 10⁻⁶ kg, such as greater than 10⁻⁵ kg, such as greater than 10⁻⁴ kg, such as greater than 10⁻³ kg, such as greater than 0.01 kg, such as greater than 0.1 kg, such as greater than 1 kg, such as greater than 10 kg, such as greater than 100 kg, such as greater than 10³ kg, such as greater than 10⁴ kg, such as greater than 10⁵ kg, such as greater than 10⁶ kg, such as greater than 10⁷ kg, such as greater than 10⁸ kg, such as greater than 10⁹ kg.

Thus, the preferred compromise between addition of a large amount of SE and a low amount of SE depends on the context, and may be smaller than 10⁻¹² kg, but may also be in the range of 10⁻¹²-10⁻¹¹ kg, 10⁻¹¹-10⁻¹⁰ kg, 10⁻¹⁰-10⁻⁹ kg, 10⁻⁹-10⁻⁸ kg, 10⁻⁸-10⁻⁷ kg, 10⁻⁷-10⁻⁶ kg, 10⁻⁶-10⁻⁵ kg, 10⁻⁵-10⁻⁴ kg, 10⁻⁴-10⁻³ kg, 0.001-0.01 kg, 0.01-0.1 kg, 0.1-1 kg, 1-10 kg, 10-100 kg, 100-1,000 kg, 10³-10⁴ kg, 10⁴-10⁵ kg, 10⁵-10⁶ kg, 10⁶-10⁷ kg, 10⁷-10⁸ kg, 10⁸-10⁹ kg, or above 10⁹ kg.

In most cases, it is not the absolute amount of SE that matters most, but rather the relative amount of SE versus total amount of material. Thus, depending on the context, the total weight of the SEs of a composite material relative to the weight of the composite material is preferentially greater than 0.00001%, more preferably greater than 0.0001%, more preferably greater than 0.001%, more preferably greater than 0.01%, more preferably greater than 0.1%, more preferably greater than 0.1%, more preferably greater than 1%, more preferably greater than 5%, more preferably greater than 10%, more preferably greater than 20%, more preferably greater than 30%, more preferably greater than 40%, more preferably greater than 50%, more preferably greater than 60%, more preferably greater than 70%, more preferably greater than 80%, more preferably greater than 90%, and even more preferably greater than 95%.

When producing an SE, the MW of the SE is an important parameter. In many cases, a low MW is preferred as smaller molecule are often less expensive to produce compared to larger molecules. Thus, depending on the context, the SE MW is preferably less than 10⁹ Dal, such as less than 10⁸ Dal, such as less than 10⁷ Dal, such as less than 10⁶ Dal, such as less than 10⁵ Dal, such as less than 10⁴ Dal, such as less than 10³ Dal, such as less than 10² Dal, such as less than 10 Dal, such as less than 3 Dal.

In other cases, a high MW is preferred as larger molecules are often less expensive to purify. Thus, depending on the context, the molecular weight is preferably greater than 3 Dal, such as greater than 10 Dal, such as greater than 10² Dal, such as greater than 10³ Dal, such as greater than 10⁴ Dal, such as greater than 10⁵ Dal, such as greater than 10⁶ Dal, such as greater than 10⁷ Dal, such as greater than 10⁸ Dal, such as greater than 10⁹ Dal.

Therefore, depending on the context, preferred molecular weight of structural entities include molecular weights ranging from 3 Dalton to more than 10⁹ Dalton, such as from 3-10 Dal (e.g. Li+ or Na+), 10-100 Dal (e.g. benzene), 100-1000 Dal, 1000-10,000 Dal (e.g. a 20 amino acid natural polypeptide) 10,000-20,000 Dal (e.g a polymer chain such as nylon), 20,000-30,000 Dal, 30,000-40,000 Dal, 40,000-50,000 Dal, 50,000-70,000 Dal, 70,000-100,000 Dal, 100,000-200,000 Dal, 200,000-500,000 Dal, 500,000-1,000,000 Dal (e.g. carbon nanotube), 1,000,000-2,000,000 Dal, 2,000,000-4,000,000 Dal, 4,000,000-10,000,000 Dal, 10,000,000-100,000,000 Dal, 100,000,000-1,000,000,000 Dal, or particles with molecular weight larger than 10⁹ Dal (e.g. gold particles).

Another important characteristic is the number of functional groups an SE comprises, as an SE with many functional groups will often be more expensive to synthesize. Thus, depending on the context, the number of functional groups on an SE is preferably less than 10⁹, such as less than 10⁸, such as less than 10⁷, such as less than 10⁶, such as less than 10⁵, such as less than 10⁴, such as less than 10³, such as less than 100, such as less than 90, such as less than 80, such as less than 70, such as less than 60, such as less than 50, such as less than 40, such as less than 30, such as less than 25, such as less than 20, such as less than 15, such as less than 10, such as less than 9, such as less than 8, such as less than 7, such as less than 6, such as less than 5, such as less than 4, such as less than 3, such as less than 2.

In other cases a high number of functional groups is desired, as the functional groups can be used to link an SE to a ML or Ligand2 or another SE, or to increase the dispersibility of the SE. Thus, depending on the context, the number of functional groups on an SE is preferably greater than 1, such as greater than 2, such as greater than 3, such as greater than 4, such as greater than 5, such as greater than 6, such as greater than 7, such as greater than 8, such as greater than 9, such as greater than 10, such as greater than 15, such as greater than 20, such as greater than 25, such as greater than 30, such as greater than 40, such as greater than 50, such as greater than 60, such as greater than 70, such as greater than 90, such as greater than 100, such as greater than 10³, such as greater than 10⁴, such as greater than 10⁵, such as greater than 10⁶, such as greater than 10⁷, such as greater than 10⁸, such as greater than 10⁹.

Thus, the preferred compromise between having an SE with many functional groups and an SE with few functional groups depends on the context, and may be in the range of 1-2, 2-3, 3-4, 4-5, 5-6, 6-7, 7-8, 8-9, 9-10, 10-15, 15-20, 20-25, 25-30, 30-40, 40-50, 50-60, 60-70, 70-80, 80-90, 90-100, 100-1,000, 10³-10⁴, 10⁴-10⁵, 10⁵-10⁶, 10⁶-10⁷, 10⁷-10⁸, 10⁸-10⁹, or above 10⁹.

Particularly preferred structural entities include nanotubes such as carbon nanotubes, fullerenes, other carbon-based molecular structures, or any other kind of molecular-, supramolecular-, or macroscopic structures.

The SEs suitable for the present invention may have a number of characteristics.

SEs may be organic or inorganic.

In a preferred embodiment of the invention, the structural entity SE1 is a tube-like structure, such as a nanotube, nanowire, nanofiber, nanorod or other tube-like structure, preferably with a high aspect ratio, such as an aspect ratio of at least 10, such as at least 100, such as at least 1000, such as at least 10000, or such as at least 100000, and a covalently closed ring that is wrapped around the tube-like structure constitutes the mechanical ligand. Most preferably, the structural entity is a nanotube, particularly a carbon nanotube.

For any characteristics of an SE mentioned above, and in each characteristic's entire range, a further characteristic of importance is the molecular weight of the SE.

Molecular weight of SEs. The molecular weight is an important determinant for the characteristics of SEs, and for the characteristics of the CMUs they are part of. For example, larger polymers typically form stronger, less flexible materials, whereas smaller polymers typically are more flexible, but have lesser strength. Therefore, depending on the context, preferred molecular weight of structural entities include molecular weights ranging from 3 Dalton to more than 10⁹ Dalton, such as from 3-10 Dal (e.g. Li+ or Na+), 10-100 Dal (e.g. benzene), 100-1000 Dal, 1000-10,000 Dal (e.g. a 20 amino acid natural polypeptide) 10,000-20,000 Dal (e.g a polymer chain such as nylon), 20,000-30,000 Dal, 30,000-40,000 Dal, 40,000-50,000 Dal, 50,000-70,000 Dal, 70,000-100,000 Dal, 100,000-200,000 Dal, 200,000-500,000 Dal, 500,000-1,000,000 Dal (e.g. carbon nanotube), 1,000,000-2,000,000 Dal, 2,000,000-4,000,000 Dal, 4,000,000-10,000,000 Dal, 10,000,000-100,000,000 Dal, 100,000,000-1,000,000,000 Dal, or particles with molecular weight larger than 10⁹ Dal (e.g. gold particles).

In cases where the strength is of highest importance, typically a high molecular weight is preferred. Thus, depending on the context, the molecular weight is preferably greater than 3 Dal, such as greater than 10 Dal, such as greater than 10² Dal, such as greater than 103 Dal, such as greater than 10⁴ Dal, such as greater than 10⁵ Dal, such as greater than 10⁶ Dal, such as greater than 10⁷ Dal, such as greater than 10⁸ Dal, such as greater than 10⁹ Dal.

In cases where the flexibility is of highest importance, a low molecular weight is typically preferred. Thus, depending on the context, the molecular weight is preferably less than 109 Dal, such as less than 10⁸ Dal, such as less than 10⁷ Dal, such as less than 10⁶ Dal, such as less than 10⁵ Dal, such as less than 10⁴ Dal, such as less than 10³ Dal, such as less than 10² Dal, such as less than 10 Dal, such as less than 3 Dal.

For any characteristics of an SE mentioned above, and in each characteristic's entire range, a further characteristic of importance is the melting point of the SE.

Melting point of SE. The melting point of the SE is often an important parameter, since the melting point of the composite often is strongly dependent on the melting point of the SE. Some applications including CMUs of the present invention involve elevated temperatures, wherefore it is important that the CMU maintains its integrity and structure at such elevated temperatures. This is for example the case when said CMU is part of a composite material, used in an application that involves high temperatures. In these cases a high melting point is preferred.

Thus, depending on the context, the melting point of the SE is preferably greater than −20° C., such as greater than 0° C., such as greater than 50° C., such as greater than 100° C., such as greater than 200° C., such as greater than 400° C., such as greater than 600° C., such as greater than 800° C., such as greater than 1000° C., such as greater than 1500° C., such as greater than 2000° C., such as greater than 3000° C., such as greater than 4000° C., such as greater than 6000° C., such as greater than 8000° C.

In other cases, a composite material's flexibility at low temperatures is important, wherefore a low melting point may be advantageous. Thus, depending on the context, the melting point of the SE is preferably less than 8000° C., such as less than 6000° C., such as less than 4000° C., such as less than 3000° C., such as less than 2000° C., such as less than 1500° C., such as less than 1000° C., such as less than 800° C., such as less than 600° C., such as less than 400° C., such as less than 200° C., such as less than 100° C., such as less than 50° C., such as less than 0° C., such as less than −20° C.

Depending on the context, preferred melting points of SEs thus are below 0° C., such as between −20° C. and 0° C.; or may be higher, such as between 0° C. and 50° C., or between 50° C. and 100° C., or between 100° C. and 200° C., or between 200° C. and 300° C., or between 300° C. and 400° C., or between 400° C. and 500° C., or between 500° C. and 600° C., or between 600° C. and 700° C., or between 700° C. and 800° C., or between 800° C. and 900° C., or between 900° C. and 1,000° C., or between 1,000° C. and 1,100° C., or between 1,000° C. and 1,200° C., or between 1,200° C. and 1,400° C., or between 1,400° C. and 1,600° C., or between 1,600° C. and 1,800° C., or between 1,800° C. and 2,000° C., or between 2,000° C. and 2,200° C., or between 2,200° C. and 2,400° C., or between 2,400° C. and 2,600° C., or between 2,600° C. and 2,800° C., or between 2,800° C. and 3,000° C., or between 3,000° C. and 3,200° C., or between 3,200° C. and 3,400° C., or between 3,400° C. and 3,600° C., or between 3,600° C. and 3,800° C., or between 3,800° C. and 4,000° C., or between 4,000° C. and 4,200° C., or between 4,200° C. and 4,400° C., or between 4,400° C. and 4,600° C., or between 4,600° C. and 4,800° C., or between 4,800° C. and 5,000° C., or between 5,000° C. and 5,200° C., or between 5,200° C. and 5,400° C., or between 5,400° C. and 5,600° C., or between 5,600° C. and 5,800° C., or between 5,800° C. and 6,000° C., or between 6,000° C. and 6,200° C., or between 6,200° C. and 6,400° C., or between 6,400° C. and 6,600° C., or between 6,600° C. and 6,800° C., or between 6,800° C. and 7,000° C., or between 7,000° C. and 7,200° C., or between 7,200° C. and 7,400° C., or between 7,400° C. and 7,600° C., or between 7,600° C. and 7,800° C., or between 7,800° C. and 8,000° C., or between 8,000° C. and 8,200° C., or between 8,400° C. and 8,600° C., or between 8,600° C. and 8,800° C., or between 8,800° C. and 9,000° C., or between 9,000° C. and 9,200° C., or between 9,200° C. and 9,400° C., or between 9,400° C. and 9,600° C., or between 9,600° C. and 9,800° C., or between 9,800° C. and 10,000° C., or between 10,000° C. and 11,000° C., or between 11,000° C. and 12,000° C., or between 12,000° C. and 13,000° C., or between 13,000° C. and 14,000° C., or between 14,000° C. and 15,000° C., or between 15,000° C. and 16,000° C., or between 16,000° C. and 17,000° C., or between 17,000° C. and 18,000° C., or between 18,000° C. and 19,000° C., or between 19,000° C. and 20,000° C., or above 20,000° C. The matrix of a composite to a high degree determines the melting point of the composite; in particular, ceramics and metals have high melting points.

For any characteristics of an SE mentioned above, and in each characteristic's entire range, a further characteristic of importance is the conductivity of the SE.

Conductivity of SE. In certain applications, e.g. use of a composite material in wind turbine blades, it may be important that the propellers are non-conductive, in order to not attract lightning. In other cases it may be desirable to prepare composite materials of modest or high conductivity, in order to be able to detect cracks in the material by analytical measurement of the conductance of the material. Likewise, for SEs used in e.g. nanosensor technology it may be important that the SE is conductive, in order to be able to detect changes in conductivity induced by the association of an analyte with the SE. In some sensor applications it may be desirable to have high conductivity (if the analyte has a strong reducing effect on the conductance of the SE), or it may be desirable to use an SE with an intermediate conductivity in order to detect small changes in conductivity. In other applications, the composite material is used as an insulator, wherefore it is important that the SE has very low conductivity. Thus, depending on the application it may be desirable that the SE has low, intermediate or high conductivity. Structural entities may have conductivities ranging from below 10⁻³⁰ S/m to at least 10¹¹ S/m and higher, such as from below 10⁻³⁰ S/m to 10⁻²⁵ S/m (e.g. Teflon), such as from 10⁻²⁵ S/m to 10⁻²⁰ S/m (e.g. PET), such as from 10⁻²⁰ S/m to 10⁻¹⁵ S/m (e.g. Quarts (fused) and Paraffin), such as from 10⁻¹⁵ S/m to 10⁻¹⁰ S/m (e.g. Hard Rubber, Diamond, Glass), such as from 10⁻¹⁰ S/m to 10⁻⁵ S/m (e.g. GaAs, Silicon), such as from 10⁻⁵ S/m to 1 S/m, such as from 1 S/m to 10 S/m (e.g. Germanium), such as from 10 S/m to 10² S/m, such as from 10² S/m to 10⁴ S/m (e.g. graphite), such as from 10⁴ S/m to 10⁶ S/m (e.g. Nichrome, Mercury,), such as from 10⁶ S/m to 10⁸ S/m (e.g. Stainless steel, Titanium, Platinum, Iron, Lithium, Aluminum, Gold, Cupper, Silver), such as from 10⁸ S/m to 10⁹ S/m, such as from 10⁹ S/m to 10¹⁰ S/m, such as from 10¹⁰ S/m to 10¹¹ S/m (e.g. Carbon nanotubes), such as from 10¹¹ S/m to 10¹² S/m (e.g. Carbon nanotubes), such as from 10¹² S/m to 10¹⁴ S/m, and above 10¹⁴ S/m (e.g. superconducting material).

Thus, depending on the context, the conductivity of an SE is preferably greater than 10⁻³⁰ S/m, such as greater than 10⁻²⁵ S/m, such as greater than 10⁻²⁰ S/m, such as greater than 10⁻¹⁵ S/m, such as greater than 10⁻¹⁰ S/m, such as greater than 10⁻⁵ S/m, such as greater than 1 S/m, such as greater than 10 S/m, such as greater than 10² S/m, such as greater than 10⁴ S/m, such as greater than 10⁶ S/m, such as greater than 10⁸ S/m, such as greater than 10⁹ S/m, such as greater than 10¹⁰ S/m, such as greater than 10¹¹ S/m, such as greater than 10¹² S/m, such as greater than 10¹³ S/m, such as greater than 10¹⁴ S/m.

In other applications, and depending on the context, the conductivity is preferably less than 10¹⁴ S/m, such as less than 10¹³ S/m, such as less than 10¹² S/m, such as less than 10¹¹ S/m, such as less than 10¹⁰ S/m, such as less than 10⁹ S/m, such as less than 10⁸ S/m, such as less than 10⁶ S/m, such as less than 10⁴ S/m, such as less than 10² S/m, such as less than 10 S/m, such as less than 1 S/m, such as less than 10⁻⁵ S/m, such as less than 10⁻¹⁰ S/m, such as less than 10⁻¹⁵ S/m, such as less than 10⁻²⁰ S/m, such as less than 10⁻²⁵ S/m, such as less than 10⁻³⁰ S/m.

For any characteristics of an SE mentioned above, and in each characteristic's entire range, a further characteristic of importance is the density and strength of the SE, as well as the ratio between the density and the various types of strength.

Density and Strength of the SE. For certain applications, for example in the airplane or automotive industry, the strength and density of the composite material is of prime importance. Sometimes, one of the two features is by far the most important. For example, if a structure such as a bridge must be built and the structure must carry a lot of weight, where this weight is much larger than the weight of the structure itself, the weight of the composite material from which the structure is built, has little importance. Only strength is important. In cases where no significant force is applied to the material other than gravity, the weight of the structure becomes important, but the strength is not important. This is for example the case where the composite material is used to make a sculpture that rests on some other structure.

Often, both low density and high strength is desired. However, as these two parameters often are opposing factors, a compromise will have to be made. Therefore, sometimes a high density is acceptable to gain strength, such as high tensile strength or large Young's Modulus. In other cases, low density is necessary, even if lower strength results. Thus, in preferred embodiments the SE may have relatively low Young's modulus or low tensile strength, and in other preferred embodiments the SE has large Young's modulus or large tensile strength; and likewise, in preferred embodiments the density can vary from very small to very large.

Preferred specific densities of SEs suitable for the present invention are lower than 0.01 kg/L, but may also include specific densities in the following ranges: 0.01-0.1 kg/L; 0.1-0.4 kg/L; 0.4-0.6 kg/L; 0.6-0.8 kg/L; 0.8-1 kg/L; 1-1.2 kg/L; 1.2-1.4 kg/L; 1.4-1.6 kg/L; 1.6-1.8 kg/L; 1.8-2 kg/L; 2-2.5 kg/L; 2.5-3 kg/L; 3-3.5 kg/L; 3.5-4 kg/L; 4-4.5 kg/L; 4.5-5 kg/L; 5-5.5 kg/L; 5.5-6 kg/L; 6-6.5 kg/L; 6.5-7 kg/L; 7-7.5 kg/L; 7.5-8 kg/L; 8-8.5 kg/L; 8.5-9 kg/L; 9-9.5 kg/L; 9.5-10 kg/L; 10⁻¹¹ kg/L; 11-12 kg/L; 12-13 kg/L; 13-14 kg/L; 14-16 kg/L; 16-20 kg/L; 20-30 kg/L; or above 30 kg/L.

In some cases high specific densities are preferred. This may be the case when an anchor is made of a composite material comprising SEs, as the anchor should rest heavily on the bottom of the ocean. Thus, depending on the context, the specific density is preferably greater than 0.01 kg/L, such as greater than 0.05 kg/L, such as greater than 0.2 kg/L, such as greater than 0.4 kg/L, such as greater than 0.6 kg/L, such as greater than 0.8 kg/L, such as greater than 1 kg/L, such as greater than 1.2 kg/L, such as greater than 1.5 kg/L, such as greater than 2 kg/L, such as greater than 4 kg/L, such as greater than 6 kg/L, such as greater than 8 kg/L, such as greater than 10 kg/L, such as greater than 12 kg/L, such as greater than 14 kg/L, such as greater than 16 kg/L, such as greater than 20 kg/L, such as greater than 30 kg/L.

In many cases low specific density is preferred. This is for example the case if the SE is part of a composite material, used to make ships that must float on the water, wherefore the weight must be minimized. Thus, depending on the context, the specific density is preferably less than 30 kg/L, such as less than 20 kg/L, such as less than 16 kg/L, such as less than 14 kg/L, such as less than 12 kg/L, such as less than 10 kg/L, such as less than 8 kg/L, such as less than 6 kg/L, such as less than 4 kg/L, such as less than 2 kg/L, such as less than 1.5 kg/L, such as less than 1.2 kg/L, such as less than 1 kg/L, such as less than 0.8 kg/L, such as less than 0.6 kg/L, such as less than 0.4 kg/L, such as less than 0.2 kg/L, such as less than 0.05 kg/L, such as less than 0.01 kg/L.

The Young's modulus of SEs. In the majority of applications of composite materials, a high Young's modulus is preferred, as this will allow the material to recover its original shape after force has been applied to the material. Thus, depending on the context, the Young's modulus is preferably greater than 0.001 TPa, such as greater than 0.01 TPa, such as greater than 0.1 TPa, such as greater than 0.15 TPa, such as greater than 0.2 TPa, such as greater than 0.5 TPa, such as greater than 1 TPa, such as greater than 2 TPa, such as greater than 4 TPa, such as greater than 6 TPa, such as greater than 8 TPa, such as greater than 10 TPa.

However, in a few applications, a low Young's modulus is desirable. This is for example the case when the degree of deformation of a composite material is being used as a measure of how much force was applied to the material. Thus, depending on the context, the Young's modulus is preferably less than 10 TPa, such as less than 8 TPa, such as less than 6 TPa, such as less than 4 TPa, such as less than 2 TPa, such as less than 1 TPa, such as less than 0.5 TPa, such as less than 0.2 TPa, such as less than 0.15 TPa, such as less than 0.1 TPa, such as less than 0.01 TPa, such as less than 0.01 TPa.

The Young's modulus of SEs suitable for the present invention can thus be lower than 0.001 TPa, but may also include SEs with Young's Modulus in the following ranges: 0.001-0 0.01 TPa; 0.01-0.03 TPa; 0.03-0.05 TPa; 0.05-0.07 TPa; 0.07-0.09 TPa; 0.09-0.1 TPa; 0.1-0.11 TPa; 0.11-0.12 TPa; 0.12-0.13 TPa; 0.13-0.14 TPa; 0.14-0.15 TPa; 0.15-0.16 TPa; 0.16-0.17 TPa; 0.17-0.18 TPa; 0.18-0.19 TPa; 0.19-0.20 TPa; 0.20-0.22 TPa (e.g. stainless steel); 0.22-0.25 TPa; 0.25-0.30 TPa; 0.30-0.35 TPa; 0.35-0.40 TPa; 0.40-0.45 TPa; 0.45-0.50 TPa; 0.50-0.60 TPa; 0.60-0.80 TPa; 0.80-1.0 TPa; 1-2 TPa (e.g. single-walled carbon nanotubes); 2-3 TPa; 3-4 TPa; 4-5 TPa; 5-7 TPa; 7-10 TPa; or above 10 TPA.

Preferred tensile strength of SEs is in most cases high, as this will enable the generation of composite materials of high tensile strength, suitable for a large number of applications, e.g. stronger fishing lines and stronger cables. Thus, depending on the context, the tensile strength of SEs is preferably greater than 0.01 GPa, such as greater than 0.05 GPa, such as greater than 0.1 GPa, such as greater than 0.5 GPa, such as greater than 1 GPa, such as greater than 2 GPa, such as greater than 3 GPa, such as greater than 5 GPa, such as greater than 10 GPa, such as greater than 20 GPa, such as greater than 30 GPa, such as greater than 40 GPa, such as greater than 60 GPa, such as greater than 80 GPa, such as greater than 100 GPa, such as greater than 200 GPa.

However, in some cases a low tensile strength is advantageous, for example in cables or lines that must break for safety reasons, in order to avoid damage to individuals. Thus, depending on the context, the tensile strength of SEs is preferably less than 200 GPa, such as less than 100 GPa, such as less than 80 GPa, such as less than 60 GPa, such as less than 40 GPa, such as less than 30 GPa, such as less than 20 GPa, such as less than 10 GPa, such as less than 5 GPa, such as less than 3 GPa, such as less than 2 GPa, such as less than 1 GPa, such as less than 0.5 GPa, such as less than 0.1 GPa, such as less than 0.05 GPa, such as less than 0.01 GPa.

The tensile strength for SEs suitable for the present invention can thus be lower than 0.01 GPa, but may also include SEs with tensile strengths in the following ranges: 0.01-0.03 GPa; 0.03-0.05 GPa; 0.05-0.07 GPa; 0.07-0.09 GPa; 0.09-0.1 GPa; 0.1-0.11 GPa; 0.11-0.12 GPa; 0.12-0.13 GPa; 0.13-0.14 GPa; 0.14-0.15 GPa; 0.15-0.16 GPa; 0.16-0.17 GPa; 0.17-0.18 GPa; 0.18-0.19 GPa; 0.19-0.20 GPa; 0.20-0.22 GPa; 0.22-0.25 GPa; 0.25-0.30 GPa; 0.30-0.35 GPa; 0.35-0.40 GPa; 0.40-0.45 GPa; 0.45-0.50 GPa; 0.50-0.60 GPa; 0.60-0.80 GPa; 0.80-1.0 GPa; 1-2 GPa (e.g. stainless steel); 2-3 GPa; 3-4 GPa; 4-5 GPa; 5-7 GPa; 7-10 GPa; 10-15 GPa; 15-20 GPa; 20-25 GPa; 25-30 GPa; 30-35 GPa; 35-40 GPa; 40-45 GPa; 45-50 GPa (e.g. single-walled carbon nanotubes); 50-55 GPa; 55-60 GPa; 60-65 GPa; 65-70 GPa; 70-75 GPa; 75-80 GPa; 80-85 GPa; 85-90 GPa; 90-100 GPa; 100-200 GPa, or above 200 GPa.

Ratio of strength to specific density is often important. The strength/specific density ratio for the structural entity that is preferred under the present invention is represented by all the ratios that can be obtained, by dividing the abovementioned strengths with the abovementioned specific densities. Thus, preferred embodiments have structural entities with strength/specific densities in the range 0.00003-1000 TPa L/Kg (where strength is represented by Young's modulus). More specifically, the strength/specific density (Young's Modulus) of the SE is preferably in the range 0.00003-1,000 TPa L/Kg, more preferably 0.001-1,000 TPA L/Kg, more preferably 0.01-1,000 TPA L/Kg, more preferably 0.1-1,000 TPA L/Kg, more preferably 1-1,000 TPA L/Kg, more preferably 10-1,000 TPA L/Kg, more preferably 100-1,000 TPA L/Kg, and more preferably 500-1,000 TPA L/Kg, or higher. In cases where e.g. the Young's modulus should be low (see above), the Young's modulus/specific density ratio is preferably less than 1,000 TPA L/kg, such as less than 500 TPA L/kg, such as less than 100 TPa L/kg, such as less than 10 TPa L/kg, such as less than 1 TPa L/kg, such as less than 0.1 TPa L/kg, such as less than 0.01 TPa L/kg, such as less than 0.001 TPa L/kg, such as less than 0.00003 TPa L/kg.

In cases where e.g. Young's modulus is preferably high, the Young's modulus/specific density ratio is preferably greater than 0.00003 TPa L/kg, such as greater than 0.001 TPa L/kg, such as greater than 0.01 TPa L/kg, such as greater than 0.1 TPa L/kg, such as greater than 1 TPa L/kg, such as greater than 10 TPa L/kg, such as greater than 100 TPa L/kg, such as greater than 500 TPa L/kg, such as greater than 1,000 TPA L/kg.

Where strength is measured as tensile strength, the preferred embodiments have structural entities with strength/specific density in the range 0.0003-20,000 GPa L/Kg. More specifically, the tensile strength/specific density of the SE is preferably in the range 0.0003-20,000 GPa L/Kg, more preferably 0.01-20,000 GPa L/Kg, more preferably 0.1-20,000 GPa L/Kg, more preferably 1-20,000 GPa L/Kg, more preferably 10-20,000 GPa L/Kg, more preferably 100-20,000 GPa L/Kg, more preferably 1,000-20,000 GPa L/Kg, more preferably 5,000-20,000 GPa L/Kg, and more preferably 10,000-20,000 GPa L/Kg, or higher.

In cases where e.g. the tensile strength is preferably low (see above), the tensile strength/specific density ratio is preferably less than 20,000 GPa L/kg, such as less than 10,000 GPa L/kg, such as less than 5,000 GPa L/kg, such as less than 1,000 GPa L/kg, such as less than 100 GPa L/kg, such as less than 10 GPa L/kg, such as less than 1 GPa L/kg, such as less than 0.1 GPa L/kg, such as less than 0.0003 GPa L/kg.

In cases where e.g. tensile strength is preferably high, the tensile strength/specific density ratio is preferably greater than 0.0003 GPa L/kg, such as greater than 0.1 GPa L/kg, such as greater than 1 GPa L/kg, such as greater than 10 GPa L/kg, such as greater than 100 GPa L/kg, such as greater than 1,000 GPa L/kg, such as greater than 5,000 GPa L/kg, such as greater than 10,000 GPa L/kg, such as greater than 20,000 GPA L/kg.

Preferred fracture toughness of SEs is in most cases high, as this will enable the generation of composite materials with a low risk of cracks propagating through the composite, ultimately leading to fracture. Examples of composite materials where a high fracture toughness is desirable includes, but are not limited to, wind turbine blades and airplane wings. Thus, depending on the context, the fracture toughness is preferably greater than 0.01 MPa·m^{1/2}, such as greater than 0.1 MPa·m^{1/2}, such as greater than 1 MPa·m^{1/2}, such as greater than 2 MPa·m^{1/2}, such as greater than 5 MPa·m^{1/2}, such as greater than 10 MPa·m^{1/2}, such as greater than 15 MPa·m^{1/2}, such as greater than 20 MPa·m^{1/2}, such as greater than 25 MPa·m^{1/2}, such as greater than 30 MPa·m^{1/2}, such as greater than 40 MPa·m^{1/2}, such as greater than 50 MPa·m^{1/2}, such as greater than 75 MPa·m^{1/2}, such as greater than 100 MPa·m^{1/2},

However, in some applications, a low fracture toughness is desirable. As an example, the fracture toughness of the windows in a train needs to be sufficiently low that a person can break the window using an appropriate tool in an emergency situation. Thus, depending on the context, the fracture toughness is preferably less than 100 MPa·m^{1/2}, such as less than 75 MPa·m^{1/2}, such as less than 50 MPa·m^{1/2}, such as less than 40 MPa·m^{1/2}, such as less than 30 MPa·m^{1/2}, such as less than 25 MPa·m^{1/2}, such as less than 20 MPa·m^{1/2}, such as less than 15 MPa·m^{1/2}, such as less than 10 MPa·m^{1/2}, such as less than 5 MPa·m^{1/2}, such as less than 2 MPa·m^{1/2}, such as less than 1 MPa·m^{1/2}, such as less than 0.1 MPa·m^{1/2}, such as less than 0.01 MPa·m^{1/2}.

The fracture toughness for SEs suitable for the present invention can thus be lower than 0.01 MPa·m^{1/2}, but may also include SEs with fracture toughness in the following ranges: 0.01-0.1 MPa·m^{1/2}, 0.1-1 MPa·m^{1/2}, 1-2 MPa·m^{1/2}, 2-5 MPa·m^{1/2}, 5-10 MPa·m^{1/2}, 10-15 MPa·m^{1/2}, 15-20 MPa·m^{1/2}, 20-25 MPa·m^{1/2}, 25-30 MPa·m^{1/2}, 30-40 MPa·m^{1/2}, 40-50 MPa·m, 50-75 MPa·m^{1/2}, 75-100 MPa·m^{1/2}, or above 100 MPa·m^{1/2}.

Bulk modulus of SEs. In the majority of applications of composite materials, a high bulk modulus is preferred, as this will allow the composite material to withstand a high compression, which is important in structural elements of buildings, bridges, etc. Thus, depending on the context, the bulk modulus is preferably greater than 0.001 GPa, such as greater than 0.01 GPa, such as greater than 0.1 GPa, such as greater than 1 GPa, such as greater than 10 GPa, such as greater than 50 GPa, such as greater than 100 GPa, such as greater than 200 GPa, such as greater than 300 GPa, such as greater than 400 GPa, such as greater than 500 GPa, such as greater than 600 GPa, such as greater than 700 GPa, such as greater than 800 GPa, such as greater than 900 GPa, such as greater than 1,000 GPa.

However, in a few applications, a low bulk modulus is desirable. This is for example the case in some foam products, where it should be easy to compress the foam, e.g. using a person's body weight. Thus, depending on the context, the bulk modulus is preferably less than 1,000 GPa, such as less than 900 GPa, such as less than 800 GPa, such as less than 700 GPa, such as less than 600 GPa, such as less than 500 GPa, such as less than 400 GPa, such as less than 300 GPa, such as less than 200 GPa, such as less than 100 GPa, such as less than 50 GPa, such as less than 10 GPa, such as less than 1 GPa, such as less than 0.1 GPa, such as less than 0.01 GPa, such as less than 0.001 GPa.

The bulk modulus for SEs suitable for the present invention can thus be lower than 0.001 GPa, but may also include SEs with bulk modules in the following ranges: 0.001-0.01 GPa, 0.01-0.1 GPa, 0.1-1 GPa, 1-10 GPa, 10-100 GPa, 100-200 GPa, 200-300 GPa, 300-400 GPa, 400-500 GPa, 500-600 GPa, 600-700 GPa, 700-800 GPa, 800-900 GPa, 900-1,000 GPa, or above 1,000 GPa.

Shear modulus of SEs. In the majority of applications of composite materials, a high shear modulus is preferred, as this will allow the composite material to withstand large forces imposed on the composite material in opposite directions, e.g. brakes on bicycles, cars, wind turbines, etc. Thus, depending on the context, the shear modulus is preferably greater than 0.001 GPa, such as greater than 0.01 GPa, such as greater than 0.1 GPa, such as greater than 1 GPa, such as greater than 10 GPa, such as greater than 50 GPa, such as greater than 100 GPa, such as greater than 200 GPa, such as greater than 300 GPa, such as greater than 400 GPa, such as greater than 500 GPa, such as greater than 600 GPa, such as greater than 700 GPa, such as greater than 800 GPa, such as greater than 900 GPa, such as greater than 1,000 GPa.

However, in some applications, a low shear modulus is desirable. This is for example the case in plastic composite materials used for buttons, e.g. to turn on or off electronic equipment. Such buttons must have a low shear modulus so pressing them is sufficiently easy. Thus, depending on the context, the shear modulus is preferably less than 1,000 GPa, such as less than 900 GPa, such as less than 800 GPa, such as less than 700 GPa, such as less than 600 GPa, such as less than 500 GPa, such as less than 400 GPa, such as less than 300 GPa, such as less than 200 GPa, such as less than 100 GPa, such as less than 50 GPa, such as less than 10 GPa, such as less than 1 GPa, such as less than 0.1 GPa, such as less than 0.01 GPa, such as less than 0.001 GPa.

The shear modulus for SEs suitable for the present invention can thus be lower than 0.001 GPa, but may also include SEs with shear modules in the following ranges: 0.001-0.01 GPa, 0.01-0.1 GPa, 0.1-1 GPa, 1-10 GPa, 10-100 GPa, 100-200 GPa, 200-300 GPa, 300-400 GPa, 400-500 GPa, 500-600 GPa, 600-700 GPa, 700-800 GPa, 800-900 GPa, 900-1,000 GPa, or above 1,000 GPa.

Other kinds of strength, such as torsional strength and impact strength, are also of importance. Thus, SEs with low, medium or high torsional strength, and SEs with low, medium or high impact strength are suitable for the present invention, and represent preferred embodiments.

For any characteristics of an SE mentioned above, and in each characteristic's entire range, a further characteristic of importance is the degree to which the SE can be elongated (stretched) without breaking.

Elongation at break. In many applications, a high elongation at break is preferred. This is for example important in components that absorb energy by deforming plastically such as crash barriers and car bumpers. Thus, depending on the context, the elongation at break is preferably greater than 0.1%, such as greater than 1%, such as greater than 5%, such as greater than 10%, such as greater than 20%, such as greater than 30%, such as greater than 40%, such as greater than 50%, such as greater than 60%, such as greater than 70%, such as greater than 80%, such as greater than 90%, such as greater than 100%, such as greater than 150%, such as greater than 200%, such as greater than 300%, such as greater than 400%, such as greater than 500%, such as greater than 800%, such as greater than 1,500%.

In other applications, a low elongation at break is preferred. This is important in composite materials that must not deform even under harsh conditions such as high pressure and elevated temperature; one such example is ceramic brakes on automobiles, aircrafts and trains. Thus, depending on the context, the elongation at break is preferably less than 1,500%, such as less than 800%, such as less than 500%, such as less than 400%, such as less than 300%, such as less than 200%, such as less than 150%, such as less than 100%, such as less than 90%, such as less than 80%, such as less than 70%, such as less than 60%, such as less than 50%, such as less than 40%, such as less than 30%, such as less than 20%, such as less than 10%, such as less than 5%, such as less than 1%, such as less than 0.1%.

SEs suitable for the present invention can thus have an elongation at break of less than 0.1%, or have elongation at break including the following ranges: 0.1-1%, 1-5%, 5-10%, 10-20%, 20-30%, 30-40%, 40-50%, 50-60%, 60-70%, 70-80%, 80-90%, 90-100%, 100-150%, 150-200%, 200-300%, 300-400%, 400-500%, 500-800%, 800-1,500%, or have elongation at break above 1,500%.

For any characteristics of an SE mentioned above, and in each characteristic's entire range, further characteristics of importance are size and shape of the SE.

Size of SE. The size and shape of the structural entity are important parameters. Thus, although depending on the characteristics of the structural entity, composite materials may benefit from SEs with extended shapes, preferably large in size, if the primary purpose is to increase the Young's modulus of the composite material, by including the SE. Thus, depending on the context, the size of the SE is preferably greater than 0.1 Å, such as greater than 2 Å, such as greater than 1 nm, such as greater than 10 nm, such as greater than 100 nm, such as greater than 1 μm, such as greater than 10 μm, such as greater than 100 μm, such as greater than 1 mm, such as greater than 10 mm.

For other applications, it may be an advantage to include SEs of smaller size, e.g. in order to increase molecular homogeneity of the composite material. In other cases, a primary characteristic of the composite material is even distribution of SEs and it may be generally desired that as little SE as possible should be used in the composite material, e.g. for economic reasons. In such cases, it may be desirable to include SEs of small size. Thus, depending on the context, the size of the SE is preferably less than 10 mm, such as less than 1 mm, such as less than 100 μm, such as less than 10 μm, such as less than 1 μm, such as less than 100 nm, such as less than 10 nm, such as less than 1 nm, such as less than 2 Å, such as less than 0.1 Å.

Often, the choice of size and shape will be a compromise between opposing interests. Thus, in preferred embodiments the SE may be very small to very large, depending on the application. For example, when making composite materials using thermoset polymers and glass fibers, typically long glass fibers in the size range 0.01-1 m are used, whereas when using thermoplastics shorter fibers of typically 1-10 mm are used.

Structural entities may vary in size from less than 1 Ångstrøm dimensions to the mm dimensions, such as from 0.1-2 Å (e.g. K⁺), 2-10 Å (e.g. benzene), 1-10 nm (e.g a short polypeptide), 10-100 nm (e.g. a carbon nanotube, a protein), 100-1,000 nm (e.g a carbon fiber, PVC polymer molecule, a carbon nanotube), 1-10 μm (e.g. a gold particle), 10-100 μm (e.g. a nylon fiber), 100-1,000 μm (e.g an alumina fiber), 1-10 μm (e.g. a plant cell), 10-100 μm (e.g. a bamboo fiber), 100-1,000 μm (e.g. a silver particle), 1-10 mm (e.g. a carbon fiber), or particles larger than 10 mm in at least one dimension.

Further characteristics of SE. For any characteristics of an SE mentioned above, and in each characteristic's entire range, further characteristics of the SE that are of importance in the present invention are the stiffness, electrical conductivity, thermal conductivity, color, fluorescence, luminescence, UV protective capability, abrasion resistance, ductility, elasticity, flexibility, energy storage capability (energy storage as heat or kinetic energy), information storage capability, hydrophilicity, hydrophobicity, polarity, aproticity, and charge, as well as the following characteristics where the unit of measure is indicated after each characteristic: Arc Resistance, sec; Impact Strength, Charpy, J/cm; Impact Strength, Izod Notched, J/cm; Impact Strength, Izod Unnotched, J/cm; Impact Strength, Charpy Notched Low Temp, J/cm; Impact Strength, Izod Notched Low Temp, J/cm; Impact Strength, Charpy Unnotched Low Temp, J/cm; Impact Strength, Charpy Unnotched, J/cm; Linear Mold Shrinkage, cm/cm; Maximum Service Temperature, Air; Melt Flow, g/10 min; Melting Point; Modulus of Elasticity, GPa; Moisture Absorption at Equilibrium, %; Oxygen Transmission, cc-mm/m; Poisson's Ratio; Processing Temperature; Surface Resistance, ohm; Tensile Strength, Ultimate, MPa; Tensile Strength, Yield, MPa; Thermal Conductivity, W/m-K; UL RTI, Electrical; UL RTI, Mechanical with Impact; UL RTI, Mechanical without Impact; Vicat Softening Point; Water Absorption, %; Coefficient of Friction; Comparative Tracking Index, V; Compressive Yield Strength, MPa; CTE, linear 20; Deflection Temperature at 0.46 MPa; Deflection Temperature at 1.8 MPa; Density, g/cc; Dielectric Constant; Dielectric Constant, Low Frequency; Dielectric Strength, kV/mm; Dissipation Factor; Dissipation Factor, Low Frequency; Electrical Resistivity, ohm-cm; Elongation @ break, %; Flammability, UL94; Flexural Modulus, GPa; Flexural Yield Strength, MPa; Glass Temperature; Hardness, Barcol; Hardness, Rockwell E; Hardness, Rockwell M; Hardness, Rockwell R; Hardness, Shore A; Hardness, Shore D; Heat Capacity, J/g. Depending on the application, an SE with a low, medium, or high degree of each of these characteristics is preferable in the present invention.

Further, SEs, in particular SE2, may be polymers or may be non-polymeric in structure.

The polymers can be divided into biological polymers and non-biological polymers.

Non-biological polymers include polymers that are not RNA, DNA or natural polypeptides, yet include PVC, epoxy, unnatural polypeptides (i.e. not solely comprising alpha-amino acids) and unnatural nucleic acids (e.g. PNA, LNA and other unnatural nucleic acids).

The following polymers represent preferred structural entities, suitable for the present invention:

Polymers. The following is a non-comprehensive list of preferred structural entities, in the form of polymers often categorized as the matrix material of a composite.

### Group 1: Polymers.

1. Polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

Polyolefins, i.e. the polymers of monoolefins exemplified in the preceding paragraph, preferably polyethylene and polypropylene, can be prepared by different, and especially by the following, methods:

a) radical polymerisation (normally under high pressure and at elevated temperature).

b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(III) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, Na and/or IIia of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

4. Hydrocarbon resins (for example C5-C8) including hydrogenated modifications thereof (e.g. tackifiers) and mixtures of polyalkylenes and starch.

Homopolymers and copolymers from 1.)-4.) may have any stereostructure including syndiotactic, isotactic, hemi-isotactic or atactic. Stereoblock polymers are also included.

5. Polystyrene, poly(p-methylstyrene), poly(α-methylstyrene).

6. Aromatic homopolymers and copolymers derived from vinyl aromatic monomers including styrene, α-methylstyrene, all isomers of vinyl toluene, especially p-vinyltoluene, all isomers of ethyl styrene, propyl styrene, vinyl biphenyl, vinyl naphthalene, and vinyl anthracene, and mixtures thereof. Homopolymers and copolymers may have any stereostructure including syndiotactic, isotactic, hemi-isotactic or atactic; where atactic polymers are preferred. Stereoblock polymers are also included.

6a. Copolymers including aforementioned vinyl aromatic monomers and comonomers selected from ethylene, propylene, dienes, nitriles, acids, maleic anhydrides, maleimides, vinyl acetate and vinyl chloride or acrylic derivatives and mixtures thereof, for example styrene/butadiene, styrene/acrylonitrile, styrene/ethylene (interpolymers), styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

6b. Hydrogenated aromatic polymers derived from hydrogenation of polymers mentioned under 6.), especially including polycyclohexylethylene (PCHE) prepared by hydrogenating atactic polystyrene, often referred to as polyvinylcyclohexane (PVCH).

6c. Hydrogenated aromatic polymers derived from hydrogenation of polymers mentioned under 6a.).

Homopolymers and copolymers may have any stereostructure including syndiotactic, isotactic, hemi-isotactic or atactic; where atactic polymers are preferred. Stereoblock polymers are also included.

7. Graft copolymers of vinyl aromatic monomers such as styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, MBS, ASA or AES polymers.

8. Halogen-containing polymers such as polychloroprene, chlorinated rubbers, chlorinated and brominated copolymer of isobutylene-isoprene (halobutyl rubber), chlorinated or sulfo-chlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bisglycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, poly-amide 6, polyamide 6/6, 6/10, 6/9, 6/12, 4/6, 12/12, polyamide 1 1, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides, polyetherimides, polyesterimides, polyhydantoins and polybenzimidazoles.

18. Polyesters derived from dicarboxylic acids and diols and/or from hydroxycarboxylic acids or the corresponding lactones or lactides, for example polyethylene terephthalate, polybutylene terephthalate, poly-1,4-dimethylolcyclohexane terephthalate, polyalkylene naphthalate and polyhydroxybenzoates as well as copolyether esters derived from hydroxyl-terminated polyethers, and also polyesters modified with polycarbonates or MBS. Copolyesters may comprise, for example—but are not limited to—polybutylenesuccinate/terephtalate, polybutyleneadipate/terephthalate, polytetramethyleneadipate/terephthalate, polybutylensuccinate/adipate, polybutylensuccinate/carbonate, poly-3-hydroxybutyrate/octanoate copolymer, poly-3-hydroxybutyrate/hexanoate/decanoate terpolymer. Furthermore, aliphatic polyesters may comprise, for example—but are not limited to—the class of poly(hydroxyalkanoates), in particular, poly(propiolactone), poly(butyrolactone), poly(pivalolactone), poly(valerolactone) and poly(caprolactone), polyethylenesuccinate, polypropylenesuccinate, polybutylenesuccinate, polyhexamethylenesuccinate, polyethyleneadipate, polypropyleneadipate, polybutyleneadi-pate, polyhexamethyleneadipate, polyethyleneoxalate, polypropyleneoxalate, polybutylene-oxalate, polyhexamethyleneoxalate, polyethylenesebacate, polypropylenesebacate and polybutylenesebacate, as well as corresponding polyesters modified with polycarbonates or MBS.

19. Polycarbonates and polyester carbonates.

20. Polyketones.

21. Polysulfones, polyether sulfones and polyether ketones.

22. Crosslinked polymers derived from aldehydes on the one hand and phenols, ureas and melamines on the other hand, such as phenol/formaldehyde resins, urea/formaldehyde resins and melamine/formaldehyde resins.

23. Drying and non-drying alkyd resins.

24. Unsaturated polyester resins derived from copolyesters of saturated and unsaturated dicarboxylic acids with polyhydric alcohols and vinyl compounds as crosslinking agents, and also halogen-containing modifications thereof of low flammability.

25. Crosslinkable acrylic resins derived from substituted acrylates, for example epoxy acrylates, urethane acrylates or polyester acrylates.

26. Alkyd resins, polyester resins and acrylate resins crosslinked with melamine resins, urea resins, isocyanates, isocyanurates, polyisocyanates or epoxy resins.

27. Crosslinked epoxy resins derived from aliphatic, cycloaliphatic, heterocyclic or aromatic glycidyl compounds, e.g. products of diglycidyl ethers of bisphenol A and bisphenol F, which are crosslinked with customary hardeners such as anhydrides or amines, with or without accelerators.

28. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

29. Blends of the aforementioned polymers (polyblends), for example PP/EPDM, Poly-amide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

The polymers can be further divided into thermosets such as polyester resin, epoxy resin, and polyurethanes, and thermoplastics such as nylon, polycarbonate and polyethylene.

The polymers can be further divided into linear and branched polymers. The branched polymers may be further divided into short-chain branched polymers, long-chain branched polymers, star-branched polymers, ladder polymers and network polymers.

Polymers and plastics. In preferred embodiments, a suitable SE is chosen from the list comprising polymers & plastics.

### Group 2: Polymers and Plastics.

polyimide, PTFE, PMMA, Kapton, Vespel, Cirlex, ABS
polyimides (kapton, upilex, etc)
polyamides
polycarbonates (PC/lexan)
polyesters (PET/mylar, melinex, dacron, PEN/teonex)
polyethylenes (LDPE, HDPE)
polypropylenes (PP)
styrenics (polystyrenes/PS, acrylonitriles/ABS)
vinyls (PVC, nylon)
acrylics (PMMA/perspex, plexiglas)
fluoroplastics (PTFE/teflon, FEP, PFA, PVDF)
polysulphones (PES)
ketones (PEEK)
polyurethanes
barrier resins (PVA/polyvinyl alcohol)
epoxy resins (FR4)
silicone resins
elastomes (PDMS)
biopolymers (wood, cellulose, starch based)
conductive polymers (Pedot:PSS/baytron, orgacon, TIPS pentacene)
light emitting polymers (white LEP, etc)
copolymers
metalised polymers
Co-polymers
Block co-polymers
Rubber
Latex

Polyacetylene, Polydiacetylenes, Polyethylene—very low density (VLDPE), Polyethylene—low density (LDPE), Polyethylene—linear low density (LLDPE), Polyethylene—medium density (MDPE), Polyethylene—high density (HDPE), Polyethylene—ultrahigh molecular weight (UHMWPE), Polyethylene—cross-linked polyethylene, Polyisoprene, Polybutadiene, Polypropylene, Polypropylene, Polypropylene, Poly-1-butene, Poly-1-hexene, Polymethylpentene, polyisobutylene, poly(ethylene propylene), Poly-1-octene, Ethylene-propylene-diene rubbers, Ethylene-propylene bases thermoplastic elastomers, Polyhexene, Polyheptene, Polyoctene, Polystyrene-butadiene, Parylene, Polystyrene, Polymers of styrene in primary forms, Expansible polystyrene in primary forms, Expanded polystyrene (EPS), Poly(p-phenylene), High-impact polystyrene (HIPS), Poly(p-phenylene-vinylene), Poly(2,5-dioctyl-1,4-phenylenevinylene), Poly(2,6-naphthalenevinylene), Polyanthracene, Poly(anthracene-vinylene), Polyvinylchloride, Polychloroprene, Non plasticised PVC mixed with any other substance in primary forms, Plasticised PVC mixed with any other substance in primary forms, Polyvinylidene chloride (PVDC), Polytetrafluorethylene (PTFE), Polyvinylidene fluoride (PVDF), ethylene tetrafluoro-ethylene copolymer (Tefzel), Polyvinylfluoride, Polyperfluoropropylene, Polyoxymethylene, Polyethyleneoxide, Polypropyleneoxide, Poly(ethylene-propylene oxide), polybutyleneoxide, Polyphenylene ether (PPE), polyacrylate, polyacrylic acid, Polymethylmethacrylate, Polymethylacrylate, Poly(ethyl acrylate), Polyhydroxyethylmethacrylate, Polybutylacrylate, Polybutylmethacrylate, Ethylene vinyl acetate (EVA) and ethylene vinyl alcohol (EVOH), Poly vinyl acetate in primary forms, Poly vinyl acetate in aqueous dispersion in primary forms, Polyvinylacetate, Polyvinylalcohol, Polycarbonate, Polyetherketon, Polyetheretherketon, Polyethyleneterephthalate, Polybutyleneterephthalate, polylactic acid, Polybutylene terephtalate (PBT), Other PET, Polycaprolactone (PCL), Polyglycolide (PG), Liqid crystalline polymers (aromatic) containing esters, Polyethylene adipate (PEA), Polytrimethylene terephthalate (PTT), Polyethylene naphthalate (PEN), Vectran, Alkyd resins, Polymers of vinyl esters or other vinyl polymers in primary forms, Polyacetals in primary forms, Bekalite, Phenol formaldehyde resins (PF), Diglycidyl Ether of Bisphenol-A (DGEBA), Phenolic (Novolac) Epoxy Resins, Poly-o-vinylbenzylalcohol, Poly-p-vinylbenzylalcohol, Polyvinyl formal, Polyvinyl acetal, Polyvinyl isobutyral, Polyvinyl butyral, Polyvinyl-n-butyl ether, Polytetramethylene sebacate, Polybutylene oxide, polypropylene oxide, Polyethylene adipate, Polyacrylonitrile (PAN) and copolymers, Acrylonitrile-butadiene-styrene (ABS) terpolymer, Styrene-acrylonitrile (SAN) copolymer, Polyaniline, Polypyrrole, Polymethacrylonitrile, Polysulphones, Polysulphides, ethylene chlorotrifluoro ethylene copolymer (ECTFE), fluorinated ethylene-propylene copolymer (Teflon FEP), polychlorotrifluoro-ethylene, Nylon PA1,1, Nylon PA1,2, Nylon PA1,3, Nylon PA1,4, Nylon PA1,5, Nylon PA1,6, Nylon PA2,1, Nylon PA6,6, Nylon PA6,10, Polyurethane based on, polyimide, polycaprolactam, aramid, Polyphenylene benzobisoxazole, Poly(m-phenyleneisophtalamide) (MPD-1) (Nomex®), Poly(p-phenyleneterephtalamide) (PPD-T) (Kevlar® and Twaron®), Polyisocyanurates, Polyimides, Bismaleimides (BMI), Polyacenaphthylene, Polyvinyl pyrrolidone, Vinyl chloride-vinyl acetate copolymers and other vinyl chloride copolymers in primary forms, perfluoroalkoxy Teflon PFA, Polydimethysiloxanes (PDMS), Organomodified siloxanes (OMS), Polymethylhydrosiloxane (PMHS), Silicones in primary forms, PolyAPTAC, (poly (acrylamido-N-propyltrimethylammonium chloride) and PolyMAPTAC (poly[(3-(methacryloylamino)-propyl]trimethylammonium chloride) are all suitable polymers for the structural entities SE.

Organic SEs include natural and unnatural polypeptides, lipids, polysaccharides, wood flour, etc.

The following additives represent preferred structural entities, suitable for the present invention: a carbon fibre, a carbon nanofibre, a carbon nanothread, a ceramic material, a composite material, a fullerene, a MWCNT, a SWCNT, graphane, graphene oxide, graphite, graphite, graphyne, a COOH-functionalized carbon nanotube, a OH-functionalized carbon nanotube, an NH2-functionalized carbon nanotube, an SH-functionalized CNT, COOH-functionalized graphene, multi-layer graphene, NH2-functionalized graphene, OH-functionalized graphene, reduced graphene oxide, thiol-functionalized graphene, a glass fibre, aramid, E-glass, iron, polyester, polyethylene, S-glass, steel, a battery, a borosilicate, a buckyball, a buckytube, a capacitator, a carbon dome, a carbon material, a carbon megatube, a carbon nanofoam, a carbon polymer, a catalyst, a cathode, a coated carbon nanotube, a conductor, a covalent crystal, a crystal, a crystalline material, a defect-free graphene sheet, a defect-free MWCNT, a defect-free SWCNT, a dielectric material, a diode, a dodecahedrane, a doped glass, a fibre, a fullerite, a fused silica, a glue, a green ceramic, a lanthanides, a machinable ceramic, a metal alloy, a metal-functionalized carbon nanotube, a metalised dielectric, a metallised ceramic, a metalloid, a mineral, a non-covalent crystal, a piezoelectric material, a platinum group metal, a post-transition metal, a rare earth element, a sapphire, a semiconductor, a sensor, a silicon nitride, a single crystal fiber, a sol-gel, a synthetic diamond, a transition metal, a triple-wall carbon nanotube, a tungsten carbide, alumina, alumina trihydrate, aluminium, aluminum boride, aluminum oxide, aluminum trihydroxide, amorphous carbon, an actinides, an amalgam, an anode, an elastomers, an electrode, an endohedral fullerene, an insulator, an intermetallic, an ionic crystal, an organic material, anode, anthracite, asbestos, barium, bone, boron, brass, buckypaper, calcium carbonite, calcium metasilicate, calcium sulfate, calcium sulphate, carbon black, carbon nanofoam, cathode, chromium, clay, coal, copper, diamond, diamond-like carbon, double-layer graphene, exfoliated graphite, exfoliated silicate, flourinated graphene, fused silica, gallium arsenide, gallium nitride, germanium, glass, glass microsphere, glass ribbons, glassy carbon, gold, hardened steel, hydrous magnesium silicate, hyperdiamond, iron oxides, lead zirconium titanate, lignite, lithium niobate, lonsdaleite, magnesium dihydroxide, magnesium oxide, manganese, metal, metal oxide, mica, molybdenum, nickel, nylon, palladium, pencil lead, platinum, prismane, pyrolytic graphite, rubber, silica, silica gel, silicon, silicon carbide, silicon dioxide, silicon nitride, silver, soot, stainless steel, tantalum, titanium, titanium oxide, tooth cementum, tooth dentine, tooth enamel, tungsten, tungsten carbide, wood, zinc oxide, zirconia.

The SEs can be further divided into SEs comprising solely aliphatic moieties, comprising solely aromatic moieties, or comprising both aliphatic and aromatic moieties.

The SEs can be further divided into SEs comprising solely single bonds, solely double bonds, solely triple bonds, or a combination of single-, double- and triple bonds.

Biological polymers are here defined as the polymers involved in the transcriptional and translational process, i.e. natural nucleic acids (RNA or DNA), and natural polypeptides. Natural polypeptides can be further divided into peptides, proteins and antibodies.

In preferred embodiments, a suitable organic SE is chosen from the list comprising biologicals, such as hair, nail, horn, ligaments, bone, cornea, teeth, fibrous cartilage, vitreous cells, intervertebral disc, womb, skin, intestines, heart membranes, membranes, stomach membrane, cartilage, chronodrocites, intervertebral cartilage, bone enamel, ligaments, tendons and tooth enamel, organs, lung, heart, brain, skin, kidney, tooth material, bone material, tendon material, skin, hair, nails, a biological surface, such as a vein, a biological macromolecule, such as a protein, such as a naturally occurring protein, such as a consensus sequence protein, a modified protein, such as a mutant protein where one or more amino acids have been changed relative to the consensus sequence.

Preferred embodiments of SEs include gold particles, carbon nanotubes, carbon fibers, aluminum fibers, nanotubes, graphene, metal ions, metal, ceramic, polyester, concrete, polystyrene, BN (boron nitride aka “white graphene”), BNNT (boron nitride nanotubes), nanotubes and nanowires and nanocrystals and nanospheres and nanochains e.g. comprising any one or more of the following elements: C, Si, Se, Cu, S, Co, Zn, Al, Au, Ag, N, B and Cd.

Particularly preferred embodiments of SEs include carbon nanotubes, multi-walled carbon nanotubes, single-walled carbon nanotubes, functionalized carbon nanotubes, carbon nanofibres, carbon nanothreads, fullerenes,
aluminum nitride nanotubes (AlNNTs), boron carbon nanotubes (BCNNT), DNA nanotube, RNA nanotube, protein nanotube, silicon nanotube, titanium oxide nanotubes, tungsten sulfide nanotubes, gallium nitride nanotubes (GaNNTs),
aluminum phosphide nanotube (AlPNT), gallium phosphide nanotube (GaPNT), carbon/diamond nanothread,
copper nanotubes, gold nanotubes, silver nanotube, platinum nanotube, zinc oxide nanotube, zinc ferrite nanotube, aluminium nanotube,
sulphide nanotubes such as WS₂ and MoS₂, selenide nanotubes such as Cadmium Selenide Nanotube CdSe, cobalt Selenide Nanotube, bismuth selenide nanotube, niobium selenide nanotubes, halide nanotubes, such as nickel chloride nanotubes, nanotubes of transition metal oxides such as SiO₂, TiO₂, MoO₃, V₂O₅ and
graphene, functionalized graphene, graphene oxide, graphyne, reduced graphyne, graphane, graphdiyne, graphone, fluorographene, chlorographene

In preferred embodiments, a suitable SE is chosen from the list comprising
Concrete admixtures
Chemical admixtures
Mineral admixtures.
Air entrainers
Water reducers
Set retarders
Set accelerators
Superplasticizers
Corrosion inhibitors
Shrinkage control admixtures
Alkali-silica reactivity inhibitors
Coloring admixtures.
Plasticizers
Water reducers
Superplasticizer
High range water reducers
Organic polymers
Lignin
Naphthalene
Melamine sulfonate superplasticisers
Pozzolans and other cementitious materials
Natural pozzolans (such as the volcanic ash used in Roman concrete)
Fly ash
Silica fume.
Dispersants.
Polycarboxylate ether superplasticizer (PCE)
Polycarboxylate (PC)
Coal
Soot
Carbon black
Anthracite
Lignite
Kevlar
Carbon fiber
Carbon nanofiber
Carbon allotropes
   Activated carbon
      Powdered activated carbon
      Granular activated carbon
      Extruded activated carbon
   Fullerenes
      Buckyball
      Buckypaper
      Buckytube
      Dodecahedrane
      Endohedral fullerenes
      Gedodesic carbon domes
      Prismane
      Carbon nanotube
         Single-wall carbon nanotubes
         Double-wall carbon nanotubes
         Triple-wall carbon nanotube
         Multi-wall carbon nanotubes
         Pristine carbon nanotubes
         Coated carbon nanotubes
         Perfect carbon nanotubes
         Imperfect carbon nanotubes
         Functionalized carbon nanotubes
         Thiol-functionalized
         Hydroxyl-functionalized
         Carboxylic acid-functionalized
         Amine-functionalized
         Carbon nanotubes that contain gadolinium
         Buckypaper
      Fullerite
         Ultrahard fullerite
      Buckminsterfullerene
      Graphene
         Single-layer graphene
         Double-layer graphene
         Triple-layer graphene
         Multi-layer graphene
         Pristine graphene
         Coated graphene
         Perfect graphene
         Imperfect graphene
         Functionalized graphene
         Graphane
         Flourinated graphene
         Graphene oxide
         Reduced graphene oxide
      Buckyball clusters
      Carbon megatubes
      Carbon polymers
      Carbon nano-onions
      Carbon nanobuds
      Fullerene rings
   Glassy carbon
   Diamond
      Hyperdiamonds
      Aggregated diamonds
   Graphite
      Pyrolytic graphite
   Pencil lead
   Lonsdaleite
   Amorphous carbon
   Carbon nanofoam
Metals
   Transition metals, Lanthanides, Actinides, Rare earth elements, Platinum group metals (PGMs), Post-transition metals
   (Al) aluminium
   (Fe) steel and stainless steel
   (Mo) molybdenum
   (Cu) copper
   (Ti) titanium
   (Pt) platinum
   (Au) gold
   (Ni) nickel
   (Pa) palladium
   (Mn) manganese
   (Ta) tantalum
   (Cr) chromium
   (Ag) silver
   (Wo) Tungsten
Metalloids
Alloys
   Stainless steel
   Steel fibers
   Hardened steel
   Brass
   Brass fibers
Amalgams
Intermetallics
Glasses
   Glass fibre
   Glass spheres
Crystal
   Ionic crystals, Covalent crystals, Non-covalent crystals
   Non-covalent crystal
Crystalline materials
   BK7, sapphire, fused silica
Glue
Ceramic
   alumina, zirconia, machinable ceramic, green ceramic, PZT, silicon nitride, tungsten carbide
   alumina (Al2O3)
   silicon nitrides (bulk and thin film)
   silicon carbides
   lithium niobates
   zirconia
   metallised ceramic
Elastomers
Fibres
Composite materials
   Wood
   Cellulose fibers
   lignin
   Bone
   Tooth enamel
   Tooth cementum
   Tooth dentine
Sol-gel
Mineral
Montmorrilonite nanoclays
Cellulose nanowhiskers
Talc
Cellulose nanofibers (e.g. Curran)
Organic-Inorganic
   Organic-Inorganic hybrids
   Polymer hybrids of poly (vinyl alcohol) and silica gel
   Boron nitride nanotube
      Single-wall boron nitride nanotubes
      Double-wall boron nitride nanotubes
      Triple-wall boron nitride nanotube
      Multi-wall boron nitride nanotubes
      Pristine boron nitride nanotubes
      Coated boron nitride nanotubes
      Perfect boron nitride nanotubes
      Imperfect boron nitride nanotubes
      Functionalized boron nitride nanotubes
         Thiol-functionalized boron nitride nanotubes
         Hydroxyl-functionalized boron nitride nanotubes
         Carboxylic acid-functionalized boron nitride nanotubes
         Amine-functionalized boron nitride nanotubes
      Boron nitride nanotubes that contain gadolinium
      Bucky paper
   Boron nitride
      Single-layer boron nitride
      Double-layer boron nitride
      Triple-layer boron nitride
      Multi-layer boron nitride
      Pristine boron nitride
      Coated boron nitride
      Perfect boron nitride
      Imperfect boron nitride
      Functionalized boron nitride
         Flourinated boron nitride
         Boron nitride oxide
         Reduced boron nitride oxide

For any characteristics of an SE mentioned above or below, and in each characteristic's entire range, a further characteristic of importance is the content of elements in the SE. The kinds of elements in an SE will be reflected in the characteristics of the SE, but can in some cases also affect other parts of a CMU. As an example, the elements of SE1 may interfere with the integrity of SE2, or alternatively, if SE2 is made in situ, i.e. after the mixing of SE1 and the precursors from which SE2 will be made, SE1 may interfere with the formation of SE2 and/or its final form, through interaction of its elements with the reactive monomers that react to form SE2.

Identities and number of elements of a structural entity. The structural entity may be composed of only one type of element, two types of elements, three types of elements, four types of elements, or more than four types of elements.

SEs consisting of one element or one type of element. Preferred embodiments of SEs comprising only one element are often ions, and often serve an essential structural role in the CMU. The following ions are particularly preferred structural entities: K+, Cl−, Ca++, Mg++, Gd+++, Cu+, Cu2+, Fe2+, Fe3+, Hg2+, Hg₂2+, Pb2+, Pb4+, Sn2+, Sn4+, Cr2+, Cr3+, Mn2+, Mn3+, Co2+, Co3+. If comprising only one element, the element may be any one of the following: Lithium (Li), Beryllium (Be), Boron (B), Carbon (C), Nitrogen (N), Oxygen (O), Fluorine (F), Sodium (Na), Magnesium (Mg), Aluminium (Al), Silicon (Si), Phosphorus (P), Sulfur (S), Chlorine (CI), Potassium (K), Calcium (Ca), Scandium (Sc), Titanium (Ti), Vanadium (V), Chromium (Cr), Manganese (Mn), Iron (Fe), Cobalt (Co), Nickel (Ni), Copper (Cu), Zinc (Zn), Gallium (Ga), Germanium (Ge), Arsenic (As), Selenium (Se), Bromine (Br), Rubidium (Rb), Strontium (Sr), Yttrium (Y), Zirconium (Zr), Niobium (Nb), Molybdenum (Mo), Technetium (Tc), Ruthenium (Ru), Rhodium (Rh), Palladium (Pd), Silver (Ag), Cadmium (Cd), Indium (In), Tin (Sn), Antimony (Sb), Tellurium (Te), Iodine (I), Caesium (Cs), Barium (Ba), Platinum (Pt), Gold (Au), Mercury (Hg), Thallium (TI), Lead (Pb), Bismuth (Bi).

SEs comprising only one type of element have no polarity, and are therefore attractive in cases where no polarity is desired. This may e.g. be the case where the polymer (e.g. SE1) of a composite has no polarity, and where it therefore may be beneficial to add an additive (SE2) with no polarity as well.

The following structural entities comprising only one element or one type of element, are particularly preferred structural entities:

Comprising carbon atoms only: Buckyball, Buckypaper, Buckytube, Dodecahedrane, Endohedral fullerenes, Gedodesic carbon domes, Prismane, Pristine carbon nanotubes, Coated carbon nanotubes, Perfect carbon nanotubes, Imperfect carbon nanotubes, Fullerite, Ultrahard fullerite, Buckminsterfullerene, Graphene, Single-layer graphene, Double-layer graphene, Triple-layer graphene, Multi-layer graphene, Pristine graphene, Perfect graphene, Imperfect graphene, Buckyball clusters, Carbon megatubes, Carbon polymers, Carbon nano-onions, Carbon nanobuds, Fullerene rings, diamond, fullerenes in general, and specifically Carbon nanotubes, Single-wall carbon nanotubes, Double-wall carbon nanotubes, Triple-wall carbon nanotube, Multi-wall carbon nanotubes including single-walled carbon nanotubes and multiwalled nanotubes, and including Carbon nanotubes with the following chiral vectors (n, m); (0,0); (1,0); (2,0); (3,0); (4,0); (5,0); (6,0); (7,0); (8,0); (9,0); (10,0); (11,0); (12,0); (13,0); (14,0); (15,0); (16,0); (17,0); (18,0); (19,0); (20,0); (0,1); (1,1); (2,1); (3,1); (4,1); (5,1); (6,1); (7,1); (8,1); (9,1); (10,1); (11,1); (12,1); (13,1); (14,1); (15,1); (16,1); (17,1); (18,1); (19,1); (20,1); (0,2); (1,2); (2,2); (3,2); (4,2); (5,2); (6,2); (7,2); (8,2); (9,2); (10,2); (11,2); (12,2); (13,2); (14,2); (15,2); (16,2); (17,2); (18,2); (19,2); (20,2); (0,3); (1,3); (2,3); (3,3); (4,3); (5,3); (6,3); (7,3); (8,3); (9,3); (10,3); (11,3); (12,3); (13,3); (14,3); (15,3); (16,3); (17,3); (18,3); (19,3); (20,3); (0,4); (1,4); (2,4); (3,4); (4,4); (5,4); (6,4); (7,4); (8,4); (9,4); (10,4); (11,4); (12,4); (13,4); (14,4); (15,4); (16,4); (17,4); (18,4); (19,4); (20,4); (0,5); (1,5); (2,5); (3,5); (4,5); (5,5); (6,5); (7,5); (8,5); (9,5); (10,5); (11,5); (12,5); (13,5); (14,5); (15,5); (16,5); (17,5); (18,5); (19,5); (20,5); (0,6); (1,6); (2,6); (3,6); (4,6); (5,6); (6,6); (7,6); (8,6); (9,6); (10,6); (11,6); (12,6); (13,6); (14,6); (15,6); (16,6); (17,6); (18,6); (19,6); (20,6); (0,7); (1,7); (2,7); (3,7); (4,7); (5,7); (6,7); (7,7); (8,7); (9,7); (10,7); (11,7); (12,7); (13,7); (14,7); (15,7); (16,7); (17,7); (18,7); (19,7); (20,7); (0,8); (1,8); (2,8); (3,8); (4,8); (5,8); (6,8); (7,8); (8,8); (9,8); (10,8); (11,8); (12,8); (13,8); (14,8); (15,8); (16,8); (17,8); (18,8); (19,8); (20,8); (0,9); (1,9); (2,9); (3,9); (4,9); (5,9); (6,9); (7,9); (8,9); (9,9); (10,9); (11,9); (12,9); (13,9); (14,9); (15,9); (16,9); (17,9); (18,9); (19,9); (20,9); (0,10); (1,10); (2,10); (3,10); (4,10); (5,10); (6,10); (7,10); (8,10); (9,10); (10,10); (11,10); (12,10); (13,10); (14,10); (15,10); (16,10); (17,10); (18,10); (19,10); (20,10); (0,11); (1,11); (2,11); (3,11); (4,11); (5,11); (6,11); (7,11); (8,11); (9,11); (10,11); (11,11); (12,11); (13,11); (14,11); (15,11); (16,11); (17,11); (18,11); (19,11); (20,11); (0,12); (1,12); (2,12); (3,12); (4,12); (5,12); (6,12); (7,12); (8,12); (9,12); (10,12); (11,12); (12,12); (13,12); (14,12); (15,12); (16,12); (17,12); (18,12); (19,12); (20,12); (0,13); (1,13); (2,13); (3,13); (4,13); (5,13); (6,13); (7,13); (8,13); (9,13); (10,13); (11,13); (12,13); (13,13); (14,13); (15,13); (16,13); (17,13); (18,13); (19,13); (20,13); (0,14); (1,14); (2,14); (3,14); (4,14); (5,14); (6,14); (7,14); (8,14); (9,14); (10,14); (11,14); (12,14); (13,14); (14,14); (15,14); (16,14); (17,14); (18,14); (19,14); (20,14); (0,15); (1,15); (2,15); (3,15); (4,15); (5,15); (6,15); (7,15); (8,15); (9,15); (10,15); (11,15); (12,15); (13,15); (14,15); (15,15); (16,15); (17,15); (18,15); (19,15); (20,15); (0,16); (1,16); (2,16); (3,16); (4,16); (5,16); (6,16); (7,16); (8,16); (9,16); (10,16); (11,16); (12,16); (13,16); (14,16); (15,16); (16,16); (17,16); (18,16); (19,16); (20,16); (0,17); (1,17); (2,17); (3,17); (4,17); (5,17); (6,17); (7,17); (8,17); (9,17); (10,17); (11,17); (12,17); (13,17); (14,17); (15,17); (16,17); (17,17); (18,17); (19,17); (20,17); (0,18); (1,18); (2,18); (3,18); (4,18); (5,18); (6,18); (7,18); (8,18); (9,18); (10,18); (11,18); (12,18); (13,18); (14,18); (15,18); (16,18); (17,18); (18,18); (19,18); (20,18); (0,19); (1,19); (2,19); (3,19); (4,19); (5,19); (6,19); (719); (8,19); (9,19); (10,19); (11,19); (12,19); (13,19); (14,19); (15,19); (16,19); (17,19); (18,19); (19,19); (20,19); (0,20); (1,20); (2,20); (3,20); (4,20); (5,20); (6,20); (7,20); (8,20); (9,20); (10,20); (11,20); (12,20); (13,20); (14,20); (15,20); (16,20); (17,20); (18,20); (19,20); (20,20)

In a preferred embodiment the structural entity is a CNT with the following chiral vectors (n, m):

n is between 0 and 20, such as between 0 and 10, such as between 0 and 5, such as between 0 and 2.

n is between 0 and 20, such as between 10 and 20, such as between 15 and 20, such as between 17 and 20.

p is between 0 and 20, such as between 0 and 10, such as between 0 and 5, such as between 0 and 2.

p is between 0 and 20, such as between 10 and 20, such as between 15 and 20, such as between 17 and 20.

Examples of structural entities consisting of only gold (Au) include gold nanotubes and gold nanowires.

Examples of structural entities consisting of only titanium include titanium rods and titanium plates.

Examples of structural entities consisting of only silver include silver fibres and silver cones.

Examples of structural entities consisting of only zinc include zinc nanotubes and zinc particles.

Examples of structural entities consisting of only copper include copper spheres and copper wires.

SEs consisting of two elements, or two types of elements. Examples of SEs comprising zinc and oxygen, or boron and nitride are ZnO nanorods, ZnO nanowires, ZnO nanotubes, ZnO Nanohelixes/nanosprings, seamless nanorings, nanopropellers, nanowires, such as single-crystal nanowires, ZnO nanobelts, polyhedral cages, single-wall boron nitride nanotubes, double-wall boron nitride nanotubes, triple-wall boron nitride nanotube, multi-wall boron nitride nanotubes, pristine boron nitride nanotubes, coated boron nitride nanotubes, perfect boron nitride nanotubes, imperfect boron nitride nanotubes, bucky paper, single-layer boron nitride, double-layer boron nitride, triple-layer boron nitride, multi-layer boron nitride, pristine boron nitride, coated boron nitride, perfect boron nitride and imperfect boron nitride.

If comprising only two elements, the elements may include any of the following: Hydrogen (H), Lithium (Li), Beryllium (Be), Boron (B), Carbon (C), Nitrogen (N), Oxygen (O), Fluorine (F), Sodium (Na), Magnesium (Mg), Aluminium (Al), Silicon (Si), Phosphorus (P), Sulfur (S), Chlorine (CI), Potassium (K), Calcium (Ca), Scandium (Sc), Titanium (Ti), Vanadium (V), Chromium (Cr), Manganese (Mn), Iron (Fe), Cobalt (Co), Nickel (Ni), Copper (Cu), Zinc (Zn), Gallium (Ga), Germanium (Ge), Arsenic (As), Selenium (Se), Bromine (Br), Rubidium (Rb), Strontium (Sr), Yttrium (Y), Zirconium (Zr), Niobium (Nb), Molybdenum (Mo), Technetium (Tc), Ruthenium (Ru), Rhodium (Rh), Palladium (Pd), Silver (Ag), Cadmium (Cd), Indium (In), Tin (Sn), Antimony (Sb), Tellurium (Te), Iodine (I), Caesium (Cs), Barium (Ba), Platinum (Pt), Gold (Au), Mercury (Hg), Thallium (TI), Lead (Pb), Bismuth (Bi).

Examples of structural entities consisting of only zinc (Zn) and oxygene (O) include ZnO nanotubes.

Examples of structural entities consisting of only carbon (C) and hydrogen (H) include polyethylene, polypropylene, polystyrene, graphane.

Examples of structural entities consisting of only boron (B) and nitrogen (N) include boron nitride and boron nitride nanotubes

Examples of structural entities consisting of two elements include polytetrafluoroethylene (comprising C, F).

Comprising C and O: Graphene oxide

Comprising C and F: Fluorinated graphene

SEs consisting of three elements, or three types of elements. If comprising only three elements, the elements may include any of the following:

Hydrogen (H), Lithium (Li), Beryllium (Be), Boron (B), Carbon (C), Nitrogen (N), Oxygen (O), Fluorine (F), Sodium (Na), Magnesium (Mg), Aluminium (Al), Silicon (Si), Phosphorus (P), Sulfur (S), Chlorine (CI), Potassium (K), Calcium (Ca), Scandium (Sc), Titanium (Ti), Vanadium (V), Chromium (Cr), Manganese (Mn), Iron (Fe), Cobalt (Co), Nickel (Ni), Copper (Cu), Zinc (Zn), Gallium (Ga), Germanium (Ge), Arsenic (As), Selenium (Se), Bromine (Br), Rubidium (Rb), Strontium (Sr), Yttrium (Y), Zirconium (Zr), Niobium (Nb), Molybdenum (Mo), Technetium (Tc), Ruthenium (Ru), Rhodium (Rh), Palladium (Pd), Silver (Ag), Cadmium (Cd), Indium (In), Tin (Sn), Antimony (Sb), Tellurium (Te), Iodine (I), Caesium (Cs), Barium (Ba), Platinum (Pt), Gold (Au), Mercury (Hg), Thallium (TI), Lead (Pb), Bismuth (Bi).

Examples of structural entities consisting of three elements include the following:
Comprising C, H, Cl: polyvinylchloride
Comprising C, H, O: poly(vinylalcohol)
Comprising C, H, N: polyacrylonitrile
Comprising C, H, Si: Poly[(dimethylsilylene)methylene]
Comprising C, H, S: Poly(thiophene)
Comprising C, S, H: thiol-functionalized graphene
Comprising C, O, H: hydroxide-functionalized graphene
Comprising C, S, H: thiol-functionalized carbon nanotubes
Comprising C, O, H: hydroxide-functionalized carbon nanotubes
Comprising B, N, O: boron nitride oxide
Comprising B, N, F: fluorinated boron nitride

SEs consisting of four elements, or four kinds of elements. If comprising only four elements, the elements may include any of the following: Hydrogen (H), Lithium (Li), Beryllium (Be), Boron (B), Carbon (C), Nitrogen (N), Oxygen (O), Fluorine (F), Sodium (Na), Magnesium (Mg), Aluminium (Al), Silicon (Si), Phosphorus (P), Sulfur (S), Chlorine (CI), Potassium (K), Calcium (Ca), Scandium (Sc), Titanium (Ti), Vanadium (V), Chromium (Cr), Manganese (Mn), Iron (Fe), Cobalt (Co), Nickel (Ni), Copper (Cu), Zinc (Zn), Gallium (Ga), Germanium (Ge), Arsenic (As), Selenium (Se), Bromine (Br), Rubidium (Rb), Strontium (Sr), Yttrium (Y), Zirconium (Zr), Niobium (Nb), Molybdenum (Mo), Technetium (Tc), Ruthenium (Ru), Rhodium (Rh), Palladium (Pd), Silver (Ag), Cadmium (Cd), Indium (In), Tin (Sn), Antimony (Sb), Tellurium (Te), Iodine (I), Caesium (Cs), Barium (Ba), Platinum (Pt), Gold (Au), Mercury (Hg), Thallium (TI), Lead (Pb), Bismuth (Bi).

Examples of structural entities consisting of four elements include the following:
Comprising C, H, Cl, O: Poly(vinyl chloroacetate)
Comprising C, H, O, N: Proteins, peptides.

SEs consisting of more than four elements. If comprising more than four elements, the elements may include any of the following kinds: Hydrogen (H), Lithium (Li), Beryllium (Be), Boron (B), Carbon (C), Nitrogen (N), Oxygen (O), Fluorine (F), Sodium (Na), Magnesium (Mg), Aluminium (Al), Silicon (Si), Phosphorus (P), Sulfur (S), Chlorine (CI), Potassium (K), Calcium (Ca), Scandium (Sc), Titanium (Ti), Vanadium (V), Chromium (Cr), Manganese (Mn), Iron (Fe), Cobalt (Co), Nickel (Ni), Copper (Cu), Zinc (Zn), Gallium (Ga), Germanium (Ge), Arsenic (As), Selenium (Se), Bromine (Br), Rubidium (Rb), Strontium (Sr), Yttrium (Y), Zirconium (Zr), Niobium (Nb), Molybdenum (Mo), Technetium (Tc), Ruthenium (Ru), Rhodium (Rh), Palladium (Pd), Silver (Ag), Cadmium (Cd), Indium (In), Tin (Sn), Antimony (Sb), Tellurium (Te), Iodine (I), Caesium (Cs), Barium (Ba), Platinum (Pt), Gold (Au), Mercury (Hg), Thallium (TI), Lead (Pb), Bismuth (Bi).

Examples of structural entities consisting of more than four elements include the following:
Comprising C, H, N, O, P: Nucleic acids

A structural entity may consist of just one atom (in its non-charged form or as an ion, e.g. Gd or Gd+++), or may consist of several atoms, held together in an organized structure.

Comprising zinc only: Zinc nanotubes.

Example SEs. The following is a non-exhaustive list of structural entities: polymer, plastic, metal, additive, filler, inorganic polymer, organic polymer, supramolecular structure, fibers or filaments of human, animal or plant origin, macromolecular structure, polyethylene (PE), polypropylene (PP), polyvinylchloride (PVC), polystyrene (PS), poly(vinylalcohol) (PVAL), polyvinaylacetate (PVAC), poly(4-methyl-1-pentene), poly(1,4-butadiene), polyisoprene, polyacrylonitrile (PAN), polymethylmethacrylate (PMMA), poly(n-alkylmethacrylate), poly(n-alkylacrylate), poly(ethylene terephtalate) (PETP), poly(butylenes terephtalate) (PBTP), polytetrafluoroethylene (PTFE), polyamide 6 (PA 6), polyamide n (PAn), polyamide 6,10 (PA 6,10), polyoxymethylene (POM), polyethyleneoxide (PEO), poly(vinylidene dichloride) (PVDC), poly(vinylidine difluoride) (PVDF), epoxy, boron nitride, boron nitride nanotubes, carbon nanotube, zinc nanotube, graphene, myosin, actin, metal, steel, Kevlar filament, metal-oxide, alloy, silk, cotton, wool, latex, rubber, aluminum, copper, polymers, ceramic, metals, cement, and concrete.

Example SEs also include naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.

Additives. The following is a non-comprehensive list of preferred structural entities, often categorized as the additives of a composite material.

### Group 3: Additives.

Calcium carbonate, silicates, glass fibres, glass bulbs, asbestos, talc, kaolin, mica, barium sulfate, metal oxides and hydroxides, wood fiber, carbon fiber, bamboo fiber, UV absorbers, colourants, plasticisers, aluminum fiber, carbon black, graphite, wood flour and flours or fibers of other natural products, synthetic fibers; nano-materials, very finely dispersed or exfoliated layer structures are particularly useful, as for example montmorillonite, bentonite and the like, as well as natural or synthetic nano-tube fillers like halloysites, zeolites or carbon-based nano-tubes or layer materials of the graphene or boron nitride type.

In a preferred embodiment, the structural entity is a nucleating agent. Nucleating agents minimize the size of the interphase around fillers. By incorporating the nucleating agent into the CMU of the present invention, it is possible to control the crystalizing tendency of the interphase, and in this way improve the quality of a composite material.

Nucleating agents suitable for the present invention includes, but are not limited to: aromatic carboxylic acid salts; sodium benzoate; talc; pigment colorants; phosphate ester salts; calcium carbonate; glass; chalk; clay; kaolin; silicates; pigments; cadmium red; cobalt yellow; chromium oxide; titanium dioxide; magnesium oxide; carbonates; sulfates; carbon black; salts of carboxylic acids; benzophenone; polymers; organic liquids; polyamide-66; molybdenum disulfide; iron sulfide; titanium dioxide; sodium phenylphosphinate; potassium stearate; organic pigments; sodium benzoate; kaolin; triphenodithiazine; pimelic acid with calcium stearate; calcium stearate; pimelic acid; quinacridone permanent red dye; N,N-dicyclohexylnaphthalene-2,6-dicarboxamide; 1,2,3,4-bis-dibenzylidene sorbitol (DBS); 1,2,3,4-bis-(p-methoxybenzylidene sorbitol) (DOS); 1,2,3,4-bis-(3,4-dimethylbenzylidene sorbitol) (MBDS); 1,3:2,4-di(3,4-dimethylbenzylidene) sorbitol (DMDBS); metal salts of substituted aromatic heterocyclic phosphate; sodium 2,2′-methylene-bis-(4,6-di-t-butylphenylene)phosphate (NA-11); salts of 2,2′-methylene-bis-(4,6-di-t-butylphenylene)phosphate; lithium 2,2′-methylene-bis-(4,6-di-t-butylphenylene)phosphate; potassium 2,2′-methylene-bis-(4,6-di-t-butylphenylene)phosphate; linear trans quinacridone (LTQ); γ-modification of LTO; calcium carboxylates, calcium salts of suberic acid (Ca-sub), calcium salts of pimelic acid (Ca-pim); N,N′-dicyclohexyl-2,6-naphtalene dicarboxamide (NJS); bicyclo[2.2.1]heptane dicarboxylate salt (HPN-68); Hyperform HPN-20E; ionomers; metal oxides; metal hybrids; organic compounds; residual catalysts; polymers; fibers; hydroxyl group-containing triglyceride oils; organic acid metal salts.

As can be seen, the structural entities SE1 and SE2 may e.g. both be a polymer, both may be an additive, both may be a filler, or one may be an additive and the other a polymer, or some other structural entity.

SE1 or SE2 may be the most abundant part of a matrix material. For example, in a composite material of PVC and carbon nanotubes, where a linker carrying two MLs or Ligand2s, one of which is attached to a PVC polymer molecule and the other is attached to a carbon nanotube, and where the PVC polymers constitute ˜99% of the composite material and the carbon nanotubes constitute ˜1% of the composite material, the PVC is considered the matrix material of the composite.

SE1 and SE2 may be the same or different. Example pairs of SE1 and SE2 are shown below:

| SE1 | SE2 |
|---|---|
| Carbon nanotube | Epoxy |
| Carbon nanotube | Polyvinyl |
| Carbon nanotube | Polystyrene |
| Graphene | Epoxy |
| Kevlar | Polypropylene |
| Silk | Metal (e.g. iron, zinc, copper) |
| Metal alloy | Collagen |
| Collagen | Carbon nanotube |
| Myosin | Steel |
| Actin | Carbon nanotube |
| Cement (C—S—H) | Nanotube |
| Carbon nanotube | Carbon nanotube |
| Graphene | Graphene |
| Carbon nanotube | Carbon nanotube |
| Polyvinyl | Polyvinyl |
| BN | BNNT |

The abovementioned structural entities (SEs) may be modified. Thus, a structural entity may be modified by the addition of one or more functional groups. Examples of simple functional groups are OH, NH2, CO, COOH, SH. More complex functional groups are biotin, antibody, and metal chelate.

In a preferred embodiment this modification introduces a charged or polar group. The polar or charged group may be advantageous in order to make the SE soluble, or in order to allow strong ionic bond interactions with another SE or with a linker moiety. As an example, CNTs may be modified with charged or polar groups in order to make the CNTs soluble in polar solvents. In another preferred embodiment the modification of the SE introduces a reactive yet non-polar, non-charged group. Such groups may be preferable in cases where for example the polymerization reaction forming a composite material is inhibited by polar or charged groups. An example functionalisation is the introduction of a polyvinyl group on the surface of a CNT. Alternatively, the functionalization may be mediated by the binding of mechanical ligands that either themselves modify the characteristics of the CNT in a desired way, or mechanical ligands that carry functional groups that mediate the desired change in characteristics of the CNT.

### Mechanical Ligand (ML) and Ligand2.

A precursor-ML, ML or Ligand2 suitable for the present invention may have a number of characteristics. One important characteristic is the affinity (or dissociation constant) of the interaction between the SE and either of the precursor-ML, ML, or Ligand2. A high affinity of the precursor-ML for the SE will increase the number of precursor-MLs that are bound at a given time, and therefore may increase the number of precursor-MLs that are turned into a ML. However, if certain binding modes of the precursor-ML are incompatible with the formation of the ML, a lower affinity may be preferred, as a lower affinity is typically associated with faster off-rates and therefore faster kinetics of association/dissociation, which will allow the precursor-ML to be involved in a larger number of binding events, potentially increasing the likelihood of the correct binding mode to take place, and thereby promoting ML formation. Once the ML has been formed, a high affinity may serve to lock the ML at the position where it was formed, which can be advantageous in some cases. In other cases, an even distribution of the MLs on the SE may be promoted by MLs with lower affinity for the SE.

For Ligand2 it may be attractive in some cases that the Ligand2 is tightly associated with the SE, as this may increase eg. the strength of a composite material. If on the other hand flexibility of a composite material is desired, it may be advantageous that the Ligand2 binds the SE with lower affinity, allowing the Ligand2 to dissociate more easily from the SE.

For any characteristics of a precursor-ML, ML or Ligand2 mentioned above, and in each characteristic's entire range, a further characteristic of importance is the molecular weight (MW) of the precursor-ML, ML or Ligand2.

MW of precursor-ML, ML or Ligand2. The molecular weight of the precursor-ML, ML or Ligand2 may be of high economic importance (smaller compounds typically cost less to produce), and also, a smaller molecular weight is often indicative of a smaller surface of interaction with the SE, wherefore typically a higher number of precursor-ML, ML or Ligand2s can bind simultaneously to the SE if their MWs are low. Thus, depending on the context, the MW is preferably less than 100,000,000 Dal, such as less than 10,000,000 Dal, such as less than 5,000,000 Dal, such as less than 2,000,000 Dal, such as less than 1,000,000 Dal, such as less than 500,000 Dal, such as less than 200,000 Dal, such as less than 100,000 Dal, such as less than 40,000 Dal, such as less than 20,000 Dal, such as less than 10,000 Dal, such as less than 7,000 Dal, such as less than 5,000 Dal, such as less than 3,000 Dal, such as less than 2,000 Dal, such as less than 1,700 Dal, such as less than 1,400 Dal, such as less than 1,200 Dal, such as less than 1,000 Dal, such as less than 900 Dal, such as less than 800 Dal, such as less than 700 Dal, such as less than 600 Dal, such as less than 500 Dal, such as less than 400 Dal, such as less than 300 Dal, such as less than 200 Dal, such as less than 100 Dal, such as less than 1 Dal.

However, it is typically easier to prepare a precursor-ML, ML or Ligand2 of high affinity if its molecular weight is higher. Thus, depending on the context, the MW is preferably greater than 1 Dal, such as greater than 100 Dal, such as greater than 200 Dal, such as greater than 300 Dal, such as greater than 400 Dal, such as greater than 500 Dal, such as greater than 600 Dal, such as greater than 700 Dal, such as greater than 800 Dal, such as greater than 900 Dal, such as greater than 1,000 Dal, such as greater than 1,200 Dal, such as greater than 1,400 Dal, such as greater than 1,700 Dal, such as greater than 2,000 Dal, such as greater than 3,000 Dal, such as greater than 5,000 Dal, such as greater than 7,000 Dal, such as greater than 10,000 Dal, such as greater than 20,000 Dal, such as greater than 40,000 Dal, such as greater than 100,000 Dal, such as greater than 200,000 Dal, such as greater than 500,000 Dal, such as greater than 1,000,000 Dal, such as greater than 2,000,000 Dal, such as greater than 5,000,000 Dal, such as greater than 10,000,000 Dal, such as greater than 100,000,000 Dal.

Therefore, depending on the application and context, the molecular weight of a precursor-ML, ML or Ligand2 may preferably be low, medium or high. Preferred embodiments of the present invention therefore include precursor-ML, ML or Ligand2s with molecular weight of 1-100 Dal; 100-200 Dal, 200-300 Dal, 300-400 Dal, 400-500 Dal, 500-600 Dal, 600-700 Dal, 700-800 Dal, 800-900 Dal, 900-1000 Dal, 1,000-1200 Dal, 1,200-1,400 Dal, 1,400-1,700 Dal, 1,700-2,000 Dal, 2,000-3,000 Dal, 3,000-5,000 Dal, 5,000-7,000 Dal, 7,000-10,000 Dal, 10,000-20,000 Dal, 20,000-40,000 Dal, 40,000-100,000 Dal, 100,000-200,000 Dal, 200,000-500,000 Dal, 500,000-1,000,000 Dal, 1,000,000-2,000,000 Dal, 2,000,000-5,000,000 Dal, 5,000,000-10,000,000 Dal, 10,000,000-100,000,000 Dal, or larger than 100,000,000 Dal.

Chemical moieties. The precursor-ML's, ML's or Ligand2's content of chemical moieties is important, either because the chemical moiety is important for the interaction with the SE, or because the chemical moiety is important for reactivity or non-reactivity of the precursor-ML, ML or Ligand2 with e.g. the polymerization reaction. Generally preferred chemical moieties include —NH2, —COOH, —CONH2, —SH, phenyl, benzene, and. The following chemical motifs are preferred chemical motifs comprised within fullerene-binding precursor-MLs, MLs or Ligand2s, and are particularly preferred chemical motifs of CNT- and graphene-binding precursor-MLs, MLs, or Ligand2s, suitable for use in the present invention:
Aromatic systems, including benzene, nitrobenzene, toluene, 1,2,3-trichlorbenzene, 1,2,4-trichlorobenzene, m-dinitrobenzene, p-nitrobenzene, naphthalene, anthracene, fluoranthene, phenanthrene, pyrene, pyrene-diamine, pyrene-phenyl ester, dipyrene (phenyl ester), tetracycline, as well as their substituted variants;
Halogens, nitro group, amine, thiol, alcohol, ester, amide, carboxylic acid, phenol, indole, imidazole, sulfonate and phophate;
Alkane, including hexane and heptane;
Soap-type molecules, including chemical motifs comprising a long alkane (including C4, C5, C6, C7, C8, C9, C10, C11, C12, C13, C14, C15, C16, C17, C18, C19, C20, C21, C22, C23, C24, C25) and a polar end group such as sulfonate, for example SDBS, Sodium dodecylbenzenesulfonate;
Lactames, such as N-methyl-pyrrolidone and lactones;
Peptides, in particular peptides with hydrophilic amino acids at the ends of the peptide and hydrophobic amino acids in the middle.
Peptides such as QLMHDYR, CPTSTGQAC, CTLHVSSYC, RLNPPSQMDPPF, QTWPPPLWFSTS, HTDWRLGTWHHS, ELWSIDTSAHRK, IFRLSWGTYFS, HWKHPWGAWDTL, ELWR, ELWRPTR, KPRSVSG-dansyl, TGTG-F-GTCT, TGTG-V-GTCT, TGTG-W-GTCT, TGTG-T-GTCT, TGTG-G-GTCT, TGTG-N-GTCT, TGTG-K-GTCT, TGTG-D-GTCT, MHGKTQATSGTIQS, DAEFRHDSGYEVHHQKLVFFAEDVGSNKGAIIGLMVGGVVIA, DAEFRHDSGYEVHHQKLVFFAEDVGSNKGAIIGLMVGGVV, CHKKPSKSC, RKLPDAPGMHTW, SCSDCLKSVDFIPSSLASS, YLTMPTP, FSWEAFA, HLESTPG, GETRAPL, RHEPPLA, GETQCAA, FPGRPSP, HTAQSTA, HKPDANR, FPGHSGP, THLPWQT, GETQCAA, FPGRPSP, HTAQSTA, VKTQATSREEPPRLPSKHRPG
Amino acids such as phenylalanine, tyrosine, tryptophan, histidine;
Heteroaromatic systems, including pyrole, thiophene, furane, pyrazole, imidazole, isoxazole, oxazole, isothiazole, thiazole, pyridine and perylene bisimides
Fused ring systems, composed of either aromatic, non-aromatic or anti-aromatic rings or combinations thereof.

Affinity of non-covalent Ligand2. For non-covalent interactions, a low affinity (i.e. a high dissociation constant) may sometimes be preferred. For example, if flexibility of a composite material is desired, it may be preferred that the Ligand2-SE interaction is weak, allowing easy dissociation. Thus, depending on the context, the dissociation constant is preferably greater than 10⁻³⁰ M, such as greater than 10⁻²⁵ M, such as greater than 10⁻²⁰ M, such as greater than 10⁻¹⁸ M, such as greater than 10⁻¹⁶ M, such as greater than 10⁻¹⁵ M, such as greater than 10⁻¹⁴ M, such as greater than 10⁻¹³ M, such as greater than 10⁻¹² M, such as greater than 10⁻¹¹ M, such as greater than 10⁻¹⁰ M, such as greater than 10⁻⁹ M, such as greater than 10⁻⁸ M, such as greater than 10⁻⁷ M, such as greater than 10⁻⁶ M, such as greater than 10⁻⁵ M, such as greater than 10⁻⁴ M, such as greater than 10⁻³ M, such as greater than 10⁻² M, such as greater than 10⁻¹ M.

Alternatively, if high strength and low flexibility of a composite material is required, it may be desired to have a very tight binding of a non-covalent Ligand2 to the SE. Thus, depending on the context, the dissociation constant is preferably less than 10⁻¹ M, such as less than 10⁻² M, such as less than 10⁻³ M, such as less than 10⁻⁴ M, such as less than 10⁻⁵ M, such as less than 10⁻⁶ M, such as less than 10⁻⁷ M, such as less than 10⁻⁸ M, such as less than 10⁻⁹ M, such as less than 10⁻¹⁰ M, such as less than 10⁻¹¹ M, such as less than 10⁻¹² M, such as less than 10⁻¹³ M, such as less than 10⁻¹⁴ M, such as less than 10⁻¹⁵ M, such as less than 10⁻¹⁶ M, such as less than 10⁻¹⁸ M, such as less than 10⁻²⁰ M, such as less than 10⁻²⁵ M, such as less than 10⁻³⁰ M.

Also, if a Ligand2's binding strength is strongly dependent on temperature, systems can be designed that are flexible at high temperatures and rigid at lower temperatures, effectuated by the Ligand2's affinity for the SE. Thus, preferred embodiments of non-covalently interacting Ligand2s of the present invention include Ligand2s whose dissociation constant for the interaction with SE is smaller than 10⁻³⁰ M, and include Ligand2s whose dissociation constant is in one of the following ranges: 10⁻³⁰-10⁻²⁵ M, 10⁻²⁵-10⁻²⁰ M, 10⁻²⁰-10⁻¹⁸ M, 10⁻¹⁸-10⁻¹⁶ M, 10⁻¹⁶-10⁻¹⁵ M, 10⁻¹⁵-10⁻¹⁴ M, 10⁻¹⁴-10⁻¹³ M, 10⁻¹³-10⁻¹² M, 10⁻¹²-10⁻¹¹ M, 10⁻¹¹-10⁻¹⁰ M, 10⁻¹⁰-10⁻⁹ M, 10⁻⁹-10⁻⁸ M, 10⁻⁸-10⁻⁷ M, 10⁻⁷-10⁻⁶ M, 10⁻⁶-10⁻⁵ M, 10⁻⁵-10⁻⁴ M, 10⁻⁴-10⁻³ M, 10⁻³-10⁻² M, 10⁻²-10⁻¹ M, or larger than 10⁻¹ M.

As described above and below, the precursor-ML, ML and/or Ligand2 will often contain chemical motifs that interact with the SE. Below is a list of such preferred chemical motifs, appropriate for making CMUs by combination with the indicated SEs, and their binding strength for different SEs (e.g. in the form of a dissociation constant).

Group 4: Chemical Motifs and the Structural Entities with which they React.

| | | | | | Affinity | | |
|---|---|---|---|---|---|---|---|
| | MW | K_{d}^{b} | K_{d}/MW | | parameter | | |
| Chemical Motif^{a} | [g/mol] | [M] | [M/Dal] | SE^{c} | value^{d} | | Ref.^{e} |
| Nitrobenzene | 123.1 | | | MWNT | 1,380 | L/kg | Kragulj et |
| | | | | | | | al. 2013 |
| Hexane | 86.2 | | | MWNT | 2,291 | L/kg | Kragulj et |
| | | | | | | | al. 2013 |
| Benzene | 78.1 | | | MWNT | 126 | L/kg | Kragulj et |
| | | | | | | | al. 2013 |
| Toluene | 92.1 | | | MWNT | 331 | L/kg | Kragulj et |
| | | | | | | | al. 2013 |
| 1,2,3-Trichloro- | 181.5 | | | MWNT | 12,882 | L/kg | Kragulj et |
| benzene | | | | | | | al. 2013 |
| 1,2,4-Trichloro- | 181.5 | | | MWNT | 5,370 | L/kg | Kragulj et |
| benzene | | | | | | | al. 2013 |
| Naphtalene | 128.2 | | | MWNT | 2,951 | L/kg | Kragulj et |
| | | | | | | | al. 2013 |
| Phenanthrene | 178.2 | | | MWNT | 87,096 | L/kg | Kragulj et |
| | | | | | | | al. 2013 |
| Pyrene | 202.3 | | | MWNT | 229,087 | L/kg | Kragulj et |
| | | | | | | | al. 2013 |
| Fluoranthene | 202.3 | | | MWNT | 204,174 | L/kg | Kragulj et |
| | | | | | | | al. 2013 |
| Nitrobenzene | 123.1 | | | MWNT | 575 | L/kg | Kragulj et |
| | | | | (acid treated, | | | al. 2013 |
| | | | | 3 hours) | | | |
| Hexane | 86.2 | | | MWNT | 813 | L/kg | Kragulj et |
| | | | | (acid treated, | | | al. 2013 |
| | | | | 3 hours) | | | |
| Benzene | 78.1 | | | MWNT | 302 | L/kg | Kraguljet |
| | | | | (acid treated, | | | al. 2013 |
| | | | | 3 hours) | | | |
| Toluene | 92.1 | | | MWNT | 269 | L/kg | Kragulj et |
| | | | | (acid treated, | | | al. 2013 |
| | | | | 3 hours) | | | |
| 1,2,3-Trichloro- | 181.5 | | | MWNT | 7,586 | L/kg | Kragulj et |
| benzene | | | | (acid treated, | | | al. 2013 |
| | | | | 3 hours) | | | |
| 1,2,4-Trichloro- | 181.5 | | | MWNT | 2,754 | L/kg | Kragulj et |
| benzene | | | | (acid treated, | | | al. 2013 |
| | | | | 3 hours) | | | |
| Naphtalene | 128.2 | | | MWNT | 4,786 | L/kg | Kragulj et |
| | | | | (acid treated, | | | al. 2013 |
| | | | | 3 hours) | | | |
| Phenanthrene | 178.2 | | | MWNT | 199,526 | L/kg | Kragulj et |
| | | | | (acid treated, | | | al. 2013 |
| | | | | 3 hours) | | | |
| Pyrene | 202.3 | | | MWNT | 457,088 | L/kg | Kragulj et |
| | | | | (acid treated, | | | al. 2013 |
| | | | | 3 hours) | | | |
| Fluoranthene | 202.3 | | | MWNT | 371,535 | L/kg | Kragulj et |
| | | | | (acid treated, | | | al. 2013 |
| | | | | 3 hours) | | | |
| Nitrobenzene | 123.1 | | | MWNT | 182 | L/kg | Kragulj et |
| | | | | (acid treated, | | | al. 2013 |
| | | | | 6 hours) | | | |
| Hexane | 86.2 | | | MWNT | 562 | L/kg | Kragulj et |
| | | | | (acid treated, | | | al. 2013 |
| | | | | 6 hours) | | | |
| Benzene | 78.1 | | | MWNT | 20 | L/kg | Kragulj et |
| | | | | (acid treated, | | | al. 2013 |
| | | | | 6 hours) | | | |
| Toluene | 92.1 | | | MWNT | 32 | L/kg | Kraguljet |
| | | | | (acid treated, | | | al. 2013 |
| | | | | 6 hours) | | | |
| 1,2,3-Trichloro- | 181.5 | | | MWNT | 8,511 | L/kg | Kraguljet |
| benzene | | | | (acid treated, | | | al. 2013 |
| | | | | 6 hours) | | | |
| 1,2,4-Trichloro- | 181.5 | | | MWNT | 9,772 | L/kg | Kragulj et |
| benzene | | | | (acid treated, | | | al. 2013 |
| | | | | 6 hours) | | | |
| Naphtalene | 128.2 | | | MWNT | 6,918 | L/kg | Kragulj et |
| | | | | (acid treated, | | | al. 2013 |
| | | | | 6 hours) | | | |
| Phenanthrene | 178.2 | | | MWNT | 301,995 | L/kg | Kragulj et |
| | | | | (acid treated, | | | al. 2013 |
| | | | | 6 hours) | | | |
| Pyrene | 202.3 | | | MWNT | 3,548,134 | L/kg | Kragulj et |
| | | | | (acid treated, | | | al. 2013 |
| | | | | 6 hours) | | | |
| Fluoranthene | 202.3 | | | MWNT | 3,715,352 | L/kg | Kragulj et |
| | | | | (acid treated, | | | al. 2013 |
| | | | | 6 hours) | | | |
| Naphtalene | 128.2 | | | SWNT | 10,000 | L/kg | Ji et al. |
| | | | | | | | 2008 |
| Naphtalene | 128.2 | | | MWNT | 1,000 | L/kg | Ji et al. |
| | | | | | | | 2008 |
| Naphtalene | 128.2 | | | Activated | 1,000,000 | L/kg | Ji et al. |
| | | | | carbon | | | 2008 |
| Naphtalene | 128.2 | | | Graphite | 1,000 | L/kg | Ji et al. |
| | | | | | | | 2008 |
| Tetracycline | 444.4 | | | SWNT | 100,000 | L/kg | Ji et al. |
| | | | | | | | 2008 |
| Tetracycline | 444.4 | | | MWNT | 10,000 | L/kg | Ji et al. |
| | | | | | | | 2008 |
| Tetracycline | 444.4 | | | Activated | 10,000 | L/kg | Ji et al. |
| | | | | carbon | | | 2008 |
| Tetracycline | 444.4 | | | Graphite | 10,000 | L/kg | Ji et al. |
| | | | | | | | 2008 |
| QLMHDYR | 962.1 | 1.6E−05 | 1.7E−08 | PLLA | 6.1E+04 | M⁻¹ | Matsuno |
| | | | | (melt | | | et al. 2008 |
| | | | | crystallization) | | | |
| QLMHDYR | 962.1 | 1.8E−04 | 1.8E−07 | PMMA | 5.7E+03 | M⁻¹ | Matsuno |
| | | | | (atactic) | | | et al. 2008 |
| QLMHDYR | 962.1 | 1.5E−04 | 1.5E−07 | PLLA | 6.8E+03 | M⁻¹ | Matsuno |
| | | | | (amorphous) | | | et al. 2008 |
| QLMHDYR | 962.1 | 6.7E−05 | 6.9E−08 | PLLA | 1.5E+04 | M⁻¹ | Matsuno |
| | | | | (layer by | | | et al. 2008 |
| | | | | layer) | | | |
| QLMHDYR | 962.1 | 2.1E−05 | 2.2E−08 | PDLA | 4.8E+04 | M⁻¹ | Matsuno |
| | | | | | | | et al. 2008 |
| CPTSTGQAC | 867 | 2.8E−07 | 3.2E−10 | Platinum | 3.6E+06 | M⁻¹ | Seker et |
| | | | | | | | al. 2011 |
| CTLHVSSYC | 1,012 | 1.1E−06 | 1.1E−09 | Platinum | 9.0E+05 | M⁻¹ | Seker et |
| | | | | | | | al. 2011 |
| RLNPPSQMD- | 1,399 | 8.3E−06 | 6.0E−09 | Silica | 1.2E+05 | M⁻¹ | Seker et |
| PPF | | | | | | | al. 2011 |
| QTWPPPLWF- | 1,447 | 8.1E−07 | 5.6E−10 | Silica | 1.2E+06 | M⁻¹ | Seker et |
| STS | | | | | | | al. 2011 |
| HTDWRLGT- | 1,533 | 1.3E−06 | 8.5E−10 | PPV | 7.7E+05 | M⁻¹ | Eijima et |
| WHHS | | | | (hyper- | | | al. 2010 |
| | | | | branched) | | | |
| HTDWRLGT- | 1,533 | 1.9E−05 | 1.3E−08 | PPV | 5.2E+04 | M⁻¹ | Eijima et |
| WHHS | | | | (linear) | | | al. 2010 |
| ELWSIDTSA- | 1,443 | 2.7E−05 | 1.9E−08 | PPV | 3.7E+04 | M⁻¹ | Eijima et |
| HRK | | | | (hyper- | | | al. 2010 |
| | | | | branched) | | | |
| ELWSIDTSA- | 1,443 | 1.3E−05 | 9.0E−09 | PPV | 7.7E+04 | M⁻¹ | Eijima et |
| HRK | | | | (linear) | | | al. 2010 |
| Sodium dodecyl- | 288.4 | 8.9E−04 | 3.1E−06 | SWNT | 1.1E+03 | M⁻¹ | Sim et al. |
| benzenesulfonate | | | | (8,6) | | | 2013 |
| Sodium dodecyl- | 288.4 | 7.1E−04 | 2.5E−06 | SWNT | 1.4E+03 | M⁻¹ | Sim et al. |
| benzenesulfonate | | | | (6,5) | | | 2013 |
| Sodium dodecyl- | 288.4 | 6.4E−04 | 2.2E−06 | SWNT | 1.6E+03 | M⁻¹ | Sim et al. |
| benzenesulfonate | | | | (10,2) | | | 2013 |
| IFRLSWGTYFS | 1,377 | 2.0E−05 | 1.5E−08 | SWNT | 5.0E+04 | M⁻¹ | Li et al. |
| | | | | (HiPco, raw) | | | 2013 |
| HWKHPWGA- | 1,534 | 5.0E−05 | 3.3E−08 | MWNT | 2.0E+04 | M⁻¹ | Wang et |
| WDTL | | | | (array) | | | al. 2003 |
| ELWR | 602.7 | 6.3E−04 | 1.0E−06 | PMMA | 1.6E+03 | M⁻¹ | Serizawa |
| | | | | (isotactic) | | | et al. 2007 |
| ELWRPTR | 957.1 | 3.6E−06 | 3.7E−09 | PMMA | 2.8E+05 | M⁻¹ | Serizawa |
| | | | | (isotactic) | | | et al. 2007 |
| ELWRPTR | 957.1 | 1.5E−04 | 1.5E−07 | PMMA | 6.8E+03 | M⁻¹ | Serizawa |
| | | | | (syndio- | | | et al. 2007 |
| | | | | tactic) | | | |
| KPRSVSG | 965 | 5.4E−06 | 5.6E−09 | Ceramic | 1.9E+05 | M⁻¹ | Islam et |
| | | | | fluorapatite | | | al. 2012 |
| KPRSVSG | 965 | 7.2E−06 | 7.5E−09 | hydroxyl- | 1.4E+05 | M⁻¹ | Islam et |
| | | | | Ceramic | | | al. 2012 |
| | | | | apatite | | | |
| Pyrene | 202.3 | 6.1E−02 | 3.0E−04 | SWNT | 1.6E+01 | M⁻¹ | Juan et al. |
| | | | | (plasma | | | 2015 |
| | | | | purified) | | | |
| Pyrene | 202.3 | 4.2E−02 | 2.1E−04 | SWNT | 2.4E+01 | M⁻¹ | Juan et al. |
| | | | | (plasma | | | 2015 |
| | | | | purified) | | | |
| Pyrene | 202.3 | 4.8E−02 | 2.4E−04 | SWNT | 2.1E+01 | M⁻¹ | Juan et al. |
| | | | | (plasma | | | 2015 |
| | | | | purified) | | | |
| Pyrene | 202.3 | 1.1E−01 | 5.5E−04 | SWNT | 9.0E+00 | M⁻¹ | Juan et al. |
| | | | | (plasma | | | 2015 |
| | | | | purified) | | | |
| Pyrene | 202.3 | 2.2E−01 | 1.1E−03 | SWNT | 4.5E+00 | M⁻¹ | Juan et al. |
| | | | | (plasma | | | 2015 |
| | | | | purified) | | | |
| Pyrene | 202.3 | 3.8E−04 | 1.9E−06 | SWNT | 2.6E+03 | M⁻¹ | Juan et al. |
| | | | | (plasma | | | 2015 |
| | | | | purified) | | | |
| Pyrene | 202.3 | 2.4E−02 | 1.2E−04 | SWNT | 4.1E+01 | M⁻¹ | Juan et al. |
| | | | | (6,5) | | | 2015 |
| Pyrene | 202.3 | 6.3E−01 | 3.1E−03 | SWNT | 1.6E+00 | M⁻¹ | Juan et al. |
| | | | | (6,5) | | | 2015 |
| Pyrene | 202.3 | 6.3E−01 | 3.1E−03 | SWNT | 1.6E+00 | M⁻¹ | Juan et al. |
| | | | | (6,5) | | | 2015 |
| Pyrene | 202.3 | 1.0E−03 | 4.9E−06 | SWNT | 1.0E+03 | M⁻¹ | Juan et al. |
| | | | | (6,5) | | | 2015 |
| Pyrene diamine | 230 | 4.5E−03 | 2.0E−05 | SWNT | 2.2E+02 | M⁻¹ | Juan et al. |
| | | | | (plasma | | | 2015 |
| | | | | purified) | | | |
| Pyrene diamine | 230 | 3.4E−02 | 1.5E−04 | SWNT | 2.9E+01 | M⁻¹ | Juan et al. |
| | | | | (6,5) | | | 2015 |
| Pyrene phenyl | 240 | 1.1E−02 | 4.6E−05 | SWNT | 9.0E+01 | M⁻¹ | Juan et al. |
| ester | | | | (plasma | | | 2015 |
| | | | | purified) | | | |
| Pyrene phenyl | 240 | 5.0E−02 | 2.1E−04 | SWNT | 2.0E+01 | M⁻¹ | Juan et al. |
| ester | | | | (plasma | | | 2015 |
| | | | | purified) | | | |
| Dipyrene phenyl | 440 | 1.5E−04 | 3.5E−07 | SWNT | 6.5E+03 | M⁻¹ | Juan et al. |
| ester | | | | (plasma | | | 2015 |
| | | | | purified) | | | |
| Dipyrene phenyl | 440 | 2.5E−04 | 5.7E−07 | SWNT | 4.0E+03 | M⁻¹ | Juan et al. |
| ester | | | | (plasma | | | 2015 |
| | | | | purified) | | | |
| Bis-pyrene | 640 | 1.4E−04 | 2.2E−07 | SWNT | 7.0E+03 | M⁻¹ | Juan et al. |
| U-shape | | | | (plasma | | | 2015 |
| molecule | | | | purified) | | | |
| TGTGFGTCT | 844 | | | Quartz | −0.8 | kcal/mol | Aby et al. |
| | | | | | | | 2012 |
| TGTGVGTCT | 796 | | | Quartz | 0.0 | kcal/mol | Aby et al. |
| | | | | | | | 2012 |
| TGTGWGTCT | 883 | | | Quartz | 0.0 | kcal/mol | Aby et al. |
| | | | | | | | 2012 |
| TGTGTGTCT | 798 | | | Quartz | 0.0 | kcal/mol | Aby et al. |
| | | | | | | | 2012 |
| TGTGGGTCT | 754 | | | Quartz | −0.9 | kcal/mol | Aby et al. |
| | | | | | | | 2012 |
| TGTGNGTCT | 811 | | | Quartz | −1.2 | kcal/mol | Aby et al. |
| | | | | | | | 2012 |
| TGTGKGTCT | 825 | | | Quartz | −0.2 | kcal/mol | Aby et al. |
| | | | | | | | 2012 |
| TGTGDGTCT | 812 | | | Quartz | −0.1 | kcal/mol | Aby et al. |
| | | | | | | | 2012 |
| TGTGFGTCT | 844 | | | Glass | −2.2 | kcal/mol | Aby et al. |
| | | | | | | | 2012 |
| TGTGVGTCT | 796 | | | Glass | −0.9 | kcal/mol | Aby et al. |
| | | | | | | | 2012 |
| TGTGWGTCT | 883 | | | Glass | −0.3 | kcal/mol | Aby et al. |
| | | | | | | | 2012 |
| TGTGTGTCT | 798 | | | Glass | −1.0 | kcal/mol | Aby et al. |
| | | | | | | | 2012 |
| TGTGGGTCT | 754 | | | Glass | −1.9 | kcal/mol | Aby et al. |
| | | | | | | | 2012 |
| TGTGNGTCT | 811 | | | Glass | −2.2 | kcal/mol | Aby et al. |
| | | | | | | | 2012 |
| TGTGKGTCT | 825 | | | Glass | −0.9 | kcal/mol | Aby et al. |
| | | | | | | | 2012 |
| TGTGDGTCT | 812 | | | Glass | −0.2 | kcal/mol | Aby et al. |
| | | | | | | | 2012 |
| TGTGFGTCT | 844 | | | PMMA | −2.2 | kcal/mol | Aby et al. |
| | | | | | | | 2012 |
| TGTGVGTCT | 796 | | | PMMA | −2.0 | kcal/mol | Aby et al. |
| | | | | | | | 2012 |
| TGTGWGTCT | 883 | | | PMMA | −0.9 | kcal/mol | Aby et al. |
| | | | | | | | 2012 |
| TGTGTGTCT | 798 | | | PMMA | −0.3 | kcal/mol | Aby et al. |
| | | | | | | | 2012 |
| TGTGGGTCT | 754 | | | PMMA | −2.1 | kcal/mol | Aby et al. |
| | | | | | | | 2012 |
| TGTGNGTCT | 811 | | | PMMA | −2.8 | kcal/mol | Aby et al. |
| | | | | | | | 2012 |
| TGTGKGTCT | 825 | | | PMMA | −1.2 | kcal/mol | Aby et al. |
| | | | | | | | 2012 |
| TGTGDGTCT | 812 | | | PMMA | −2.5 | kcal/mol | Aby et al. |
| | | | | | | | 2012 |
| TGTGFGTCT | 844 | | | HDPE | −3.9 | kcal/mol | Aby et al. |
| | | | | | | | 2012 |
| TGTGVGTCT | 796 | | | HDPE | −4.0 | kcal/mol | Aby et al. |
| | | | | | | | 2012 |
| TGTGWGTCT | 883 | | | HDPE | −2.1 | kcal/mol | Aby et al. |
| | | | | | | | 2012 |
| TGTGTGTCT | 798 | | | HDPE | −1.8 | kcal/mol | Aby et al. |
| | | | | | | | 2012 |
| TGTGGGTCT | 754 | | | HDPE | −3.6 | kcal/mol | Aby et al. |
| | | | | | | | 2012 |
| TGTGNGTCT | 811 | | | HDPE | −3.5 | kcal/mol | Aby et al. |
| | | | | | | | 2012 |
| TGTGKGTCT | 825 | | | HDPE | −3.9 | kcal/mol | Aby et al. |
| | | | | | | | 2012 |
| TGTGDGTCT | 812 | | | HDPE | −2.8 | kcal/mol | Aby et al. |
| | | | | | | | 2012 |
| m-Dinitrobenzene | 168.11 | | | Graphene | 0.0569 | L/mg | Chen et |
| | | | | | | | al. 2015 |
| m-Dinitrobenzene | 168.11 | | | Graphene | 0.00299 | L/mg | Chen et |
| | | | | oxide | | | al. 2015 |
| m-Dinitrobenzene | 168.11 | | | Graphene | 0.162 | L/mg | Chen et |
| | | | | oxide | | | al. 2015 |
| | | | | (reduced) | | | |
| Nitrobenzene | 123.06 | | | Graphene | 0.0118 | L/mg | Chen et |
| | | | | | | | al. 2015 |
| Nitrobenzene | 123.06 | | | Graphene | 0.00105 | L/mg | Chen et |
| | | | | oxide | | | al. 2015 |
| Nitrobenzene | 123.06 | | | Graphene | 0.0330 | L/mg | Chen et |
| | | | | oxide | | | al. 2015 |
| | | | | (reduced) | | | |
| p-Nitrotoluene | 137.14 | | | Graphene | 0.0939 | L/mg | Chen et |
| | | | | | | | al. 2015 |
| p-Nitrotoluene | 137.14 | | | Graphene | 0.00395 | L/mg | Chen et |
| | | | | oxide | | | al. 2015 |
| p-Nitrotoluene | 137.14 | | | Graphene | 0.121 | L/mg | Chen et |
| | | | | oxide | | | al. 2015 |
| | | | | (reduced) | | | |
| MHGKTQATS- | 10,018 | 1.5E−10 | 1.5E−14 | Gold | 6.7E+09 | M⁻¹ | Brown |
| GTIQS7 | | | | | | | 1997 |
| DAEFRHDSGY- | 4,514 | 6.3E−18 | 1.4E−21 | Copper | 1.6E+17 | M⁻¹ | Atwood et |
| EVHHQKLVFF- | | | | | | | al. 2000 |
| AEDVGSNKGA- | | | | | | | |
| IIGLMVGGVVIA | | | | | | | |
| DAEFRHDSGY- | 4,330 | 5.0E−11 | 1.2E−14 | Copper | 2.0E+10 | M⁻¹ | Atwood et |
| EVHHQKLVFF- | | | | | | | al. 2000 |
| AEDVGSNKGA- | | | | | | | |
| IIGLMVGGVV | | | | | | | |
| CHKKPSKSC | 1,015 | 4.1E−09 | 4.0E−12 | Silica | 2.5E+08 | M⁻¹ | Chen et |
| | | | | | | | al. 2006 |
| RKLPDAPGM- | 1,408 | 1.3E−05 | 9.4E−09 | Titanium | 7.6E+04 | M⁻¹ | Sano et al. |
| HTW | | | | | | | 2005 |
| SCSDCLKSVD- | 1,946 | 2.5E−07 | 1.3E−10 | Titanium | 4.0E+06 | M⁻¹ | Meyers et |
| FIPSSLASS | | | | | | | al. 2007 |
| YLTMPTP | 822 | 5.0E−12 | 6.1E−15 | Polystyrene | 2.0E+11 | M⁻¹ | Serizawa |
| | | | | (syndiotactic) | | | et al. 2007 |
| FSWEAFA | 857 | 8.5E−11 | 9.9E−14 | Polystyrene | 1.2E+10 | M⁻¹ | Serizawa |
| | | | | (atactic) | | | et al. 2007 |
| FSWEAFA | 857 | 3.4E−11 | 4.0E−14 | Polystyrene | 2.9E+10 | M⁻¹ | Serizawa |
| | | | | (isotactic) | | | et al. 2007 |
| FSWEAFA | 857 | 6.1E−12 | 7.1E−15 | Polystyrene | 1.6E+11 | M⁻¹ | Serizawa |
| | | | | (syndiotactic) | | | et al. 2007 |
| HLESTPG | 740 | 1.0E−10 | 1.4E−13 | Polystyrene | 9.8E+09 | M⁻¹ | Serizawa |
| | | | | (atactic) | | | et al. 2007 |
| HLESTPG | 740 | 6.5E−11 | 8.8E−14 | Polystyrene | 1.5E+10 | M⁻¹ | Serizawa |
| | | | | (isotactic) | | | et al. 2007 |
| HLESTPG | 740 | 7.9E−12 | 1.1E−14 | Polystyrene | 1.3E+11 | M⁻¹ | Serizawa |
| | | | | (syndiotactic) | | | et al. 2007 |
| GETRAPL | 743 | 6.7E−11 | 9.0E−14 | Polystyrene | 1.5E+10 | M⁻¹ | Serizawa |
| | | | | (atactic) | | | et al. 2007 |
| GETRAPL | 743 | 3.6E−11 | 4.9E−14 | Polystyrene | 2.8E+10 | M⁻¹ | Serizawa |
| | | | | (isotactic) | | | et al. 2007 |
| GETRAPL | 743 | 6.7E−12 | 9.0E−15 | Polystyrene | 1.5E+11 | M⁻¹ | Serizawa |
| | | | | (syndiotactic) | | | et al. 2007 |
| RHEPPLA | 819 | 5.6E−11 | 6.8E−14 | Polystyrene | 1.8E+10 | M⁻¹ | Serizawa |
| | | | | (atactic) | | | et al. 2007 |
| RHEPPLA | 819 | 2.1E−11 | 2.6E−14 | Polystyrene | 4.7E+10 | M⁻¹ | Serizawa |
| | | | | (isotactic) | | | et al. 2007 |
| RHEPPLA | 819 | 1.1E−11 | 1.3E−14 | Polystyrene | 9.4E+10 | M⁻¹ | Serizawa |
| | | | | (syndiotactic) | | | et al. 2007 |
| GETQCAA | 679 | 3.4E−11 | 5.0E−14 | Polystyrene | 3.0E+10 | M⁻¹ | Serizawa |
| | | | | (atactic) | | | et al. 2007 |
| YLTMPTP | 822 | 2.2E−11 | 2.6E−14 | Polystyrene | 4.6E+10 | M⁻¹ | Serizawa |
| | | | | (atactic) | | | et al. 2007 |
| FPGRPSP | 757 | 3.1E−11 | 4.1E−14 | Polystyrene | 3.2E+10 | M⁻¹ | Serizawa |
| | | | | (atactic) | | | et al. 2007 |
| HTAQSTA | 715 | 1.4E−11 | 2.0E−14 | Polystyrene | 7.0E+10 | M⁻¹ | Serizawa |
| | | | | (atactic) | | | et al. 2007 |
| HKPDANR | 837 | 2.5E−11 | 3.0E−14 | PMMA | 4.0E+10 | M⁻¹ | Serizawa |
| | | | | (conditioned | | | et al. 2007 |
| | | | | syndiotactic | | | |
| | | | | film) | | | |
| FPGHSGP | 698 | 1.0E−10 | 1.4E−13 | PMMA | 1.0E+10 | M⁻¹ | Serizawa |
| | | | | (non- | | | et al. 2007 |
| | | | | conditioned | | | |
| | | | | syndiotactic | | | |
| | | | | film) | | | |
| THLPWQT | 882 | 6.7E−11 | 7.6E−14 | PMMA | 1.5E+10 | M⁻¹ | Serizawa |
| | | | | (non- | | | et al. 2007 |
| | | | | conditioned | | | |
| | | | | syndiotactic | | | |
| | | | | film) | | | |
| GETQCAA | 679 | 7.4E−12 | 1.1E−14 | Polystyrene | 1.4E+11 | M⁻¹ | Serizawa |
| | | | | (syndiotactic) | | | et al. 2007 |
| FPGRPSP | 757 | 8.5E−12 | 1.1E−14 | Polystyrene | 1.2E+11 | M⁻¹ | Serizawa |
| | | | | (syndiotactic) | | | et al. 2007 |
| HTAQSTA | 715 | 1.0E−11 | 1.4E−14 | Polystyrene | 9.7E+10 | M⁻¹ | Serizawa |
| | | | | (syndiotactic) | | | et al. 2007 |
| VKTQATSREE− | 9,433 | 1.0E−10 | 1.1E−14 | Zeolite | 1.0E+10 | M⁻¹ | Nygaard |
| PPRLPSKHRPG₄ | | | | | | | et al. 2002 |
| PQAQDVELPQ- | 12,366 | 4.0E−11 | 3.2E−15 | SWNT | 2.5E+10 | M⁻¹ | Brown et |
| ELQDQHREVEV₅ | | | | (HiPco, | | | al. 2008 |
| | | | | purified) | | | |

^{a}All chemical motifs denoted by capital letters are peptide sequences; for polypeptides, the subscripts denote how many times the peptide sequence is repeated.
^{b}K_{d} is the dissociation constant.
^{c}MWNT is multi walled carbon nanotube; SWNT is single walled carbon nanotube; PLLA is polylactic acid; PMMA is poly(methyl methacrylate); PDLA is poly-D-lactide; PPV is poly(p-phenylene vinylene); HDPE is high-density polyethylene; numbers in brackets after SWNTs denote chirality, e.g. (6,5).
^{d}Affinity parameter values with the unit L/kg are affinities expressed as the adsorption distribution coefficient; affinity parameter values with the unit M⁻¹ are affinities expressed as the affinity constant Kₐ, which is equal to 1/K_{d}; affinity parameter values with the unit kcal/mol are affinities expressed as the standard-state adsorption free energy values (ΔG°_{ads}); affinity parameter values with the unit L/mg are affinities expressed as Langmuir affinity constant (K_{L}).

For any characteristics of a precursor-ML, ML or Ligand2 mentioned above, and in each characteristic's entire range, a further characteristic of importance is the Affinity-to-MW ratio of the precursor-ML, ML or Ligand2, respectively.

Binding constant-to-MW ratio of precursor-ML, ML or Ligand2. In some cases, it is not the absolute affinity of a precursor-ML, ML or Ligand2 for an SE that is important, but rather the affinity-to-MW (K_{B}/MW) ratio that is important. As an example, if the economical cost of preparing two small Ligand2s with a combined binding constant for an SE of K_{B}=10¹⁰ M⁻¹ is smaller than the cost of preparing one larger Ligand2 with the same binding constant, it may be desirable to use the smaller Ligand2s. Thus, depending on the context, the K_{B}/MW ratio is preferably greater than 1 M⁻¹/Dal, such as greater than 10⁶ M⁻¹/Dal, such as greater than 10¹⁰ M⁻¹/Dal, such as greater than 10¹³ M⁻¹/Dal, such as greater than 10¹⁶ M⁻¹/Dal, such as greater than 10¹⁸ M⁻¹/Dal, such as greater than 10²⁰ M⁻¹/Dal.

However, if the processing of the composite material is performed more easily using fewer precursor-MLs, MLs, or Ligand2s, it may be desirable to use larger precursor-MLs, MLs, or Ligand2s, respectively. Thus, depending on the context, the K_{B}/MW ratio is preferably less than 10²⁰ M⁻¹/Dal, such as less than 10¹⁸ M⁻¹/Dal, such as less than 10¹⁶ M⁻¹/Dal, such as less than 10¹³ M⁻¹/Dal, such as less than 10¹⁰ M⁻¹/Dal, such as less than 10⁶ M⁻¹/Dal, such as less than 1 M⁻¹/Dal.

Thus, the preferred compromise between many small precursor-MLs, MLs, or Ligand2s with relatively high K_{B}/MW ratios and fewer large precursor-MLs, MLs, or Ligand2s, respectively, with relatively low K_{B}/MW ratios depends on the context. Preferred embodiments include precursor-MLs, MLs, or Ligand2s with K_{B}/MW ratios of from 1 M⁻¹/Dal to 10²⁰M⁻¹/Dal, more preferably precursor-MLs, MLs, or Ligand2s with K_{B}/MW ratios of from 103 M⁻¹/Dal to 10²⁰M⁻¹/Dal, more preferably precursor-MLs, MLs, or Ligand2s with K_{B}/MW ratios of from 10⁶ M⁻¹/Dal to 10²⁰M⁻¹/Dal, more preferably precursor-MLs, MLs, or Ligand2s with K_{B}/MW ratios of from 10¹⁰ M⁻¹/Dal to 10²⁰M⁻¹/Dal, more preferably precursor-MLs, MLs, or Ligand2s with K_{B}/MW ratios of from 10¹³ M⁻¹/Dal to 10²⁰M⁻¹/Dal, more preferably precursor-MLs, MLs, or Ligand2s with K_{B}/MW ratios of from 10¹⁶ M⁻¹/Dal to 10²⁰M⁻¹/Dal, more preferably precursor-MLs, MLs, or Ligand2s with K_{B}/MW ratios of from 10¹⁸ M⁻¹/Dal to 10²⁰M⁻¹/Dal, and more preferably precursor-MLs, MLs, or Ligand2s with K_{B}/MW ratios larger than 10²⁰M⁻¹/Dal.

For any characteristics of a precursor-ML or Ligand2 mentioned above, and in each characteristic's entire range, a further characteristic of importance is the half-life of the precursor-ML-SE complex or the Ligand2-SE complex, respectively.

Half-life of precursor-ML or Ligand2. In many cases, precursor-MLs or Ligand2s with large half-lifes are preferred. This is for example the case for Ligand2s in composite materials where the characteristics of the composite material should change as little over time as possible, e.g. in structural elements of buildings, bridges, etc. Thus, depending on the context, the half-life is preferably greater than 0.01 second, such as greater than 0.1 second, such as greater than 1 second, such as greater than 10 seconds, such as greater than 1 minute, such as greater than 10 minutes, such as greater than 1 hour, such as greater than 5 hours, such as greater than 10 hours, such as greater than 24 hours, such as greater than 2 days, such as greater than 10 days, such as greater than 50 days, such as greater than 100 days, such as greater than 1 year, such as greater than 10 years.

In other cases, precursor-MLs or Ligand2s with short half-lifes are preferred. This may be the case if it is desirable that a material gives in after some prespecified time. Thus, depending on the context, the half-life is preferably less than 10 years, such as less than 1 year, such as less than 100 days, such as less than 50 days, such as less than 10 days, such as less than 2 days, such as less than 24 hours, such as less than 10 hours, such as less than 5 hours, such as less than 1 hour, such as less than 10 minutes, such as less than 1 minute, such as less than 10 seconds, such as less than 1 second, such as less than 0.1 second, such as less than 0.01 second.

Thus, the preferred compromise between long half-lifes and short half-lifes depends on the context and half-lifes suitable for the present invention can be shorter than 0.01 second, but may also include half-lifes in the following ranges: 0.01-0.1 seconds, 0.1-1 seconds, 1-10 seconds, 10-60 seconds, 1-10 minutes, 10-60 minutes, 1-5 hours, 5-10 hours, 10-24 hours, 1-2 days, 2-10 days, 10-50 days, 50-100 days, 100-365 days, 1-10 years, or more than 10 years. Eg. when the Ligand2-SE interaction is characterized by an appropriately long half-life, the SE and Ligand2 will remain associated for a long time, and the composite material comprising such CMUs will retain its characteristics for a longer period of time.

Half-life-to-MW ratio of precursor-ML or Ligand2. In some cases, it is not the half-life (T½) of a precursor-ML or Ligand2 for an SE that is important, but rather the half-life-to-MW (T½/MW) ratio that is important. As an example, if the economical cost of preparing two small precursor-MLs with a combined half life for an SE of T½=5 days is smaller than the cost of preparing one larger precursor-ML with the same binding constant, it may be desirable to use the smaller precursor-MLs. Thus, depending on the context, the T½/MW ratio is preferably greater than 10⁻⁸ days/Dal, such as greater than 10⁻⁶ days/Dal, such as greater than 10⁻⁴ days/Dal, such as greater than 0.01 days/Dal, such as greater than 1 days/Dal, such as greater than 100 days/Dal, such as greater than 10,000 days/Dal.

However, if the processing of the composite material is performed more easily using fewer precursor-MLs or Ligand2s, it may be desirable to use larger precursor-MLs or Ligand2s. Thus, depending on the context, the T½/MW ratio is preferably less than 10,000 days/Dal, such as less than 100 days/Dal, such as less than 1 days/Dal, such as less than 0.01 days/Dal, such as less than 10⁻⁴ days/Dal, such as less than 10⁻⁶ days/Dal, such as less than 10⁻⁸ days/Dal.

Thus, the preferred compromise between a high and low T½/MW ratio depends on the context, and may be lower than 10⁻⁸ days/Dal, but may also be in the range of 10⁻⁸-10⁻⁶ days/Dal, 10⁻⁶-10⁻⁴ days/Dal, 10⁻⁴-0.01 days/Dal, 0.01-1 days/Dal, 1-100 days/Dal, 100-10,000 days/Dal, or above 10,000 days/Dal.

For any characteristics of a precursor-ML, ML or Ligand2 mentioned above, and in each characteristic's entire range, a further characteristic of importance is the charge of the precursor-ML, ML or Ligand2.

Charge of precursor-ML, ML or Ligand2. The charge of the precursor-ML, ML or Ligand2 can be important. As an example, if the precursor-ML, ML or Ligand2 is used as a means to prepare a nanosensor, where a conducting nanotube is used to sense the binding of certain analytes to another SE, linked to the nanotube by way of the precursor-ML, ML or Ligand2, then the charge of the precursor-ML, ML or Ligand2, respectively, is likely to have an effect on the conductivity of the nanotube (and hence, an effect on the read-out), which may not always be desirable. A precursor-ML, ML or Ligand2 carrying a charge may also be a disadvantage during the preparation of a composite material comprising CMUs, because the charge may interfere with e.g. polymerization of the matrix material. Alternatively, a ligand carrying a charge can help disperse an SE in certain solvents, in which case it will be an advantage to have a charged precursor-ML, ML or Ligand2. Thus, depending on the context, the net charge at pH 7 is preferably greater than −10, such as greater than −9, such as greater than −8, such as greater than −7, such as greater than −6, such as greater than −5, such as greater than −4, such as greater than −3, such as greater than −2, such as greater than −1, such as greater than 0, such as greater than 1, such as greater than 2, such as greater than 3, such as greater than 4, such as greater than 5, such as greater than 6, such as greater than 7, such as greater than 8, such as greater than 9, such as greater than 10, such as greater than 11, such as greater than 12, such as greater than 13. Preferred embodiments of the present invention include precursor-MLs, MLs or Ligand2s with a net charge at pH 7 of less than −10, or a net charge of −10, or −9, −8, −7, −6, −5, −4, −3, −2, −1, 0 (e.g. the amino acid alanine), +1, +2, +3, +4, +5, +6, +7, +8, +9, +10, +11, +12, +13, or more than a net charge of +13.

Likewise, preferred embodiments of the present invention include precursor-MLs, MLs or Ligand2s with a total number of charges (positive or negative charges) of 0, 1, 2 (e.g. the amino acid alanine at pH 7), 3, 4, 5, 6, 7, 8, 9, 10, 11, 12, 13-15, 15-20, 20-30, 30-50, 50-100, or more than 100.

For any characteristics of a precursor-ML, ML or Ligand2 mentioned above, and in each characteristic's entire range, a further characteristic of importance is the surface area of interaction of the precursor-ML, ML or Ligand2 with the SE.

Surface area of the interaction of the precursor-ML, ML or Ligand2 with the SE. The surface area of interaction between the precursor-ML, ML or Ligand2 and SE determines how many precursor-MLs, MLs, or Ligand2s can bind to a given SE. Therefore, the surface area of interaction can be an important parameter and in some cases, a large surface area of interaction is desirable, as it may allow the precursor-ML to bind with a higher affinity to the SE. Thus, depending on the context, the surface area of interaction is preferably greater than 20 Å², such as greater than 100 Å², such as greater than 200 Å², such as greater than 300 Å², such as greater than 500 Å², such as greater than 700 Å², such as greater than 1,000 Å², such as greater than 2,000 Å², such as greater than 4,000 Å², such as greater than 8,000 Å², such as greater than 15,000 Å², such as greater than 30,000 Å², such as greater than 100,000 Å².

In other cases, a small surface area of interaction is desirable, e.g if a higher number of precursor-ML, ML or Ligand2 must be bound to the SE, and thus, depending on the context, the surface area of interaction is preferably less than 100,000 Å², such as less than 30,000 Å², such as less than 15,000 Å², such as less than 8,000 Å², such as less than 4,000 Å², such as less than 2,000 Å², such as less than 1,000 Å², such as less than 700 Å², such as less than 500 Å², such as less than 300 Å², such as less than 200 Å², such as less than 100 Å², such as less than 20 Å².

Preferred embodiments of the present invention include precursor-MLs, MLs, or Ligand2s that contact the SE over a surface area of less than 20 Å², or contact the SE over a surface area of 20-100 Å², 100-200 Å², 200-300 Å², 300-500 Å², 500-700 Å², 700-1,000 Å², 1,000-2,000 Å², 2,000-4,000 Å², 4,000-8,000 Å², 8,000-15,000 Å², 15,000-30,000 Å², 30,000-100,000 Å², or more than 100,000 Å².

For any characteristics of a precursor-ML, ML or Ligand2 mentioned above, and in each characteristic's entire range, further characteristics of importance are the Affinity-to-charge ratio of the precursor-ML, ML or Ligand2, respectively, the Affinity to area-of-interaction ratio of the precursor-ML, ML or Ligand2, respectively, the degradability and biodegradability of the precursor-ML, ML or Ligand2, respectively, and the intrinsic stability of the precursor-ML, ML or Ligand2, respectively.

Particularly the biodegradability is of importance. Degradation by enzymes such as peptidases, nucleases and other enzymes commonly found in nature can decrease the lifetime of a composite material, wherefore it is often advantageous to avoid the use of natural and unnatural oligonucleotides, natural and unnatural polypeptides (comprising natural and unnatural amino acids), and in general avoid the use of polyamides or amide bonds in general, or any other kind of chemical entity or bond that is commonly found in nature.

In short, when trying to avoid biodegradation, it is often advantageous to use components for the making of composite materials that do not resemble too strongly the chemical entities found in nature. Thus, use of precursor-MLs, MLs, or Ligand2s (and structural entities and linkers) that do not contain peptides or nucleotides is often preferable.

Chemical stability is also of importance. It is generally advantageous to use precursor-MLs, MLs, or Ligand2s that are chemically stable (e.g. stable towards high temperature, low or high pH, high pressure, etc), in order to ensure that the precursor-ML's, ML's or Ligand2's characteristics, especially the affinity for the structural entity, remain relatively constant under varying conditions.

In another preferred embodiment it is advantageous to use biodegradable components, to avoid e.g. long term pollution of the environment.

Precursor-MLs, MLs, or Ligand2s may be organic or inorganic.

Further, precursor-MLs, MLs, or Ligand2s may be polymers or may be non-polymeric in structure. Preferred polymeric precursor-MLs, MLs, or Ligand2s include the polymers listed above and below.

The polymeric precursor-MLs, MLs, or Ligand2s can be divided into biological polymers and non-biological polymers.

Biological polymers shall here be defined as the polymers involved in the transcriptional and translational process, i.e. natural nucleic acids (RNA or DNA), or natural polypeptides. Natural polypeptides can be further divided into peptides, proteins and antibodies.

Peptide-based precursor-MLs, MLs, or Ligand2s. The number of amino acids (AA) of the precursor-ML, ML or Ligand2 may be of high economic importance (smaller peptides typically cost less to produce), and also, a smaller peptide is often indicative of a smaller surface of interaction with the SE, wherefore typically a higher number of precursor-MLs, MLs, or Ligand2s can bind simultaneously to the SE if each precursor-ML, ML or Ligand2 comprise fewer amino acids. Thus, depending on the context, the peptide-based precursor-ML, ML or Ligand2 is preferably comprised of fewer than 100 AA, such as fewer than 90 AA, such as fewer than 80 AA, such as fewer than 70 AA, such as fewer than 60 AA, such as fewer than 50 AA, such as fewer than 40 AA, such as fewer than 30 AA, such as fewer than 25 AA, such as fewer than 20 AA, such as fewer than 15 AA, such as fewer than 10 AA, such as fewer than 9 AA, such as fewer than 8 AA, such as fewer than 7 AA, such as fewer than 6 AA, such as fewer than 5 AA, such as fewer than 4 AA, such as fewer than 3 AA, such as fewer than 2 AA.

However, it is typically easier to prepare a peptide-based precursor-ML, ML or Ligand2 of high affinity if it comprises more amino acids. Thus, depending on the context, the peptide-based precursor-ML, ML or Ligand2 is preferably comprised of more than 1 AA, such as more than 2 AA, such as more than 3 AA, such as more than 4 AA, such as more than 5 AA, such as more than 6 AA, such as more than 7 AA, such as more than 8 AA, such as more than 9 AA, such as more than 10 AA, such as more than 15 AA, such as more than 20 AA, such as more than 25 AA, such as more than 30 AA, such as more than 40 AA, such as more than 50 AA, such as more than 60 AA, such as more than 70 AA, such as more than 80 AA, such as more than 90 AA, such as more than 100 AA.

Thus, the preferred compromise between peptide-based precursor-MLs, MLs, or Ligand2s comprising few or many amino acids depends on the context, and may be lower than 2 AA, but may also be in the range: 2-3 AA, 3-4 AA, 4-5 AA, 5-6 AA, 6-7 AA, 7-8 AA, 8-9 AA, 9-10 AA, 10-15 AA, 15-20 AA, 20-25 AA, 25-30 AA, 30-40 AA, 40-50 AA, 50-60 AA, 60-70 AA, 70-80 AA, 80-90 AA, 90-100 AA, or more than 100 AA.

Preferred peptide-based precursor-MLs, MLs, or Ligand2s include the following peptides, as well as all shorter peptide sequences that may be derived from these peptide sequences:

PQAQDVELPQELQDQHREVEV₅ =
PQAQDVELPQELQDQHREVEVPQAQDVELPQELQDQHREVEVPQAQDVEL
PQELQDQHREVEVPQAQDVELPQELQDQHREVEVPQAQDVELPQELQDQH
REVEV)

Non-biological polymers include polymers that are not RNA, DNA or natural polypeptides, e.g. including PVC, epoxy, unnatural polypeptides (i.e. not solely comprising alpha-amino acids) and unnatural nucleic acids (e.g. PNA, LNA and other unnatural nucleic acids).

The polymeric precursor-MLs, MLs, or Ligand2s can be further divided into linear and branched polymers. The branched polymers may be further divided into short-chain branched polymers, long-chain branched polymers, star-branched polymers, ladder polymers and network polymers.

The precursor-MLs, MLs, or Ligand2s can be further divided into precursor-MLs, MLs, or Ligand2s comprising solely aliphatic moieties, comprising solely aromatic moieties, or comprising both aliphatic and aromatic moieties.

The precursor-MLs, MLs, or Ligand2s can be further divided into precursor-MLs, MLs, or Ligand2s comprising solely single bonds, solely double bonds, solely triple bonds, solely aromatic bonds, or a combination of single-, double-, triple and aromatic bonds.

Organic precursor-MLs, MLs, or Ligand2s include natural and unnatural polypeptides, lipids, polysaccharides, wood, flour, Inorganic precursor-MLs, MLs, or Ligand2s include metal ions, Cu+, Cu2+, Fe2+, Fe3+, Hg2+, Hg₂2+, Pb2+, Pb4+, Sn2+, Sn4+, Cr2+, Cr3+, Mn2+, Mn3+, Co2+, Co3+.

Identities and number of different elements of a Precursor-ML, ML or Ligand2. The Precursor-ML, ML or Ligand2 may be composed of only one element, two elements, three elements, four elements, or more than four elements.

Precursor-MLs, MLs, or Ligand2s consisting of one element. The precursor-ML, ML or Ligand2 may consist of just one atom (in its non-charged form or as an ion, e.g. Gd or Gd+++), or may consist of several atoms, held together in an organized structure.

The following ions are particularly preferred precursor-MLs, MLs, or Ligand2s: K+, Cl−, Ca++, Mg++, Gd+++, Cu+, Cu2+, Fe2+, Fe3+, Hg2+, Hg₂2+, Pb2+, Pb4+, Sn2+, Sn4+, Cr2+, Cr3+, Mn2+, Mn3+, Co2+, Co3+.

If comprising only one element, or one type of element, the element may be any one of the following elements: Lithium (Li), Beryllium (Be), Boron (B), Carbon (C), Nitrogen (N), Oxygen (O), Fluorine (F), Sodium (Na), Magnesium (Mg), Aluminium (Al), Silicon (Si), Phosphorus (P), Sulfur (S), Chlorine (CI), Potassium (K), Calcium (Ca), Scandium (Sc), Titanium (Ti), Vanadium (V), Chromium (Cr), Manganese (Mn), Iron (Fe), Cobalt (Co), Nickel (Ni), Copper (Cu), Zinc (Zn), Gallium (Ga), Germanium (Ge), Arsenic (As), Selenium (Se), Bromine (Br), Rubidium (Rb), Strontium (Sr), Yttrium (Y), Zirconium (Zr), Niobium (Nb), Molybdenum (Mo), Technetium (Tc), Ruthenium (Ru), Rhodium (Rh), Palladium (Pd), Silver (Ag), Cadmium (Cd), Indium (In), Tin (Sn), Antimony (Sb), Tellurium (Te), Iodine (I), Caesium (Cs), Barium (Ba), Platinum (Pt), Gold (Au), Mercury (Hg), Thallium (TI), Lead (Pb), Bismuth (Bi).

Examples of precursor-MLs, MLs, or Ligand2s consisting of only carbon (C) include the following: Fullerenes including graphene and carbon nanotubes, carbon fiber, and pyrene.

Precursor-MLs, MLs, or Ligand2s consisting of two elements. If comprising only two elements, or two types of elements, the elements may include any of the following:

Hydrogen (H), Lithium (Li), Beryllium (Be), Boron (B), Carbon (C), Nitrogen (N), Oxygen (O), Fluorine (F), Sodium (Na), Magnesium (Mg), Aluminium (Al), Silicon (Si), Phosphorus (P), Sulfur (S), Chlorine (CI), Potassium (K), Calcium (Ca), Scandium (Sc), Titanium (Ti), Vanadium (V), Chromium (Cr), Manganese (Mn), Iron (Fe), Cobalt (Co), Nickel (Ni), Copper (Cu), Zinc (Zn), Gallium (Ga), Germanium (Ge), Arsenic (As), Selenium (Se), Bromine (Br), Rubidium (Rb), Strontium (Sr), Yttrium (Y), Zirconium (Zr), Niobium (Nb), Molybdenum (Mo), Technetium (Tc), Ruthenium (Ru), Rhodium (Rh), Palladium (Pd), Silver (Ag), Cadmium (Cd), Indium (In), Tin (Sn), Antimony (Sb), Tellurium (Te), Iodine (I), Caesium (Cs), Barium (Ba), Platinum (Pt), Gold (Au), Mercury (Hg), Thallium (TI), Lead (Pb), Bismuth (Bi).

Examples of precursor-MLs, MLs, or Ligand2s consisting of only carbon (C) and hydrogen (H) include the following: polyethylene, polypropylene, polystyrene, phenylacetylene, naphthalene, ethylbenzene, phenanthrene, pyrene, decane, benzo(a)pyrene, trans-cyclooctene, anhydrous 1-octyne, meso-1,2-diphenylethylene, 1,2,3,4-tetrahydro-naphthalene, benzo[a]phenanthrene, 1,1-di(phenyl)ethylene, 1,2-benzacenaphthene, 1,2-dihydroacenaphthylene, 1,2-benzanthracene, perylene, 1-iso-propyl-4-methylbenzene, N-dodecane, tert-butyl benzene, 1-methyl-naphthalene, α-n-hexadecene, 1-n-decene, phenylenemethyl-ethylene, trans-2-methylstyrene, ethylmethylbenzene, 2-methyl-naphthalene, 4-methyl-styrene, triphenylemethane, 1-phenyl-1-propyne, 2,2,4-trimethylpentane, 4-methyl phenyl acetylene, hexamethyl-benzene, [3.3.1]nonane, p-mentha-1,8-diene, acetnaphthylene, 1,2,4,5-tetramethyl benzene, 2,6,6-trimethylbicyclo[3.1.1]hept-2-ene, 1,2,4-trimethyl benzene, tricyclo[3.3.1.1{3,7}]decane, butylbenzene, 2,3-benzanthracene, 4-methyl-biphenyl, β-carotene, and derivatives thereof.
Comprising Al and Cl: Aluminium trichloride
Comprising Al and O: Aluminum oxide
Comprising Nb and O: Niobium oxide
Comprising C and F: Polytetrafluoroethylene, pentafluoropropylene, 1,1,4,4,4-pentafluoro-2-butyne, pentafluoro-ethane.
Comprising C and Cl: 1,1,2,2-tetrachloroethylene, hexachloro-benzene.

Precursor-MLs, MLs, or Ligand2s consisting of three elements. If comprising only three elements, or three types of elements, the elements may include any of the following: Hydrogen (H), Lithium (Li), Beryllium (Be), Boron (B), Carbon (C), Nitrogen (N), Oxygen (O), Fluorine (F), Sodium (Na), Magnesium (Mg), Aluminium (Al), Silicon (Si), Phosphorus (P), Sulfur (S), Chlorine (CI), Potassium (K), Calcium (Ca), Scandium (Sc), Titanium (Ti), Vanadium (V), Chromium (Cr), Manganese (Mn), Iron (Fe), Cobalt (Co), Nickel (Ni), Copper (Cu), Zinc (Zn), Gallium (Ga), Germanium (Ge), Arsenic (As), Selenium (Se), Bromine (Br), Rubidium (Rb), Strontium (Sr), Yttrium (Y), Zirconium (Zr), Niobium (Nb), Molybdenum (Mo), Technetium (Tc), Ruthenium (Ru), Rhodium (Rh), Palladium (Pd), Silver (Ag), Cadmium (Cd), Indium (In), Tin (Sn), Antimony (Sb), Tellurium (Te), Iodine (I), Caesium (Cs), Barium (Ba), Platinum (Pt), Gold (Au), Mercury (Hg), Thallium (TI), Lead (Pb), Bismuth (Bi).

Examples of precursor-MLs, MLs, or Ligand2s consisting of three elements include:
Comprising C, H, Cl: Polyvinylchloride
Comprising C, H, O: Poly(vinylalcohol)
Comprising Ag, C, O: Silver carbonate, silver(I) oxalate
Comprising C, H, Cl: 3,3′,4,4′,5,5′-hexachlorobiphenyl; 1,2,4,5-TeCB; 2,4′-DDT; pentachloroethane; pentachloro-benzene

Precursor-MLs, MLs, or Ligand2s consisting of four elements. If comprising only four elements, or three types of elements, the elements may include any of the following:

Hydrogen (H), Lithium (Li), Beryllium (Be), Boron (B), Carbon (C), Nitrogen (N), Oxygen (O), Fluorine (F), Sodium (Na), Magnesium (Mg), Aluminium (Al), Silicon (Si), Phosphorus (P), Sulfur (S), Chlorine (CI), Potassium (K), Calcium (Ca), Scandium (Sc), Titanium (Ti), Vanadium (V), Chromium (Cr), Manganese (Mn), Iron (Fe), Cobalt (Co), Nickel (Ni), Copper (Cu), Zinc (Zn), Gallium (Ga), Germanium (Ge), Arsenic (As), Selenium (Se), Bromine (Br), Rubidium (Rb), Strontium (Sr), Yttrium (Y), Zirconium (Zr), Niobium (Nb), Molybdenum (Mo), Technetium (Tc), Ruthenium (Ru), Rhodium (Rh), Palladium (Pd), Silver (Ag), Cadmium (Cd), Indium (In), Tin (Sn), Antimony (Sb), Tellurium (Te), Iodine (I), Caesium (Cs), Barium (Ba), Platinum (Pt), Gold (Au), Mercury (Hg), Thallium (TI), Lead (Pb), Bismuth (Bi).

Precursor-MLs, MLs, or Ligand2s consisting of four elements include:
Comprising C, H, Cl, O: 1,2,3,6,7,8-hexachlorooxanthrene; 4,4′-dichloro-benzophenone; Dieldrite; α,α-diphenylacetyl chloride; 1,2,3,4,6,7,8-H7CDF; 1,2,3,4,7,8-hexachlorooxanthrene; 2,3-dichloro-1,4-dihydro-1,4-dioxonaphthalene; 1,2,3,7,8,9-hexachlorooxanthrene.

Precursor-MLs, MLs, or Ligand2s consisting of more than four elements. If comprising more than four elements, the elements may include any of the following:

Hydrogen (H), Lithium (Li), Beryllium (Be), Boron (B), Carbon (C), Nitrogen (N), Oxygen (O), Fluorine (F), Sodium (Na), Magnesium (Mg), Aluminium (Al), Silicon (Si), Phosphorus (P), Sulfur (S), Chlorine (CI), Potassium (K), Calcium (Ca), Scandium (Sc), Titanium (Ti), Vanadium (V), Chromium (Cr), Manganese (Mn), Iron (Fe), Cobalt (Co), Nickel (Ni), Copper (Cu), Zinc (Zn), Gallium (Ga), Germanium (Ge), Arsenic (As), Selenium (Se), Bromine (Br), Rubidium (Rb), Strontium (Sr), Yttrium (Y), Zirconium (Zr), Niobium (Nb), Molybdenum (Mo), Technetium (Tc), Ruthenium (Ru), Rhodium (Rh), Palladium (Pd), Silver (Ag), Cadmium (Cd), Indium (In), Tin (Sn), Antimony (Sb), Tellurium (Te), Iodine (I), Caesium (Cs), Barium (Ba), Platinum (Pt), Gold (Au), Mercury (Hg), Thallium (TI), Lead (Pb), Bismuth (Bi).

Precursor-MLs, MLs, or Ligand2s consisting of more than four elements include:
Comprising N, H, Br, O, C: 1-amino-4-bromo-2-nitrobenzene, 5,7-dibromo-8-hydroxy quinolone; 4-Bromophenyl isothiocyanate; 2-(bromoacetyl)-thiophene

A precursor-ML, ML or Ligand2 may contain chemical motifs that bind SE, as described above. The following is a non-comprehensive list of such chemical motifs that bind SE, where the SE that the chemical motif binds to, or may bind to, follows in parenthesis. Some of these chemical motifs bind only weakly to the SEs.

Group 5: Chemical Motifs and the SEs they Bind.
Polystyrene (carbon nanotube)
Riboflavin (carbon nanotube)
DNA (carbon nanotube)
Porphyrine (carbon nanotube)
Pyrenyl (carbon nanotube)
SDBS (carbon nanotube)
Polypeptide with sequence SVSVGMKPSPRPGGGK (hydroxyapatite)
Polypeptide with sequence THRTSTLDYFVI (chlorine-doped polypyrrole)
Benzene (carbon nanotubes)
Naphthalene (carbon nanotubes)
Biphenyl (carbon nanotubes)
Fluorene (carbon nanotubes)
Phenanthrene (carbon nanotubes)
Anthracene (carbon nanotubes)
Pyrene (carbon nanotubes; graphene)
Triphenylene (carbon nanotubes)
P-terphenyl (carbon nanotubes)
Tetraphene (carbon nanotubes)
Pyrenecarboxylic acid (carbon nanotubes)
SDS (carbon nanotubes)
SDSA (carbon nanotubes)
DTAB (carbon nanotubes)
NaDDBS (carbon nanotubes)
Tween-60 (carbon nanotubes)
Tween-80 (carbon nanotubes)
Monostearate (carbon nanotubes)
Monooleate (carbon nanotubes)
PSPEO (carbon nanotubes)
PVP (carbon nanotubes)
Sulfonate (carbon nanotubes)

### Subligands.

Ligand2 may comprise one or more subligands held together by one or more sub-linkers. As an example, Ligand2 may comprise two subligands, each of which is capable of binding SE1, and which are linked by a sub-linker. The subligands of Ligand2 may be linked in series or in parallel.

The subligands may be of varying affinities. In a preferred embodiment, the subligands of Ligand2 are arranged in series, and the SubLigand closest to LinkerL is of weak affinity, and therefore easy to dissociate from SE1, and the SubLigand farthest away from LinkerL is of high affinity and therefore difficult to dissociate from SE1. In composite materials where SE1 is a structural entity of high strength (e.g. a carbon nanotube) and SE2 is a polymer such as epoxy or polypropylene, the composite material made up of CMUs comprising subligands as described immediately above will be very flexible, but will also be of high strength. By using SubLigands of varying affinities, as well as using linkers of varying lengths, the flexibility and strength of the composite material can be varied. Moreover, CMUs comprising Ligands with more than one SubLigand will add self-healing properties to a composite material in which they are used. Thus, if during applied stress to the composite material one of the SubLigand-SE interactions is interrupted, the other SubLigand may stay associated with the SE, and upon removal of the applied stress, the interrupted SubLigand-SE interaction may re-form, thereby re-establishing the shape of the composite material. The subligands may also be arranged in parallel, in which case the corresponding composite material will be less flexible but often have higher strength.

### Covalent Bonds.

Mechanical ligands as well as Ligand2s typically comprise one or more covalent bonds. Ligand2s capable of covalently linking SEs with the linker may comprise functional groups such as OH, COOH, NH2, SH and CO, but can be any atom or molecule capable of forming a chemical bond with another atom or molecule. Below is shown a number of reactive/functional groups, and the covalent bond that each pair of functional groups may form. These functional groups as well as the covalent bond that they form, may be contained in SEs, Linkers, precursor-MLs, MLs and Ligand2s of the present invention:

### Group 6: Reactive Groups, and Covalent Bond Formed Upon Reaction.

| Functional group 1 | Functional group 2 | Covalent bond formed |
|---|---|---|
| NH2 | COOH | CONH (amide bond) |
| SH | SH | SS (disulfide bond |
| CO (aldehyde) | NH2 | CNH (secondary |
| | | amine bond) |

Covalent bond-forming chemical reactions suitable for forming the covalent bond of or between SEs, Linkers, precursor-MLs, MLs and/or Ligand2s, including the ring-forming reactions of precursor-MLs to produce MLs, include any one or more of the reactions in the list below.

### Group 7: Covalent Bond-Forming Chemical Reactions.

Chemical reactions for synthesizing polymers, small molecules, or other chemical compounds such as those listed in March's Advanced Organic Chemistry, Organic Reactions, Organic Syntheses, organic text books, journals such as Journal of the American Chemical Society, Journal of Organic Chemistry, Tetrahedron, etc., and Carruther's Some Modern Methods of Organic Chemistry can be used. For example, substitution reactions, carbon-carbon bond forming reactions, elimination reactions, acylation reactions, and addition reactions. An illustrative but not exhaustive list of aliphatic nucleophilic substitution reactions useful in the present invention includes, for example, SN2 reactions, SNI reactions, SNi reactions, allylic rearrangements, nucleophilic substitution at an aliphatic trigonal carbon, and nucleophilic substitution at a vinylic carbon.
Specific aliphatic nucleophilic substitution reactions with oxygen nucleophiles include, for example, hydrolysis of alkyl halides, hydrolysis of gen-dihalides, hydrolysis of 1,1,1-trihalides, hydrolysis of alkyl esters or inorganic acids, hydrolysis of diazo ketones, hydrolysis of acetal and enol ethers, hydrolysis of epoxides, hydrolysis of acyl halides, hydrolysis of anhydrides, hydrolysis of carboxylic esters, hydrolysis of amides, alkylation with alkyl halides (Williamson Reaction), epoxide formation, alkylation with inorganic esters, alkylation with diazo compounds, dehydration of alcohols, transetherification, alcoholysis of epoxides, alkylation with onium salts, hydroxylation of silanes, alcoholysis of acyl halides, alcoholysis of anhydrides, esterfication of carboxylic acids, alcoholysis of carboxylic esters (transesterfication), alcoholysis of amides, alkylation of carboxylic acid salts, cleavage of ether with acetic anhydride, alkylation of carboxylic acids with diazo compounds, acylation of carboxylic acids with acyl halides; acylation of carlpoxylic acids with carboxylic acids, formation of oxoniiim salts, preparation of peroxides arid hydroperoxides, preparation of inorganic esters (e.g., nitrites, nitrates, sulfonates), preparation of alcohols from amines, arid preparation of mixed organic-inorganic anhydrides.
Specific aliphatic nucleophilic substitution reactions with sulfur nucleophiles, which tend to be better nucleophiles than their oxygen analogs, include, for example, attack by SH at an alkyl carbon to form thiols, attack by S at an alkyl carbon to form thioethers, attack by SH or SR at an acyl carbon, formation of disulfides, formation of Bunte salts, alkylation of sulfuric acid salts, and formation of alkyl thiocyanates.
Aliphatic nucleophilic substitution reactions with nitrogen nucleophiles include, for example, alkylation of amines, N-arylation of amines, replacement of a hydroxy by an amino group, transamination, transamidation, alkylation of amines with diazo compounds, animation of epoxides, amination of oxetanes, amination of aziridines, amination of alkanes, formation of isocyanides, acylation of amines by acyl halides, acylation of amines by anhydrides, acylation of amines by carboxylic acids, acylation of amines by carboxylic esters, acylation of amines by amides, acylation of amines by other acid derivatives, N-alkylation or N-arylation of amides and imides, N-acylation of amides and imides, formation of aziridines from epoxides, formation of nitro compounds, formation of azides, formation of isocyanates and isothiocyanates, and formation of azoxy compounds. Aliphatic nucleophilic substitution reactions with halogen nucleophiles include, for example, attack at an alkyl carbon, halide exchange, formation of alkyl halides from esters of sulfuric and sulfonic acids, formation of alkyl halides from alcohols, formation of alkyl halides from ethers, formation of halohydrins from epoxides, cleavage of carboxylic esters with lithium iodide, conversion of diazo ketones to alpha-halo ketones, conversion of amines to halides, conversion of tertiary amines to cyanamides (the von Braun reaction), formation of acyl halides from carboxylic acids, and formation of acyl halides from acid derivatives.
Aliphatic nucleophilic substitution reactions using hydrogen as a nudeophile include, for example, reduction of alkyl halides, reduction of tosylates, other sulfonates, and similar compounds, hydrogenolysis of alcohols, hydrogenolysis of esters (Barton-McCombie reaction), hydrogenolysis of nitriles, replacement of alkoxyl by hydrogen, reduction of epoxides, reductive cleavage of carboxylic esters, reduction of a C—N bond, desulfurization, reduction of acyl halides, reduction of carboxylic acids, esters, and anhydrides to aldehydes, and reduction of amides to aldehydes.
Aliphatic nucleophilic substitution reactions using carbon nucleophiles include, for example, coupling with silanes, coupling of alkyl halides (the Wurtz reaction), the reaction of alkyl halides and sulfonate esters with Group I (I A), and II (II A) organometallic reagents, reaction of alkyl halides and sulfonate esters with organocuprates, reaction of alkyl halides and sulfonate esters with other organometallic reagents; allylic and propargylic coupling with a halide substrate, coupling of organometallic reagents with esters of sulfuric and sulfonic acids, sulfoxides, and sulfones, coupling involving alcohols, coupling of organometallic reagents with carboxylic esters, coupling of organometallic reagents with compounds containing an esther linkage, reaction of organometallic reagents with epoxides, reaction of organometallics with aziridine, alkylation at a carbon bearing an active hydrogen, alkylation of ketones, nitriles, and carboxylic esters, alkylation of carboxylic acid salts, alkylation at a position alpha to a heteroatom (alkylation of 1,3-dithianes), alkylation of dihydro-1,3-oxazine (the Meyers synthesis of aldehydes, ketones, and carboxylic acids), alkylation with trialkylboranes, alkylation at an alkynyl carbon, preparation of nitriles, direct conversion of alkyl halides to aldehydes and ketones, conversion of alkyl halides, alcohols, or alkanes to carboxylic acids and their derivatives, the conversion of acyl halides to ketones with organometallic compounds, the conversion of anhydrides, carboxylic esters, or amides to ketones with organometallic compounds, the coupling of acyl halides, acylation at a carbon bearing an active hydrogen, acylation of carboxylic esters by carboxylic esters (the Claisen and Dieckmann condensation), acylation of ketones and nitriles with carboxylic esters, acylation of carboxylic acid salts, preparation of acyl cyanides, and preparation of diazo ketones, ketonic decarboxylation.
Reactions which involve nucleophilic attack at a sulfonyl sulfur atom may also be used in the present invention and include, for example, hydrolysis of sulfonic acid derivatives (attack by OH), formation of sulfonic esters (attack by OR), formation of sulfonamides (attack by nitrogen), formation of sulfonyl halides (attack by halides), reduction of sulfonyl chlorides (attack by hydrogen), and preparation of sulfones (attack by carbon).
Aromatic electrophilic substitution reactions may also be used. Hydrogen exchange reactions are examples of aromatic electrophilic substitution reactions that use hydrogen as the electrophile. Aromatic electrophilic substitution, reactions which use nitrogen electrophiles include, for example, nitration and nitro-dehydrogenation, nitrosation of nitroso-de-hydrogenation, diazonium coupling, direct introduction of the diazonium group, and amination or amino-dehydrogenation. Reactions of this type with sulfur electrophiles include, for example, sulfonation, sulfo-dehydrogenation, halosulfonation, halosulfo-dehydrogenation, sulfurization, and sulfonylation. Reactions using halogen electrophiles include, for example, halogenation, and halo-dehydrogenation. Aromatic electrophilic substitution reactions with carbon electrophiles include, for example, Friedel-Crafts alkylation, alkylation, alkyl-dehydrogenation, Friedel-Crafts arylation (the Scholl reaction), Friedel-Crafts acylation, formylation with disubstituted formamides, formylation with zinc cyanide and HCl (the Gatterman reaction), formylation with chloroform (the Reimer-Tiemami reaction), other formylations, formyl-dehydrogenation, carboxylation with carbonyl halides, carboxylation with carbon dioxide (the Kolbe-Schmitt reaction), amidation with isocyanates, N-alkylcarbamoyl-dehydrogenation, hydroxyalkylation, hydroxyalkyl-dehydrogenation, cyclodehydration of aldehydes and ketones, haloalkylation, halo-dehydrogenation, aminoalkylation, amidoalkylation, dialkylaminoalkylation, dialkylamino-dehydrogenation, thioalkylation, acylation with nitriles (the Hoesch reaction), cyanation, and cyano-de hydrogenation. Reactions using oxygen electrophiles include, for example, hydroxylation and hydroxy-dehydrogenation.
Rearrangement reactions include, for example, the Fries rearrangement, migration of a nitro group, migration of a nitroso group (the Fischer-Hepp Rearrangement), migration of an arylazo group, migration of a halogen (the Orton rearrangement), migration of an alkyl group, etc. Other reaction on an aromatic ring include the reversal of a Friedel-Crafts alkylation, decarboxylation of aromatic aldehydes, decarboxylation of aromatic acids, the Jacobsen reaction, deoxygenation, desulfonation, hydro-desulfonation, dehalogenation, hydro-dehalogenation, and hydrolysis of organometallic compounds.
Aliphatic electrophilic substitution reactions are also useful. Reactions using the SEI, SE2 (front), SE2 (back), SEi, addition-elimination, and cyclic mechanisms can be used in the present invention. Reactions of this type with hydrogen as the leaving group include, for example, hydrogen exchange (deuterio-de-hydrogenation, deuteriation), migration of a double bond, and keto-enol tautomerization. Reactions with halogen electrophiles include, for example, halogenation of aldehydes and ketones, halogenation of carboxylic acids and acyl halides, and halogenation of sulfoxides and sulfones. Reactions with nitrogen electrophiles include, for example, aliphatic diazonium coupling, nitrosation at a carbon bearing an active hydrogen, direct formation of diazo compounds, conversion of amides to alpha-azido amides, direct amination at an activated position, and insertion by nitrenes. Reactions with sulfur or selenium electrophiles include, for example, sulfenylation, sulfonation, and selenylation of ketones and carboxylic esters. Reactions with carbon electrophiles include, for example, acylation at an aliphatic carbon, conversion of aldehydes to beta-keto esters or ketones, cyanation, cyano-de-hydrogenation, alkylation of alkanes, the Stork enamine reaction, and insertion by carbenes. Reactions with metal electrophiles include, for example, metalation with organometallic compounds, metalation with metals and strong bases, and conversion of enolates to silyl enol ethers. Aliphatic electrophilic substitution reactions with metals as leaving groups include, for example, replacement of metals by hydrogen, reactions between organometallic reagents and oxygen, reactions between organometallic reagents and peroxides, oxidation of trialkylboranes to borates, conversion of Grignard reagents to sulfur compounds, halo-demetalation, the conversion of organometallic compounds to amines, the conversion of organometallic compounds to ketones, aldehydes, carboxylic esters and amides, cyano-de-metalation, transmetalation with a metal, transmetalation with a metal halide, transmetalation with an organometallic compound, reduction of alkyl halides, metallo-de-halogenation, replacement of a halogen by a metal from an organometallic compound, decarboxylation of aliphatic acids, cleavage of alkoxides, replacement of a carboxyl group by an acyl group, basic cleavage of beta-keto esters and beta-diketones, haloform reaction, cleavage of non-enolizable ketones, the Haller-Bauer reaction, cleavage of alkanes, decyanation, and hydro-de-cyanation. Electrophilic substitution reactions at nitrogen include, for example, diazotization, conversion of hydrazines to azides, N-nitrosation, N-nitroso-de-hydrogenation, conversion of amines to azo compounds, N-halogenation, N-halo-de-hydrogenation, reactions of amines with carbon monoxide, and reactions of amines with carbon dioxide.
Aromatic nudeophilic substitution reactions may also be used in the present invention. Reactions proceeding via the SNAr mechanism, the SNI mechanism, the benzyne mechanism, the SRN1 mechanism, or other mechanism, for example, can be used. Aromatic nudeophilic substitution reactions with oxygen nucleophiles include, for example, hydroxy-de-halogenation, alkali fusion of sulfonate salts, and replacement of OR or OAr. Reactions with sulfur nucleophiles include, for example, replacement by SH or SR. Reactions using nitrogen nucleophiles include, for example, replacement by NH2, NHR, or NR2, and replacement of a hydroxy group by an amino group: Reactions with halogen nucleophiles include, for example, the introduction halogens. Aromatic nudeophilic substitution reactions with hydrogen as the nucleophile include, for example, reduction of phenols and phenolic esters and ethers, and reduction of halides and nitro compounds. Reactions with carbon nucleophiles include, for example, the Rosenmund-von Braun reaction, coupling of organometallic compounds with aryl halides, ethers, and carboxylic esters, arylation at a carbon containing an active hydrogen, conversions of aryl substrates to carboxylic acids, their derivatives, aldehydes, and ketones, and the Ullmann reaction. Reactions with hydrogen as the leaving group include, for example, alkylation, arylation, and amination of nitrogen heterocycles. Reactions with N2+ as the leaving group include, for example, hydroxy-de-diazoniation, replacement by sulfur-containing groups, iodo-de-diazoniation, and the Schiemann reaction. Rearrangement reactions include, for example, the von Richter rearrangement, the Sommelet-Hauser rearrangement, rearrangement of aryl hydroxylamines, and the Smiles rearrangement. Reactions involving free radicals can also be used, although the free radical reactions used in nudeotide-templated chemistry should be carefully chosen to avoid modification or cleavage of the nucleotide template. With that limitation, free radical substitution reactions can be used in the present invention. Particular free radical substitution reactions include, for example, substitution by halogen, halogenation at an alkyl carbon, allylic halogenation, benzylic halogenation, halogenation of aldehydes, hydroxylation at an aliphatic carbon, hydroxylation at an aromatic carbon, oxidation of aldehydes to carboxylic acids, formation of cyclic ethers, formation of hydroperoxides, formation of peroxides, acyloxylation, acyloxy-de-hydrogenation, chlorosulfonation, nitration of alkanes, direct conversion of aldehydes to amides, amidation and amination at an alkyl carbon, simple coupling at a susceptible position, coupling of alkynes, arylation of aromatic compounds by diazonium salts, arylation of activated alkenes by diazonium salts (the Meerwein arylation), arylation and alkylation of alkenes by organopalladium compounds (the Heck reaction), arylation and alkylation of alkenes by vinyltin compounds (the StHle reaction), alkylation and arylation of aromatic compounds by peroxides, photochemical arylation of aromatic compounds, alkylation, acylation, and carbalkoxylation of nitrogen heterocydes. Particular reactions in which N2+ is the leaving group include, for example, replacement of the diazonium group by hydrogen, replacement of the diazonium group by chlorine or bromine, nitro-de-diazoniation, replacement of the diazonium group by sulfur-containing groups, aryl dimerization with diazonium salts, methylation of diazonium salts, vinylation of diazonium salts, arylation of diazonium salts, and conversion of diazonium salts to aldehydes, ketones, or carboxylic acids. Free radical substitution reactions with metals as leaving groups include, for example, coupling of Grignard reagents, coupling of boranes, and coupling of other organometallic reagents. Reaction with halogen as the leaving group are included. Other free radical substitution reactions with various leaving groups include, for example, desulfurization with Raney Nickel, conversion of sulfides to organolithium compounds, decarboxylase dimerization (the Kolbe reaction), the Hunsdiecker reaction, decarboxylative allylation, and decarbonylation of aldehydes and acyl halides.
Reactions involving additions to carbon-carbon multiple bonds are also used. Any mechanism may be used in the addition reaction including, for example, electrophilic addition, nucleophilic addition, free radical addition, and cyclic mechanisms. Reactions involving additions to conjugated systems can also be used. Addition to cyclopropane rings can also be utilized. Particular reactions include, for example, isomerization, addition of hydrogen halides, hydration of double bonds, hydration of triple bonds, addition of alcohols, addition of carboxylic acids, addition of H2S and thiols, addition of ammonia and amines, addition of amides, addition of hydrazoic acid, hydrogenation of double and triple bonds, other reduction of double and triple bonds, reduction of the double and triple bonds of conjugated systems, hydrogenation of aromatic rings, reductive cleavage of cyclopropanes, hydroboration, other hydrometalations, addition of alkanes, addition of alkenes and/or alkynes to alkenes and/or alkynes (e.g., pi-cation cyclization reactions, hydro-alkenyl-addition), ene reactions, the Michael reaction, addition of organometallics to double and triple bonds not conjugated to carbonyls, the addition of two alkyl groups to an alkyne, 1,4-addition of organometallic compounds to activated double bonds, addition of boranes to activated double bonds, addition of tin and mercury hydrides to activated double bonds, acylation of activated double bonds and of triple bonds, addition of alcohols, amines, carboxylic esters, aldehydes, etc., carbonylation of double and triple bonds, hydrocarboxylation, hydroformylation, addition of aldehydes, addition of HCN, addition of silanes, radical addition, radical cydization, halogenation of double and triple bonds (addition of halogen, halogen), halolactonization, halolactamization, addition of hypohalous acids and hypohalites (addition of halogen, oxygen), addition of sulfur compounds (addition of halogen, sulfur), addition of halogen and an amino group (addition of halogen, nitrogen), addition of NOX and NO2X (addition of halogen, nitrogen), addition of XN3 (addition of halogen, nitrogen), addition of alkyl halides (addition of halogen, carbon), addition of acyl halides (addition of halogen, carbon), hydroxylation (addition of oxygen, oxygen) (e.g., asymmetric dihydroxylation reaction with OSO4), dihydroxylation of aromatic rings, epoxidation (addition of oxygen, oxygen) (e.g., Sharpless asymmetric epoxidation), photooxidation of dienes (addition of oxygen, oxygen), hydroxysulfenylation (addition of oxygen, sulfur), oxyamination (addition of oxygen, nitrogen), diamination (addition of nitrogen, nitrogen), formation of aziridines (addition of nitrogen), aminosulferiylation (addition of nitrogen, sulfur), acylacyloxylation and acylamidation (addition of oxygen, carbon or nitrogen, carbon), 1,3-dipolar addition; (addition of oxygen, nitrogen, carbon), Diels-Alder reaction, heteroatom Diels-Alder reaction, all carbon 3+2 cycloadditions, dimerization of alkenes, the addition of carbenes and carbenoids to double and triple bonds, trimerization and tetramerization of alkynes, and other cycloaddition reactions.
In addition to reactions involving additions to carbon-carbon multiple bonds, addition reactions to carbon-hetero multiple bonds can be used in nucleotide-templated chemistry. Exemplary reactions include, for example, the addition of water to aldehydes and ketones (formation of hydrates), hydrolysis of carbon-nitrogen double bond, hydrolysis of aliphatic nitro compounds, hydrolysis of nitriles, addition of alcohols and thiols to aldehydes and ketones, reductive alkylation of alcohols, addition of alcohols to isocyanates, alcoholysis of nitriles, formation of xanthates, addition of H2S and thiols to carbonyl compounds, formation of bisulfite addition products, addition of amines to aldehydes and ketones, addition of amides to aldehydes, reductive alkylation of ammonia or amines, the Mannich reaction, the addition of amines to isocyanates, addition of ammonia or amines to nitriles, addition of amines to carbon disulfide and carbon dioxide, addition of hydrazine derivative to carbonyl compounds, formation of oximes, conversion of aldehydes to nitriles, formation of gem-dihalides from aldehydes and ketones, reduction of aldehydes and ketones to alcohols, reduction of the carbon-nitrogen double bond, reduction of nitriles to amines, reduction of nitriles to aldehydes, addition of Grignard reagents and organolithium reagents to aldehydes and ketones, addition of other organometallics to aldehydes and ketones, addition of trialkylallylsilanes to aldehydes and ketones, addition of conjugated alkenes to aldehydes (the Baylis-Billmah reaction), the Reformatsky reaction, the conversion of carboxylic acid salts to ketones with organometallic compounds, the addition of Grignard reagents to acid derivatives, the addition of Organometallic compounds to CO2 and CS2, addition of organometallic compounds to C=IM compounds, addition of carbenes and diazoalkanbs to C═N compounds, addition of Grignard reagents to nitriles and isocyanates, the Aldol reaction, Mukaiyama Aldol and related reactions, Aldol-type reactions between carboxylic esters or amides and aldehydes or ketones, the Knoevenagel reaction (e.g., the Nef reaction, the Favorskii reaction), the Peterson alkenylation reaction, the addition of active hydrogen compounds to CO2 and CS2, the Perkin reaction, Darzens glycidic ester condensation, the Tollens reaction, the Wittig reaction, the Tebbe alkenylation, the Petasis alkenylation, alternative alkenylations, the Thorpe reaction, the Thorpe-Ziegler reaction, addition of silanes, formation of cyanohydrins, addition of HCN to C═N and C—N bonds, the Prins reaction, the benzoin condensation, addition of radicals to C═O, C═S, C═N compounds, the Ritter reaction, acylation of aldehydes and ketones, addition of aldehydes to aldehydes, the addition of isocyanates to isocyanates (formation of carbodiimides), the conversion of carboxylic acid salts to nitriles, the formation of epoxides from aldehydes and ketones, the formation of episulfides and episulfones, the formation of beta-lactones and oxetanes (e.g., the Paterno-Buchi reaction), the formation of beta-lactams, etc. Reactions involving addition to isocyanides include the addition of water to isocyanides, the Passerini reaction, the Ug reaction, and the formation of metalated aldimines.
Elimination reactions, including alpha, beta, and gamma eliminations, as well as extrusion reactions, can be performed using nucleotide-templated chemistry, although the strength of the reagents and conditions employed should be considered. Preferred elimination reactions include reactions that go by EI, E2, EIcB, or E2C mechanisms. Exemplary reactions include, for example, reactions in which hydrogen is removed from one side (e.g., dehydration of alcohols, cleavage of ethers to alkenes, the Chugaev reaction, ester decomposition, cleavage of quarternary ammonium hydroxides, cleavage of quaternary ammonium salts with strong bases, cleavage of amine oxides, pyrolysis of keto-ylids, decomposition of toluene-p-sulfonylhydrazones, cleavage of sulfoxides, cleavage of selenoxides, cleavage of sulfornes, dehydrogalogenation of alkyl halides, dehydrohalogenation of acyl halides, dehydrohalogenation of sulfonyl halides, elimination of boranes, conversion of alkenes to alkynes, decarbonylation of acyl halides), reactions in which neither leaving atom is hydrogen (e.g., deoxygenation of vicinal diols, cleavage of cyclic thionocarbonates, conversion of epoxides to episulfides and alkenes, the Ramberg-Backlund reaction, conversion of aziridines to alkenes, dehalogenation of vicinal dihalides, dehalogenation of alpha-halo acyl halides, and elimination of a halogen and a hetero group), fragmentation reactions (i.e., reactions in which carbon is the positive leaving group or the electrofuge, such as, for example, fragmentation of gamma-amino and gamma-hydroxy halides, fragmentation of 1,3-diols, decarboxylation of beta-hydroxy carboxylic acids, decarboxylation of (3-lactones, fragmentation of alpha-beta-epoxy hydrazones, elimination of CO from bridged bicydic compounds, and elimination Of CO2 from bridged bicydic compounds), reactions in which C═N or C═N bonds are formed (e.g., dehydration of aldoximes or similar compounds, conversion of ketoximes to nitriles, dehydration of unsubstituted amides, and conversion of l\l-alkylformamides to isocyanides), reactions in which C═O bonds are formed (e.g., pyrolysis of beta-hydroxy alkenes), and reactions in which N═N bonds are formed (e.g., eliminations to give diazoalkenes). Extrusion reactions include, for example, extrusion of N2 from pyrazolines, extrusion of N2 from pyrazoles, extrusion of N2 from triazolines, extrusion of CO, extrusion Of CO2, extrusion Of SO2, the Story synthesis, and alkene synthesis by twofold extrusion.
Rearrangements, including, for example, nudeophilic rearrangements, electrophilic rearrangements, prototropic rearrangements, and free-radical rearrangements, can also be performed. Both 1,2 rearrangements and non-1,2 rearrangements can be performed. Exemplary reactions include, for example, carbon-to-carbon migrations of R, H, and Ar (e.g., Wagner-Meerwein and related reactions, the Pinacol rearrangement, ring expansion reactions, ring contraction reactions, acid-catalyzed rearrangements of aldehydes and ketones, the dienone-phenol rearrangement, the Favorskii rearrangement, the Arndt-Eistert synthesis, homologation of aldehydes, and homologation of ketones), carbon-to-carbon migrations of other groups (e.g., migrations of halogen, hydroxyl, amino, etc.; migration of boron; and the Neber rearrangement), carbon-to-nitrogen migrations of R and Ar (e.g., the Hofmann rearrangement, the Curtius rearrangement, the Lossen rearrangement, the Schmidt reaction, the Beckman rearrangement, the Stieglits rearrangement, and related rearrangements), carbon-to-oxygen migrations of R and Ar (e.g., the Baeyer-Villiger rearrangement and rearrangment of hydroperoxides), nitrogen-to-carbon, oxygen-to-carbon, and sulfur-to-carbon migration (e.g., the Stevens rearrangement, and the Wittig rearrangement), boron-to-carbon migrations (e.g., conversion of boranes to alcohols (primary or otherwise), conversion of boranes to aldehydes, conversion of boranes to carboxylic acids, conversion of vinylic boranes to alkenes, formation of alkynes from boranes and acetylides, formation of alkenes from boranes and acetylides, and formation of ketones from boranes and acetylides), electrocyclic rearrangements (e.g., of cydobutenes and 1,3-cyclohexadienes, or conversion of stilbenes to phenanthrenes), sigmatropic rearrangements (e.g., (1,j) sigmatropic migrations of hydrogen, (Ij) sigmatropic migrations of carbon, conversion of vinylcydopropanes to cyclopentenes, the Cope rearrangement, the Claisen rearrangement, the Fischer indole synthesis, (2,3) sigmatropic rearrangements, and the benzidine rearrangement), other cyclic rearrangements (e.g., metathesis of alkenes, the di-n-methane and related rearrangements, and the Hofmann-Loffler and related reactions), and non-cyclic rearrangements (e.g., hydride shifts, the Chapman rearrangement, the Wallach rearrangement, and dybtropic rearrangements).
Oxidative and reductive reactions may also be performed. Exemplary reactions may involve, for example, direct electron transfer, hydride transfer, hydrogen-atom transfer, formation of ester intermediates, displacement mechanisms, or addition-elimination mechanisms. Exemplary oxidations include, for example, eliminations of hydrogen (e.g., aromatization of six-membered rings, dehydrogenations yielding carbon-carbon double bonds, oxidation or dehydrogenation of alcohols to aldehydes and ketones, oxidation of phenols and aromatic amines to quinones, oxidative cleavage of ketones, oxidative cleavage of aldehydes, oxidative cleavage of alcohols, ozonolysis, oxidative cleavage of double bonds and aromatic rings, oxidation of aromatic side chains, oxidative decarboxylation, and bisdecarboxylation), reactions involving replacement of hydrogen by oxygen (e.g., oxidation of methylene to carbonyl, oxidation of methylene to OH, CO2R, or OR, oxidation of arylmethanes, oxidation of ethers to carboxylic esters and related reactions, oxidation of aromatic hydrocarbons to quinones, oxidation of amines or nitro compounds to aldehydes, ketones, or dihalides, oxidation of primary alcohols to carboxylic acids or carboxylic esters, oxidation of alkenes to aldehydes or ketones, oxidation of amines to nitroso compounds and hydroxylamines, oxidation of primary amines, oximes, azides, isocyanates, or nitroso compounds, to nitro compounds, oxidation of thiols and other sulfur compounds to sulfonic acids), reactions in which oxygen is added to the subtrate (e.g., oxidation of alkynes to alpha-diketones, oxidation of tertiary amines to amine oxides, oxidation of thioesters to sulfoxides and sulfones, and oxidation of carboxylic acids to peroxy acids, and oxidative coupling reactions (e.g., coupling involving carbanoins, dimerization of silyl enol ethers or of lithium enolates, and oxidation of thiols to disulfides). Exemplary reductive reactions include, for example, reactions involving replacement of oxygen by hydrogen {e.g., reduction of carbonyl to methylene in aldehydes and ketones, reduction of carboxylic acids to alcohols, reduction of amides to amines, reduction of carboxylic esters to ethers, reduction of cyclic anhydrides to lactones and acid derivatives to alcohols, reduction of carboxylic esters to alcohols, reduction of carboxylic acids and esters to alkanes, complete reduction of epoxides, reduction of nitro compounds to amines, reduction of nitro compounds to hydroxylamines, reduction of nitroso compounds and hydroxylamines to amines, reduction of oximes to primary amines or aziridines, reduction of azides to primary amines, reduction of nitrogen compounds, and reduction of sulfonyl halides and sulfonic acids to thiols), removal of oxygen from the substrate {e.g., reduction of amine oxides and azoxy compounds, reduction of sulfoxides and sulfones, reduction of hydroperoxides and peroxides, and reduction of aliphatic nitro compounds to oximes or nitrites), reductions that include cleavage {e.g., de-alkylation of amines and amides, reduction of azo, azoxy, and hydrazo compounds to amines, and reduction of disulfides to thiols), reductive coupling reactions {e.g., bimolecular reduction of aldehydes and ketones to 1,2-diols, bimolecular reduction of aldehydes or ketones to alkenes, acyloin ester condensation, reduction of nitro to azoxy compounds, and reduction of nitro to azo compounds), and. reductions in which an organic substrate is both oxidized and reduced {e.g., the Cannizzaro reaction, the Tishchenko reaction, the Pummerer rearrangement, and the Willgerodt reaction).

Covalent bonds relevant for the present invention, including those formed above, are listed in the following.

### Group 8: Covalent Bonds.

A single bond, such as a single carbon-carbon bond, a carbon-heteroatom single bond, a heteroatom-heteroatom single bond, a double bond, such as a carbon-carbon double bond or a carbon-heteroatom double bond, a heteroatom-heteroatom double, bond, triple bond, such as a carbon-carbon triple bond or a carbon-heteroatom triple bond, a heteroatom-heteroatom triple bond, —CH2-, —C(O)—, —NH—, —O—, —S—, —SO2-, —CH2CH2-, —C(O)CH2-, —CH2C(O)—, —NHCH2-, —CH2NH—, —OCH2-, —CH2O—, —SCH2-, —CH2S—, —SO2CH2-, —CH2SO2-, —NHC(O)—, —C(O)NH—, —NHSO2-, —SO2NH—, —CH2CH2CH2-, —CH2CH2C(O)—, —CH2CH2NH—, —CH2CH2O—, —CH2CH₂S—, —CH2CH2SO2-, —CH2C(O)CH2-, —CH2NHCH2-, —CH2OCH2-, —CH2SCH2-, —CH2SO2CH2-, —C(O)CH2CH2-, —NHCH2CH2-, -OCH2CH2-, —SCH2CH2-, —SO2CH2CH2-, —CH2C(O)NH—, —CH2SO2NH—, —CH2NHC(O)—, —CH2NHSO2-, —C(O)NHCH2-, —SO2NHCH2-, —NHC(O)CH2-, —NHSO2CH2-, and —NHC(O)NH—

### Linkers.

A linker may consist of just one bond, or a number of covalent and/or non-covalent bonds. A linker may have any length. A longer and more flexible linker will more easily allow the precursor-MLs, MLs and Ligand2s and SEs to interact independently of the linker; however, a short linker connecting two precursor-MLs, MLs or Ligand2s bound to the same SE may result in high synergy in the binding of the two precursor-MLs, MLs or Ligand2s to the same SE—but may also interfere with efficient binding of the two precursor-MLs, MLs and Ligand2s because of linker constraints and/or inappropriate orientation of the interacting molecules. Thus, in some cases a short linker is preferable; in other cases a long linker is preferable. The linker may thus have a length of 0.1-100,000 nm, such as in the ranges of 0.1-0.4 nm, 0.4-1 nm, 1-2 nm, 2-4 nm, 4-8 nm, 8-15 nm, 15-25 nm, 25-40 nm, 40-100 nm, 100-200 nm, 200-500 nm, 500-1,000 nm, 1,000-10,000 nm, or 10,000-100,000 nm, or larger.

In a preferred embodiment the linker has a length of less than 1 μm, such as less than 100 nm, such as less than 50 nm, such as less than 40 nm, such as less than 30, such as less than 25 nm, such as less than 20 nm, such as less than 15 nm, such as less than 10 nm, such as less than 5 nm, such as less than 2 nm, such as less than 1 nm, such as less than 0.7 nm, such as less than 0.5 nm, such as less than 0.2 nm. Shorter linker lengths will often result in composite materials with higher tensile strength, wherefore it may be desirable to use shorter linkers to obtain higher strength of the composite material. In another preferred embodiment the linker has a length of more than 0.1 nm, such as more than 0.2 nm, such as more than 0.3 nm, such as more than 0.6 nm, such as more than 0.8 nm, such as more than 1 nm, such as more than 2 nm, such as more than 4 nm, such as more than 6 nm, such as more than 8 nm, such as more than 12 nm, such as more than 15 nm, such as more than 20 nm, such as more than 25 nm, such as more than 50 nm, such as more than 80 nm, such as more than 100 nm, such as more than 200 nm, such as more than 500 nm, such as more than 1 μm, such as more than 5 μm. Longer linkers will often lead to composite materials with higher flexibility, wherefore it may be desirable to increase the length of the linker if a higher flexibility is desired.

Shorter linker lengths may result in composite materials with higher tensile strength, and longer linkers may result in increased flexibility of the composite material. Therefore, the appropriate compromise between strength and flexibility of a composite material may be obtained by appropriate choice of linker length. In a preferred embodiment the linker length is between 1 and 10 nm, less preferably between 0.5 nm and 25 nm, as this linker length often is a good compromise between flexibility and strength of the composite material.

A linker may connect two, three, four or more precursor-MLs, MLs or Ligand2s. Thus, the linker may be linear (connecting two precursor-MLs, MLs or Ligand2s) or may be branched (connecting three or more precursor-MLs, MLs and Ligand2s).

Example linkers are organic molecules such as consisting of alkanes or alkenes, or polyvinyl, polypropylene, ethylene glycol, and the linkers may consist of just one element (e.g. carbon) or several elements (e.g. C, O, N).

A linker may comprise or consist of any polymer mentioned above or below, or may comprise or consist of any part of any polymer mentioned above or below, such as any number of repeating units of any polymer mentioned above or below, such as e.g. one, two, three, four or more repeating units of any polymer mentioned above or below.

### Group 9: Linkers.

The following is a non-comprehensive list of linkers: alkanes, alkenes, alkynes or combinations thereof (C1, C2, C3, C4, C5, C6, C7, C8, C9, C10, C12, C13, C14, C15, C16, C17, C18, C19, C20) and any other alkane, alkene, alkyne or combinations thereof comprising between 20 and 30 carbon atoms, or between 30 and 40 carbon atoms, or between 40 and 50 carbon atoms, or more than 50 carbon atoms; polyethylene glycol.

Any of the structural entities listed above or below may also be used as a linker.

The linkers may be modified. The modifications may be added to the linker before, after or during synthesis of the composite material unit or composite material. The modification may involve covalent attachment of aromatic or aliphatic rings, charged or polar groups such as NH2, CO, COOH, and COSH.

Ideally, the chemical and physical characteristics of the linker should be similar to at least some of the characteristics of the structural entities of the CMU, in order to prepare composite materials where the characteristics of the matrix material and the additive are not significantly perturbed by the presence of the linker. However, under certain circumstances, such as for example when using carbon nanotubes as the additive, using processes and conditions under which e.g. solubility of the carbon nanotubes in the solution or matrix material is low, the linker may due to its solubility characteristics help make the carbon nanotube more soluble, because the linker becomes bound to the carbon nanotube by way of the precursor-ML, ML and/or Ligand2s.

### CMUs—Combination of SE1, ML, Linker, Ligand2, and SE2.

A composite material unit (CMU) comprises a first structural entity (SE1), a mechanical ligand (ML), a Linker, a Ligand (Ligand2), and a second structural entity (SE2). Preferred CMUs of the present invention include anyone of the following CMUs, here identified as any specific combination of said first structural entity (SE1), ML, Linker, Ligand2, and second structural entity (SE2):
SE1-ML-Linker-Ligand2-SE2 (a CMU)
where SE1 is any specific Structural Entity, or any specific type of Structural Entity, listed above or below;
where ML is any specific mechanical ligand, or any specific type of mechanical ligand, listed above or below;
where Linker is any specific Linker, or any specific type of Linker, listed above or below; where Ligand2 is any specific Ligand2, or any specific type of Ligand2, listed above or below;
and where SE2 is any specific Structural Entity, or any specific type of Structural Entity, listed above or below.

What is further provided is a polymeric structure of CMUs, consisting of a number of repeats of the structure SE1-ML-Linker-Ligand2-SE2-Ligand2-Linker-ML-SE1. Thus, the overall structure of said polymeric structure of CMUs is (SE1-ML-Linker-Ligand2-SE2-Ligand2-Linker-ML-)ₙSE1, where n is an integer larger than zero.

For n=1, the polymeric structure of CMUs is thus described by the structure -SE1-ML-Linker-Ligand2-SE2-Ligand2-Linker-ML-SE1.

For n=2, the polymeric structure of CMUs is thus described by the structure SE1-ML-Linker-Ligand2-SE2-Ligand2-Linker-ML-SE1-ML-Linker-Ligand2-SE2-Ligand2-Linker-ML-SE1.

For n=3, the polymeric structure of CMUs is thus described by the structure SE1-ML-Linker-Ligand2-SE2-Ligand2-Linker-ML-SE1-ML-Linker-Ligand2-SE2-Ligand2-Linker-ML-SE1-ML-Linker-Ligand2-SE2-Ligand2-Linker-ML-SE1.

For n=5, the polymeric structure of CMUs is thus described by the structure SE1-ML-Linker-Ligand2-SE2-Ligand2-Linker-ML-SE1-ML-Linker-Ligand2-SE2-Ligand2-Linker-ML-SE1-ML-Linker-Ligand2-SE2-Ligand2-Linker-ML-SE1-ML-Linker-Ligand2-SE2-Ligand2-Linker-ML-SE1-ML-Linker-Ligand2-SE2-Ligand2-Linker-ML-SE1.

Preferred polymeric structures of CMUs are the polymeric structures where SE1 is a carbon nanotube, and n=1, 2, 3, 4, 5, 6, 7, 8, 9, 10-20, 20-100, or 100-1000, or higher.

Other preferred polymeric structures of CMUs are the polymeric structures where SE1 is a nanotube, and n=1, 2, 3, 4, 5, 6, 7, 8, 9, 10-20, 20-100, or 100-1000, or higher.

Other preferred polymeric structures of CMUs are the polymeric structures where SE1 is a nanotube or graphene, SE2 is a nanotube or graphene, and n=1, 2, 3, 4, 5, 6, 7, 8, 9, 10-20, 20-100, or 100-1000, or higher.

Other preferred polymeric structures of CMUs are the polymeric structures where SE1 is a nanotube, SE2 is a plast polymer, and n=1, 2, 3, 4, 5, 6, 7, 8, 9, 10-20, 20-100, or 100-1000, or higher.

Other preferred polymeric structures of CMU are the polymeric structures where SE1 is a carbon nanotube, SE2 is not a carbon nanotube, and the number of repeats is two or higher.

### Methods of Preparing Composite Material Units and Composite Materials.

The individual components of the composite material units (CMU), i.e. the structural entities (SEs), the MLs, Ligand2s, and the linker(s), may be synthesized before, during or after linking the SE, ML, Ligand2, and linker(s).

The following three processes for the synthesis of reinforced polymers (composite materials comprising a polymer component and an additive) are examples of processes where the individual components of the CMU are prepared before, during or after linking its SEs, linker(s), Ligand2 and ML:

Solution mixing: The additive (e.g. a nanotube dispersion) is mixed with a solution of preformed polymer (e.g. polyvinyl alcohol, polystyrene, polycarbonate, or poly(methyl methacrylate)) and precursor-MLs, MLs and/or Ligand2s and linker(s). CMUs will now form in the solution, whereafter the solvents are evaporated, leaving the reinforced polymer as a solid material. In this approach, the linker, precursor-ML or ML, Ligand2, polymer, and structural entities (polymer and additive) may associate during incubation in solvent, or may be partly associated prior to their mixing with the other components.

Melt processing: This process employs thermoplastic polymers (e.g. high-impact polystyrene, acrylonitrile-butadiene-styrene, polypropylene) that soften and melt when heated. The preformed, thermoplastic polymers are melted and then mixed with precursor-MLs, MLs and/or Ligand2slinkers and additive(s). Upon lowering of the temperature, and optionally fibre-spinning, melt-spinning, extrusion or other relevant process, reinforced polymers of desired characteristics are formed. As for solution mixing, the linker, precursor-ML, ML, Ligand2, polymer, and structural entities (polymer and additive) may associate during incubation, or may be partly associated prior to their mixing with the other components.

In situ polymerization: In this process, the monomer(s) rather than the polymer(s) are used as starting material, whereafter the polymerization is carried out in situ. Thus, the additive is mixed with the monomer (e.g. epoxy resin), linkers and precursor-MLs, MLs and/or Ligand2s. As for the two processes described immediately above, the linker and precursor-MLs, MLs and/or Ligand2s may be preformed as one moiety which is then added to the polymerization mixture. In the example of a reinforced epoxy, one would therefore use an excess of the non-modified epoxy resin, plus a modified epoxy resin which had been coupled to a precursor-ML, ML and/or Ligand2s capable of binding the additive in question.

Precursor-MLs, MLs and Ligand2s, linkers and SEs suitable for the present invention include small compact molecules, linear structures, polymers, polypeptides, poly-ureas, polycarbamates, scaffold structures, cyclic structures, natural compound derivatives, alpha-, beta-, gamma-, and omega-peptides, mono-, di- and tri-substituted peptides, L- and D-form peptides, cyclohexane- and cydopentane-backbone modified beta-peptides, vinylogous polypeptides, glycopolypeptides, polyamides, vinylogous sulfonamide peptide, Polysulfonamide conjugated peptide (i.e., having prosthetic groups), Polyesters, Polysaccharides, polycarbamates, polycarbonates, polyureas, poly-peptidylphosphonates, Azatides, peptoids (oligo N-substituted glycines), Polyethers, ethoxyformacetal oligomers, poly-thioethers, polyethylene, glycols (PEG), polyethylenes, polydisulfides, polyarylene sulfides, Polynucleotides, PNAs, LNAs, Morpholinos, oligo pyrrolinone, polyoximes, Polyimines, Polyethyleneimine, Polyacetates, Polystyrenes, Polyacetylene, Polyvinyl, Lipids, Phospholipids, Glycolipids, poiycycles, (aliphatic), polycycles (aromatic), polyheterocydes, Proteoglycan, Polysiloxanes, Polyisocyanides, Polyisocyanates, polymethacryiates, Monofunctional, Difunctional, Trifunctional and Oligofunctional open-chain hydrocarbons. Monofunctional, Difunctional, Trifunctional and Oligofunctional Nonaromatic Carbocycles, Monocyclic, Bicyclic, Tricyclic and Polycydic Hydrocarbons, Bridged Polycyclic Hydrocarbones, Monofunctional, Difunctional, Trifunctional and Oligofunctional Nonaromatic, Heterocycles, Monocyclic, Bicydic, Tricyclic and Polycyclic Heterocycles, bridged Polycyclic Heterocycles, Monofunctional, Difunctional, Trifunctional and Oligofunctional Aromatic Carbocycles. Monocyclic, Bicydic, Tricyclic and Polycyclic Aromatic Carbocycles.

Monofunctional, Difunctional, Trifunctional and Oligofunctional Aromatic Hetero-cycles. Monocyclic, Bicydic, Tricyclic and Polycyclic Heterocycles. Chelates, fullerenes, and any combination of the above.

In preferred embodiments, the structural entity, the precursor-ML, ML or Ligand2, the linker or the composite material comprises one or more entities chosen from the list comprising:

Aluminium antimonide—AlSb, Aluminium arsenide—AlAs, Aluminium chloride—AlCl3, Aluminium fluoride—AlF3, Aluminium hydroxide—Al(OH)3, Aluminium nitrate—Al(NO3)3, Aluminium nitride—AlN, Aluminium oxide—Al2O3, Aluminium phosphide—AIP, Aluminium sulfate—Al2(SO4)3, Ammonia—NH3, Ammonium bicarbonate—NH4HCO3, Ammonium cerium(IV) nitrate—(NH4)2Ce(NO3)6, Ammonium chloride—NH4Cl, Ammonium hydroxide NH4OH, Ammonium nitrate—NH4NO3, Ammonium sulfate—(NH4)2SO4, Ammonium tetrathiocyanatodiamminechromate(III)—NH4[Cr(SCN)4(NH3)2], Antimony hydride—SbH3, Antimony pentachloride—SbCl5, Antimony pentafluoride—SbF5, Antimony trioxide—Sb2O3, Arsenic trioxide (Arsenic(III) oxide)—As2O3, Arsenous acid—As(OH)3, Arsine—AsH3, Baking soda—NaHCO3, Barium chloride—BaCl2, Barium chromate—BaCrO4, Barium hydroxide—Ba(OH)2, Barium iodide—BaI2, Barium nitrate—Ba(NO3)2, Barium sulfate—BaSO4, Barium titanate—BaTiO3, Beryllium borohydride—Be(BH4)2, Beryllium bromide—BeBr2, Beryllium carbonate—BeCO3, Beryllium chloride—BeCl2, Beryllium fluoride—BeF2, Beryllium hydride—BeH2, Beryllium hydroxide—Be(OH)2, Beryllium iodide BeI2, Beryllium nitrate—Be(NO3)2, Beryllium nitride—Be3N2, Beryllium oxide—BeO, Beryllium sulfate—BeSO4, Beryllium sulfite—BeSO3, Beryllium telluride—BeTe, Bismuth(III) oxide—Bi2O3, Bismuth(III) telluride—Bi2Te3, Borane—Diborane: B2H6, Pentaborane: B5H9 Decaborane: B10H14, Borax—Na2B4O7·10H2O, Boric acid—H3BO3, Boron carbide—B4C, Boron nitride—BN, Boron oxide—B2O3, Boron suboxide—B6O, Boron trichloride—BCl3, Boron trifluoride—BF3, Bromine pentafluoride—BrF5, Bromine trifluoride—BrF3, Cacodylic acid—(CH3)2AsO2H, Cadmium arsenide—Cd3As2, Cadmium bromide—CdBr2, Cadmium chloride—CdCl2, Cadmium fluoride—CdF2, Cadmium iodide—Cdl2, Cadmium nitrate—Cd(NO3)2, Cadmium selenide—CdSe (of quantum dot fame), Cadmium sulfate—CdSO4, Cadmium telluride—CdTe, Caesium bicarbonate—CsHCO3, Caesium carbonate—Cs2CO3, Caesium chloride—CsCl, Caesium chromate—Cs2CrO4, Caesium fluoride—CsF, Caesium hydride—CsH, Calcium carbide—CaC2, Calcium chlorate Ca(ClO3)2, Calcium chloride—CaCl2, Calcium chromate—CaCrO4, Calcium cyanamide—CaCN2, Calcium fluoride—CaF2, Calcium hydride—CaH2, Calcium hydroxide—Ca(OH)2, Calcium sulfate (Gypsum)—CaSO4, Carbon dioxide—CO2, Carbon disulfide—CS2, Carbon monoxide—CO, Carbon tetrabromide—CBr4, Carbon tetrachloride—CCl4, Carbon tetraiodide—Cl4, Carbonic acid—H2CO3, Carbonyl fluoride—COF2, Carbonyl sulfide—COS, Carboplatin—C6H12N2O4Pt, carborundum SiC, Cerium aluminium—CeAl, Cerium cadmium—CeCd, Cerium magnesium—CeMg, Cerium mercury—CeHg, Cerium silver—CeAg, Cerium thallium—CeTl, Cerium zinc—CeZn, Cerium(III) bromide—CeBr3, Cerium(III) chloride—CeCl3, Cerium(IV) sulfate—Ce(SO4)2, Chrome-alum; K2SO4Cr2(SO4)3.24H2O, Chromic acid—CrO3, Chromium trioxide (Chromic acid)—CrO3, Chromium(II) chloride—CrCl2 (also chromous chloride), Chromium(II) sulfate—CrSO4, Chromium(III) chloride—CrCl3, Chromium(III) oxide—Cr2O3, Chromium(IV) oxide—CrO2, Chromyl chloride—CrO2Cl2, Cisplatin (cis-platinum(II) chloride diammine)—PtCl2(NH3)2, Cobalt(II) bromide—CoBr2, Cobalt(II) carbonate—CoCO3, Cobalt(II) chloride—CoCl2, Cobalt(II) sulfate—CoSO4, Columbite—Fe2+Nb2O6, Copper(I) chloride—CuCl, Copper(I) oxide—Cu2O, Copper(I) sulfide—Cu2S, Copper(II) carbonate—CuCO3, Copper(II) chloride CuCl2, Copper(II) hydroxide—Cu(OH)2, Copper(II) nitrate—Cu(NO3)2, Copper(II) oxide—CuO, Copper(II) sulfate—CuSO4, Copper(II) sulfide—CuS, Cyanogen—(CN)2, Cyanogen chloride—CNCl, Cyanuric chloride—C3Cl3N3, Decaborane (Diborane)—B10H14, Diammonium phosphate—(NH4)2HPO4, Diborane—B2H6, Dichlorosilane—SiH2Cl2, Digallane—Ga2H6, Dinitrogen pentoxide (nitronium nitrate)—N2O5, Disilane—Si2H6, Disulfur dichloride S2Cl2, Dysprosium(III) chloride—DyCl3, Erbium(III) chloride—ErCl3, Erbium-copper—ErCu, Erbium-gold—ErAu, Erbium-Iridium—Erlr, Erbium-silver—ErAg, Europium(III) chloride—EuCl3, Fluorosulfuric acid—FSO2(OH), Gadolinium(III) chloride—GdCl3, Gadolinium(III) oxide—Gd2O3, Gallium antimonide—GaSb, Gallium arsenide—GaAs, Gallium nitride—GaN, Gallium phosphide—GaP, Gallium trichloride—GaCl3, Germanium (IV) nitride—Ge3N4, Germanium telluride—GeTe, Germanium(II) bromide—GeBr2, Germanium(II) chloride—GeCl2, Germanium(II) fluoride—GeF2, Germanium(II) iodide—GeI2, Germanium(II) oxide—GeO, Germanium(II) selenide—GeSe, Germanium(II) sulfide—GeS, Germanium(III) hydride—Ge2H6, Germanium(IV) bromide—GeBr4, Germanium(IV) chloride—GeCl4, Germanium(IV) fluoride—GeF4, Germanium(IV) hydride (Germane)—GeH4, Germanium(IV) iodide—GeI4, Germanium(IV) oxide—GeO2, Germanium(IV) selenide—GeSe2, Germanium(IV) sulfide—GeS2, Gold ditelluride—AuTe2, Gold(I) bromide—AuBr, Gold(I) chloride—AuCl, Gold(I) iodide—AuI, Gold(I) sulfide—Au2S, Gold(I,III) chloride—Au4Cl8, Gold(III) bromide—(AuBr3)2, Gold(III) chloride—(AuCl3)2, Gold(III) chloride—AuCl3, Gold(III) fluoride—AuF3, Gold(III) iodide—AuI3, Gold(III) oxide—Au2O3, Gold(III) selenide—Au2Se3, Gold(IIII) selenide—AuSe, Gold(III) sulfide—Au2S3, Gold(V) fluoride—AuF5, Hafnium fluoride, Hafnium tetrachloride—HfCl4, Hexadecacarbonylhexarhodium—Rh6CO16, Hydrazine—N2H4, Hydrazoic acid—HN3, Hydrobromic acid—HBr, Hydrochloric acid—HCl, Hydrogen bromide—HBr, Hydrogen chloride—HCl, Hydrogen fluoride—HF, Hydrogen peroxide—H2O2, Hydrogen selenide—H2Se, Hydrogen sulfide—H2S, Hydrogen telluride—H2Te, Hydroiodic acid—HI, Hydroxylamine—NH2OH, Hypochlorous acid—HClO, Hypophosphorous acid—H3PO2, Indium antimonide—InSb, Indium arsenide—InAs, Indium nitride—InN, Indium phosphide—InP, Indium(I) chloride, lodic acid—HIO3, Iodine heptafluoride—IF7, Iodine monochloride—ICl, Iodine pentafluoride—IF5, Iridium(IV) chloride, Iron(II) chloride—FeCl2 including hydrate, Iron(II) oxide—FeO, Iron(II,III) oxide—Fe3O4, Iron(III) chloride—FeCl3, Iron(III) nitrate—Fe(NO3)3(H2O)9, Iron(III) oxide—Fe2O3, Iron(III) thiocyanate, Iron-sulfur cluster, Krypton difluoride—KrF2, Lanthanum aluminium—LaAI, Lanthanum cadmium—LaCd, Lanthanum carbonate—La2(CO3)3, Lanthanum magnesium—LaMg, Lanthanum mercury—LaHg, Lanthanum silver—LaAg, Lanthanum tallium—LaTI, Lanthanum zinc—LaZn, Lead zirconate titanate—Pb[TixZr1-x]O3 (e.g., x=0.52 is Lead zirconium titanate), Lead(II) carbonate—Pb(Co3), Lead(II) chloride—PbCl2, Lead(II) iodide—PbI2, Lead(II) nitrate—Pb(NO3)2, Lead(II) oxide—PbO, Lead(II) phosphate—Pb3(PO4)2, Lead(II) selenide—PbSe, Lead(II) sulfate—Pb(SO4), Lead(II) sulfide—PbS, Lead(II) telluride—PbTe, Lead(IV) oxide—PbO2, Lithium aluminium hydride—LiAlH4, Lithium bromide—LiBr, Lithium carbonate (Lithium salt)—Li2CO3, Lithium chloride—LiCl, Lithium hydride—LiH, Lithium hydroxide—LiOH, Lithium iodide—Lil, Lithium nitrate—LiNO3, Lithium sulfate—Li2SO4, Magnesium antimonide—MgSb, Magnesium carbonate—MgCO3, Magnesium chloride—MgCl2, Magnesium oxide—MgO, Magnesium phosphate—Mg3(PO4)2, Magnesium sulfate—MgSO4, Manganese(II) chloride—MnCl2, Manganese(II) phosphate—Mn3(PO4)2, Manganese(II) sulfate monohydrate—MnSO4·H2O, Manganese(III) chloride—MnCl3, Manganese(IV) fluoride—MnF4, Manganese(IV) oxide (manganese dioxide)—MnO2, Mercury fulminate—Hg(ONC)2, Mercury(I) chloride—Hg2Cl2, Mercury(I) sulfate—Hg2SO4, Mercury(II) chloride—HgCl2, Mercury(II) selenide—HgSe, Mercury(II) sulfate—HgSO4, Mercury(II) sulfide—HgS, Mercury(II) telluride—HgTe, Metaphosphoric acid—HPO3, Molybdate orange, Molybdenum disulfide—MoS2, Molybdenum hexacarbonyl—C6O6Mo, Molybdenum trioxide—MoO3, Molybdic acid—H2MoO4, Neodymium(III) chloride—NdCl3, Nessler's reagent—K2[HgI4], Nickel(II) carbonate—NiCO3, Nickel(II) chloride—NiCl2 and hexahydrate, Nickel(II) hydroxide—Ni(OH)2, Nickel(II) nitrate—Ni(NO3)2, Nickel(II) oxide—NiO, Niobium oxychloride—NbOCl3, Niobium pentachloride—NbCl5, Nitric acid—HNO3, Nitrogen dioxide—NO2, Nitrogen monoxide—NO, Nitrosylsulfuric acid—NOHSO4, Osmium tetroxide (osmium(VIII) oxide)—OsO4, Osmium trioxide (osmium(VI) oxide)—OsO3, Oxybis(tributyltin)—C24H54OSn2, Oxygen difluoride—OF2, Ozone—O3, Palladium(II) chloride—PdCl2, Palladium(II) nitrate—Pd(NO3)2, Pentaborane—B5H9, Pentasulfide antimony—Sb2S5, Perchloric acid—HClO4, Perchloryl fluoride—ClFO3, Persulfuric acid (Caro's acid)—H2SO5, Perxenic acid—H4XeO6, Phenylarsine oxide—(C6H5)AsO, Phenylphosphine—C6H7P, Phosgene—COCl2, Phosphine—PH3, Phosphite—HPO32-, Phosphomolybdic acid—HMoNiO6P-4, Phosphoric acid—H3PO4, Phosphorous acid (Phosphoric(III) acid)—H3PO3, Phosphorus pentabromide—PBr5, Phosphorus pentafluoride—PF5, Phosphorus pentasulfide—P4S10, Phosphorus pentoxide—P2O5, Phosphorus sesquisulfide—P4S3, Phosphorus tribromide—PBr3, Phosphorus trichloride—PC13, Phosphorus trifluoride—PF3, Phosphorus triiodide—PI3, Phosphotungstic acid—H3PW12O40, Platinum(II) chloride—PtCl2, Platinum(IV) chloride—PtCl4, Plutonium dioxide (Plutonium(IV) oxide)—PuO2, Plutonium(III) chloride—PuCl3, Potash Alum-K2SO4·Al2(SO4)3·24H2O, Potassium aluminium fluoride—KAlF4, Potassium borate—K2B4O7·4H2O, Potassium bromide—KBr, Potassium calcium chloride—KCaCl3, Potassium carbonate—K2CO3, Potassium chlorate—KClO3, Potassium chloride—KCl, Potassium ferrioxalate—K3[Fe(C2O4)3], Potassium hydrogen fluoride—HF2K, Potassium hydrogencarbonate—KHCO3, Potassium hydroxide—KOH, Potassium iodide—KI, Potassium monopersulfate—K2SO4·KHSO4·2KHSO5, Potassium nitrate—KNO3, Potassium perbromate—KBrO4, Potassium perchlorate—KClO4, Potassium permanganate—KMnO4, Potassium sulfate—K2SO4, Potassium sulfide—K2S, Potassium titanyl phosphate—KTiOPO4, Potassium vanadate—KVO3, Praseodymium(III) chloride—PrCl3, Protonated molecular hydrogen—H3+, Prussian blue (Iron(III) hexacyanoferrate(II))—Fe4[Fe(CN)6]3, Pyrosulfuric acid—H2S2O7, Radium chloride—RaCl2, Radon difluoride—RnF2, Rhodium(III) chloride—RhCl3, Rubidium bromide—RbBr, Rubidium chloride—RbCl, Rubidium fluoride—RbF, Rubidium hydroxide—RbOH, Rubidium iodide—RbI, Rubidium nitrate—RbNO3, Rubidium oxide—Rb2O, Rubidium telluride—Rb2Te, Ruthenium(VIII) oxide—RuO4, Samarium(II) iodide—SmI2, Samarium(III) chloride—SmCl3, Scandium(III) chloride—ScCl3 and hydrate, Scandium(III) fluoride—ScF3, Scandium(III) nitrate—Sc(NO3)3, Scandium(III) oxide—Sc203, Scandium(III) triflate—Sc(OSO2CF3)3, Selenic acid—H2SeO4, Selenious acid—H2SeO3, Selenium dioxide—SeO2, Selenium trioxide—SeO3, Silane—SiH4, Silica gel—SiO2·nH2O, Silicic acid—[SiOx(OH)4-2x]n, Silicochloroform—Cl3HSi, Silicofluoric acid—H2SiF6, Silicon dioxide—SiO2, Silver chloride—AgCl, Silver iodide—Agl, Silver nitrate—AgNO3, Silver sulfide—Ag2S, Silver(I) fluoride—AgF, Silver(II) fluoride—AgF2, Soda lime —, Sodamide—NaNH2, Sodium borohydride—NaBH4, Sodium bromate—NaBrO3, Sodium bromide—NaBr, Sodium carbonate—Na2CO3, Sodium chlorate—NaClO3, Sodium chloride—NaCl, Sodium cyanide—NaCN, Sodium ferrocyanide—Na4Fe(CN)6, Sodium hydride—NaH, Sodium hydrogen carbonate (Sodium bicarbonate)—NaHCO3, Sodium hydrosulfide—NaSH, Sodium hydroxide—NaOH, Sodium iodide—NaI, Sodium monofluorophosphate (MFP)—Na2PFO3, Sodium nitrate—NaNO3, Sodium nitrite—NaNO2, Sodium percarbonate—2Na2CO3.3H2O2, Sodium persulfate—Na2S2O8, Sodium phosphate; see Trisodium phosphate—Na3PO4, Sodium silicate—Na2SiO3, Sodium sulfate—Na2SO4, Sodium sulfide—Na2S, Sodium sulfite—Na2SO3, Sodium tellurite—Na2TeO3, Stannous chloride (tin(II) chloride)—SnCl2, Stibine—SbH3, Strontium chloride—SrCl2, Strontium nitrate—Sr(NO3)2, Strontium titanate—SrTiO3, Sulfamic acid—H3NO3S, Sulfane—H2S, Sulfur dioxide—SO2, Sulfuric acid—H2SO4, Sulfurous acid—H2SO3, Sulfuryl chloride—SO2Cl2, Tantalum carbide—TaC, Tantalum(V) oxide—Ta2O5, Telluric acid—H6TeO6, Tellurium dioxide—TeO2, Tellurium tetrachloride—TeCl4, Tellurous acid—H2TeO3, Terbium(III) chloride—TbCl3, Tetraborane(10)—B4H10, Tetrachloroauric acid—AuCl3, Tetrafluorohydrazine—N2F4, Tetramminecopper(II) sulfate—[Cu(NH3)4]SO4, Tetrasulfur tetranitride—S4N4, Thallium(I) carbonate—T12CO3, Thallium(I) fluoride—TIF, Thallium(III) oxide T1203, Thallium(III) sulfate, Thionyl chloride—SOCl2, Thiophosgene—CSCl2, Thiophosphoryl chloride—Cl3PS, Thorium dioxide—ThO2, Thortveitite—(Sc,Y)2Si2O7, Thulium(III) chloride—TmCl3, Tin(II) chloride—SnCl2, Tin(II) fluoride—SnF2, Tin(IV) chloride—SnCl4, Titanium boride—TiB2, Titanium carbide—TiC, Titanium dioxide (B) (titanium(IV) oxide)—TiO2, Titanium dioxide (titanium(IV) oxide)—TiO2, Titanium nitride—TiN, Titanium(II) chloride—TiCl2, Titanium(III) chloride—TiCl3, Titanium(IV) bromide (titanium tetrabromide)—TiBr4, Titanium(IV) chloride (titanium tetrachloride)—TiCl4, Titanium(IV) iodide (titanium tetraiodide)—TiI4, Trifluoromethanesulfonic acid—CF3SO3H, Trifluoromethylisocyanide—C2NF3, Trimethylphosphine—C3H9P, Trioxidane—H2O3, Tripotassium phosphate—K3PO4, Trisodium phosphate—Na3PO4, Triuranium octaoxide (pitchblende or yellowcake)—U3O8, Tungsten carbide—WC, Tungsten hexacarbonyl—W(CO)6, Tungsten(VI) chloride—WCl6, Tungsten(VI) Fluoride—WF6, Tungstic acid—H2WO4, Uranium hexafluoride—UF6, Uranium pentafluoride—UF5, Uranium tetrachloride—UC14, Uranium tetrafluoride—UF4, Uranyl carbonate—UO2CO3, Uranyl chloride—UO2Cl2, Uranyl fluoride—UO2F2, Uranyl hydroxide—(UO2)2(OH)4, Uranyl hydroxide—UO2(OH)2, Uranyl nitrate—UO2(NO3)2, Uranyl sulfate—UO2SO4, Vanadium carbide—VC, Vanadium oxytrichloride (Vanadium(V) oxide trichloride)—VOCl3, Vanadium(II) chloride—VCl2, Vanadium(II) oxide—VO, Vanadium(III) bromide—VBr3, Vanadium(III) chloride—VCl3, Vanadium(III) fluoride—VF3, Vanadium(III) nitride—VN, Vanadium(III) oxide—V2O3, Vanadium(IV) chloride—VCl4, Vanadium(IV) fluoride—VF4, Vanadium(IV) oxide—VO2, Vanadium(IV) sulfate—VOSO4, Vanadium(V) oxide—V2O5, Water—H2O, Xenic acid—H2XeO4, Xenon difluoride—XeF2, Xenon hexafluoroplatinate—Xe[PtF6], Xenon tetrafluoride—XeF4, Xenon tetroxide—XeO4, Ytterbium(III) chloride—YbCl3, Ytterbium(III) oxide—Yb2O3, Yttrium aluminium garnet—Y3Al5O12, Yttrium barium copper oxide—YBa2Cu3O7, Yttrium cadmium—YCd, Yttrium copper—YCu, Yttrium gold—YAu, Yttrium iridium—Ylr, Yttrium iron garnet—Y3Fe5O12, Yttrium magnesium—YMg, Yttrium rhodium—YRh, Yttrium silver—YAg, Yttrium zinc—YZn, Yttrium(III) antimonide—YSb, Yttrium(III) arsenide—YAs, Yttrium(III) bromide—YBr3, Yttrium(III) fluoride—YF3, Yttrium(III) oxide—Y2O3, Yttrium(III) sulfide—Y2S3, Zinc bromide—ZnBr2, Zinc carbonate—ZnCO3, Zinc chloride—ZnCl2, Zinc cyanide—Zn(CN)2, Zinc fluoride—ZnF2, Zinc iodide—Zn12, Zinc oxide—ZnO, Zinc selenide—ZnSe, Zinc sulfate—ZnSO4, Zinc sulfide—ZnS, Zinc telluride—ZnTe, Zirconia hydrate—ZrO2·nH2O, Zirconium carbide—ZrC, Zirconium hydroxide—Zr(OH)4, Zirconium nitride—ZrN, Zirconium orthosilicate—ZrSiO4, Zirconium tetrahydroxide—H4O4Zr, or Zirconium tungstate—ZrW208, Zirconium(IV) chloride—ZrCl4, Zirconium(IV) oxide—ZrO2.

### Combinations of SEs, Precursor-MLs, MLs and Ligand2s and Linkers, and Composite Materials.

Preferred embodiments include i) Embodiments in which ML and Ligand2 are both capable of mechanically binding, or are both mechanically bound, to SE1 and SE2, respectively, ii) Embodiments in which ML and Ligand2 are both capable of non-covalent binding, or are both non-covalently bound, to SE1 and SE2, respectively, iii) Embodiments in which Ligand2 is covalently bound to SE2, and where for each of i), ii) and iii), SE1 and SE2 are defined as follows:
SE1 is a metal; more preferably SE1 is a metal and SE2 is a ceramic; more preferably SE1 is a metal and SE2 is a polymer; yet more preferably SE1 is metal and SE2 is a metal, or
SE1 is a polymer; more preferably SE1 is a polymer and SE2 is a ceramic; more preferably SE1 is a polymer and SE2 is a polymer; yet more preferably SE1 is polymer and SE2 is a metal, or
SE1 is a ceramic; more preferably SE1 is a ceramic and SE2 is a ceramic; more preferably SE1 is a ceramic and SE2 is a polymer; yet more preferably SE1 is ceramic and SE2 is a metal, or
SE1 is a fullerene; more preferably SE1 is a fullerene and SE2 is a ceramic; more preferably SE1 is a fullerene and SE2 is a polymer; yet more preferably SE1 is fullerene and SE2 is a metal, or
SE1 is a carbon nanotube; more preferably SE1 is a carbon nanotube and SE2 is a ceramic; more preferably SE1 is a carbon nanotube and SE2 is a polymer; yet more preferably SE1 is carbon nanotube and SE2 is a metal, or
SE1 is a graphene; more preferably SE1 is a graphene and SE2 is a ceramic; more preferably SE1 is a graphene and SE2 is a polymer; yet more preferably SE1 is graphene and SE2 is a metal, or
SE1 is a diamond or diamond film; more preferably SE1 is a diamond or diamond film and SE2 is a ceramic; more preferably SE1 is a diamond or diamond film and SE2 is a polymer; yet more preferably SE1 is diamond or diamond film and SE2 is a metal, or
SE1 is a nanotube; more preferably SE1 is a nanotube and SE2 is a ceramic; more preferably SE1 is a nanotube and SE2 is a polymer; yet more preferably SE1 is nanotube and SE2 is a metal, or
SE1 is an epoxy polymer; more preferably SE1 is an epoxy polymer and SE2 is a ceramic; more preferably SE1 is an epoxy polymer and SE2 is a polymer; yet more preferably SE1 is an epoxy polymer and SE2 is a metal, or
SE1 is a quartz; more preferably SE1 is a quartz and SE2 is a ceramic; more preferably SE1 is a quartz and SE2 is a polymer; yet more preferably SE1 is quartz and SE2 is a metal, or
SE1 is a carbon nanofiber; more preferably SE1 is a carbon nanofiber and SE2 is a ceramic; more preferably SE1 is a carbon nanofiber and SE2 is a polymer; yet more preferably SE1 is carbon nanofiber and SE2 is a metal, or
SE1 is a linear polymer; more preferably SE1 is a linear polymer and SE2 is a ceramic; more preferably SE1 is a linear polymer and SE2 is a polymer; yet more preferably SE1 is linear polymer and SE2 is a metal, or
SE1 is a short-chain branched polymer; more preferably SE1 is a short-chain branched polymer and SE2 is a ceramic; more preferably SE1 is a short-chain branched polymer and SE2 is a polymer; yet more preferably SE1 is short-chain branched polymer and SE2 is a metal, or
SE1 is a long-chain branched polymer; more preferably SE1 is a long-chain branched polymer and SE2 is a ceramic; more preferably SE1 is a long-chain branched polymer and SE2 is a polymer; yet more preferably SE1 is long-chain branched polymer and SE2 is a metal, or
SE1 is a ladder-type polymer; more preferably SE1 is a ladder-type polymer and SE2 is a ceramic; more preferably SE1 is a ladder-type polymer and SE2 is a polymer; yet more preferably SE1 is ladder-type polymer and SE2 is a metal, or
SE1 is a star-branched polymer; more preferably SE1 is a star-branched polymer and SE2 is a ceramic; more preferably SE1 is a star-branched polymer and SE2 is a polymer; yet more preferably SE1 is star-branched polymer and SE2 is a metal, or
SE1 is a network polymer; more preferably SE1 is a network polymer and SE2 is a ceramic; more preferably SE1 is a network polymer and SE2 is a polymer; yet more preferably SE1 is network polymer and SE2 is a metal.

In any of the above examples, SE1 and SE2 may be components of a CMU. Said CMU may be part of a composite material, or the CMU may be a sensor or some other partly isolated entity.

Particularly preferred LUs include LUs that comprise a ML that binds CNT

Particularly preferred LUs include LUs that consist of two MLs that bind CNT

Particularly preferred LUs include LUs that comprise two MLs that bind graphene

Particularly preferred LUs include LUs that consist of two MLs that bind graphene

Particularly preferred LUs include LUs that comprise two MLs that bind boronitride

Particularly preferred LUs include LUs that consist of two MLs that bind boronitride

Particularly preferred LUs include LUs that comprise two MLs that bind boronitride nanotube

Particularly preferred LUs include LUs that consist of two MLs that bind boronitride nanotube

Particularly preferred LUs include LUs that comprise two MLs where one binds CNT and the other binds graphene

Particularly preferred LUs include LUs that consist of two MLs where one binds CNT and the other binds boronitride

Particularly preferred LUs include LUs that comprise two MLs where one binds CNT and the other binds boronitride nanotube

Particularly preferred LUs include LUs that consist a ML and a Ligand2 where one binds graphene and the other binds boronitride nanotube

Preferably, SE1 is a ceramic material, a COOH-functionalized CNT, a OH-functionalized carbon nanotube, an NH2-functionalized carbon nanotube, an SH-functionalized CNT, COOH-functionalized graphene, multi-layer graphene, NH2-functionalized graphene, OH-functionalized graphene, a glass fibre, aramid, E-glass, iron, polyester, polyethylene, S-glass, steel, a battery, a borosilicate, a buckyball, a buckytube, a capacitator, a carbon dome, a carbon material, a carbon megatube, a carbon nanofoam, a carbon polymer, a catalyst, a cathode, a coated carbon nanotube, a conductor, a covalent crystal, a crystal, a crystalline material, a defect-free graphene sheet, a defect-free MWCNT, a defect-free SWCNT, a dielectric material, a diode, a dodecahedrane, a doped glass, a fibre, a fullerite, a fused silica, a glue, a green ceramic, a lanthanides, a machinable ceramic, a metal alloy, a metal-functionalized carbon nanotube, a metalised dielectric, a metallised ceramic, a metalloid, a mineral, a non-covalent crystal, a piezoelectric material, a platinum group metal, a post-transition metal, a rare earth element, a sapphire, a semiconductor, a sensor, a silicon nitride, a single crystal fiber, a sol-gel, a synthetic diamond, a transition metal, a triple-wall carbon nanotube, a tungsten carbide, alumina, alumina trihydrate, aluminium, aluminum boride, aluminum oxide, aluminum trihydroxide, amorphous carbon, an actinides, an amalgam, an anode, an elastomers, an electrode, an endohedral fullerene, an insulator, an intermetallic, an ionic crystal, an organic material, anode, anthracite, asbestos, barium, bone, boron, brass, buckypaper, calcium carbonite, calcium metasilicate, calcium sulfate, calcium sulphate, carbon black, carbon nanofoam, cathode, chromium, clay, coal, copper, diamond, diamond-like carbon, double-layer graphene, exfoliated graphite, exfoliated silicate, flourinated graphene, fused silica, gallium arsenide, gallium nitride, germanium, glass, glass microsphere, glass ribbons, glassy carbon, gold, hardened steel, hydrous magnesium silicate, hyperdiamond, iron oxides, lead zirconium titanate, lignite, lithium niobate, lonsdaleite, magnesium dihydroxide, magnesium oxide, manganese, metal oxide, mica, molybdenum, nickel, nylon, palladium, pencil lead, platinum, prismane, pyrolytic graphite, rubber, silica, silica gel, silicon, silicon carbide, silicon dioxide, silicon nitride, silver, soot, stainless steel, tantalum, titanium, titanium oxide, tooth cementum, tooth dentine, tooth enamel, tungsten, tungsten carbide, wood, zinc oxide, zirconia, a nanofibre, a plastic, a fibre, a nanomaterial, graphite, a cellulose nanofibre, a ceramic, curran, a nanothread, a functionalized nanotube, a plastic material, a metal material, a polymer material, or a thio-functionalized graphene molecule

More preferably, SE1 is a graphane molecule, a graphene oxide molecule, a graphyne molecule, a reduced graphene oxide molecule, or a metal

Most preferably, SE1 is a carbon fibre, a carbon nanofibre, a carbon nanothread, a composite material, a fullerene, a MWCNT, a SWCNT, a graphene molecule, a nanotube, a boron nitride sheet, a one-layer molecule, a one-atom layer molecule, a boron nitride nanotube, a functionalized CNT, a functionalized graphene, a functionalized boron nitride nanotube or sheet, a multi-walled nanotube, or a single-walled nanotube

Preferably, SE2 is a biopolymer, a block copolymer, a conductive polymer, a cross-linked polyethylene, a flouroplastic, a high density polypropylene, a low density polypropylene, a medium density polyethylene, a medium density polypropylene, a polyacrylonitrile, a polycaprolactone molecule, a polychloroprene, a polychlorotrifluoroethylene, a polyester molecule, a polyimide, a polylactic acid, a polyphenol, a polysulphone, a polytetrafluoroethylene, a polyurea, a polyurethane, a polyvinyl, a silicone, an elastomer, an inorganic polymer, an ultra-high-molecular-weight polyethylene, a melamin resin, a neoprene, a superlinear polyethylene, a poly(ethylene-vinyl acetate) (PEVA), a polyamide, a polyoxymethylene (POM), polyethylene, polyurethaner, epoxy-based polymer, poly ethylvinyl acetate, polystyrene, polypropylene, polyether, polyethylene oxide, polypropylene oxide, polyacrylates, a polymer, a non-biologic polymer, a biologic polymer, polyaromatic polymer, polyaliphatic polymer, a polymer consisting of C, a polymer consisting of C and H, a polymer consisting of C and H and O, a polymer comprising C, a polymer comprising C and H, a polymer comprising C and H and O, polytetrafluoroethylene (PTFE), a polymer comprising C, a polymer comprising O, a polymer comprising N, a polymer comprising Cl, a polymer comprising H, a polymer comprising a carbonyl, a polymer comprising an OH, a polymer comprising an amide bond, a polymer comprising F, a polymer comprising S, a polymer comprising Si, a polymer consisting of C and H and O and N, a polymer comprising C and H and O and N, a polymer consisting of C and H and Cl, a polymer comprising C and H and Cl, a polymer consisting of C and H and F, a polymer comprising C and H and F, a shape memory polymer, a polymer consisting of 4-(ethoxycarbonyl)benzoic ester, a polymer consisting of butyl, a polymer consisting of chloro-ethyl, a polymer consisting of ethyl, a polymer consisting of ethyl-acetate, a polymer consisting of ethyl-nitril, a polymer consisting of ethylbenzene, a polymer consisting of isobutyl, a polymer consisting of isopentyl, a polymer consisting of isopropyl, a polymer consisting of methyl, a polymer consisting of methyl 2-methyl-propionate, a polymer consisting of neopentyl, a polymer consisting of pentyl, a polymer consisting of phenyl-sulfide, a polymer consisting of propanoic acid, a polymer consisting of propanoic acid methyl ester, a polymer consisting of propyl, a polymer consisting of sec-butyl, a polymer consisting of sec-pentyl, a polymer consisting of tert-butyl, a polymer consisting of tert-pentyl, a polymer consisting of tetra-flouro-ethyl, a polymer comprising 2-methyl-propanoic acid methyl ester, a polymer comprising 4-(2-phenylpropan-2-yl)phenyl hydrogen carbonate, a polymer comprising 4-(4-phenoxybenzoyl)benzaketone, a polymer comprising 4-(ethoxycarbonyl)benzoic ester, a polymer comprising butyl, a polymer comprising chloro-ethyl, a polymer comprising ethyl, a polymer comprising ethyl-acetate, a polymer comprising ethyl-nitril, a polymer comprising ethylbenzene, a polymer comprising isobutyl, a polymer comprising isopentyl, a polymer comprising isopropyl, a polymer comprising methyl, a polymer comprising methyl 2-methyl-propionate, a polymer comprising neopentyl, a polymer comprising pentyl, a polymer comprising phenyl-sulfide, a polymer comprising propanoic acid, a polymer comprising propanoic acid methyl ester, a polymer comprising propyl, a polymer comprising sec-butyl, a polymer comprising sec-pentyl, a polymer comprising tert-butyl, a polymer comprising tert-pentyl, or a polymer comprising tetra-flour-ethyl

More preferably, SE2 is a polyacrylate, a polyolefine, an acrylonitrile butadiene styrene polymer (ABS), an organic polymer, a styrene acrylonitrile copolymer, a styrene butadiene latex, an unsaturated polyester (UPR), a bis-maleimide (BMI), a polymeric cyanate ester, A6 nylon, a polyarylether-etherketone (PEEK), a polyethylenimine (PEI), a poly-ether-ketone-ketone (PEKK), a poly(methyl methacrylate) (PMMA), a polyphenylene sulfide (PPS), poly(ethylvinyl alcohol)I(EVA), a carbon fibre, a carbon nanofibre, a carbon nanothread, a composite material, a fullerene, a graphane molecule, a graphene oxide molecule, a graphyne molecule, a reduced graphene oxide molecule, a metal, a boron nitride sheet, a one-layer molecule, a one-atom layer molecule, a functionalized CNT, a functionalized graphene, a functionalized boron nitride, a multi-walled nanotube, or a single-walled nanotube.

Most preferably, SE2 is a copolymer, a high density polyethylene (HDPE), a linear low density polyethylene (LLDPE), a low density polyethylene (LDPE), a nylon, a polyamide (PA), a polycarbonate (PC), a polyethylene (PE), a polymer, a polypropylene (PP), a polystyrene (PS), an epoxy-based polymer, a polyethylene terephtalate (PET), a polyvinylchloride (PVC), a MWCNT, a SWCNT, a graphene molecule, a nanotube, or a boron nitride nanotube.

Preferably, the ML or Ligand2 comprises any of the following molecule structures: compound 1 from de Juan et al., 2015, doi: 10.1039/c5sc02916c, compound 2 from de Juan et al., 2015, doi: 10.1039/c5sc02916c, compound 3 from de Juan et al., 2015, doi: 10.1039/c5sc02916c, compound 4 from de Juan et al., 2015, doi: 10.1039/c5sc02916c, compound 5 from de Juan et al., 2015, doi: 10.1039/c5sc02916c, 1,2,3-Trichlorobenzene, 1,2,4-Trichlorobenzene, 9,10-dihydroanthracene, covalent bond, non-covalent bond, peptide composed of 5 amino acids, peptide composed of 6 amino acids, pyrene phenyl ester, small molecule with a molecular weight of 12 to 1200 dalton, benzene, biphenyl, peptide with the sequence CPTSTGQAC, peptide with the sequence CTLHVSSYC, dodecyl-trimethylammonium bromide (DTAB), peptide with the sequence ELWR, peptide with the seqeunce ELWRPTR, with the sequence ELWSIDTSAHRK, fluoranthene, hexane, peptide with the sequence HTDWRLGTWHHS, peptide with the sequence KPRSVSG-dansyl, m-dinitrobenzene, monooleate, monostearate, nitrobenzene, p-nitrotoluene, p-terphenyl, polycyclic carbonhydrides, polystyrene-polyethylene oxide copoymer, polyvinylpyrrolidone, porphyrine, pyrenecarboxylicacid, pyrenyl, peptide with the sequence QLMHDYR, peptide with the sequence QTWPPPLWFSTS, riboflavin, peptide with the sequence RLNPPSQMDPPF, sodium Dodecyl Benzene Sulphonate (SDBS), sodium dodecyl sulfate (SDS), tetraphene, peptide with the sequence IFRLSWGTYFS, peptide with the sequence KTQATSESGSAGRQMFVADMG, peptide with the sequence KTQATSRGTRGMRTSGGFPVG, peptide with the sequence KTQATSVPRKAARRWEQVDSV, peptide with the sequence MHGKTQATSGTIQS, peptide with the sequence PQAQDVELPQELQDQHREVEV, peptide with the sequence SKTSGRDQSKRVPRYWNVHRD, peptide with the sequence SKTSRESSAVQMGKARFLCT, toluene, trans-1,2-diaminocyclohexane-N,N,N9,N9-tetraacetic acid (CDTA), triphenylene, tween-60, tween-80, aromatic molecule, aromatic amino acid, aromatic ring, heteoaromatic ring, non-aromatic molecule, triple bond, Annulene, Aceanthrylene, Acenaphthylene, Acephenanthrylene, Anthracene, as-Indacene, Azulene, Benzene, Biphenylene, Chrysene, Coronene, Decacene, Decahelicene, Decaphene, Fluoranthene, Fluorene, Heptacene, Heptahelicene, Heptaphene, Heptaphenylene, Hexacene, Hexahelicene, Hexaphene, Hexaphenylene, Indene, Naphthalene, Nonacene, Nonahelicene, Nonaphene, Nonaphenylene, Octacene, Octahelicene, Octaphene, Octaphenylene, Ovalene, Pentacene, Pentalene, Pentaphene, Pentaphenylene, Perylene, Phenalene, Phenanthrene, Picene, Pleiadene, Polyacene, Polyalene, Polyaphene, Polyhelicene, Polynaphthylene, Polyphenylene, Pyranthrene, Rubicene, s-Indacene, Tetracene, Tetranaphthylene, Tetraphene, Tetraphenylene, Trinaphthylene, Triphenylene, 1,10-Phenanthroline, 1,5-Naphthyridine, 1,6-Naphthyridine, 1,7-Naphthyridine, 1,7-Phenanthroline, 1,8-Naphthyridine, 1,8-Phenanthroline, 1,9-Phenanthroline, 2,6-Naphthyridine, 2,7-Naphthyridine, 2,7-Phenanthroline, 2,8-Phenanthroline, 2,9-Phenanthroline, 3,7-Phenanthroline, 3,8-Phenanthroline, 4,7-Phenanthroline, Acridarsine, Acridine, Acridophosphine, Arsanthrene, Arsanthridine, Arsindole, Arsindolizine, Arsinoline, Arsinolizine, Boranthrene, Carbazole, Chromene, Cinnoline, Furan, Imidazole, Indazole, Indole, Indolizine, Isoarsindole, Isoarsinoline, Isochromene, Isoindole, Isophosphindole, Isophosphinoline, Isoquinoline, lsoselenochromene, Isotellurochromene, Isothiochromene, Mercuranthrene, Oxanthrene, Perimidine, Phenanthridine, Phenarsazinine, Phenazine, Phenomercurazine, Phenophosphazinine, Phenoselenazine, Phenotellurazine, Phenothiarsinine, Phenothiazine, Phenoxaphosphinine, Phenoxarsinine, Phenoxaselenine, Phenoxastibinine, Phenoxatellurine, Phenoxathiine, Phenoxazine, Phosphanthrene, Phosphanthridine, Phosphindole, Phosphindolizine, Phosphinoline, Phosphinolizine, Phthalazine, Pteridine, Purine, Pyran, Pyrazine, Pyrazole, Pyridazine, Pyridine, Pyrimidine, Pyrrole, Pyrrolizine, Quinazoline, Quinoline, Quinolizine, Quinoxaline, Selenanthrene, Selenochromene, Selenoxanthene, Silanthrene, Telluranthrene, Tellurochromene, Telluroxanthene, Thianthrene, Thiochromene, Thioxanthene, or Xanthene

More preferably, ML and/or Ligand2 comprises a diamino pyrene, covalent ligand, anthracene, peptide with the sequence IFRLSWGTYFS, naphtalene, phenanthrene, aminogroup-containing carbonhydride, peptide with the sequence HWKHPWGAWDTL, bis-pyrene, dipyrene (phenyl ester), tetracycline, peptide with the sequence DAEFRHDSGYEVHHQKLVFFAEDVGSNKGAIIGLMVGGVV, or peptide with the sequence DAEFRHDSGYEVHHQKLVFFAEDVGSNKGAIIGLMVGGVVIA.

Most preferably, ML and/or Ligand2 comprises a pyrene, aromatic system, such as benzene, nitrobenzene, toluene, 1,2,3-trichlorbenzene, 1,2,4-trichorobenzene, m-dinitrobenzene, p-nitrobenzene, naphthalene, anthracene, fluoranthene, phenanthrene, pyrene, pyrene-diamine, pyrene-phenyl ester, dipyrene (phenyl ester), tetracycline, as well as their substituted variants, a halogen, nitro group, amine, thiol, alcohol, ester, amide, carboxylic acid, phenol, indole, imidazole, sulfonate or phophate, C1-C10 alkane, such as hexane and heptane, detergent including chemical motifs comprising a C4-C25 alkane and a polar end group such as sulfonate, for example SDBS, Sodium dodecylbenzenesulfonate, lactam, such as N-methyl-pyrrolidone and lactone, amino acid residue such as phenylalanine, tyrosine, tryptophan, histidine, heteroaromatic system, including pyrole, thiophene, furane, pyrazole, imidazole, isoxazole, oxazole, isothiazole, thiazole, pyridine and perylene bisimides, fused ring system, composed of either aromatic, non-aromatic or anti-aromatic rings or combinations thereof

Preferably, Ligand2 is a non-covalent bond, a single bond, a double bond, a triple bond, peptide with the sequence DAEFRHDSGYEVHHQKLVFFAEDVGSNKGAIIGLMVGGVV, peptide with the sequence DAEFRHDSGYEVHHQKLVFFAEDVGSNKGAIIGLMVGGVVIA or covalent ligand.

More preferably, Ligand2 is an amino group-containing carbonhydride, peptide with the sequence HWKHPWGAWDTL, bis-pyrene, dipyrene (phenyl ester), or tetracycline.

Preferably, ML and/or Ligand2 comprises a peptide, anthracene, peptide with the sequence IFRLSWGTYFS, pyrene, diamino pyrene, naphtalene, phenanthrene, aromatic system, such as benzene, nitrobenzene, toluene, 1,2,3-trichlorbenzene, 1,2,4-trichorobenzene, m-dinitrobenzene, p-nitrobenzene, naphthalene, anthracene, fluoranthene, phenanthrene, pyrene, pyrene-diamine, pyrene-phenyl ester, dipyrene (phenyl ester), tetracycline, as well as their substituted variants, a halogen, nitro group, amine, thiol, alcohol, ester, amide, carboxylic acid, phenol, indole, imidazole, sulfonate or phophate, C1-C10 alkane, such as hexane and heptane, detergent including chemical motifs comprising a long alkane (including C4, C5, C6, C7, C8, C9, C10, C11, C12, C13, C14, C15, C16, C17, C18, C19, C20, C21, C22, C23, C24, C25) and a polar end group such as sulfonate, for example SDBS, Sodium dodecylbenzenesulfonate, lactam, such as N-methyl-pyrrolidone and lactone, amino acid residue such as phenylalanine, tyrosine, tryptophan, histidine, a heteroaromatic system, including pyrrole, thiophene, furane, pyrazole, imidazole, isoxazole, oxazole, isothiazole, thiazole, pyridine and perylene bisimides, fused ring system, composed of either aromatic, non-aromatic or anti-aromatic rings or combinations thereof, or an amide bond, made up of two amide bonds arranged in parallel

Preferably, the Linker is a covalent bond, a nylon polymer molecule, an alkyl chain, a branched alkyl, an aromatic molecule, a heteroaromatic molecule, a dendrimer, a polyethylene glycol, or a C1-C50 hydrocarbon chain, with 0-20 double bonds and 0-20 triple bonds.

More preferably, the Linker is a polymer, a polyolefine, a polypropylene (PP), a polystyrene (PS), an acrylonitrile butadiene styrene polymer (ABS), an epoxy-based polymer, an organic polymer, a polyethylene terephtalate (PET), a polyvinylchloride (PVC), a styrene acrylonitrile copolymer, a styrene butadiene latex, an unsaturated polyester (UPR), a bis-maleimide (BMI), a polymeric cyanate ester, a polyarylether-etherketone (PEEK), a polyethylenimine (PEI), a poly-ether-ketone-ketone (PEKK), a poly(methyl methacrylate) (PMMA), a polyphenylene sulfide (PPS) or poly(ethylvinyl alcohol)I(EVA).

Most preferably, Linker is a linear molecule, a branched molecule, a rigid molecule, a flexible molecule, a polymer, a linear polymer, a branched polymer, a copolymer, a nylon, a polyacrylate, a polyamide (PA), a polycarbonate (PC), a polyethylene (PE), a high density polyethylene (HDPE), a linear low density polyethylene (LLDPE), or a low density polyethylene (LDPE)

Preferred matrices are inorganic matter, biologic matter, non-biologic matter, polymers.

Most preferred matrices are a metal, a ceramic, organic matter, a plastic, a resin, a copolymer, a high density polyethylene (HDPE), a linear low density polyethylene (LLDPE), a low density polyethylene (LDPE), a nylon, a polyamide (PA), a polycarbonate (PC), a polyethylene (PE), a polymer, a polypropylene (PP), a polystyrene (PS), an epoxy-based polymer, a polyethylene terephtalate (PET), or a polyvinylchloride (PVC)

Preferred polymerisation methods are a polycondensation, a uv-induced polymerisation, a step-growth polymerisation, a chain-growth polymerisation, an emulsion polymerisation, a solution polymerisation, a suspension polymerisation, and a precipitation polymerization.

Preferred processing methods are injection molding, compression molding, transfer molding, blow molding, extrusion, injection molding, liquid casting, DMC, SMC, RIM, RRIM, GRP (hand-layup), GRP (spray and match die), filament winding, pultrusion, rotational molding, thermoforming, screw extrusion, calendering, powder injection molding, thixomolding, coating, cold pressure molding, encapsulation, filament winding, laminating, contact molding and slush molding,

Preferred embodiments are a CMU; or a composite material comprising a CMU;
or a composite material comprising a CMU and a matrix chosen from; a metal, a ceramic, organic matter, a plastic, a resin, a copolymer, a high density polyethylene (HDPE), a linear low density polyethylene (LLDPE), a low density polyethylene (LDPE), a nylon, a polyamide (PA), a polycarbonate (PC), a polyethylene (PE), a polymer, a polypropylene (PP), a polystyrene (PS), an epoxy-based polymer, a polyethylene terephtalate (PET), a polyvinylchloride (PVC); wherein the CMU is chosen from the following;

C1.1.1: a CMU, where SE1 is a carbon fibre.

C1.1.2: a CMU, where SE1 is a carbon fibre and SE2 is copolymer.

C1.1.3: a CMU, where SE1 is a carbon fibre, and SE2 is a high density polyethylene.

C1.1.4: a CMU, where SE1 is a carbon fibre, and SE2 is a linear low density polyethylene.

C1.1.5: a CMU, where SE1 is a carbon fibre, and SE2 is a low density polyethylene.

C1.1.6: a CMU, where SE1 is a carbon fibre, and SE2 is a nylon.

C1.1.7: a CMU, where SE1 is a carbon fibre, and SE2 is a polyamide.

C1.1.8: a CMU, where SE1 is a carbon fibre, and SE2 is a polycarbonate.

C1.1.9: a CMU, where SE1 is a carbon fibre, and SE2 is a polyethylene.

C1.1.10: a CMU, where SE1 is a carbon fibre, and SE2 is a polymer.

C1.1.11: a CMU, where SE1 is a carbon fibre, and SE2 is a polypropylene.

C1.1.12: a CMU, where SE1 is a carbon fibre, and SE2 is a polystyrene.

C1.1.13: a CMU, where SE1 is a carbon fibre, and SE2 is an epoxy-based polymer.

C1.1.14: a CMU, where SE1 is a carbon fibre, and SE2 is a polyethylene terephtalate.

C1.1.15: a CMU, where SE1 is a carbon fibre, and SE2 is a polyvinylchloride.

C1.1.16: a CMU, where SE1 is a carbon fibre, and SE2 is a MWCNT.

C1.1.17: a CMU, where SE1 is a carbon fibre, and SE2 is a SWCNT.

C1.1.18: a CMU, where SE1 is a carbon fibre, and SE2 is a GS.

C1.1.19: a CMU, where SE1 is a carbon fibre, and SE2 is a nanotube.

C1.1.20: a CMU, where SE1 is a carbon fibre, and SE2 is a BNNT.

C1.1.21: a CMU, where SE1 is a carbon fibre, and SE2 is a polyacrylate.

C1.1.22: a CMU, where SE1 is a carbon fibre, and SE2 is a polyolefine.

ophan, or histidine, and SE2 is an epoxy-based polymer.

### Desired Characteristics of Composite Materials Described Herein.

For any characteristics of composite material mentioned above and below, and in each characteristic's entire range, further characteristics of the composite material that are of importance in the present invention are the crystallinity of the matrix material, stiffness, electrical conductivity, thermal conductivity, color, fluorescence, luminescence, UV protective capability, abrasion resistance, ductility, elasticity, flexibility, energy storage capability (energy storage as heat or kinetic energy), information storage capability, hydrophilicity, hydrophobicity, polarity, aproticity, and charge, as well as the following characteristics where the unit of measure is indicated after each characteristic: Arc Resistance, sec; Impact Strength, Charpy, J/cm; Impact Strength, Izod Notched, J/cm; Impact Strength, Izod Unnotched, J/cm; Impact Strength, Charpy Notched Low Temp, J/cm; Impact Strength, Izod Notched Low Temp, J/cm; Impact Strength, Charpy Unnotched Low Temp, J/cm; Impact Strength, Charpy Unnotched, J/cm; Linear Mold Shrinkage, cm/cm; Maximum Service Temperature, Air; Melt Flow, g/10 min; Melting Point; Modulus of Elasticity, GPa; Moisture Absorption at Equilibrium, %; Oxygen Transmission, cc-mm/m; Poisson's Ratio; Processing Temperature; Surface Resistance, ohm; Tensile Strength, Ultimate, MPa; Tensile Strength, Yield, MPa; Thermal Conductivity, W/m-K; UL RTI, Electrical; UL RTI, Mechanical with Impact; UL RTI, Mechanical without Impact; Vicat Softening Point; Water Absorption, %; Coefficient of Friction; Comparative Tracking Index, V; Compressive Yield Strength, MPa; CTE, linear 20; Deflection Temperature at 0.46 MPa; Deflection Temperature at 1.8 MPa; Density, g/cc; Dielectric Constant; Dielectric Constant, Low Frequency; Dielectric Strength, kV/mm; Dissipation Factor; Dissipation Factor, Low Frequency; Electrical Resistivity, ohm-cm; Elongation @ break, %; Flammability, UL94; Flexural Modulus, GPa; Flexural Yield Strength, MPa; Glass Temperature; Hardness, Barcol; Hardness, Rockwell E; Hardness, Rockwell M; Hardness, Rockwell R; Hardness, Shore A; Hardness, Shore D; Heat Capacity, J/g.

Depending on the application, composite material with a low, medium, or high degree of each of these characteristics is preferable in the present invention.

### Composite Material.

The composite materials of the present invention may have a number of characteristics. One such characteristic is the number of different CMUs in the composite. Several different CMUs may be preferred in cases where a number of different characteristics of the composite is sought, and wherefore several different CMUs may be used, each representing one or more sought characteristic.

Number of different CMUs in the composite. The composite may comprise 2 or more different CMUs, preferably 3 or more, such as 4 or more, 5 or more, 6 or more, 7 or more, 8 or more, 9 or more, 10 or more, 15 or more, 20 or more, 30 or more or 50 or more different CMUs.

For any characteristics of a composite material mentioned above, and in each characteristic's entire range, a further characteristic of importance is the number of CMUs per area or volume in the composite.

Number of CMUs per area or volume in the composite. Often it is not the absolute number of CMUs in a composite material, but rather the number of CMUs per area or volume that is most important for obtaining the desired properties of the composite material. If the CMUs are solely providing attractive characteristics at a small cost, it will in most cases be preferable to have as many CMUs as practically possible per square millimeter or per cubic millimeter. However, if the CMU provides advantageous characteristics (e.g. high strength) as well as disadvantageous characteristics (e.g. high conductivity), a compromise must be sought where the desired characteristic (e.g. a certain strength) is obtained, and where the disadvantageous characteristics (e.g. conductivity) is kept appropriately low.

Thus, depending on the context, the total number of CMUs per square millimeter of the composite material is preferably less than 10¹², such as less than 10¹⁰, such as less than 10⁹, such as less than 10⁸, such as less than 10⁷, such as less than 10⁶, such as less than 10⁵, such as less than 10⁴, such as less than 10³, such as less than 100, such as less than 10.

As described above, sometimes the highest possible number of CMUs per square millimeter is sought. Thus, depending on the context, the total number of CMUs per square millimeter of the composite material is preferably more than 10, such as more than 100, such as more than 10³, such as more than 10⁴, such as more than 10⁵, such as more than 10⁶, such as more than 10⁷, such as more than 10⁸, such as more than 10⁹, such as more than 10¹⁰, such as more than 10¹².

Composite materials may thus preferably comprise only a few CMUs per square millimeter, such as less than 10 CMUs per square millimeter, or may comprise more, such as 10-100 CMUs per square millimeter, such as 100-1000 CMUs per square millimeter, such as 103-10⁴ CMUs per square millimeter, such as 104-105 CMUs per square millimeter, such as 10⁵-10⁶ CMUs per square millimeter, such as 10⁶-10⁷ CMUs per square millimeter, such as 107-10⁸ CMUs per square millimeter, such as 10⁸-10⁹ CMUs per square millimeter, such as 10⁹-10¹⁰ CMUs per square millimeter, such as 10¹⁰-10¹¹ CMUs per square millimeter, such as 10¹¹-10¹² CMUs per square millimeter, or more than 10¹² per square millimeter.

Thus, depending on the context, the total number of CMUs per cubic millimeter of the composite material is preferably less than 10¹⁸, such as less than 10¹⁶, such as less than 10¹⁴, such as less than 10¹², such as less than 10¹⁰, such as less than 10⁸, such as less than 10⁷, such as less than 10⁶, such as less than 10⁴, such as less than 1000, such as less than 100.

As described above, sometimes the highest possible number of CMUs per cubic millimeter is sought. Thus, depending on the context, the total number of CMUs per cubic millimeter of the composite material is preferably more than 100, such as more than 1000, such as more than 10⁴, such as more than 10⁶, such as more than 10⁸, such as more than 10¹⁰, such as more than 10¹², such as more than 10¹⁴, such as more than 10¹⁶, such as more than 10¹⁸, such as more than 10²⁰.

Composite materials may thus preferably comprise only a few CMUs per cubic millimeter, such as less than 100 CMUs per cubic millimeter, or may comprise more, such as 100-1000 CMUs per cubic millimeter, such as 10³-10⁵ CMUs per cubic millimeter, such as 10⁵-10⁸ CMUs per cubic millimeter, such as 10⁸-10¹¹ CMUs per cubic millimeter, such as 10¹¹-10¹⁴ CMUs per cubic millimeter, such as 10¹⁴-10¹⁶ CMUs per cubic millimeter, such as 10¹⁶-10¹⁸ CMUs per cubic millimeter, such as 10¹⁸-10²⁰ CMUs per cubic millimeter, or more than 10²⁰ per cubic millimeter.

For any characteristics of a composite material mentioned above, and in each characteristic's entire range, a further characteristic of importance is the number of different SEs in the composite.

Number of different SEs in the composite. The composite may comprise 2 or more different SE, preferably 3 or more, such as 4 or more, 5 or more, 6 or more, 7 or more, 8 or more, 9 or more, 10 or more, 15 or more, 20 or more, 30 or more or 50 or more different SEs.

For any characteristics of a composite material mentioned above, and in each characteristic's entire range, a further characteristic of importance is the melting point of the composite material.

Melting point of composite material. The melting point of the composite material is an important parameter and in some cases, such as ceramic brakes for automobiles, aircrafts and trains, a high melting point is desired. Thus, depending on the context, the melting point of the composite material is preferably greater than −20° C., such as greater than 0° C., such as greater than 50° C., such as greater than 100° C., such as greater than 200° C., such as greater than 400° C., such as greater than 600° C., such as greater than 800° C., such as greater than 1,000° C., such as greater than 1,500° C., such as greater than 2,000° C., such as greater than 3,000° C., such as greater than 4,000° C., such as greater than 6,000° C., such as greater than 8,000° C.

In other cases, a composite material's flexibility at low temperatures is important, wherefore a low melting point may be advantageous. Thus, depending on the context, the melting point of the composite material is preferably less than 8,000° C., such as less than 6,000° C., such as less than 4,000° C., such as less than 3,000° C., such as less than 2,000° C., such as less than 1,500° C., such as less than 1,000° C., such as less than 800° C., such as less than 600° C., such as less than 400° C., such as less than 200° C., such as less than 100° C., such as less than 50° C., such as less than 0° C., such as less than −20° C.

Composite materials may have melting points below 0° C., such as between −20° C. and 0° C.; or may be higher, such as between 0° C. and 50° C., or between 50° C. and 100° C., or between 100° C. and 200° C., or between 200° C. and 300° C., or between 300° C. and 400° C., or between 400° C. and 500° C., or between 500° C. and 600° C., or between 600° C. and 700° C., or between 700° C. and 800° C., or between 800° C. and 900° C., or between 900° C. and 1,000° C., or between 1,000° C. and 1,100° C., or between 1,000° C. and 1,200° C., or between 1,200° C. and 1,400° C., or between 1,400° C. and 1,600° C., or between 1,600° C. and 1,800° C., or between 1,800° C. and 2,000° C., or between 2,000° C. and 2,200° C., or between 2,200° C. and 2,400° C., or between 2,400° C. and 2,600° C., or between 2,600° C. and 2,800° C., or between 2,800° C. and 3,000° C., or between 3,000° C. and 3,200° C., or between 3,200° C. and 3,400° C., or between 3,400° C. and 3,600° C., or between 3,600° C. and 3,800° C., or between 3,800° C. and 4,000° C., or between 4,000° C. and 4,200° C., or between 4,200° C. and 4,400° C., or between 4,400° C. and 4,600° C., or between 4,600° C. and 4,800° C., or between 4,800° C. and 5,000° C., or between 5,000° C. and 5,200° C., or between 5,200° C. and 5,400° C., or between 5,400° C. and 5,600° C., or between 5,600° C. and 5,800° C., or between 5,800° C. and 6,000° C., or between 6,000° C. and 6,200° C., or between 6,200° C. and 6,400° C., or between 6,400° C. and 6,600° C., or between 6,600° C. and 6,800° C., or between 6,800° C. and 7,000° C., or between 7,000° C. and 7,200° C., or between 7,200° C. and 7,400° C., or between 7,400° C. and 7,600° C., or between 7,600° C. and 7,800° C., or between 7,800° C. and 8,000° C., or between 8,000° C. and 8,200° C., or between 8,400° C. and 8,600° C., or between 8,600° C. and 8,800° C., or between 8,800° C. and 9,000° C., or between 9,000° C. and 9,200° C., or between 9,200° C. and 9,400° C., or between 9,400° C. and 9,600° C., or between 9,600° C. and 9,800° C., or between 9,800° C. and 10,000° C., or between 10,000° C. and 11,000° C., or between 11,000° C. and 12,000° C., or between 12,000° C. and 13,000° C., or between 13,000° C. and 14,000° C., or between 14,000° C. and 15,000° C., or between 15,000° C. and 16,000° C., or between 16,000° C. and 17,000° C., or between 17,000° C. and 18,000° C., or between 18,000° C. and 19,000° C., or between 19,000° C. and 20,000° C., or above 20,000° C.

For any characteristics of a composite material mentioned above, and in each characteristic's entire range, a further characteristic of importance is the density and strength of the composite material.

Density and Strength of the composite material. For certain applications, for example in the airplane or automotive industry, the strength and density of the composite material is of prime importance. Often, both low density and high strength is desired. However, as these two parameters often are opposing factors, a compromise will have to be made. Therefore, sometimes a high density is acceptable to gain strength, such as high tensile strength or large Young's Modulus. In other cases, low density is necessary, even if lower strength results. Thus, in preferred embodiments the composite material may have relatively low Young's modulus or low tensile strength, and in other preferred embodiments the composite material has large Young's modulus or large tensile strength; and likewise, in preferred embodiments the density can vary from very small to very large.

The specific density of composite materials of the present invention may be lower than 0.01 kg/L, but may also include specific densities in the following ranges: 0.01-0.1 kg/L; 0.1-0.4 kg/L; 0.4-0.6 kg/L; 0.6-0.8 kg/L; 0.8-1 kg/L; 1-1.2 kg/L; 1.2-1.4 kg/L; 1.4-1.6 kg/L; 1.6-1.8 kg/L; 1.8-2 kg/L; 2-2.5 kg/L; 2.5-3 kg/L; 3-3.5 kg/L; 3.5-4 kg/L; 4-4.5 kg/L; 4.5-5 kg/L; 5-5.5 kg/L; 5.5-6 kg/L; 6-6.5 kg/L; 6.5-7 kg/L; 7-7.5 kg/L; 7.5-8 kg/L; 8-8.5 kg/L; 8.5-9 kg/L; 9-9.5 kg/L; 9.5-10 kg/L; 10⁻¹¹ kg/L; 11-12 kg/L; 12-13 kg/L; 13-14 kg/L; 14-16 kg/L; 16-20 kg/L; 20-30 kg/L; or above 30 kg/L.

In some cases high specific densities are preferred. This may be the case when the composite material is e.g. an anchor, as an anchor should rest heavily on the bottom. Thus, depending on the context, the specific density is preferably greater than 0.01 kg/L, such as greater than 0.05 kg/L, such as greater than 0.2 kg/L, such as greater than 0.4 kg/L, such as greater than 0.6 kg/L, such as greater than 0.8 kg/L, such as greater than 1 kg/L, such as greater than 1.2 kg/L, such as greater than 1.5 kg/L, such as greater than 2 kg/L, such as greater than 4 kg/L, such as greater than 6 kg/L, such as greater than 8 kg/L, such as greater than 10 kg/L, such as greater than 12 kg/L, such as greater than 14 kg/L, such as greater than 16 kg/L, such as greater than 20 kg/L, such as greater than 30 kg/L.

In many cases low specific density is preferred. This is for example the case if the composite material is used to make ships that must float on the water, wherefore the weight must be minimized. Thus, depending on the context, the specific density is preferably less than 30 kg/L, such as less than 20 kg/L, such as less than 16 kg/L, such as less than 14 kg/L, such as less than 12 kg/L, such as less than 10 kg/L, such as less than 8 kg/L, such as less than 6 kg/L, such as less than 4 kg/L, such as less than 2 kg/L, such as less than 1.5 kg/L, such as less than 1.2 kg/L, such as less than 1 kg/L, such as less than 0.8 kg/L, such as less than 0.6 kg/L, such as less than 0.4 kg/L, such as less than 0.2 kg/L, such as less than 0.05 kg/L, such as less than 0.01 kg/L.

The Young's modulus of composite materials. In the majority of applications of composite materials, a high Young's modulus is preferred, as this will allow the material to recover its original shape after force has been applied to the material. Thus, depending on the context, the Young's modulus is preferably greater than 0.001 TPa, such as greater than 0.01 TPa, such as greater than 0.1 TPa, such as greater than 0.15 TPa, such as greater than 0.2 TPa, such as greater than 0.5 TPa, such as greater than 1 TPa, such as greater than 2 TPa, such as greater than 4 TPa, such as greater than 6 TPa, such as greater than 8 TPa, such as greater than 10 TPa.

However, in a few applications, a low Young's modulus is desirable. This is for example the case when the degree of deformation of a composite material is being used as a measure of how much force was applied to the material. Thus, depending on the context, the Young's modulus is preferably less than 10 TPa, such as less than 8 TPa, such as less than 6 TPa, such as less than 4 TPa, such as less than 2 TPa, such as less than 1 TPa, such as less than 0.5 TPa, such as less than 0.2 TPa, such as less than 0.15 TPa, such as less than 0.1 TPa, such as less than 0.01 TPa, such as less than 0.01 TPa.

The Young's modulus of composite materials suitable for the present invention can thus be lower than 0.001 TPa, but may also include SEs with Young's Modulus in the following ranges: 0.001-0 0.01 TPa; 0.01-0.03 TPa; 0.03-0.05 TPa; 0.05-0.07 TPa; 0.07-0.09 TPa; 0.09-0.1 TPa; 0.1-0.11 TPa; 0.11-0.12 TPa; 0.12-0.13 TPa; 0.13-0.14 TPa; 0.14-0.15 TPa; 0.15-0.16 TPa; 0.16-0.17 TPa; 0.17-0.18 TPa; 0.18-0.19 TPa; 0.19-0.20 TPa; 0.20-0.22 TPa (e.g. stainless steel); 0.22-0.25 TPa; 0.25-0.30 TPa; 0.30-0.35 TPa; 0.35-0.40 TPa; 0.40-0.45 TPa; 0.45-0.50 TPa; 0.50-0.60 TPa; 0.60-0.80 TPa; 0.80-1.0 TPa; 1-2 TPa (e.g. single-walled carbon nanotubes); 2-3 TPa; 3-4 TPa; 4-5 TPa; 5-7 TPa; 7-10 TPa; or above 10 TPA.

Preferred tensile strength of composite materials is in most cases high, as this is suitable for a large number of applications, e.g. stronger fishing lines and stronger cables. Thus, depending on the context, the tensile strength of the composite material is preferably greater than 0.01 GPa, such as greater than 0.05 GPa, such as greater than 0.1 GPa, such as greater than 0.5 GPa, such as greater than 1 GPa, such as greater than 2 GPa, such as greater than 3 GPa, such as greater than 5 GPa, such as greater than 10 GPa, such as greater than 20 GPa, such as greater than 30 GPa, such as greater than 40 GPa, such as greater than 60 GPa, such as greater than 80 GPa, such as greater than 100 GPa, such as greater than 200 GPa.

However, in some cases a low tensile strength is advantageous, for example in cables or lines that must break for safety reasons, in order to avoid damage to individuals. Thus, depending on the context, the tensile strength of the composite material is preferably less than 200 GPa, such as less than 100 GPa, such as less than 80 GPa, such as less than 60 GPa, such as less than 40 GPa, such as less than 30 GPa, such as less than 20 GPa, such as less than 10 GPa, such as less than 5 GPa, such as less than 3 GPa, such as less than 2 GPa, such as less than 1 GPa, such as less than 0.5 GPa, such as less than 0.1 GPa, such as less than 0.05 GPa, such as less than 0.01 GPa.

The tensile strength for composite materials suitable for the present invention can thus be lower than 0.01 GPa, but may also include composite materials with tensile strengths in the following ranges: 0.01-0.03 GPa; 0.03-0.05 GPa; 0.05-0.07 GPa; 0.07-0.09 GPa; 0.09-0.1 GPa; 0.1-0.11 GPa; 0.11-0.12 GPa; 0.12-0.13 GPa; 0.13-0.14 GPa; 0.14-0.15 GPa; 0.15-0.16 GPa; 0.16-0.17 GPa; 0.17-0.18 GPa; 0.18-0.19 GPa; 0.19-0.20 GPa; 0.20-0.22 GPa; 0.22-0.25 GPa; 0.25-0.30 GPa; 0.30-0.35 GPa; 0.35-0.40 GPa; 0.40-0.45 GPa; 0.45-0.50 GPa; 0.50-0.60 GPa; 0.60-0.80 GPa; 0.80-1.0 GPa; 1-2 GPa (e.g. stainless steel); 2-3 GPa; 3-4 GPa; 4-5 GPa; 5-7 GPa; 7-10 GPa; 10-15 GPa; 15-20 GPa; 20-25 GPa; 25-30 GPa; 30-35 GPa; 35-40 GPa; 40-45 GPa; 45-50 GPa (e.g. single-walled carbon nanotubes); 50-55 GPa; 55-60 GPa; 60-65 GPa; 65-70 GPa; 70-75 GPa; 75-80 GPa; 80-85 GPa; 85-90 GPa; 90-100 GPa; 100-200 GPa, or above 200 GPa.

Often, it is the ratio of strength to density that is most important. The strength/specific density ratio for the composite material that is preferred under the present invention is represented by all the ratios that can be obtained, by dividing the abovementioned strengths with the abovementioned specific densities. Thus, preferred embodiments have composite materials with strength/specific densities in the range 0.00003-1000 TPa L/Kg (where strength is represented by Young's modulus). More specifically, the strength/specific density (Young's Modulus) of the composite material is preferably in the range 0.00003-1000 TPa L/Kg, more preferably 0.001-1000 TPA L/Kg, more preferably 0.01-1000 TPA L/Kg, more preferably 0, 1-1000 TPA L/Kg, more preferably 1-1000 TPA L/Kg, more preferably 10-1000 TPA L/Kg, more preferably 100-1000 TPA L/Kg, and more preferably 500-1000 TPA L/Kg, or higher. Where strength is measured as Tensile strength, the preferred embodiments have composite materials with strength/specific density in the range 0.0003-20000 GPa L/Kg. More specifically, the tensile strength/specific density of the composite material is preferably in the range 0.0003-20000 TPa L/Kg, more preferably 0.01-20000 TPA L/Kg, more preferably 0, 1-20000 TPA L/Kg, more preferably 1-20000 TPA L/Kg, more preferably 10-20000 TPA L/Kg, more preferably 100-20000 TPA L/Kg, more preferably 1000-20000 TPA L/Kg, more preferably 5000-20000 TPA L/Kg, and more preferably 10000-20000 TPA L/Kg, or higher.

Ratio of strength to specific density is often important. The strength/specific density ratio for the composite material that is preferred under the present invention is represented by all the ratios that can be obtained, by dividing the abovementioned strengths with the abovementioned specific densities. Thus, preferred embodiments have composite material with strength/specific densities in the range 0.00003-1,000 TPa L/Kg (where strength is represented by Young's modulus). More specifically, the strength/specific density (Young's Modulus) of the composite material is preferably in the range 0.00003-1,000 TPa L/Kg, more preferably 0.001-1,000 TPA L/Kg, more preferably 0.01-1,000 TPA L/Kg, more preferably 0.1-1,000 TPA L/Kg, more preferably 1-1,000 TPA L/Kg, more preferably 10-1,000 TPA L/Kg, more preferably 100-1,000 TPA L/Kg, and more preferably 500-1,000 TPA L/Kg, or higher.

In cases where e.g. the Young's modulus should be low (see above), the Young's modulus/specific density ratio is preferably less than 1,000 TPA L/kg, such as less than 500 TPA L/kg, such as less than 100 TPa L/kg, such as less than 10 TPa L/kg, such as less than 1 TPa L/kg, such as less than 0.1 TPa L/kg, such as less than 0.01 TPa L/kg, such as less than 0.001 TPa L/kg, such as less than 0.00003 TPa L/kg.

In cases where e.g. Young's modulus is preferably high, the Young's modulus/specific density ratio is preferably greater than 0.00003 TPa L/kg, such as greater than 0.001 TPa L/kg, such as greater than 0.01 TPa L/kg, such as greater than 0.1 TPa L/kg, such as greater than 1 TPa L/kg, such as greater than 10 TPa L/kg, such as greater than 100 TPa L/kg, such as greater than 500 TPa L/kg, such as greater than 1,000 TPA L/kg.

Where strength is measured as tensile strength, the preferred embodiments have composite materials with strength/specific density in the range 0.0003-20,000 GPa L/Kg. More specifically, the tensile strength/specific density of the composite material is preferably in the range 0.0003-20,000 GPa L/Kg, more preferably 0.01-20,000 GPa L/Kg, more preferably 0.1-20,000 GPa L/Kg, more preferably 1-20,000 GPa L/Kg, more preferably 10-20,000 GPa L/Kg, more preferably 100-20,000 GPa L/Kg, more preferably 1,000-20,000 GPa L/Kg, more preferably 5,000-20,000 GPa L/Kg, and more preferably 10,000-20,000 GPa L/Kg, or higher.

In cases where e.g. the tensile strength is preferably low (see above), the tensile strength/specific density ratio is preferably less than 20,000 GPa L/kg, such as less than 10,000 GPa L/kg, such as less than 5,000 GPa L/kg, such as less than 1,000 GPa L/kg, such as less than 100 GPa L/kg, such as less than 10 GPa L/kg, such as less than 1 GPa L/kg, such as less than 0.1 GPa L/kg, such as less than 0.0003 GPa L/kg.

In cases where e.g. tensile strength is preferably high, the tensile strength/specific density ratio is preferably greater than 0.0003 GPa L/kg, such as greater than 0.1 GPa L/kg, such as greater than 1 GPa L/kg, such as greater than 10 GPa L/kg, such as greater than 100 GPa L/kg, such as greater than 1,000 GPa L/kg, such as greater than 5,000 GPa L/kg, such as greater than 10,000 GPa L/kg, such as greater than 20,000 GPA L/kg.

Preferred fracture toughness of composite materials is in most cases high, as this results in a low risk of cracks propagating through the composite, ultimately leading to fracture.

Examples of composite materials where a high fracture toughness is desirable includes, but are not limited to, wind turbine blades and airplane wings. Thus, depending on the context, the fracture toughness is preferably greater than 0.01 MPa·m^{1/2}, such as greater than 0.1 MPa·m^{1/2}, such as greater than 1 MPa·m^{1/2}, such as greater than 2 MPa·m^{1/2}, such as greater than 5 MPa·m^{1/2}, such as greater than 10 MPa·m^{1/2}, such as greater than 15 MPa·m^{1/2}, such as greater than 20 MPa·m^{1/2}, such as greater than 25 MPa·m^{1/2}, such as greater than 30 MPa·m^{1/2}, such as greater than 40 MPa·m^{1/2}, such as greater than 50 MPa·m^{1/2}, such as greater than 75 MPa·m^{1/2}, such as greater than 100 MPa·m^{1/2},

However, in some applications, a low fracture toughness is desirable. As an example, the fracture toughness of the windows in a train needs to be sufficiently low that a person can break the window using an appropriate tool in an emergency situation. Thus, depending on the context, the fracture toughness is preferably less than 100 MPa·m^{1/2}, such as less than 75 MPa·m^{1/2}, such as less than 50 MPa·m^{1/2}, such as less than 40 MPa·m^{1/2}, such as less than 30 MPa·m^{1/2}, such as less than 25 MPa·m^{1/2}, such as less than 20 MPa·m^{1/2}, such as less than 15 MPa·m^{1/2}, such as less than 10 MPa·m^{1/2}, such as less than 5 MPa·m^{1/2}, such as less than 2 MPa·m^{1/2}, such as less than 1 MPa·m^{1/2}, such as less than 0.1 MPa·m^{1/2}, such as less than 0.01 MPa·m^{1/2}.

The fracture toughness for composite materials suitable for the present invention can thus be lower than 0.01 MPa·m^{1/2}, but may also include composite materials with fracture toughness in the following ranges: 0.01-0.1 MPa·m^{1/2}, 0.1-1 MPa·m^{1/2}, 1-2 MPa·m^{1/2}, 2-5 MPa·m^{1/2}, 5-10 MPa·m^{1/2}, 10⁻¹⁵ MPa·m^{1/2}, 15-20 MPa·m^{1/2}, 20-25 MPa·m^{1/2}, 25-30 MPa·m^{1/2}, 30-40 MPa·m^{1/2}, 40-50 MPa·m^{1/2}, 50-75 MPa·m^{1/2}, 75-100 MPa·m^{1/2}, or above 100 MPa·m^{1/2}.

Bulk modulus of composite materials. In the majority of applications of composite materials, a high bulk modulus is preferred, as this will allow the composite material to withstand a high compression, which is important in structural elements of buildings, bridges, etc. Thus, depending on the context, the bulk modulus is preferably greater than 0.001 GPa, such as greater than 0.01 GPa, such as greater than 0.1 GPa, such as greater than 1 GPa, such as greater than 10 GPa, such as greater than 50 GPa, such as greater than 100 GPa, such as greater than 200 GPa, such as greater than 300 GPa, such as greater than 400 GPa, such as greater than 500 GPa, such as greater than 600 GPa, such as greater than 700 GPa, such as greater than 800 GPa, such as greater than 900 GPa, such as greater than 1,000 GPa.

However, in a few applications, a low bulk modulus is desirable. This is for example the case in some foam products, where it should be easy to compress the foam, e.g. using a person's body weight. One such example may be skiing boots where the foam must be able to deform, in order to take up the shape of the skier's foot. Thus, depending on the context, the bulk modulus is preferably less than 1,000 GPa, such as less than 900 GPa, such as less than 800 GPa, such as less than 700 GPa, such as less than 600 GPa, such as less than 500 GPa, such as less than 400 GPa, such as less than 300 GPa, such as less than 200 GPa, such as less than 100 GPa, such as less than 50 GPa, such as less than 10 GPa, such as less than 1 GPa, such as less than 0.1 GPa, such as less than 0.01 GPa, such as less than 0.001 GPa.

The bulk modulus for composite materials suitable for the present invention can thus be lower than 0.001 GPa, but may also include composite materials with bulk modules in the following ranges: 0.001-0.01 GPa, 0.01-0.1 GPa, 0.1-1 GPa, 1-10 GPa, 10-100 GPa, 100-200 GPa, 200-300 GPa, 300-400 GPa, 400-500 GPa, 500-600 GPa, 600-700 GPa, 700-800 GPa, 800-900 GPa, 900-1,000 GPa, or above 1,000 GPa.

Shear modulus of composite materials. In the majority of applications of composite materials, a high shear modulus is preferred, as this will allow the composite material to withstand large forces imposed on the composite material in parallel, but opposite directions, e.g. brakes on bicycles, cars, wind turbines, etc. Thus, depending on the context, the shear modulus is preferably greater than 0.001 GPa, such as greater than 0.01 GPa, such as greater than 0.1 GPa, such as greater than 1 GPa, such as greater than 10 GPa, such as greater than 50 GPa, such as greater than 100 GPa, such as greater than 200 GPa, such as greater than 300 GPa, such as greater than 400 GPa, such as greater than 500 GPa, such as greater than 600 GPa, such as greater than 700 GPa, such as greater than 800 GPa, such as greater than 900 GPa, such as greater than 1,000 GPa.

However, in some applications, a low shear modulus is desirable. This is for example the case in plastic composite materials used for buttons, e.g. to turn on or off electronic equipment. Such buttons must have a low shear modulus so pressing them is sufficiently easy. Thus, depending on the context, the shear modulus is preferably less than 1,000 GPa, such as less than 900 GPa, such as less than 800 GPa, such as less than 700 GPa, such as less than 600 GPa, such as less than 500 GPa, such as less than 400 GPa, such as less than 300 GPa, such as less than 200 GPa, such as less than 100 GPa, such as less than 50 GPa, such as less than 10 GPa, such as less than 1 GPa, such as less than 0.1 GPa, such as less than 0.01 GPa, such as less than 0.001 GPa.

The shear modulus for composite materials suitable for the present invention can thus be lower than 0.001 GPa, but may also include composite materials with shear modules in the following ranges: 0.001-0.01 GPa, 0.01-0.1 GPa, 0.1-1 GPa, 1-10 GPa, 10-100 GPa, 100-200 GPa, 200-300 GPa, 300-400 GPa, 400-500 GPa, 500-600 GPa, 600-700 GPa, 700-800 GPa, 800-900 GPa, 900-1,000 GPa, or above 1,000 GPa.

Other kinds of strength, such as torsional strength and impact strength, are also of importance. Thus, composite materials with low, medium or high torsional strength, and composite materials with low, medium or high impact strength are suitable for the present invention, and thus represent preferred embodiments.

For any characteristics of a composite material mentioned above, and in each characteristic's entire range, a further characteristic of importance is the conductivity of the composite material.

Conductivity of composite material. In certain applications, e.g. use of a composite material in wind turbine blades, it may be important that the propellers are non-conductive, in order to not attract lightning. In other cases, it may be desirable to prepare composite materials of modest or high conductivity, in order to be able to detect cracks in the material by analytical measurement of the conductance of the material. Likewise, for composite materials used in e.g. nanosensor technology it may be important that the composite material is conductive, in order to be able to detect changes in conductivity induced by the association of an analyte with the composite material. In some sensor applications it may be desirable to have high conductivity (if the analyte has a strong reducing effect on the conductance of the composite material), or it may be desirable to use a composite material with an intermediate conductivity in order to detect small changes in conductivity. Thus, depending on the application it may be desirable that the composite material has low, intermediate or high conductivity. Composite materials may have conductivities ranging from below 10⁻³⁰ S/m to at least 10¹¹ S/m and higher, such as from below 10⁻³⁰ S/m to 10⁻²⁵ S/m (e.g. Teflon), such as from 10⁻²⁵ S/m to 10⁻²⁰ S/m (e.g. PET), such as from 10⁻²⁰ S/m to 10⁻¹⁵ S/m (e.g. Quarts (fused) and Paraffin), such as from 10⁻¹⁵ S/m to 10⁻¹⁰ S/m (e.g. Hard Rubber, Diamond, Glass), such as from 10⁻¹⁰ S/m to 10⁻⁵ S/m (e.g. GaAs, Silicon), such as from 10⁻⁵ S/m to 1 S/m, such as from 1 S/m to 10 S/m (e.g. Germanium), such as from 10 S/m to 10² S/m, such as from 10² S/m to 10⁴ S/m (e.g. graphite), such as from 10⁴ S/m to 10⁶ S/m (e.g. Nichrome, Mercury,), such as from 10⁶ S/m to 10⁸ S/m (e.g. Stainless steel, Titanium, Platinum, Iron, Lithium, Aluminum, Gold, Coper, Silver), such as from 10⁸ S/m to 10⁹ S/m, such as from 109 S/m to 10¹⁰ S/m, such as from 10¹⁰ S/m to 10¹¹ S/m (e.g. Carbon nanotubes), such as from 10¹¹ S/m to 10¹² S/m (e.g. Carbon nanotubes), such as from 10¹² S/m to 10¹⁴ S/m, and above 10¹⁴ S/m (e.g. superconducting material).

Thus, depending on the context, the conductivity of a composite material is preferably greater than 10⁻³⁰ S/m, such as greater than 10⁻²⁵ S/m, such as greater than 10⁻²⁰ S/m, such as greater than 10⁻¹⁵ S/m, such as greater than 10⁻¹⁰ S/m, such as greater than 10⁻⁵ S/m, such as greater than 1 S/m, such as greater than 10 S/m, such as greater than 10² S/m, such as greater than 10⁴ S/m, such as greater than 10⁶ S/m, such as greater than 10⁸ S/m, such as greater than 10⁹ S/m, such as greater than 10¹⁰ S/m, such as greater than 10¹¹ S/m, such as greater than 10¹² S/m, such as greater than 10¹³ S/m, such as greater than 10¹⁴ S/m.

In other applications, and depending on the context, the conductivity is preferably less than 10¹⁴ S/m, such as less than 10¹³ S/m, such as less than 10¹² S/m, such as less than 10¹¹ S/m, such as less than 10¹⁰ S/m, such as less than 10⁹ S/m, such as less than 10⁸ S/m, such as less than 10⁶ S/m, such as less than 10⁴ S/m, such as less than 10² S/m, such as less than 10 S/m, such as less than 1 S/m, such as less than 10⁻⁵ S/m, such as less than 10⁻¹⁰ S/m, such as less than 10⁻¹⁵ S/m, such as less than 10⁻²⁰ S/m, such as less than 10⁻²⁵ S/m, such as less than 10⁻³⁰ S/m.

For any characteristics of a composite material mentioned above, and in each characteristic's entire range, a further characteristic of importance is the degree to which the composite material can be elongated (stretched) without breaking.

Elongation at break. In many applications, a high elongation at break is preferred. This is for example important in composite materials that absorb energy by deforming plastically such as crash barriers and car bumpers. Thus, depending on the context, the elongation at break of a composite material is preferably greater than 0.1%, such as greater than 1%, such as greater than 5%, such as greater than 10%, such as greater than 20%, such as greater than 30%, such as greater than 40%, such as greater than 50%, such as greater than 60%, such as greater than 70%, such as greater than 80%, such as greater than 90%, such as greater than 100%, such as greater than 150%, such as greater than 200%, such as greater than 300%, such as greater than 400%, such as greater than 500%, such as greater than 800%, such as greater than 1,500%.

In other applications, a low elongation at break is preferred. This is important in composite materials that must not deform even under harsh conditions such as high pressure and elevated temperature; one such example is ceramic brakes on automobiles, aircrafts and trains. Thus, depending on the context, the elongation at break of a composite material is preferably less than 1,500%, such as less than 800%, such as less than 500%, such as less than 400%, such as less than 300%, such as less than 200%, such as less than 150%, such as less than 100%, such as less than 90%, such as less than 80%, such as less than 70%, such as less than 60%, such as less than 50%, such as less than 40%, such as less than 30%, such as less than 20%, such as less than 10%, such as less than 5%, such as less than 1%, such as less than 0.1%.

Composite materials suitable for the present invention can thus have an elongation at break of less than 0.1%, or have elongation at break including the following ranges: 0.1-1%, 1-5%, 5-10%, 10-20%, 20-30%, 30-40%, 40-50%, 50-60%, 60-70%, 70-80%, 80-90%, 90-100%, 100-150%, 150-200%, 200-300%, 300-400%, 400-500%, 500-800%, 800-1,500%, or have elongation at break above 1,500%.

For any characteristics of a composite material mentioned above, and in each characteristic's entire range, a further characteristic of importance is the size of the composite material.

Size of composite material. The size and shape of the composite material are important parameters. Thus, although depending on the characteristics of the composite material, composite materials may benefit from being large in size, as measured by the total weight of a piece of the composite material, the largest single dimension of a piece of composite material, or the total volume of a piece of composite material. Thus, depending on the context, the total weight of the composite material is preferably greater than 10⁻¹² kg, such as greater than 10⁻¹¹ kg, such as greater than 10⁻¹⁰ kg, such as greater than 10⁻⁹ kg, such as greater than 10⁻⁸ kg, such as greater than 10⁻⁷ kg, such as greater than 10⁻⁶ kg, such as greater than 10⁻⁵ kg, such as greater than 10⁻⁴ kg, such as greater than 10⁻³ kg, such as greater than 0.01 kg, such as greater than 0.1 kg, such as greater than 1 kg, such as greater than 10 kg, such as greater than 100 kg, such as greater than 10³ kg, such as greater than 10⁴ kg, such as greater than 10⁵ kg, such as greater than 10⁶ kg, such as greater than 107 kg, such as greater than 10⁸ kg, such as greater than 10⁹ kg.

And the largest dimension of a composite material is preferably, depending on the context, greater than 0.1 Å, such as greater than 2 Å, such as greater than 1 nm, such as greater than 10 nm, such as greater than 100 nm, such as greater than 1 μm, such as greater than 10 μm, such as greater than 100 μm, such as greater than 1 mm, such as greater than 10 mm, such as greater than 100 mm, such as greater than 1 m, such as greater than 10 m, such as greater than 100 m, such as greater than 1,000 m.

And the total volume of a composite material is preferably, depending on the context, greater than 1 nm³, such as greater than 1,000 nm³, such as greater than 1,000,000 nm³, such as greater than 1 μm³, such as greater than 1,000 μm³, such as greater than 1,000,000 μm³, such as greater than 1 mm³, such as greater than 1,000 mm³, such as greater than 1,000,000 mm³, such as greater than 1 m³, such as greater than 10 m³, such as greater than 100 m³, such as greater than 1,000 m³.

On the other hand, a composite material, depending on other characteristics of the composite material, may benefit from being small in size, as measured by the total weight of a piece of the composite material, the largest single dimension of a piece of composite material, or the total volume of a piece of composite material. Thus, depending on the context, the total weight of the composite material is preferably less than 10⁹ kg, such as less than 10⁸ kg, such as less than 10⁷ kg, such as less than 10⁶ kg, such as less than 10⁵ kg, such as less than 10⁴ kg, such as less than 10³ kg, such as less than 100 kg, such as less than 10 kg, such as less than 1 kg, such as less than 0.1 kg, such as less than 0.01 kg, such as less than 10⁻³ kg, such as less than 10⁻⁴ kg, such as less than 10⁻⁵ kg, such as less than 10⁻⁶ kg, such as less than 10⁻⁷ kg, such as less than 10⁻⁸ kg, such as less than 10⁻⁹ kg, such as less than 10⁻¹⁰ kg, such as less than 10⁻¹¹ kg, such as less than 10⁻¹² kg.

And the largest dimension of a composite material is preferably, depending on the context, less than 1,000 m, such as less than 100 m, such as less than 10 m, such as less than 1 m, such as less than 100 mm, such as less than 10 mm, such as less than 1 mm, such as less than 100 μm, such as less than 10 μm, such as less than 1 μm, such as less than 100 nm, such as less than 10 nm, such as less than 1 nm, such as less than 2 Å, such as less than 0.1 Å.

And the total volume of a composite material is preferably, depending on the context, less than 1,000 m³, such as less than 100 m³, such as less than 10 m³, such as less than 1 m³, such as less than 1,000,000 mm³, such as less than 1,000 mm³, such as less than 1 mm³, such as less than 1,000,000 μm³, such as less than 1,000 μm³, such as less than 1 μm³, such as less than 1,000,000 nm³, such as less than 1,000 nm³, such as less than 1 nm³.

Often, the choice of size and shape will be a compromise between opposing interests. Thus, in preferred embodiments the composite material may be very small to very large, depending on the application.

Therefore, the preferred compromise between high and low weight of the composite material depends on the context, and may be smaller than 10⁻¹² kg, but may also be in the range of 10⁻¹²-10⁻¹¹ kg, 10⁻¹¹-10⁻¹⁰ kg, 10⁻¹⁰-10⁻⁹ kg, 10⁻⁹-10⁻⁸ kg, 10⁻⁸-10⁻⁷ kg, 10⁻⁷-10⁻⁶ kg, 10⁻⁶-10⁻⁵ kg, 10⁻⁵-10⁻⁴ kg, 10⁻⁴-10⁻³ kg, 0.001-0.01 kg, 0.01-0.1 kg, 0.1-1 kg, 1-10 kg, 10-100 kg, 100-1,000 kg, 10³-10⁴ kg, 10⁴-10⁵ kg, 10⁵-10⁶ kg, 10⁶-10⁷ kg, 10⁷-10⁸ kg, 10⁸-10⁹ kg, or above 10⁹ kg.

Therefore, the preferred compromise between large and small dimensions of the composite material depends on the context, and may be smaller than 0.01 Å, but may also be in the range of 0.1-2 Å, 0.2-1 nm, 1-10 nm, 10-100 nm, 0.1-1 μm, 1-10 μm, 10-100 μm, 0.1-1 mm, 1-10 mm, 10-100 mm, 0.1-1 m, 1-10 m, 10-100 m, 100-1,000 m, or above 1,000 m.

Therefore, the preferred compromise between a large and a low volume of the composite material depends on the context, and may be smaller than 1 nm³, but may also be in the range of 1-1,000 nm³, 1,000-1,000,000 nm³, 0.001-1 μm³, 1-1,000 μm³, 1,000-1,000,000 μm³, 0.001-1 mm³, 1-1,000 mm³, 1,000-1,000,000 mm³, 0.001-1 m³, 1-10 m³, 10-100 m³, 100-1,000 m³, or above 1,000 m³.

For any characteristics of a composite material mentioned above, and in each characteristic's entire range, a further characteristic of importance is the number of SEs in the composite material.

In many applications, a high number of SEs in a composite material is preferred, as the characteristics of the SE (e.g. high tensional strength) become more pronounced in the composite material. Thus, depending on the context, the total number of SEs in a composite material is preferably greater than 1E+00, such as greater than 1E+01, such as greater than 1E+02, such as greater than 1E+03, such as greater than 1E+04, such as greater than 1E+05, such as greater than 1E+06, such as greater than 1E+07, such as greater than 1E+08, such as greater than 1E+09, such as greater than 1E+10, such as greater than 1E+11, such as greater than 1E+12, such as greater than 1E+13, such as greater than 1E+14, such as greater than 1E+15, such as greater than 1E+16, such as greater than 1E+17, such as greater than 1E+18, such as greater than 1E+19, such as greater than 1E+20.

In other applications, a low number of SEs in a composite material is preferred, as it makes processing of the composite material easier and/or reduces the cost of the final composite material. Thus, depending on the context, the total number of SEs in a composite material is preferably less than 1E+20, such as less than 1E+19, such as less than 1E+18, such as less than 1E+17, such as less than 1E+16, such as less than 1E+15, such as less than 1E+14, such as less than 1E+13, such as less than 1E+12, such as less than 1E+11, such as less than 1E+10, such as less than 1E+09, such as less than 1E+08, such as less than 1E+07, such as less than 1E+06, such as less than 1E+05, such as less than 1E+04, such as less than 1E+03, such as less than 1E+02, such as less than 1E+01, such as less than 2E+00.

Thus, the preferred compromise between a high and a low number of SEs in a composite material depends on the context, and may be smaller than 2, but may also be in the range of 1E+00-1E+01, 1E+01-1E+02, 1E+02-1E+03, 1E+03-1E+04, 1E+04-1E+05, 1E+05-1E+06, 1E+06-1E+07, 1E+07-1E+08, 1E+08-1E+09, 1E+09-1E+10, 1E+10-1E+11, 1E+11-1E+12, 1E+12-1E+13, 1E+13-1E+14, 1E+14-1E+15, 1E+15-1E+16, 1E+16-1E+17, 1E+17-1E+18, 1E+18-1E+19, 1E+19-1E+20, or above 1E+20.

For any characteristics of a composite material mentioned above, and in each characteristic's entire range, a further characteristic of importance is the total weight of the SEs in the composite material.

In many applications, a high total weight of an SE in a composite material is preferred, as the preferred characteristics of the SE (e.g. a high Young's modulus) then become more pronounced in the composite material. Thus, depending on the context, the total weight of SEs in a composite material is preferably greater than 1E−15 kg, such as greater than 1E−14 kg, such as greater than 1E−13 kg, such as greater than 1E−12 kg, such as greater than 1E−11 kg, such as greater than 1E−10 kg, such as greater than 1E−09 kg, such as greater than 1E−08 kg, such as greater than 1E−07 kg, such as greater than 1E−06 kg, such as greater than 1E−05 kg, such as greater than 1E−04 kg, such as greater than 1E−03 kg, such as greater than 1E−02 kg, such as greater than 1E−01 kg, such as greater than 1E+00 kg, such as greater than 1E+01 kg, such as greater than 1E+02 kg, such as greater than 1E+03 kg, such as greater than 1E+04 kg, such as greater than 1E+05 kg, such as greater than 1E+06 kg, such as greater than 1E+07 kg, such as greater than 1E+08 kg, such as greater than 1E+09 kg.

In other applications, a low total weight of an SE in a composite material is preferred, as it reduces the total weight of the composite material. Thus, depending on the context, the total number of SEs in a composite material is preferably less than 1E+09 kg, such as less than 1E+08 kg, such as less than 1E+07 kg, such as less than 1E+06 kg, such as less than 1E+05 kg, such as less than 1E+04 kg, such as less than 1E+03 kg, such as less than 1E+02 kg, such as less than 1E+01 kg, such as less than 1E+00 kg, such as less than 1E−01 kg, such as less than 1E−02 kg, such as less than 1E−03 kg, such as less than 1E−04 kg, such as less than 1E−05 kg, such as less than 1E−06 kg, such as less than 1E−07 kg, such as less than 1E−08 kg, such as less than 1E−09 kg, such as less than 1E−10 kg, such as less than 1E−11 kg, such as less than 1E−12 kg, such as less than 1E−13 kg, such as less than 1E−14 kg, such as less than 1E−15 kg.

Thus, the preferred compromise between a high and a low total weight of an SE in a composite material depends on the context, and may be smaller than 1E−15 kg, but may also be in the range of 1E−15-1E−14 kg, 1E−14-1E−13 kg, 1E−13-1E−12 kg, 1E−12-1E−11 kg, 1E−11-1E−10 kg, 1E−10-1E−09 kg, 1E−09-1E−08 kg, 1E−08-1E−07 kg, 1E−07-1E−06 kg, 1E−06-1E−05 kg, 1E−05-1E−04 kg, 1E−04-1E−03 kg, 1E−03-1E−02 kg, 1E−02-1E−01 kg, 1E−01-1E+00 kg, 1E+00-1E+01 kg, 1E+01-1E+02 kg, 1E+02-1E+03 kg, 1E+03-1E+04 kg, 1E+04-1E+05 kg, 1E+05-1E+06 kg, 1E+06-1E+07 kg, 1E+07-1E+08 kg, 1E+08-1E+09 kg, or above 1E+09 kg.

For any characteristics of a composite material mentioned above, and in each characteristic's entire range, a further characteristic of importance is the total number of CMUs in the composite material.

In many applications, a high number of CMUs in a composite material is preferred, as the characteristics of the CMUs (e.g. high tensional strength) then become more pronounced in the composite material. Thus, depending on the context, the total number of CMUs in a composite material is preferably greater than 1E+00, such as greater than 1E+01, such as greater than 1E+02, such as greater than 1E+03, such as greater than 1E+04, such as greater than 1E+05, such as greater than 1E+06, such as greater than 1E+07, such as greater than 1E+08, such as greater than 1E+09, such as greater than 1E+10, such as greater than 1E+11, such as greater than 1E+12, such as greater than 1E+13, such as greater than 1E+14, such as greater than 1E+15, such as greater than 1E+16, such as greater than 1E+17, such as greater than 1E+18, such as greater than 1E+19, such as greater than 1E+20.

In other applications, a low number of CMUs in a composite material is preferred, as it makes processing of the composite material easier and reduces the cost of the final composite material. Thus, depending on the context, the total number of CMUs in a composite material is preferably less than 1E+20, such as less than 1E+19, such as less than 1E+18, such as less than 1E+17, such as less than 1E+16, such as less than 1E+15, such as less than 1E+14, such as less than 1E+13, such as less than 1E+12, such as less than 1E+11, such as less than 1E+10, such as less than 1E+09, such as less than 1E+08, such as less than 1E+07, such as less than 1E+06, such as less than 1E+05, such as less than 1E+04, such as less than 1E+03, such as less than 1E+02, such as less than 1E+01, such as less than 2E+00.

Thus, the preferred compromise between a high and a low number of CMUs in a composite material depends on the context, and may be smaller than 2, but may also be in the range of 1E+00-1E+01, 1E+01-1E+02, 1E+02-1E+03, 1E+03-1E+04, 1E+04-1E+05, 1E+05-1E+06, 1E+06-1E+07, 1E+07-1E+08, 1E+08-1E+09, 1E+09-1E+10, 1E+10-1E+11, 1E+11-1E+12, 1E+12-1E+13, 1E+13-1E+14, 1E+14-1E+15, 1E+15-1E+16, 1E+16-1E+17, 1E+17-1E+18, 1E+18-1E+19, 1E+19-1E+20, or 1E+20-1E+30.

For any characteristics of a composite material mentioned above, and in each characteristic's entire range, a further characteristic of importance is homogeneity of the composite material.

A material can be homogeneous on a number of levels. Here, homogeneity is defined at the following levels: macroscopic homogeneity (objects 0.01 m), milliscopic homogeneity (objects 1-10 mm), microscopic homogeneity (objects 1-1,000 μm), nanoscopic homogeneity (objects 1-1,000 nm), and picoscopic homogeneity (objects 1-1,000 μm). For composite materials, homogeneity is here defined as the additive being uniformly dispersed in the composite material as evaluated by the naked eye or microscopy. Composite materials can be homogeneous on the macroscopic, milliscopic, microscopic and nanoscopic level, but not on the picoscopic level, as individual atoms can be visualized at the picoscopic level.

In many applications, the homogeneity of the composite material is an important characteristic, as a homogeneous dispersion of SEs in the composite material results in a better transfer of the properties of the SE (e.g. tensile strength) to the composite material. Thus, depending on the context, the composite material is preferably homogenous on a level less than the macroscopic level, such as a level less than the milliscopic level, such as a level less than the microscopic level.

In other applications, the homogeneity of the composite material is a less important characteristic, and processing costs can be reduced and a less expensive material produced, if the composite material is less homogeneous. Thus, depending on the context, the composite material is preferably homogenous on a level greater than the nanoscopic level, such as greater than than the microscopic level, such as greater than the milliscopic level, such as greater than the macroscopic level.

Thus, the preferred compromise between a high and a low homogeneity depends on the context, and may be less than on the nanoscopic level, but may also be in the range of the nanoscopic-microscopic level, the microscopic-milliscopic level, the milliscopic-macroscopic level, or above the macroscopic level.

Further characteristics of composite material. For any characteristics of an composite material mentioned above, and in each characteristic's entire range, further characteristics of the composite material that are of importance in the present invention are the stiffness, electrical conductivity, thermal conductivity, color, fluorescence, luminescence, UV protective capability, abrasion resistance, ductility, elasticity, flexibility, energy storage capability (energy storage as heat or kinetic energy), information storage capability, hydrophilicity, hydrophobicity, polarity, aproticity, and charge, as well as the following characteristics where the unit of measure is indicated after each characteristic: Arc Resistance, sec; Impact Strength, Charpy, J/cm; Impact Strength, Izod Notched, J/cm; Impact Strength, Izod Unnotched, J/cm; Impact Strength, Charpy Notched Low Temp, J/cm; Impact Strength, Izod Notched Low Temp, J/cm; Impact Strength, Charpy Unnotched Low Temp, J/cm; Impact Strength, Charpy Unnotched, J/cm; Linear Mold Shrinkage, cm/cm; Maximum Service Temperature, Air; Melt Flow, g/10 min; Melting Point; Modulus of Elasticity, GPa; Moisture Absorption at Equilibrium, %; Oxygen Transmission, cc-mm/m; Poisson's Ratio; Processing Temperature; Surface Resistance, ohm; Tensile Strength, Ultimate, MPa; Tensile Strength, Yield, MPa; Thermal Conductivity, W/m-K; UL RTI, Electrical; UL RTI, Mechanical with Impact; UL RTI, Mechanical without Impact; Vicat Softening Point; Water Absorption, %; Coefficient of Friction; Comparative Tracking Index, V; Compressive Yield Strength, MPa; CTE, linear 20; Deflection Temperature at 0.46 MPa; Deflection Temperature at 1.8 MPa; Density, g/cc; Dielectric Constant; Dielectric Constant, Low Frequency; Dielectric Strength, kV/mm; Dissipation Factor; Dissipation Factor, Low Frequency; Electrical Resistivity, ohm-cm; Elongation @ break, %; Flammability, UL94; Flexural Modulus, GPa; Flexural Yield Strength, MPa; Glass Temperature; Hardness, Barcol; Hardness, Rockwell E; Hardness, Rockwell M; Hardness, Rockwell R; Hardness, Shore A; Hardness, Shore D; Heat Capacity, J/g.

Depending on the application, a composite material with a low, medium, or high degree of each of these characteristics is preferable in the present invention.

### Example Composite Materials.

The CMUs described herein may be used to form composite materials comprising a large number of CMUs.

### Structural Entities and Preferred Embodiments.

Polymer and additive. In a preferred embodiment the matrix of a composite material is non-polar. As a result, non-polar additives (e.g. CNT, graphene) will typically integrate more efficiently in the polymer, making the composite material more homogeneous, which is often an advantage, as described above. Polar additives, on the other hand, may in some cases have a strong effect on the electronic and thermal characteristics of the composite material compared to the matrix material without the additive, because of the non-polarity of the matrix and the polarity of the additive. This can be advantageous in certain cases, e.g. when used in sensor applications. A preferred embodiment thus is a composite material where the matrix (SE2) is non-polar and the additive (SE1) is polar. Another preferred embodiment is a composite material where SE1 is non-polar, and the other structural entity of the same CMU is polar (i.e. SE2 is polar).

Nanosensor. The remarkable sensitivity of carbon nanotube or graphene properties (e.g. carbon nanotube conductivity) to the surface adsorbates permits the use of carbon nanotubes and grapheme as highly sensitive sensors.

In a preferred embodiment, one of the structural entities of a CMU comprises an entity chosen from the list of nucleic acid, single-stranded DNA, double-stranded DNA, protein, antibody, enzyme, receptor, where each entity may be attached to another entity chosen from the list comprising carbon nanotube, single-walled carbon nanotube, multi-walled carbon nanotube, graphene, single layer graphene, multi-layer graphene, or graphene oxide. If a CMU comprises e.g. a structural entity SE1 (e.g. an antibody) that binds to a molecule X, and if the other structural entity SE2 is e.g. a conducting CNT, the CMU may be used as a nanosensor for the detection of molecule X.

CNT-reinforced polymer. In a preferred embodiment, one of the structural entities of a CMU is a polymer and the other structural entity of the same CMU is an additive providing increased strength to the composite material made of the CMUs, compared to the material that does not contain the additive. In a preferred embodiment of said embodiment the precursor-ML, ML, or Ligand2 attaching the additive to the linker is capable of non-covalently binding said additive. In a preferred embodiment of said embodiment the additive is a carbon nanotube.

Mixed polymer composite material. In some circumstances it may be desirable to mix two or more polymers. In one preferred embodiment, SE1 represents a molecule of one kind of polymer and SE2 represents a molecule of another kind of polymer. As an example, SE1 may be PVC and SE2 may be polycarbamate. In another preferred embodiment, SE1 represents a polymer molecule and SE2 is an additive, and the composite material additionally comprises one or more polymer types different from SE1.

In a preferred embodiment, the CMU comprises two structural entities SE1 and SE2, where SE1 is an additive of high strength, and SE2 is a polymer and part of the matrix material in a composite material. Ligand2 comprises a large number of SubLigands, such as 4, 5, 6 or more Subligands, where the dissociation constant of the individual SubLigands is relatively high, such as in the range between 10¹⁰-10⁻² M. Such relatively weak interactions of the individual SubLigand with SE2, e.g. in a setting where a large number of serially connected SubLigands can interact with SE2, will provide a very high degree of flexibility and self-healing to a composite material made of such CMUs.

In another preferred embodiment, the CMU comprises two structural entities SE1 and SE2, where SE1 is an additive of high strength, and SE2 is a polymer and part of the matrix material in a composite material. The Ligand2-SE2 interaction is covalent.

In a preferred embodiment, SE1 and SE2 are both a carbon nanotube, and the linker connecting SE1 and SE2 is of a length between 0.1 nm and 10 nm. In a preferred embodiment, the composite material is a material made up of a large number of CMUs, each of which comprise two structural entities SE, both of which are carbon nanotubes, and Ligand2 is either mechanically bound to a carbon nanotube or is non-covalently bound to a carbon nanotube. The linker is relatively short, such as e.g. between 1 and 10 nm. The material is essentially a tight aggregate of carbon nanotubes. As a result, the material is of high strength.

In another preferred embodiment, SE1 and SE2 are both graphene, and the linker connecting SE1 and SE2 is of a length between 0.1 nm and 10 nm. The resulting CMU will have higher strength than each of the two individual graphenes.

In a preferred embodiment, a composite material comprises more than one kind of CMUs. For example, if the composite material is intended to function as a glue between two surfaces, it may be desirable to have one kind of CMU (e.g. made up of a polymer (SE1) and a strengthening additive such as graphene (SE2) that is the core of a reinforced polymer that does not easily break apart, and another kind of CMU (e.g. comprising the same polymer (SE1) but a third structural entity (SE3) that is part of the two surfaces that must be glued together.

### Carbon Nanotube-Reinforced Ceramics

Ceramics cover a wide range of materials, including structural materials and technical ceramics. Concrete and piezoelectric materials are prototypical ceramics. Ceramics are usually defined as solids with a mixture of metallic or semi-metallic and non-metallic elements (often, although not always, oxygen), and they are often quite hard, non-conducting and corrosion-resistant.

Concrete is the most widely used construction material, which among other things comprises silicates. Concrete is produced by mixing cement with sand and water and adding aggregates. Other ingredients in the concrete are termed admixtures, for example air and water reducers such as superplasticizers. An example of a superplasticizer is Mapai, Dynamon SP1. Retarders and accelerators are other useful admixtures. Another ingredient in many concrete mixtures is supplementary cementitious materials also called pozzolans. These materials include fly ash, slag cement (sometimes called ground granulated blast furnace slag or slag cement), silica fume, and metakaolin. Supplementary cementitious materials are used as replacement for cement and since they have a very small particle size they reduce the permeability of concrete.

The relative amount of the water and cement is one of the key parameters that determines the strength of concrete—a lower water-to-cement ratio gives higher strength but at the expense of a higher viscosity.

Addition of fillers such as fullerenes, e.g. CNTs, to concrete in the form of linker units (LUs) or composite material units (CMUs) according to the present invention may help disperse the CNTs more efficiently, and increase the strength of the concrete.

In a preferred embodiment, SE1 or SE2 is a silicate, superplastiziser (e.g. Mapai, Dynamon SP1), a retarder, an accelerator, a pozzolan, or metakaolin, and optionally, SE1 is a carbon nanotube or graphene. In said preferred embodiment, the water-to-cement ratio is preferably lower than 0.01; more preferably between 0.01 and 0.1; more preferably between 0.1 and 0.2; more preferably between 0.2 and 0.3; more preferably between 0.3 and 0.5; more preferably between 0.5 and 1; more preferably between 1 and 2; more preferably between 2 and 5; or even more preferably between 5 and 10.

Aa. Nanotube Composites without Nanotube Aggregates.

Formation of nanotube-ML complexes can lead to efficient dispersion of the nanotubes, even when otherwise strongly agglomerating carbon nanotubes are employed. Many of the Examples of this patent application show that nanotube aggregates can be dissolved and a major fraction of the nanotubes be coated with MLs and in this way composites can be made where nanotube aggregates are not detectable. One such example is Example A20 (and the related Examples A1-A32, including analyses of the formed composite), but many of the examples of this patent application show that nanotube aggregates are minute or undetectable, even by high resolution electron microcopy (**Examples . . . **).

When producing composites, it is in most cases desirable to keep the ML complexed with the nanotube, and in this way avoid a potential reaggregation of the nanotubes. However, in certain cases, such as e.g. if a heat conductive or electrically conductive composite is sought, it may be desirable to remove some or all of the MLs from the nanotubes after the nanotubes have been efficiently dispersed by complexing with the MLs, as this may improve electrical conductivity and especially heat conductivity. This may be done by e.g. cleaving the ML with UV light, hydrolysis, reduction, or any other means that will strip the nanotube for its complexed MLs.

Cleavable precursor-MLs and MLs can be designed in many different ways. Below some of these are shown, along with general procedures for their cleavage:
Heat-cleavable ML. The precursor-ML may be designed to contain a heat-cleavable moiety that will become part of the closed ring of the ML. Then, after formation of the ML-nanotube complexes and the resulting dispersion of the ML-nanotube in the preparation or final composite material, the ML may be cleaved by heating the composite material and/or applying an electrical current through the composite material and/or subjecting the composite material to a magnetic field, leaving the pristine (naked) nanotube without any MLs complexed to it. UV-cleavable ML. The precursor-ML may be designed to contain a UV-cleavable moiety that will become part of the closed ring of the ML. Then, after formation of the ML-nanotube complexes and the resulting dispersion of the ML-nanotube in the preparation or final composite material, the ML may be cleaved by UV-light, leaving the pristine (naked) nanotube without any MLs complexed to it.
ML with cleavable disulfide bond. The precursor-ML may be designed to contain a disulfide moiety that will become part of the closed ring of the ML. Then, after formation of the ML-nanotube complexes and the resulting dispersion of the ML-nanotube in the preparation or final composite material, the ML may be cleaved by addition of DTT and reduction of the disulfide bond, leaving the pristine (naked) nanotube without any MLs complexed to it.
ML with hydrolysable ester bond. The precursor-ML may be designed to contain an ester moiety that will become part of the closed ring of the ML. Then, after formation of the ML-nanotube complexes and the resulting dispersion of the ML-nanotube in the preparation or final composite material, the ML may be cleaved by addition of strong base or strong acid and water, by hydrolysis of the ester bond, leaving the pristine (naked) nanotube without any MLs complexed to it.
ML with dynamic covalent bond. The precursor-ML may be designed to contain a dynamic covalent bond that will become part of the closed ring of the ML. Then, after formation of the ML-nanotube complexes and the resulting dispersion of the ML-nanotube in the preparation or final composite material, the ML may be cleaved by addition of reagents that form a covalent bond with the dynamic covalent bond of the ring, thereby cleaving the ML, leaving the pristine (naked) nanotube without any MLs complexed to it. An example of such dynamic covalent bond is the ring-closing double bond formed by ring-closing metathesis of two double bonds, using Grubb's second generation catalyst, as applied in many of the Examples of this patent application. Addition of a large excess (relative to the amount of MLs) of appropriate compounds carrying double bonds, and addition of e.g. Grubb's second generation catalyst, will lead to reaction of the added reagents with the double bond of the ML, thereby leading to its cleavage, thereby leaving the pristine (naked) nanotube without any MLs complexed to it.

As described above, in some cases it is desirable to keep the MLs complexed to and wrapped around the nanotube, and therefore to produce composites with no nanotube aggregates or at least small nanotube aggregates, where in the composites the MLs are complexed to the nanotube.

Thus, in a preferred embodiment of the invention a preparation of nanotubes or a collection of CMUs or a composite material comprises nanotubes of an average length larger than 10 nm, and at a concentration of at least 0.01 w/w % nanotube, where each nanotube is complexed to one or more MLs, and where the composite has a volume of at least 100 nm³, and does not comprise any nanotube aggregate with smallest dimension larger than 3 nm.

In other cases it is desirable to remove the MLs from the nanotubes after the nanotubes have been dispersed.

Thus, in a preferred embodiment of the invention a

A composite material comprising nanotubes is also provided, wherein said composite material does not comprise any nanotube aggregates having a smallest dimension larger than 1 mm.

What is further provided is a means for the efficient anchoring of nanotubes, in particular carbon nanotubes, in composite materials.

What is further provided is a means for applying the invention to industrial production of products made from composite materials, including minimizing the presence of nanotube aggregates at high nanotube concentration; and improving the dispersion of commercial preparations of nanotubes, comprising many different nanotube species.

The composite material preferably does not comprise any nanotube aggregates having a smallest dimension larger than 1 mm, such as larger than 0.1 mm, such as larger than 0.01 mm, such as larger than 1 μm, such as larger than 0.1 μm, such as larger than 0.01 μm, such as larger than 2 nm.

Further provided is a composite material, having a volume of more than 50 nm³ and comprising more than 0.01 w/w % nanotubes.

Further provided is a composite material, having a volume of more than 50 nm³ and comprising more than 0.01 w/w % nanotubes, such as 0.01-0.1 w/w %, or 0.1-1 w/w %, or 2-3 w/w %, or 4-5 w/w %, or 5-10 w/w %, or 10-15 w/w %, or 15-20 w/w %, or 20-25 w/w %, or 25-30 w/w %, or 30-35 w/w %, or 35-40 w/w %, or 40-50 w/w %, or 50-60 w/w %, or 60-70 w/w %, or 60-80 w/w %, or 80-99.99 w/w %.

Further provided is a composite material, wherein the composite material has a mass of more than 10⁻¹⁵ g, such as more than 10⁻¹⁴ g, such as more than 10⁻¹³ g, such as more than 10⁻¹¹ g, such as more than 10⁻¹⁰ g, such as more than 10⁻⁹ g, such as more than 10⁻⁸ g, such as more than 10⁻⁷ g, such as more than 10⁻⁶ g, such as more than 10⁻⁵ g, such as more than 10⁻⁴ g, such as more than 10⁻³ g, such as more than 10⁻² g, such as more than 0.1 g, such as more than 1 g, such as more than 10 g, such as more than 100 g, such as more than 1 kg, such as more than 10 kg, such as more than 100 kg, such as more than 1000 kg, such as more than 10,000 kg; and/or
wherein the nanotube concentration is 0.01-0.1 w/w %, or 0.1-1 w/w %, or 2-3 w/w %, or 4-5 w/w %, or 5-10 w/w %, or 10-15 w/w %, or 15-20 w/w %, or 20-25 w/w %, or 25-30 w/w %, or 30-35 w/w %, or 35-40 w/w %, or 40-50 w/w %, or 50-60 w/w %, or 60-70 w/w %, or 60-80 w/w %, or 80-99.99 w/w %; and/or
where the nanotubes have an average length of at least 10 nm, such as at least 20 nm, such as at least 50 nm, such as at least 100 nm, such as at least 300 nm, such as at least 500 nm, such as at least 1 μm, or such as at least 20 μm.

Further provided is a composite material, having a volume of at least 100 nm³, such as at least 300 nm³, such as at least 1000 nm³, such as at least 10000 nm³, such as at least 100000 nm³, such as at least 100000 nm³, such as at least 1000000 nm³, such as at least 10000000 nm³, such as at least 100000000 nm³, such as at least 1000000000 nm³, such as at least 10 μm³, such as at least 100 μm³, such as at least 1000 μm³, such as at least 10000 μm³, such as at least 100000 μm³, such as at least 1000000 μm³, such as at least 10000000 μm³, such as at least 100000000 μm³, such as at least 1 mm³, or such as at least 10 mm³.

Further provided is a composite material, wherein a nanotube is complexed to a mechanical ligand that is a closed ring structure, and where the mechanical ligand comprises any of the following chemical moieties: hydroxyl, thiol, phenyl or other aromatic moiety.

Further provided is a composite material, comprising a nanotube and a closed ring molecule where the outer diameter of the nanotube is between 0.3 and 0.6 nm, and the closed ring molecule comprises 10-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 0.6 and 0.7 nm, and the closed ring molecule comprises 15-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 0.7 and 0.8 nm, and the closed ring molecule comprises 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 0.8 and 0.9 nm, and the closed ring molecule comprises 25-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 1.0 and 1.2 nm, and the closed ring molecule comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 1.2 and 1.4 nm, and the closed ring molecule comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 1.4 and 1.7 nm, and the closed ring molecule comprises 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 1.7 and 2.0 nm, and the closed ring molecule comprises 50-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 2.0 and 2.5 nm, and the closed ring molecule comprises 60-70 atoms, or 71-80 atoms, or 81-90 atoms, or 91-100 atoms, 101-150 atoms, or 151-500 atoms, or 501-5000 atoms.

In the composite material described herein, the composite material may additionally comprise a polymer chosen from: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

Further provided is a composite material, wherein at least one of said one or more mechanical ligands is bonded to a polymer chain, preferably a polymer chosen from: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In one aspect of the composite material, the nanotubes are selected from carbon nanotube, multiwall, single-wall, or double-wall nanotubes, or mixtures thereof.

In a further aspect of the composite material, said composite material does not comprise any nanotube aggregates having a smallest dimension larger than 0.1 μm, wherein the nanotube concentration is 10-15 w/w %; and wherein the composite material has a volume of at least 1 μm³.

Suitably, said composite material does not comprise any nanotube aggregates having a smallest dimension larger than 0.1 μm, wherein the nanotube concentration is 15-25 w/w %; and wherein the composite material has a volume of at least 1 μm³.

In a further aspect, said composite material does not comprise any nanotube aggregates having a smallest dimension larger than 0.1 μm, wherein the nanotube concentration is 25-40 w/w %; and wherein the composite material has a volume of at least 1 μm³.

In a further aspect, said composite material does not comprise any nanotube aggregates having a smallest dimension larger than 0.1 μm, wherein the nanotube concentration is 40-70 w/w %; and wherein the composite material has a volume of at least 1 μm³.

In a further aspect, said composite material does not comprise any nanotube aggregates having a smallest dimension larger than 0.1 μm, wherein the nanotube concentration is 70-99,99 w/w %; and wherein the composite material has a volume of at least 1 μm³.

In a further aspect, said composite material does not comprise any nanotube aggregates having a smallest dimension larger than 0.1 μm, wherein the nanotube concentration is 10-25 w/w %; and wherein the composite material has a volume of at least 1 μm³.

In a further aspect, said composite material does not comprise any nanotube aggregates having a smallest dimension larger than 0.1 μm, wherein the nanotube concentration is 10-25 w/w %; and wherein the composite material has a volume of at least 10 μm³.

In a further aspect, said composite material does not comprise any nanotube aggregates having a smallest dimension larger than 0.1 μm, wherein the nanotube concentration is 10-25 w/w %; and wherein the composite material has a volume of at least 100 μm³.

In a further aspect, said composite material does not comprise any nanotube aggregates having a smallest dimension larger than 0.01 μm, wherein the nanotube concentration is 10-25 w/w %; and wherein the composite material has a volume of at least 10 μm³.

Bb. Composite Materials Comprising Nanotube-ML Complexes Involving Several Different Types of Nanotubes.

As described elsewhere herein mechanical ligands (MLs) may be designed to efficiently bind a specific nanotube, thereby improving the dispersion and anchoring of the nanotube in the matrix. However, many different forms of nanotubes (e.g. nanotubes of different element compositions, chiralities, structures, and diameters) are produced under the manufacturing conditions used today. As an example, Tuballs is a product manufactured by OCSiAl. The Tuballs product contains carbon nanotubes with of many different chiralities and diameters.

Using Tuballs or other sources of carbon nanotubes that contain multiple forms of the nanotube will lead to composite materials with sub-optimal characteristics, unless MLs are designed so that they can interact and from mechanical bonds with most of the different carbon nanotubes present in the composite. In other words, in some cases the final composite material should ideally contain many different mechanical ligand structures, capable of forming mechanical bonds with virtually all of the carbon nanotubes of that material. Or alternatively, the MLs and/or precursor MLs should be designed in a way that allows one ML to bind several different types of carbon nanotubes with different chiralities and/or diameter.

Preparations of nanotubes typically comprise many different types of nanotubes. These may have different diameter, chirality, content of elements, etc. This is particularly relevant for commercial nanotube products where focus is more on volume than purity. One such example is Tuballs carbon nanotube products, from OCSiAl. This carbon nanotube product is one of a few products that is currently being produced to industrial scale, i.e. approximately 100 tons produced per year. In the Tuballs product, one carbon nanotube chirality is dominant, but more than 10 different carbon nanotube chiralities are present in the Tuballs product in significant amounts. Being able to form ML-nanotube complexes of e.g. these 11 different nanotube chiralities, rather than just one of them, could increase the reinforcement dramatically, e.g. 10-100 fold, or more.

When a nanotube preparation is used as filler to reinforce a polymer or other type of matrix (e.g. ceramics, metal), it is important to efficiently disperse and anchor most of the nanotubes, and not just one or a few—in order to achieve a high reinforcement. In the present invention, efficient dispersion and anchoring is achieved by the binding of MLs to the nanotube, allowing for efficient covalent or non-covalent interaction between the ML and the matrix material, or between the (individualized) nanotube and the matrix material. Thus, efficient dispersion and anchoring requires ML-nanotube complex formation, and in order to obtain efficient reinforcement of the nanotube composite material it thus is important that a major fraction of the types of nanotubes are complexed to MLs.

By appropriate design of the precursor-MLs and resulting MLs, it is possible to, in the same composite material, obtain more than one type of nanotube that have been complexed with one or more MLs. An example of this is shown in Example JJ36-JJ38, where in the same carbon nanotube preparation SWNTs and DWNTs of different outer diameters, were identified.

In a preferred embodiment, the invention allows mechanical ligand formation with nanotubes of different diameter and different chirality, in the same composite material sample, thereby enabling efficient dispersion and efficient anchoring of these several different nanotubes.

In order to efficiently disperse and anchor several different nanotubes with different diameters and chirality, the affinity of the precursor-ML for the nanotube, the final ring length (number of atoms in the ring that forms around the given nanotube), the tendency to form dimers, trimers and multimers in solution or in the solid or molten matrix, the tendency to form dimers, trimer and multimers when bound to the nanotube, must be adjusted relatively and absolutely.

Thus, in a preferred embodiment a composite material is provided, said composite material comprising at least a first and at least a second carbon nanotube, where the outer diameter of the second nanotube is more than 0.1 nm greater than the outer diameter of the first nanotube, and wherein said first and said second nanotubes are each complexed with mechanical ligands.

Further provided is a composite material, said composite material further comprising at least a third carbon nanotube, where the outer diameter of the third nanotube is more than 0.1 nm greater than the outer diameter of the second nanotube, and wherein said first, second and said third nanotubes are each complexed with mechanical ligands.

Further provided is a composite material, said composite material further comprising at least a fourth carbon nanotube, where the outer diameter of the fourth nanotube is more than 0.1 nm greater than the outer diameter of the third nanotube, and wherein said first, second, third and fourth nanotubes are complexed with mechanical ligands.

Further provided is a composite material, said composite material further comprising at least a fifth carbon nanotube, where the outer diameter of the fifth nanotube is more than 0.1 nm greater than the outer diameter of the fourth nanotube, and wherein said first, second, third, fourth and fifth nanotubes are complexed with mechanical ligands.

Further provided is a composite material, said composite material further comprising at least a sixth carbon nanotube, where the outer diameter of the sixth nanotube is more than 0.1 nm greater than the outer diameter of the fifth nanotube, and wherein said first, second, third, fourth, fifth and sixth nanotubes are complexed with mechanical ligands.

Further provided is a composite material, said composite material further comprising at least a seventh carbon nanotube, where the outer diameter of the seventh nanotube is more than 0.1 nm greater than the outer diameter of the sixth nanotube, and wherein said first, second, third, fourth, fifth, sixth and seventh nanotubes are complexed with mechanical ligands.

Further provided is a composite material, said composite material further comprising at least a eighth carbon nanotube, where the outer diameter of the eighth nanotube is more than 0.1 nm greater than the outer diameter of the seventh nanotube, and wherein said first, second, third, fourth, fifth, sixth, seventh and eighth nanotubes are complexed with mechanical ligands.

Further provided is a composite material, said composite material further comprising at least a ninth carbon nanotube, where the outer diameter of the ninth nanotube is more than 0.1 nm greater than the outer diameter of the eighth nanotube, and wherein said first, second, third, fourth, fifth, sixth, seventh, eighth and ninth nanotubes are complexed with mechanical ligands.

Further provided is a composite material, said composite material further comprising at least a tenth carbon nanotube, where the outer diameter of the tenth nanotube is more than 0.1 nm greater than the outer diameter of the ninth nanotube, and wherein said first, second, third, fourth, fifth, sixth, seventh, eighth, ninth and tenth nanotubes are complexed with mechanical ligands.

In another preferred embodiment of the invention a composite material comprises two or more nanotube-ML complexes where the two or more nanotubes comprise significantly different ratios of two elements (“significantly different ratios of two elements” shall in this paragraph mean that the ratios are at least 10% different), such as 2 or more nanotubes comprising significantly different ratios of two elements where the 2 or more nanotubes are all complexed with MLs, such as 3 or more nanotubes comprising significantly different ratios of two elements where the 3 or more nanotubes are all complexed with MLs, such as 4 or more nanotubes comprising significantly different ratios of two elements where the 4 or more nanotubes are all complexed with MLs, such as 5 or more nanotubes comprising significantly different ratios of two elements where the 5 or more nanotubes are all complexed with MLs.

In another preferred embodiment of the invention a composite material comprises two or more nanotube-ML complexes where the two or more nanotubes comprise significantly different ratios of three elements (“significantly different ratios of two elements” shall in this paragraph mean that the ratios are at least 10% different), such as 2 or more nanotubes comprising significantly different ratios of three elements where the 2 or more nanotubes are all complexed with MLs, such as 3 or more nanotubes comprising significantly different ratios of three elements where the 3 or more nanotubes are all complexed with MLs, such as 4 or more nanotubes comprising significantly different ratios of three elements where the 4 or more nanotubes are all complexed with MLs, such as 5 or more nanotubes comprising significantly different ratios of three elements where the 5 or more nanotubes are all complexed with MLs.

In another preferred embodiment of the invention a composite material comprises two or more nanotube-ML complexes where the two or more nanotubes each comprise the element carbon but also each comprise an additional element that is different in the two or more nanotubes, such as 2 or more nanotubes each comprising carbon but each additionally comprising different elements and where all the nanotubes are complexed with MLs, such as 3 or more nanotubes each comprising carbon but each additionally comprising different elements and where all the nanotubes are complexed with MLs, such as 4 or more nanotubes each comprising carbon but each additionally comprising different elements and where all the nanotubes are complexed with MLs.

Cc. Non-Covalent Linkage of Polymer to Nanotube-ML Complex.

In most cases a strong interaction between the nanotube-ML complex and the polymer is desired. A strong interaction between polymer and nanotube-ML complex may improve the quality of the composite material in several ways: i) it may help disperse the nanotube-ML complexes more efficiently during e.g. shear mixing, because the polymer will function as a handle that pulls one nanotube-ML complex from another nanotube-ML complex, ii) it may increase the anchoring efficiency in the matrix, thereby iii) increasing e.g. the tensile strength of the final product.

In some cases, a weak interaction between the nanotube-ML complex and the matrix (polymer) and hence low strength (e.g. high Young's modulus) is desired. This is the case for leading edge coating of wind turbine blades. Coatings for leading edge protection are typically based on elastomers, as a soft (flexible) outer coating of the wind turbine blade is desired. A major issue for such leading edge coatings is the impact fatigue generated by the continuous impact of rain drops on the leading edge during rainfall, particularly with big wind turbines where the wing tip speed approaches 300 km/h. Impact by rain drops generates very small cracks that may propagate and eventually lead to major damage of the leading edge of the blade. It is desirable to limit crack propagation by inclusion of a high concentration of (well-dispersed) nanotubes, as the numerous nanotubes would then serve as stopping blocks for crack propagation.

Thus, ideally, to make a good leading edge coating one would want to add a high concentration of nanotubes to the commercial polyurethane coating (in order to limit crack propagation) but at the same time ensure a very weak interaction between the nanotube-ML complexes and the polymer, so that the anchoring of the nanotubes would be poor and hence the strength (particularly Young's Modulus) would not increase much relative to the commercially available PU coating.

In one embodiment of the invention, a composite material comprises a number of nanotubes, some or all of which are complexed to one or more mechanical ligands (MLs), and a polymer matrix consisting of individual polymer molecules (e.g. linear polyethylene molecules) or a network of crosslinked molecules (e.g. cross-linked epoxy polymer), where neither the nanotube nor the ML is covalently attached to the polymer. In this composite material, the efficiency of anchoring of the nanotubes in the matrix depends on a number of factors, including i) strength of direct non-covalent bonds between nanotube and polymer, ii) strength of direct non-covalent bonds between ML and polymer, and iii) number of MLs per nanotube. The number of MLs can affect the anchoring efficiency by e.g. providing attracting or repulsive forces between the ML and the polymer, but may also affect the direct interaction between nanotube and polymer by masking the surface of the nanotubes so that it cannot directly and non-covalently interact with the polymer.

As described above, in most cases the anchoring efficiency of the nanotubes in the matrix is desired to be high, but in some cases is desired to be low. These anchoring efficiencies may be reached by designing strong or weak or repulsive non-covalent bonds between the nanotube and the polymer; by designing strong or weak or repulsive non-covalent bonds between the ML and the polymer; and by tuning the number of MLs per nanotube.

As an example of a relatively strong interaction, two aromatic molecules (e.g. two phenyls) would interact relatively strongly and non-covalently. One aromatic entity could be attached to an ML complexed to a nanotube, the other aromatic entity could be part of the polymer—then the polymer and nanotube would be non-covalently attached to each other through one relatively strong bond.

As an example of a medium strength interaction, two small hydrophobic molecules (e.g. methyl groups or ethyl groups) could non-covalently bind to each other. As an example, a methyl group carried by an ML complexed to a nanotube could interact non-covalently with an ethyl group of a polymer.

As an example of a repulsive interaction, two negatively charged groups (e.g. glutamate and aspartate) would repel each other. As an example, if a polyamide polymer carried a glutamate, and if a ML complexed to a nanotube carried an aspartate, the nanotube and the polymer would repel each other, i.e. the nanotube would be very poorly anchored in the polymer matrix.

As another example of an attractive force between a nanotube and a polymer, the polymer might comprise aromatic groups that could stack on the surface of a carbon nanotube with its sp2-hybridized structure, and hence, non-covalently interact and thereby help to anchor the nanotube in the matrix.

It is thus clear from these examples that the nanotube, the polymer and the ML may be designed in a way so that they either increase or decrease the non-covalent interactions between polymer and nanotube, polymer and ML, or even between ML and nanotube. The nanotube may contain any of these chemical entities, either as a result of its synthesis or as a result of its post-synthesis functionalization.

Appropriate chemical entities for the weak, strong or repulsive non-covalent interaction between nanotube, polymer and/or ML include the following chemical entities (general and specific chemical structures):

### General Chemical Structures:

Aliphatic compound, aromatic compound, alkyl, alkane, alkene, alkyne, cyclic aliphate, cyclic aromate, polycyclic aromate, polycyclic aliphate, bridged cyclic aromate, bridged cyclic aliphate, etc.**

### Specific Chemical Structures:

Thiol, hydroxyl, carbonyl, carboxy anhydride, carboxylic acid, single bond, double bond, triple bond, N═N, azide, etc **

Dd. Composite Materials Comprising Pairs of Nanotubes and Mechanical Ligands with Matching Sizes.

A key component of nanotube composites of the present invention is the nanotube-mechanical ligand (nanotube-ML) complex. The efficiency of nanotube-ML formation and the load transfer that may be achieved by using nanotube-ML complexes as fillers in composites, is dependent on the structure of the nanotube as well as of the precursor-ML and the ML, but the relative size of nanotube and ML (e.g. the circumference of the nanotube relative to the number of atoms in the closed-ring molecule) is also of significant importance.

A ML-nanotube complex is provided, comprising at least two mechanical ligands (ML) complexed to a single nanotube, and wherein said at least two mechanical ligands are covalently linked to one another.

Formation of the ML-nanotube complex. For efficient formation of an ML complexed to the nanotube, the precursor-ML must be able to non-covalently interact with the nanotube, ideally with several parts of the precursor-ML, and at the same time the interaction should be reversible enough that the termini of the precursor-ML with reasonable probability will encounter each other and react, and thereby form a ML. The precursor-ML should not be too tightly bound or the ML too tightly wrapped around the nanotube, as this will make the termini of the precursor-ML less likely to get into reactive distance of each other. At the same time, the termini should not be separated by a linker that is so long that the two ends for this reason have a low likelihood of getting into reactive distance of each other. In other words, the precursor-ML should be large enough to provide structural flexibility, but at the same time be small enough to maximize the chance of a productive encounter between the reactive groups on the termini.

Thus, in a preferred embodiment the precursor-ML is of an appropriate structure so that the ML resulting from ring-closing of the precursor-ML around the nanotube will have an appropriate number of atoms in its closed-ring structure allowing it to efficiently wrap around the nanotube without being too strained.

### Optimal Characteristics of the Nanotube-ML Complex.

Once the closed ring (the ML) has formed around the nanotube, the nanotube-binding moieties of the ML will be non-covalently bound to the surface of the nanotube most of the time, because of the high local concentration of the binding moiety of the ML around the nanotube—where the high local concentration results from the fact that the ML is mechanically bound to the nanotube and therefore constantly held in the vicinity of the nanotube. The smaller the closed ring (i.e. the fewer the atoms in the closed ring), the higher the local concentration of the binding moieties of the ML, and the larger the fraction of the time the ML will be non-covalently bound to the nanotube. Hence, the smaller the closed ring of the ML, the more restricted the mobility of the ML along the length of the nanotube will be. Such restricted mobility can result in rigidity of the composite material and is therefore often desired.

However, in some cases an initial strain (flexibility) is desired when stress is applied to the composite material. By using a ML with a relatively large closed ring (a relatively large number of atoms in the closed ring) such an initial flexibility will result, both as result of the mechanical binding (that hinders complete dissociation of the ML and the nanotube in a direction away from and perpendicular to the tube), and as a result of the non-covalent binding being established a smaller fraction of the time because the local concentration is lower as compared to the smaller closed ring described above. As a result, the initial movement will be less restricted initially perpendicular to the ring and will be generally less restricted along the length of the nanotube.

Thus, it is possible to design composite materials of different characteristics depending on the relative size of the nanotube (its circumference) and the closed ring (e.g. its number of atoms in the closed ring), and the pairwise combination of nanotube and ML is therefore an important determinant of composite material characteristics.

In a preferred embodiment, the circumference of the nanotube and the number of atoms in the closed ring of the ML that is complexed to the nanotube, are optimized relative to each other, in order to obtain the desired characteristics of the composite material.

### Complexation of a Pre-Closed-Ring Molecule to a Nanotube.

MLs that are complexed to the nanotube near the ends of the nanotube may migrate along the nanotube and fall off the end. In such cases it is advantageous if the matrix comprises pre-formed closed ring molecules that may slide on to the nanotube to form a mechanical ligand wrapped around the nanotube, in place of the ML that fell off the nanotube.

Typically, the higher the concentration of such pre-formed closed rings in the matrix, the higher the likelihood of closed-ring molecules forming nanotube-ML complexes.

The size of the pre-formed closed-ring molecule is of importance for how efficiently the closed-ring molecule may complex with and wrap around the nanotube terminus. The closed-ring molecule should have a closed-ring circumference significantly larger than the circumference of the nanotube, in order to efficiently complex and wrap around the nanotube.

From the above considerations it is clear that the relative sizes of the nanotube's circumference (which is linearly correlated with its outer diameter) and the length of the closed ring of the ML mechanically bound to the nanotube (as measured by the number of atoms in the closed ring) may determine the characteristics of the composite material that the ML-nanotube complex is a part of.

Thus, in a preferred embodiment of the invention, a composite comprises a nanotube-ML complex where the outer diameter of the nanotube is between 0.3 and 0.6 nm, and the covalently closed ring of the ML bound to said nanotube comprises 10-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube-ML complex where the outer diameter of the nanotube is between 0.6 and 0.7 nm, and the covalently closed ring of the ML bound to said nanotube comprises 15-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube-ML complex where the outer diameter of the nanotube is between 0.7 and 0.8 nm, and the covalently closed ring of the ML bound to said nanotube comprises 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube-ML complex where the outer diameter of the nanotube is between 0.8 and 0.9 nm, and the covalently closed ring of the ML bound to said nanotube comprises 25-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube-ML complex where the outer diameter of the nanotube is between 1 and 1.2 nm, and the covalently closed ring of the ML bound to said nanotube comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube-ML complex where the outer diameter of the nanotube is between 1,2 and 1.4 nm, and the covalently closed ring of the ML bound to said nanotube comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube-ML complex where the outer diameter of the nanotube is between 1,4 and 1.7 nm, and the covalently closed ring of the ML bound to said nanotube comprises 41-50 atoms, or 51-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube-ML complex where the outer diameter of the nanotube is between 1,7 and 2 nm, and the covalently closed ring of the ML bound to said nanotube comprises 50-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube-ML complex where the outer diameter of the nanotube is between 2 and 2.5 nm, and the covalently closed ring of the ML bound to said nanotube comprises 60-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube-ML complex where the outer diameter of the nanotube is between 2,5 and 3 nm, and the covalently closed ring of the ML bound to said nanotube comprises 71-80 atoms, or 81-90 atoms, or 91-100 atoms, 101-150 atoms, or 151-500 atoms, or 501-5000 atoms.

In another preferred embodiment of the invention, a composite comprises a nanotube-ML complex where the outer diameter of the nanotube is between 3 and 5 nm, and the covalently closed ring of the ML bound to said nanotube comprises 80-90 atoms, or 91-100 atoms, 101-150 atoms, or 151-500 atoms, or 501-5000 atoms.

In another preferred embodiment of the invention, a composite comprises a nanotube-ML complex where the outer diameter of the nanotube is between 5 and 10 nm, and the covalently closed ring of the ML bound to said nanotube comprises 100-150 atoms, or 151-500 atoms, or 501-5000 atoms.

In another preferred embodiment of the invention, a composite comprises a nanotube-ML complex where the outer diameter of the nanotube is between 10 and 20 nm, and the covalently closed ring of the ML bound to said nanotube comprises 100-300 atoms, or 301-500 atoms, or 501-2000 atoms, or 2001-10000 atoms.

In another preferred embodiment of the invention, a composite comprises a nanotube-ML complex where the outer diameter of the nanotube is between 20 and 40 nm, and the covalently closed ring of the ML bound to said nanotube comprises 301-500 atoms, or 501-2000 atoms, or 2001-10000 atoms.

In another preferred embodiment of the invention, a composite comprises a nanotube-ML complex where the outer diameter of the nanotube is between 40 and 400 nm, and the covalently closed ring of the ML bound to said nanotube comprises 500-2000 atoms, or 2001-10000 atoms.

From the above consideration it is also clear that in order for a closed ring molecule to associate and bind to a nanotube in a way so that it forms a mechanical bond with the nanotube, and for the resulting ML-nanotube complex to provide the desired characteristics of the composite material within which it resides, the relative sizes of the closed ring and the circumference of the nanotube are important.

From the above considerations it is clear that the relative sizes of the nanotube's circumference (which is linearly correlated with its outer diameter) and the length of the closed ring (as measured by the number of atoms in the closed ring) may determine the characteristics of the composite material that the closed ring and the nanotube is a part of.

Thus, in a preferred embodiment of the invention, a composite comprises a nanotube and a closed ring molecule where the outer diameter of the nanotube is between 0.3 and 0.6 nm, and the closed ring molecule comprises 10-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube and a closed ring molecule where the outer diameter of the nanotube is between 0.6 and 0.7 nm, and the closed ring molecule comprises 15-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube and a closed ring molecule where the outer diameter of the nanotube is between 0.7 and 0.8 nm, and the closed ring molecule comprises 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube and a closed ring molecule where the outer diameter of the nanotube is between 0.8 and 0.9 nm, and the closed ring molecule comprises 25-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube and a closed ring molecule where the outer diameter of the nanotube is between 1 and 1.2 nm, and the closed ring molecule comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube and a closed ring molecule where the outer diameter of the nanotube is between 1,2 and 1.4 nm, and the closed ring molecule comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube and a closed ring molecule where the outer diameter of the nanotube is between 1,4 and 1.7 nm, and the closed ring molecule comprises 41-50 atoms, or 51-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube and a closed ring molecule where the outer diameter of the nanotube is between 1,7 and 2 nm, and the closed ring molecule comprises 50-60 atoms, or 61-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube and a closed ring molecule where the outer diameter of the nanotube is between 2 and 2.5 nm, and the closed ring molecule comprises 60-70 atoms, or 71-80 atoms, or 81-90 atoms, or 91-100 atoms, 101-150 atoms, or 151-500 atoms, or 501-5000 atoms.

In another preferred embodiment of the invention, a composite comprises a nanotube and a closed ring molecule where the outer diameter of the nanotube is between 2,5 and 3 nm, and the closed ring molecule comprises 71-80 atoms, or 81-90 atoms, or 91-100 atoms, 101-150 atoms, or 151-500 atoms, or 501-5000 atoms.

In another preferred embodiment of the invention, a composite comprises a nanotube and a closed ring molecule where the outer diameter of the nanotube is between 3 and 5 nm, and the closed ring molecule comprises 80-90 atoms, or 91-100 atoms, 101-150 atoms, or 151-500 atoms, or 501-5000 atoms.

In another preferred embodiment of the invention, a composite comprises a nanotube and a closed ring molecule where the outer diameter of the nanotube is between 5 and 10 nm, and the closed ring molecule comprises 100-150 atoms, or 151-500 atoms, or 501-5000 atoms.

In another preferred embodiment of the invention, a composite comprises a nanotube and a closed ring molecule where the outer diameter of the nanotube is between 10 and 20 nm, and the closed ring molecule comprises 100-300 atoms, or 301-500 atoms, or 501-2000 atoms, or 2001-10000 atoms.

In another preferred embodiment of the invention, a composite comprises a nanotube and a closed ring molecule where the outer diameter of the nanotube is between 20 and 40 nm, and the closed ring molecule comprises 301-500 atoms, or 501-2000 atoms, or 2001-10000 atoms.

In another preferred embodiment of the invention, a composite comprises a nanotube and a closed ring molecule where the outer diameter of the nanotube is between 40 and 400 nm, and the closed ring molecule comprises 500-2000 atoms, or 2001-10000 atoms.

For industrial applications it is often preferred that the composite comprises a polymer, metal, or a ceramic.

Thus, in a preferred embodiment of the invention, a composite comprises a nanotube-ML complex where the outer diameter of the nanotube is between 0.2 and 0.6 nm, and the covalently closed ring of the ML bound to said nanotube comprises 7-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube-ML complex where the outer diameter of the nanotube is between 0.6 and 0.7 nm, and the covalently closed ring of the ML bound to said nanotube comprises 15-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube-ML complex where the outer diameter of the nanotube is between 0.7 and 0.8 nm, and the covalently closed ring of the ML bound to said nanotube comprises 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube-ML complex where the outer diameter of the nanotube is between 0.8 and 0.9 nm, and the covalently closed ring of the ML bound to said nanotube comprises 25-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube-ML complex where the outer diameter of the nanotube is between 1 and 1.2 nm, and the covalently closed ring of the ML bound to said nanotube comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube-ML complex where the outer diameter of the nanotube is between 1,2 and 1.4 nm, and the covalently closed ring of the ML bound to said nanotube comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube-ML complex where the outer diameter of the nanotube is between 1,4 and 1.7 nm, and the covalently closed ring of the ML bound to said nanotube comprises 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube-ML complex where the outer diameter of the nanotube is between 1,7 and 2 nm, and the covalently closed ring of the ML bound to said nanotube comprises 50-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube-ML complex where the outer diameter of the nanotube is between 2 and 2.5 nm, and the covalently closed ring of the ML bound to said nanotube comprises 60-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube-ML complex where the outer diameter of the nanotube is between 2,5 and 3 nm, and the covalently closed ring of the ML bound to said nanotube comprises 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube-ML complex where the outer diameter of the nanotube is between 3 and 5 nm, and the covalently closed ring of the ML bound to said nanotube comprises 80-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube-ML complex where the outer diameter of the nanotube is between 5 and 10 nm, and the covalently closed ring of the ML bound to said nanotube comprises 100-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube-ML complex where the outer diameter of the nanotube is between 10 and 20 nm, and the covalently closed ring of the ML bound to said nanotube comprises 100-300 atoms, or 301-500 atoms, or 501-2000 atoms, or 2001-10000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube-ML complex where the outer diameter of the nanotube is between 20 and 40 nm, and the covalently closed ring of the ML bound to said nanotube comprises 301-500 atoms, or 501-2000 atoms, or 2001-10000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube-ML complex where the outer diameter of the nanotube is between 40 and 400 nm, and the covalently closed ring of the ML bound to said nanotube comprises 500-2000 atoms, or 2001-10000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

From the above consideration it is also clear that in order for a closed ring molecule to associate and bind to a nanotube in a way so that it forms a mechanical bond with the nanotube, and for the resulting ML-nanotube complex to provide the desired characteristics of the composite material within which it resides, the relative sizes of the closed ring and the circumference of the nanotube are important, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

From the above considerations it is clear that the relative sizes of the nanotube's circumference (which is linearly correlated with its outer diameter) and the length of the closed ring (as measured by the number of atoms in the closed ring) may determine the characteristics of the composite material that the closed ring and the nanotube is a part of, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

Thus, in a preferred embodiment of the invention, a composite comprises a nanotube and a closed ring molecule where the outer diameter of the nanotube is between 0.2 and 0.6 nm, and the closed ring molecule comprises 7-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube and a closed ring molecule where the outer diameter of the nanotube is between 0.6 and 0.7 nm, and the closed ring molecule comprises 15-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube and a closed ring molecule where the outer diameter of the nanotube is between 0.7 and 0.8 nm, and the closed ring molecule comprises 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube and a closed ring molecule where the outer diameter of the nanotube is between 0.8 and 0.9 nm, and the closed ring molecule comprises 25-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube and a closed ring molecule where the outer diameter of the nanotube is between 1 and 1.2 nm, and the closed ring molecule comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube and a closed ring molecule where the outer diameter of the nanotube is between 1,2 and 1.4 nm, and the closed ring molecule comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube and a closed ring molecule where the outer diameter of the nanotube is between 1,4 and 1.7 nm, and the closed ring molecule comprises 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube and a closed ring molecule where the outer diameter of the nanotube is between 1,7 and 2 nm, and the closed ring molecule comprises 50-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube and a closed ring molecule where the outer diameter of the nanotube is between 2 and 2.5 nm, and the closed ring molecule comprises 60-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube and a closed ring molecule where the outer diameter of the nanotube is between 2,5 and 3 nm, and the closed ring molecule comprises 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube and a closed ring molecule where the outer diameter of the nanotube is between 3 and 5 nm, and the closed ring molecule comprises 80-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube and a closed ring molecule where the outer diameter of the nanotube is between 5 and 10 nm, and the closed ring molecule comprises 100-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube and a closed ring molecule where the outer diameter of the nanotube is between 10 and 20 nm, and the closed ring molecule comprises 100-300 atoms, or 301-500 atoms, or 501-2000 atoms, or 2001-10000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube and a closed ring molecule where the outer diameter of the nanotube is between 20 and 40 nm, and the closed ring molecule comprises 301-500 atoms, or 501-2000 atoms, or 2001-10000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a nanotube and a closed ring molecule where the outer diameter of the nanotube is between 40 and 400 nm, and the closed ring molecule comprises 500-2000 atoms, or 2001-10000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

### For High-Strength Applications, Carbon Nanotubes are Particularly Preferred Nanotubes.

Thus, in a preferred embodiment of the invention, a composite comprises a carbon nanotube-ML complex where the outer diameter of the carbon nanotube is between 0.2 and 0.6 nm, and the covalently closed ring of the ML bound to said carbon nanotube comprises 7-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube-ML complex where the outer diameter of the carbon nanotube is between 0.6 and 0.7 nm, and the covalently closed ring of the ML bound to said carbon nanotube comprises 15-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube-ML complex where the outer diameter of the carbon nanotube is between 0.7 and 0.8 nm, and the covalently closed ring of the ML bound to said carbon nanotube comprises 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube-ML complex where the outer diameter of the carbon nanotube is between 0.8 and 0.9 nm, and the covalently closed ring of the ML bound to said carbon nanotube comprises 25-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube-ML complex where the outer diameter of the carbon nanotube is between 1 and 1.2 nm, and the covalently closed ring of the ML bound to said carbon nanotube comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube-ML complex where the outer diameter of the carbon nanotube is between 1,2 and 1.4 nm, and the covalently closed ring of the ML bound to said carbon nanotube comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube-ML complex where the outer diameter of the carbon nanotube is between 1,4 and 1.7 nm, and the covalently closed ring of the ML bound to said carbon nanotube comprises 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube-ML complex where the outer diameter of the carbon nanotube is between 1,7 and 2 nm, and the covalently closed ring of the ML bound to said carbon nanotube comprises 50-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube-ML complex where the outer diameter of the carbon nanotube is between 2 and 2.5 nm, and the covalently closed ring of the ML bound to said carbon nanotube comprises 60-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube-ML complex where the outer diameter of the carbon nanotube is between 2,5 and 3 nm, and the covalently closed ring of the ML bound to said carbon nanotube comprises 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube-ML complex where the outer diameter of the carbon nanotube is between 3 and 5 nm, and the covalently closed ring of the ML bound to said carbon nanotube comprises 80-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube-ML complex where the outer diameter of the carbon nanotube is between 5 and 10 nm, and the covalently closed ring of the ML bound to said carbon nanotube comprises 100-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube-ML complex where the outer diameter of the carbon nanotube is between 10 and 20 nm, and the covalently closed ring of the ML bound to said carbon nanotube comprises 100-300 atoms, or 301-500 atoms, or 501-2000 atoms, or 2001-10000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube-ML complex where the outer diameter of the carbon nanotube is between 20 and 40 nm, and the covalently closed ring of the ML bound to said carbon nanotube comprises 301-500 atoms, or 501-2000 atoms, or 2001-10000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube-ML complex where the outer diameter of the carbon nanotube is between 40 and 400 nm, and the covalently closed ring of the ML bound to said carbon nanotube comprises 500-2000 atoms, or 2001-10000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

From the above consideration it is also clear that in order for a closed ring molecule to associate and bind to a carbon nanotube in a way so that it forms a mechanical bond with the carbon nanotube, and for the resulting ML-carbon nanotube complex to provide the desired characteristics of the composite material within which it resides, the relative sizes of the closed ring and the circumference of the carbon nanotube are important, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

From the above considerations it is clear that the relative sizes of the carbon nanotube's circumference (which is linearly correlated with its outer diameter) and the length of the closed ring (as measured by the number of atoms in the closed ring) may determine the characteristics of the composite material that the closed ring and the carbon nanotube is a part of, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

Thus, in a preferred embodiment of the invention, a composite comprises a carbon nanotube and a closed ring molecule where the outer diameter of the carbon nanotube is between 0.2 and 0.6 nm, and the closed ring molecule comprises 7-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube and a closed ring molecule where the outer diameter of the carbon nanotube is between 0.6 and 0.7 nm, and the closed ring molecule comprises 15-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube and a closed ring molecule where the outer diameter of the carbon nanotube is between 0.7 and 0.8 nm, and the closed ring molecule comprises 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube and a closed ring molecule where the outer diameter of the carbon nanotube is between 0.8 and 0.9 nm, and the closed ring molecule comprises 25-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube and a closed ring molecule where the outer diameter of the carbon nanotube is between 1 and 1.2 nm, and the closed ring molecule comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube and a closed ring molecule where the outer diameter of the carbon nanotube is between 1,2 and 1.4 nm, and the closed ring molecule comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube and a closed ring molecule where the outer diameter of the carbon nanotube is between 1,4 and 1.7 nm, and the closed ring molecule comprises 41-50 atoms, or 51-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube and a closed ring molecule where the outer diameter of the carbon nanotube is between 1,7 and 2 nm, and the closed ring molecule comprises 50-60 atoms, or 61-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube and a closed ring molecule where the outer diameter of the carbon nanotube is between 2 and 2.5 nm, and the closed ring molecule comprises 60-70 atoms, or 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube and a closed ring molecule where the outer diameter of the carbon nanotube is between 2,5 and 3 nm, and the closed ring molecule comprises 71-80 atoms, or 81-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube and a closed ring molecule where the outer diameter of the carbon nanotube is between 3 and 5 nm, and the closed ring molecule comprises 80-90 atoms, or 91-100 atoms, 101-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube and a closed ring molecule where the outer diameter of the carbon nanotube is between 5 and 10 nm, and the closed ring molecule comprises 100-150 atoms, or 151-500 atoms, or 501-5000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube and a closed ring molecule where the outer diameter of the carbon nanotube is between 10 and 20 nm, and the closed ring molecule comprises 100-300 atoms, or 301-500 atoms, or 501-2000 atoms, or 2001-10000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube and a closed ring molecule where the outer diameter of the carbon nanotube is between 20 and 40 nm, and the closed ring molecule comprises 301-500 atoms, or 501-2000 atoms, or 2001-10000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

In another preferred embodiment of the invention, a composite comprises a carbon nanotube and a closed ring molecule where the outer diameter of the carbon nanotube is between 40 and 400 nm, and the closed ring molecule comprises 500-2000 atoms, or 2001-10000 atoms, and where the composite further comprises a polymer, metal, or a ceramic, where said polymer, metal, or ceramic is optionally non-covalently or covalently or mechanically linked to the closed ring, and where the polymer optionally is chosen from the following list of polymers: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

Ee. Reaction of Several Precursor-MLs to Form One ML.

Precursor-MLs may be designed in a way that allows two or more precursor-MLs to react to form one ML, i.e. to form a covalently closed ring around a nanotube from two or more precursor-MLs. Parameters affecting the success of such approaches include rigidity of the precursor-ML, flexibility, dissociation constants of the nanotube-binding moieties of the precursor-ML, reactivity of the ring-closing reactive groups and the dependence of reactivity on positioning of the reactive groups, and many more. Appropriate tuning of some of these parameters allow the formation of an ML from 2, 3, 4, 5,6,7, 8, 9 or more precursor-MLs.

The precursor-MLs that end up in the same ML, covalently closed around a nanotube, may be identical or different. In Example JJ36-JJ38 it is shown how just one precursor-ML compound can form MLs around nanotubes with diameters ranging from approximately 1.3 nm to approximately 1.9 nm. The closed ring formed from one precursor is can at most wrap around a nanotube with a diameter of around 1.3 nm. However, to form a closed ring around a nanotube with diameter of 1.9 nm requires at least two precursor-MLs to react to form this closed ring. As MLs in the form of closed rings around the 1.9 nm diameter nanotube can be observed in Example JJ36-JJ38, it can be concluded that two precursor-MLs of this type has reacted to form one ML around a nanotube. Another example of this is described in Example JJ21, B5 where at least 5 precursor-MLs are supposed to react to form an ML in the form of a closed ring around a nanotube.

Thus, by appropriate design of the precursor-MLs and/or appropriate design or choice of nanotube, it is possible to use just one precursor-ML to form MLs of varying sizes around nanotubes, and specifically, to have two or more precursor-MLs react to form one ML.

Preferential Dispersion and/or Anchoring and/or Purification of Subtypes of Nanotubes.

The present invention may be used to differentially disperse, anchor, purify or remove certain nanotubes, based on their chirality, diameter, element composition, or other characteristics that lead to e.g. differential ML-nanotube complex formation of the various different nanotubes present.

For example, when the dispersion and/or anchoring of just one type or category of nanotubes is sought, the present invention can be applied. For example, in a carbon nanotube composite material it may be desirable that only the metallic carbon nanotubes are well dispersed. In such cases MLs may be designed that selectively (i.e. with high specificity) bind to metallic carbon nanotubes, and thereby disperse these efficiently, as opposed to those that are not metallic.

Likewise, if a semiconducting material is sought, the MLs may be designed in a way that allows preferential binding of MLs to carbon nanotubes with semiconducting properties.

Metallic and semiconducting carbon nanotubes fall in separate chirality groups and have rather different surface topologies. DNA-based ligands have been prepared that preferentially bind to one group of chiralities. The design of a ML that preferentially bind to metallic carbon nanotubes could therefore involve including in the ML and/or precursor-ML a chemical moiety known to preferentially bind metallic carbon nanotubes.

If a carbon nanotube product contains several species of carbon nanotubes (i.e. carbon nanotubes of several different chiralities), and the desired characteristics of the carbon nanotubes (e.g. high conductivity) is primarily represented by carbon nanotube species of the product that fall within a given range of diameters, the preferential dispersion of the desired species can be performed by using a mechanical ligand (here: a ring structure) of a certain length (corresponding to a certain maximum diameter). Depending on rigidity or pre-shaped form of the mechanical ligand, the mechanical ligand preferentially may not to any significant extent disperse carbon nanotubes with much smaller or much larger diameters than the maximum diameter of the ring-shaped ML.

Thus, in a preferred embodiment, the mechanical ligand is a covalently closed ring capable of binding to or is bound to a carbon nanotube and has a circumference (i.e. length of the closed ring structure) of less than 2 nm, or from 2.01 nm to 2.5 nm, or from 2.51 nm to 3 nm, or from 3.01 nm to 3.5 nm, or from 3.51 nm to 4 nm, or from 4.01 nm to 4.5 nm, or from 4.51 nm to 5 nm, or from 5.01 nm to 5.5 nm, or from 5.51 nm to 6 nm, or from 6.01 nm to 7 nm, or from 7.01 nm to 9 nm, or from 9.01 nm to 11 nm, or from 11.01 nm to 13 nm, or from 13.01 nm to 15 nm, or from 15.01 nm to 20 nm, or from 20.01 nm to 30 nm, or from 30.01 nm to 50 nm, or from 50 nm to 100 nm, or larger.

In another preferred embodiment, the mechanical ligand is a covalently closed ring capable of binding to or bound to a carbon nanotube, wherein the covalently closed ring comprises less than 10 atoms, or comprises from 11 to 15, or from 16 to 20, or from 21 to 25, or from 26 to 30, or from 31 to 35, or from 36 to 40, or from 41 to 45, or from 46 to 50, or from 51 to 60, or from 61 to 70, or from 71 to 80, or from 81 to 100, or from 101 to 120, or from 121 to 150, or from 151 to 200, or from 201 to 300, or from 301 to 400, or from 401 to 600 atoms, or more than 600 atoms.

In yet another preferred embodiment, the mechanical ligand is a covalently closed ring capable of binding to or bound to a carbon nanotube with a diameter of less than 0.7 nm, or within the range of 0.71-0.8 nm, or within the range of 0.81-0.9 nm, or within the range of 0.91-1 nm, or within the range of 1.01-1.1 nm, or within the range of 1.11-1.2 nm, or within the range of 1.21-1.3 nm, or within the range of 1.31-1.4 nm, or within the range of 1.41-1.5 nm, or within the range of 1.51-1.6 nm, or within the range of 1.61-1.8 nm, or within the range of 1.81-2 nm, or within the range of 2.01-2.3 nm, or within the range of 2.31-2.6 nm, or within the range of 2.61-3 nm, or within the range of 3.01-4 nm, or within the range of 4.01-6 nm, or within the range of 6.01-9 nm, or within the range of 9.01-12 nm, or within the range of 12.01-15 nm, or within the range of 15.01-25 nm, or within the range of 25.01-40 nm, or within the range of 40.01-70 nm, or within the range of 70.01-200 nm, or larger than 200 nm.

In yet another preferred embodiment, the mechanical ligand is a covalently closed ring bound to a single walled carbon nanotube with a diameter of less than 1 nm, or within the range of 1-2 nm, or within the range of 2-3 nm, or within the range of 3-5 nm, or larger than 5 nm.

In the above examples, by choosing particular designs of MLs and/or precursor-MLs, the undesired carbon nanotubes were kept less dispersed in the composite material. If a material comprising less of the undesired carbon nanotubes is sought, a purification step may be introduced while the carbon nanotubes are in solution, prior to formation of the composite material. Such purification may involve preferential binding of ML or precursor-ML to the desired carbon nanotubes, followed by precipitation during centrifugation of the carbon nanotube aggregates (that were not dispersed by the chosen MLs/precursor-MLs), or followed by immobilization of the MLs and/or precursor-MLs, and with these the carbon nanotubes they bind, thus isolating the desired carbon nanotubes from the solution. The resulting solution, enriched for the desired carbon nanotubes, may then be used to prepare a composite material, enriched for the desired carbon nanotubes.

Many of the attractive properties of carbon nanotube composites, such as heat- or electrical conductivity, and strength, are more pronounced for longer carbon nanotubes of small diameter. It is therefore particularly advantageous to form composite materials comprising SE1-ML complexes where SE1 is a carbon nanotube and ML is a covalently closed ring, and where the carbon nanotube preparation has a large aspect ratio.

Thus, in a preferred embodiment, the mechanical ligand is a closed ring and the carbon nanotube is longer than 100 nm, such as longer than 1 μm, such as longer than 10 μm, such as longer than 100 μm, such as longer than 1000 μm, such as longer than 10000 μm, such as longer than 100000 μm.

Thus, in a preferred embodiment, the mechanical ligand is a closed ring and the carbon nanotube has an aspect ratio of at least 10, such as at least 100, such as at least 1000, such as at least 10000, such as at least 100000, such as at least 1000000, such as at least 10000000.

The dispersion of carbon nanotubes is improved in a solution with a higher degree of polydispersity. Thus, it is often advantageous to combine different lengths of carbon nanotubes, in order to increase the dispersion of the carbon nanotubes.

Thus, in a preferred embodiment, a composite material comprises a mechanical ligand that is a closed ring capable of binding to or bound to a carbon nanotube, and comprises carbon nanotubes, 5% of which have a length in the range of 1-10 nm, 5% of which have a length in the range of 10-100 nm, and 5% of which have a length in the range of 100-1000 nm; or
5% of which have a length in the range of 1-100 nm, 5% of which have a length in the range of 100-1000 nm, and 5% of which have a length in the range of 1000-10000 nm; or
5% of which have a length in the range of 1-1000 nm, 5% of which have a length in the range of 1000-10000 nm, and 5% of which have a length in the range of 10000-100000 nm; or
5% of which have a length in the range of 1-10000 nm, 5% of which have a length in the range of 10000-100000 nm, and 5% of which have a length in the range of 100000-1000000 nm; or
5% of which have a length in the range of 1-10 μm, 5% of which have a length in the range of 100-1000 μm, and 5% of which have a length in the range of 1000-100000 μm.

In the above examples, and in the preferred embodiments below, it will often be advantageous to have multiple mechanical ligands bound to each carbon nanotube, such as at least 5 MLs, such as at least 10 MLs, such as at least 20 MLs, such as at least 50 MLs, such as at least 100 MLs, such as at least 200 MLs, such as at least 300 MLs, such as at least 400 MLs, such as at least 500 MLs, such as at least 800 MLs, such as at least 1000 MLs, such as at least 2000 MLs, such as at least 5000 mechanical ligands bound per 1 μm carbon nanotube in a composite material.

In another preferred embodiment, at least 5 MLs, such as at least 10 MLs, such as at least 20 MLs, such as at least 50 MLs, such as at least 100 MLs, such as at least 200 MLs, such as at least 300 MLs, such as at least 400 MLs, such as at least 500 MLs, such as at least 800 MLs, such as at least 1000 MLs, such as at least 2000 MLs, such as at least 5000, such as at least 10.000, such as at least 20.000, such as at least 40.000 mechanical ligands are on average bound per carbon nanotube in a composite material.

Thus, in a preferred embodiment a composite material comprises at least one, such as more than one, such as more than 2, such as more than 3, such as more than 4, such as more than 5, such as more than 6, such as more than 7, such as more than 8, such as more than 9, such as more than 10, such as more than 11, such as more than 12, such as more than 13, such as more than 14 carbon nanotubes with a unique chirality, where said carbon nanotubes with a unique chirality are bound to one or more mechanical ligands.

In another preferred embodiment, a composite material comprises at least 1, such as at least 2, such as at least 3, such as at least 4, such as at least 5, such as at least 6, such as at least 7, such as at least 8, such as at least 9, such as at least 10 carbon nanotubes of mutually different diameters, where each of said carbon nanotubes of mutually different diameters are bound by one or more mechanical ligands.

In another preferred embodiment, more than 5%, such as more than 10%, such as more than 20%, such as more than 30%, such as more than 40%, such as more than 50%, such as more than 60%, such as more than 70%, such as more than 80%, such as more than 90%, such as more than 95%, such as more than 98% of the carbon nanotubes in a composite material is bound by one or more mechanical ligands.

In another preferred embodiment, a composite material comprises carbon nanotubes with a diameter of less than 2 nm that is bound by a mechanical ligand.

In another preferred embodiment, a composite material comprises carbon nanotubes with a diameter of less than 1.7 nm that is bound by a mechanical ligand.

In another preferred embodiment, a composite material comprises carbon nanotubes with a diameter of less than 1.4 nm that is bound by a mechanical ligand.

In another preferred embodiment, a composite material comprises carbon nanotubes with a diameter of less than 1.2 nm that is bound by a mechanical ligand.

In another preferred embodiment, a composite material comprises carbon nanotubes with a diameter of less than 1 nm that is bound by a mechanical ligand.

In another preferred embodiment, a composite material comprises carbon nanotubes with a diameter of less than 0.9 nm that is bound by a mechanical ligand.

In another preferred embodiment, a composite material comprises carbon nanotubes with a diameter of less than 0.8 nm that is bound by a mechanical ligand.

In another preferred embodiment, a composite material comprises carbon nanotubes with a diameter of less than 0.7 nm that is bound by a mechanical ligand.

In another preferred embodiment, a composite material comprises carbon nanotubes with a diameter of less than 0.6 nm that is bound by a mechanical ligand.

In another preferred embodiment, a composite material comprises carbon nanotubes with a diameter of less than 0.5 nm that is bound by a mechanical ligand.

In another preferred embodiment, a composite material comprises carbon nanotubes with a diameter of more than 0.2 nm that is bound by a mechanical ligand.

In another preferred embodiment, a composite material comprises carbon nanotubes with a diameter of more than 0.4 nm that is bound by a mechanical ligand.

In another preferred embodiment, a composite material comprises carbon nanotubes with a diameter of more than 0.6 nm that is bound by a mechanical ligand.

In another preferred embodiment, a composite material comprises carbon nanotubes with a diameter of more than 0.8 nm that is bound by a mechanical ligand.

In another preferred embodiment, a composite material comprises carbon nanotubes with a diameter of more than 1 nm that is bound by a mechanical ligand.

In another preferred embodiment, a composite material comprises carbon nanotubes with a diameter of more than 1.2 nm that is bound by a mechanical ligand.

In another preferred embodiment, a composite material comprises carbon nanotubes with a diameter of more than 1.4 nm that is bound by a mechanical ligand.

In another preferred embodiment, a composite material comprises carbon nanotubes with a diameter of more than 1.6 nm that is bound by a mechanical ligand.

In another preferred embodiment, a composite material comprises carbon nanotubes with a diameter of more than 1.8 nm that is bound by a mechanical ligand.

In another preferred embodiment, a composite material comprises carbon nanotubes with a diameter of more than 2 nm that is bound by a mechanical ligand.

In another preferred embodiment, a composite material comprises carbon nanotubes with a diameter of more than 2.5 nm that is bound by a mechanical ligand.

In another preferred embodiment, a composite material comprises carbon nanotubes with a diameter of more than 3 nm that is bound by a mechanical ligand.

In another preferred embodiment, a composite material comprises carbon nanotubes with a diameter of more than 4 nm that is bound by a mechanical ligand.

In another preferred embodiment, a composite material comprises carbon nanotubes with a diameter of more than 5 nm that is bound by a mechanical ligand.

In another preferred embodiment, a composite material comprises carbon nanotubes with a diameter of more than 7 nm that is bound by a mechanical ligand.

In another preferred embodiment, a composite material comprises carbon nanotubes with a diameter of more than 10 nm that is bound by a mechanical ligand.

In another preferred embodiment, a composite material comprises carbon nanotubes with a diameter of more than 15 nm that is bound by a mechanical ligand.

In another preferred embodiment, a composite material comprises carbon nanotubes with a diameter of more than 20 nm that is bound by a mechanical ligand.

In another preferred embodiment, a composite material comprises carbon nanotubes with a diameter of more than 30 nm that is bound by a mechanical ligand.

In another preferred embodiment, a composite material comprises carbon nanotubes with a diameter of more than 50 nm that is bound by a mechanical ligand.

In another preferred embodiment, a composite material comprises carbon nanotubes with a diameter of less than 0.8 nm that is bound by a mechanical ligand, and carbon nanotubes with a diameter of more than 0.8 nm that is bound by a mechanical ligand.

In another preferred embodiment, a composite material comprises carbon nanotubes with a diameter of less than 1 nm that is bound by a mechanical ligand, and carbon nanotubes with a diameter of more than 1 nm that is bound by a mechanical ligand.

In another preferred embodiment, a composite material comprises carbon nanotubes with a diameter of less than 1.2 nm that is bound by a mechanical ligand, and carbon nanotubes with a diameter of more than 1.2 nm that is bound by a mechanical ligand.

In another preferred embodiment, a composite material comprises carbon nanotubes with a diameter of less than 1.4 nm that is bound by a mechanical ligand, and carbon nanotubes with a diameter of more than 1.4 nm that is bound by a mechanical ligand.

In another preferred embodiment, a composite material comprises carbon nanotubes with a diameter of less than 1.6 nm that is bound by a mechanical ligand, and carbon nanotubes with a diameter of more than 1.6 nm that is bound by a mechanical ligand.

In another preferred embodiment, a composite material comprises carbon nanotubes with a diameter of less than 1.8 nm that is bound by a mechanical ligand, and carbon nanotubes with a diameter of more than 1.8 nm that is bound by a mechanical ligand.

In another preferred embodiment, a composite material comprises carbon nanotubes with a diameter of less than 1 nm that is bound by a mechanical ligand, and carbon nanotubes with a diameter of more than 1.3 nm that is bound by a mechanical ligand.

In another preferred embodiment, a composite material comprises carbon nanotubes with a diameter of less than 1 nm that is bound by a mechanical ligand, and carbon nanotubes with a diameter of more than 1.5 nm that is bound by a mechanical ligand.

In another preferred embodiment, a composite material comprises carbon nanotubes with a diameter of less than 1.2 nm that is bound by a mechanical ligand, and carbon nanotubes with a diameter of more than 1.6 nm that is bound by a mechanical ligand.

In another preferred embodiment, a composite material comprises carbon nanotubes with a diameter of less than 1 nm that is bound by a mechanical ligand, and carbon nanotubes with a diameter of more than 2 nm that is bound by a mechanical ligand.

In another preferred embodiment, a composite material comprises carbon nanotubes with a diameter of less than 1 nm that is bound by a mechanical ligand, and carbon nanotubes with a diameter of more than 3 nm that is bound by a mechanical ligand.

In another preferred embodiment, a composite material comprises mechanical ligands bound to metallic carbon nanotubes, where the ratio of metallic to non-metallic carbon nanotubes in the composite is less than 0.000001 or is in the range of 0.000001-0.00001 or is in the range of 0.00001-0.0001 or is in the range of 0.0001-0.001 or is in the range of 0.001-0.01 or is in the range of 0.01-0.1 or is in the range of 0.1-1 or is in the range of 1-10 or is in the range of 10-100 or is in the range of 100-1.000 or is in the range of 1.000-10.000 or is in the range of 10.000-100.000, or is higher than 100.000.

In yet another preferred embodiment, more than 0.001%, such as more than 0.01%, such as more than 0.1%, such as more than 1%, such as more than 5%, such as more than 10%, such as more than 20%, such as more than 20%, such as more than 30%, such as more than 40%, such as more than 50%, such as more than 60%, such as more than 70%, such as more than 80%, such as more than 90%, such as more than 95%, such as more than 97%, such as more than 99% of the nanotubes in a composite material are bound by a mechanical ligand.

In yet another preferred embodiment, more than 0.001%, such as more than 0.01%, such as more than 0.1%, such as more than 1%, such as more than 5%, such as more than 10%, such as more than 20%, such as more than 20%, such as more than 30%, such as more than 40%, such as more than 50%, such as more than 60%, such as more than 70%, such as more than 80%, such as more than 90%, such as more than 95%, such as more than 97%, such as more than 99% of the carbon nanotubes in a composite material are bound by a mechanical ligand.

Ff. In Situ Polymerization and Formation of CNT-Polymer Composites, Including Composites of High Electric Conductivity and/or High Heat Conductivity, Often Comprise Residual Chemical Structures that Influence the Characteristics of the Composite.

In situ polymerization—here defined as polymerization in the presence of SE1 and/or ML—is a very useful and industrially relevant method for preparing composites. In cases where the SE1-ML complex is not easily dispersed in the relevant solvent or matrix, in situ polymerization may help to more efficiently disperse the SE-ML complex.

Examples CC1-CC6 and CC19-21 describe such in situ polymerization experiments. In these examples SE1 is a nanotube, the ML is a closed ring, and the SE1-ML complex is a closed ring wrapped around a nanotube. Examples CC1-CC6 and CC19-21 seem to suggest that in situ polymerization improves the dispersion of the SE1-ML complexes, possibly as a result of the direct interaction with the growing polymer and the SE1-ML complexes (which may to some extent be agglomerated), or alternatively, upon association of the SE1-ML complex and SE2 when the suspension is stirred which may release individual SE1-ML complexes from the agglomerate.

In preferred embodiments of the invention, in situ polymerization reactions (polymerization reactions in the presence of ML and/or SE1 such as e.g. CNT, SWNT, MWNT, and ML), may either involve i) polymerization initiated and terminated in solution, in which case the resulting polymer may become non-covalently attached to the SE1-ML complex; or ii) polymerization initiated on (a functional group of) the ML, and terminated in solution (here termed ‘grafting from’), in which case the resulting polymer may become covalently linked to the SE1-ML complex at one end of the polymer and the other end being in solution; or iii) polymerization is initiated in solution but terminates on (a functional group of) the ML (here termed ‘grafting to’), in which case the resulting polymer may become covalently attached to the ML at one end and the other end being in solution; or iv) polymerization is initiated on (a functional group of) a ML and terminates on (a functional group of) a ML, in which case the polymer will bridge two MLs, possibly complexed to different SE1s, where in the latter case the polymer will serve the function of cross-linking two SE1s.

Polymerization reactions may involve a monomer (capable of reacting with another monomer, thereby forming a growing polymer), an initiator, further reagent(s), catalyst(s), and often works best within a certain range of conditions (pH-range, salt concentration range, temperature range, etc). Furthermore, the monomer, initiator, further reagent(s), catalysts, terminator, and salts, etc., or derivatives of these, or by-products of the polymerization reaction, often remain in the composite, i.e. is not removed following polymerization. Likewise, precursor-MLs that have not been converted into MLs, may also be present at significant concentration. These chemical structures (e.g. extended chains, precursor-MLs, minerals, metal complexes, ions or polar groups) will often be present at significant concentration in the final composite and may therefore affect the characteristics of the composite. Some such chemical structures may e.g. function as plasticizers, affect the mechanical characteristics, increase ductility or decrease strength, and/or affect the electrical- or heat conductivity. Thus, the content of such by-products of the polymerization reaction generally influence the characteristics of the composite and are therefore important parameters to include when describing the composites of the present invention.

Example by-products of the in situ polymerization reactions and composite generation protocols include the following:
Hydrochloric acid (HCl), produced during polyamide formation from acid chlorides and amines, or NaCl if the product is treated with NaOH.
Water (H2O) produced during polyester formation from acids and alcohols or produced during polyamide formation from acids and amines.
Amine (—NH2), CO2, and urea (—R—NH—C(O)—NH—R) formation during synthesis of polyurethanes
NC—C(CH3)2-C(CH3)2-CN produced initiator radical recombination of two molecules of NC—C*(CH3)2—where C* denotes a carbon radical—during radical polymerization using azobisisobutyronitrile (AIBN).
Biphenyl produced during free radical polymerization using benzoyl peroxide.

In some embodiments of the invention, the final composite comprises SE1s that are complexed to a large number of MLs. A near-complete coating of the SE1 with a large number of MLs may be advantageous since this may help disperse the SE1 efficiently during the composite production process. However, during the later stages of the production process or in the final composite it may be advantageous to separate the SE1 and ML from each other, and optionally remove some or all of the MLs.

The dissociation of the SE1-ML complex is described elsewhere in this application. As described, in preferred embodiments of the invention the dissociation of the SE1-ML complex may be mediated by e.g. cleavage of the ML, e.g. by addition of a protease that may cleave a ML comprising a polypeptide moiety; or addition of base to cleave a ML comprising an ester bond; or exposure to UV light, to cleave a ML that carries a UV cleavable chemical moiety; or partial or full degradation of the ML.

One of the situations where it is sometimes advantageous to dissociate the SE1-ML complex is in the case of a composite where the SE1 is a nanotube such as a carbon nanotube and the ML is a closed ring, wrapped around the nanotube. In this case the closed rings complexed to the nanotube may have an insulating effect and thereby decrease the electrical- and heat conductivity of the individual nanotubes and hence of the composite.

Thus, in a preferred embodiment of the invention, the ML is cleaved to dissociate the SE1-ML complex and in this way increase the conductivity of the composite material wherein it resides. If desired, the cleaved ML can then be removed from the composite by purification, or it can be fully degraded. In any case the resulting composite may be more conductive for both heat and electricity.

The composites resulting from such treatment may thus display high electrical- and/or heat conductivity, since the nanotubes are not coated by MLs, and in some cases the MLs have been removed entirely from the composite.

Thus, in preferred embodiments of the present invention, the ML is important for the production of high-quality composites, but is dissociated from the SE1 or removed entirely from the composite at a later stage of the production process, in order to e.g. obtain composites of high heat or electrical conductivity. This is particularly relevant for nanotube composites.

In a preferred embodiment of the invention, polymer-based composites such as nanotube-polymer composites that have been made by in situ polymerization may additionally contain chemical structures, such as monomer derivatives and by-products from the polymerization process, that serve e.g. a plasticizing or stabilizing function.

### Items

The following items are particularly preferred embodiments of the present invention.

### A. Absence of Large Aggregates

Item A-1. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-2. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-3. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-4. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-5. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-6. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-7. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-8. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-9. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-10. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-11. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-12. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-13. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-14. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-15. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-16. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-17. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-18. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-19. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-20. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-21. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-22. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-23. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-24. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-25. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-26. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-27. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-28. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-29. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-30. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-31. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-32. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-33. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-34. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-35. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-36. In a preferred embodiment, a composite, a nanotube preparation, or a collection of CMUs comprises nanotubes of an average length larger than 1E−8 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-37. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-38. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-39. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-40. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-41. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-42. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-43. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-44. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-45. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-46. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-47. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-48. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-49. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-50. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-51. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-52. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-53. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-54. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-55. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-56. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-57. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-58. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-59. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-60. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-61. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-62. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-63. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-64. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-65. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-66. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-67. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-68. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-69. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-70. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-71. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-72. In a preferred embodiment, a composite, a nanotube preparation, or a collection of CMUs comprises nanotubes of an average length larger than 1E−8 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-73. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 100 nm3 and does not comprise any aggregates with a smallest dimension larger than 2 nm3.

Item A-74. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 300 nm3 and does not comprise any aggregates with a smallest dimension larger than 3 nm3.

Item A-75. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-76. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-77. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-78. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-79. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 100 nm3 and does not comprise any aggregates with a smallest dimension larger than 2 nm3.

Item A-80. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 300 nm3 and does not comprise any aggregates with a smallest dimension larger than 3 nm3.

Item A-81. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-82. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-83. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-84. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-85. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 100 nm3 and does not comprise any aggregates with a smallest dimension larger than 2 nm3.

Item A-86. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 300 nm3 and does not comprise any aggregates with a smallest dimension larger than 3 nm3.

Item A-87. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-88. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-89. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-90. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-91. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 100 nm3 and does not comprise any aggregates with a smallest dimension larger than 2 nm3.

Item A-92. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 300 nm3 and does not comprise any aggregates with a smallest dimension larger than 3 nm3.

Item A-93. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-94. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-95. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-96. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-97. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 100 nm3 and does not comprise any aggregates with a smallest dimension larger than 2 nm3.

Item A-98. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 300 nm3 and does not comprise any aggregates with a smallest dimension larger than 3 nm3.

Item A-99. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-100. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-101. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-102. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-103. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 100 nm3 and does not comprise any aggregates with a smallest dimension larger than 2 nm3.

Item A-104. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 300 nm3 and does not comprise any aggregates with a smallest dimension larger than 3 nm3.

Item A-105. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-106. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-107. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-108. In a preferred embodiment, a composite, a nanotube preparation, or a collection of CMUs comprises nanotubes of an average length larger than 1E−8 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-109. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 100 nm3 and does not comprise any aggregates with a smallest dimension larger than 2 nm3.

Item A-110. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 300 nm3 and does not comprise any aggregates with a smallest dimension larger than 3 nm3.

Item A-111. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-112. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-113. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-114. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-115. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 100 nm3 and does not comprise any aggregates with a smallest dimension larger than 2 nm3.

Item A-116. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 300 nm3 and does not comprise any aggregates with a smallest dimension larger than 3 nm3.

Item A-117. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-118. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-119. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-120. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-121. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 100 nm3 and does not comprise any aggregates with a smallest dimension larger than 2 nm3.

Item A-122. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 300 nm3 and does not comprise any aggregates with a smallest dimension larger than 3 nm3.

Item A-123. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-124. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-125. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-126. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-127. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 100 nm3 and does not comprise any aggregates with a smallest dimension larger than 2 nm3.

Item A-128. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 300 nm3 and does not comprise any aggregates with a smallest dimension larger than 3 nm3.

Item A-129. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-130. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-131. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-132. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-133. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 100 nm3 and does not comprise any aggregates with a smallest dimension larger than 2 nm3.

Item A-134. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 300 nm3 and does not comprise any aggregates with a smallest dimension larger than 3 nm3.

Item A-135. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-136. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-137. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-138. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-139. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 100 nm3 and does not comprise any aggregates with a smallest dimension larger than 2 nm3.

Item A-140. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 300 nm3 and does not comprise any aggregates with a smallest dimension larger than 3 nm3.

Item A-141. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-142. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-143. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-144. In a preferred embodiment, a composite, a nanotube preparation, or a collection of CMUs comprises nanotubes of an average length larger than 1E−8 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-145. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 100 nm3 and does not comprise any aggregates with a smallest dimension larger than 2 nm3.

Item A-146. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 300 nm3 and does not comprise any aggregates with a smallest dimension larger than 3 nm3.

Item A-147. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-148. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-149. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-150. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-151. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 100 nm3 and does not comprise any aggregates with a smallest dimension larger than 2 nm3.

Item A-152. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 300 nm3 and does not comprise any aggregates with a smallest dimension larger than 3 nm3.

Item A-153. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-154. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-155. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-156. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-157. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 100 nm3 and does not comprise any aggregates with a smallest dimension larger than 2 nm3.

Item A-158. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 300 nm3 and does not comprise any aggregates with a smallest dimension larger than 3 nm3.

Item A-159. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-160. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-161. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-162. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-163. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 100 nm3 and does not comprise any aggregates with a smallest dimension larger than 2 nm3.

Item A-164. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 300 nm3 and does not comprise any aggregates with a smallest dimension larger than 3 nm3.

Item A-165. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-166. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-167. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-168. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-169. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 100 nm3 and does not comprise any aggregates with a smallest dimension larger than 2 nm3.

Item A-170. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 300 nm3 and does not comprise any aggregates with a smallest dimension larger than 3 nm3.

Item A-171. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-172. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-173. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-174. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-175. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 100 nm3 and does not comprise any aggregates with a smallest dimension larger than 2 nm3.

Item A-176. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 300 nm3 and does not comprise any aggregates with a smallest dimension larger than 3 nm3.

Item A-177. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-178. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-179. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-180. In a preferred embodiment, a composite, a nanotube preparation, or a collection of CMUs comprises nanotubes of an average length larger than 1E−8 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-181. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 100 nm3 and does not comprise any aggregates with a smallest dimension larger than 2 nm3.

Item A-182. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 300 nm3 and does not comprise any aggregates with a smallest dimension larger than 3 nm3.

Item A-183. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-184. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-185. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-186. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-187. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 100 nm3 and does not comprise any aggregates with a smallest dimension larger than 2 nm3.

Item A-188. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 300 nm3 and does not comprise any aggregates with a smallest dimension larger than 3 nm3.

Item A-189. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-190. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-191. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-192. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-193. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 100 nm3 and does not comprise any aggregates with a smallest dimension larger than 2 nm3.

Item A-194. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 300 nm3 and does not comprise any aggregates with a smallest dimension larger than 3 nm3.

Item A-195. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-196. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-197. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-198. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-199. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 100 nm3 and does not comprise any aggregates with a smallest dimension larger than 2 nm3.

Item A-200. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 300 nm3 and does not comprise any aggregates with a smallest dimension larger than 3 nm3.

Item A-201. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-202. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-203. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-204. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-205. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 100 nm3 and does not comprise any aggregates with a smallest dimension larger than 2 nm3.

Item A-206. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 300 nm3 and does not comprise any aggregates with a smallest dimension larger than 3 nm3.

Item A-207. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-208. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-209. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-210. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-211. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 100 nm3 and does not comprise any aggregates with a smallest dimension larger than 2 nm3.

Item A-212. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 300 nm3 and does not comprise any aggregates with a smallest dimension larger than 3 nm3.

Item A-213. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-214. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-215. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-216. In a preferred embodiment, a composite, a nanotube preparation, or a collection of CMUs comprises nanotubes of an average length larger than 1E−8 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-217. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 100 nm3 and does not comprise any aggregates with a smallest dimension larger than 2 nm3.

Item A-218. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 300 nm3 and does not comprise any aggregates with a smallest dimension larger than 3 nm3.

Item A-219. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-220. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-221. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-222. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-223. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 100 nm3 and does not comprise any aggregates with a smallest dimension larger than 2 nm3.

Item A-224. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 300 nm3 and does not comprise any aggregates with a smallest dimension larger than 3 nm3.

Item A-225. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-226. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-227. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-228. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-229. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 100 nm3 and does not comprise any aggregates with a smallest dimension larger than 2 nm3.

Item A-230. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 300 nm3 and does not comprise any aggregates with a smallest dimension larger than 3 nm3.

Item A-231. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-232. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-233. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-234. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-235. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 100 nm3 and does not comprise any aggregates with a smallest dimension larger than 2 nm3.

Item A-236. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 300 nm3 and does not comprise any aggregates with a smallest dimension larger than 3 nm3.

Item A-237. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-238. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-239. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-240. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-241. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 100 nm3 and does not comprise any aggregates with a smallest dimension larger than 2 nm3.

Item A-242. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 300 nm3 and does not comprise any aggregates with a smallest dimension larger than 3 nm3.

Item A-243. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-244. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-245. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-246. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-247. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 100 nm3 and does not comprise any aggregates with a smallest dimension larger than 2 nm3.

Item A-248. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 300 nm3 and does not comprise any aggregates with a smallest dimension larger than 3 nm3.

Item A-249. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-250. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-251. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-252. In a preferred embodiment, a composite, a nanotube preparation, or a collection of CMUs comprises nanotubes of an average length larger than 1E−8 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-253. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 100 nm3 and does not comprise any aggregates with a smallest dimension larger than 2 nm3.

Item A-254. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 300 nm3 and does not comprise any aggregates with a smallest dimension larger than 3 nm3.

Item A-255. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-256. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-257. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-258. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-259. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 100 nm3 and does not comprise any aggregates with a smallest dimension larger than 2 nm3.

Item A-260. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 300 nm3 and does not comprise any aggregates with a smallest dimension larger than 3 nm3.

Item A-261. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-262. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-263. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-264. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-265. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 100 nm3 and does not comprise any aggregates with a smallest dimension larger than 2 nm3.

Item A-266. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 300 nm3 and does not comprise any aggregates with a smallest dimension larger than 3 nm3.

Item A-267. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-268. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-269. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-270. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-271. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 100 nm3 and does not comprise any aggregates with a smallest dimension larger than 2 nm3.

Item A-272. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 300 nm3 and does not comprise any aggregates with a smallest dimension larger than 3 nm3.

Item A-273. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-274. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-275. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-276. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-277. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 100 nm3 and does not comprise any aggregates with a smallest dimension larger than 2 nm3.

Item A-278. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 300 nm3 and does not comprise any aggregates with a smallest dimension larger than 3 nm3.

Item A-279. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-280. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-281. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-282. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-283. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 100 nm3 and does not comprise any aggregates with a smallest dimension larger than 2 nm3.

Item A-284. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 300 nm3 and does not comprise any aggregates with a smallest dimension larger than 3 nm3.

Item A-285. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-286. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-287. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-288. In a preferred embodiment, a composite, a nanotube preparation, or a collection of CMUs comprises nanotubes of an average length larger than 1E−8 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-289. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-290. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-291. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-292. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-293. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-294. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-295. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-296. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-297. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-298. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-299. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-300. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-301. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-302. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-303. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-304. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-305. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-306. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-307. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-308. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-309. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-310. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-311. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-312. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-313. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-314. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-315. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-316. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-317. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-318. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-319. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-320. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-321. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-322. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-323. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-324. In a preferred embodiment, a composite, a nanotube preparation, or a collection of CMUs comprises nanotubes of an average length larger than 1E−7 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-325. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-326. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-327. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-328. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-329. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-330. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-331. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-332. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-333. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-334. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-335. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-336. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-337. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-338. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-339. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-340. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-341. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-342. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-343. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-344. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-345. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-346. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-347. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-348. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-349. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-350. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-351. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-352. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-353. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-354. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-355. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-356. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-357. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-358. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-359. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-360. In a preferred embodiment, a composite, a nanotube preparation, or a collection of CMUs comprises nanotubes of an average length larger than 1E−7 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-361. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 100 nm3 and does not comprise any aggregates with a smallest dimension larger than 2 nm3.

Item A-362. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 300 nm3 and does not comprise any aggregates with a smallest dimension larger than 3 nm3.

Item A-363. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-364. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-365. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-366. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-367. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 100 nm3 and does not comprise any aggregates with a smallest dimension larger than 2 nm3.

Item A-368. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 300 nm3 and does not comprise any aggregates with a smallest dimension larger than 3 nm3.

Item A-369. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-370. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-371. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-372. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-373. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 100 nm3 and does not comprise any aggregates with a smallest dimension larger than 2 nm3.

Item A-374. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 300 nm3 and does not comprise any aggregates with a smallest dimension larger than 3 nm3.

Item A-375. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-376. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-377. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-378. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-379. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 100 nm3 and does not comprise any aggregates with a smallest dimension larger than 2 nm3.

Item A-380. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 300 nm3 and does not comprise any aggregates with a smallest dimension larger than 3 nm3.

Item A-381. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-382. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-383. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-384. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-385. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 100 nm3 and does not comprise any aggregates with a smallest dimension larger than 2 nm3.

Item A-386. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 300 nm3 and does not comprise any aggregates with a smallest dimension larger than 3 nm3.

Item A-387. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-388. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-389. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-390. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-391. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 100 nm3 and does not comprise any aggregates with a smallest dimension larger than 2 nm3.

Item A-392. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 300 nm3 and does not comprise any aggregates with a smallest dimension larger than 3 nm3.

Item A-393. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-394. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-395. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-396. In a preferred embodiment, a composite, a nanotube preparation, or a collection of CMUs comprises nanotubes of an average length larger than 1E−7 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-397. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 100 nm3 and does not comprise any aggregates with a smallest dimension larger than 2 nm3.

Item A-398. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 300 nm3 and does not comprise any aggregates with a smallest dimension larger than 3 nm3.

Item A-399. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-400. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-401. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-402. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-403. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 100 nm3 and does not comprise any aggregates with a smallest dimension larger than 2 nm3.

Item A-404. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 300 nm3 and does not comprise any aggregates with a smallest dimension larger than 3 nm3.

Item A-405. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-406. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-407. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-408. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-409. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 100 nm3 and does not comprise any aggregates with a smallest dimension larger than 2 nm3.

Item A-410. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 300 nm3 and does not comprise any aggregates with a smallest dimension larger than 3 nm3.

Item A-411. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-412. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-413. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-414. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-415. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 100 nm3 and does not comprise any aggregates with a smallest dimension larger than 2 nm3.

Item A-416. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 300 nm3 and does not comprise any aggregates with a smallest dimension larger than 3 nm3.

Item A-417. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-418. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-419. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-420. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-421. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 100 nm3 and does not comprise any aggregates with a smallest dimension larger than 2 nm3.

Item A-422. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 300 nm3 and does not comprise any aggregates with a smallest dimension larger than 3 nm3.

Item A-423. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-424. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-425. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-426. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-427. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 100 nm3 and does not comprise any aggregates with a smallest dimension larger than 2 nm3.

Item A-428. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 300 nm3 and does not comprise any aggregates with a smallest dimension larger than 3 nm3.

Item A-429. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-430. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-431. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-432. In a preferred embodiment, a composite, a nanotube preparation, or a collection of CMUs comprises nanotubes of an average length larger than 1E−7 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-433. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 100 nm3 and does not comprise any aggregates with a smallest dimension larger than 2 nm3.

Item A-434. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 300 nm3 and does not comprise any aggregates with a smallest dimension larger than 3 nm3.

Item A-435. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-436. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-437. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-438. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-439. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 100 nm3 and does not comprise any aggregates with a smallest dimension larger than 2 nm3.

Item A-440. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 300 nm3 and does not comprise any aggregates with a smallest dimension larger than 3 nm3.

Item A-441. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-442. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-443. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-444. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-445. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 100 nm3 and does not comprise any aggregates with a smallest dimension larger than 2 nm3.

Item A-446. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 300 nm3 and does not comprise any aggregates with a smallest dimension larger than 3 nm3.

Item A-447. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-448. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-449. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-450. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-451. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 100 nm3 and does not comprise any aggregates with a smallest dimension larger than 2 nm3.

Item A-452. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 300 nm3 and does not comprise any aggregates with a smallest dimension larger than 3 nm3.

Item A-453. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-454. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-455. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-456. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-457. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 100 nm3 and does not comprise any aggregates with a smallest dimension larger than 2 nm3.

Item A-458. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 300 nm3 and does not comprise any aggregates with a smallest dimension larger than 3 nm3.

Item A-459. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-460. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-461. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-462. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-463. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 100 nm3 and does not comprise any aggregates with a smallest dimension larger than 2 nm3.

Item A-464. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 300 nm3 and does not comprise any aggregates with a smallest dimension larger than 3 nm3.

Item A-465. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-466. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-467. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-468. In a preferred embodiment, a composite, a nanotube preparation, or a collection of CMUs comprises nanotubes of an average length larger than 1E−7 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-469. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 100 nm3 and does not comprise any aggregates with a smallest dimension larger than 2 nm3.

Item A-470. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 300 nm3 and does not comprise any aggregates with a smallest dimension larger than 3 nm3.

Item A-471. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-472. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-473. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-474. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-475. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 100 nm3 and does not comprise any aggregates with a smallest dimension larger than 2 nm3.

Item A-476. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 300 nm3 and does not comprise any aggregates with a smallest dimension larger than 3 nm3.

Item A-477. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-478. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-479. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-480. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-481. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 100 nm3 and does not comprise any aggregates with a smallest dimension larger than 2 nm3.

Item A-482. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 300 nm3 and does not comprise any aggregates with a smallest dimension larger than 3 nm3.

Item A-483. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-484. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-485. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-486. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-487. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 100 nm3 and does not comprise any aggregates with a smallest dimension larger than 2 nm3.

Item A-488. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 300 nm3 and does not comprise any aggregates with a smallest dimension larger than 3 nm3.

Item A-489. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-490. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-491. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-492. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-493. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 100 nm3 and does not comprise any aggregates with a smallest dimension larger than 2 nm3.

Item A-494. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 300 nm3 and does not comprise any aggregates with a smallest dimension larger than 3 nm3.

Item A-495. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-496. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-497. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-498. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-499. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 100 nm3 and does not comprise any aggregates with a smallest dimension larger than 2 nm3.

Item A-500. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 300 nm3 and does not comprise any aggregates with a smallest dimension larger than 3 nm3.

Item A-501. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-502. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-503. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-504. In a preferred embodiment, a composite, a nanotube preparation, or a collection of CMUs comprises nanotubes of an average length larger than 1E−7 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-505. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 100 nm3 and does not comprise any aggregates with a smallest dimension larger than 2 nm3.

Item A-506. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 300 nm3 and does not comprise any aggregates with a smallest dimension larger than 3 nm3.

Item A-507. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-508. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-509. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-510. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-511. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 100 nm3 and does not comprise any aggregates with a smallest dimension larger than 2 nm3.

Item A-512. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 300 nm3 and does not comprise any aggregates with a smallest dimension larger than 3 nm3.

Item A-513. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-514. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-515. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-516. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-517. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 100 nm3 and does not comprise any aggregates with a smallest dimension larger than 2 nm3.

Item A-518. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 300 nm3 and does not comprise any aggregates with a smallest dimension larger than 3 nm3.

Item A-519. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-520. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-521. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-522. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-523. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 100 nm3 and does not comprise any aggregates with a smallest dimension larger than 2 nm3.

Item A-524. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 300 nm3 and does not comprise any aggregates with a smallest dimension larger than 3 nm3.

Item A-525. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-526. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-527. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-528. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-529. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 100 nm3 and does not comprise any aggregates with a smallest dimension larger than 2 nm3.

Item A-530. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 300 nm3 and does not comprise any aggregates with a smallest dimension larger than 3 nm3.

Item A-531. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-532. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-533. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-534. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-535. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 100 nm3 and does not comprise any aggregates with a smallest dimension larger than 2 nm3.

Item A-536. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 300 nm3 and does not comprise any aggregates with a smallest dimension larger than 3 nm3.

Item A-537. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-538. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-539. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-540. In a preferred embodiment, a composite, a nanotube preparation, or a collection of CMUs comprises nanotubes of an average length larger than 1E−7 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-541. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 100 nm3 and does not comprise any aggregates with a smallest dimension larger than 2 nm3.

Item A-542. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 300 nm3 and does not comprise any aggregates with a smallest dimension larger than 3 nm3.

Item A-543. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-544. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-545. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-546. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-547. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 100 nm3 and does not comprise any aggregates with a smallest dimension larger than 2 nm3.

Item A-548. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 300 nm3 and does not comprise any aggregates with a smallest dimension larger than 3 nm3.

Item A-549. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-550. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-551. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-552. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-553. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 100 nm3 and does not comprise any aggregates with a smallest dimension larger than 2 nm3.

Item A-554. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 300 nm3 and does not comprise any aggregates with a smallest dimension larger than 3 nm3.

Item A-555. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-556. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-557. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-558. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-559. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 100 nm3 and does not comprise any aggregates with a smallest dimension larger than 2 nm3.

Item A-560. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 300 nm3 and does not comprise any aggregates with a smallest dimension larger than 3 nm3.

Item A-561. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-562. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-563. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-564. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-565. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 100 nm3 and does not comprise any aggregates with a smallest dimension larger than 2 nm3.

Item A-566. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 300 nm3 and does not comprise any aggregates with a smallest dimension larger than 3 nm3.

Item A-567. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-568. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-569. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-570. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-571. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 100 nm3 and does not comprise any aggregates with a smallest dimension larger than 2 nm3.

Item A-572. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 300 nm3 and does not comprise any aggregates with a smallest dimension larger than 3 nm3.

Item A-573. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-574. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-575. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-576. In a preferred embodiment, a composite, a nanotube preparation, or a collection of CMUs comprises nanotubes of an average length larger than 1E−7 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-577. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-578. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-579. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-580. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-581. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-582. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-583. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-584. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-585. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-586. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-587. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-588. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-589. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-590. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-591. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-592. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-593. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-594. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-595. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-596. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-597. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-598. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-599. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-600. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-601. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-602. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-603. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-604. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-605. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-606. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-607. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-608. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-609. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-610. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-611. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-612. In a preferred embodiment, a composite, a nanotube preparation, or a collection of CMUs comprises nanotubes of an average length larger than 1E−6 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-613. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-614. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-615. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-616. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-617. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-618. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-619. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-620. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-621. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-622. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-623. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-624. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-625. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-626. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-627. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-628. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-629. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-630. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-631. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-632. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-633. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-634. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-635. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-636. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-637. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-638. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-639. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-640. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-641. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-642. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-643. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-644. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-645. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-646. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-647. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-648. In a preferred embodiment, a composite, a nanotube preparation, or a collection of CMUs comprises nanotubes of an average length larger than 1E−6 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-649. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 100 nm3 and does not comprise any aggregates with a smallest dimension larger than 2 nm3.

Item A-650. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 300 nm3 and does not comprise any aggregates with a smallest dimension larger than 3 nm3.

Item A-651. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-652. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-653. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-654. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-655. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 100 nm3 and does not comprise any aggregates with a smallest dimension larger than 2 nm3.

Item A-656. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 300 nm3 and does not comprise any aggregates with a smallest dimension larger than 3 nm3.

Item A-657. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-658. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-659. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-660. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-661. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 100 nm3 and does not comprise any aggregates with a smallest dimension larger than 2 nm3.

Item A-662. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 300 nm3 and does not comprise any aggregates with a smallest dimension larger than 3 nm3.

Item A-663. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-664. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-665. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-666. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-667. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 100 nm3 and does not comprise any aggregates with a smallest dimension larger than 2 nm3.

Item A-668. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 300 nm3 and does not comprise any aggregates with a smallest dimension larger than 3 nm3.

Item A-669. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-670. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-671. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-672. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-673. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 100 nm3 and does not comprise any aggregates with a smallest dimension larger than 2 nm3.

Item A-674. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 300 nm3 and does not comprise any aggregates with a smallest dimension larger than 3 nm3.

Item A-675. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-676. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-677. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-678. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-679. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 100 nm3 and does not comprise any aggregates with a smallest dimension larger than 2 nm3.

Item A-680. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 300 nm3 and does not comprise any aggregates with a smallest dimension larger than 3 nm3.

Item A-681. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-682. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-683. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-684. In a preferred embodiment, a composite, a nanotube preparation, or a collection of CMUs comprises nanotubes of an average length larger than 1E−6 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-685. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 100 nm3 and does not comprise any aggregates with a smallest dimension larger than 2 nm3.

Item A-686. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 300 nm3 and does not comprise any aggregates with a smallest dimension larger than 3 nm3.

Item A-687. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-688. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-689. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-690. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-691. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 100 nm3 and does not comprise any aggregates with a smallest dimension larger than 2 nm3.

Item A-692. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 300 nm3 and does not comprise any aggregates with a smallest dimension larger than 3 nm3.

Item A-693. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-694. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-695. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-696. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-697. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 100 nm3 and does not comprise any aggregates with a smallest dimension larger than 2 nm3.

Item A-698. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 300 nm3 and does not comprise any aggregates with a smallest dimension larger than 3 nm3.

Item A-699. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-700. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-701. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-702. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-703. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 100 nm3 and does not comprise any aggregates with a smallest dimension larger than 2 nm3.

Item A-704. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 300 nm3 and does not comprise any aggregates with a smallest dimension larger than 3 nm3.

Item A-705. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-706. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-707. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-708. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-709. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 100 nm3 and does not comprise any aggregates with a smallest dimension larger than 2 nm3.

Item A-710. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 300 nm3 and does not comprise any aggregates with a smallest dimension larger than 3 nm3.

Item A-711. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-712. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-713. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-714. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-715. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 100 nm3 and does not comprise any aggregates with a smallest dimension larger than 2 nm3.

Item A-716. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 300 nm3 and does not comprise any aggregates with a smallest dimension larger than 3 nm3.

Item A-717. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-718. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-719. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-720. In a preferred embodiment, a composite, a nanotube preparation, or a collection of CMUs comprises nanotubes of an average length larger than 1E−6 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-721. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 100 nm3 and does not comprise any aggregates with a smallest dimension larger than 2 nm3.

Item A-722. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 300 nm3 and does not comprise any aggregates with a smallest dimension larger than 3 nm3.

Item A-723. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-724. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-725. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-726. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-727. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 100 nm3 and does not comprise any aggregates with a smallest dimension larger than 2 nm3.

Item A-728. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 300 nm3 and does not comprise any aggregates with a smallest dimension larger than 3 nm3.

Item A-729. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-730. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-731. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-732. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-733. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 100 nm3 and does not comprise any aggregates with a smallest dimension larger than 2 nm3.

Item A-734. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 300 nm3 and does not comprise any aggregates with a smallest dimension larger than 3 nm3.

Item A-735. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-736. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-737. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-738. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-739. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 100 nm3 and does not comprise any aggregates with a smallest dimension larger than 2 nm3.

Item A-740. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 300 nm3 and does not comprise any aggregates with a smallest dimension larger than 3 nm3.

Item A-741. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-742. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-743. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-744. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-745. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 100 nm3 and does not comprise any aggregates with a smallest dimension larger than 2 nm3.

Item A-746. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 300 nm3 and does not comprise any aggregates with a smallest dimension larger than 3 nm3.

Item A-747. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-748. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-749. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-750. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-751. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 100 nm3 and does not comprise any aggregates with a smallest dimension larger than 2 nm3.

Item A-752. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 300 nm3 and does not comprise any aggregates with a smallest dimension larger than 3 nm3.

Item A-753. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-754. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-755. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-756. In a preferred embodiment, a composite, a nanotube preparation, or a collection of CMUs comprises nanotubes of an average length larger than 1E−6 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-757. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 100 nm3 and does not comprise any aggregates with a smallest dimension larger than 2 nm3.

Item A-758. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 300 nm3 and does not comprise any aggregates with a smallest dimension larger than 3 nm3.

Item A-759. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-760. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-761. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-762. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-763. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 100 nm3 and does not comprise any aggregates with a smallest dimension larger than 2 nm3.

Item A-764. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 300 nm3 and does not comprise any aggregates with a smallest dimension larger than 3 nm3.

Item A-765. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-766. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-767. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-768. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-769. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 100 nm3 and does not comprise any aggregates with a smallest dimension larger than 2 nm3.

Item A-770. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 300 nm3 and does not comprise any aggregates with a smallest dimension larger than 3 nm3.

Item A-771. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-772. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-773. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-774. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-775. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 100 nm3 and does not comprise any aggregates with a smallest dimension larger than 2 nm3.

Item A-776. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 300 nm3 and does not comprise any aggregates with a smallest dimension larger than 3 nm3.

Item A-777. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-778. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-779. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-780. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-781. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 100 nm3 and does not comprise any aggregates with a smallest dimension larger than 2 nm3.

Item A-782. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 300 nm3 and does not comprise any aggregates with a smallest dimension larger than 3 nm3.

Item A-783. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-784. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-785. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-786. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-787. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 100 nm3 and does not comprise any aggregates with a smallest dimension larger than 2 nm3.

Item A-788. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 300 nm3 and does not comprise any aggregates with a smallest dimension larger than 3 nm3.

Item A-789. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-790. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-791. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-792. In a preferred embodiment, a composite, a nanotube preparation, or a collection of CMUs comprises nanotubes of an average length larger than 1E−6 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-793. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 100 nm3 and does not comprise any aggregates with a smallest dimension larger than 2 nm3.

Item A-794. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 300 nm3 and does not comprise any aggregates with a smallest dimension larger than 3 nm3.

Item A-795. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-796. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-797. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-798. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-799. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 100 nm3 and does not comprise any aggregates with a smallest dimension larger than 2 nm3.

Item A-800. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 300 nm3 and does not comprise any aggregates with a smallest dimension larger than 3 nm3.

Item A-801. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-802. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-803. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-804. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-805. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 100 nm3 and does not comprise any aggregates with a smallest dimension larger than 2 nm3.

Item A-806. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 300 nm3 and does not comprise any aggregates with a smallest dimension larger than 3 nm3.

Item A-807. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-808. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-809. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-810. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-811. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 100 nm3 and does not comprise any aggregates with a smallest dimension larger than 2 nm3.

Item A-812. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 300 nm3 and does not comprise any aggregates with a smallest dimension larger than 3 nm3.

Item A-813. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-814. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-815. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-816. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-817. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 100 nm3 and does not comprise any aggregates with a smallest dimension larger than 2 nm3.

Item A-818. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 300 nm3 and does not comprise any aggregates with a smallest dimension larger than 3 nm3.

Item A-819. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-820. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-821. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-822. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-823. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 100 nm3 and does not comprise any aggregates with a smallest dimension larger than 2 nm3.

Item A-824. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 300 nm3 and does not comprise any aggregates with a smallest dimension larger than 3 nm3.

Item A-825. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-826. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-827. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-828. In a preferred embodiment, a composite, a nanotube preparation, or a collection of CMUs comprises nanotubes of an average length larger than 1E−6 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-829. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 100 nm3 and does not comprise any aggregates with a smallest dimension larger than 2 nm3.

Item A-830. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 300 nm3 and does not comprise any aggregates with a smallest dimension larger than 3 nm3.

Item A-831. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-832. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-833. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-834. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-835. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 100 nm3 and does not comprise any aggregates with a smallest dimension larger than 2 nm3.

Item A-836. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 300 nm3 and does not comprise any aggregates with a smallest dimension larger than 3 nm3.

Item A-837. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-838. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-839. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-840. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-841. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 100 nm3 and does not comprise any aggregates with a smallest dimension larger than 2 nm3.

Item A-842. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 300 nm3 and does not comprise any aggregates with a smallest dimension larger than 3 nm3.

Item A-843. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-844. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-845. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-846. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-847. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 100 nm3 and does not comprise any aggregates with a smallest dimension larger than 2 nm3.

Item A-848. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 300 nm3 and does not comprise any aggregates with a smallest dimension larger than 3 nm3.

Item A-849. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-850. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-851. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-852. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-853. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 100 nm3 and does not comprise any aggregates with a smallest dimension larger than 2 nm3.

Item A-854. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 300 nm3 and does not comprise any aggregates with a smallest dimension larger than 3 nm3.

Item A-855. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-856. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-857. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-858. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-859. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 100 nm3 and does not comprise any aggregates with a smallest dimension larger than 2 nm3.

Item A-860. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 300 nm3 and does not comprise any aggregates with a smallest dimension larger than 3 nm3.

Item A-861. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-862. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-863. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-864. In a preferred embodiment, a composite, a nanotube preparation, or a collection of CMUs comprises nanotubes of an average length larger than 1E−6 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-865. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-866. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-867. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-868. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-869. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-870. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-871. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-872. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-873. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-874. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-875. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-876. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-877. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-878. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-879. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-880. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-881. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-882. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-883. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-884. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-885. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-886. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-887. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-888. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-889. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-890. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-891. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-892. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-893. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-894. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-895. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-896. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-897. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-898. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-899. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-900. In a preferred embodiment, a composite, a nanotube preparation, or a collection of CMUs comprises nanotubes of an average length larger than 1E−5 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-901. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-902. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-903. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-904. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-905. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-906. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-907. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-908. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-909. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-910. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-911. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-912. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-913. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-914. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-915. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-916. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-917. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-918. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-919. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-920. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-921. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-922. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-923. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-924. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-925. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-926. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-927. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-928. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-929. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-930. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-931. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-932. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-933. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-934. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-935. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-936. In a preferred embodiment, a composite, a nanotube preparation, or a collection of CMUs comprises nanotubes of an average length larger than 1E−5 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-937. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 100 nm3 and does not comprise any aggregates with a smallest dimension larger than 2 nm3.

Item A-938. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 300 nm3 and does not comprise any aggregates with a smallest dimension larger than 3 nm3.

Item A-939. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-940. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-941. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-942. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-943. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 100 nm3 and does not comprise any aggregates with a smallest dimension larger than 2 nm3.

Item A-944. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 300 nm3 and does not comprise any aggregates with a smallest dimension larger than 3 nm3.

Item A-945. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-946. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-947. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-948. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-949. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 100 nm3 and does not comprise any aggregates with a smallest dimension larger than 2 nm3.

Item A-950. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 300 nm3 and does not comprise any aggregates with a smallest dimension larger than 3 nm3.

Item A-951. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-952. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-953. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-954. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-955. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 100 nm3 and does not comprise any aggregates with a smallest dimension larger than 2 nm3.

Item A-956. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 300 nm3 and does not comprise any aggregates with a smallest dimension larger than 3 nm3.

Item A-957. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-958. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-959. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-960. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-961. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 100 nm3 and does not comprise any aggregates with a smallest dimension larger than 2 nm3.

Item A-962. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 300 nm3 and does not comprise any aggregates with a smallest dimension larger than 3 nm3.

Item A-963. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-964. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-965. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-966. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-967. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 100 nm3 and does not comprise any aggregates with a smallest dimension larger than 2 nm3.

Item A-968. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 300 nm3 and does not comprise any aggregates with a smallest dimension larger than 3 nm3.

Item A-969. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-970. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-971. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-972. In a preferred embodiment, a composite, a nanotube preparation, or a collection of CMUs comprises nanotubes of an average length larger than 1E−5 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-973. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 100 nm3 and does not comprise any aggregates with a smallest dimension larger than 2 nm3.

Item A-974. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 300 nm3 and does not comprise any aggregates with a smallest dimension larger than 3 nm3.

Item A-975. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-976. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-977. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-978. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-979. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 100 nm3 and does not comprise any aggregates with a smallest dimension larger than 2 nm3.

Item A-980. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 300 nm3 and does not comprise any aggregates with a smallest dimension larger than 3 nm3.

Item A-981. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-982. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-983. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-984. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-985. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 100 nm3 and does not comprise any aggregates with a smallest dimension larger than 2 nm3.

Item A-986. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 300 nm3 and does not comprise any aggregates with a smallest dimension larger than 3 nm3.

Item A-987. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-988. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-989. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-990. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-991. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 100 nm3 and does not comprise any aggregates with a smallest dimension larger than 2 nm3.

Item A-992. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 300 nm3 and does not comprise any aggregates with a smallest dimension larger than 3 nm3.

Item A-993. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-994. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-995. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-996. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-997. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 100 nm3 and does not comprise any aggregates with a smallest dimension larger than 2 nm3.

Item A-998. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 300 nm3 and does not comprise any aggregates with a smallest dimension larger than 3 nm3.

Item A-999. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-1000. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-1001. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-1002. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-1003. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 100 nm3 and does not comprise any aggregates with a smallest dimension larger than 2 nm3.

Item A-1004. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 300 nm3 and does not comprise any aggregates with a smallest dimension larger than 3 nm3.

Item A-1005. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-1006. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-1007. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-1008. In a preferred embodiment, a composite, a nanotube preparation, or a collection of CMUs comprises nanotubes of an average length larger than 1E−5 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-1009. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1010. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1011. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1012. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1013. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1014. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1015. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1016. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1017. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1018. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1019. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1020. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1021. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1022. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1023. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1024. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1025. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1026. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1027. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1028. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1029. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1030. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1031. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1032. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1033. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1034. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1035. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1036. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1037. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1038. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1039. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1040. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1041. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1042. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1043. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1044. In a preferred embodiment, a composite, a nanotube preparation, or a collection of CMUs comprises nanotubes of an average length larger than 1E−5 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1045. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1046. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1047. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1048. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1049. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1050. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1051. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1052. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1053. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1054. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1055. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1056. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1057. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1058. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1059. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1060. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1061. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1062. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1063. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1064. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1065. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1066. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1067. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1068. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1069. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1070. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1071. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1072. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1073. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1074. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1075. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1076. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1077. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1078. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1079. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1080. In a preferred embodiment, a composite, a nanotube preparation, or a collection of CMUs comprises nanotubes of an average length larger than 1E−5 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1081. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1082. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1083. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1084. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1085. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1086. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1087. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1088. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1089. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1090. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1091. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1092. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1093. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1094. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1095. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1096. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1097. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1098. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1099. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1100. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1101. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1102. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1103. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1104. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1105. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1106. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1107. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1108. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1109. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1110. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1111. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1112. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1113. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1114. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1115. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1116. In a preferred embodiment, a composite, a nanotube preparation, or a collection of CMUs comprises nanotubes of an average length larger than 1E−5 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1117. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1118. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1119. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1120. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1121. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1122. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1123. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1124. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1125. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1126. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1127. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1128. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1129. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1130. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1131. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1132. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1133. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1134. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1135. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1136. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1137. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1138. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1139. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1140. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1141. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1142. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1143. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1144. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1145. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1146. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1147. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1148. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1149. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1150. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1151. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1152. In a preferred embodiment, a composite, a nanotube preparation, or a collection of CMUs comprises nanotubes of an average length larger than 1E−5 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1153. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-1154. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-1155. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-1156. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-1157. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-1158. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-1159. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-1160. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-1161. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-1162. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-1163. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-1164. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-1165. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-1166. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-1167. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-1168. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-1169. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-1170. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-1171. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-1172. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-1173. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-1174. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-1175. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-1176. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-1177. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-1178. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-1179. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-1180. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-1181. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-1182. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-1183. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-1184. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-1185. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-1186. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-1187. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-1188. In a preferred embodiment, a composite, a nanotube preparation, or a collection of CMUs comprises nanotubes of an average length larger than 1E−4 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-1189. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-1190. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-1191. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-1192. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-1193. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-1194. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-1195. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-1196. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-1197. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-1198. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-1199. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-1200. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-1201. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-1202. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-1203. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-1204. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-1205. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-1206. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-1207. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-1208. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-1209. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-1210. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-1211. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-1212. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-1213. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-1214. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-1215. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-1216. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-1217. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-1218. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-1219. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-1220. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-1221. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-1222. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-1223. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-1224. In a preferred embodiment, a composite, a nanotube preparation, or a collection of CMUs comprises nanotubes of an average length larger than 1E−4 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-1225. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 100 nm3 and does not comprise any aggregates with a smallest dimension larger than 2 nm3.

Item A-1226. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 300 nm3 and does not comprise any aggregates with a smallest dimension larger than 3 nm3.

Item A-1227. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-1228. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-1229. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-1230. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-1231. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 100 nm3 and does not comprise any aggregates with a smallest dimension larger than 2 nm3.

Item A-1232. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 300 nm3 and does not comprise any aggregates with a smallest dimension larger than 3 nm3.

Item A-1233. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-1234. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-1235. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-1236. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-1237. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 100 nm3 and does not comprise any aggregates with a smallest dimension larger than 2 nm3.

Item A-1238. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 300 nm3 and does not comprise any aggregates with a smallest dimension larger than 3 nm3.

Item A-1239. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-1240. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-1241. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-1242. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-1243. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 100 nm3 and does not comprise any aggregates with a smallest dimension larger than 2 nm3.

Item A-1244. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 300 nm3 and does not comprise any aggregates with a smallest dimension larger than 3 nm3.

Item A-1245. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-1246. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-1247. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-1248. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-1249. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 100 nm3 and does not comprise any aggregates with a smallest dimension larger than 2 nm3.

Item A-1250. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 300 nm3 and does not comprise any aggregates with a smallest dimension larger than 3 nm3.

Item A-1251. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-1252. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-1253. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-1254. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-1255. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 100 nm3 and does not comprise any aggregates with a smallest dimension larger than 2 nm3.

Item A-1256. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 300 nm3 and does not comprise any aggregates with a smallest dimension larger than 3 nm3.

Item A-1257. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-1258. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-1259. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-1260. In a preferred embodiment, a composite, a nanotube preparation, or a collection of CMUs comprises nanotubes of an average length larger than 1E−4 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-1261. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 100 nm3 and does not comprise any aggregates with a smallest dimension larger than 2 nm3.

Item A-1262. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 300 nm3 and does not comprise any aggregates with a smallest dimension larger than 3 nm3.

Item A-1263. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-1264. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-1265. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-1266. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-1267. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 100 nm3 and does not comprise any aggregates with a smallest dimension larger than 2 nm3.

Item A-1268. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 300 nm3 and does not comprise any aggregates with a smallest dimension larger than 3 nm3.

Item A-1269. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-1270. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-1271. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-1272. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-1273. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 100 nm3 and does not comprise any aggregates with a smallest dimension larger than 2 nm3.

Item A-1274. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 300 nm3 and does not comprise any aggregates with a smallest dimension larger than 3 nm3.

Item A-1275. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-1276. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-1277. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-1278. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-1279. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 100 nm3 and does not comprise any aggregates with a smallest dimension larger than 2 nm3.

Item A-1280. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 300 nm3 and does not comprise any aggregates with a smallest dimension larger than 3 nm3.

Item A-1281. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-1282. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-1283. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-1284. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-1285. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 100 nm3 and does not comprise any aggregates with a smallest dimension larger than 2 nm3.

Item A-1286. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 300 nm3 and does not comprise any aggregates with a smallest dimension larger than 3 nm3.

Item A-1287. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-1288. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-1289. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-1290. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-1291. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 100 nm3 and does not comprise any aggregates with a smallest dimension larger than 2 nm3.

Item A-1292. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 300 nm3 and does not comprise any aggregates with a smallest dimension larger than 3 nm3.

Item A-1293. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-1294. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-1295. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-1296. In a preferred embodiment, a composite, a nanotube preparation, or a collection of CMUs comprises nanotubes of an average length larger than 1E−4 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-1297. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1298. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1299. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1300. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1301. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1302. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1303. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1304. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1305. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1306. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1307. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1308. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1309. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1310. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1311. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1312. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1313. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1314. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1315. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1316. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1317. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1318. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1319. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1320. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1321. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1322. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1323. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1324. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1325. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1326. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1327. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1328. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1329. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1330. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1331. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1332. In a preferred embodiment, a composite, a nanotube preparation, or a collection of CMUs comprises nanotubes of an average length larger than 1E−4 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1333. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1334. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1335. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1336. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1337. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1338. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1339. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1340. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1341. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1342. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1343. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1344. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1345. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1346. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1347. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1348. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1349. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1350. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1351. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1352. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1353. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1354. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1355. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1356. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1357. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1358. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1359. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1360. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1361. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1362. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1363. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1364. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1365. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1366. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1367. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1368. In a preferred embodiment, a composite, a nanotube preparation, or a collection of CMUs comprises nanotubes of an average length larger than 1E−4 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1369. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1370. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1371. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1372. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1373. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1374. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1375. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1376. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1377. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1378. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1379. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1380. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1381. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1382. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1383. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1384. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1385. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1386. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1387. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1388. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1389. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1390. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1391. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1392. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1393. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1394. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1395. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1396. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1397. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1398. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1399. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1400. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1401. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1402. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1403. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1404. In a preferred embodiment, a composite, a nanotube preparation, or a collection of CMUs comprises nanotubes of an average length larger than 1E−4 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1405. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1406. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1407. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1408. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1409. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1410. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1411. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1412. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1413. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1414. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1415. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1416. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1417. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1418. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1419. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1420. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1421. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1422. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1423. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1424. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1425. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1426. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1427. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1428. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1429. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1430. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1431. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1432. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1433. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1434. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1435. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1436. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1437. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1438. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1439. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1440. In a preferred embodiment, a composite, a nanotube preparation, or a collection of CMUs comprises nanotubes of an average length larger than 1E−4 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1441. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-1442. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-1443. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-1444. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-1445. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-1446. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-1447. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-1448. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-1449. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-1450. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-1451. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-1452. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-1453. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-1454. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-1455. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-1456. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-1457. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-1458. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-1459. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-1460. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-1461. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-1462. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-1463. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-1464. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-1465. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-1466. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-1467. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-1468. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-1469. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-1470. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-1471. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 100 nm3 and does not comprise any aggregates with a smallest dimension larger than 2 nm3.

Item A-1472. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 300 nm3 and does not comprise any aggregates with a smallest dimension larger than 3 nm3.

Item A-1473. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1000 nm3 and does not comprise any aggregates with a smallest dimension larger than 5 nm3.

Item A-1474. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E4 nm3 and does not comprise any aggregates with a smallest dimension larger than 10 nm3.

Item A-1475. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E5 nm3 and does not comprise any aggregates with a smallest dimension larger than 20 nm3.

Item A-1476. In a preferred embodiment, a composite, a nanotube preparation, or a collection of CMUs comprises nanotubes of an average length larger than 1E−3 m, and a nanotube concentration of 0.01-0.1 w/w %, wherein the composite, preparation or collection of CMUs has a volume of at least 1E6 nm3 and does not comprise any aggregates with a smallest dimension larger than 50 nm3.

Item A-1477. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-1478. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-1479. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-1480. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-1481. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-1482. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-1483. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-1484. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-1485. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-1486. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-1487. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-1488. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-1489. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-1490. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-1491. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-1492. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-1493. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-1494. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-1495. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-1496. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-1497. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-1498. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-1499. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-1500. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-1501. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-1502. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-1503. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-1504. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-1505. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-1506. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-1507. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 100 nm3 and does not comprise any aggregates with a smallest dimension larger than 2 nm3.

Item A-1508. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 300 nm3 and does not comprise any aggregates with a smallest dimension larger than 3 nm3.

Item A-1509. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1000 nm3 and does not comprise any aggregates with a smallest dimension larger than 5 nm3.

Item A-1510. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E4 nm3 and does not comprise any aggregates with a smallest dimension larger than 10 nm3.

Item A-1511. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E5 nm3 and does not comprise any aggregates with a smallest dimension larger than 20 nm3.

Item A-1512. In a preferred embodiment, a composite, a nanotube preparation, or a collection of CMUs comprises nanotubes of an average length larger than 1E−3 m, and a nanotube concentration of 0.1-1 w/w %, wherein the composite, preparation or collection of CMUs has a volume of at least 1E6 nm3 and does not comprise any aggregates with a smallest dimension larger than 50 nm3.

Item A-1513. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 100 nm3 and does not comprise any aggregates with a smallest dimension larger than 2 nm3.

Item A-1514. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 300 nm3 and does not comprise any aggregates with a smallest dimension larger than 3 nm3.

Item A-1515. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-1516. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-1517. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-1518. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-1519. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 100 nm3 and does not comprise any aggregates with a smallest dimension larger than 2 nm3.

Item A-1520. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 300 nm3 and does not comprise any aggregates with a smallest dimension larger than 3 nm3.

Item A-1521. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-1522. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-1523. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-1524. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-1525. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 100 nm3 and does not comprise any aggregates with a smallest dimension larger than 2 nm3.

Item A-1526. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 300 nm3 and does not comprise any aggregates with a smallest dimension larger than 3 nm3.

Item A-1527. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-1528. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-1529. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-1530. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-1531. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 100 nm3 and does not comprise any aggregates with a smallest dimension larger than 2 nm3.

Item A-1532. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 300 nm3 and does not comprise any aggregates with a smallest dimension larger than 3 nm3.

Item A-1533. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-1534. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-1535. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-1536. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-1537. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 100 nm3 and does not comprise any aggregates with a smallest dimension larger than 2 nm3.

Item A-1538. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 300 nm3 and does not comprise any aggregates with a smallest dimension larger than 3 nm3.

Item A-1539. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-1540. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-1541. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-1542. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-1543. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 100 nm3 and does not comprise any aggregates with a smallest dimension larger than 2 nm3.

Item A-1544. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 300 nm3 and does not comprise any aggregates with a smallest dimension larger than 3 nm3.

Item A-1545. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1000 nm3 and does not comprise any aggregates with a smallest dimension larger than 5 nm3.

Item A-1546. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E4 nm3 and does not comprise any aggregates with a smallest dimension larger than 10 nm3.

Item A-1547. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E5 nm3 and does not comprise any aggregates with a smallest dimension larger than 20 nm3.

Item A-1548. In a preferred embodiment, a composite, a nanotube preparation, or a collection of CMUs comprises nanotubes of an average length larger than 1E−3 m, and a nanotube concentration of 1-5 w/w %, wherein the composite, preparation or collection of CMUs has a volume of at least 1E6 nm3 and does not comprise any aggregates with a smallest dimension larger than 50 nm3.

Item A-1549. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 100 nm3 and does not comprise any aggregates with a smallest dimension larger than 2 nm3.

Item A-1550. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 300 nm3 and does not comprise any aggregates with a smallest dimension larger than 3 nm3.

Item A-1551. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-1552. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-1553. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-1554. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-1555. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 100 nm3 and does not comprise any aggregates with a smallest dimension larger than 2 nm3.

Item A-1556. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 300 nm3 and does not comprise any aggregates with a smallest dimension larger than 3 nm3.

Item A-1557. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-1558. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-1559. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-1560. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-1561. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 100 nm3 and does not comprise any aggregates with a smallest dimension larger than 2 nm3.

Item A-1562. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 300 nm3 and does not comprise any aggregates with a smallest dimension larger than 3 nm3.

Item A-1563. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-1564. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-1565. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-1566. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-1567. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 100 nm3 and does not comprise any aggregates with a smallest dimension larger than 2 nm3.

Item A-1568. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 300 nm3 and does not comprise any aggregates with a smallest dimension larger than 3 nm3.

Item A-1569. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-1570. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-1571. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-1572. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-1573. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 100 nm3 and does not comprise any aggregates with a smallest dimension larger than 2 nm3.

Item A-1574. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 300 nm3 and does not comprise any aggregates with a smallest dimension larger than 3 nm3.

Item A-1575. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-1576. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-1577. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-1578. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-1579. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 100 nm3 and does not comprise any aggregates with a smallest dimension larger than 2 nm3.

Item A-1580. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 300 nm3 and does not comprise any aggregates with a smallest dimension larger than 3 nm3.

Item A-1581. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1000 nm3 and does not comprise any aggregates with a smallest dimension larger than 5 nm3.

Item A-1582. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E4 nm3 and does not comprise any aggregates with a smallest dimension larger than 10 nm3.

Item A-1583. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E5 nm3 and does not comprise any aggregates with a smallest dimension larger than 20 nm3.

Item A-1584. In a preferred embodiment, a composite, a nanotube preparation, or a collection of CMUs comprises nanotubes of an average length larger than 1E−3 m, and a nanotube concentration of 5-10 w/w %, wherein the composite, preparation or collection of CMUs has a volume of at least 1E6 nm3 and does not comprise any aggregates with a smallest dimension larger than 50 nm3.

Item A-1585. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1586. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1587. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1588. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1589. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1590. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1591. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1592. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1593. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1594. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1595. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1596. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1597. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1598. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1599. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1600. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1601. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1602. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1603. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1604. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1605. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1606. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1607. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1608. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1609. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1610. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1611. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1612. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1613. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1614. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1615. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 100 nm3 and does not comprise any aggregates with a smallest dimension larger than 2 nm3.

Item A-1616. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 300 nm3 and does not comprise any aggregates with a smallest dimension larger than 3 nm3.

Item A-1617. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1000 nm3 and does not comprise any aggregates with a smallest dimension larger than 5 nm3.

Item A-1618. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E4 nm3 and does not comprise any aggregates with a smallest dimension larger than 10 nm3.

Item A-1619. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E5 nm3 and does not comprise any aggregates with a smallest dimension larger than 20 nm3.

Item A-1620. In a preferred embodiment, a composite, a nanotube preparation, or a collection of CMUs comprises nanotubes of an average length larger than 1E−3 m, and a nanotube concentration of 10-20 w/w %, wherein the composite, preparation or collection of CMUs has a volume of at least 1E6 nm3 and does not comprise any aggregates with a smallest dimension larger than 50 nm3.

Item A-1621. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1622. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1623. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1624. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1625. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1626. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1627. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1628. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1629. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1630. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1631. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1632. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1633. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1634. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1635. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1636. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1637. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1638. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1639. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1640. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1641. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1642. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1643. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1644. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1645. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1646. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1647. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1648. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1649. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1650. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1651. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 100 nm3 and does not comprise any aggregates with a smallest dimension larger than 2 nm3.

Item A-1652. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 300 nm3 and does not comprise any aggregates with a smallest dimension larger than 3 nm3.

Item A-1653. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1000 nm3 and does not comprise any aggregates with a smallest dimension larger than 5 nm3.

Item A-1654. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E4 nm3 and does not comprise any aggregates with a smallest dimension larger than 10 nm3.

Item A-1655. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E5 nm3 and does not comprise any aggregates with a smallest dimension larger than 20 nm3.

Item A-1656. In a preferred embodiment, a composite, a nanotube preparation, or a collection of CMUs comprises nanotubes of an average length larger than 1E−3 m, and a nanotube concentration of 20-30 w/w %, wherein the composite, preparation or collection of CMUs has a volume of at least 1E6 nm3 and does not comprise any aggregates with a smallest dimension larger than 50 nm3.

Item A-1657. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1658. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1659. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1660. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1661. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1662. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1663. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1664. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1665. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1666. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1667. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1668. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1669. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1670. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1671. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1672. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1673. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1674. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1675. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1676. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1677. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1678. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1679. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1680. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1681. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1682. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1683. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1684. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1685. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1686. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1687. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 100 nm3 and does not comprise any aggregates with a smallest dimension larger than 2 nm3.

Item A-1688. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 300 nm3 and does not comprise any aggregates with a smallest dimension larger than 3 nm3.

Item A-1689. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1000 nm3 and does not comprise any aggregates with a smallest dimension larger than 5 nm3.

Item A-1690. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E4 nm3 and does not comprise any aggregates with a smallest dimension larger than 10 nm3.

Item A-1691. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E5 nm3 and does not comprise any aggregates with a smallest dimension larger than 20 nm3.

Item A-1692. In a preferred embodiment, a composite, a nanotube preparation, or a collection of CMUs comprises nanotubes of an average length larger than 1E−3 m, and a nanotube concentration of 30-40 w/w %, wherein the composite, preparation or collection of CMUs has a volume of at least 1E6 nm3 and does not comprise any aggregates with a smallest dimension larger than 50 nm3.

Item A-1693. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1694. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1695. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1696. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1697. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1698. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1699. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1700. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1701. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1702. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1703. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1704. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1705. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1706. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1707. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1708. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1709. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1710. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1711. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1712. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1713. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1714. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1715. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1716. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1717. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1718. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1719. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1720. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1721. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1722. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E6 nm3 and does not comprise any aggregates with a smallest dimension larger than 50 nm3.

Item A-1723. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 100 nm3 and does not comprise any aggregates with a smallest dimension larger than 2 nm3.

Item A-1724. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 300 nm3 and does not comprise any aggregates with a smallest dimension larger than 3 nm3.

Item A-1725. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1000 nm3 and does not comprise any aggregates with a smallest dimension larger than 5 nm3.

Item A-1726. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E4 nm3 and does not comprise any aggregates with a smallest dimension larger than 10 nm3.

Item A-1727. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E5 nm3 and does not comprise any aggregates with a smallest dimension larger than 20 nm3.

Item A-1728. In a preferred embodiment, a composite, a nanotube preparation, or a collection of CMUs comprises nanotubes of an average length larger than 1E−3 m, and a nanotube concentration of 40-50 w/w %, wherein the composite, preparation or collection of CMUs has a volume of at least 1E6 nm3 and does not comprise any aggregates with a smallest dimension larger than 50 nm3.

### B. Nanotube Diameters and Chiralities

Item B-1. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 2 nanotubes with different diameters that are both complexed with MLs.

Item B-2. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 3 nanotubes with different diameters that are all complexed with MLs.

Item B-3. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 4 nanotubes with different diameters that are all complexed with MLs.

Item B-4. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 5 nanotubes with different diameters that are all complexed with MLs.

Item B-5. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 6 nanotubes with different diameters that are all complexed with MLs.

Item B-6. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 7 nanotubes with different diameters that are all complexed with MLs.

Item B-7. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 8 nanotubes with different diameters that are all complexed with MLs.

Item B-8. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 9 nanotubes with different diameters that are all complexed with MLs.

Item B-9. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 10 nanotubes with different diameters that are all complexed with MLs.

Item B-10. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 11 nanotubes with different diameters that are all complexed with MLs.

Item B-11. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 12 nanotubes with different diameters that are all complexed with MLs.

Item B-12. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 13 nanotubes with different diameters that are all complexed with MLs.

Item B-13. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 14 nanotubes with different diameters that are all complexed with MLs.

Item B-14. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 15-19 nanotubes with different diameters that are all complexed with MLs.

Item B-15. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 20-24 nanotubes with different diameters that are all complexed with MLs.

Item B-16. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 25-29 nanotubes with different diameters that are all complexed with MLs.

Item B-17. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 30-49 nanotubes with different diameters that are all complexed with MLs.

Item B-18. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 50-99 nanotubes with different diameters that are all complexed with MLs.

Item B-19. In a preferred embodiment, a composite, a nanotube preparation, or a collection of CMUs, comprises two or more MLs forming a ML-nanotube complex or forming a ring around a nanotube, wherein the nanotubes have different outer diameters (“different outer diameters” shall in this paragraph mean that the outer diameters are at least 0.1 nm different), such as 100 or more nanotubes with different diameters that are all complexed with MLs.

Item Bx-1. In a preferred embodiment, a composite, a nanotube preparation, or a collection of CMUs, comprises two or more MLs forming a ML-nanotube complex or forming a ring around a nanotube, wherein the nanotubes have different chiralities, such as 2 nanotubes with different chiralities that are all complexed with MLs.

Item Bx-2. In a preferred embodiment, a composite, a nanotube preparation, or a collection of CMUs, comprises two or more MLs forming a ML-nanotube complex or forming a ring around a nanotube, wherein the nanotubes have different chiralities, such as 3 nanotubes with different chiralities that are both complexed with MLs.

Item Bx-3. In a preferred embodiment, a composite, a nanotube preparation, or a collection of CMUs, comprises two or more MLs forming a ML-nanotube complex or forming a ring around a nanotube, wherein the nanotubes have different chiralities, such as 4 nanotubes with different chiralities that are all complexed with MLs.

Item Bx-4. In a preferred embodiment, a composite, a nanotube preparation, or a collection of CMUs, comprises two or more MLs forming a ML-nanotube complex or forming a ring around a nanotube, wherein the nanotubes have different chiralities, such as 5 nanotubes with different chiralities that are all complexed with MLs.

Item Bx-5. In a preferred embodiment, a composite, a nanotube preparation, or a collection of CMUs, comprises two or more MLs forming a ML-nanotube complex or forming a ring around a nanotube, wherein the nanotubes have different chiralities, such as 6 nanotubes with different chiralities that are all complexed with MLs.

Item Bx-6. In a preferred embodiment, a composite, a nanotube preparation, or a collection of CMUs, comprises two or more MLs forming a ML-nanotube complex or forming a ring around a nanotube, wherein the nanotubes have different chiralities, such as 7 nanotubes with different chiralities that are all complexed with MLs.

Item Bx-7. In a preferred embodiment, a composite, a nanotube preparation, or a collection of CMUs, comprises two or more MLs forming a ML-nanotube complex or forming a ring around a nanotube, wherein the nanotubes have different chiralities, such as 8 nanotubes with different chiralities that are all complexed with MLs.

Item Bx-8. In a preferred embodiment, a composite, a nanotube preparation, or a collection of CMUs, comprises two or more MLs forming a ML-nanotube complex or forming a ring around a nanotube, wherein the nanotubes have different chiralities, such as 9 nanotubes with different chiralities that are all complexed with MLs.

Item Bx-9. In a preferred embodiment, a composite, a nanotube preparation, or a collection of CMUs, comprises two or more MLs forming a ML-nanotube complex or forming a ring around a nanotube, wherein the nanotubes have different chiralities, such as 10 nanotubes with different chiralities that are all complexed with MLs.

Item Bx-10. In a preferred embodiment, a composite, a nanotube preparation, or a collection of CMUs, comprises two or more MLs forming a ML-nanotube complex or forming a ring around a nanotube, wherein the nanotubes have different chiralities, such as 11 nanotubes with different chiralities that are all complexed with MLs.

Item Bx-11. In a preferred embodiment, a composite, a nanotube preparation, or a collection of CMUs, comprises two or more MLs forming a ML-nanotube complex or forming a ring around a nanotube, wherein the nanotubes have different chiralities, such as 12 nanotubes with different chiralities that are all complexed with MLs.

Item Bx-12. In a preferred embodiment, a composite, a nanotube preparation, or a collection of CMUs, comprises two or more MLs forming a ML-nanotube complex or forming a ring around a nanotube, wherein the nanotubes have different chiralities, such as 13 nanotubes with different chiralities that are all complexed with MLs.

Item Bx-13. In a preferred embodiment, a composite, a nanotube preparation, or a collection of CMUs, comprises two or more MLs forming a ML-nanotube complex or forming a ring around a nanotube, wherein the nanotubes have different chiralities, such as 14 nanotubes with different chiralities that are all complexed with MLs.

Item Bx-14. In a preferred embodiment, a composite, a nanotube preparation, or a collection of CMUs, comprises two or more MLs forming a ML-nanotube complex or forming a ring around a nanotube, wherein the nanotubes have different chiralities, such as 15-19 nanotubes with different chiralities that are all complexed with MLs.

Item Bx-15. In a preferred embodiment, a composite, a nanotube preparation, or a collection of CMUs, comprises two or more MLs forming a ML-nanotube complex or forming a ring around a nanotube, wherein the nanotubes have different chiralities, such as 20-24 nanotubes with different chiralities that are all complexed with MLs.

Item Bx-16. In a preferred embodiment, a composite, a nanotube preparation, or a collection of CMUs, comprises two or more MLs forming a ML-nanotube complex or forming a ring around a nanotube, wherein the nanotubes have different chiralities, such as 25-29 nanotubes with different chiralities that are all complexed with MLs.

Item Bx-17. In a preferred embodiment, a composite, a nanotube preparation, or a collection of CMUs, comprises two or more MLs forming a ML-nanotube complex or forming a ring around a nanotube, wherein the nanotubes have different chiralities, such as 30-49 nanotubes with different chiralities that are all complexed with MLs.

Item Bx-18. In a preferred embodiment, a composite, a nanotube preparation, or a collection of CMUs, comprises two or more MLs forming a ML-nanotube complex or forming a ring around a nanotube, wherein the nanotubes have different chiralities, such as 50-99 nanotubes with different chiralities that are all complexed with MLs.

Item Bx-19. In a preferred embodiment, a composite, a nanotube preparation, or a collection of CMUs, comprises two or more MLs forming a ML-nanotube complex or forming a ring around a nanotube, wherein the nanotubes have different chiralities, such as 100 or more nanotubes with different chiralities that are all complexed with MLs.

Item Bx-20. In a preferred embodiment, a composite, a nanotube preparation, or a collection of CMUs, comprises two or more MLs forming a ML-nanotube complex or forming a ring around a nanotube, wherein the nanotubes have different chiralities, such as 400 or more nanotubes with different chiralities that are all complexed with MLs.

### C. Non-Covalent Links

Item C-0. In a preferred embodiment, a composite material, a collection of CMUs, or a preparation of nanotubes comprises a polymer, a nanotube and a closed ring, each of which comprises a group participating in a non-covalent interaction with a polymer, a nanotube or a closed ring, and where said group is chosen from the list comprising:
alkyl, cycloalkyl, aryl, heterocyclyl, and heteroaryl,
an aryl, a heteroaryl, an alkyl, a cycloalkyl, a heterocycle, an alkene, a cycloalkene, an alkyne, a cycloalkyne,
—C—, —CH2, —CH3, —CHO, —CN, —C(O)—, —C(O)—O—, —CH(OH)—, —COOH,
—S—, —SH,
—O—, —OH, ═O,
—NH—, —NH2, —NO2,
a hydrophobic group, a hydrophilic group,
a negatively charged group, a positively charged group, a neutral group,
a halogen, —Cl, —F, —Br,
a pi system, a single bond, a double bond, a triple bond,
allene, alkene, allyl, vinyl, alkyl, methyl, ethyl, propyl, butyl, pentyl, alkyne, benzyl, carbene, cumulene, methylene, methylene, methine, phenyl, acetal, acetoxy, acetyl, acryloyl, acyl, aldehyde, alkoxy, methoxy, benzoyl, carbonyl, carboxyl, carboxylic anhydride, dioxirane, epoxide, ester, ether, ethylenedioxy, halo, hydroxy, ketone, methylenedioxy, peroxy, orthoester, ynon, amine, azo, carbamate, cyanate, hydrazone, imide, imine, isocyanate, isonitrile, nitrate, nitrene, nitrile, nitro, nitroso, nitrosooxy, amide, oxime, phosphonate, phosphonous, disulfide, persulfide, sulfo, sulfone, sulfonic acid, sulfoxide, thial, thioester, thionoester, sulfide, sulfino, sulfinyl, sulfonyl, thioketone, thiol, thionyl, selenol, selenonic acid, seleninic acid, selenenic acid, selon, tellurol, telluroketone, fluoroethylisothiocyanate, phosphoramide, sulfenyl chloride, sulfonamide thiocyanat,
azepanylonyl, azepanylyl, azetidinonyl, azetidinyl, cyclobutyl, cyclohexyl, cyclopentadienyl, cyclopentyl, cyclopropyl, diazepanylyl, diazetidinyl, dihydropyridinyl, dihydropyrrole, furanyl, hexahydropyrimidinyl, imidazolidinyl, imidazolyl, isothiazolidinyl, isothiazolyl, isoxazolidinyl, isoxazolyl, morpholinyl, oxadiazolyl, oxathiazolyl, oxazepanylyl, oxazetidinyl, oxazinanylyl, oxazolidinyl, oxazolyl, phenyl, piperazinyl, piperidinonyl, piperidinyl, pyranyl, pyrazine, pyrazolidinyl, pyrazolyl, pyridazine, pyrimidinyl, pyrrolidinonyl, pyrrolidinyl, pyrrolyl, tetrahydro-2H-pyranyl, tetrahydro-2H-thiopyranyl, tetrahydrofuranyl, tetrahydrothiophene, tetrazine, tetrazolyl, thiadiazolyl, thiazinanylyl, thiazolidinyl, thiazolyl, thienyl, thiomorpholinyl, thioxoazetidinyl, triazinyl, triazolyl.

### C. Chemical Motifs Enabling the Non-Covalent Interaction Between Nanotube, ML, and Polymer.

Item C-1. In a preferred embodiment, a nanotube is non-covalently linked via a —COOH group to a —NH2 group on a nanotube.

Item C-2. In a preferred embodiment, a nanotube is non-covalently linked via a π system, such as benzene to a cation, such as an —NH3+ group on a closed ring.

Item C-3. In a preferred embodiment, a nanotube is non-covalently linked via a —NH2 group to an —OH group on a polymer.

Item C-4. In a preferred embodiment, a closed ring is non-covalently linked via a —COOH group to a —NH2 group on a nanotube.

Item C-5. In a preferred embodiment, a closed ring is non-covalently linked via a π system, such as benzene to a cation, such as an —NH3+ group on a closed ring.

Item C-6. In a preferred embodiment, a closed ring is non-covalently linked via a —NH2 group to an —OH group on a polymer.

Item C-7. In a preferred embodiment, a polymer is non-covalently linked via a —COOH group to a —NH2 group on a nanotube.

Item C-8. In a preferred embodiment, a polymer is non-covalently linked via a π system, such as benzene to a cation, such as an —NH3+ group on a closed ring.

Item C-9. In a preferred embodiment, a polymer is non-covalently linked via a —NH2 group to an —OH group on a polymer.

Item C-10. In a preferred embodiment, a nanotube is non-covalently linked via a —COOH group to a —NH2 group on a nanotube.

Item C-11. In a preferred embodiment, a nanotube is non-covalently linked via a π system, such as benzene to a cation, such as an —NH3+ group on a closed ring.

Item C-12. In a preferred embodiment, a nanotube is non-covalently linked via a —NH2 group to an —OH group on a polymer.

Item C-13. In a preferred embodiment, a closed ring is non-covalently linked via a —COOH group to a —NH2 group on a nanotube.

Item C-14. In a preferred embodiment, a closed ring is non-covalently linked via a π system, such as benzene to a cation, such as an —NH3+ group on a closed ring.

Item C-15. In a preferred embodiment, a closed ring is non-covalently linked via a —NH2 group to an —OH group on a polymer.

Item C-16. In a preferred embodiment, a polymer is non-covalently linked via a —COOH group to a —NH2 group on a nanotube.

Item C-17. In a preferred embodiment, a polymer is non-covalently linked via a π system, such as benzene to a cation, such as an —NH3+ group on a closed ring.

Item C-18. In a preferred embodiment, a polymer is non-covalently linked via a —NH2 group to an —OH group on a polymer.

Item C-19. In a preferred embodiment, a nanotube is non-covalently linked via a —COOH group to a —NH2 group on a nanotube.

Item C-20. In a preferred embodiment, a nanotube is non-covalently linked via a π system, such as benzene to a cation, such as an —NH3+ group on a closed ring.

Item C-21. In a preferred embodiment, a nanotube is non-covalently linked via a —NH2 group to an —OH group on a polymer.

Item C-22. In a preferred embodiment, a closed ring is non-covalently linked via a —COOH group to a —NH2 group on a nanotube.

Item C-23. In a preferred embodiment, a closed ring is non-covalently linked via a π system, such as benzene to a cation, such as an —NH3+ group on a closed ring.

Item C-24. In a preferred embodiment, a closed ring is non-covalently linked via a —NH2 group to an —OH group on a polymer.

Item C-25. In a preferred embodiment, a polymer is non-covalently linked via a —COOH group to a —NH2 group on a nanotube.

Item C-26. In a preferred embodiment, a polymer is non-covalently linked via a π system, such as benzene to a cation, such as an —NH3+ group on a closed ring.

Item C-27. In a preferred embodiment, a polymer is non-covalently linked via a —NH2 group to an —OH group on a polymer.

### D. Pairs of Nanotube and Appropriately Sized Closed Rings.

Item D-1. In a preferred embodiment, a composite, a nanotube preparation, or a collection of CMUs, comprises a closed ring in a closed-ring-nanotube complex or forming a closed ring around a nanotube, wherein a closed ring with a diameter of 1-2 nm encircles a nanotube with a diameter of 0.3 nm.

Item D-2. In a preferred embodiment, a composite, a nanotube preparation, or a collection of CMUs, comprises a closed ring in a closed-ring-nanotube complex or forming a closed ring around a nanotube, wherein a closed ring with a diameter of 2-3 nm encircles a nanotube with a diameter of 0.3-2 nm.

Item D-3. In a preferred embodiment, a composite, a nanotube preparation, or a collection of CMUs, comprises a closed ring in a closed-ring-nanotube complex or forming a closed ring around a nanotube, wherein a closed ring with a diameter of 3-4 nm encircles a nanotube with a diameter of 0.3-3 nm.

Item D-4. In a preferred embodiment, a composite, a nanotube preparation, or a collection of CMUs, comprises a closed ring in a closed-ring-nanotube complex or forming a closed ring around a nanotube, wherein a closed ring with a diameter of 4-5 nm encircles a nanotube with a diameter of 0.3-4 nm.

Item D-5. In a preferred embodiment, a composite, a nanotube preparation, or a collection of CMUs, comprises a closed ring in a closed-ring-nanotube complex or forming a closed ring around a nanotube, wherein a closed ring with a diameter of 5-6 nm encircles a nanotube with a diameter of 0.3-5 nm.

Item D-6. In a preferred embodiment, a composite, a nanotube preparation, or a collection of CMUs, comprises a closed ring in a closed-ring-nanotube complex or forming a closed ring around a nanotube, wherein a closed ring with a diameter of 6-7 nm encircles a nanotube with a diameter of 0.3-6 nm.

Item D-7. In a preferred embodiment, a composite, a nanotube preparation, or a collection of CMUs, comprises a closed ring in a closed-ring-nanotube complex or forming a closed ring around a nanotube, wherein a closed ring with a diameter of 7-8 nm encircles a nanotube with a diameter of 0.3-7 nm.

Item D-8. In a preferred embodiment, a composite, a nanotube preparation, or a collection of CMUs, comprises a closed ring in a closed-ring-nanotube complex or forming a closed ring around a nanotube, wherein a closed ring with a diameter of 8-9 nm encircles a nanotube with a diameter of 0.3-8 nm.

Item D-9. In a preferred embodiment, a composite, a nanotube preparation, or a collection of CMUs, comprises a closed ring in a closed-ring-nanotube complex or forming a closed ring around a nanotube, wherein a closed ring with a diameter of 9-10 nm encircles a nanotube with a diameter of 0.3-9 nm.

Item D-10. In a preferred embodiment, a composite, a nanotube preparation, or a collection of CMUs, comprises a closed ring in a closed-ring-nanotube complex or forming a closed ring around a nanotube, wherein a closed ring with a diameter of 10-11 nm encircles a nanotube with a diameter of 0.3-10 nm.

Item D-11. In a preferred embodiment, a composite, a nanotube preparation, or a collection of CMUs, comprises a closed ring in a closed-ring-nanotube complex or forming a closed ring around a nanotube, wherein a closed ring with a diameter of 11-12 nm encircles a nanotube with a diameter of 0.3-11 nm.

Item D-12. In a preferred embodiment, a composite, a nanotube preparation, or a collection of CMUs, comprises a closed ring in a closed-ring-nanotube complex or forming a closed ring around a nanotube, wherein a closed ring with a diameter of 12-13 nm encircles a nanotube with a diameter of 0.3-12 nm.

Item D-13. In a preferred embodiment, a composite, a nanotube preparation, or a collection of CMUs, comprises a closed ring in a closed-ring-nanotube complex or forming a closed ring around a nanotube, wherein a closed ring with a diameter of 13-14 nm encircles a nanotube with a diameter of 0.3-13 nm.

Item D-14. In a preferred embodiment, a composite, a nanotube preparation, or a collection of CMUs, comprises a closed ring in a closed-ring-nanotube complex or forming a closed ring around a nanotube, wherein a closed ring with a diameter of 14-15 nm encircles a nanotube with a diameter of 0.3-14 nm.

Item D-15. In a preferred embodiment, a composite, a nanotube preparation, or a collection of CMUs, comprises a closed ring in a closed-ring-nanotube complex or forming a closed ring around a nanotube, wherein a closed ring with a diameter of 15-16 nm encircles a nanotube with a diameter of 0.3-15 nm.

Item D-16. In a preferred embodiment, a composite, a nanotube preparation, or a collection of CMUs, comprises a closed ring in a closed-ring-nanotube complex or forming a closed ring around a nanotube, wherein a closed ring with a diameter of 16-20 nm encircles a nanotube with a diameter of 0.3-16 nm.

Item D-17. In a preferred embodiment, a composite, a nanotube preparation, or a collection of CMUs, comprises a closed ring in a closed-ring-nanotube complex or forming a closed ring around a nanotube, wherein a closed ring with a diameter of 20-25 nm encircles a nanotube with a diameter of 0.3-20 nm.

Item D-18. In a preferred embodiment, a composite, a nanotube preparation, or a collection of CMUs, comprises a closed ring in a closed-ring-nanotube complex or forming a closed ring around a nanotube, wherein a closed ring with a diameter of 25-50 nm encircles a nanotube with a diameter of 0.3-25 nm.

Item D-19. In a preferred embodiment, a composite, a nanotube preparation, or a collection of CMUs, comprises a closed ring in a closed-ring-nanotube complex or forming a closed ring around a nanotube, wherein a closed ring with a diameter of 50-100 nm encircles a nanotube with a diameter of 0.3-50 nm.

Item D-20. In a preferred embodiment, a composite, a nanotube preparation, or a collection of CMUs, comprises a closed ring in a closed-ring-nanotube complex or forming a closed ring around a nanotube, wherein a closed ring with a diameter of more than 100 nm encircles a nanotube with a diameter of 0.3-100 nm.

E. More than One U-Shape to Make a Closed Ring.

Item E-1. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 1 U-shape.

Item E-2. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 2 U-shapes.

Item E-3. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 3 U-shapes.

Item E-4. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 4 U-shapes.

Item E-5. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 5 U-shapes.

Item E-6. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 6 U-shapes.

Item E-7. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 7 U-shapes.

Item E-8. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 8 U-shapes.

Item E-9. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 9 U-shapes.

Item E-10. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 10 U-shapes.

Item E-11. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 11 U-shapes.

Item E-12. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 12 U-shapes.

Item E-13. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 13 U-shapes.

Item E-14. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 14 U-shapes.

Item E-15. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 15 U-shapes.

Item E-16. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 16-19 U-shapes.

Item E-17. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 20-24 U-shapes.

Item E-18. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 25-50 U-shapes.

Item E-19. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 51-100 U-shapes.

Item E-20. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing more than 100 U-shapes.

Item E-21. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 1 U-shape.

Item E-22. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 2 different U-shapes.

Item E-23. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 3 different U-shapes.

Item E-24. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 4 different U-shapes.

Item E-25. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 5 different U-shapes.

Item E-26. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 6 different U-shapes.

Item E-27. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 7 different U-shapes.

Item E-28. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 8 different U-shapes.

Item E-29. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 9 different U-shapes.

Item E-30. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 10 different U-shapes.

Item E-31. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 11 different U-shapes.

Item E-32. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 12 different U-shapes.

Item E-33. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 13 different U-shapes.

Item E-34. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 14 different U-shapes.

Item E-35. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 15 different U-shapes.

Item E-36. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 16-19 different U-shapes.

Item E-37. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 20-24 different U-shapes.

Item E-38. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 25-50 different U-shapes.

Item E-39. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing 51-100 different U-shapes.

Item E-40. In a preferred embodiment, a composite, a nanotube preparation, or a collection of CMUs, comprises two or more closed rings, wherein a closed ring forms a complex with a nanotube or forms a ring around a nanotube, and wherein a closed ring is synthesized by covalently cyclizing more than 100 different U-shapes.

Item FF1. A composite comprising a nanotube and H2O.

Item FF2. A composite comprising a carbon nanotube and HCl.

Item FF3. A composite comprising a multi-wall nanotube and NaCl.

Item FF4. A composite comprising a multi-wall carbon nanotube and NC—C(CH3)2-C(CH3)2-CN.

Item FF5. A composite comprising a single-wall nanotube and biphenyl.

Item FF6. A composite comprising a single-wall carbon nanotube and N2.

Item FF7. A composite comprising graphene and CO2.

Item FF8. A composite comprising a carbon fibre and NC—C(CH3)(CH2-CH3)-C(CH3)(CH2-CH3)-CN.

Item FF9. A composite comprising a carbon nanofibre and NC—C(CH3)(CH2-C(CH3)2-O—CH3)-C(CH3)(CH2-C(CH3)2-O—CH3)-CN.

Item FF10. A composite comprising a carbon nanothread and NC—C(CH3)(CH2-C(CH3)2-O—CH3)-C(CH3)(CH2-C(CH3)2-O—CH3)-CN.

Item FF11. A composite comprising a ceramic material and H2O.

Item FF12. A composite comprising a fullerene and H2O.

Item FF13. A composite comprising graphane and H2O.

Item FF14. A composite comprising graphene oxide and H2O.

Item FF15. A composite comprising graphite and H2O.

Item FF16. A composite comprising graphyne and H2O.

Item FF17. A composite comprising a COOH-functionalized carbon nanotube and H2O.

Item FF18. A composite comprising a OH-functionalized carbon nanotube and H2O.

Item FF19. A composite comprising an NH2-functionalized carbon nanotube and H2O.

Item FF20. A composite comprising an SH-functionalized carbon nanotube and H2O.

Item FF21. A composite comprising COOH-functionalized graphene and H2O.

Item FF22. A composite comprising NH2-functionalized graphene and H2O.

Item FF23. A composite comprising OH-functionalized graphene and H2O.

Item FF24. A composite comprising thiol-functionalized graphene and H2O.

Item FF25. A composite comprising a glass fibre and H2O.

Item FF26. A composite comprising a nanotube and HCl.

Item FF27. A composite comprising a carbon nanotube and HCl.

Item FF28. A composite comprising a multi-wall nanotube and HCl.

Item FF29. A composite comprising a multi-wall carbon nanotube and HCl.

Item FF30. A composite comprising a single-wall nanotube and HCl.

Item FF31. A composite comprising a single-wall carbon nanotube and HCl.

Item FF32. A composite comprising graphene and HCl.

Item FF33. A composite comprising a carbon fibre and HCl.

Item FF34. A composite comprising a carbon nanofibre and HCl.

Item FF35. A composite comprising a carbon nanothread and HCl.

Item FF36. A composite comprising a ceramic material and HCl.

Item FF37. A composite comprising a fullerene and HCl.

Item FF38. A composite comprising graphane and HCl.

Item FF39. A composite comprising graphene oxide and HCl.

Item FF40. A composite comprising graphite and HCl.

Item FF41. A composite comprising graphyne and HCl.

Item FF42. A composite comprising a COOH-functionalized carbon nanotube and HCl.

Item FF43. A composite comprising a OH-functionalized carbon nanotube and HCl.

Item FF44. A composite comprising an NH2-functionalized carbon nanotube and HCl.

Item FF45. A composite comprising an SH-functionalized carbon nanotube and HCl.

Item FF46. A composite comprising COOH-functionalized graphene and HCl.

Item FF47. A composite comprising NH2-functionalized graphene and HCl.

Item FF48. A composite comprising OH-functionalized graphene and HCl.

Item FF49. A composite comprising thiol-functionalized graphene and HCl.

Item FF50. A composite comprising a glass fibre and HCl.

Item FF51. A composite comprising a nanotube and NaCl.

Item FF52. A composite comprising a carbon nanotube and NaCl.

Item FF53. A composite comprising a multi-wall nanotube and NaCl.

Item FF54. A composite comprising a multi-wall carbon nanotube and NaCl.

Item FF55. A composite comprising a single-wall nanotube and NaCl.

Item FF56. A composite comprising a single-wall carbon nanotube and NaCl.

Item FF57. A composite comprising graphene and NaCl.

Item FF58. A composite comprising a carbon fibre and NaCl.

Item FF59. A composite comprising a carbon nanofibre and NaCl.

Item FF60. A composite comprising a carbon nanothread and NaCl.

Item FF61. A composite comprising a ceramic material and NaCl.

Item FF62. A composite comprising a fullerene and NaCl.

Item FF63. A composite comprising graphane and NaCl.

Item FF64. A composite comprising graphene oxide and NaCl.

Item FF65. A composite comprising graphite and NaCl.

Item FF66. A composite comprising graphyne and NaCl.

Item FF67. A composite comprising a COOH-functionalized carbon nanotube and NaCl.

Item FF68. A composite comprising a OH-functionalized carbon nanotube and NaCl.

Item FF69. A composite comprising an NH2-functionalized carbon nanotube and NaCl.

Item FF70. A composite comprising an SH-functionalized carbon nanotube and NaCl.

Item FF71. A composite comprising COOH-functionalized graphene and NaCl.

Item FF72. A composite comprising NH2-functionalized graphene and NaCl.

Item FF73. A composite comprising OH-functionalized graphene and NaCl.

Item FF74. A composite comprising thiol-functionalized graphene and NaCl.

Item FF75. A composite comprising a glass fibre and NaCl.

Item FF76. A composite comprising a nanotube and N2.

Item FF77. A composite comprising a carbon nanotube and N2.

Item FF78. A composite comprising a multi-wall nanotube and N2.

Item FF79. A composite comprising a multi-wall carbon nanotube and N2.

Item FF80. A composite comprising a single-wall nanotube and N2.

Item FF81. A composite comprising a single-wall carbon nanotube and N2.

Item FF82. A composite comprising graphene and N2.

Item FF83. A composite comprising a carbon fibre and N2.

Item FF84. A composite comprising a carbon nanofibre and N2.

Item FF85. A composite comprising a carbon nanothread and N2.

Item FF86. A composite comprising a ceramic material and N2.

Item FF87. A composite comprising a fullerene and N2.

Item FF88. A composite comprising graphane and N2.

Item FF89. A composite comprising graphene oxide and N2.

Item FF90. A composite comprising graphite and N2.

Item FF91. A composite comprising graphyne and N2.

Item FF92. A composite comprising a COOH-functionalized carbon nanotube and N2.

Item FF93. A composite comprising a OH-functionalized carbon nanotube and N2.

Item FF94. A composite comprising an NH2-functionalized carbon nanotube and N2.

Item FF95. A composite comprising an SH-functionalized carbon nanotube and N2.

Item FF96. A composite comprising COOH-functionalized graphene and N2.

Item FF97. A composite comprising NH2-functionalized graphene and N2.

Item FF98. A composite comprising OH-functionalized graphene and N2.

Item FF99. A composite comprising thiol-functionalized graphene and N2.

Item FF100. A composite comprising a glass fibre and N2.

Item FF101. A composite comprising a nanotube and CO2.

Item FF102. A composite comprising a carbon nanotube and CO2.

Item FF103. A composite comprising a multi-wall nanotube and CO2.

Item FF104. A composite comprising a multi-wall carbon nanotube and CO2.

Item FF105. A composite comprising a single-wall nanotube and CO2.

Item FF106. A composite comprising a single-wall carbon nanotube and CO2.

Item FF107. A composite comprising graphene and CO2.

Item FF108. A composite comprising a carbon fibre and CO2.

Item FF109. A composite comprising a carbon nanofibre and CO2.

Item FF110. A composite comprising a carbon nanothread and CO2.

Item FF111. A composite comprising a ceramic material and CO2.

Item FF112. A composite comprising a fullerene and CO2.

Item FF113. A composite comprising graphane and CO2.

Item FF114. A composite comprising graphene oxide and CO2.

Item FF115. A composite comprising graphite and CO2.

Item FF116. A composite comprising graphyne and CO2.

Item FF117. A composite comprising a COOH-functionalized carbon nanotube and CO2.

Item FF118. A composite comprising a OH-functionalized carbon nanotube and CO2.

Item FF119. A composite comprising an NH2-functionalized carbon nanotube and CO2.

Item FF120. A composite comprising an SH-functionalized carbon nanotube and CO2.

Item FF121. A composite comprising COOH-functionalized graphene and CO2.

Item FF122. A composite comprising NH2-functionalized graphene and CO2.

Item FF123. A composite comprising OH-functionalized graphene and CO2.

Item FF124. A composite comprising thiol-functionalized graphene and CO2.

Item FF125. A composite comprising a glass fibre and CO2.

Item FF126. A composite comprising a nanotube and biphenyl.

Item FF127. A composite comprising a carbon nanotube and biphenyl.

Item FF128. A composite comprising a multi-wall nanotube and biphenyl.

Item FF129. A composite comprising a multi-wall carbon nanotube and biphenyl.

Item FF130. A composite comprising a single-wall nanotube and biphenyl.

Item FF131. A composite comprising a single-wall carbon nanotube and biphenyl.

Item FF132. A composite comprising graphene and biphenyl.

Item FF133. A composite comprising a carbon fibre and biphenyl.

Item FF134. A composite comprising a carbon nanofibre and biphenyl.

Item FF135. A composite comprising a carbon nanothread and biphenyl.

Item FF136. A composite comprising a ceramic material and biphenyl.

Item FF137. A composite comprising a fullerene and biphenyl.

Item FF138. A composite comprising graphane and biphenyl.

Item FF139. A composite comprising graphene oxide and biphenyl.

Item FF140. A composite comprising graphite and biphenyl.

Item FF141. A composite comprising graphyne and biphenyl.

Item FF142. A composite comprising a COOH-functionalized carbon nanotube and biphenyl.

Item FF143. A composite comprising a OH-functionalized carbon nanotube and biphenyl.

Item FF144. A composite comprising an NH2-functionalized carbon nanotube and biphenyl.

Item FF145. A composite comprising an SH-functionalized carbon nanotube and biphenyl.

Item FF146. A composite comprising COOH-functionalized graphene and biphenyl.

Item FF147. A composite comprising NH2-functionalized graphene and biphenyl.

Item FF148. A composite comprising OH-functionalized graphene and biphenyl.

Item FF149. A composite comprising thiol-functionalized graphene and biphenyl.

Item FF150. A composite comprising a glass fibre and biphenyl.

Item FF151. A composite comprising a nanotube and NC—C(CH3)2-C(CH3)2-CN.

Item FF152. A composite comprising a carbon nanotube and NC—C(CH3)2-C(CH3)2-CN.

Item FF153. A composite comprising a multi-wall nanotube and NC—C(CH3)2-C(CH3)2-CN.

Item FF154. A composite comprising a multi-wall carbon nanotube and NC—C(CH3)2-C(CH3)2-CN.

Item FF155. A composite comprising a single-wall nanotube and NC—C(CH3)2-C(CH3)2-CN Item FF156. A composite comprising a single-wall carbon nanotube and NC—C(CH3)2-C(CH3)2-CN.

Item FF157. A composite comprising graphene and NC—C(CH3)2-C(CH3)2-CN.

Item FF158. A composite comprising a carbon fibre and NC—C(CH3)2-C(CH3)2-CN.

Item FF159. A composite comprising a carbon nanofibre and NC—C(CH3)2-C(CH3)2-CN.

Item FF160. A composite comprising a carbon nanothread and NC—C(CH3)2-C(CH3)2-CN.

Item FF161. A composite comprising a ceramic material and NC—C(CH3)2-C(CH3)2-CN.

Item FF162. A composite comprising a fullerene and NC—C(CH3)2-C(CH3)2-CN.

Item FF163. A composite comprising graphane and NC—C(CH3)2-C(CH3)2-CN.

Item FF164. A composite comprising graphene oxide and NC—C(CH3)2-C(CH3)2-CN.

Item FF165. A composite comprising graphite and NC—C(CH3)2-C(CH3)2-CN.

Item FF166. A composite comprising graphyne and NC—C(CH3)2-C(CH3)2-CN.

Item FF167. A composite comprising a COOH-functionalized carbon nanotube and NC—C(CH3)2-C(CH3)2-CN.

Item FF168. A composite comprising a OH-functionalized carbon nanotube and NC—C(CH3)2-C(CH3)2-CN.

Item FF169. A composite comprising an NH2-functionalized carbon nanotube and NC—C(CH3)2-C(CH3)2-CN.

Item FF170. A composite comprising an SH-functionalized carbon nanotube and NC—C(CH3)2-C(CH3)2-CN.

Item FF171. A composite comprising COOH-functionalized graphene and NC—C(CH3)2-C(CH3)2-CN.

Item FF172. A composite comprising NH2-functionalized graphene and NC—C(CH3)2-C(CH3)2-CN.

Item FF173. A composite comprising OH-functionalized graphene and NC—C(CH3)2-C(CH3)2-CN.

Item FF174. A composite comprising thiol-functionalized graphene and NC—C(CH3)2-C(CH3)2-CN.

Item FF175. A composite comprising a glass fibre and NC—C(CH3)2-C(CH3)2-CN.

Item FF176. A composite comprising a nanotube and NC—C(CH3)(CH2-CH3)-C(CH3)(CH2-CH3)-CN.

Item FF177. A composite comprising a carbon nanotube and NC—C(CH3)(CH2-CH3)-C(CH3)(CH2-CH3)-CN.

Item FF178. A composite comprising a multi-wall nanotube and NC—C(CH3)(CH2-CH3)-C(CH3)(CH2-CH3)-CN.

Item FF179. A composite comprising a multi-wall carbon nanotube and NC—C(CH3)(CH2-CH3)-C(CH3)(CH2-CH3)-CN.

Item FF180. A composite comprising a single-wall nanotube and NC—C(CH3)(CH2-CH3)-C(CH3)(CH2-CH3)-CN.

Item FF181. A composite comprising a single-wall carbon nanotube and NC—C(CH3)(CH2-CH3)-C(CH3)(CH2-CH3)-CN.

Item FF182. A composite comprising graphene and NC—C(CH3)(CH2-CH3)-C(CH3)(CH2-CH3)-CN.

Item FF183. A composite comprising a carbon fibre and NC—C(CH3)(CH2-CH3)-C(CH3)(CH2-CH3)-CN.

Item FF184. A composite comprising a carbon nanofibre and NC—C(CH3)(CH2-CH3)-C(CH3)(CH2-CH3)-CN.

Item FF185. A composite comprising a carbon nanothread and NC—C(CH3)(CH2-CH3)-C(CH3)(CH2-CH3)-CN.

Item FF186. A composite comprising a ceramic material and NC—C(CH3)(CH2-CH3)-C(CH3)(CH2-CH3)-CN.

Item FF187. A composite comprising a fullerene and NC—C(CH3)(CH2-CH3)-C(CH3)(CH2-CH3)-CN.

Item FF188. A composite comprising graphane and NC—C(CH3)(CH2-CH3)-C(CH3)(CH2-CH3)-CN.

Item FF189. A composite comprising graphene oxide and NC—C(CH3)(CH2-CH3)-C(CH3)(CH2-CH3)-CN.

Item FF190. A composite comprising graphite and NC—C(CH3)(CH2-CH3)-C(CH3)(CH2-CH3)-CN.

Item FF191. A composite comprising graphyne and NC—C(CH3)(CH2-CH3)-C(CH3)(CH2-CH3)-CN.

Item FF192. A composite comprising a COOH-functionalized carbon nanotube and NC—C(CH3)(CH2-CH3)-C(CH3)(CH2-CH3)-CN.

Item FF193. A composite comprising a OH-functionalized carbon nanotube and NC—C(CH3)(CH2-CH3)-C(CH3)(CH2-CH3)-CN.

Item FF194. A composite comprising an NH2-functionalized carbon nanotube and NC—C(CH3)(CH2-CH3)-C(CH3)(CH2-CH3)-CN.

Item FF195. A composite comprising an SH-functionalized carbon nanotube and NC—C(CH3)(CH2-CH3)-C(CH3)(CH2-CH3)-CN.

Item FF196. A composite comprising COOH-functionalized graphene and NC—C(CH3)(CH2-CH3)-C(CH3)(CH2-CH3)-CN.

Item FF197. A composite comprising NH2-functionalized graphene and NC—C(CH3)(CH2-CH3)-C(CH3)(CH2-CH3)-CN.

Item FF198. A composite comprising OH-functionalized graphene and NC—C(CH3)(CH2-CH3)-C(CH3)(CH2-CH3)-CN.

Item FF199. A composite comprising thiol-functionalized graphene and NC—C(CH3)(CH2-CH3)-C(CH3)(CH2-CH3)-CN.

Item FF200. A composite comprising a glass fibre and NC—C(CH3)(CH2-CH3)-C(CH3)(CH2-CH3)-CN.

Item FF201. A composite comprising a nanotube and NC—C(CH3)(CH2-C(CH3)2-O—CH3)-C(CH3)(CH2-C(CH3)2-O—CH3)-CN.

Item FF202. A composite comprising a carbon nanotube and NC—C(CH3)(CH2-C(CH3)2-O—CH3)-C(CH3)(CH2-C(CH3)2-O—CH3)-CN.

Item FF203. A composite comprising a multi-wall nanotube and NC—C(CH3)(CH2-C(CH3)2-O—CH3)-C(CH3)(CH2-C(CH3)2-O—CH3)-CN.

Item FF204. A composite comprising a multi-wall carbon nanotube and NC—C(CH3)(CH2-C(CH3)2-O—CH3)-C(CH3)(CH2-C(CH3)2-O—CH3)-CN.

Item FF205. A composite comprising a single-wall nanotube and NC—C(CH3)(CH2-C(CH3)2-O—CH3)-C(CH3)(CH2-C(CH3)2-O—CH3)-CN.

Item FF206. A composite comprising a single-wall carbon nanotube and NC—C(CH3)(CH2-C(CH3)2-O—CH3)-C(CH3)(CH2-C(CH3)2-O—CH3)-CN.

Item FF207. A composite comprising graphene and NC—C(CH3)(CH2-C(CH3)2-O—CH3)-C(CH3)(CH2-C(CH3)2-O—CH3)-CN.

Item FF208. A composite comprising a carbon fibre and NC—C(CH3)(CH2-C(CH3)2-O—CH3)-C(CH3)(CH2-C(CH3)2-O—CH3)-CN.

Item FF209. A composite comprising a carbon nanofibre and NC—C(CH3)(CH2-C(CH3)2-O—CH3)-C(CH3)(CH2-C(CH3)2-O—CH3)-CN.

Item FF210. A composite comprising a carbon nanothread and NC—C(CH3)(CH2-C(CH3)2-O—CH3)-C(CH3)(CH2-C(CH3)2-O—CH3)-CN.

Item FF211. A composite comprising a ceramic material and NC—C(CH3)(CH2-C(CH3)2-O—CH3)-C(CH3)(CH2-C(CH3)2-O—CH3)-CN.

Item FF212. A composite comprising a fullerene and NC—C(CH3)(CH2-C(CH3)2-O—CH3)-C(CH3)(CH2-C(CH3)2-O—CH3)-CN.

Item FF213. A composite comprising graphane and NC—C(CH3)(CH2-C(CH3)2-O—CH3)-C(CH3)(CH2-C(CH3)2-O—CH3)-CN.

Item FF214. A composite comprising graphene oxide and NC—C(CH3)(CH2-C(CH3)2-O—CH3)-C(CH3)(CH2-C(CH3)2-O—CH3)-CN.

Item FF215. A composite comprising graphite and NC—C(CH3)(CH2-C(CH3)2-O—CH3)-C(CH3)(CH2-C(CH3)2-O—CH3)-CN.

Item FF216. A composite comprising graphyne and NC—C(CH3)(CH2-C(CH3)2-O—CH3)-C(CH3)(CH2-C(CH3)2-O—CH3)-CN.

Item FF217. A composite comprising a COOH-functionalized carbon nanotube and NC—C(CH3)(CH2-C(CH3)2-O—CH3)-C(CH3)(CH2-C(CH3)2-O—CH3)-CN.

Item FF218. A composite comprising a OH-functionalized carbon nanotube and NC—C(CH3)(CH2-C(CH3)2-O—CH3)-C(CH3)(CH2-C(CH3)2-O—CH3)-CN.

Item FF219. A composite comprising an NH2-functionalized carbon nanotube and NC—C(CH3)(CH2-C(CH3)2-O—CH3)-C(CH3)(CH2-C(CH3)2-O—CH3)-CN.

Item FF220. A composite comprising an SH-functionalized carbon nanotube and NC—C(CH3)(CH2-C(CH3)2-O—CH3)-C(CH3)(CH2-C(CH3)2-O—CH3)-CN.

Item FF221. A composite comprising COOH-functionalized graphene and NC—C(CH3)(CH2-C(CH3)2-O—CH3)-C(CH3)(CH2-C(CH3)2-O—CH3)-CN.

Item FF222. A composite comprising NH2-functionalized graphene and NC—C(CH3)(CH2-C(CH3)2-O—CH3)-C(CH3)(CH2-C(CH3)2-O—CH3)-CN.

Item FF223. A composite comprising OH-functionalized graphene and NC—C(CH3)(CH2-C(CH3)2-O—CH3)-C(CH3)(CH2-C(CH3)2-O—CH3)-CN.

Item FF224. A composite comprising thiol-functionalized graphene and NC—C(CH3)(CH2-C(CH3)2-O—CH3)-C(CH3)(CH2-C(CH3)2-O—CH3)-CN.

Item FF225. A composite comprising a glass fibre and NC—C(CH3)(CH2-C(CH3)2-O—CH3)-C(CH3)(CH2-C(CH3)2-O—CH3)-CN.

Item FFF1. A composite comprising a nanotube and polyester and H2O.

Item FFF2. A composite comprising a carbon nanotube and polyester and H2O.

Item FFF3. A composite comprising a multi-wall nanotube and polyester and H2O.

Item FFF4. A composite comprising a multi-wall carbon nanotube and polyester and H2O.

Item FFF5. A composite comprising a single-wall nanotube and polyester and H2O.

Item FFF6. A composite comprising a single-wall carbon nanotube and polyester and H2O.

Item FFF7. A composite comprising graphene and polyester and H2O.

Item FFF8. A composite comprising a carbon fibre and polyester and H2O.

Item FFF9. A composite comprising a carbon nanofibre and polyester and H2O.

Item FFF10. A composite comprising a carbon nanothread and polyester and H2O.

Item FFF11. A composite comprising a ceramic material and polyester and H2O.

Item FFF12. A composite comprising a fullerene and polyester and H2O.

Item FFF13. A composite comprising graphane and polyester and H2O.

Item FFF14. A composite comprising graphene oxide and polyester and H2O.

Item FFF15. A composite comprising graphite and polyester and H2O.

Item FFF16. A composite comprising graphyne and polyester and H2O.

Item FFF17. A composite comprising a COOH-functionalized carbon nanotube and polyester and H2O.

Item FFF18. A composite comprising a OH-functionalized carbon nanotube and polyester and H2O.

Item FFF19. A composite comprising an NH2-functionalized carbon nanotube and polyester and H2O.

Item FFF20. A composite comprising an SH-functionalized carbon nanotube and polyester and H2O.

Item FFF21. A composite comprising COOH-functionalized graphene and polyester and H2O.

Item FFF22. A composite comprising NH2-functionalized graphene and polyester and H2O.

Item FFF23. A composite comprising OH-functionalized graphene and polyester and H2O.

Item FFF24. A composite comprising thiol-functionalized graphene and polyester and H2O.

Item FFF25. A composite comprising a glass fibre and polyester and H2O.

Item FFF26. A composite comprising a nanotube and polyamide and H2O.

Item FFF27. A composite comprising a carbon nanotube and polyamide and H2O.

Item FFF28. A composite comprising a multi-wall nanotube and polyamide and H2O.

Item FFF29. A composite comprising a multi-wall carbon nanotube and polyamide and H2O.

Item FFF30. A composite comprising a single-wall nanotube and polyamide and H2O.

Item FFF31. A composite comprising a single-wall carbon nanotube and polyamide and H2O.

Item FFF32. A composite comprising graphene and polyamide and H2O.

Item FFF33. A composite comprising a carbon fibre and polyamide and H2O.

Item FFF34. A composite comprising a carbon nanofibre and polyamide and H2O.

Item FFF35. A composite comprising a carbon nanothread and polyamide and H2O.

Item FFF36. A composite comprising a ceramic material and polyamide and H2O.

Item FFF37. A composite comprising a fullerene and polyamide and H2O.

Item FFF38. A composite comprising graphane and polyamide and H2O.

Item FFF39. A composite comprising graphene oxide and polyamide and H2O.

Item FFF40. A composite comprising graphite and polyamide and H2O.

Item FFF41. A composite comprising graphyne and polyamide and H2O.

Item FFF42. A composite comprising a COOH-functionalized carbon nanotube and polyamide and H2O.

Item FFF43. A composite comprising a OH-functionalized carbon nanotube and polyamide and H2O.

Item FFF44. A composite comprising an NH2-functionalized carbon nanotube and polyamide and H2O.

Item FFF45. A composite comprising an SH-functionalized carbon nanotube and polyamide and H2O.

Item FFF46. A composite comprising COOH-functionalized graphene and polyamide and H2O.

Item FFF47. A composite comprising NH2-functionalized graphene and polyamide and H2O.

Item FFF48. A composite comprising OH-functionalized graphene and polyamide and H2O.

Item FFF49. A composite comprising thiol-functionalized graphene and polyamide and H2O.

Item FFF50. A composite comprising a glass fibre and polyamide and H2O.

Item FFF51. A composite comprising a nanotube and polyamide and HCl.

Item FFF52. A composite comprising a carbon nanotube and polyamide and HCl.

Item FFF53. A composite comprising a multi-wall nanotube and polyamide and HCl.

Item FFF54. A composite comprising a multi-wall carbon nanotube and polyamide and HCl.

Item FFF55. A composite comprising a single-wall nanotube and polyamide and HCl.

Item FFF56. A composite comprising a single-wall carbon nanotube and polyamide and HCl.

Item FFF57. A composite comprising graphene and polyamide and HCl.

Item FFF58. A composite comprising a carbon fibre and polyamide and HCl.

Item FFF59. A composite comprising a carbon nanofibre and polyamide and HCl.

Item FFF60. A composite comprising a carbon nanothread and polyamide and HCl.

Item FFF61. A composite comprising a ceramic material and polyamide and HCl.

Item FFF62. A composite comprising a fullerene and polyamide and HCl.

Item FFF63. A composite comprising graphane and polyamide and HCl.

Item FFF64. A composite comprising graphene oxide and polyamide and HCl.

Item FFF65. A composite comprising graphite and polyamide and HCl.

Item FFF66. A composite comprising graphyne and polyamide and HCl.

Item FFF67. A composite comprising a COOH-functionalized carbon nanotube and polyamide and HCl.

Item FFF68. A composite comprising a OH-functionalized carbon nanotube and polyamide and HCl.

Item FFF69. A composite comprising an NH2-functionalized carbon nanotube and polyamide and HCl.

Item FFF70. A composite comprising an SH-functionalized carbon nanotube and polyamide and HCl.

Item FFF71. A composite comprising COOH-functionalized graphene and polyamide and HCl.

Item FFF72. A composite comprising NH2-functionalized graphene and polyamide and HCl.

Item FFF73. A composite comprising OH-functionalized graphene and polyamide and HCl.

Item FFF74. A composite comprising thiol-functionalized graphene and polyamide and HCl.

Item FFF75. A composite comprising a glass fibre and polyamide and HCl.

Item FFF76. A composite comprising a nanotube and polyurethane and CO2.

Item FFF77. A composite comprising a carbon nanotube and polyurethane and CO2.

Item FFF78. A composite comprising a multi-wall nanotube and polyurethane and CO2.

Item FFF79. A composite comprising a multi-wall carbon nanotube and polyurethane and CO2.

Item FFF80. A composite comprising a single-wall nanotube and polyurethane and CO2.

Item FFF81. A composite comprising a single-wall carbon nanotube and polyurethane and CO2.

Item FFF82. A composite comprising graphene and polyurethane and CO2.

Item FFF83. A composite comprising a carbon fibre and polyurethane and CO2.

Item FFF84. A composite comprising a carbon nanofibre and polyurethane and CO2.

Item FFF85. A composite comprising a carbon nanothread and polyurethane and CO2.

Item FFF86. A composite comprising a ceramic material and polyurethane and CO2.

Item FFF87. A composite comprising a fullerene and polyurethane and CO2.

Item FFF88. A composite comprising graphane and polyurethane and CO2.

Item FFF89. A composite comprising graphene oxide and polyurethane and CO2.

Item FFF90. A composite comprising graphite and polyurethane and CO2.

Item FFF91. A composite comprising graphyne and polyurethane and CO2.

Item FFF92. A composite comprising a COOH-functionalized carbon nanotube and polyurethane and CO2.

Item FFF93. A composite comprising a OH-functionalized carbon nanotube and polyurethane and CO2.

Item FFF94. A composite comprising an NH2-functionalized carbon nanotube and polyurethane and CO2.

Item FFF95. A composite comprising an SH-functionalized carbon nanotube and polyurethane and CO2.

Item FFF96. A composite comprising COOH-functionalized graphene and polyurethane and CO2.

Item FFF97. A composite comprising NH2-functionalized graphene and polyurethane and CO2.

Item FFF98. A composite comprising OH-functionalized graphene and polyurethane and CO2.

Item FFF99. A composite comprising thiol-functionalized graphene and polyurethane and CO2.

Item FFF100. A composite comprising a glass fibre and polyurethane and CO2.

Item FFF101. A composite comprising a nanotube and polystyrene and CO2.

Item FFF102. A composite comprising a carbon nanotube and polystyrene and CO2.

Item FFF103. A composite comprising a multi-wall nanotube and polystyrene and CO2.

Item FFF104. A composite comprising a multi-wall carbon nanotube and polystyrene and CO2.

Item FFF105. A composite comprising a single-wall nanotube and polystyrene and CO2.

Item FFF106. A composite comprising a single-wall carbon nanotube and polystyrene and CO2.

Item FFF107. A composite comprising graphene and polystyrene and CO2.

Item FFF108. A composite comprising a carbon fibre and polystyrene and CO2.

Item FFF109. A composite comprising a carbon nanofibre and polystyrene and CO2.

Item FFF110. A composite comprising a carbon nanothread and polystyrene and CO2.

Item FFF111. A composite comprising a ceramic material and polystyrene and CO2.

Item FFF112. A composite comprising a fullerene and polystyrene and CO2.

Item FFF113. A composite comprising graphane and polystyrene and CO2.

Item FFF114. A composite comprising graphene oxide and polystyrene and CO2.

Item FFF115. A composite comprising graphite and polystyrene and CO2.

Item FFF116. A composite comprising graphyne and polystyrene and CO2.

Item FFF117. A composite comprising a COOH-functionalized carbon nanotube and polystyrene and CO2.

Item FFF118. A composite comprising a OH-functionalized carbon nanotube and polystyrene and CO2.

Item FFF119. A composite comprising an NH2-functionalized carbon nanotube and polystyrene and CO2.

Item FFF120. A composite comprising an SH-functionalized carbon nanotube and polystyrene and CO2.

Item FFF121. A composite comprising COOH-functionalized graphene and polystyrene and CO2.

Item FFF122. A composite comprising NH2-functionalized graphene and polystyrene and CO2.

Item FFF123. A composite comprising OH-functionalized graphene and polystyrene and CO2.

Item FFF124. A composite comprising thiol-functionalized graphene and polystyrene and CO2.

Item FFF125. A composite comprising a glass fibre and polystyrene and CO2.

Item FFF126. A composite comprising a nanotube and polystyrene linked to —C(CH3)2-CN.

Item FFF127. A composite comprising a carbon nanotube and polystyrene linked to —C(CH3)2-CN.

Item FFF128. A composite comprising a multi-wall nanotube and polystyrene linked to —C(CH3)2-CN.

Item FFF129. A composite comprising a multi-wall carbon nanotube and polystyrene linked to —C(CH3)2-CN.

Item FFF130. A composite comprising a single-wall nanotube and polystyrene linked to —C(CH3)2-CN.

Item FFF131. A composite comprising a single-wall carbon nanotube and polystyrene linked to —C(CH3)2-CN.

Item FFF132. A composite comprising graphene and polystyrene linked to —C(CH3)2-CN.

Item FFF133. A composite comprising a carbon fibre and polystyrene linked to —C(CH3)2-CN.

Item FFF134. A composite comprising a carbon nanofibre and polystyrene linked to —C(CH3)2-CN.

Item FFF135. A composite comprising a carbon nanothread and polystyrene linked to —C(CH3)2-CN.

Item FFF136. A composite comprising a ceramic material and polystyrene linked to —C(CH3)2-CN.

Item FFF137. A composite comprising a fullerene and polystyrene linked to —C(CH3)2-CN.

Item FFF138. A composite comprising graphane and polystyrene linked to —C(CH3)2-CN.

Item FFF139. A composite comprising graphene oxide and polystyrene linked to —C(CH3)2-CN.

Item FFF140. A composite comprising graphite and polystyrene linked to —C(CH3)2-CN.

Item FFF141. A composite comprising graphyne and polystyrene linked to —C(CH3)2-CN.

Item FFF142. A composite comprising a COOH-functionalized carbon nanotube and polystyrene linked to —C(CH3)2-CN.

Item FFF143. A composite comprising a OH-functionalized carbon nanotube and polystyrene linked to —C(CH3)2-CN.

Item FFF144. A composite comprising an NH2-functionalized carbon nanotube and polystyrene linked to —C(CH3)2-CN.

Item FFF145. A composite comprising an SH-functionalized carbon nanotube and polystyrene linked to —C(CH3)2-CN.

Item FFF146. A composite comprising COOH-functionalized graphene and polystyrene linked to —C(CH3)2-CN.

Item FFF147. A composite comprising NH2-functionalized graphene and polystyrene linked to —C(CH3)2-CN.

Item FFF148. A composite comprising OH-functionalized graphene and polystyrene linked to —C(CH3)2-CN.

Item FFF149. A composite comprising thiol-functionalized graphene and polystyrene linked to —C(CH3)2-CN.

Item FFF150. A composite comprising a glass fibre and polystyrene linked to —C(CH3)2-CN.

Item FFF151. A composite comprising a nanotube and polymethyl methacrylate linked to —C(CH3)(CH2-CH3)-CN.

Item FFF152. A composite comprising a carbon nanotube and polymethyl methacrylate linked to —C(CH3)(CH2-CH3)-CN.

Item FFF153. A composite comprising a multi-wall nanotube and polymethyl methacrylate linked to —C(CH3)(CH2-CH3)-CN.

Item FFF154. A composite comprising a multi-wall carbon nanotube and polymethyl methacrylate linked to —C(CH3)(CH2-CH3)-CN.

Item FFF155. A composite comprising a single-wall nanotube and polymethyl methacrylate linked to —C(CH3)(CH2-CH3)-CN.

Item FFF156. A composite comprising a single-wall carbon nanotube and polymethyl methacrylate linked to —C(CH3)(CH2-CH3)-CN.

Item FFF157. A composite comprising graphene and polymethyl methacrylate linked to —C(CH3)(CH2-CH3)-CN.

Item FFF158. A composite comprising a carbon fibre and polymethyl methacrylate linked to —C(CH3)(CH2-CH3)-CN.

Item FFF159. A composite comprising a carbon nanofibre and polymethyl methacrylate linked to —C(CH3)(CH2-CH3)-CN.

Item FFF160. A composite comprising a carbon nanothread and polymethyl methacrylate linked to —C(CH3)(CH2-CH3)-CN.

Item FFF161. A composite comprising a ceramic material and polymethyl methacrylate linked to —C(CH3)(CH2-CH3)-CN.

Item FFF162. A composite comprising a fullerene and polymethyl methacrylate linked to —C(CH3)(CH2-CH3)-CN.

Item FFF163. A composite comprising graphane and polymethyl methacrylate linked to —C(CH3)(CH2-CH3)-CN.

Item FFF164. A composite comprising graphene oxide and polymethyl methacrylate linked to —C(CH3)(CH2-CH3)-CN.

Item FFF165. A composite comprising graphite and polymethyl methacrylate linked to —C(CH3)(CH2-CH3)-CN.

Item FFF166. A composite comprising graphyne and polymethyl methacrylate linked to —C(CH3)(CH2-CH3)-CN.

Item FFF167. A composite comprising a COOH-functionalized carbon nanotube and polymethyl methacrylate linked to —C(CH3)(CH2-CH3)-CN.

Item FFF168. A composite comprising a OH-functionalized carbon nanotube and polymethyl methacrylate linked to —C(CH3)(CH2-CH3)-CN.

Item FFF169. A composite comprising an NH2-functionalized carbon nanotube and polymethyl methacrylate linked to —C(CH3)(CH2-CH3)-CN.

Item FFF170. A composite comprising an SH-functionalized carbon nanotube and polymethyl methacrylate linked to —C(CH3)(CH2-CH3)-CN.

Item FFF171. A composite comprising COOH-functionalized graphene and polymethyl methacrylate linked to —C(CH3)(CH2-CH3)-CN.

Item FFF172. A composite comprising NH2-functionalized graphene and polymethyl methacrylate linked to —C(CH3)(CH2-CH3)-CN.

Item FFF173. A composite comprising OH-functionalized graphene and polymethyl methacrylate linked to —C(CH3)(CH2-CH3)-CN.

Item FFF174. A composite comprising thiol-functionalized graphene and polymethyl methacrylate linked to —C(CH3)(CH2-CH3)-CN.

Item FFF175. A composite comprising a glass fibre and polymethyl methacrylate linked to —C(CH3)(CH2-CH3)-CN.

Item FFF176. A composite comprising a nanotube and polymethyl methacrylate linked to —C(CH3)(CH2-C(CH3)2-O—CH3)-CN.

Item FFF177. A composite comprising a carbon nanotube and polymethyl methacrylate linked to —C(CH3)(CH2-C(CH3)2-O—CH3)-CN.

Item FFF178. A composite comprising a multi-wall nanotube and polymethyl methacrylate linked to —C(CH3)(CH2-C(CH3)2-O—CH3)-CN.

Item FFF179. A composite comprising a multi-wall carbon nanotube and polymethyl methacrylate linked to —C(CH3)(CH2-C(CH3)2-O—CH3)-CN.

Item FFF180. A composite comprising a single-wall nanotube and polymethyl methacrylate linked to —C(CH3)(CH2-C(CH3)2-O—CH3)-CN.

Item FFF181. A composite comprising a single-wall carbon nanotube and polymethyl methacrylate linked to —C(CH3)(CH2-C(CH3)2-O—CH3)-CN.

Item FFF182. A composite comprising graphene and polymethyl methacrylate linked to —C(CH3)(CH2-C(CH3)2-O—CH3)-CN.

Item FFF183. A composite comprising a carbon fibre and polymethyl methacrylate linked to —C(CH3)(CH2-C(CH3)2-O—CH3)-CN.

Item FFF184. A composite comprising a carbon nanofibre and polymethyl methacrylate linked to —C(CH3)(CH2-C(CH3)2-O—CH3)-CN.

Item FFF185. A composite comprising a carbon nanothread and polymethyl methacrylate linked to —C(CH3)(CH2-C(CH3)2-O—CH3)-CN.

Item FFF186. A composite comprising a ceramic material and polymethyl methacrylate linked to —C(CH3)(CH2-C(CH3)2-O—CH3)-CN.

Item FFF187. A composite comprising a fullerene and polymethyl methacrylate linked to —C(CH3)(CH2-C(CH3)2-O—CH3)-CN.

Item FFF188. A composite comprising graphane and polymethyl methacrylate linked to —C(CH3)(CH2-C(CH3)2-O—CH3)-CN.

Item FFF189. A composite comprising graphene oxide and polymethyl methacrylate linked to —C(CH3)(CH2-C(CH3)2-O—CH3)-CN.

Item FFF190. A composite comprising graphite and polymethyl methacrylate linked to —C(CH3)(CH2-C(CH3)2-O—CH3)-CN.

Item FFF191. A composite comprising graphyne and polymethyl methacrylate linked to —C(CH3)(CH2-C(CH3)2-O—CH3)-CN.

Item FFF192. A composite comprising a COOH-functionalized carbon nanotube and polymethyl methacrylate linked to —C(CH3)(CH2-C(CH3)2-O—CH3)-CN.

Item FFF193. A composite comprising a OH-functionalized carbon nanotube and polymethyl methacrylate linked to —C(CH3)(CH2-C(CH3)2-O—CH3)-CN.

Item FFF194. A composite comprising an NH2-functionalized carbon nanotube and polymethyl methacrylate linked to —C(CH3)(CH2-C(CH3)2-O—CH3)-CN.

Item FFF195. A composite comprising an SH-functionalized carbon nanotube and polymethyl methacrylate linked to —C(CH3)(CH2-C(CH3)2-O—CH3)-CN.

Item FFF196. A composite comprising COOH-functionalized graphene and polymethyl methacrylate linked to —C(CH3)(CH2-C(CH3)2-O—CH3)-CN.

Item FFF197. A composite comprising NH2-functionalized graphene and polymethyl methacrylate linked to —C(CH3)(CH2-C(CH3)2-O—CH3)-CN.

Item FFF198. A composite comprising OH-functionalized graphene and polymethyl methacrylate linked to —C(CH3)(CH2-C(CH3)2-O—CH3)-CN.

Item FFF199. A composite comprising thiol-functionalized graphene and polymethyl methacrylate linked to —C(CH3)(CH2-C(CH3)2-O—CH3)-CN.

Item FFF200. A composite comprising a glass fibre and polymethyl methacrylate linked to —C(CH3)(CH2-C(CH3)2-O—CH3)-CN.

Item FFF201. A composite comprising a nanotube and polyacrylate linked to a phenyl group.

Item FFF202. A composite comprising a carbon nanotube and polyacrylate linked to a phenyl group.

Item FFF203. A composite comprising a multi-wall nanotube and polyacrylate linked to a phenyl group.

Item FFF204. A composite comprising a multi-wall carbon nanotube and polyacrylate linked to a phenyl group.

Item FFF205. A composite comprising a single-wall nanotube and polyacrylate linked to a phenyl group.

Item FFF206. A composite comprising a single-wall carbon nanotube and polyacrylate linked to a phenyl group.

Item FFF207. A composite comprising graphene and polyacrylate linked to a phenyl group.

Item FFF208. A composite comprising a carbon fibre and polyacrylate linked to a phenyl group.

Item FFF209. A composite comprising a carbon nanofibre and polyacrylate linked to a phenyl group.

Item FFF210. A composite comprising a carbon nanothread and polyacrylate linked to a phenyl group.

Item FFF211. A composite comprising a ceramic material and polyacrylate linked to a phenyl group.

Item FFF212. A composite comprising a fullerene and polyacrylate linked to a phenyl group.

Item FFF213. A composite comprising graphane and polyacrylate linked to a phenyl group.

Item FFF214. A composite comprising graphene oxide and polyacrylate linked to a phenyl group.

Item FFF215. A composite comprising graphite and polyacrylate linked to a phenyl group.

Item FFF216. A composite comprising graphyne and polyacrylate linked to a phenyl group.

Item FFF217. A composite comprising a COOH-functionalized carbon nanotube and polyacrylate linked to a phenyl group.

Item FFF218. A composite comprising a OH-functionalized carbon nanotube and polyacrylate linked to a phenyl group.

Item FFF219. A composite comprising an NH2-functionalized carbon nanotube and polyacrylate linked to a phenyl group.

Item FFF220. A composite comprising an SH-functionalized carbon nanotube and polyacrylate linked to a phenyl group.

Item FFF221. A composite comprising COOH-functionalized graphene and polyacrylate linked to a phenyl group.

Item FFF222. A composite comprising NH2-functionalized graphene and polyacrylate linked to a phenyl group.

Item FFF223. A composite comprising OH-functionalized graphene and polyacrylate linked to a phenyl group.

Item FFF224. A composite comprising thiol-functionalized graphene and polyacrylate linked to a phenyl group.

Item FFF225. A composite comprising a glass fibre and polyacrylate linked to a phenyl group.

Item FFF226. A composite comprising a nanotube and polyacrylate and NC—C(CH3)2-C(CH3)2-CN.

Item FFF227. A composite comprising a carbon nanotube and polyacrylate and NC—C(CH3)2-C(CH3)2-CN.

Item FFF228. A composite comprising a multi-wall nanotube and polyacrylate and NC—C(CH3)2-C(CH3)2-CN.

Item FFF229. A composite comprising a multi-wall carbon nanotube and polyacrylate and NC—C(CH3)2-C(CH3)2-CN.

Item FFF230. A composite comprising a single-wall nanotube and polyacrylate and NC—C(CH3)2-C(CH3)2-CN.

Item FFF231. A composite comprising a single-wall carbon nanotube and polyacrylate and NC—C(CH3)2-C(CH3)2-CN.

Item FFF232. A composite comprising graphene and polyacrylate and NC—C(CH3)2-C(CH3)2-CN.

Item FFF233. A composite comprising a carbon fibre and polyacrylate and NC—C(CH3)2-C(CH3)2-CN.

Item FFF234. A composite comprising a carbon nanofibre and polyacrylate and NC—C(CH3)2-C(CH3)2-CN.

Item FFF235. A composite comprising a carbon nanothread and polyacrylate and NC—C(CH3)2-C(CH3)2-CN.

Item FFF236. A composite comprising a ceramic material and polyacrylate and NC—C(CH3)2-C(CH3)2-CN.

Item FFF237. A composite comprising a fullerene and polyacrylate and NC—C(CH3)2-C(CH3)2-CN.

Item FFF238. A composite comprising graphane and polyacrylate and NC—C(CH3)2-C(CH3)2-CN.

Item FFF239. A composite comprising graphene oxide and polyacrylate and NC—C(CH3)2-C(CH3)2-CN.

Item FFF240. A composite comprising graphite and polyacrylate and NC—C(CH3)2-C(CH3)2-CN.

Item FFF241. A composite comprising graphyne and polyacrylate and NC—C(CH3)2-C(CH3)2-CN.

Item FFF242. A composite comprising a COOH-functionalized carbon nanotube and polyacrylate and NC—C(CH3)2-C(CH3)2-CN.

Item FFF243. A composite comprising a OH-functionalized carbon nanotube and polyacrylate and NC—C(CH3)2-C(CH3)2-CN.

Item FFF244. A composite comprising an NH2-functionalized carbon nanotube and polyacrylate and NC—C(CH3)2-C(CH3)2-CN.

Item FFF245. A composite comprising an SH-functionalized carbon nanotube and polyacrylate and NC—C(CH3)2-C(CH3)2-CN.

Item FFF246. A composite comprising COOH-functionalized graphene and polyacrylate and NC—C(CH3)2-C(CH3)2-CN.

Item FFF247. A composite comprising NH2-functionalized graphene and polyacrylate and NC—C(CH3)2-C(CH3)2-CN.

Item FFF248. A composite comprising OH-functionalized graphene and polyacrylate and NC—C(CH3)2-C(CH3)2-CN.

Item FFF249. A composite comprising thiol-functionalized graphene and polyacrylate and NC—C(CH3)2-C(CH3)2-CN.

Item FFF250. A composite comprising a glass fibre and polyacrylate and NC—C(CH3)2-C(CH3)2-CN.

Item FFF251. A composite comprising a nanotube and polyacrylonitrile and NC—C(CH3)(CH2-CH3)-C(CH3)(CH2-CH3)-CN.

Item FFF252. A composite comprising a carbon nanotube and polyacrylonitrile and NC—C(CH3)(CH2-CH3)-C(CH3)(CH2-CH3)-CN.

Item FFF253. A composite comprising a multi-wall nanotube and polyacrylonitrile and NC—C(CH3)(CH2-CH3)-C(CH3)(CH2-CH3)-CN.

Item FFF254. A composite comprising a multi-wall carbon nanotube and polyacrylonitrile and NC—C(CH3)(CH2-CH3)-C(CH3)(CH2-CH3)-CN.

Item FFF255. A composite comprising a single-wall nanotube and polyacrylonitrile and NC—C(CH3)(CH2-CH3)-C(CH3)(CH2-CH3)-CN.

Item FFF256. A composite comprising a single-wall carbon nanotube and polyacrylonitrile and NC—C(CH3)(CH2-CH3)-C(CH3)(CH2-CH3)-CN.

Item FFF257. A composite comprising graphene and polyacrylonitrile and NC—C(CH3)(CH2-CH3)-C(CH3)(CH2-CH3)-CN.

Item FFF258. A composite comprising a carbon fibre and polyacrylonitrile and NC—C(CH3)(CH2-CH3)-C(CH3)(CH2-CH3)-CN.

Item FFF259. A composite comprising a carbon nanofibre and polyacrylonitrile and NC—C(CH3)(CH2-CH3)-C(CH3)(CH2-CH3)-CN.

Item FFF260. A composite comprising a carbon nanothread and polyacrylonitrile and NC—C(CH3)(CH2-CH3)-C(CH3)(CH2-CH3)-CN.

Item FFF261. A composite comprising a ceramic material and polyacrylonitrile and NC—C(CH3)(CH2-CH3)-C(CH3)(CH2-CH3)-CN.

Item FFF262. A composite comprising a fullerene and polyacrylonitrile and NC—C(CH3)(CH2-CH3)-C(CH3)(CH2-CH3)-CN.

Item FFF263. A composite comprising graphane and polyacrylonitrile and NC—C(CH3)(CH2-CH3)-C(CH3)(CH2-CH3)-CN.

Item FFF264. A composite comprising graphene oxide and polyacrylonitrile and NC—C(CH3)(CH2-CH3)-C(CH3)(CH2-CH3)-CN.

Item FFF265. A composite comprising graphite and polyacrylonitrile and NC—C(CH3)(CH2-CH3)-C(CH3)(CH2-CH3)-CN.

Item FFF266. A composite comprising graphyne and polyacrylonitrile and NC—C(CH3)(CH2-CH3)-C(CH3)(CH2-CH3)-CN.

Item FFF267. A composite comprising a COOH-functionalized carbon nanotube and polyacrylonitrile and NC—C(CH3)(CH2-CH3)-C(CH3)(CH2-CH3)-CN.

Item FFF268. A composite comprising a OH-functionalized carbon nanotube and polyacrylonitrile and NC—C(CH3)(CH2-CH3)-C(CH3)(CH2-CH3)-CN.

Item FFF269. A composite comprising an NH2-functionalized carbon nanotube and polyacrylonitrile and NC—C(CH3)(CH2-CH3)-C(CH3)(CH2-CH3)-CN.

Item FFF270. A composite comprising an SH-functionalized carbon nanotube and polyacrylonitrile and NC—C(CH3)(CH2-CH3)-C(CH3)(CH2-CH3)-CN.

Item FFF271. A composite comprising COOH-functionalized graphene and polyacrylonitrile and NC—C(CH3)(CH2-CH3)-C(CH3)(CH2-CH3)-CN.

Item FFF272. A composite comprising NH2-functionalized graphene and polyacrylonitrile and NC—C(CH3)(CH2-CH3)-C(CH3)(CH2-CH3)-CN.

Item FFF273. A composite comprising OH-functionalized graphene and polyacrylonitrile and NC—C(CH3)(CH2-CH3)-C(CH3)(CH2-CH3)-CN.

Item FFF274. A composite comprising thiol-functionalized graphene and polyacrylonitrile and NC—C(CH3)(CH2-CH3)-C(CH3)(CH2-CH3)-CN.

Item FFF275. A composite comprising a glass fibre and polyacrylonitrile and NC—C(CH3)(CH2-CH3)-C(CH3)(CH2-CH3)-CN.

Item FFF276. A composite comprising a nanotube and polyacrylonitrile and NC—C(CH3)(CH2-C(CH3)2-O—CH3)-C(CH3)(CH2-C(CH3)2-O—CH3)-CN.

Item FFF277. A composite comprising a carbon nanotube and polyacrylonitrile and NC—C(CH3)(CH2-C(CH3)2-O—CH3)-C(CH3)(CH2-C(CH3)2-O—CH3)-CN.

Item FFF278. A composite comprising a multi-wall nanotube and polyacrylonitrile and NC—C(CH3)(CH2-C(CH3)2-O—CH3)-C(CH3)(CH2-C(CH3)2-O—CH3)-CN.

Item FFF279. A composite comprising a multi-wall carbon nanotube and polyacrylonitrile and NC—C(CH3)(CH2-C(CH3)2-O—CH3)-C(CH3)(CH2-C(CH3)2-O—CH3)-CN.

Item FFF280. A composite comprising a single-wall nanotube and polyacrylonitrile and NC—C(CH3)(CH2-C(CH3)2-O—CH3)-C(CH3)(CH2-C(CH3)2-O—CH3)-CN.

Item FFF281. A composite comprising a single-wall carbon nanotube and polyacrylonitrile and NC—C(CH3)(CH2-C(CH3)2-O—CH3)-C(CH3)(CH2-C(CH3)2-O—CH3)-CN.

Item FFF282. A composite comprising graphene and polyacrylonitrile and NC—C(CH3)(CH2-C(CH3)2-O—CH3)-C(CH3)(CH2-C(CH3)2-O—CH3)-CN.

Item FFF283. A composite comprising a carbon fibre and polyacrylonitrile and NC—C(CH3)(CH2-C(CH3)2-O—CH3)-C(CH3)(CH2-C(CH3)2-O—CH3)-CN.

Item FFF284. A composite comprising a carbon nanofibre and polyacrylonitrile and NC—C(CH3)(CH2-C(CH3)2-O—CH3)-C(CH3)(CH2-C(CH3)2-O—CH3)-CN.

Item FFF285. A composite comprising a carbon nanothread and polyacrylonitrile and NC—C(CH3)(CH2-C(CH3)2-O—CH3)-C(CH3)(CH2-C(CH3)2-O—CH3)-CN.

Item FFF286. A composite comprising a ceramic material and polyacrylonitrile and NC—C(CH3)(CH2-C(CH3)2-O—CH3)-C(CH3)(CH2-C(CH3)2-O—CH3)-CN.

Item FFF287. A composite comprising a fullerene and polyacrylonitrile and NC—C(CH3)(CH2-C(CH3)2-O—CH3)-C(CH3)(CH2-C(CH3)2-O—CH3)-CN.

Item FFF288. A composite comprising graphane and polyacrylonitrile and NC—C(CH3)(CH2-C(CH3)2-O—CH3)-C(CH3)(CH2-C(CH3)2-O—CH3)-CN.

Item FFF289. A composite comprising graphene oxide and polyacrylonitrile and NC—C(CH3)(CH2-C(CH3)2-O—CH3)-C(CH3)(CH2-C(CH3)2-O—CH3)-CN.

Item FFF290. A composite comprising graphite and polyacrylonitrile and NC—C(CH3)(CH2-C(CH3)2-O—CH3)-C(CH3)(CH2-C(CH3)2-O—CH3)-CN.

Item FFF291. A composite comprising graphyne and polyacrylonitrile and NC—C(CH3)(CH2-C(CH3)2-O—CH3)-C(CH3)(CH2-C(CH3)2-O—CH3)-CN.

Item FFF292. A composite comprising a COOH-functionalized carbon nanotube and polyacrylonitrile and NC—C(CH3)(CH2-C(CH3)2-O—CH3)-C(CH3)(CH2-C(CH3)2-O—CH3)-CN.

Item FFF293. A composite comprising a OH-functionalized carbon nanotube and polyacrylonitrile and NC—C(CH3)(CH2-C(CH3)2-O—CH3)-C(CH3)(CH2-C(CH3)2-O—CH3)-CN.

Item FFF294. A composite comprising an NH2-functionalized carbon nanotube and polyacrylonitrile and NC—C(CH3)(CH2-C(CH3)2-O—CH3)-C(CH3)(CH2-C(CH3)2-O—CH3)-CN.

Item FFF295. A composite comprising an SH-functionalized carbon nanotube and polyacrylonitrile and NC—C(CH3)(CH2-C(CH3)2-O—CH3)-C(CH3)(CH2-C(CH3)2-O—CH3)-CN.

Item FFF296. A composite comprising COOH-functionalized graphene and polyacrylonitrile and NC—C(CH3)(CH2-C(CH3)2-O—CH3)-C(CH3)(CH2-C(CH3)2-O—CH3)-CN.

Item FFF297. A composite comprising NH2-functionalized graphene and polyacrylonitrile and NC—C(CH3)(CH2-C(CH3)2-O—CH3)-C(CH3)(CH2-C(CH3)2-O—CH3)-CN.

Item FFF298. A composite comprising OH-functionalized graphene and polyacrylonitrile and NC—C(CH3)(CH2-C(CH3)2-O—CH3)-C(CH3)(CH2-C(CH3)2-O—CH3)-CN.

Item FFF299. A composite comprising thiol-functionalized graphene and polyacrylonitrile and NC—C(CH3)(CH2-C(CH3)2-O—CH3)-C(CH3)(CH2-C(CH3)2-O—CH3)-CN.

Item FFF300. A composite comprising a glass fibre and polyacrylonitrile and NC—C(CH3)(CH2-C(CH3)2-O—CH3)-C(CH3)(CH2-C(CH3)2-O—CH3)-CN.

In preferred embodiments, the composite material comprises one or more of the following combinations;
a carbon nanotube and a covalently closed ring; a carbon nanotube and a covalently closed ring comprising a pyrene; a carbon nanotube and a covalently closed ring comprising a π-extended tetrathiafulvalene; a carbon nanotube and a covalently closed ring comprising an aromatic system; a carbon nanotube and a covalently closed ring comprising a C1-C10 alkane; a carbon nanotube and a covalently closed ring consisting of carbon; a carbon nanotube and a covalently closed ring consisting of carbon and oxygen; a carbon nanotube and a covalently closed ring consisting of carbon and nitrogen; a carbon nanotube and a covalently closed ring consisting of carbon and oxygen and nitrogen; a carbon nanotube and a covalently closed ring consisting of 3 to 20 atoms; a carbon nanotube and a covalently closed ring consisting of 21 to 50 atoms; a carbon nanotube and a covalently closed ring consisting of 51 to 100 atoms; a carbon nanotube and a covalently closed ring consisting of 101 to 200 atoms; a multi wall nanotube and a covalently closed ring; a multi wall nanotube and a covalently closed ring comprising a pyrene; a multi wall nanotube and a covalently closed ring comprising a π-extended tetrathiafulvalene; a multi wall nanotube and a covalently closed ring comprising an aromatic system; a multi wall nanotube and a covalently closed ring comprising a C1-C10 alkane; a multi wall nanotube and a covalently closed ring consisting of carbon; a multi wall nanotube and a covalently closed ring consisting of carbon and oxygen; a multi wall nanotube and a covalently closed ring consisting of carbon and nitrogen; a multi wall nanotube and a covalently closed ring consisting of carbon and oxygen and nitrogen; a multi wall nanotube and a covalently closed ring consisting of 3 to 20 atoms; a multi wall nanotube and a covalently closed ring consisting of 21 to 50 atoms; a multi wall nanotube and a covalently closed ring consisting of 51 to 100 atoms; a multi wall nanotube and a covalently closed ring consisting of 101 to 200 atoms; single wall nanotube and a covalently closed ring; single wall nanotube and a covalently closed ring comprising a pyrene; single wall nanotube and a covalently closed ring comprising a π-extended tetrathiafulvalene; single wall nanotube and a covalently closed ring comprising an aromatic system; single wall nanotube and a covalently closed ring comprising a C1-C10 alkane; single wall nanotube and a covalently closed ring consisting of carbon; single wall nanotube and a covalently closed ring consisting of carbon and oxygen; single wall nanotube and a covalently closed ring consisting of carbon and nitrogen; single wall nanotube and a covalently closed ring consisting of carbon and oxygen and nitrogen; single wall nanotube and a covalently closed ring consisting of 3 to 20 atoms; single wall nanotube and a covalently closed ring consisting of 21 to 50 atoms; single wall nanotube and a covalently closed ring consisting of 51 to 100 atoms; single wall nanotube and a covalently closed ring consisting of 101 to 200 atoms.

In preferred embodiments, the composite material comprises one or more of the following;
a covalently closed ring formed around a carbon nanotube; a covalently closed ring comprising a pyrene formed around a carbon nanotube; a covalently closed ring comprising a π-extended tetrathiafulvalene formed around a carbon nanotube; a covalently closed ring comprising an aromatic system formed around a carbon nanotube; a covalently closed ring comprising a C1-C10 alkane formed around a carbon nanotube; a covalently closed ring consisting of carbon formed around a carbon nanotube; a covalently closed ring consisting of carbon and oxygen formed around a carbon nanotube; a covalently closed ring consisting of carbon and nitrogen formed around a carbon nanotube; a covalently closed ring consisting of carbon and oxygen and nitrogen formed around a carbon nanotube; a covalently closed ring consisting of 3 to 20 atoms formed around a carbon nanotube; a covalently closed ring consisting of 21 to 50 atoms formed around a carbon nanotube; a covalently closed ring consisting of 51 to 100 atoms formed around a carbon nanotube; a covalently closed ring consisting of 101 to 200 atoms formed around a carbon nanotube; a covalently closed ring formed around a multi wall nanotube; a covalently closed ring comprising a pyrene formed around a multi wall nanotube; a covalently closed ring comprising a π-extended tetrathiafulvalene formed around a multi wall nanotube; a covalently closed ring comprising an aromatic system formed around a multi wall nanotube; a covalently closed ring comprising a C1-C10 alkane formed around a multi wall nanotube; a covalently closed ring consisting of carbon formed around a multi wall nanotube; a covalently closed ring consisting of carbon and oxygen formed around a multi wall nanotube; a covalently closed ring consisting of carbon and nitrogen formed around a multi wall nanotube; a covalently closed ring consisting of carbon and oxygen and nitrogen formed around a multi wall nanotube; a covalently closed ring consisting of 3 to 20 atoms formed around a multi wall nanotube; a covalently closed ring consisting of 21 to 50 atoms formed around a multi wall nanotube; a covalently closed ring consisting of 51 to 100 atoms formed around a multi wall nanotube; a covalently closed ring consisting of 101 to 200 atoms formed around a multi wall nanotube; a covalently closed ring formed around single wall nanotube; a covalently closed ring comprising a pyrene formed around single wall nanotube; a covalently closed ring comprising a π-extended tetrathiafulvalene formed around single wall nanotube; a covalently closed ring comprising an aromatic system formed around single wall nanotube; a covalently closed ring comprising a C1-C10 alkane formed around single wall nanotube; a covalently closed ring consisting of carbon formed around single wall nanotube; a covalently closed ring consisting of carbon and oxygen formed around single wall nanotube; a covalently closed ring consisting of carbon and nitrogen formed around single wall nanotube; a covalently closed ring consisting of carbon and oxygen and nitrogen formed around single wall nanotube; a covalently closed ring consisting of 3 to 20 atoms formed around single wall nanotube; a covalently closed ring consisting of 21 to 50 atoms formed around single wall nanotube; a covalently closed ring consisting of 51 to 100 atoms formed around single wall nanotube; a covalently closed ring consisting of 101 to 200 atoms formed around single wall nanotube.

In preferred embodiments, the composite material comprises one or more of the following combinations; epoxy and a covalently closed ring; epoxy and a covalently closed ring comprising a pyrene; epoxy and a covalently closed ring comprising a π-extended tetrathiafulvalene; epoxy and a covalently closed ring comprising an aromatic system; epoxy and a covalently closed ring comprising a C1-C10 alkane; epoxy and a covalently closed ring consisting of carbon; epoxy and a covalently closed ring consisting of carbon and oxygen; epoxy and a covalently closed ring consisting of carbon and nitrogen; epoxy and a covalently closed ring consisting of carbon and oxygen and nitrogen; epoxy and a covalently closed ring consisting of 3 to 20 atoms; epoxy and a covalently closed ring consisting of 21 to 50 atoms; epoxy and a covalently closed ring consisting of 51 to 100 atoms; epoxy and a covalently closed ring consisting of 101 to 200 atoms; polycarbonate and a covalently closed ring; polycarbonate and a covalently closed ring comprising a pyrene; polycarbonate and a covalently closed ring comprising a π-extended tetrathiafulvalene; polycarbonate and a covalently closed ring comprising an aromatic system; polycarbonate and a covalently closed ring comprising a C1-C10 alkane; polycarbonate and a covalently closed ring consisting of carbon; polycarbonate and a covalently closed ring consisting of carbon and oxygen; polycarbonate and a covalently closed ring consisting of carbon and nitrogen; polycarbonate and a covalently closed ring consisting of carbon and oxygen and nitrogen; polycarbonate and a covalently closed ring consisting of 3 to 20 atoms; polycarbonate and a covalently closed ring consisting of 21 to 50 atoms; polycarbonate and a covalently closed ring consisting of 51 to 100 atoms; polycarbonate and a covalently closed ring consisting of 101 to 200 atoms; polyethylene and a covalently closed ring; polyethylene and a covalently closed ring comprising a pyrene; polyethylene and a covalently closed ring comprising a π-extended tetrathiafulvalene; polyethylene and a covalently closed ring comprising an aromatic system; polyethylene and a covalently closed ring comprising a C1-C10 alkane; polyethylene and a covalently closed ring consisting of carbon; polyethylene and a covalently closed ring consisting of carbon and oxygen; polyethylene and a covalently closed ring consisting of carbon and nitrogen; polyethylene and a covalently closed ring consisting of carbon and oxygen and nitrogen; polyethylene and a covalently closed ring consisting of 3 to 20 atoms; polyethylene and a covalently closed ring consisting of 21 to 50 atoms; polyethylene and a covalently closed ring consisting of 51 to 100 atoms; polyethylene and a covalently closed ring consisting of 101 to 200 atoms.

In preferred embodiments, the composite material comprises one or more of the following;
epoxy linked to a covalently closed ring; epoxy linked to a covalently closed ring comprising a pyrene; epoxy linked to a covalently closed ring comprising a π-extended tetrathiafulvalene; epoxy linked to a covalently closed ring comprising an aromatic system; epoxy linked to a covalently closed ring comprising a C1-C10 alkane; epoxy linked to a covalently closed ring consisting of carbon; epoxy linked to a covalently closed ring consisting of carbon and oxygen; epoxy linked to a covalently closed ring consisting of carbon and nitrogen; epoxy linked to a covalently closed ring consisting of carbon and oxygen and nitrogen; epoxy linked to a covalently closed ring consisting of 3 to 20 atoms; epoxy linked to a covalently closed ring consisting of 21 to 50 atoms; epoxy linked to a covalently closed ring consisting of 51 to 100 atoms; epoxy linked to a covalently closed ring consisting of 101 to 200 atoms; polycarbonate linked to a covalently closed ring; polycarbonate linked to a covalently closed ring comprising a pyrene; polycarbonate linked to a covalently closed ring comprising a π-extended tetrathiafulvalene; polycarbonate linked to a covalently closed ring comprising an aromatic system; polycarbonate linked to a covalently closed ring comprising a C1-C10 alkane; polycarbonate linked to a covalently closed ring consisting of carbon; polycarbonate linked to a covalently closed ring consisting of carbon and oxygen; polycarbonate linked to a covalently closed ring consisting of carbon and nitrogen; polycarbonate linked to a covalently closed ring consisting of carbon and oxygen and nitrogen; polycarbonate linked to a covalently closed ring consisting of 3 to 20 atoms; polycarbonate linked to a covalently closed ring consisting of 21 to 50 atoms; polycarbonate linked to a covalently closed ring consisting of 51 to 100 atoms; polycarbonate linked to a covalently closed ring consisting of 101 to 200 atoms; polyethylene linked to a covalently closed ring; polyethylene linked to a covalently closed ring comprising a pyrene; polyethylene linked to a covalently closed ring comprising a π-extended tetrathiafulvalene; polyethylene linked to a covalently closed ring comprising an aromatic system; polyethylene linked to a covalently closed ring comprising a C1-C10 alkane; polyethylene linked to a covalently closed ring consisting of carbon; polyethylene linked to a covalently closed ring consisting of carbon and oxygen; polyethylene linked to a covalently closed ring consisting of carbon and nitrogen; polyethylene linked to a covalently closed ring consisting of carbon and oxygen and nitrogen; polyethylene linked to a covalently closed ring consisting of 3 to 20 atoms; polyethylene linked to a covalently closed ring consisting of 21 to 50 atoms; polyethylene linked to a covalently closed ring consisting of 51 to 100 atoms; polyethylene linked to a covalently closed ring consisting of 101 to 200 atoms.

In preferred embodiments, the composite material comprises one or more of the following combinations;
a carbon nanotube and epoxy and a covalently closed ring; a carbon nanotube and epoxy and a covalently closed ring comprising a pyrene; a carbon nanotube and epoxy and a covalently closed ring comprising a π-extended tetrathiafulvalene; a carbon nanotube and epoxy and a covalently closed ring comprising an aromatic system; a carbon nanotube and epoxy and a covalently closed ring comprising a C1-C10 alkane; a carbon nanotube and epoxy and a covalently closed ring consisting of carbon; a carbon nanotube and epoxy and a covalently closed ring consisting of carbon and oxygen; a carbon nanotube and epoxy and a covalently closed ring consisting of carbon and nitrogen; a carbon nanotube and epoxy and a covalently closed ring consisting of carbon and oxygen and nitrogen; a carbon nanotube and epoxy and a covalently closed ring consisting of 3 to 20 atoms; a carbon nanotube and epoxy and a covalently closed ring consisting of 21 to 50 atoms; a carbon nanotube and epoxy and a covalently closed ring consisting of 51 to 100 atoms; a carbon nanotube and epoxy and a covalently closed ring consisting of 101 to 200 atoms; a multi wall nanotube and polycarbonate and a covalently closed ring; a multi wall nanotube and polycarbonate and a covalently closed ring comprising a pyrene; a multi wall nanotube and polycarbonate and a covalently closed ring comprising a π-extended tetrathiafulvalene; a multi wall nanotube and polycarbonate and a covalently closed ring comprising an aromatic system; a multi wall nanotube and polycarbonate and a covalently closed ring comprising a C1-C10 alkane; a multi wall nanotube and polycarbonate and a covalently closed ring consisting of carbon; a multi wall nanotube and polycarbonate and a covalently closed ring consisting of carbon and oxygen; a multi wall nanotube and polycarbonate and a covalently closed ring consisting of carbon and nitrogen; a multi wall nanotube and polycarbonate and a covalently closed ring consisting of carbon and oxygen and nitrogen; a multi wall nanotube and polycarbonate and a covalently closed ring consisting of 3 to 20 atoms; a multi wall nanotube and polycarbonate and a covalently closed ring consisting of 21 to 50 atoms; a multi wall nanotube and polycarbonate and a covalently closed ring consisting of 51 to 100 atoms; a multi wall nanotube and polycarbonate and a covalently closed ring consisting of 101 to 200 atoms; single wall nanotube and polyethylene and a covalently closed ring; single wall nanotube and polyethylene and a covalently closed ring comprising a pyrene; single wall nanotube and polyethylene and a covalently closed ring comprising a π-extended tetrathiafulvalene; single wall nanotube and polyethylene and a covalently closed ring comprising an aromatic system; single wall nanotube and polyethylene and a covalently closed ring comprising a C1-C10 alkane; single wall nanotube and polyethylene and a covalently closed ring consisting of carbon; single wall nanotube and polyethylene and a covalently closed ring consisting of carbon and oxygen; single wall nanotube and polyethylene and a covalently closed ring consisting of carbon and nitrogen; single wall nanotube and polyethylene and a covalently closed ring consisting of carbon and oxygen and nitrogen; single wall nanotube and polyethylene and a covalently closed ring consisting of 3 to 20 atoms; single wall nanotube and polyethylene and a covalently closed ring consisting of 21 to 50 atoms; single wall nanotube and polyethylene and a covalently closed ring consisting of 51 to 100 atoms; single wall nanotube and polyethylene and a covalently closed ring consisting of 101 to 200 atoms.

In preferred embodiments, the composite material comprises one or more of the following combinations;
a carbon nanotube and epoxy linked to a covalently closed ring; a carbon nanotube and epoxy linked to a covalently closed ring comprising a pyrene; a carbon nanotube and epoxy linked to a covalently closed ring comprising a π-extended tetrathiafulvalene; a carbon nanotube and epoxy linked to a covalently closed ring comprising an aromatic system; a carbon nanotube and epoxy linked to a covalently closed ring comprising a C1-C10 alkane; a carbon nanotube and epoxy linked to a covalently closed ring consisting of carbon; a carbon nanotube and epoxy linked to a covalently closed ring consisting of carbon and oxygen; a carbon nanotube and epoxy linked to a covalently closed ring consisting of carbon and nitrogen; a carbon nanotube and epoxy linked to a covalently closed ring consisting of carbon and oxygen and nitrogen; a carbon nanotube and epoxy linked to a covalently closed ring consisting of 3 to 20 atoms; a carbon nanotube and epoxy linked to a covalently closed ring consisting of 21 to 50 atoms; a carbon nanotube and epoxy linked to a covalently closed ring consisting of 51 to 100 atoms; a carbon nanotube and epoxy linked to a covalently closed ring consisting of 101 to 200 atoms; a multi wall nanotube and polycarbonate linked to a covalently closed ring; a multi wall nanotube and polycarbonate linked to a covalently closed ring comprising a pyrene; a multi wall nanotube and polycarbonate linked to a covalently closed ring comprising a π-extended tetrathiafulvalene; a multi wall nanotube and polycarbonate linked to a covalently closed ring comprising an aromatic system; a multi wall nanotube and polycarbonate linked to a covalently closed ring comprising a C1-C10 alkane; a multi wall nanotube and polycarbonate linked to a covalently closed ring consisting of carbon; a multi wall nanotube and polycarbonate linked to a covalently closed ring consisting of carbon and oxygen; a multi wall nanotube and polycarbonate linked to a covalently closed ring consisting of carbon and nitrogen; a multi wall nanotube and polycarbonate linked to a covalently closed ring consisting of carbon and oxygen and nitrogen; a multi wall nanotube and polycarbonate linked to a covalently closed ring consisting of 3 to 20 atoms; a multi wall nanotube and polycarbonate linked to a covalently closed ring consisting of 21 to 50 atoms; a multi wall nanotube and polycarbonate linked to a covalently closed ring consisting of 51 to 100 atoms; a multi wall nanotube and polycarbonate linked to a covalently closed ring consisting of 101 to 200 atoms; single wall nanotube and polyethylene linked to a covalently closed ring; single wall nanotube and polyethylene linked to a covalently closed ring comprising a pyrene; single wall nanotube and polyethylene linked to a covalently closed ring comprising a π-extended tetrathiafulvalene; single wall nanotube and polyethylene linked to a covalently closed ring comprising an aromatic system; single wall nanotube and polyethylene linked to a covalently closed ring comprising a C1-C10 alkane; single wall nanotube and polyethylene linked to a covalently closed ring consisting of carbon; single wall nanotube and polyethylene linked to a covalently closed ring consisting of carbon and oxygen; single wall nanotube and polyethylene linked to a covalently closed ring consisting of carbon and nitrogen; single wall nanotube and polyethylene linked to a covalently closed ring consisting of carbon and oxygen and nitrogen; single wall nanotube and polyethylene linked to a covalently closed ring consisting of 3 to 20 atoms; single wall nanotube and polyethylene linked to a covalently closed ring consisting of 21 to 50 atoms; single wall nanotube and polyethylene linked to a covalently closed ring consisting of 51 to 100 atoms; single wall nanotube and polyethylene linked to a covalently closed ring consisting of 101 to 200 atoms.

In preferred embodiments, the composite material comprises one or more of the following combinations; epoxy and a covalently closed ring formed around a carbon nanotube; epoxy and a covalently closed ring comprising a pyrene formed around a carbon nanotube; epoxy and a covalently closed ring comprising a π-extended tetrathiafulvalene formed around a carbon nanotube; epoxy and a covalently closed ring comprising an aromatic system formed around a carbon nanotube; epoxy and a covalently closed ring comprising a C1-C10 alkane formed around a carbon nanotube; epoxy and a covalently closed ring consisting of carbon formed around a carbon nanotube; epoxy and a covalently closed ring consisting of carbon and oxygen formed around a carbon nanotube; epoxy and a covalently closed ring consisting of carbon and nitrogen formed around a carbon nanotube; epoxy and a covalently closed ring consisting of carbon and oxygen and nitrogen formed around a carbon nanotube; epoxy and a covalently closed ring consisting of 3 to 20 atoms formed around a carbon nanotube; epoxy and a covalently closed ring consisting of 21 to 50 atoms formed around a carbon nanotube; epoxy and a covalently closed ring consisting of 51 to 100 atoms formed around a carbon nanotube; epoxy and a covalently closed ring consisting of 101 to 200 atoms formed around a carbon nanotube; polycarbonate and a covalently closed ring formed around a multi wall nanotube; polycarbonate and a covalently closed ring comprising a pyrene formed around a multi wall nanotube; polycarbonate and a covalently closed ring comprising a π-extended tetrathiafulvalene formed around a multi wall nanotube; polycarbonate and a covalently closed ring comprising an aromatic system formed around a multi wall nanotube; polycarbonate and a covalently closed ring comprising a C1-C10 alkane formed around a multi wall nanotube; polycarbonate and a covalently closed ring consisting of carbon formed around a multi wall nanotube; polycarbonate and a covalently closed ring consisting of carbon and oxygen formed around a multi wall nanotube; polycarbonate and a covalently closed ring consisting of carbon and nitrogen formed around a multi wall nanotube; polycarbonate and a covalently closed ring consisting of carbon and oxygen and nitrogen formed around a multi wall nanotube; polycarbonate and a covalently closed ring consisting of 3 to 20 atoms formed around a multi wall nanotube; polycarbonate and a covalently closed ring consisting of 21 to 50 atoms formed around a multi wall nanotube; polycarbonate and a covalently closed ring consisting of 51 to 100 atoms formed around a multi wall nanotube; polycarbonate and a covalently closed ring consisting of 101 to 200 atoms formed around a multi wall nanotube; polyethylene and a covalently closed ring formed around single wall nanotube; polyethylene and a covalently closed ring comprising a pyrene formed around single wall nanotube; polyethylene and a covalently closed ring comprising a π-extended tetrathiafulvalene formed around single wall nanotube; polyethylene and a covalently closed ring comprising an aromatic system formed around single wall nanotube; polyethylene and a covalently closed ring comprising a C1-C10 alkane formed around single wall nanotube; polyethylene and a covalently closed ring consisting of carbon formed around single wall nanotube; polyethylene and a covalently closed ring consisting of carbon and oxygen formed around single wall nanotube; polyethylene and a covalently closed ring consisting of carbon and nitrogen formed around single wall nanotube; polyethylene and a covalently closed ring consisting of carbon and oxygen and nitrogen formed around single wall nanotube; polyethylene and a covalently closed ring consisting of 3 to 20 atoms formed around single wall nanotube; polyethylene and a covalently closed ring consisting of 21 to 50 atoms formed around single wall nanotube; polyethylene and a covalently closed ring consisting of 51 to 100 atoms formed around single wall nanotube; polyethylene and a covalently closed ring consisting of 101 to 200 atoms formed around single wall nanotube.

In preferred embodiments, the composite material comprises one or more of the following combinations; epoxy linked to a covalently closed ring formed around a carbon nanotube; epoxy linked to a covalently closed ring comprising a pyrene formed around a carbon nanotube; epoxy linked to a covalently closed ring comprising a π-extended tetrathiafulvalene formed around a carbon nanotube; epoxy linked to a covalently closed ring comprising an aromatic system formed around a carbon nanotube; epoxy linked to a covalently closed ring comprising a C1-C10 alkane formed around a carbon nanotube; epoxy linked to a covalently closed ring consisting of carbon formed around a carbon nanotube; epoxy linked to a covalently closed ring consisting of carbon and oxygen formed around a carbon nanotube; epoxy linked to a covalently closed ring consisting of carbon and nitrogen formed around a carbon nanotube; epoxy linked to a covalently closed ring consisting of carbon and oxygen and nitrogen formed around a carbon nanotube; epoxy linked to a covalently closed ring consisting of 3 to 20 atoms formed around a carbon nanotube; epoxy linked to a covalently closed ring consisting of 21 to 50 atoms formed around a carbon nanotube; epoxy linked to a covalently closed ring consisting of 51 to 100 atoms formed around a carbon nanotube; epoxy linked to a covalently closed ring consisting of 101 to 200 atoms formed around a carbon nanotube; polycarbonate linked to a covalently closed ring formed around a multi wall nanotube; polycarbonate linked to a covalently closed ring comprising a pyrene formed around a multi wall nanotube; polycarbonate linked to a covalently closed ring comprising a π-extended tetrathiafulvalene formed around a multi wall nanotube; polycarbonate linked to a covalently closed ring comprising an aromatic system formed around a multi wall nanotube; polycarbonate linked to a covalently closed ring comprising a C1-C10 alkane formed around a multi wall nanotube; polycarbonate linked to a covalently closed ring consisting of carbon formed around a multi wall nanotube; polycarbonate linked to a covalently closed ring consisting of carbon and oxygen formed around a multi wall nanotube; polycarbonate linked to a covalently closed ring consisting of carbon and nitrogen formed around a multi wall nanotube; polycarbonate linked to a covalently closed ring consisting of carbon and oxygen and nitrogen formed around a multi wall nanotube; polycarbonate linked to a covalently closed ring consisting of 3 to 20 atoms formed around a multi wall nanotube; polycarbonate linked to a covalently closed ring consisting of 21 to 50 atoms formed around a multi wall nanotube; polycarbonate linked to a covalently closed ring consisting of 51 to 100 atoms formed around a multi wall nanotube; polycarbonate linked to a covalently closed ring consisting of 101 to 200 atoms formed around a multi wall nanotube; polyethylene linked to a covalently closed ring formed around single wall nanotube; polyethylene linked to a covalently closed ring comprising a pyrene formed around single wall nanotube; polyethylene linked to a covalently closed ring comprising a π-extended tetrathiafulvalene formed around single wall nanotube; polyethylene linked to a covalently closed ring comprising an aromatic system formed around single wall nanotube; polyethylene linked to a covalently closed ring comprising a C1-C10 alkane formed around single wall nanotube; polyethylene linked to a covalently closed ring consisting of carbon formed around single wall nanotube; polyethylene linked to a covalently closed ring consisting of carbon and oxygen formed around single wall nanotube; polyethylene linked to a covalently closed ring consisting of carbon and nitrogen formed around single wall nanotube; polyethylene linked to a covalently closed ring consisting of carbon and oxygen and nitrogen formed around single wall nanotube; polyethylene linked to a covalently closed ring consisting of 3 to 20 atoms formed around single wall nanotube; polyethylene linked to a covalently closed ring consisting of 21 to 50 atoms formed around single wall nanotube; polyethylene linked to a covalently closed ring consisting of 51 to 100 atoms formed around single wall nanotube; polyethylene linked to a covalently closed ring consisting of 101 to 200 atoms formed around single wall nanotube.

### Definitions

Additive shall be defined as a first substance added to a second substance to improve, strengthen, or in other ways alter the characteristics of said second substance. Used interchangeably with filler.

Aspect ratio shall mean the largest dimension (eg. length) of a molecule or a piece of material, divided by the smallest dimension (eg. width) of said molecule or piece of material.

Carbon nanotube is used interchangeably with CNT, and shall be defined as a fullerene having a cylindrical or toroidal configuration.

Chemical entity shall mean a structure comprising one atom, or two or more atoms held together by covalent bonds

Closed ring shall mean a continuous string of atoms held together by covalent bonds, forming a closed circle, not at any point interrupted by a non-covalent bond. Only those atoms forming the actual ring need to be covalently linked; atoms and molecular entities attached to the atoms making up the continuous string of atoms of the circle, but not being part of the continuous string itself, do not need to be covalently linked to each other or to the atoms of the ring.

Five subtypes of a Closed ring, i.e. ML-1, ML-2, ML-3, ML-4, and ML-5 are defined hereunder.

Whenever the term “Closed ring” is used, it may mean any of the four subtypes alone, or any two or three of the four subtypes together, or all of the subtypes together.

In one aspect, “closed ring, subtype ML-1” shall mean a continuous string of atoms held together by covalent bonds, forming a closed circle, not at any point interrupted by a non-covalent bond. Only those atoms forming the actual ring need to be covalently linked; atoms and molecular entities attached to the atoms making up the continuous string of atoms of the circle, but not being part of the continuous string itself, do not need to be covalently linked to each other or to the atoms of the ring. The ring encircles a space large enough for a molecule with one dimension of at least 2 Å to pass through or reside.

In one aspect, “closed ring, subtype ML-1” describes a compound of formula ML-1 comprising a ring forming an unbroken circular chain of n atoms (X) around a hole where a molecule with a smallest diameter of more than 2 Ångstrom can reside in or pass through, and wherein said ring corresponds to an unbroken circular chain of atoms which has the lowest total molecular weight of any such possible unbroken circular chain of atoms in the compound, and wherein n=8 to 10000.

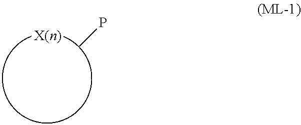

In the following molecules an unbroken circular chain of atoms (in bold) can be traced but these atoms do not form an unbroken circular chain of n atoms (X) around a hole where a molecule with a smallest diameter of more than 2 Ångstrom can reside in or pass through, and thus it is not a compound of formula ML-1.

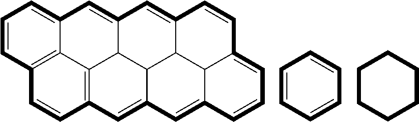

In the following molecules an unbroken circular chain of atoms (in bold) can be traced and these atoms form an unbroken circular chain of n atoms (X) around a hole where a molecule with a smallest diameter of more than 2 Ångstrom can reside in or pass through, and thus are compounds of formula ML-1.

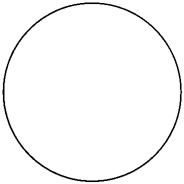

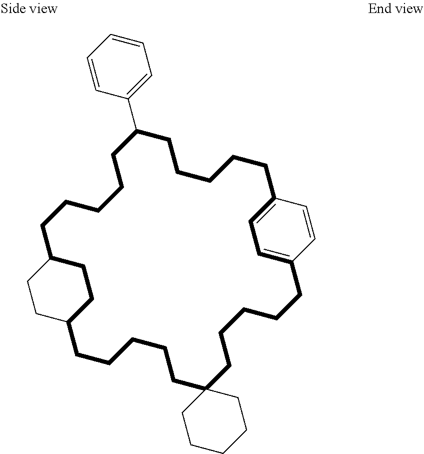

In another aspect, “Closed ring, subtype ML-2” describes a compound of formula ML-2 comprising a ring forming an unbroken circular chain of n atoms (X) around a nanotube, wherein there is no covalent bonds between said compound and said nanotube, and wherein said ring corresponds to an unbroken circular chain of atoms which has the lowest total molecular weight of any such possible unbroken circular chain of atoms around a nanotube in the compound, and wherein n=8 to 10000.

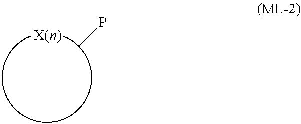

In yet another aspect, “closed ring, subtype ML-3” describes a compound of formula ML-3 comprising a ring forming an unbroken circular chain of n atoms (X), and wherein no two atoms A and B of the ring are connected by a number m of covalent bonds where one or more of said covalent bonds are not part of the closed ring and where the number m of covalent bonds is smaller than the minimum number o of covalent bonds between A and B in the ring, and wherein n is any number between 8 and 10000.

The following figure shows a chemical structure comprising a ring structure (in yellow) that is not a Closed ring of formula ML-3.

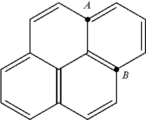

The yellow ring in the figure above is not a closed ring of formula ML-3, because the smallest number m of covalent bonds connecting A and B (green) is 2, and thus is smaller than the number o of covalent bonds between A and B in the ring which is 4.

In another aspect, “closed ring, subtype ML-4” shall mean a closed circular string of atoms connected solely by covalent bonds, wherein said circle can encircle a nanotube with a diameter of x nm and wherein each atom in the string forms covalent bonds to two other atoms in the string but not to any other atoms in the string. X can have any value between 0.2 and 400 nm.

In another aspect, “closed ring, subtype ML-5” shall mean a closed circular string of atoms connected solely by covalent bonds, through which a spherical object of y nm in diameter can pass, and wherein each atom in the string forms covalent bonds to two other atoms in the string but not to any other atoms in the string. y can have any value between 0.2 and 400 nm.

The number of atoms (n) of any Closed ring, including Closed ring, subtype ML-1; Closed ring, subtype ML-2; Closed ring, subtype ML-3; and Closed ring, subtype ML-4, is preferably more than 10, such as more than 20, such as more than 30, such as more than 40, such as more than 50, such as more than 60, such as more than 70, such as more than 80, such as more than 90, such as more than 100, such as more than 200, such as more than 300, such as more than 400, such as more than 500, such as more than 600, such as more than 700, such as more than 800, such as more than 900, such as more than 1000, such as more than 1500, such as more than 2000, such as more than 2500, such as more than 3000, such as more than 3500, such as more than 4000, such as more than 4500, such as more than 5000, such as more than 6000, such as more than 7000, such as more than 8000, such as more than 9000, or less than 10000, such as less than 9000, such as less than 8000, such as less than 7000, such as less than 6000, such as less than 5000, such as less than 4500, such as less than 4000, such as less than 3500, such as less than 3000, such as less than 2500, such as less than 2000, such as less than 1500, such as less than 1000, such as less than 900, such as less than 800, such as less than 700, such as less than 600, such as less than 500, such as less than 400, such as less than 300, such as less than 200, such as less than 100, such as less than 90, such as less than 80, such as less than 70, such as less than 60, such as less than 50, such as less than 40, such as less than 30, such as less than 20, or 10 to 20, 20 to 30, 30 to 40, 40 to 50, 50 to 60, 60 to 70, 70 to 80, 80 to 90, 90 to 100, 100 to 200, 200 to 300, 300 to 400, 400 to 500, 500 to 600, 600 to 700, 700 to 800, 800 to 900, 900 to 1000, 1000 to 1500, 1500 to 2000, 2000 to 2500, 2500 to 3000, 3000 to 3500, 3500 to 4000, 4000 to 4500, 4500 to 5000, 5000 to 6000, 6000 to 7000, 7000 to 8000, 8000 to 9000, or 9000 to 10000.

Composite material is used interchangeably with composite. A combination of two or more materials such as a polymer combined with an additive; a metal with an additive, or a ceramic with an additive. Typically, the material in excess is called the matrix, whereas the material present in small amount is called the additive or filler. Example composites are polystyrene combined with a small amount of carbon fibers, and metal combined with a small amount of carbon nanotube.

Composite material unit is used interchangeably with CMU. A CMU comprises two structural entities held together by a linker, a mechanical ligand and a Ligand2. A CMU can be a constituent of a composite material.

Covalently closed ring shall be used interchangeably with closed ring.

Covalent mechanical bond shall be used interchangeably with mechanical bond.

Covalent ring closure shall mean the final step of the process of forming a covalently closed ring.

Element shall exclusively refer to an element of the periodic table of the elements.

Filler is used interchangeably with Additive.

Inorganic structural entities or materials shall mean any material or entity except those comprising carbon and at least one other element. Inorganic SEs thus include CNT, graphene, other fullerenes, and carbon fibers.

Ligand2 shall mean an entity capable of forming a covalent bond, a non-covalent bond, or a mechanical bond to a material, where said entity is a molecule composed of atoms.

Linker Unit is used interchangeably with LU. A linker unit comprises one or more MLs, capable of forming a mechanical bond to a structural entity, one or more Ligand2s, capable of binding covalently or non-covalently to a structural entity, and one or more linkers that link the MLs and Ligand2s together.

Material shall mean anything made of matter. The material may be in a solid state (such as ice) or for all practical purposes solid (e.g. such as glass).

Matrix material shall be defined as the most abundant component of a composite material.

Mechanical Bond shall mean a bond between a Mechanical Ligand (ML) and a structural entity (SE) where at least one intramolecular covalent bond in the SE or in the ML must be broken in order to bring the structural entity and the mechanical ligand apart.

However, for a complex of an SE and an ML where the SE and/or ML has an aspect ratio of more than 100 (one hundred), a Mechanical Bond shall mean a bond between said ML and said SE where at least one intramolecular covalent bond in the SE or in the ML must be broken in order to bring the SE and the ML apart in a direction other than the direction of the largest dimension of said SE and/or said ML that has an aspect ratio of more than 100. For the avoidance of doubt, an intramolecular covalent bond shall mean a covalent bond between atoms within a given molecule (i.e. within the SE or within the ML).

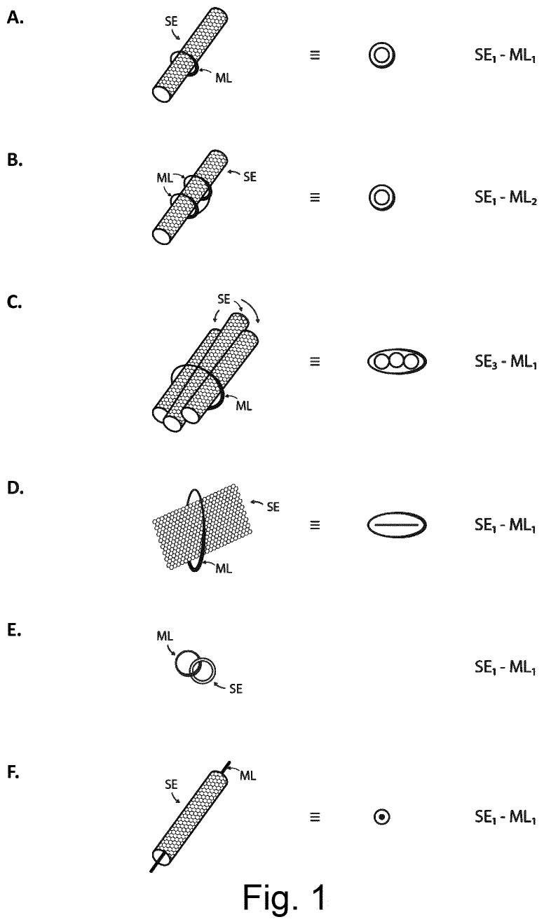

The following are examples of such mechanical bonds between MLs and SEs that keep the SE and the ML interlocked as a consequence of their topology (see also FIG. 1):
i) The ML is a closed ring such as a peptide, wrapped around a nanotube that has an aspect ratio larger than 100. The ends of the peptide have been covalently linked so that the peptide forms a continuous string of covalently linked atoms around the nanotube. The nanotube is a cylindrical structure with an aspect ratio of more than 100, which means that its length (along the cylindrical axis) is more than 100 times larger than its diameter (the diameter of the cylindrical structure). Theoretically, the ML (the closed ring peptide) and the SE (the nanotube) could be brought apart by moving the ML up or down the length of the nanotube (i.e. in the direction of the largest dimension of the nanotube), without breaking an intramolecular covalent bond of the closed ring peptide (the ML) or of the nanotube (the SE). However, it is impossible to bring the closed ring peptide and the nanotube apart in a direction other than the direction of the largest dimension of the nanotube (which has an aspect ratio of more than 100) without breaking an intramolecular covalent bond in the closed ring peptide or the nanotube, and therefore the closed ring peptide and the nanotube per definition forms a mechanical bond between them.
ii) Another example of a mechanical bond is a chemical entity (SE), engulfed by a hollow ball (ML). If the ML and SE cannot be brought apart without breaking an intramolecular covalent bond in either the ML or the SE, then the SE and ML forms a mechanical bond between them.
iii) Another example of a mechanical bond is a linear entity, e.g. a polymer, inserted through a short nanotube and modified at both ends such that the polymer and the nanotube cannot be brought apart without breaking at least one intramolecular covalent bond in either the SE or the ML.
iv) An example similar to the example above is a linear entity, e.g. a polymer (ML) with an aspect ratio of more than 100, inserted through a nanotube (SE) with an aspect ratio of more than 100. In theory, the polymer and the nanotube could be brought apart by sliding one down the length of the other (i.e. bringing the polymer and the nanotube apart in the direction of the largest dimension of the nanotube, i.e. along the axis of the cylindric structure of the nanotube) (or by bringing the polymer and nanotube apart in the direction of the largest dimension of the polymer) (in this special case these two directions are the same). However, it is impossible to bring the polymer and the nanotube apart in a direction other than the direction of the largest dimension of the nanotube without breaking an intramolecular covalent bond in the polymer or breaking an intramolecular covalent bond in the nanotube, and it is impossible to bring the polymer and the nanotube apart in a direction other than the direction of the largest dimension of the polymer without breaking an intramolecular covalent bond in the polymer or breaking an intramolecular covalent bond in the nanotube, and therefore the polymer and the nanotube per definition form a mechanical bond between them.
v) Another example of a mechanical bond is two closed ring structures (e.g. two polymers where the terminals have been covalently closed so that both polymers form closed ring structures), where one of the closed rings have been formed around the continuous string of covalently linked atoms of the other closed ring, such as shown in e.g. (FIG. 1, E). The two closed rings cannot be brought apart without breaking an intramolecular covalent bond in one of the closed ring structures, and therefore per definition the two closed ring structures form a mechanical bond between them.

Mechanical Ligand and ML is used interchangeably and shall mean a chemical entity that is capable of forming a mechanical bond with a structural entity, or is forming a mechanical bond with a structural entity. An example mechanical ligand is a closed ring of atoms wrapped around a structural entity.

Mechanically bound shall mean held together by a mechanical bond.

Multi walled nanotube and MWNT are used interchangeably and shall be defined as a coaxial assembly of nanotubes similar to a coaxial cable, or as a molecular sheet, e.g. of graphene, rolled into the shape of a scroll. Examples include multi wall carbon nanotubes, which is used interchangeably with MWCNT.

Nanotube shall be defined as a hollow cylindrical or toroidal molecule, which is shorter than 1,000 nanometers in at least one dimension.

Nanotube aggregate shall mean a defined volume V within which there is a high concentration of nanotubes. Three subtypes of nanotube aggregate shall here be defined, “Nanotube Aggregate type 1”, “Nanotube Aggregate type 2”, “Nanotube Aggregate type 3”.

In Nanotube Aggregate type 1, between 50% and 80% of volume V is nanotubes, and in a Nanotube Aggregate type 2 between 80% and 99% of volume V is nanotubes, and in a Nanotube Aggregate type 3 between 99% and 100% of volume V is nanotubes.

Natural as used herein, refers to entities, which are found abundantly in nature, such as in biological systems. For example, a natural peptide is composed of the twenty natural amino acids; Isoleucine, Alanine, Leucine, Asparagine, Lysine, Aspartic Acid, Methionine, Cysteine, Phenylalanine, Glutamic Acid, Threonine, Glutamine, Tryptophan, Glycine, Valine, Proline, Serine, Tyrosine, Arginine, Histidine. Similarly, a natural oligonucleotide is composed of the four natural nucleotides cytidine, adenosine, guanosine, and thymidine.

Non-covalent mechanical bond shall mean a bond between a chemical entity and a structural entity (SE) that keeps the SE and said chemical entity associated as a consequence of their topology. A non-covalent mechanical bond is not a type of mechanical bond, since a non-covalent mechanical bond can be broken by breaking a non-covalent bond, as opposed to a mechanical bond which can only be broken by breaking a covalent bond.

Non-covalently closed ring shall mean a continuous string of atoms held together by chemical bonds, forming a closed circle, where at least one of said chemical bonds is a non-covalent bond.

Non-covalent ring closure shall mean the final step of the process of forming a non-covalently closed ring, where said final step involves the formation of a non-covalent bond.

Non-natural as used herein refers to entities, which are not found abundantly in nature, such as in biological systems. For example, a non-natural peptide is a peptide, which comprises an entity not found in the list of natural amino acids. Similarly, a non-natural oligonucleotide is an oligonucleotide, which comprises an entity that is not found in the list of the four natural nucleosides.

One atom layer molecule shall be defined as a molecule, which has exactly one atom thickness in one dimension, e.g. graphene.

One layer molecule shall be defined as a molecule, which cannot be separated into two layers without breaking a chemical bond.

Organic materials or structural entities shall mean materials or entities, which contain carbon and at least one other element.

Polymer shall mean a long, repeating chain, such as a branched chain, of atoms, comprising repeated identical or similar units, formed through the linkage of many monomers. Thus, a polymer is a molecule of high relative molecular mass, the structure of which essentially comprises the multiple repetition of units derived, actually or conceptually, from molecules of low relative molecular mass. The monomers can be identical, or they can have one or more substituted chemical groups. Some polymers are made of more than one kind of monomer.

Example polymers are polyvinylchloride, polystyrene, DNA, protein and polypeptide.

PolyUshape shall mean a compound comprising at least two precursor-MLs connected by a linker, where each of the at least two precursor-MLs are capable of forming a closed ring around a nanotube.

Precursor-ML shall mean a chemical entity that can be turned into a mechanical ligand (ML) by formation of a covalent bond between two different parts of said precursor-ML.

Single wall nanotube is used interchangeably with SWNT and shall mean a cylindrical nanostructure or a molecular tube with at least one dimension less than 1,000 nanometers. Examples include single wall carbon nanotubes, which is used interchangeable with SWNT.

Structural Entity (SE). A structural entity shall mean a chemical or physical entity. A structural entity may be an atom (e.g. an ion), a molecule (e.g. a nylon polymer or a CNT), or part of a surface/material (e.g. metal). Furthermore, a molecular SE may either be small (largest dimension less than 10 nm), or large (largest dimension more than 10 nm). The two latter categories of SEs shall be referred to as Small Molecular SEs and Large Molecular SEs. A structural entity can be part of a composite material unit (CMU), and said composite material unit may be part of a composite material. A structural entity may be used to anchor the CMU in place in the larger structure of a composite material, or alternatively, may be used to modify the characteristics of a composite material, e.g. by modifying the strength, flexibility, or appearance of the composite material.

Surface shall mean a material layer constituting a boundary, such as the one or few outermost atomic layer(s) of a material.

Ushape shall mean a precursor-ML capable of forming a closed ring around a nanotube.

Weight percent. This shall mean the mass of the substance in question (e.g. of the nanotubes in a composite material) divided by the mass of all of the substances (e.g. of the mass of the composite material wherein the nanotube is), and the following terms shall all denote the weight percent: wt %, w/w %, w/w, w %.

### EXAMPLES

Example 0. Different sequences of events leading to composite material. As depicted in FIG. 119a, there are several principally different sequences of events leading to the formation of a nanotube-polymer composite material, comprising polymer-coated nanotubes:

Sequence 1 (ring closing, then attach polymer): The nanotube and the precursor-ML (also termed the Ushape) is first mixed, and the Ushape is closed around the nanotube to form a ring around it. Then the polymer is added and attached to the rings. The final result is a nanotube with rings around it, where the rings are attached to polymer. This is the nanotube-polymer composite material, comprising polymer-coated nanotubes.

Sequence 2 (poly-Ushape formation, then ring-closing): The U shapes are attached to a preformed polymer, to make poly-Ushape. Then nanotubes are added to the polyUshape, and the U shapes are closed around the nanotube to form rings. This is the nanotube-polymer composite material, comprising polymer-coated nanotubes.

Sequence 3 (monomer-Ushape formation, then ring-closing and polymerization): The Ushape and the monomeric unit are first attached to each other, to form a Ushape-monomer molecule. Nanotubes are added and the U shapes bind to the nanotube. The final polymerization of the monomer units into polymer and the closing of the U shapes to form rings around the nanotubes, can be performed in different ways, i.e. (A) first the U shapes are closed around the nanotube to form rings, and then the monomer units polymerize while immobilized on the nanotube, or (B) first the monomer units polymerize while immobilized on the nanotube, and then the U shapes are closed around the nanotube to form rings, or (C) polymerization of the monomer units and ring-closing of the U shapes happens simultaneously.

Sequence 4 (ring closing, then attach reacting polymer): Similar to Sequence 1, the nanotube and the precursor-ML is first mixed, and the Ushape is closed around the nanotube to form a ring around it. The ring carries a polymerization termination functionality. The growing polymer is added and it attaches to the rings through the polymerization termination functionalities. The final result is a nanotube with rings around it, where the rings are each attached to different polymer chains. This is the nanotube-polymer composite material, comprising polymer-coated nanotubes.

### Example A1. Synthesis of ‘Poly[N-(4-Tosylatebutyl)]-cis-5-norbornene-exo-2,3-dicarboximide’ (compound A1)

The Ring-Opening-Metathesis-Polymerization (ROMP) of N-(4-Tosylatebutyl)]-cis-5-norbornene-exo-2,3-dicarboximide is described in this example. See (FIG. 15).

Step 1. In a round-bottom 10 mL 2-neck Schlenk flask, pre-dried in an oven at 120° C. for 1 hour, 400 mg (1.03 mmol) of N-(4-Tosylatebutyl)]-cis-5-norbornene-exo-2,3-dicarboximide was introduced and solubilized in dry dichloromethane (2.5 mL), under Argon.

Step 2. In a second round-bottom 5 mL flask, pre-dried in an oven at 120° C. for 1 hour, 50.6 mg (0.057 mmol) of Grubbs-III (3^{rd} generation) catalyst was solubilized in 1 mL of dry dichloromethane, under Argon.

Step 3. Then, the solution of Grubbs-III catalyst of step 2 was added quickly (in 2-3 seconds) to the solution of N-(4-Tosylatebutyl)]-cis-5-norbornene-exo-2,3-dicarboximide of step 1 under vigorous stirring and Argon atmosphere.

Step 4. The solution of step 3 was stirred for 3 hours and then 1.7 mL of ethyl vinyl ether was added in order to quench the reaction.

Step 5. The resultant polymer solution was dried under reduced pressure using a rotary evaporator with the bath at 35° C.

Step 6. The polymer was solubilized in 1 mL of dichloromethane and was added with a syringe of 1 mL quickly in 200 mL of diethyl ether, under vigorous stirring while ‘Poly[N-(4-Tosylatebutyl)]-cis-5-norbornene-exo-2,3-dicarboximide’(compound A1) precipitated from the solution. This procedure was repeated twice.

Step 7. The precipitate was dried in vacuo to give 320 mg of ‘Poly[N-(4-Tosylatebutyl)]-cis-5-norbornene-exo-2,3-dicarboximide’ (compound A1) as a white solid (approx. 80% yield).

### Example A2. Proton NMR (¹H NMR) for identification of ‘Poly[N-(4-Tosylatebutyl)]-cis-5-norbornene-exo-2,3-dicarboximide’ (compound A1, synthesized in example A1)

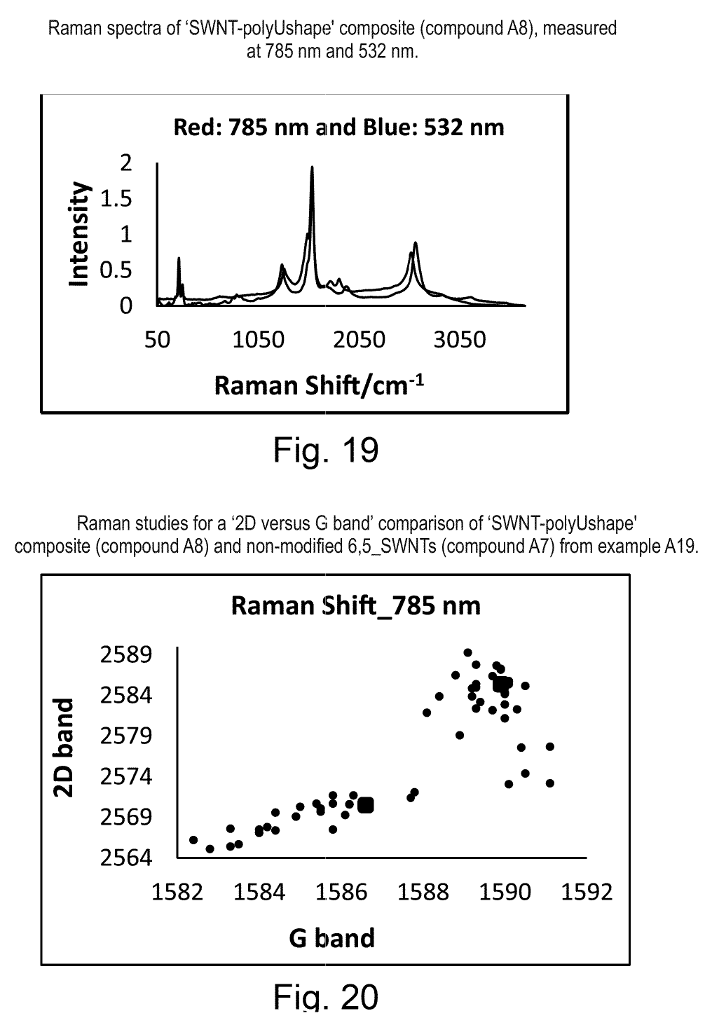

The ¹H NMR spectrum of polymer from example A1 was obtained with a Bruker Avance 400 spectrometer (Magnet Ascend 400), operating at a frequency of 400 MHz. See (FIG. 19).

The ¹H NMR spectrum showed the characteristic peaks of the four tosylate protons at 7.68 ppm (2H) and 7.19 ppm (2H) and the —CH₂OTs protons at 3.93 ppm, confirming the structure of the side-ended chains of polymer formed after ROMP reaction in example A1. The olefinic protons of monomer N-(4-Tosylatebutyl)]-cis-5-norbornene-exo-2,3-dicarboximide showed in the ¹H NMR spectrum a proton peak around 6.2 ppm due to its double bond. After ROMP polymerization this peak becomes a double peak and shifts at 5.61 and 5.47 ppm, confirming the formation of polymer from example A1. Also, in the ¹H NMR spectrum, there is no signal around 6.2 ppm showing that that there is no unreacted monomer and the polymerization is completed. Finally, the ¹H NMR spectrum shows all characteristic peaks of ‘Poly[N-(4-Tosylatebutyl)]-cis-5-norbornene-exo-2,3-dicarboximide’ (compound A1).

### Example A3. Synthesis of ‘Poly[N-(4-azidobutyl)]-cis-5-norbornene-exo-2,3-dicarboximide’ (compound A2)

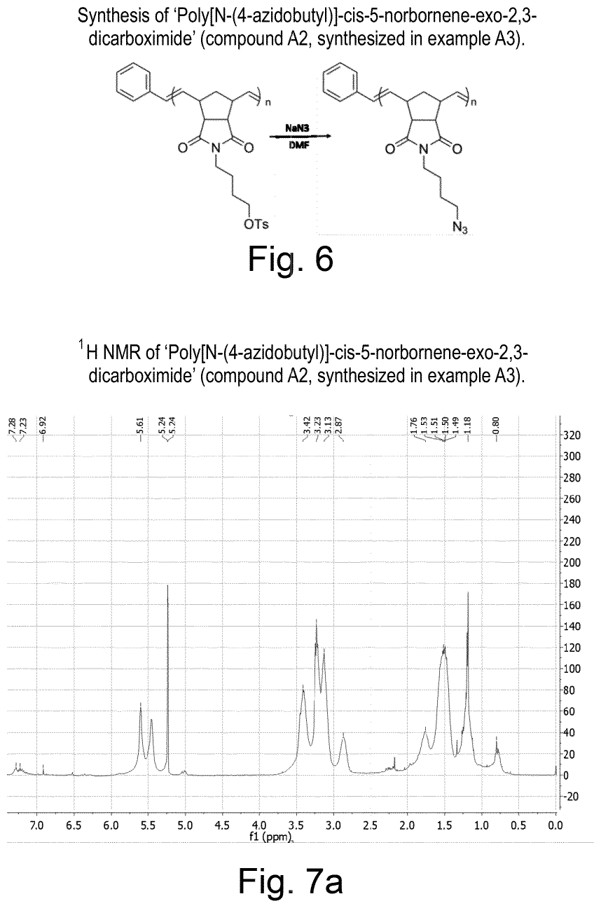

See (FIG. 6).

Step 1. In a round-bottom 15 mL 2-neck Schlenk flask, pre-dried in an oven at 120° C. for 1 hour, 200 mg of ‘Poly[N-(4-Tosylatebutyl)]-cis-5-norbornene-exo-2,3-dicarboximide’ (compound A2) was added and solubilized in 8 mL of dry DMF.

Step 2. The solution was deoxygenated with Argon for 20 min.

Step 3. NaN₃ (50 mg, 0.76 mmol) was added under Argon.

Step 4. The reaction was stirred for 12 h at 80° C., under argon atmosphere.

Step 5. The reaction mixture was added to a 50 mL separatory funnel. Then 10 mL of saturated NaCl deionized water solution and 15 mL of dichloromethane were added and the polymer was extracted in the organic phase.

Step 6. The organic phase was consequently washed five times with deionized water (5 mL each time).

Step 7. The dichloromethane (organic) phase was then introduced into a round 50 mL flask and the solvent was eliminated by rotary evaporation. 113 mg of ‘Poly[N-(4-azidobutyl)]-cis-5-norbornene-exo-2,3-dicarboximide’ (compound A2) was obtained as a yellowish solid (approx. 79% yield).

### Example A4. Analytical data for identification of ‘Poly[N-(4-azidobutyl)]-cis-5-norbornene-exo-2,3-dicarboximide’ (compound A2) synthesized in example A3)

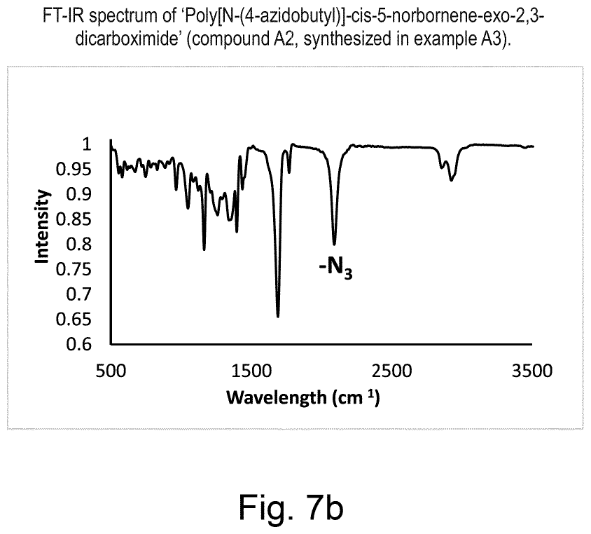

A4.1. ¹H NMR spectroscopy was measured in a Bruker Avance 400 spectrometer (Magnet Ascend 400), operating at a frequency of 400 MHz. It showed no signal in the region around 7.5 ppm belonging to the tosylate group showing that all polymer units were terminated with azide groups. Moreover, the new —CH₂N₃ proton peak appears at 3.42 ppm and is shielded when compared to —CH₂ Ts proton peak of ‘Poly[N-(4-Tosylatebutyl)]-cis-5-norbornene-exo-2,3-dicarboximide’ (compound A1), which was at 3.93 ppm, further confirming the successful nucleophilic substitution of most or all tosylate groups into azide groups. See (FIG. 7a).

Furthermore, the ¹H NMR spectrum shows all the rest characteristic peaks of ‘Poly[N-(4-azidobutyl)]-cis-5-norbornene-exo-2,3-dicarboximide’ (compound A2).

A4.2. Fourier transform infrared (FT-IR) spectrum was recorded on a FTIR Bruker IFS66v spectrometer. It showed the appearance of the characteristic strong absorption band at 2091 cm⁻¹ which corresponds to the azide (—N₃) groups. See (FIG. 7b).

### Example A5. End-group analysis of ‘Poly[N-(4-azidobutyl)]-cis-5-norbornene-exo-2,3-dicarboximide’ (compound A2, synthesized in example A3)

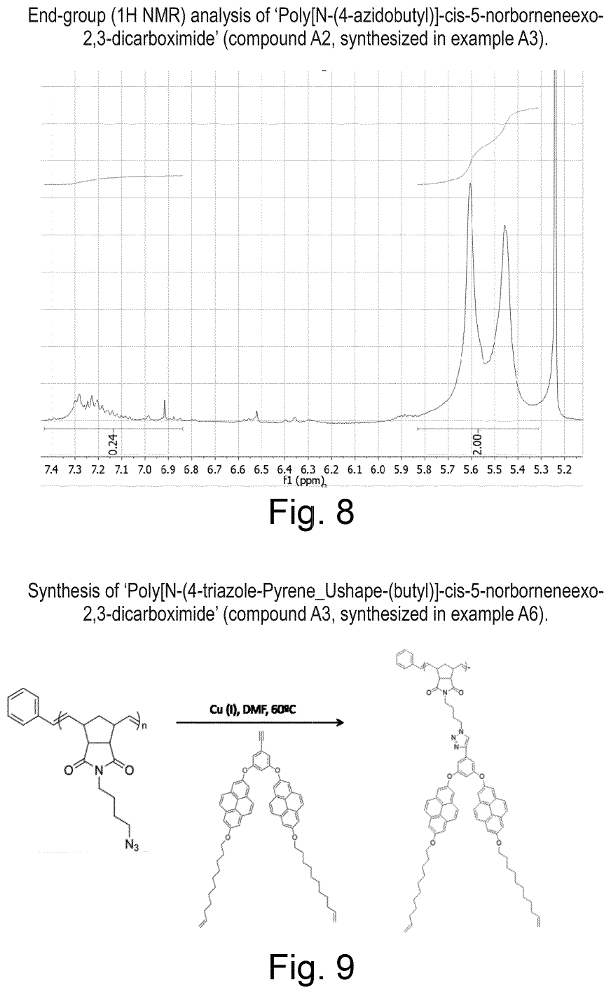

The end-group analysis was performed by using the ¹H NMR spectrum of example A4, which provides an estimate of the number of polymer units. As described in example A4, in the ¹H NMR spectrum of ‘Poly[N-(4-azidobutyl)]-cis-5-norbornene-exo-2,3-dicarboximide’ (compound A2), the region 7.0-7.5 ppm had no significant tosylate proton signals as they had been replaced by azide groups. In this region there was only the phenyl proton peaks from the end-group of the polymer. The proton peaks of the phenyl end-group of the polymer were integrated and compared to the integrated olefinic protons in the region 5.4 ppm-5.7 ppm. The comparison shows that ‘Poly[N-(4-azidobutyl)]-cis-5-norbornene-exo-2,3-dicarboximide’ (compound A2) has 21±2 polymer units. See (FIG. 8).

### Example A6. Synthesis of ‘Poly[N-(4-triazole-Pyrene Ushape-(butyl)]-cis-5-norbornene-exo-2,3-dicarboximide’ (compound A3)

See (FIG. 9).

Step 1. In a round-bottom 25 mL two-neck Schlenk flask, pre-dried in an oven at 120° C. for 1 hour, a solution of 100 mg of ‘Poly[N-(4-azidobutyl)]-cis-5-norbornene-exo-2,3-dicarboximide’ (compound A2, from Example A3) in 15 mL of deoxygenated and dry dimethylformamide (DMF) was introduced, together with a solution of 408 mg (0.45 mmol) of the alkyne U-shape in 15 mL of deoxygenated and dry dimethylformamide (DMF).

Step 2. Then 0.06 mL (0.36 mmol) of N,N-diisopropylethylamine (DIPEA) was added to the solution.

Step 3. 69 mg (0.36 mmol) of copper iodide (CuI) was added.

Step 4. The solution mixture was stirred at 60° C. for 12 hours.

Step 5. Dichloromethane (20 mL) and saturated sodium chloride (NaCl) deionized water (15 mL) solutions were added to the solution mixture resulting from step 4.

Step 6. Then the addition of 2 mL aqueous ammonia (NH₃) solution (25%) by a syninge of 2 mL followed and the mixture was left for 15 min. under vigorous stirring.

Step 7. Using a 100 mL separatory funnel, the organic phase was extracted and washed three times with deionized aqueous solution of 10 mL.

Step 8. Then the organic phase was introduced in a round-bottom 50 mL flask and the solvent was eliminated by rotary evaporation.

Step 9. The solid from step 8 was solubilized in 1 mL of dichloromethane and was added quickly by a syringe of 1 mL in a solution of 300 mL of diethyl ether.

Step 10. The precipitate from step 9 was collected by paper filtration and dried under vacuum, giving 470 mg of ‘Poly[N-(4-triazole-Pyrene_Ushape-(butyl)]-cis-5-norbornene-exo-2,3-dicarboximide’ (compound A3) as a yellow/orange crystalline solid (approx. 93% yield).

### Example A7. Infrared Spectroscopy data for identification of ‘Poly[N-(4-triazole-Pyrene Ushape-(butyl)]-cis-5-norbornene-exo-2,3-dicarboximide’ (compound A3, synthesized in example A6)

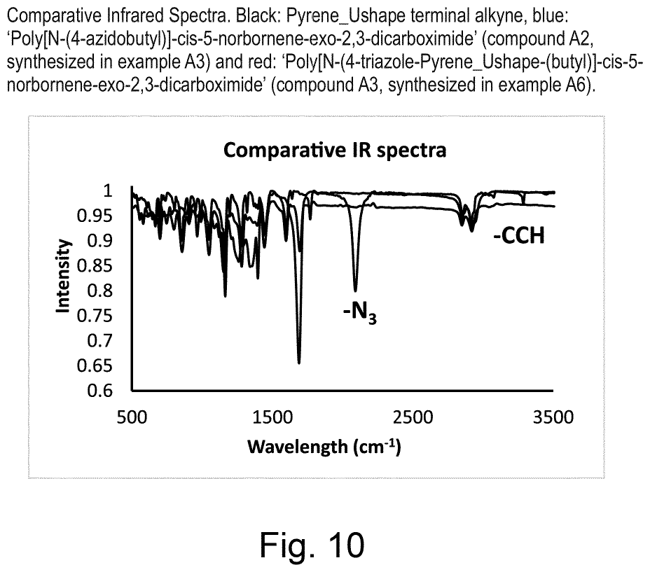

Infrared spectroscopy was performed on the product resulting from example A6 using a FTIR Bruker IFS66v spectrometer. In the IR spectrum (example A4) the azide (—N₃) characteristic signal of ‘Poly[N-(4-azidobutyl)]-cis-5-norbornene-exo-2,3-dicarboximide’ (compound A2) at 2091 cm⁻¹ disappeared, indicating that the product contained no free azide groups, i.e. all azide groups were replaced by the triazole groups connecting the U-shape pyrene molecule to every polymer unit. The characteristic peak at 3284 cm⁻¹ of the C—C triple bond of the terminal alkyne of the Pyrene_Ushape molecule disappeared, indicating that all pyrene groups were attached to the side chains of ‘Poly[N-(4-azidobutyl)]-cis-5-norbornene-exo-2,3-dicarboximide’ (compound A2) and that there are no free, not attached, Pyrene_U-shape molecules encapsulated or attached to final ‘Poly[N-(4-triazole-Pyrene_Ushape-(butyl)]-cis-5-norbornene-exo-2,3-dicarboximide’ (compound A3). See (FIG. 10).

### Example A8. Other analytical data for identification of ‘Poly[N-(4-triazole-Pyrene Ushape-(butyl)]-cis-5-norbornene-exo-2,3-dicarboximide’ (compound A3, synthesized in example A6)

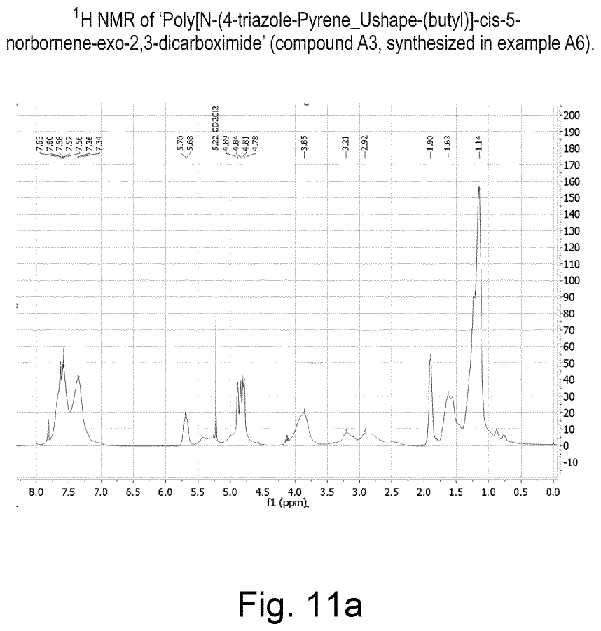

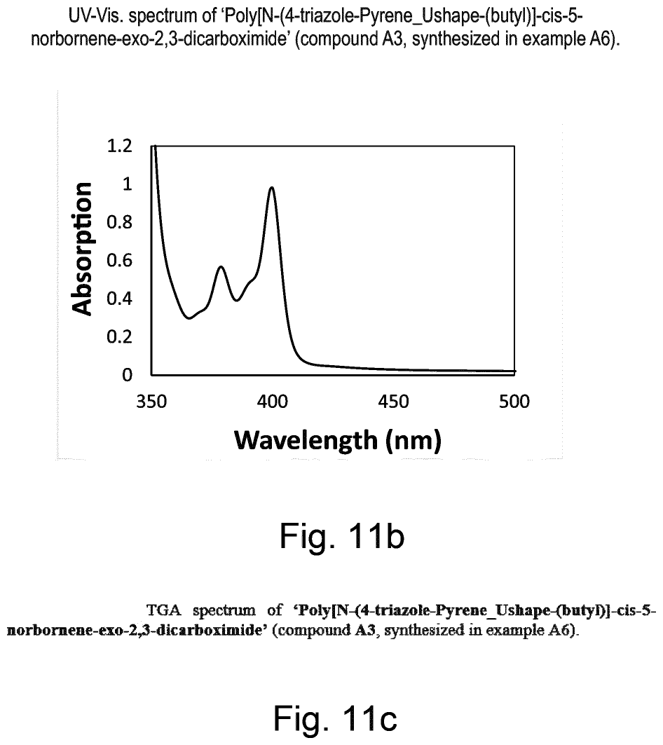

A.8.1. In ¹H NMR the —CH₂ triazole peak appears at 3.85 ppm which is deshielded when compared to the —CH₂N₃ peak of its precursor due to the electron-withdrawing properties of the triazole group and the characteristic peaks of the U-shape molecules are observed, confirming the formation of ‘Poly[N-(4-triazole-Pyrene_Ushape-(butyl)]-cis-5-norbornene-exo-2,3-dicarboximide’ (compound A3). See (FIG. 11a).

Also, the ¹H NMR spectrum shows all characteristic peaks of ‘Poly[N-(4-triazole-Pyrene_Ushape-(butyl)]-cis-5-norbornene-exo-2,3-dicarboximide’ (compound A3).

A.8.2. UV-Vis spectroscopy was measured in an Agilent Cary 5000 UV-Vis-NIR spectrometer. UV-Vis. spectrum shows the same two absorption bands at 380 nm and 400 nm (characteristic of the pyrene groups) as the terminal alkyne of the Pyrene_Ushape molecule, suggesting that the U-shaped molecules are indeed attached to polymer. See (FIG. 11b).

### Example A9. Nanoindentation Measurement Method

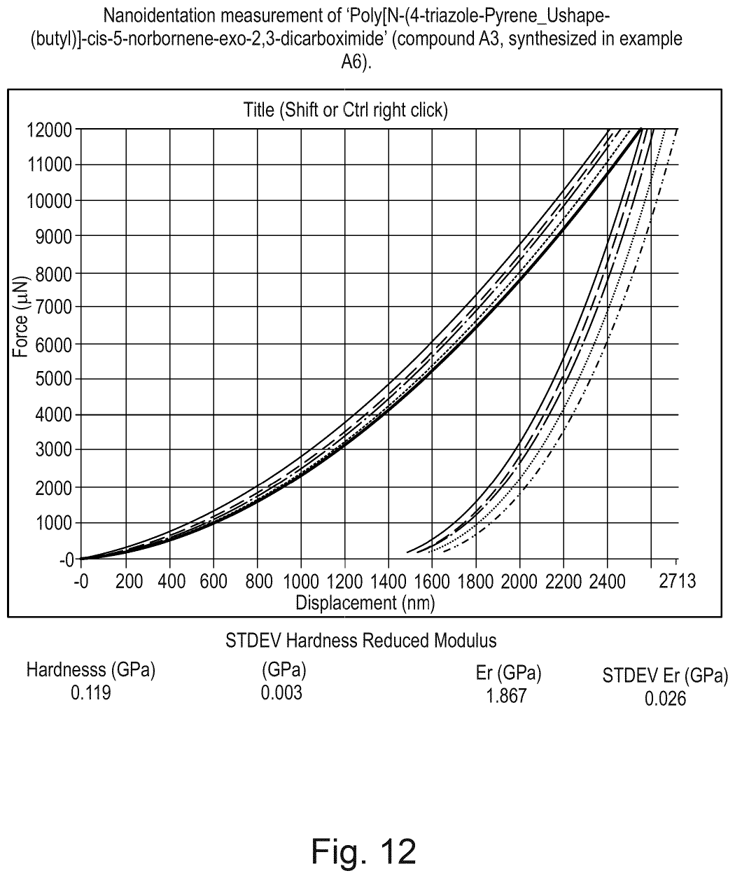

Nanoindentation testing was carried out on a Hysitron T1950 Triboindenter equipped with either a three-sided pyramidal Berkovich with a tip radius of 350 nm or a cube-corner diamond indenter with a tip radius of <100 nm. See (FIG. 12). Multiple indentations were performed at different locations of the film, in load-control mode at different maximum loads, using load-hold-unload cycle times of 30-30-5 s. All data were analysed with the Oliver and Pharr method (ref). To obtain the elastic modulus, the unloading portion of the load-depth curve was analysed according to:

$${E}_{r} = ( S √ π ) / ( 2 √ ( A ( h ) ) \qquad ( 1 )$$

where A(h) is the contact area, obtained from the tip area function, which was calibrated beforehand from indentations on fused silica, S is the contact stiffness, and Er is the reduced modulus. The hardness (H) was determined from the peak load and the projected area of contact A(h):

$$H = \frac{F}{A ( h )} \qquad ( 2 )$$

### Example A10. Mechanical stability evaluation of ‘Poly[N-(4-triazole-Pyrene Ushape-(butyl)]-cis-5-norbornene-exo-2,3-dicarboximide’ (compound A3)

‘Poly[N-(4-triazole-Pyrene_Ushape-(butyl)]-cis-5-norbornene-exo-2,3-dicarboximide’ (compound A3), in powder form, was embedded into epoxy resin. It had higher density than epoxy resin, therefore the sample powder was dispersed on the bottom of the mould where resin was poured. Once the epoxy resin was cured at room temperature the face of the piece that contained the sample powder was ground with consecutively finer SiC papers, and finally polished with 3 and 1 μm diamond suspension to reach a surface finish suitable for nanoindentation. The indenter area function was determined using indents on a reference fused silica sample. All data were analysed with the Oliver and Pharr method. The hardness was calculated to be 0.119 GPa and the reduced modulus 1.867 GPa. See (FIG. 12).

### Example A11. Synthesis of ‘Poly[N-(4-Tosylatebutyl)]-cis-5-norbornene-exo-2,3-dicarboximide’ (compound A4)

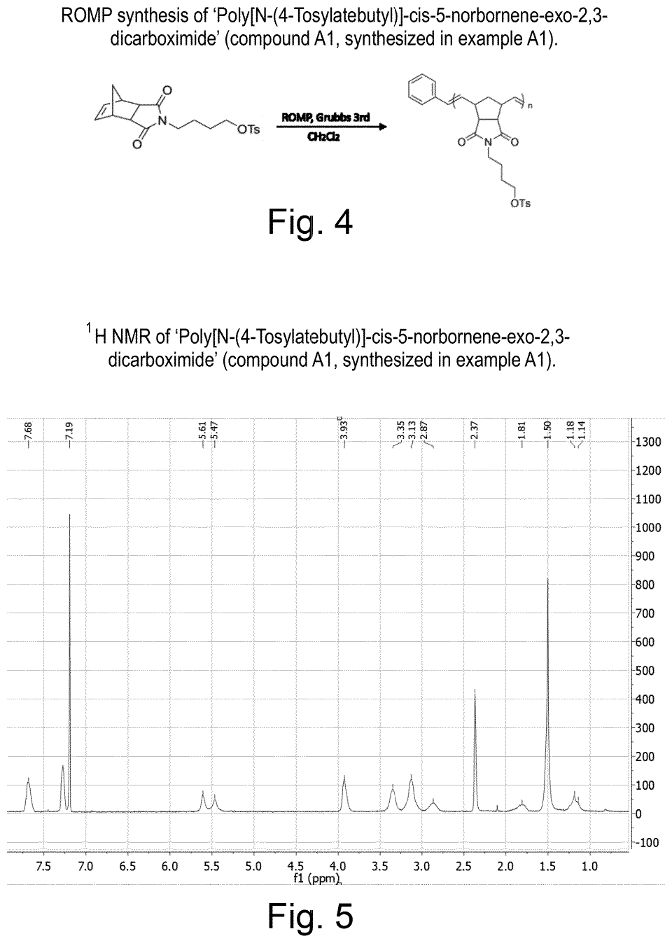

The synthesis of ‘Poly[N-(4-Tosylatebutyl)]-cis-5-norbornene-exo-2,3-dicarboximide’ (compound A4), is similar to that described in example A1, except that Grubbs catalyst is here reduced in order to increase the average number of units per polymer. See (FIG. 4).

Step 1. In a round-bottom 10 mL 2-neck Schlenk flask, pre-dried in an oven at 120° C. for 1 hour, 200 mg (0.52 mmol) of N-(4-Tosylatebutyl)]-cis-5-norbornene-exo-2,3-dicarboximide was introduced and solubilized in dry dichloromethane (1.3 mL), under Argon.

Step 2. In a second round-bottom 5 mL flask, pre-dried in an oven at 120° C. for 1 hour, 15 mg (0.017 mmol) of Grubbs-III (3^{rd} generation) catalyst was solubilized in 0.6 mL of dry dichloromethane, under Argon.

Step 3. Then, the solution of Grubbs-III catalyst was added quickly (in 2-3 seconds) to the solution of N-(4-Tosylatebutyl)]-cis-5-norbornene-exo-2,3-dicarboximide under vigorous stirring and Argon atmosphere.

Step 4. The solution was stirred for 4 hours and then 1 mL of ethyl vinyl ether was added in order to quench the reaction.

Step 5. The resultant polymer solution was dried under reduced pressure using a rotary evaporator at 35° C.

Step 6. The polymer was solubilized in 0.8 mL of dichloromethane and was added with a syringe of 1 mL quickly in 250 mL of diethyl ether, under vigorous stirring while ‘Poly[N-(4-Tosylatebutyl)]-cis-5-norbornene-exo-2,3-dicarboximide’ (compound A4) precipitated from the solution. This procedure was repeated twice.

Step 7. The new precipitate was dried in vacuo to give 150 mg of ‘Poly[N-(4-Tosylatebutyl)]-cis-5-norbornene-exo-2,3-dicarboximide’ (compound A4) (approx. 75% yield).

### Example A12. Proton NMR (¹H NMR) for identification of ‘Poly[N-(4-Tosylatebutyl)]-cis-5-norbornene-exo-2,3-dicarboximide’ (compound A4, synthesized in example A11)

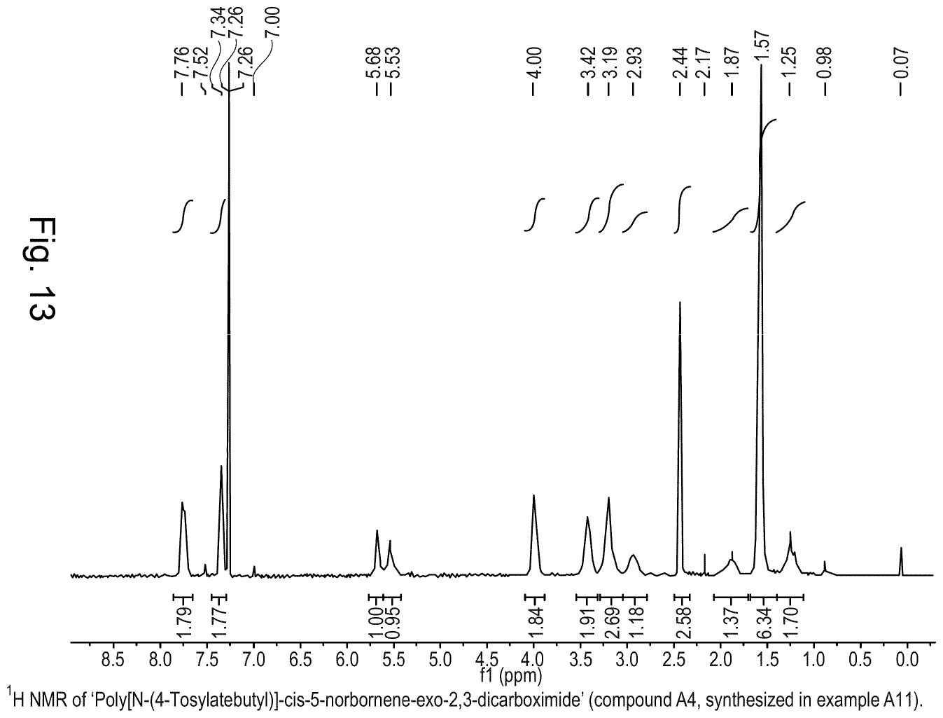

¹H NMR analyses corresponded to those of example A2. See (FIG. 13).

The ¹H NMR spectrum of polymer from example A10 was obtained with a Bruker Avance 400 spectrometer (Magnet Ascend 400), operating at a frequency of 400 MHz and was very informative about the product.

The ¹H NMR spectrum showed the characteristic peaks of the four tosylate protons at 7.76 ppm (2H) and 7.34 ppm (2H) and the —CH₂OTs protons at 4.00 ppm, confirming the structure of the side-ended chains of polymer formed after ROMP reaction in example A11.

The olefinic protons of monomer N-(4-Tosylatebutyl)]-cis-5-norbornene-exo-2,3-dicarboximide showed in the ¹H NMR spectrum a proton peak around 6.2 ppm due to its double bond. After ROMP polymerization this peak becomes double and shifts to 5.5-5.8 ppm region, confirming the formation of polymer from example A1.

Also, in the ¹H NMR spectrum, there is no signal around 6.2 ppm showing that that there is no unreacted monomer and the polymerization is completed.

Last, the ¹H NMR spectrum shows all characteristic peaks of ‘Poly[N-(4-Tosylatebutyl)]-cis-5-norbornene-exo-2,3-dicarboximide’ (compound A4).

### Example A13. Synthesis of ‘Poly[N-(4-azidobutyl)]-cis-5-norbornene-exo-2,3-dicarboximide’ (compound A5)

This experimental procedure is identical to example A3. See (FIG. 6). The detailed procedure is described below:

Step 1. In a round-bottom 15 mL 2-neck schlenk flask, pre-dried in an oven at 120° C. for 1 hour, 150 mg of ‘Poly[N-(4-Tosylatebutyl)]-cis-5-norbornene-exo-2,3-dicarboximide’ (compound A4) was added and solubilized in 5 mL of dry DMF.

Step 2. The solution was deoxygenated with Argon for 20 min.

Step 3. Then, NaN₃ (37 mg, 0.57 mmol) was added under Argon.

Step 4. The reaction was stirred for 12 h at 80° C., under argon atmosphere.

Step 5. The reaction mixture was added to a separatory funnel of 50 mL. Then 8 mL of saturated NaCl deionized water solution and 12 mL of dichloromethane was added and the polymer was extracted in the organic phase.

Step 6. The organic phase was consequently washed five times with deionized water (5 mL each time).

Step 7. The dichloromethane (organic) phase was then introduced into a round 50 mL flask and the solvent was eliminated by rotary evaporation. 60 mg of ‘Poly[N-(4-azidobutyl)]-cis-5-norbornene-exo-2,3-dicarboximide’ (compound A5) was obtained as a yellowish solid (approx. 76% yield).

### Example A14. Analytical data for identification of Poly[N-(4-azidobutyl)]-cis-5-norbornene-exo-2,3-dicarboximide (compound A5, synthesized in example A13)

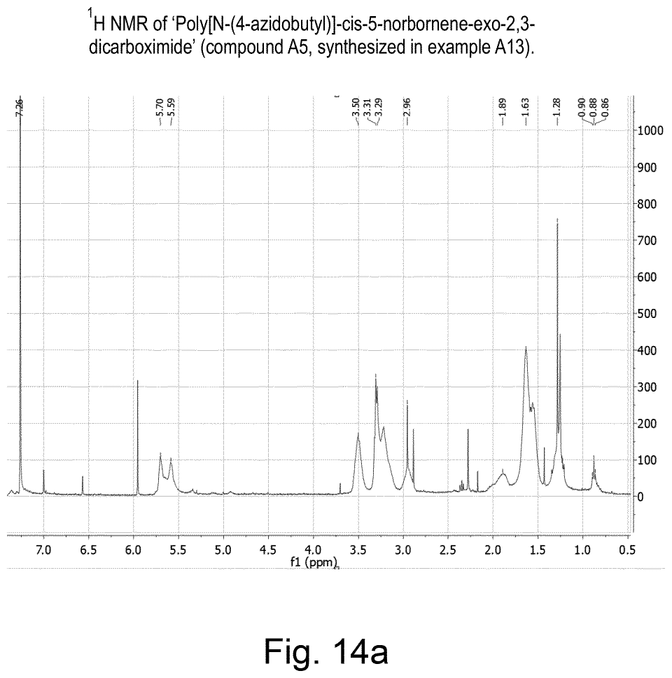

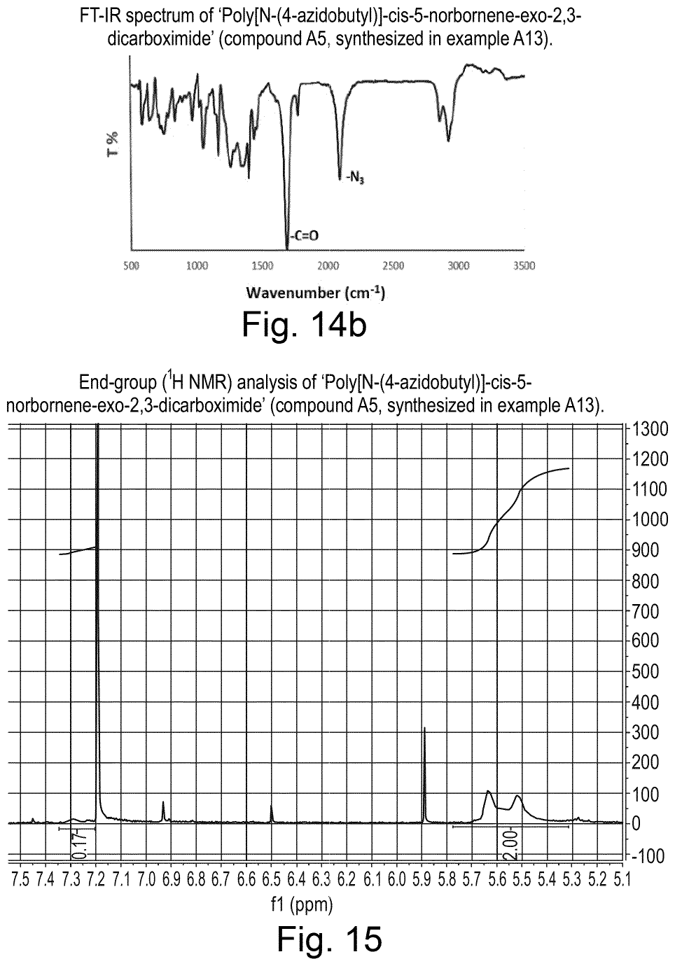

¹H NMR and FT-IR analyses were similar to those of example A4. See (FIG. 14a and FIG. 14b).

A14.1. ¹H NMR spectroscopy was measured in a Bruker Avance 400 spectrometer (Magnet Ascend 400), operating at a frequency of 400 MHz. It showed no signal in the region 7.0-7.5 ppm belonging to the tosylate group showing that all polymer units are now terminated with azide groups. Moreover, the new —CH₂N₃ proton peak appears at 3.51 ppm and is shifted when compared to —CH₂ Ts proton peak of ‘Poly[N-(4-Tosylatebutyl)]-cis-5-norbornene-exo-2,3-dicarboximide’ (compound A4).

Also, the ¹H NMR spectrum shows all characteristic peaks of ‘Poly[N-(4-azidobutyl)]-cis-5-norbornene-exo-2,3-dicarboximide’ (compound A5).

A14.2. Fourier transform infrared (FT-IR) spectrum was recorded on a FTIR Bruker IFS66v spectrometer. It showed the appearance of the characteristic strong absorption band at 2095 cm⁻¹ which corresponds to the azide (—N₃) groups.

### Example A15. End-group analysis of Poly[N-(4-azidobutyl)]-cis-5-norbornene-exo-2,3-dicarboximide (compound A5, synthesized in example A13)

The end-group analysis was performed as in example A5, by using the ¹H NMR spectrum of example A14. An estimation of the number of polymer units was carried out. See (FIG. 15).

As described in example A5, in the ¹H NMR spectrum of ‘Poly[N-(4-azidobutyl)]-cis-5-norbornene-exo-2,3-dicarboximide’ (compound A5), the region 7.0-7.5 ppm was clear from tosylate proton signals as they were replaced by azide groups. In this region there was only the phenyl proton peaks from the end-group of the polymer. The proton peaks of the phenyl end-group of the polymer were integrated and compared to the integrated olefinic protons in the region 5.3 ppm-5.7 ppm. The comparison shows that ‘Poly[N-(4-azidobutyl)]-cis-5-norbornene-exo-2,3-dicarboximide’ (compound A5) has 29±5 polymer units.

### Example A16. Synthesis of ‘Poly[N-(4-triazole-Pyrene Ushape-(butyl)]-cis-5-norbornene-exo-2,3-dicarboximide’ (compound A6)

This experimental procedure is similar to that of example A6. See (FIG. 9). The detailed procedure is described below:

Step 1. In a round-bottom 15 mL two-neck Schlenk flask, pre-dried in an oven at 120° C. for 1 hour, 50 mg of ‘Poly[N-(4-azidobutyl)]-cis-5-norbornene-exo-2,3-dicarboximide’ (compound A5) in 8 mL of deoxygenated and dry DMF was introduced together with 205 mg (0.23 mmol) of the alkyne U-shape in 8 mL of deoxygenated and dry DMF.

Step 2. Then 0.03 mL (0.18 mmol) of N,N-diisopropylethylamine (DIPEA) was added in the solution.

Step 3. The addition of 34 mg (0.18 mmol) of CuI followed.

Step 4. The solution mixture was stirred at 60° C. for 12 hours.

Step 5. Afterwards, CH₂Cl₂ (10 mL) and saturated NaCl deionized water (8.3 mL) solutions were added followed by the addition of 1.3 mL of NH₃ aqueous solution by a syringe of 2 mL and the mixture was left for 15 min. under vigorous stirring.

Step 6. Using a 50 mL separatory funnel, the organic phase was extracted and washed three times with 3 mL deionized aqueous solution.

Step 7. Then the organic phase was introduced in a round-bottom 15 mL flask and the solvent was eliminated by rotary evaporation.

Step 8. The solid was solubilized in 0.5 mL of dichloromethane and was added quickly by a syringe of 1 mL in a solution of 200 mL of diethyl ether.

Step 9. The precipitate (polymer) was collected by paper filtration.

Step 10. The polymer was dried under vacuum, giving 230 mg of ‘Poly[N-(4-triazole-Pyrene_Ushape-(butyl)]-cis-5-norbornene-exo-2,3-dicarboximide’ (compound A6) as a yellow/orange crystalline solid (approx. 90% yield).

### Example A17. Infrared Spectroscopy data for identification of Poly[N-(4-triazole-Pyrene Ushape-(butyl)]-cis-5-norbornene-exo-2,3-dicarboximide (synthesized in example A15)

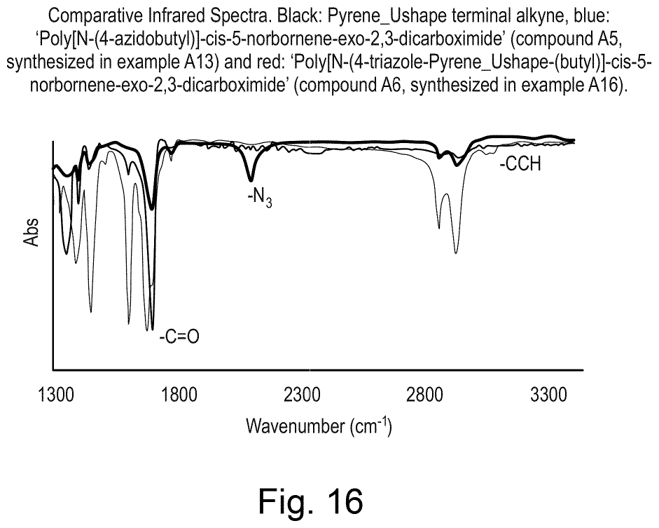

FT-IR data gave similar set of data as in example A7. See (FIG. 16).

Infrared spectroscopy was performed on the product resulting from example A16 using a FTIR Bruker IFS66v spectrometer. In the IR spectrum (example A14.2.) the azide (—N₃) characteristic signal of ‘Poly[N-(4-azidobutyl)]-cis-5-norbornene-exo-2,3-dicarboximide’ (compound A5) at 2095 cm⁻¹ disappeared, indicating that the product contained no free azide groups, i.e. all azide groups were replaced by the triazole groups connecting the U-shape pyrene molecule to every polymer unit. The characteristic peak at 3284 cm⁻¹ of the triple bond of the terminal alkyne of the Pyrene_Ushape molecule also disappeared indicating that all pyrene groups were attached to the side chains of ‘Poly[N-(4-azidobutyl)]-cis-5-norbornene-exo-2,3-dicarboximide’ (compound A5) and that there are no free, not-attached, Pyrene_U-shape molecules encapsulated or attached to final ‘Poly[N-(4-triazole-Pyrene_Ushape-(butyl)]-cis-5-norbornene-exo-2,3-dicarboximide’ (compound A6).

### Example A18. Other analytical data for identification of ‘Poly[N-(4-triazole-Pyrene Ushape-(butyl)]-cis-5-norbornene-exo-2,3-dicarboximide’ (compound A6, synthesized in example A16)

These analytical data gave similar set of data as in example A8.

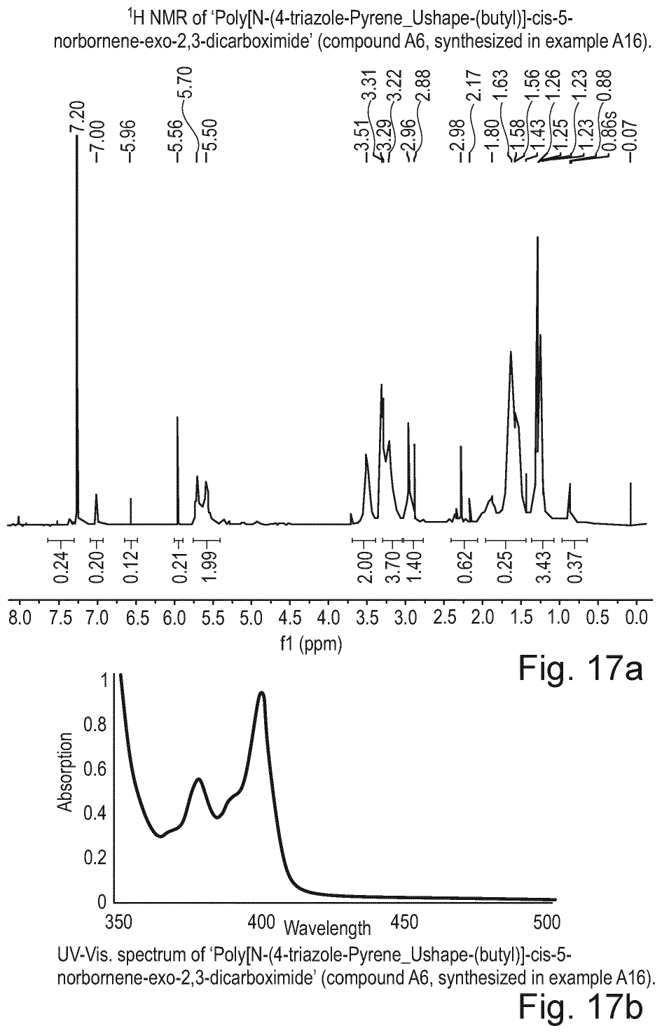

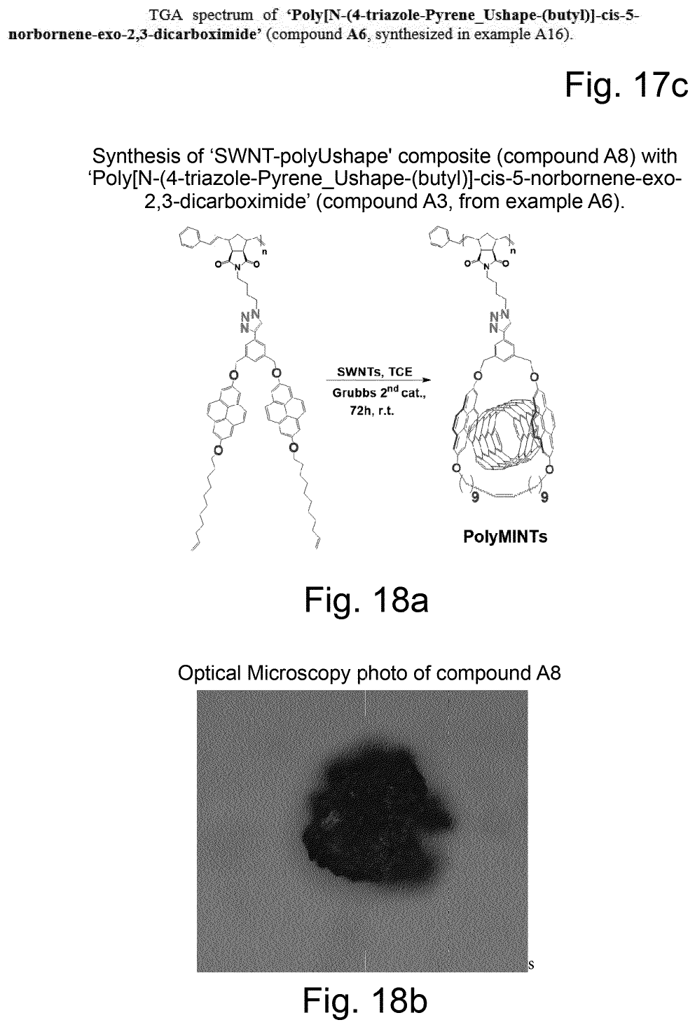

A18.1. In ¹H NMR the —CH₂triazole peak appears at 3.92 ppm—which is deshielded when compared to the —CH₂N₃ peak of its precursor—due to the electron-withdrawing properties of the triazole group and the characteristic peaks of the U-shape molecules are observed, confirming the formation of ‘Poly[N-(4-triazole-Pyrene_Ushape-(butyl)]-cis-5-norbornene-exo-2,3-dicarboximide’ (compound A6). See (FIG. 17a).

Furthermore, the ¹H NMR spectrum shows all characteristic peaks of Poly[N-(4-triazole-Pyrene_Ushape-(butyl)]-cis-5-norbornene-exo-2,3-dicarboximide (compound A6).

A18.2. UV-Vis spectroscopy was measured in an Agilent Cary 5000 UV-Vis-NIR spectrometer. UV-Vis. spectrum shows the same two absorption bands at 380 nm and 400 nm (characteristic of the pyrene groups) as the terminal alkyne of the Pyrene_Ushape molecule, suggesting that the U-shaped molecules are indeed attached to polymer. See (FIG. 17b).

### Example A19. Purification of 6,5-enriched SWNTs (compound A7)

Step 1. 100 mg of SWNTs were suspended in 70 mL of 35% HCl and sonicated for 10 min.

Step 2. The mixture was poured in 200 mL of miliQ water Step 3. The mixture was filtered through a polycarbonate membrane of 0.2 μm pore size.

Step 4. The solid, compound A7, was left to dry.

### Example A20. Synthesis of ‘SWNT-polyUshape’ composite (compound A8) with ‘Poly[N-(4-triazole-Pyrene Ushape-(butyl)]-cis-5-norbornene-exo-2,3-dicarboximide’ (compound A3, from example A6)

See (FIG. 18a, b).

Step 1. A 2-neck round-bottom 500 mL Schlenk flask was pre-dried in an oven at 120° C. for 1 hour.

Step 2. Then, 2.4 mg of cleaned 6,5-SWNTs from example B3 were added in the schlenk followed by the addition of 300 mL of dry tetrachloroethane (TCE) at room temperature.

Step 3. The suspension was deoxygenated bubbling N₂ for 10 minutes.

Step 4. Then in a 5 mL sample glass tube, 36 mg (0.002 mmol) of compound A3 of example A6 were dissolved in 3.6 mL of TCE.

Step 5. The 500 mL round-flask was then introduced in a bath sonicator while the polymer (compound A3) solution was added in portions (1.2 mL×3). Between each addition, the solution was sonicated for three minutes.

Step 6. At the end of the addition process, the flask was removed from the bath sonicator and deoxygenated by bubbling N₂ for 20 min.

Step 7. Last, 40% of Grubbs-2^{nd} generation catalyst (11 mg, 0.012 mmol) was added portionwise, under N₂ and under vigorous stirring.

Step 8. Then, the suspension was left to stir for 3 days at room temperature.

Step 9. The suspension was filtered through a PTFE membrane of 0.2 μm pore size.

Step 10. The composite was collected from the filter and was re-dispersed in 50 mL TCE in a round-bottom 100 mL flask by bath sonication for 5 min and filtered again.

Step 11. Step 10 was repeated 4 times. The solution obtained after the final addition of TCE, but before the final filtration, was called “Solution of ROMP polymer-coated SWNT of Example A20”.

Step 12. The composite A8 was collected in a round glass sample vial and dried overnight at 150° C. in an oven. The dried composite was called “SWNT-ROMP polymer composite of Example A20”.

### Example A21. Raman Spectroscopy of ‘SWNT-polyUshape’ composite (compound A8)

A21.1. Raman spectra measured at 785 nm and 532 nm.

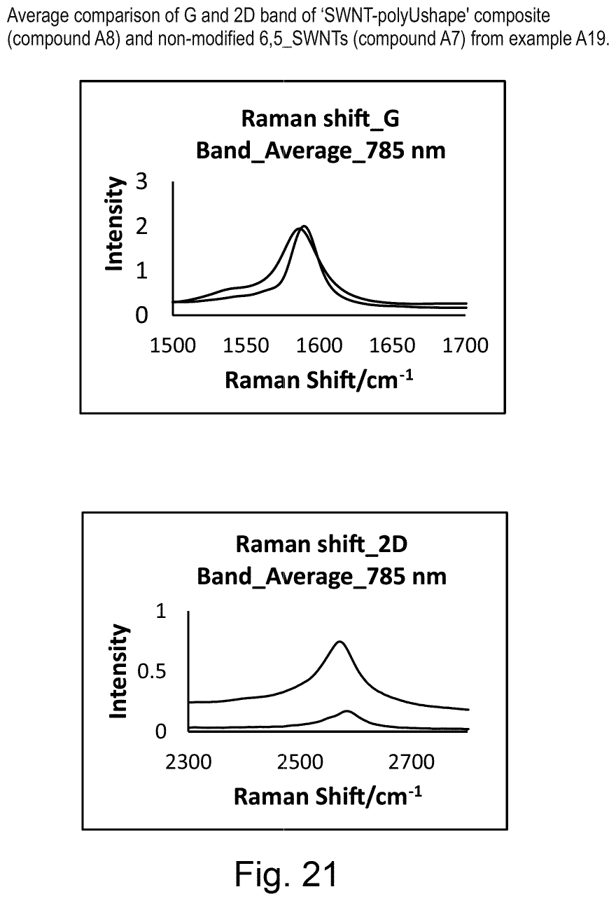

All the characteristic SWNTs peaks are observed, namely radial breathing modes, D, G and 2D bands. We obsrerved no increase in the I_{D}/I_{G} ratio, showing that the composite formation did not modify the structure of the 6,5-SWNTs (compound A7). The mechanical bond did not interact with the carbon nanotube surface. See (FIG. 19-FIG. 21).

A21.2. Raman studies for a ‘2D versus G band’ comparison of composite A8 and non-modified 6,5-SWNTs (compound A7) from example A19. This type of studies allows for the differentiation between electronic and strain effects in graphene and SWNTs (Nat. Commun. 2012).

Several Raman spectroscopic measurements (30 measurements for both, compound A8 and A7) have been performed. When the Raman shifts of the 2D versus G band are plotted, a different tendency is observed of the points between the two materials showing that 6,5-SWNTs are modified by polymer A3.

A21.3. Average comparison of G and 2D band of composite A8 and non-modified 6,5-SWNTs (compound A7) from example A19.

The shift in the 2D band and G band of composite A8 in comparison with the starting material (compound A7) shows that even though these 2 characteristic bands of 6,5_SWNTs are preserved (an indication that the structure of the nanotubes are not modified), the material has changed. See (FIG. 19-FIG. 21).

### Example A22. UV.Vis NIR studies of ‘SWNT-polyUshape’ composite (compound A8)

A22.1. UV.Vis_NIR spectra comparison between a) ‘Poly[N-(4-triazole-Pyrene_Ushape-(butyl)]-cis-5-norbornene-exo-2,3-dicarboximide’ (compound A3, from example A6), b) ‘SWNT-polyUshape’ composite (compound A8) after step 8 and c) ‘SWNT-polyUshape’ composite (compound A8) after step 11.

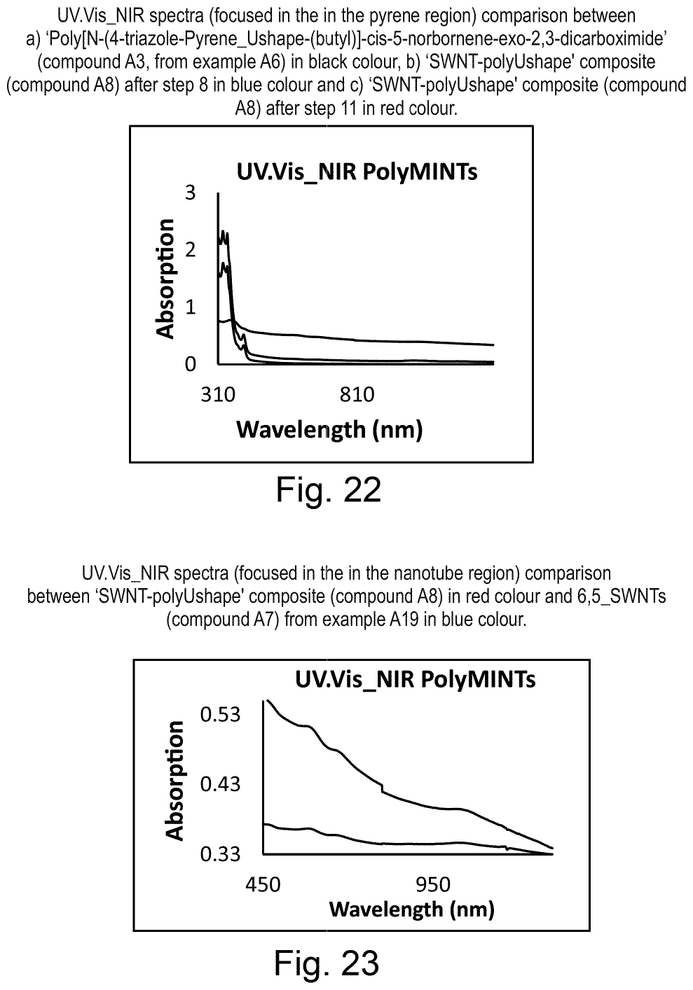

In the UV.Vis. NIR spectra, the differences between compounds A3 and A8 are highlighted. In the region where the characteristic pyrene bands are observed (300-420 nm), the pyrene absorption of compound A8 is clearly red-shifted compared to free polymer A3, indicating the difference between the two materials. This shift is most likely caused by the pyrene chromophores being in close proximity to the surface of carbon nanotubes, because they are closed around 6,5-SWNTs. Another observation in that the shoulder-band of pyrene after 410 nm in the visible is quenched in composite A8. See (FIG. 22).

The characteristic bands belonging to carbon nanotubes around 580 nm, 680 nm and 1030 nm are also red-shifted in composite A8 which is in accordance with the observations above, showing the difference between A7 mother material and A8 resultant composite. See (FIG. 23).

### Example A23. Microscopic analyses of ‘SWNT-polyUshape’ composite (compound A8)

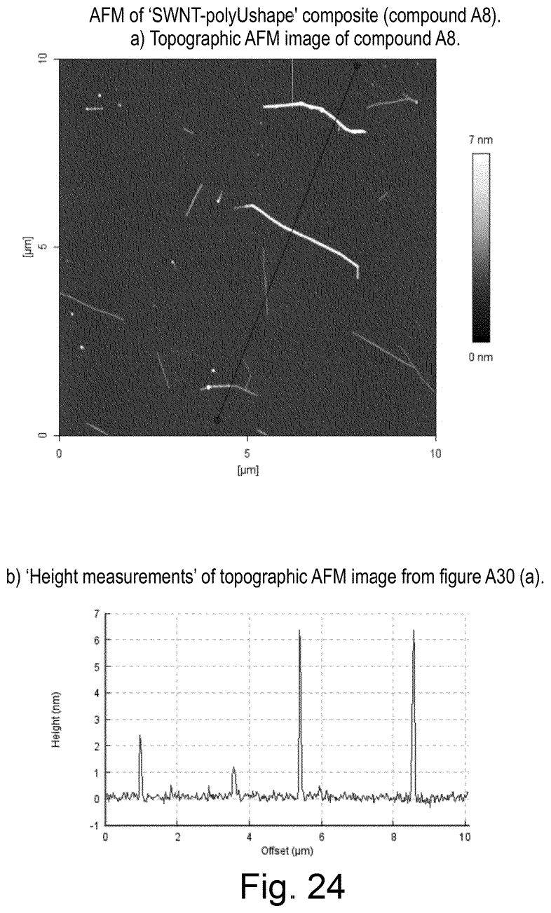

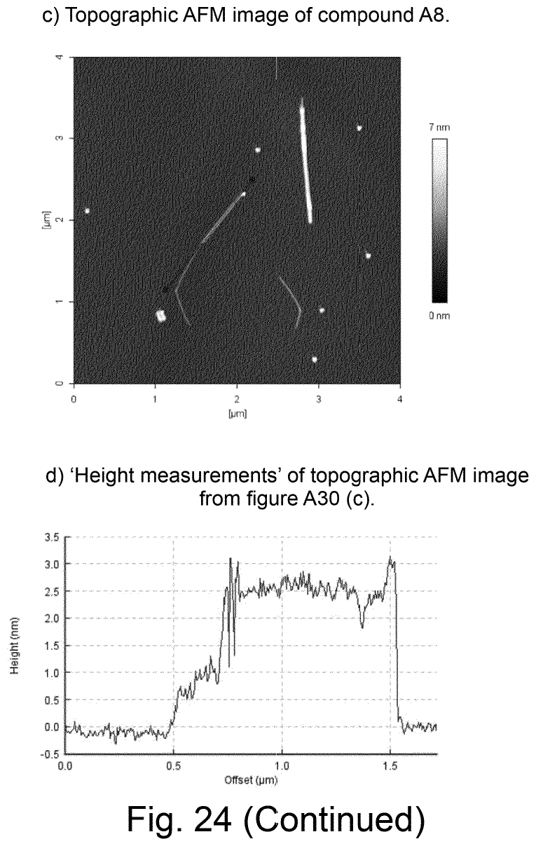

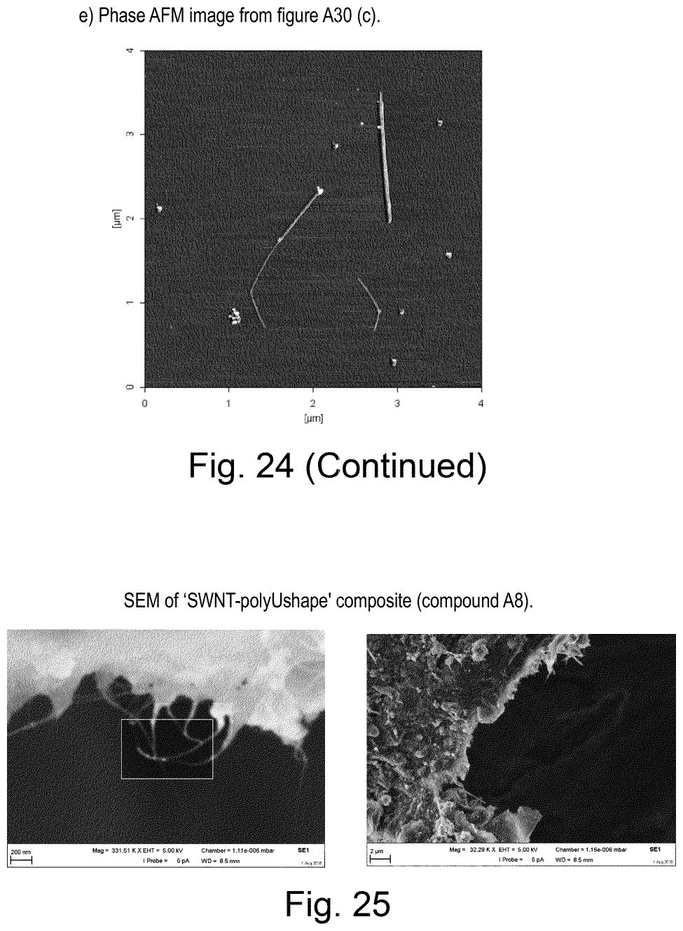

A23.1. AFM shows the topography of SWNTs of the composite (compound A8). See (FIG. 24).

A23.2. SEM and SEM-in-lens show the surface of the composite material and the connection between carbon nanotubes which is happening due to polymer A3. See (FIG. 25 and FIG. 26).

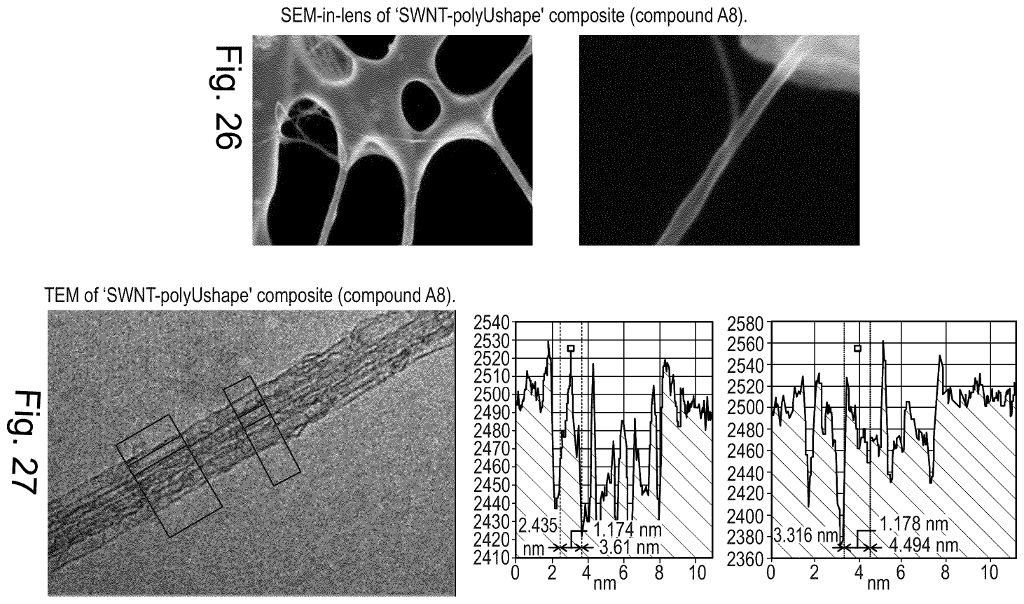

A23.3. TEM shows that the diameter of the carbon nanotubes of composite A8 is around 1.2 nm, slightly bigger than the mother SWNTs diameter of compound A7, indicating the existence of polymers A3 around A7. See (FIG. 27).

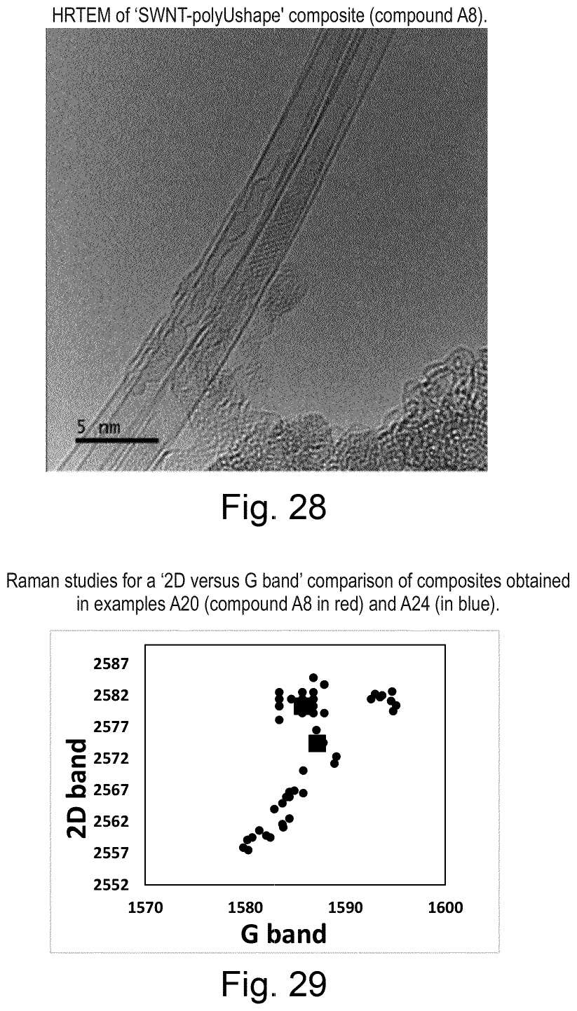

A23.4. HRTEM shows that in the surface of carbon nanotubes, the polymer is embedded without exceeding the ‘walls’ of carbon nanotubes. Also, polymers A3 appear to be crystallized on the surface of A7. See (FIG. 28).

### Example A24. ‘Control’ Experiment

In order to confirm the formation of ‘SWNT-polyUshape’ composite (compound A8), a ‘control’ experiment was performed. Example A24 is identical to example A20, with only difference step 7 of example A20 (addition of Grubb's 2^{nd} generation catalyst) which was omitted. With this ‘control’ experiment, the necessity of macrocycle formation around SWNTs was highlighted

### Example A25. Raman Studies for a ‘2D Versus G Band’ Comparison of Composites Obtained in Examples A20 and A24

Several Raman spectroscopic measurements (30 measurements for both, compound A8 and compound obtained in example A24) have been performed. When the 2D versus G band are plotted, a different tendency is observed of the points between the two materials showing that macrocyclization around the SWNTs defines the efficient formation of the composite A8. See (FIG. 29).

### Example A26. Synthesis of ‘SWNT-polyUshape Supramolecular’ composite (compound A9) with ‘Poly[N-(4-triazole-Pyrene Ushape-(butyl)]-cis-5-norbornene-exo-2,3-dicarboximide’ (compound A3, from example A6)

Step 1. A 2-neck round-bottom 500 mL schlenk flask was pre-dried in an oven at 120° C. for 1 hour.

Step 2. Then, 2.4 mg of cleaned 6,5-SWNTs of example B3 were added in the schlenk followed by the addition of 300 mL of tetrachloroethane (TCE) at room temperature (23° C.).

Step 3. The suspension was deoxygenated by bubbling N₂ for 10 minutes.

Step 4. Then in a 5 mL sample glass tube, 36 mg (0.002 mmol) of compound A3 of example A6 were dissolved in 3.6 mL of TCE.

Step 5. The 500 mL round-flask was then introduced in a bath sonicator while the polymer (compound A3) solution was added portionwise (1.2 mL×3). Between each addition, the solution was sonicated for three minutes.

Step 6. At the end of the addition process, the flask was removed from the bath sonicator and was deoxygenated by bubbling N₂ for 20 min.

Step 7. Then, the suspension was left to stir for 2 days at room temperature (23° C.).

Step 8. The suspension was filtered through a PTFE membrane of 0.2 μm pore size.

Step 9. The composite was rinsed with 50 mL of TCE.

Step 10. Last, supramolecular composite A9 was collected in a round glass sample vial and dried overnight at 150° C.

### Example A27. Raman Spectroscopy of ‘SWNT-polyUshape Supramolecular’ Composite (Compound A9)

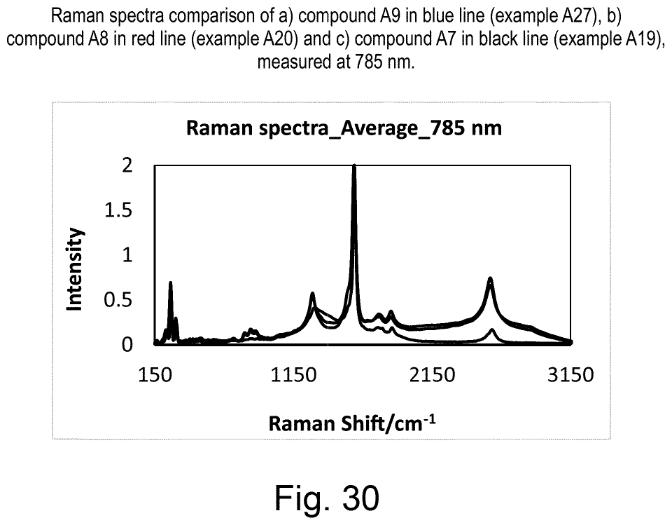

A27.1. Raman spectra comparison of a) compound A9 (example A27), b) compound A8 (example A20) and c) compound A7 (example A19), measured at 785 nm, was performed. See (FIG. 30).

In these comparative spectra, the structure of SWNTs is shown unmodified in both composite materials A8 and A9, showing that there is no interaction of the mechanical bond on the structure on nanotubes. Both composites (mechanical bonded and supramolecular bonded) present the same shift when compared to 6,5-SWNTs A7.

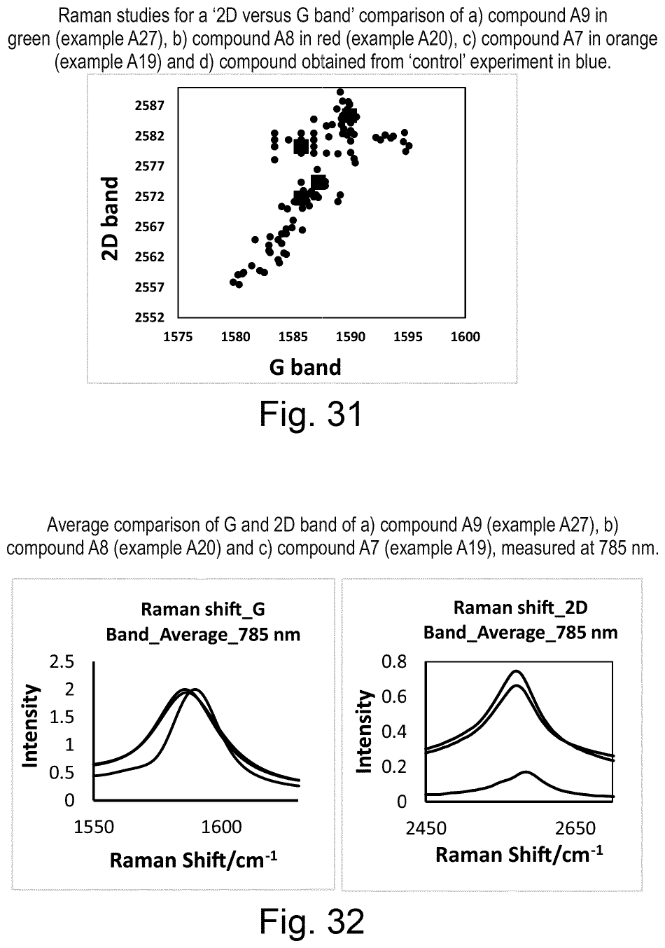

A27.2. Raman studies for a ‘2D versus G band’ comparison of a) compound A9 (example A27), b) compound A8 (example A20) and c) compound A7 (example A19) and d) compound obtained from ‘control’ experiment (example A24) was performed. See (FIG. 31).

Several Raman spectroscopic measurements (30 measurements for compound A8, compound obtained in example A24, compound A7 and last compound A9) have been performed. When the 2D versus G band are plotted, a similar tendency is observed of the points plotted for compounds A7 and ‘control’ compound obtained in example A24, indicating that without Grubbs catalyst and therefore the closure of rings around SWNTs surface the polymer is not efficiently attached around carbon nanotubes. This also further proves the efficient formation of composite A8, as in the same diagram, it shows a different tendency from both above-mentioned compounds. Last, the supramolecular compound A9 presents the same tendency with composite A8, as except for the different kind of attachement, they are composed of the same component materials.

A27.3. Average comparison of G and 2D band of a) compound A9 (example A27), b) compound A8 (example A20) and c) compound A7 (example A19), measured at 785 nm, was performed. See (FIG. 32).

Both composites (mechanical bonded and supramolecular bonded) present the same shift when compared to 6,5-SWNTs A7.

### Example A28. UV.Vis NIR Comparison Spectra

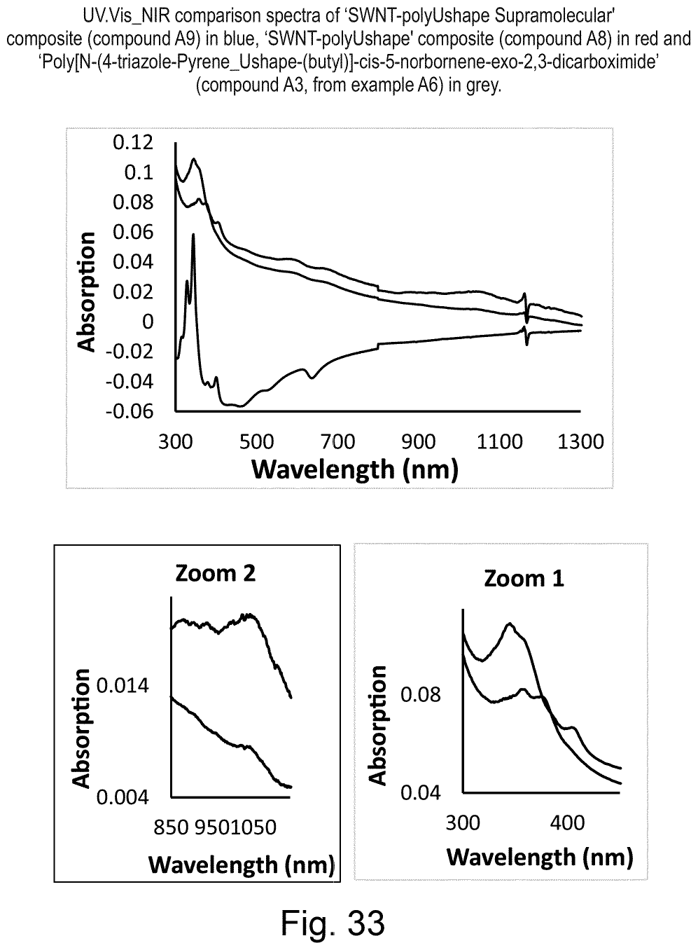

UV.Vis_NIR comparison spectra of ‘SWNT-polyUshape Supramolecular’ composite (compound A9) in blue, ‘SWNT-polyUshape’ composite (compound A8) in red and ‘Poly[N-(4-triazole-Pyrene_Ushape-(butyl)]-cis-5-norbornene-exo-2,3-dicarboximide’ (compound A3, from example A6) in grey are shown in (FIG. 33).

In these comparative spectra, the difference in absorption properties between compounds A9, A8 and A3 is studied. In the pyrene region, the characteristic bands of the pyrene in the supramolecular material A9 and polymer A3 were found in the same wavelength, whereas in the case of A8, these are red-shifted. This further confirms the closure of the rings of polymer A3 around the carbon nanotubes surface and therefore the formation of composite A8.

In the carbon nanotube region, the adequate bands of A9 are blue-shifted when compared to A8, showing the difference between the two materials as far as the interaction polymer/carbon nanotube is concerned.

### Example A29. HRTEM of ‘SWNT-polyUshape Supramolecular’ Composite (Compound A9)

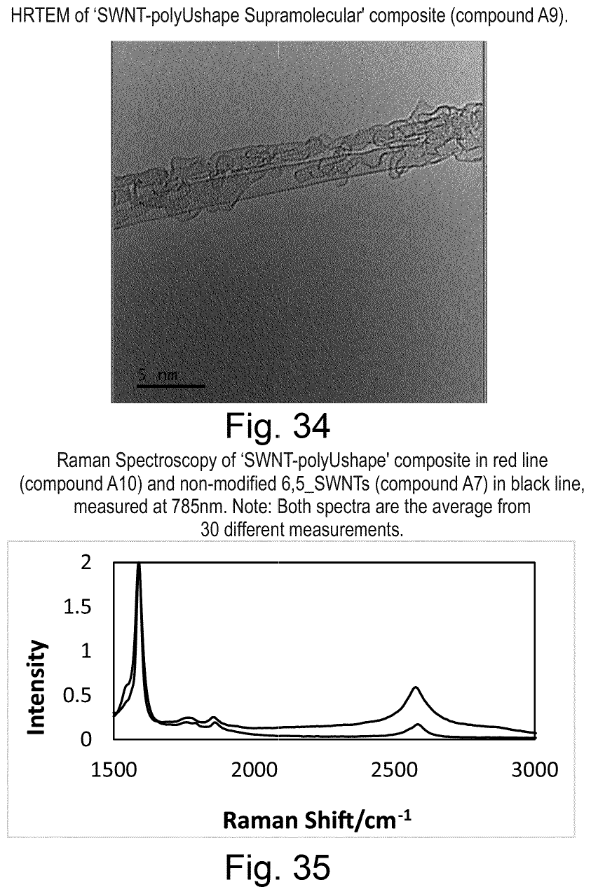

HRTEM of compound A9 shows that a considerable amount of polymer A3 is adsorbed on the surface of 6,5-SWNTs. The image is very different from that of Example A23.5. highlighting the difference between A8 (polymer and 6,5-SWNTs bonded through mechanical bonds) and A9 (polymer and 6,5-SWNTs bonded through supramolecular forces). Also, polymers A3 appear to be crystallized on the surface of A7. See (FIG. 34).

### Example A30. Synthesis of ‘SWNT-polyUshape’ composite (compound A10) with ‘Poly[N-(4-triazole-Pyrene Ushape-(butyl)]-cis-5-norbornene-exo-2,3-dicarboximide’ (compound A4, from example A11)

The synthesis of compound A9 is identical to the synthesis of compound A8 in example A20 but in this case ‘Poly[N-(4-triazole-Pyrene_Ushape-(butyl)]-cis-5-norbornene-exo-2,3-dicarboximide’ (compound A4, from example A11) was used.

### Example A31. Raman Spectroscopy of ‘SWNT-polyUshape’ Composite (Compound A10)

A31.1. Raman Spectroscopy of ‘SWNT-polyUshape’ composite (compound A10) and non-modified 6,5_SWNTs (compound A7), measured at 785 nm, is shown in (FIG. 35).

All the characteristic SWNTs peaks are observed, showing that the composite formation did not modify the structure of the 6,5-SWNTs (compound A7). The mechanical bonds did not interact with the carbon nanotube surface.

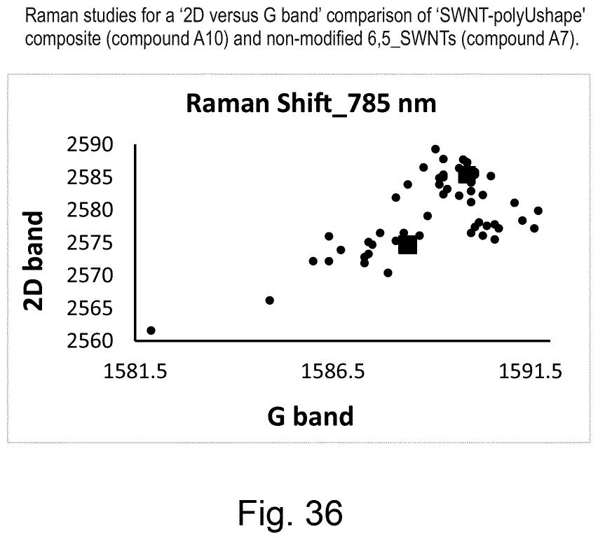

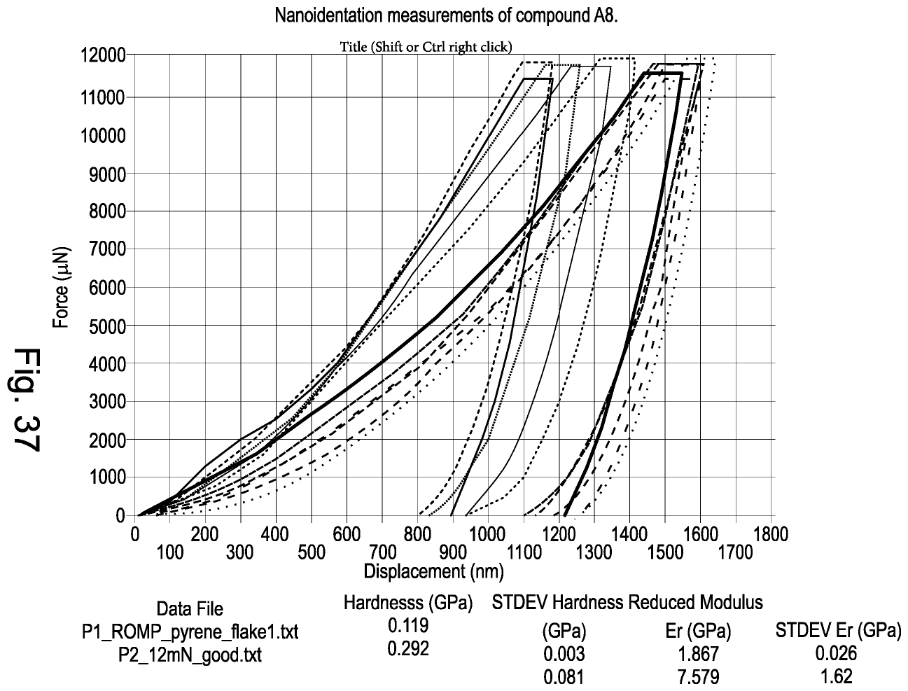

A31.2. Raman studies for a ‘2D versus G band’ comparison of ‘SWNT-polyUshape’ composite (compound A10) and non-modified 6,5_SWNTs (compound A7) is shown in (FIG. 36).

Several Raman spectroscopic measurements (30 measurements for both, compound A10 and A7) have been performed. When the 2D versus G band are plotted, a different tendency is observed of the points between the two materials showing that 6,5-SWNTs are modified by polymer A6.

### Example A32. Mechanical Stability Evaluation of ‘SWNT-polyUshape’ Composite (Compound A10) Through Nanoindentation Method (Example A9)

‘SWNT-polyUshape’ composite (compound A10), in powder form, was embedded into epoxy resin. It had higher density than epoxy resin, therefore the sample powder was dispersed on the bottom of the mould where resin was poured. Once the epoxy resin was cured at room temperature the face of the piece that contained the sample powder was ground with consecutively finer SiC papers, and finally polished with 3 and 1 μm diamond suspension to reach a surface finish suitable for nanoindentation. The indenter area function was determined using indents on a reference fused silica sample. All data were analysed with the Oliver and Pharr method. The hardness was calculated to be 0.292 GPa and the reduced modulus 7.579 GPa. See (FIG. 37).

### Example B1. Synthesis of the Precursor-ML

In this example, the synthesis of a precursor-ML, compound (J-1), is described. The precursor-ML is a linear molecule comprising two recognition motifs towards SWNTs and two terminal alkene functionalities that can react to turn the linear molecule into a closed ring structure around a SWNT. The recognition motifs used here are pyrenes.

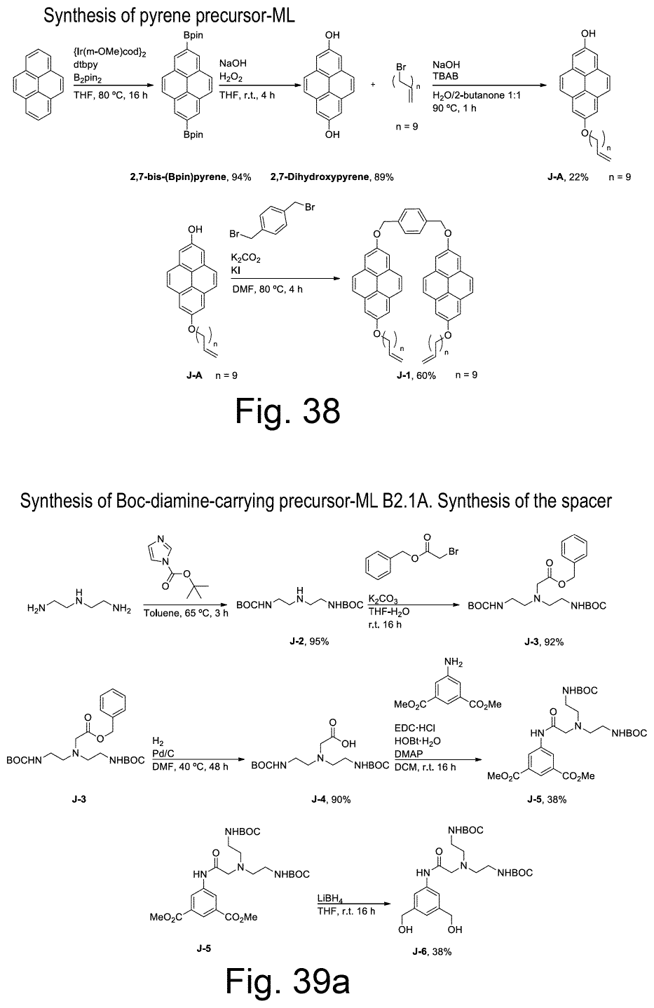

Compound (J-1) was synthesized as in López-Moreno et al. Chem. Commun. 2015, 51, 5421, DOI: 10.1039/C40008970G. The synthesis is performed in four linear steps, as depicted in (FIG. 38).

The first and second steps of this synthesis are reproduced from Ramdahl et al. Bioorg. Med. Chem. Lett. 2016, 26, 4318-4321.

Step 1. To obtain product (2,7-bis-(Bpin)pyrene), in a flask under nitrogen, [{Ir(m-OMe)cod}₂](0.060 g, 0.09 mmol), 4,4′-di-tert-butyl-2,2′-bipyridine (dtbpy, 0.048 g, 0.18 mmol), and B₂pin₂ (0.10 g, 0.39 mmol) were dissolved in THF (5 mL). The mixture was added to a flask containing pyrene (1.80 g, 8.90 mmol) and B₂pin₂ (4.86 g, 19.1 mmol). After addition of THF (10 mL), the reaction mixture was stirred for 16 h at 80° C. under nitrogen. After this time, the reaction mixture was passed through a 5 cm silica plug using CH₂Cl₂ as eluent and the solvent was removed under reduced pressure. The residue was washed with hexane to obtain (2,7-bis-(Bpin)pyrene) as a white solid; yield: 3.80 g (94%).

Step 2. To obtain compound (2,7-Dihydroxypyrene), compound (2,7-bis-(Bpin)pyrene) (0.50 g, 1.1 mmol) and NaOH (0.26 g, 6.5 mmol) were dissolved in THF (50 mL) and an aqueous solution of 30% H₂O₂ (2.00 mL, 6.5 mmol) was added to this mixture. After stirring at room temperature for 4 h, the solution was acidified with 1 M HCl until pH 1-2. The product was extracted with Et₂O (3×100 mL) and the organic fractions were dried over MgSO₄ (Caution: care must be taken to destroy all peroxides in the aqueous phase by stirring with aqueous H₂SO₄ and CuI). The solvent volume was reduced to about 10 mL under reduced pressure and the product was precipitated by addition of hexane (200 mL). Final filtration afforded compound (2,7-Dihydroxypyrene) as a light-brown solid; yield: 0.23 g (89%).

Step 3. To obtain compound (J-A), a mixture of the previously synthesized (2,7-Dihydroxypyrene), 11-bromo-1-undecene (0.46 mL, 2.1 mmol), NaOH (84 mg, 2.5 mmol) and tetrabutylammonium bromide (68 mg, 0.21 mmol) was stirred in a H₂O/2-butanone 1:1 mixture at 90° C. for 1 h. After this time, the reaction was quenched with HCl 1M and the organic phase extracted with EtOAc. The combined extracts were dried over MgSO₄, filtered, and concentrated. The mixture was purified by column chromatography using CH₂Cl₂ as eluent to afford compound (J-A) as a white solid; yield: 179 mg (22%).

The resulting product was termed “monoalkylated pyrene of Example B1” (compound J-A)

Step 4. To afford compound (J-1), monoalkylated pyrene (compound (J-A)), (150 mg, 0.39 mmol) was dissolved in dry N,N-dimethylformamide (15 mL). To this solution, dry K₂CO₃ (221 mg, 1.6 mmol), α,α′-Dibromo-p-xylene (53 mg, 0.20 mmol) and KI (3.3 mg, 0.02 mmol) were added. The mixture was stirred at 80° C. for 4 h. After this time, the crude reaction was poured into ice-cold 1 M HCl and filtrated. The filtered product was washed with MeOH and Et₂O to afford compound (J-1) as a light brown solid; yield: 105 mg (60%).

The resulting product was termed “pyrene precursor-ML of Example B1” (compound J-1).

### Example B2. Synthesis of the Boc-Diamine-Carrying Precursor-ML

This example describes the synthesis of a precursor-ML carrying two amine groups for covalent attachment to e.g. a polymer in a composite material. The precursor-ML is a linear molecule comprising of two recognition motifs towards SWNTs and two terminal alkene functionalities that react forming a closed ring structure around the SWNT.

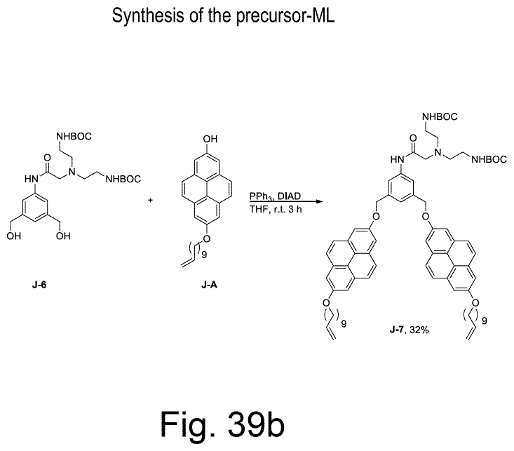

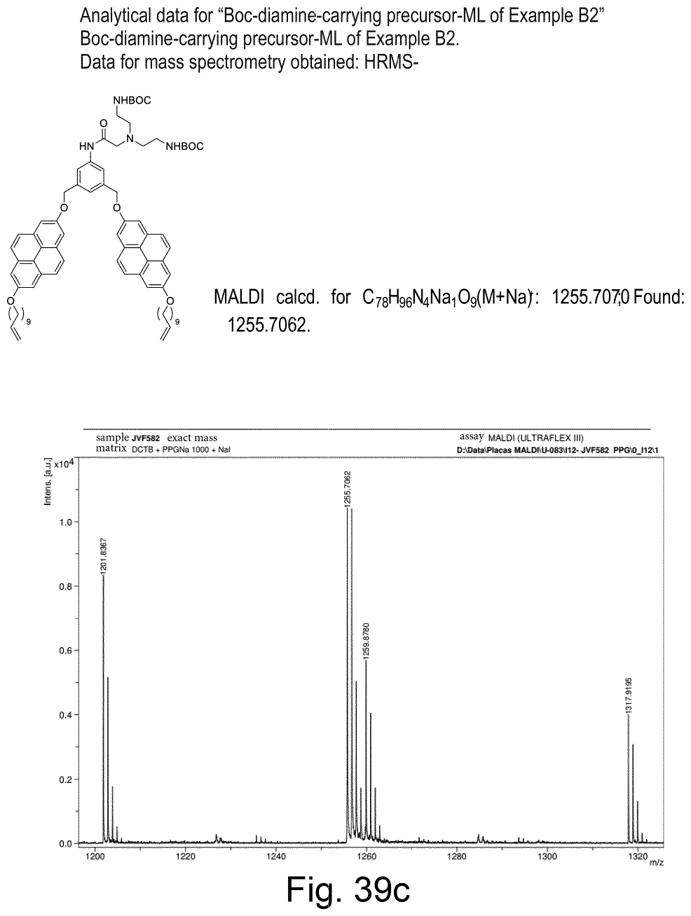

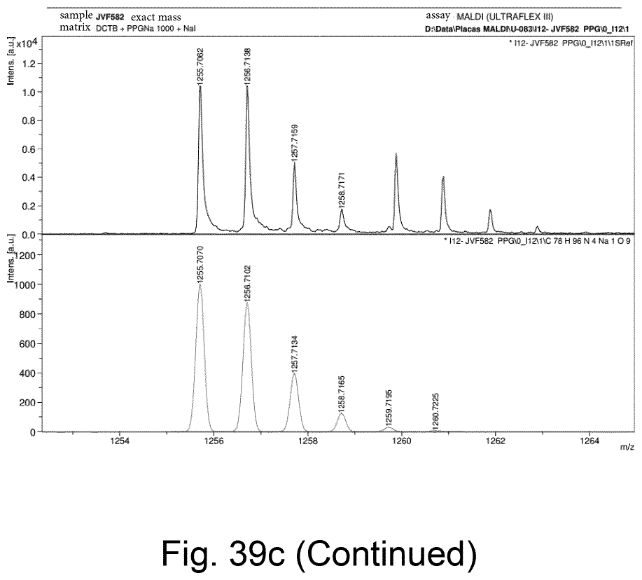

The synthesis is divided in three steps; 1) Synthesis of the pyrene-derived recognition motif (monoalkylated pyrene of Example 1 (Compound (J-A)). 2) Synthesis of a spacer molecule (Compound (J-6), FIG. 39a). 3) Synthesis of Boc-diamine-carrying precursor-ML (Compound (J-7) (FIG. 39b).

Step 1: The monoalkylated pyrene of Example 1 (Compound (J-A)) was synthesized as described in Example 1, Steps 1 to 3.

Step 2: The spacer, compound (J-6), was synthesized as depicted in (FIG. 39a):

The first part of this synthesis is reproduced from Ramdahl et al. Bioorg. Med. Chem. Lett. 2016, 26, 4318-4321, DOI: 10.1016/j.bmcl.2016.07.034. (Boc)₂O (4.5 g, 20.5 mmol) was added in portions to a solution of imidazole (1.5 g, 22.0 mmol) in dry dichloromethane (8 mL) at room temperature. The mixture was stirred for 1 h at room temperature. After this time, the volatiles were removed under reduced pressure, giving Boc-imidazole. The freshly made Boc-imidazole was dissolved in dry toluene (10 mL), commercially available diethylenetriamine (1.1 mL, 10.2 mmol) was added and the mixture was stirred at 60° C. for 2 h. It was then cooled to room temperature, diluted with dichloromethane, washed with water and dried over Na₂SO₄. The crude was concentrated by rotary evaporation, and purification using column chromatography CH₂Cl₂/MeOH (95:5) afforded compound (J-2) as a colourless solid; yield: 2.9 g (95%).

Compounds (J-3) and (J-4) were synthesized as in Ndinguri et al. Inorg. Chim. Acta 2010, 363, 1796-1804, DOI: 10.1016/j.ica.2010.02.027. A solution of (J-2) (2.7 mg, 8.7 mmol) in 25 mL of THF—H₂O (25:1) was treated with a solution of benzyl 2-bromoacetate (3.0 g, 13 mmol) and K₂CO₃ (1.2 g, 8.7 mmol) in 15 mL of THF—H₂O (25:1) and stirred at 25° C. for 12 h. Then the crude was extracted with EtOAc. The combined organic phases were washed with brine, dried and concentrated under vacuum to afford (J-3) as a pale yellow solid; yield: 3.6 g (92%).

To obtain compound (J-4), to a solution of (J-3) (4.7 g, 10 mmol) in DMF (50 mL), Pd/C (10%, 0.47 g) dissolved in an additional 10 mL DMF was added. The mixture was stirred at room temperature for 12 h under H₂ atmosphere. After this time, it was filtered through Celite and washed with methanol. The solvent was removed under reduced pressure, and crystallization in a methanol/Et₂O mixture afforded the final product (J-4) as a white solid; yield: 3.3 mg (90%).

To obtain compound (J-5), a mixture of (J-4) (227 mg, 0.63 mmol), dimethyl 5-aminoisophthalate (144 mg, 0.69 mmol) and 4-dimethylaminopyridine (462 mg, 3.8 mmol) was dissolved in dichloromethane (10 mL) and cooled to 0° C. HOBt (188 mg, 1.4 mmol) and EDC (266 mg, 1.4 mmol) were added and the reaction mixture was allowed to warm up to room temperature by stirring overnight. Next day, the reaction was extracted with HCl 0.5 M and the crude obtained was purified on a column in CH₂Cl₂/MeOH (95:5) to afford (J-5) as a white solid; yield: 133 mg (38%).

Finally, to a solution of (J-5) (133 mg, 0.24 mmol) in THF (10 mL) at −78° C. was added dropwise LiBH₄ (2M in THF, 0.5 mL, 1.0 mmol). The reaction mixture was stirred at −78° C. for 10 min and then it was allowed to warm to room temperature during 3 h. The reaction mixture was stirred overnight under reflux. After this time, excess reactants were consumed by the addition of saturated NH₄Cl. The organic phase was extracted with CH₂Cl₂. The combined organic phases were washed with brine, dried and concentrated under vacuum. The crude obtained was purified by column chromatography using a CH₂Cl₂/MeOH (9:1) mixture as eluent to afford (J-6) as a white solid; yield: 45 mg (38%).

Step 3: To obtain the Boc-diamine-carrying precursor-ML (compound (J-7)), compound (J-6) (718 mg, 1.5 mmol) was dissolved in THF (5 mL). Compound (J-A) (2.0 g, 5.8 mmol) and triphenylphosphine (761 mg, 2.9 mmol) were added. The mixture was stirred for 15 min at room temperature and diisopropyl azodicarboxylate (586 mg, 2.9 mmol) dissolved in THF (1.6 mL) was added. The reaction mixture was allowed to stir for 3 h at room temperature. The crude was then concentrated under vacuum. Purification by column chromatography using an hexane/EtOAc (1:1) mixture as eluent afforded (J-7) as a light yellow solid; yield: 24 mg (32%). This product was termed “Boc-diamine-carrying precursor-ML of Example B2” (compound J-7). Analytical data for the final product is shown in FIG. 39c.

### Example B3. Purification of Single-Walled Carbon Nanotubes

This example describes the purification of SWNTs.

50 mg of SWNTs purchased from Sigma-Aldrich (Product number: 773735) were suspended in 34 mL of 35% HCl. The mixture was sonicated for 15 min. Then, it was poured into 100 mL of milliQ water and filtered through a 0.2 μm-pore size polycarbonate membrane. The solid was sonicated again in 100 mL milliQ water and filtered in the same way. This step was repeated until the filtered water had approximately neutral pH. Then, the single-walled carbon nanotubes were dried in an oven at 350° C. for 30 min.

The resulting product is termed “SWNTs of Example B3”.

### Example B4. Ring-Closing of a Macrocycle Around Single-Walled Carbon Nanotubes

In this example, a nanotube-ML complex is formed. The precursor-ML binds first to the nanotube and its two ends are reacted to form a closed ring around the nanotube. The nanotube is a single-wall carbon nanotube (SWNT), the precursor-ML is a linear molecule and the mechanical ligand (ML) is a covalently closed ring structure comprising pyrenes, recognition motifs for carbon nanotubes.

Step 1. 20 mg “SWNTs of Example B3”, i.e. purified SWNTs, were dispersed in tetrachloroethane (TCE, 20 mL, 1 mg/mL) by sonication in a bath sonicator (10 min).

Step 2. To this dispersion, the “pyrene precursor-ML of Example 1” (compound (J-1)) (11 mg, 0.013 mmol) was added.

Step 3. The mixture was degassed with N₂ and Grubbs' second-generation catalyst was added (11 mg, 0.013 mmol, 1 equiv. with respect to compound (J-1)).

Step 4. The reaction is maintained for 72 h at room temperature, allowing the ring-closing metathesis reaction to take place.

Step 5. After this time, the suspension was filtered through a 0.2 μm-pore size polytetrafluoroethylene (PTFE) membrane. The solid obtained was removed from the filter and washed with dichloromethane employing 10 min sonication. This cleaning procedure was repeated three times, until the filtration solvent was completely colourless. A final wash with Et₂O was performed and the product was dried at 100° C. for 15 min.

Step 6. TGA and spectroscopy confirmed that the solid retained by the filter after the vigorous washing procedure consisted of single-walled carbon nanotubes (SWNT) with cyclic molecules closed around them.

The analyses indicated that on average, hundreds of rings were wrapped around one SWNT.

The resulting product, SWNTs with covalently closed ring structures around them is termed “SWNT-ML of Example B4”.

The procedure described in this example was applied to the generation of a number of different ML-SWNT complexes, as described in the following examples.

### Example B5. Synthesis of a ML-SWNT Complex Carrying Two Boc-Protected Terminal Amine Groups

In this example it is described how to prepare a SWNT-ML complex carrying two terminal Boc-protected amines that may be used for attachment to e.g. a polymer in a composite material.

For the synthesis, Steps 1 to 5 in Example B4 were followed, except that in Step 2 the “Boc-diamine-carrying precursor-ML of Example B2” (compound (J-7)) (16 mg, 0.013 mmol) was added instead of compound (J-1).

The resulting product, SWNT complexed with a covalently closed ring structure that carries two Boc-protected primary amines, is termed “SWNT-ML-Boc-diamine of Example B5”.

### Example B6. Synthesis of a ML-SWNT Complex Carrying Two Terminal Amine Groups

In this example, the deprotection of the terminal amines of “SWNT-ML-Boc-diamine of Example B5” is described.

To remove the Boc protecting group, the “SWNT-ML-Boc-diamine of Example B5” (40 mg) was dispersed in a 35% HCl:EtOAc (1.3 mL/5 mL) mixture by stirring first at room temperature for 30 min, then in an ice bath for 15 min. The sample was further sonicated for 1 min to obtain a suspension that was then filtered through a 0.2 μm-pore size polycarbonate membrane (Whatman). The filter cake was successively washed with EtOAc, acetone, and milliQ water. Then, it was dispersed in milliQ water (15 mL) by sonication (1 min) and 1 drop of aq. NaHCO₃ (5%) was added. This final MINT suspension with pH=7-8 was further filtered through a 0.2 μm-pore size polycarbonate membrane. The filter cake was successively washed with milliQ water and acetone. It was then dried in an oven at 150° C. for 30 min.

The resulting product, a SWNT complexed with a covalently closed ring structure that carries two primary amines, is termed “SWNT-ML-diamine of Example B6”.

### Example B24.1. Formation of Macrocyclic Molecule Around a Single-Walled Carbon Nanotube by Ring-Closing of a Linear Molecule Comprising Bisphenol A (BPA) Motifs

In this example, nanotube-ML complex is formed, by first binding a precursor-ML to the nanotube, and then reacting to the two ends of the precursor-ML to form a closed ring around the nanotube. The nanotube is a single-wall carbon nanotube (SWNT), the precursor-ML is a linear molecule, and the mechanical ligand (ML) is a covalently closed ring structure comprising bisphenol A (BPA) motifs.

Step 1. 10 mg single-walled carbon nanotubes, purchased from Sigma-Aldrich ((6,5) chirality, ≥95% carbon basis (≥95% as carbon nanotubes), 0.78 nm average diameter), purified according to example B3, were dispersed in 10 ml tetrachloroethane (TCE) by sonication in a bath sonicator.

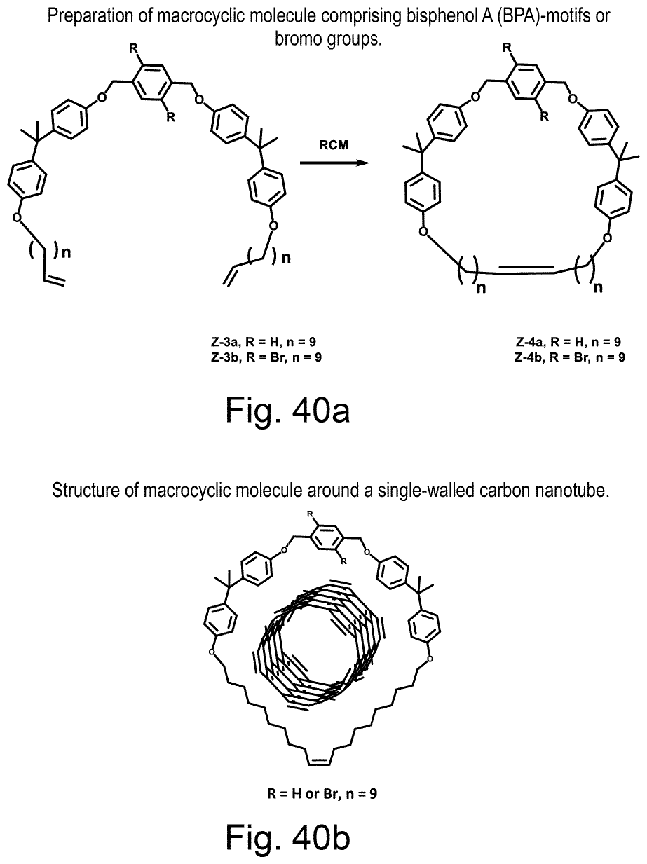

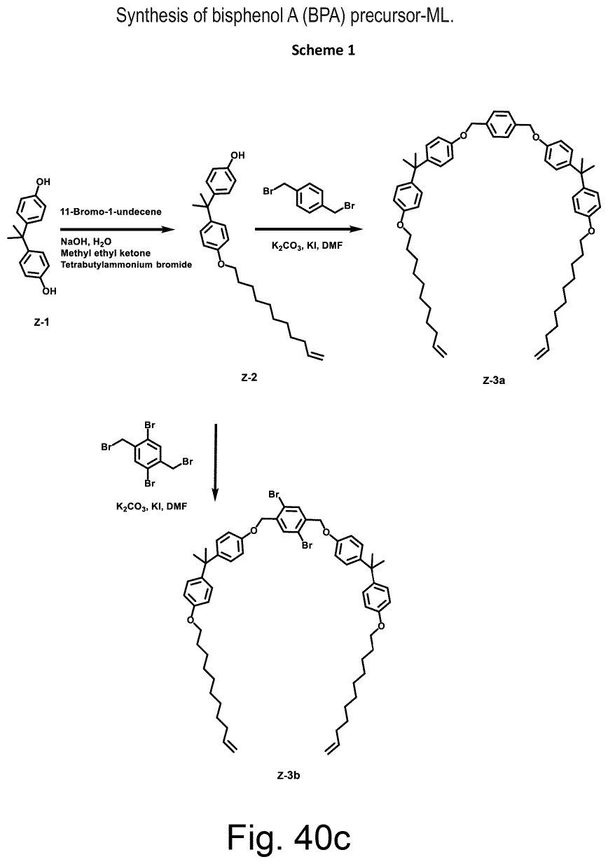

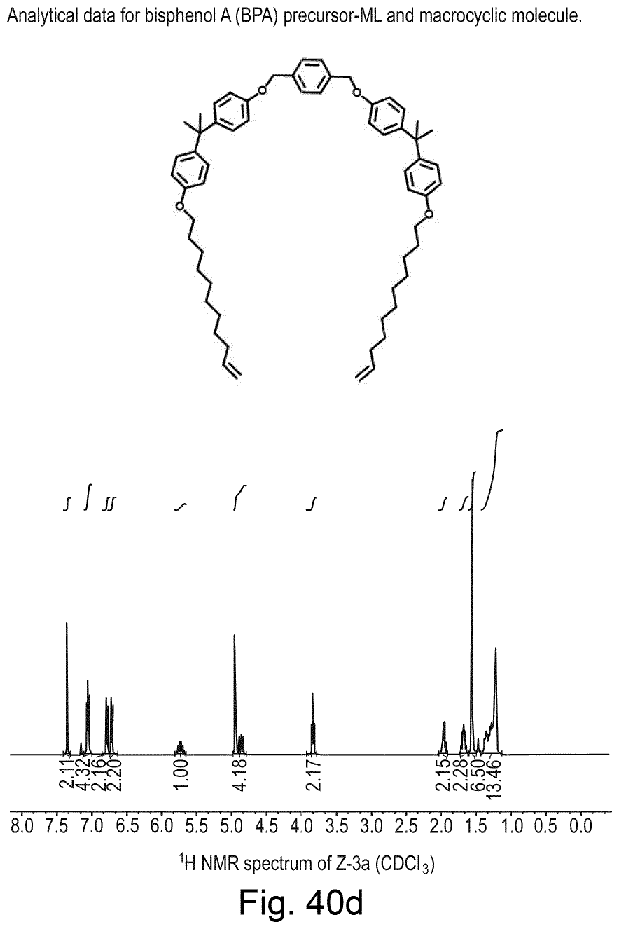

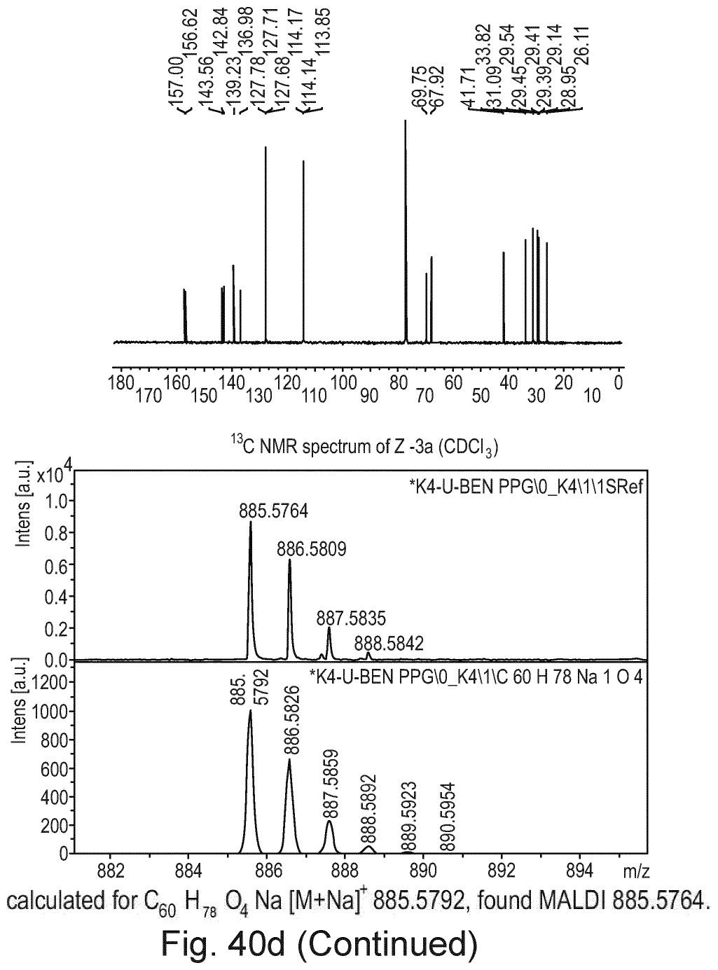

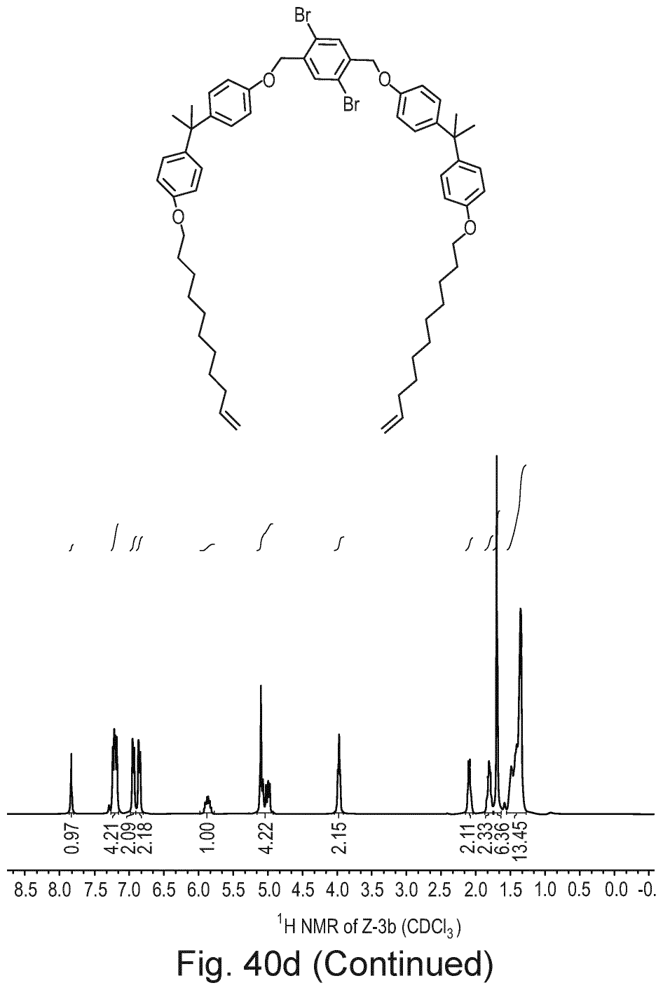

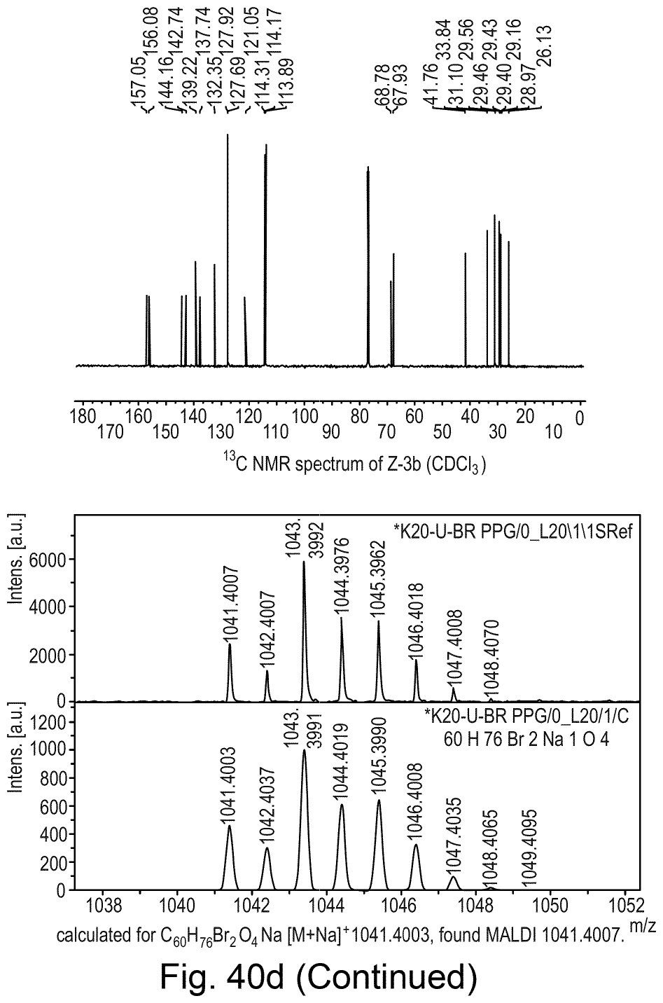

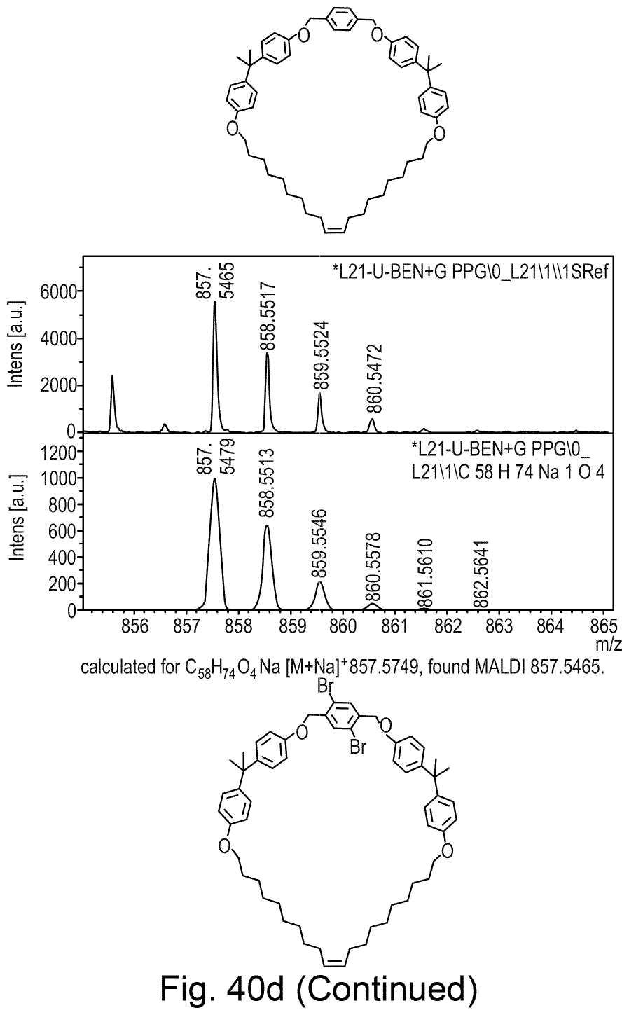

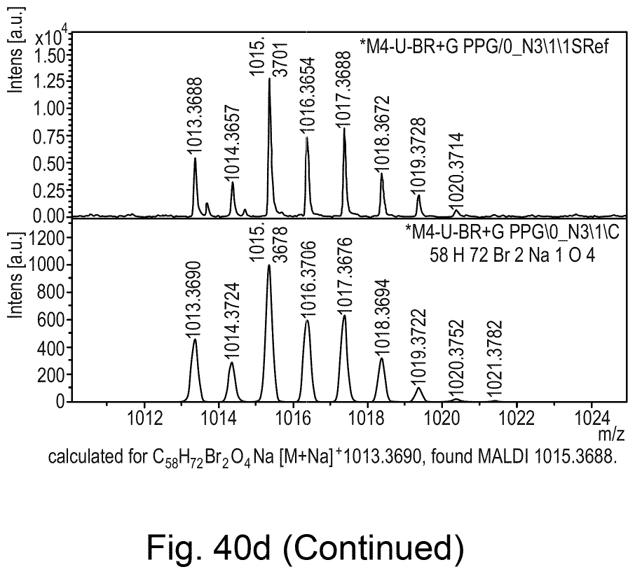

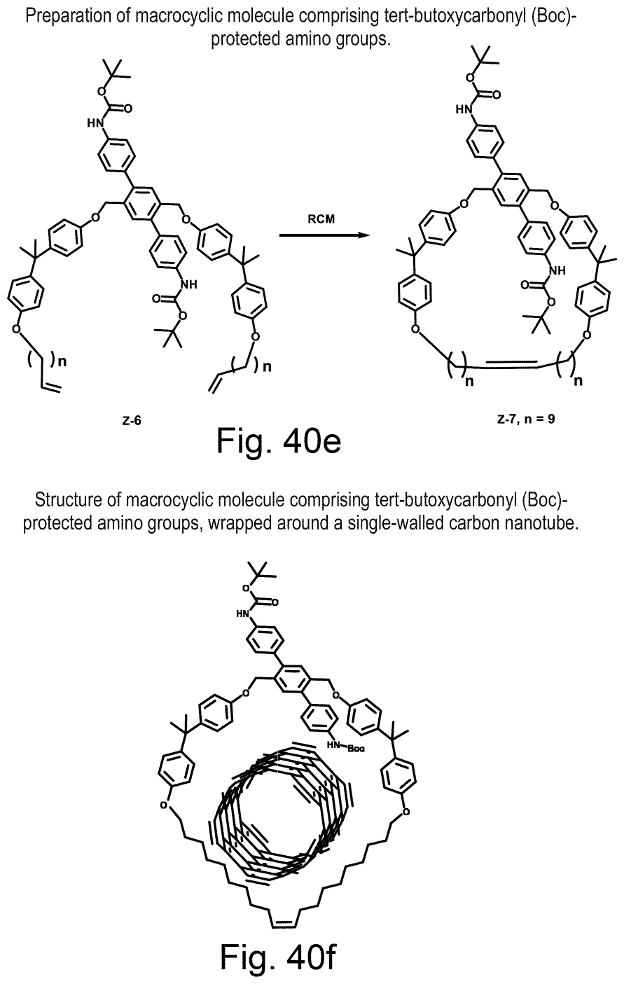

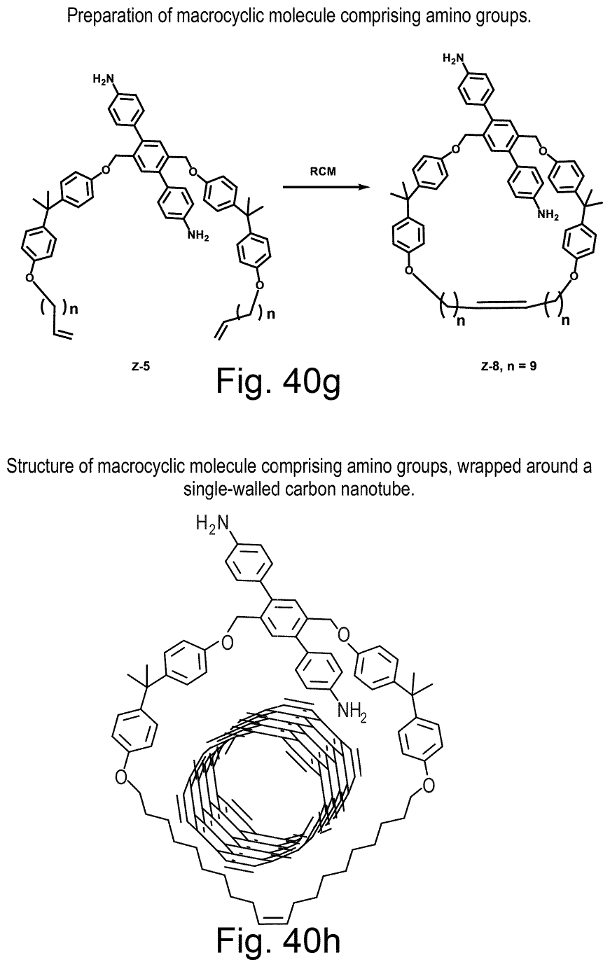

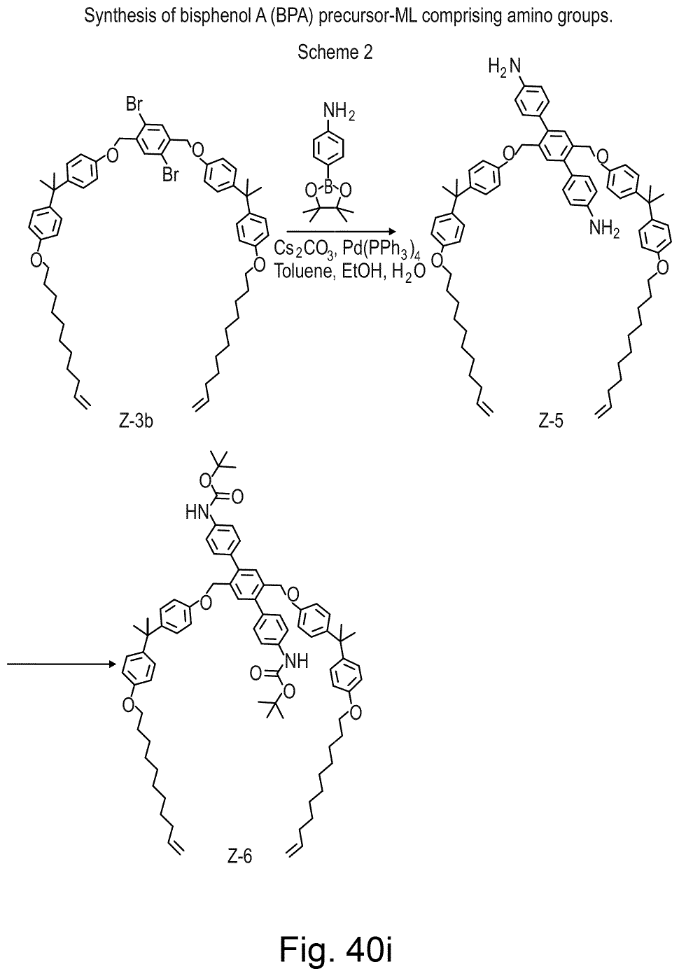

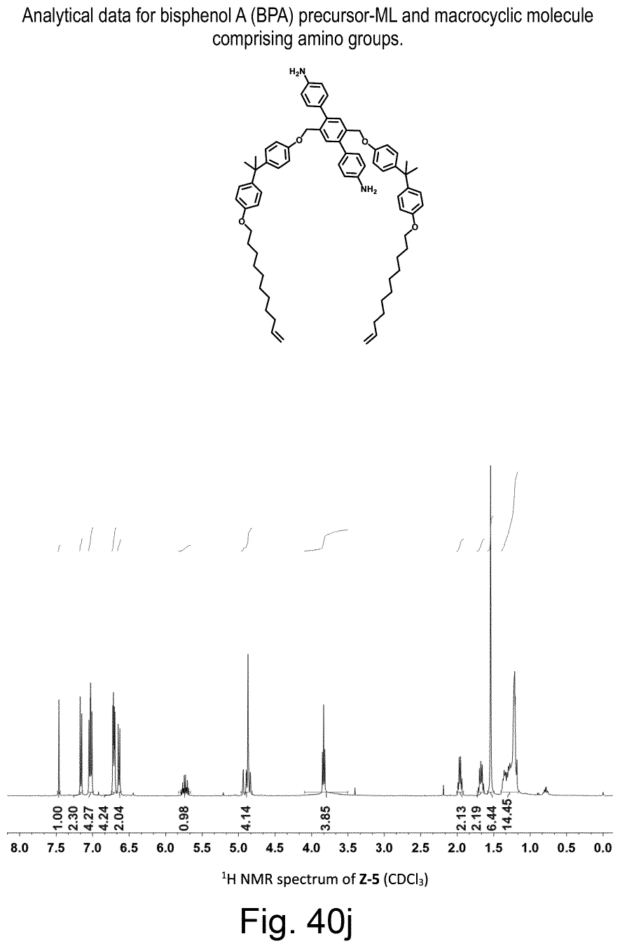

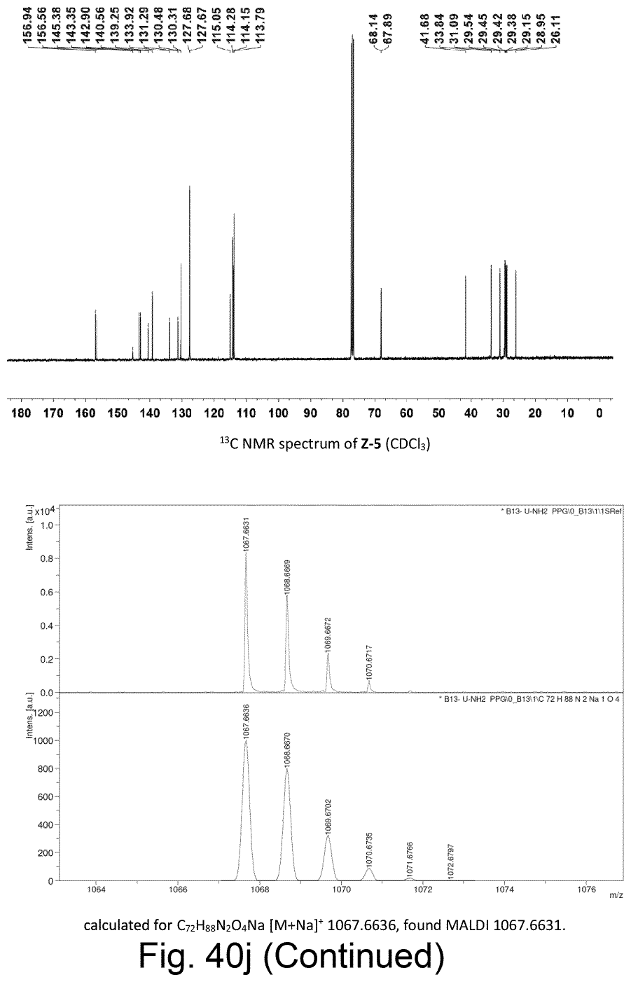

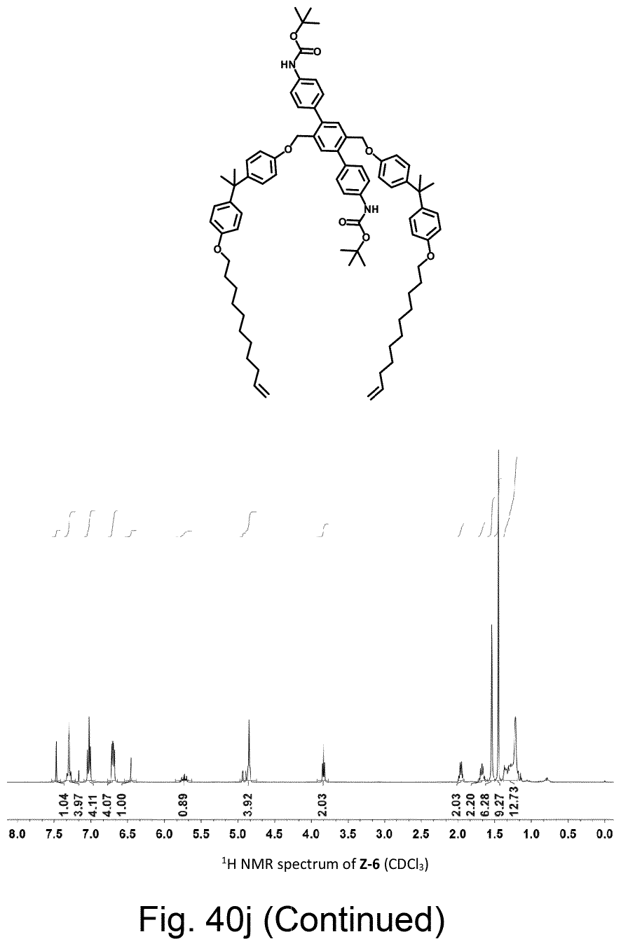

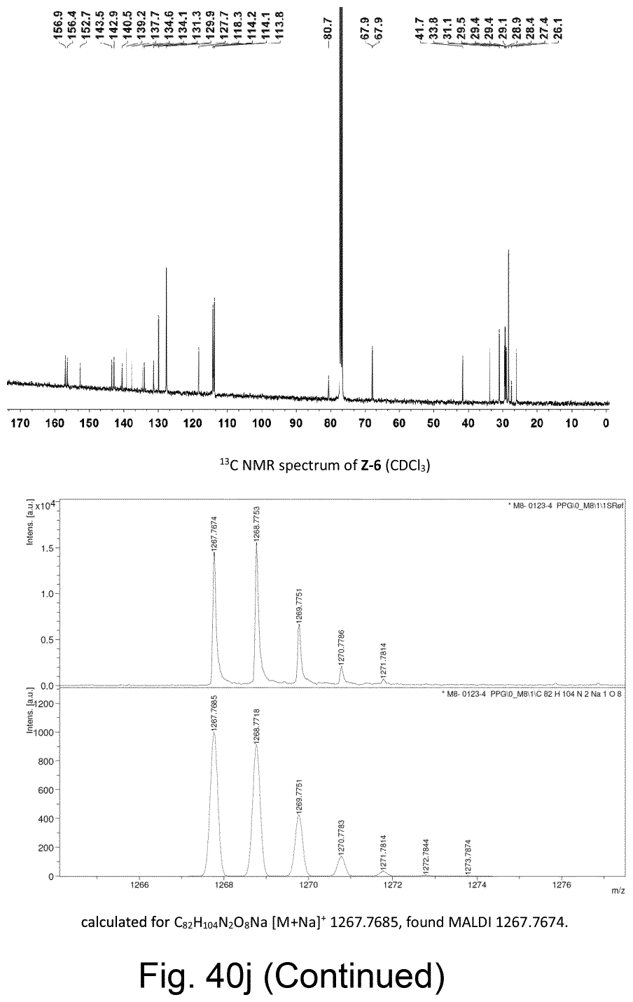

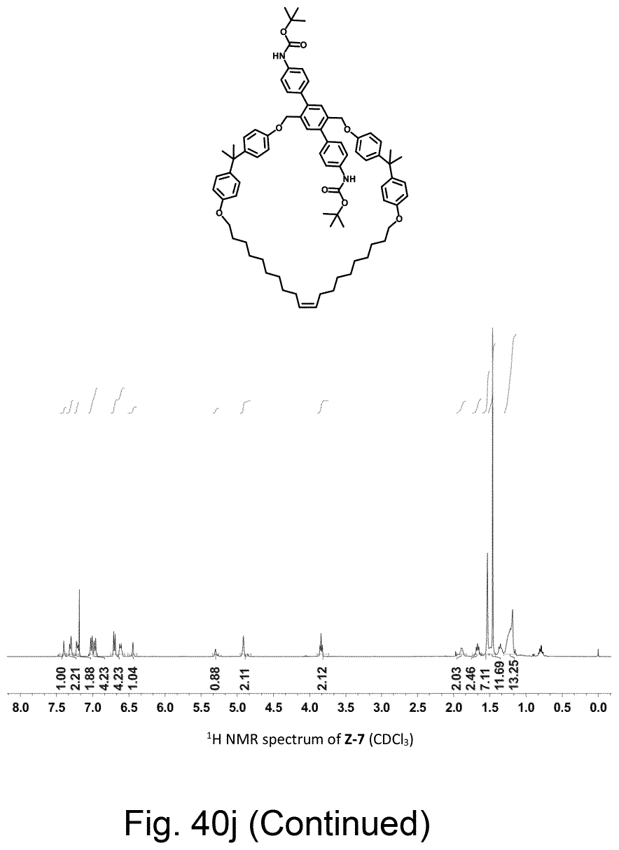

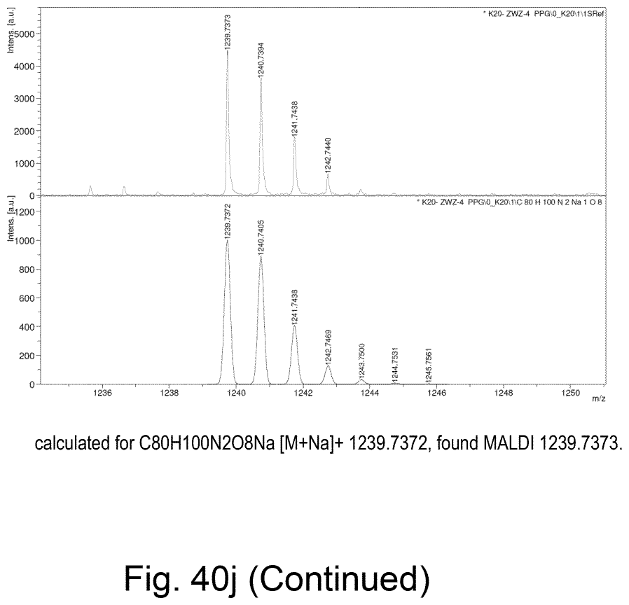

Step 2. The suspension of step 1 was mixed with 0.01 mmol compound Z-3a (a linear molecule), shown in FIG. 40a (where n=9). See Example B24.3 for synthesis of compound Z-3a.

Step 3. The mixture was bubbled with nitrogen (N₂) for 10 minutes.

Step 4. 0.01 mmol Grubb's second-generation catalyst was added to the mixture at room temperature.

Step 5. The reaction was stirred for 72 hours at 40° C. under nitrogen (N₂).

Step 6. The suspension was filtered through a 0.2 μm pore-size polytetrafluoroethylene (PTFE) membrane and washed profusely with dichloromethane (DCM).

Step 7. The solid was removed from the filter, sonicated for 10 minutes in 10 ml DCM and filtered through a 0.2 μm PTFE membrane. This washing procedure was repeated three times, to remove unreacted precursor-MLs, non-interlocked macrocycles, and remaining catalyst. The resulting product, single-walled carbon nanotubes (SWNTs) with cyclic molecules closed around them, is depicted in FIG. 40b. Thermogravimetric analysis (TGA) confirmed the successful functionalization. The cyclic molecule that forms a ring around the SWNT is called compound Z-4a. The SWNTs with cyclic molecules closed around them were named “SWNT-compound Z-4a complexes of Example B24.1”.

### Example B24.2. Formation of Macrocyclic Molecule Around a Single-Walled Carbon Nanotube by Ring-Closing of a Linear Molecule Comprising Bisphenol A (BPA) Motifs and Bromo Groups

In this example, a nanotube-ML complex is formed, by first binding a precursor-ML to the nanotube, and then reacting the two ends of the precursor-ML to form a closed ring around the nanotube. The nanotube is a single-wall carbon nanotube (SWNT), the precursor-ML is a linear molecule, and the mechanical ligand (ML) is a covalently closed ring structure comprising bisphenol A (BPA) motifs and bromo groups.

The procedure is similar to that described for Example B24.1, except that the linear precursor Z-3b was used in step 2.

Step 1. 10 mg single-walled carbon nanotubes, purchased from Sigma-Aldrich ((6,5) chirality, ≥95% carbon basis (≥95% as carbon nanotubes), 0.78 nm average diameter), purified according to example B3, were dispersed in 10 ml tetrachloroethane (TCE) by sonication in a bath sonicator.

Step 2. The suspension of step 1 was mixed with 0.01 mmol compound Z-3b (a linear molecule), shown in FIG. 40a (where n=9). See Example B24.3b for synthesis of compound Z-3b.

Step 3. The mixture was bubbled with nitrogen (N₂) for 10 minutes.

Step 4. 0.01 mmol Grubbs second-generation catalyst was added to the mixture at room temperature.

Step 5. The reaction was stirred for 72 hours at 40° C. under nitrogen (N₂).

Step 6. The suspension was filtered on a 0.2 μm pore-size polytetrafluoroethylene (PTFE) membrane and the solid that stayed on the filter was washed profusely with dichloromethane (DCM).

Step 7. The solid was removed from the filter, sonicated for 10 minutes in 10 ml DCM and filtered through a 0.2 μm PTFE membrane. This washing procedure was repeated three times, to remove unreacted precursor-MLs, non-interlocked macrocycles, and remaining catalyst. The resulting complex of a single-walled carbon nanotube (SWNT) with a cyclic molecule closed around it is depicted in FIG. 40b. Thermogravimetric analysis (TGA) confirmed the successful functionalization. The cyclic molecule that forms a ring around the SWNT is called compound Z-4b.

The SWNTs with cyclic molecules closed around them were named “SWNT-compound Z-4b complexes of Example B24.2”.

### Example B24.3. Preparation of Precursor-MLs that can Ring-Close Around Nanotubes is Described. Ring-Closing Reactions are Also Described

### Example B24.3.a. Preparation of Compound Z-3a and Z-4a

Step 1. Bisphenol A (1) (25.2 mmol), sodium hydroxide (NaOH, 25.2 mmol) and 11-bromo-1-undecene (27 mmol) were added to a mixture of water/butanone (100 ml/100 ml). The reaction was stirred for 1 hour at 80° C. Monoalkylated compound Z-2 was obtained in 57% yield after column chromatography on silica gel. See FIG. 40c.

Step 2. Potassium carbonate (K₂CO₃) (5 mmol), potassium iodide (KI) and 1,4-bis-bromomethyl-benzene (1.5 mmol) were added to a solution of monoalkylated compound Z-2 (3.9 mmol) in 40 ml dry N, N-Dimethylformamide (DMF). The reaction was stirred for 20 hours at 80° C. under nitrogen (N₂). Compound Z-3a was obtained in 28% yield after column chromatography on silica gel. See FIG. 40c.

Step 3. Macrocyclic compound Z-4a was obtained by ring-closing reaction with Grubbs second-generation catalyst in dichloromethane (DCM) under refluxing. See FIG. 40a.

Analytical data of the final products Z-3a and Z-4a are shown in FIG. 40d.

### Example B24.3.b. Preparation of Compound Z-3b and Z-4b

The procedure is similar to that described for the synthesis of Example B24.3.a., except that 1,4-Dibromo-2,5-bis(bromomethyl)benzene was used instead of 1,4-bis-bromoethyl-benzene in step 2.

Step 1. Bisphenol A (1) (25.2 mmol), Sodium hydroxide (NaOH, 25.2 mmol) and 11-bromo-1-undecene (27 mmol) were added to a mixture of water/butanone (100 ml/100 ml). The reaction was stirred for 1 hour at 80° C. Monoalkylated compound Z-2 was obtained in 57% yield after column chromatography on silica gel.

Step 2. Potassium carbonate (K₂CO₃) (7.2 mmol), potassium iodide (KI) and 1,4-Dibromo-2,5-bis(bromomethyl)benzene (2.5 mmol) were added to a solution of monoalkylated compound Z-2 (6.3 mmol) in 35 ml dry N,N-dimethylformamide (DMF). The reaction was stirred for 20 hours at 80° C. under nitrogen (N₂). Compound Z-3b was obtained in 47% yield after column chromatography on silica gel. See FIG. 40c.

Step 3. Macrocyclic compound Z-4b was obtained by ring-closing reaction with Grubbs second-generation catalyst in dichloromethane (DCM) under refluxing. See FIG. 40a.

Analytical data of the final product Z-3b and Z-4b were shown in FIG. 40d.

### Example B24.4. Formation of a Covalently Closed Ring Around a Single-Walled Carbon Nanotube, where the Ring Carries Amino Groups for Linking to e.g. A Polymer

In this example, a SE-ML-Linker complex was formed, by first binding a precursor-ML to the SE1, and then reacting the two ends of the precursor-ML to form a closed ring around the SE1. SE1 is a single-wall carbon nanotube (SWNT), the precursor-ML is a linear molecule, and the mechanical ligand (ML) is a closed ring structure comprising bisphenol A (BPA) motifs that bind to SWNT. The linker comprises an amino group for reaction with e.g. a polymer molecule.

### Example B24.4.a. Preparation of Compound Z-8 Around SWNT from Compound Z-6

The procedure is similar to that described for Example B24.1, except that an additional step (step 8) was introduced for the deprotection of the tert-butyloxycarbonyl (BOC) protected amine.

Step 1. 10 mg single-walled carbon nanotubes, purchased from Sigma-Aldrich ((6,5) chirality, ≥95% carbon basis (≥95% as carbon nanotubes), 0.78 nm average diameter), purified according to example B3, were dispersed in 10 ml tetrachloroethane (TCE) by sonication in a bath sonicator.

Step 2. The suspension of step 1 was mixed with 0.01 mmol compound Z-6 (a linear molecule). See FIG. 40e (where n=9). See Example B24.5 for synthesis of compound Z-6.

Step 3. The mixture was bubbled with nitrogen (N₂) for 10 minutes.

Step 4. 0.01 mmol Grubb's second-generation catalyst was added to the mixture at room temperature.

Step 5. The reaction was stirred for 72 hours at 40° C. under nitrogen (N₂).

Step 6. The suspension was filtered through a 0.2 μm pore-size polytetrafluoroethylene (PTFE) membrane and washed profusely with dichloromethane (DCM).

Step 7. The solid was removed from the filter, sonicated for 10 minutes in 10 ml DCM and filtered through a 0.2 μm PTFE membrane. This washing procedure was repeated three times, to remove unreacted precursor-MLs, non-interlocked macrocycles, and remaining catalyst. The resulting single-walled carbon nanotube (SWNTs) with a cyclic molecule (compound Z-7) closed around it is depicted in FIG. 40f.

Step 8. The tert-butoxycarbonyl (Boc) unit was then removed to generate the amine by acid hydrolysis in hydrochloric acid (1 M), to form compound Z-8 (FIG. 40g) around SWNTs (FIG. 40h). Thermogravimetric analysis (TGA) confirmed the successful functionalization. The resulting SWNTs with cyclic molecules closed around them were named “SWNT-compound Z-8 complexes of Example B24.4a”.

### Example B24.4.b Preparation of Compound Z-8 Around SWNT from Molecule Z-5

The procedure is similar to that described for Example B24.4.a, except that compound Z-5 is used instead of compound Z-6 in step 2, and Schrock's catalyst is used in step 2 for the ring-closing reaction instead of Grubbs second-generation catalyst. See Example B24.5 for synthesis of compound Z-6.

Step 1. 10 mg single-walled carbon nanotubes, purchased from Sigma-Aldrich ((6,5) chirality, ≥95% carbon basis (≥95% as carbon nanotubes), 0.78 nm average diameter), purified according to example B3, were dispersed in 10 ml tetrachloroethane (TCE) by sonication in a bath sonicator.

Step 2. The suspension of step 1 is mixed with 0.01 mmol compound Z-5 (a linear molecule), shown in FIG. 40g (where n=9).

Step 3. The mixture was bubbled with nitrogen (N₂) for 10 minutes.

Step 4. Schrock's catalyst (2,6-Diisopropylphenylimidoneophylidene molybdenum(VI) bis(hexafluoro-t-butoxide), CAS Number: 139220-25-0) was added to the mixture at room temperature.

Step 5. The reaction was stirred for 72 hours at 40° C. under nitrogen (N₂).

Step 6. The suspension was filtered through a 0.2 μm pore-size polytetrafluoroethylene (PTFE) membrane and washed profusely with dichloromethane (DCM).

Step 7. The solid is removed from the filter, sonicated for 10 minutes in 10 ml DCM and filtered through a 0.2 μm PTFE membrane. This washing procedure was repeated three times. The resulting single-walled carbon nanotubes (SWNT) with cyclic molecules (compound Z-8) closed around them are called “SWNT-compound Z-8 complexes of Example B24.4b”. The SWNT-compound Z-8 complex is depicted in FIG. 40h.

The terminal amino group can be used for linking to e.g. a polymer, by the formation of a covalent bond. Modification of the terminal amino group with different functional groups can also control the dispersibility of the SE-ML-Linker complex in different solvents, such as water, methanol, ethanol, acetonitrile, and benzene.

### Example B24.5. Preparation of Linear Precursor-MLs (Compound Z-5, Z-6), and of the Macrocyclic Compound Z-7

Step 1. Compound Z-5 was prepared by Suzuki coupling from Z-3b and 4-aminophenylboronic acid pinacol ester, shown in FIG. 40i (Scheme 2). Z-3b (0.01 mmol), 4-aminophenylboronic acid pinacol ester (0.25 mmol), caesium carbonate (Cs₂CO₃) (0.3 mmol) and tetrakis(triphenylphosphine)palladium (Pd(PPh₃)4) (0.01 mmol) were added to a mixture of toluene/ethanol/water (10 mL/3 mL/3 mL) and bubbled with nitrogen (N₂) for 15 minutes. The reaction was stirred for 15 hours at 90° C. under nitrogen (N₂). Compound Z-5 was obtained in 76% yield after column chromatography on silica gel.

Step 2. 1 mmol di-tert-butyl dicarbonate and sodium hydrogencarbonate (NaHCO₃) were added to a solution of 0.37 mmol compound Z-5 in 40 ml isopropanol, see FIG. 40i (Scheme 2). The reaction was stirred for 24 hours. Compound Z-6 was obtained in 88% yield after column chromatography on silica gel.

Step 3. 0.01 mmol Grubb's second-generation catalyst was added to a solution of 0.018 Compound Z-6 in 30 ml dichloromethane (DCM) and refluxed for 15 hours, shown in FIG. 40e. Macrocyclic compound Z-7 was obtained in 68% yield after column chromatography on silica gel.

Analytical data of the final product Z-5, Z-6, and Z-7 are shown in FIG. 40j.

### Example B24.6. Composites of Epoxy-Carbon Nanotubes

This example describes the generation of epoxy-carbon nanotube composites.

The epoxy monomer, bisphenol A diglycidyl ether (D.E.R.™ 332), and curing agent diethylenetriamine (DETA) were purchased from Sigma-Aldrich.

CNT/epoxy composites were prepared through the following steps.

Step 1. Preparation of primary CNTs suspensions.

Substep 1.1. 13 mg of “SWNTs of Example B3”, 26 mg “SWNT-ML-diamine of Example B6” and 26 mg of “SWNT-supra complexes of Example H1” were separately dispersed, in 4 vials, into 5 ml of acetone by ultrasonication in a bath sonicator at 20° C. for 1 hr. The resulting suspensions were placed on the hotplate at 75° C. to partly remove the acetone thereby forming three pastes.

Substep 1.2. The three pastes were each mixed with 10 ml epoxy monomer (D.E.R.™ 332) and dispersed in three stages, first using a bath sonicator at 20° C. for 30 min, then a probe sonicator with the ice water bath for 1 hr (40% amplitude and pulse interval of 1s) and finally a probe sonicator with ice water bath for 30 min (47% amplitude) to get three primary CNTs suspensions, comprising “SWNTs of Example B24.6”, “SWNT-ML-diamine of Example B24.6”, and [“SWNT-supra complexes of Example B24.6” ], respectively.

Step 2. UV-vis spectra was used to normalize the concentration of CNTs in the suspensions.

Substep 2.1. Each CNT suspension (0.1 ml) was separately dispersed into 9.9 ml DMF by bath ultrasonication for 1 min to get the suspension sample for the UV-vis spectra analysis.

Substep 2.2. The absorbance at 1000 nm of the suspension of the “SWNTs of Example B24.6” was used as a reference point for the normalization, as follows.

Substep 2.3. The absorbance of the two other CNT suspension samples, i.e. “SWNT-ML-diamine of Example B24.6” and “SWNT-U-shape of Example B24.6”, respectively, were then recorded and gradually diluted with D.E.R.™ 332 until their absorbance at 1000 nm equalled that of the suspension of “SWNTs of Example B3”. The dilution process was conducted by first using a bath sonicator at 20° C. for 30 min and then a probe sonicator with the ice water bath for 15 min (40% amplitude and pulse interval of 1s).

Step 3. To prepare the epoxy-CNTs composite, three separate reactions were performed, combining 5 ml of each of the three normalized CNT suspensions from step 2, with 0.72 ml curing agent (DETA), followed by manual stirring for 1 min, and then fast degassed under vacuum at 50° C. for removing bubbles. After that, each mixture was poured slowly into dumbbell-shaped teflon molds and successively cured at 60° C., 80° C. and 105° C. for 1 hr each, followed by post-cure at 145° C. for 1.5 hr. The prepared CNT/epoxy composite samples then were picked up from the molds for further measurement. SWNT loading with respect to total weight of cured epoxy specimen is approximately 0.1% (w/w). As a control sample, neat polymer without any CNTs was prepared by mixing 5 ml epoxy monomer and 0.72 ml curing agent, and the same curing process as described above for the other two suspensions was applied.

Step 4. Mechanical properties of the obtained composite samples were tested according to the standard method (ASTM D638-02a) using a universal tensile machine. 3 sample specimens were tested for each of the three composites. Stress-strain curves were recorded at a tensile rate of 1 mm per minute. A summary of data of mechanical properties is shown in Table B24.6-1.

TABLE B24.6-1

| | | | | | Young's | Increase in | Tensile | Increase in |
|---|---|---|---|---|---|---|---|---|
| | Epoxy | Curing | | SWNTs | Modulus | Young's | strength | tensile |
| sample | monomer | agent | CNTs | loading | (MPa) | Modulus | (MPa) | strength |
| 1 | D.E.R. ™ | DETA | None | — | 2541 | — | 65.7 | — |
| | 332 | | | | | | | |
| 2 | D.E.R. ™ | DETA | SWNTs | 0.1% | 2492.5 | −1.9% | 62.3 | −5.2% |
| | 332 | | | | | | | |
| 3 | D.E.R. ™ | DETA | SWNTs- | 0.1% | 2562 | +0.8% | 73.2 | +11.4% |
| | 332 | | ML-di- | | | | | |
| | | | amine | | | | | |
| 4 | D.E.R. ™ | DETA | SWNT | 0.1% | 2576.7 | +1.4% | 65.8 | +0.15% |
| | 332 | | U-shape | | | | | |

The data show that the Young's modulus of the composites changes slightly compared to the neat epoxy resin. The tensile strength of the SWNTs-ML-diamine of Example B24.6/epoxy composite was 11.4% improved compared to the neat polymer.

### Example B24.7 Composites of Epoxy-Carbon Nanotubes, Employing a Mechanical Ligand Carrying Bromo Groups

This example describes epoxy-carbon nanotube composite formation using a bromidecarrying mechanical ligand.

In this example, the epoxy monomer (D.E.R.™ 332) and curing agent (DETA) are the same as those of Example B24.6. Many of the steps of this example are identical to steps of Example B24.6.

CNT/epoxy composites were prepared through the following steps.

Step 1. Preparation of primary CNTs suspensions.

Substep 1.1. 5.2 mg of “SWNTs of Example B3” and 10 mg “SWNT-compound Z-4b complexes of Example B24.2” were separately dispersed into 5 ml of acetone by ultrasonication in a bath sonicator at 20° C. for 1 hr. The resulting suspensions were placed on the hotplate at 75° C. to partly remove the acetone, thereby forming two pastes.

Substep 1.2. The two pastes were each mixed with 10 ml epoxy monomer (D.E.R.™ 332) and dispersed in three stages, first using a bath sonicator at 20° C. for 30 min, then a probe sonicator with the ice water bath for 1 hr (40% amplitude and pulse interval of 1s) and finally a probe sonicator with ice water bath for 30 min (47% amplitude) to get two primary CNT suspensions, comprising “SWNTs of Example B24.7” and “SWNT-compound Z-4b complexes of Example B24.7”, respectively.

Step 2. UV-vis spectra was used to normalize the concentration of CNT in the suspensions.

Substep 2.1. Each CNT suspension (0.1 ml) was separately dispersed into 9.9 ml DMF by bath ultrasonication for 1 min to get the suspension sample for the UV-vis spectra analysis.

Substep 2.2. The absorbance at 1000 nm of the suspension of the “SWNTs of Example B24.7” was used as a reference point for the normalization, as follows.

Substep 2.3. The absorbance of the other CNT suspension, comprising “SWNT-compound Z-4b complexes of Example B24.7” was then recorded and gradually diluted with D.E.R.™ 332 until its absorbance at 1000 nm equalled that of the suspension of “SWNTs of Example B24.7”. The dilution process was conducted by first using a bath sonicator at 20° C. for 30 min and then a probe sonicator with the ice water bath for 15 min (40% amplitude and pulse interval of 1s).

Step 3. To prepare the epoxy-CNTs composites, two separate reactions were performed, combining 5 ml of each of the two normalized CNT suspensions from step 2, with 0.72 ml curing agent (DETA), followed by manual stirring for 1 min, and then fast degassed under vacuum at 50° C. to remove bubbles. After that, each mixture was poured slowly into dumbbell-shaped teflon molds and successively cured at 60° C., 80° C. and 105° C. for 1 hr each, followed by post-cure at 145° C. for 1.5 hr. The prepared CNT/epoxy composite samples then were picked up from the molds for further measurement. SWNT loading with respect to total weight of cured epoxy specimen is approximately 0.04% (w/w). As a control sample, neat polymer without any CNTs was prepared by mixing 5 ml epoxy monomer and 0.72 ml curing agent, and the same curing process as described above for the other suspension was applied.

Step 4. Mechanical properties of the obtained composite samples were tested according to the standard method (ASTM D638-02a) using a universal tensile machine [**(INSTRON XXX)**]. 3 sample specimens were tested for each of the two composites. Stress-strain curves were recorded at a tensile rate of 1 mm per minute. A summary of data of mechanical properties is shown in Table B24.7-1.

TABLE B24.7-1

| | | | | | Young's | Increase in | Tensile | Increase in |
|---|---|---|---|---|---|---|---|---|
| | Epoxy | Curing | | SWNTs | Modulus | Young's | strength | tensile |
| sample | monomer | agent | CNTs | loading | (MPa) | Modulus | (MPa) | strength |
| 1 | D.E.R. ™ | DETA | None | — | 2541 | — | 65.7 | — |
| | 332 | | | | | | | |
| 2 | D.E.R. ™ | DETA | SWNTs | 0.04% | 2682 | +5.5% | 68.9 | +4.9% |
| | 332 | | | | | | | |
| 3 | D.E.R. ™ | DETA | SWNTs- | 0.04% | 2556 | +0.6% | 67.9 | +3.3% |
| | 332 | | Z-4b | | | | | |

The data show that the Young's modulus and the tensile strength of the -SWNTs/epoxy composite improve by 5.5% and 4.9%, respectively, relative to neat epoxy. For the SWNT-Z-4b/epoxy composite, the improvement in the Young's modulus and the tensile strength is 0.6% and 3.3%, respectively.

### Example B24.8 Composites of Epoxy-Carbon Nanotubes, Employing the PEA (D-230) Curing Agent and a Mechanical Ligand that Comprises Bis-Phenol Motifs and Carries a Diamine

This example describes the use of the curing agent, poly(propylene glycol) bis(2-aminopropyl ether), as well as describes composite formation using different SWNTs-ML.

Poly(propylene glycol) bis(2-aminopropyl ether), abbreviated PEA (D-230) (average Mₙ ˜230, Sigma-Aldrich) was used as the curing agent.

The PEA cured epoxy-CNT composites were prepared by the following steps.

Step 1. 3.1 mg “SWNTs of Example B3” and 5.5 mg “SWNT-compound Z-8 complexes of Example B24.4b” were separately dispersed in 8 ml epoxy monomer, using bath sonicator at 20° C. for 30 min, probe sonicator with the ice water bath for 1 hr (40% amplitude and pulse interval of 1s) and probe sonicator with ice water bath for 30 min (47% amplitude) to get the corresponding two primary CNT suspensions, “SWNTs of Example B24.8” and “SWNT-compound Z-8 complexes of Example B24.8”.

Step 2. The concentration of CNT in the suspension “SWNT-compound Z-8 complexes of Example B24.8” was normalized relative to the suspension of “SWNTs of Example B24.8” by UV-vis spectra, as described in Example B24.6.

Step 3. To prepare the CNT/epoxy composites, 4.5 ml of each of the two CNT suspensions was separately mixed with 1.86 ml PEA (D-230) curing agent and stirred manually for 1 min, and then degassed under vacuum at 50° C. to remove bubbles. After that, the mixture was poured slowly into dumbbell-shaped teflon molds and successively cured at 80° C. for 2 hr, followed by post-cure at 130° C. for 4 hr. Two PEA-cured epoxy-CNT composites were prepared, with a SWNT loading of approximately 0.025% (w/w). As a control, the neat polymer without CNTs was prepared by mixing 4.5 ml epoxy monomer and 1.86 ml curing agent using the curing process described above.

Mechanical properties of the obtained composite samples were tested as described in Example B24.6, step 4. Data for Young's modulus and ultimate strength are shown in Table B24.8-1.

TABLE B24.8-1

| | | | | | Young's | Increase in | Ultimate | Increase in |
|---|---|---|---|---|---|---|---|---|
| | Epoxy | Curing | | SWNTs | Modulus | Young's | strength | ultimate |
| sample | monomer | agent | CNTs | loading | (MPa) | Modulus | (MPa) | strength |
| 1 | D.E.R. ™ | PEA | None | — | 2580 | — | 62.1 | — |
| | 332 | (D-230) | | | | | | |
| 2 | D.E.R. ™ | PEA | SWNT | 0.025% | 2695 | +4.4% | 64 | +3% |
| | 332 | (D-230) | | | | | | |
| 3 | D.E.R. ™ | PEA | SWNT- | 0.025% | 2701 | +4.7% | 64.2 | +3.4% |
| | 332 | (D-230) | Z-8 | | | | | |

The data show that the Young's modulus of the SWNT/epoxy composite and the SWNT-Z-8/epoxy composite improved by 4.4% and 4.7%, respectively, relative to the neat epoxy resin. The ultimate strength of the SWNT/epoxy composite and the SWNT-Z-8/epoxy composite improved by 3% and 3.4%, respectively, relative to the neat polymer.

### Example B24.9 Composites of PEA-Cured Epoxy-Carbon Nanotubes with Higher Concentrations of SWNT

This example describes the preparation of PEA-cured epoxy-carbon nanotube composites with higher concentration of SWNT, compared to the composites of Example B24.8.

The PEA-cured epoxy-CNT composites were prepared by the following steps.

Step 1. 6.2 mg “SWNTs of Example B3” and 11 mg “SWNT-compound Z-8 complexes of Example B24.4b” were separately dispersed in 8 ml epoxy monomer, using bath sonicator at 20° C. for 30 min, probe sonicator with the ice water bath for 1 hr (40% amplitude and pulse interval of 1s) and probe sonicator with ice water bath for 30 min (47% amplitude) to get the corresponding two primary CNT suspensions, “SWNTs of Example B24.9” and “SWNT-compound Z-8 complexes of Example B24.9”.

Step 2. The concentration of CNT in the suspension “SWNT-compound Z-8 complexes of Example B24.9” was normalized relative to the suspension of “SWNTs of Example B24.9” by UV-vis spectra, as described in Example B24.6.

Step 3. To prepare the CNT/epoxy composites, 4.5 ml of each of the two CNT suspensions was separately mixed with 1.86 ml PEA (D-230) curing agent and stirred manually for 1 min, and then degassed under vacuum at 50° C. to remove bubbles. After that, the mixture was poured slowly into dumbbell-shaped teflon molds and successively cured at 80° C. for 2 hr, followed by post-cure at 130° C. for 4 hr. Two PEA-cured epoxy-CNT composites were prepared, with a SWNT loading of approximately 0.05% (w/w). As a control, the neat polymer without CNTs was prepared by mixing 4.5 ml epoxy monomer and 1.86 ml curing agent using the curing process described above.

Mechanical properties of the obtained composite samples were tested as described in Example B24.6, step 4. Data for Young's modulus and ultimate strength are shown in Table B24.9-1.

TABLE B24.9-1

| | | | | | Young's | Increase in | Ultimate | Increase in |
|---|---|---|---|---|---|---|---|---|
| | Epoxy | Curing | | SWNTs | Modulus | Young's | strength | ultimate |
| sample | monomer | agent | CNTs | loading | (MPa) | Modulus | (MPa) | strength |
| 1 | D.E.R. ™ | PEA | None | — | 2580 | — | 62.1 | — |
| | 332 | (D-230) | | | | | | |
| 2 | D.E.R. ™ | PEA | SWNTs | 0.05% | 2714 | +5.2% | 63.8 | +2.7% |
| | 332 | (D-230) | | | | | | |
| 3 | D.E.R. ™ | PEA | SWNT- | 0.05% | 2652 | +2.8% | 62.5 | +0.6% |
| | 332 | (D-230) | Z-8 | | | | | |

The data show that the Young's modulus of the SWNTs/epoxy composite and the SWNT-Z-8/epoxy composite improves by 5.2% and 2.8%, respectively, relative to the neat epoxy resin. The ultimate strength of the SWNTs/epoxy composite and the SWNTs-ML-amine-2/epoxy composite improves by 2.7% and 0.6%, respectively, than the neat polymer.

### Example H1. Poly (Methyl Methacrylate) (PMMA) Composites Comprising SWNT

This is an example of Poly (methyl methacrylate) (PMMA) polymer fibers reinforced with three types of carbon nanofillers: pristine (6,5)-SWNT, (6,5)-SWNT functionalized with mechanical ligands (ML) and (6,5)-SWNT functionalized with supramolecular ligands (SL) which were used as a control sample. Table H1-1 explains the structural characteristics of each nanofiller with a schematic representation:

TABLE H1-1
Different nanofillers used to prepare polymer fiber composites.

| | Type of non-covalent interaction | |
|---|---|---|
| Nanofiller | between the NT and the molecular ring | Scheme |
| SWNT | NA | 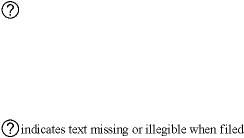 |
| SWNT-SL (control) | Supramolecular: the molecular ring does not wrap around the nanotube | 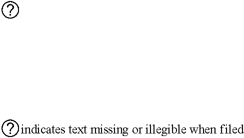 |
| SWNT-ML | Mechanical: the molecular ring wraps around the nanotube | 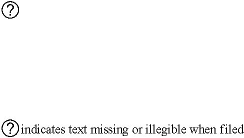 |

Both the SWNT-SL and the SWNT-ML nanofillers comprise carbon nanotubes and covalently closed rings. In the SWNT-SL sample, the ring binds to the surface of the carbon nanotube but does not wrap around the carbon nanotube; in the SWNT-ML sample, the ring wraps around the carbon nanotube to form a mechanical bond between the ring and the carbon nanotube. The SWNT-SL complex thus serves as a negative control as regards the effect of having a mechanical bond between the ring and the carbon nanotube, and how this affects the mechanical properties of the composite.

Step 1. (6,5)-enriched SWNTs purchased from Sigma-Aldrich (0.7-0.9 nm in diameter, length≥700 nm, mostly semiconducting) were previously purified, to obtain “SWNT of Example B3” (see Example B3).

Step 2. To prepare SWNT-SL complexes we followed the procedure described in Example B4, except that a pre-closed macrocycle instead of the linear precursor was added in Step 2, and no Grubbs' catalyst was added in Step 3. The resulting product was termed “SWNT-supra complexes of Example H1”

Step 3. SWNT-ML samples were prepared previously, to obtain “SWNT-ML of Example B4” (see Example B4)

Step 4. A suspension of 1 mg of “SWNT-ML of Example B4” in a mixture of dry solvents, 20 mL of acetonitrile (MeCN) and 80 mL of dimethylformide (DMF) (1:4) (purchased from Across Organics), was sonicated at 20° C. for 4 h, to obtain a stable suspension without visible aggregates.

Step 5. UV-Vis spectra of the stable suspension prepared in step 4 were collected in a Varian Cary 50 UV-Vis, and the absorbance at 1000 nm of the suspension was adjusted to 0.1 by the addition of a mixture of solvents MeCN: DMF (1:4).

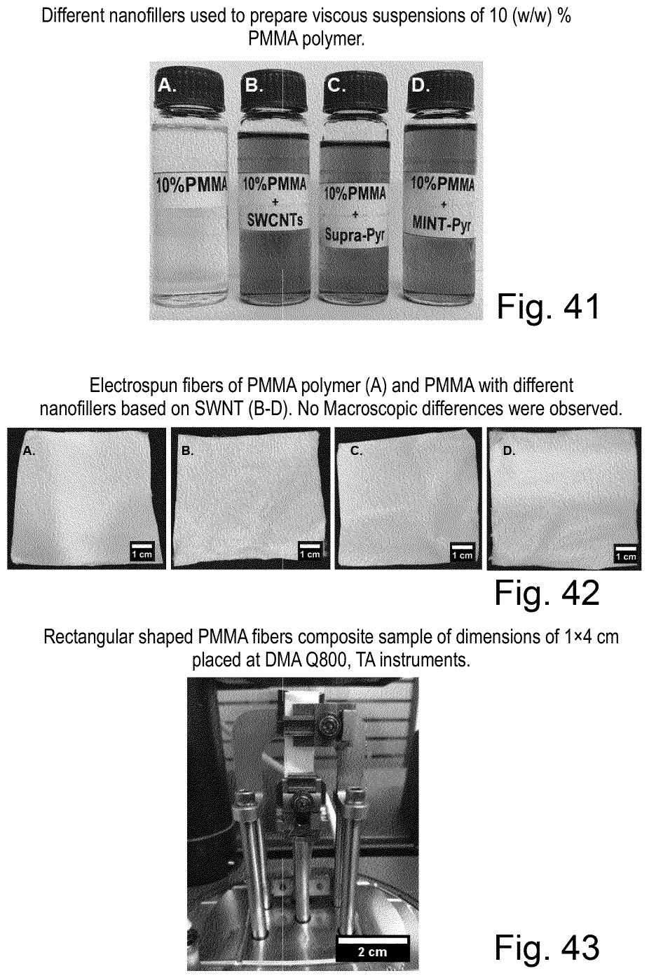

Step 6. 1.5 g of PMMA polymer (average Mw ˜350000 by GPC purchased from Sigma-Aldrich) was added to 14.80 mL of the suspension prepared in the step 5 in order to obtain 10% w/w of PMMA. The viscous solution was vigorously stirred at room temperature overnight until all the polymer was dissolved (FIG. 41).

Step 7. The polymeric suspension of “SWNT-ML of Example B4” of step 6 was transferred to a syringe connected to a tube (Tube E—0.8 mm tubing with male luer to female ¼″-28 adaptor and female luer to female ¼″-28 adaptor, purchased from Spraybase) that was placed in an electrospinning equipment. The viscous suspension was then pumped to a flow of 0.2 mL·h⁻¹ and a voltage of ˜7 kV (Table H1-2). Polymer fibers were deposited on a collector previously covered with aluminum foil. The homogeneity of the collected fibers was checked by optical microscopy. The total polymer mass deposited on the collector was approximately 100 mg (FIG. 42).

TABLE H1-2
Electrospinning parameters for PMMA polymer fibers

| | | Voltage | Flow |
|---|---|---|---|
| Polymer | Solvent | (kV) | (mL · h⁻¹) |
| 10% PMMA | DMF:CH₃CN | 7.01 | 0.2 |
| | (4:1) | | |
| 10% PMMA + SWNT | DMF:CH₃CN | 7.05 | 0.2 |
| | (4:1) | | |
| 10% PMMA + SWNT-supra complexes of | DMF:CH₃CN | 7.52 | 0.2 |
| example H1 | (4:1) | | |
| 10% PMMA + SWNT-ring complexes of | DMF:CH₃CN | 7.30 | 0.2 |
| example B4 | (4:1) | | |

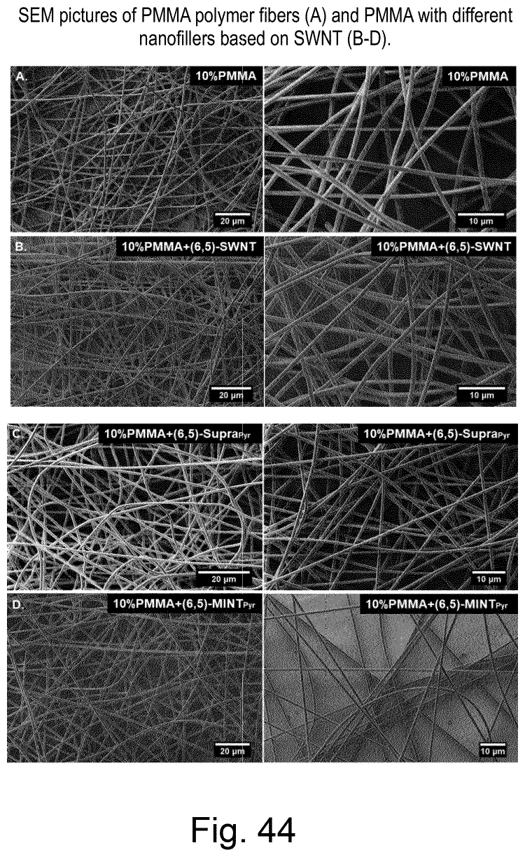

Step 8. From the sample of polymer fibers which were deposited on the collector with thickness between 0.08 and 0.10 mm, rectangular-shaped samples were cut with dimensions of 1×4 cm. Mechanical properties were determined using a dynamic mechanical analyzer (DMA Q800, TA Instruments) (FIG. 43) and recorded stress-strain curves at a rate of 0.2 N·min⁻¹ (FIG. 44).

TABLE H1-3
Young's Modulus and Tensile Strength of PMMA polymer-
and PMMA/SWNT composite electrospun fiber materials;

| | | | | Improvement | Improvement |
|---|---|---|---|---|---|
| | | | | of Young's | of Tensile |
| | | Young's | Tensile | Modulus | Strength |
| | | Modulus | Strength | with respect | with respect |
| Sample | Interaction | (MPa) | (MPa) | to PMMA (%) | to PMMA (%) |
| 10% | — | 6.3 ± 0.4 | 0.25 ± 0.04 | — | — |
| PMMA | | | | | |
| 10% | — | 9.7 ± 0.6 | 0.28 ± 0.05 | +54 | +12 |
| PMMA + | | | | | |
| SWNT | | | | | |
| 10% | Supramolecular | 10.3 ± 1.5 | 0.28 ± 0.05 | +63 | +12 |
| PMMA + | | | | | |
| SWNT-SL | | | | | |
| (control) | | | | | |
| 10% | Mechanical | 16.2 ± 1.3 | 0.35 ± 0.06 | +157 | +40 |
| PMMA + | bond | | | | |
| SWNT-ML | | | | | |

Step 9. For the preparation of samples comprising PMMA fibers loaded with SWNT, steps 4 to 8 were performed using the “SWNT of Example B3” instead of “SWNT-ML of Example B4” Step 10. For the preparation of the control samples comprising PMMA fibers loaded with SWNT-SL nanofillers, steps 4 to 8 were repeated using the “SWNT-SL of Example H1” instead of “SWNT-ML of Example B4”

Step 11. For the preparation of neat PMMA polymer samples, steps 4-8 were repeated, except that no nanofiller was added.

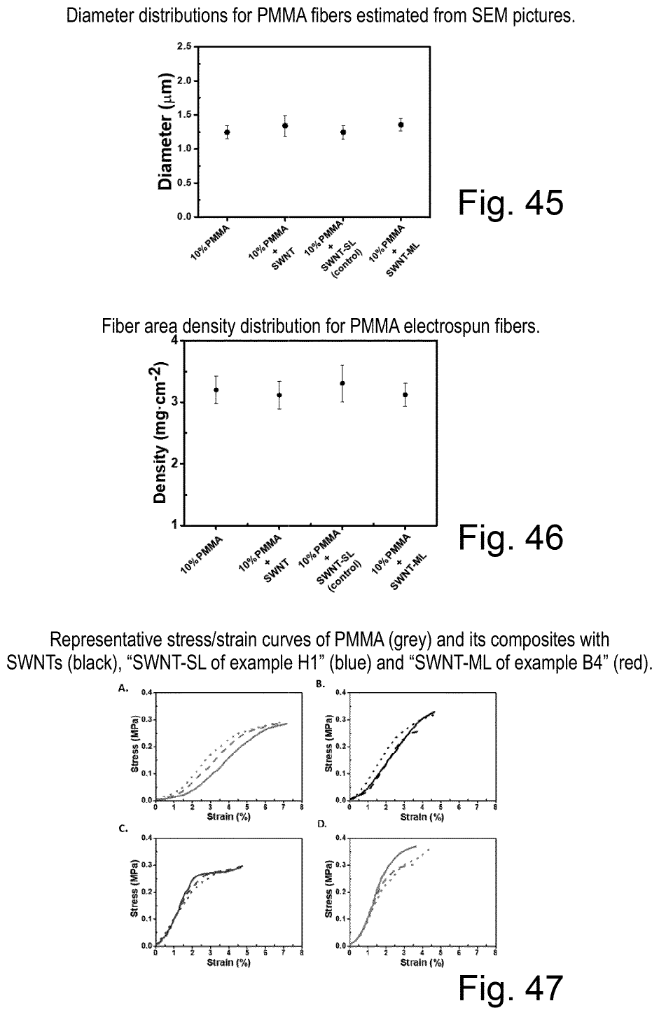

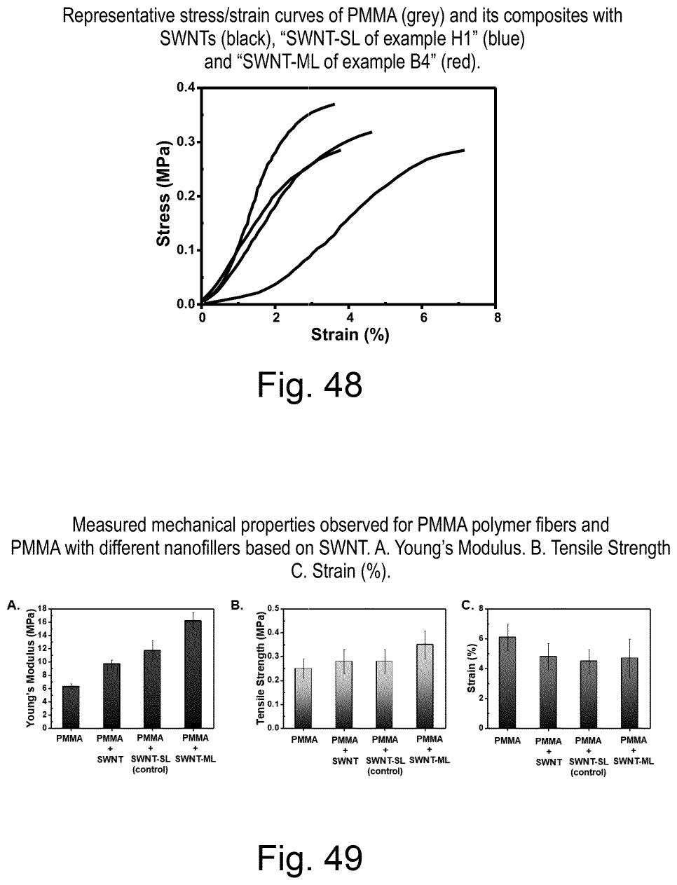

Scanning electron microscopy pictures, diameter distributions, area density, stress-strain curves, and determination of mechanical properties of the four different PMMA polymer- or composite fibers are shown in FIGS. 44, 45 and 46, 47, 48, and 49, respectively.

### Example H2. Polysulfone (PSU) Composites Comprising SWNT

This is an example of Polysulfone (PSU) polymer fibers reinforced with three types of carbon nanofillers: pristine (6,5)-SWNT, (6,5)-SWNT functionalized with mechanical ligands (ML) and (6,5)-SWNT functionalized with supramolecular ligands (SL) which were used as a control sample. Table H2-1 explains the structural characteristics of each nanofiller with a schematic representation:

TABLE H2-1
Different nanofillers used to prepare polymer fiber composites.

| | Type of non-covalent interaction | |
|---|---|---|
| Nanofiller | between the NT and the molecular ring | Scheme |
| SWNT | — | 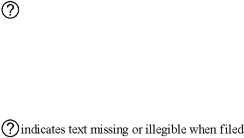 |
| SWNT-SL (control) | Supramolecular: the molecular ring does not wrap around the nanotube | 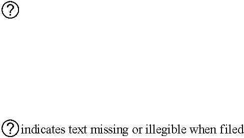 |
| SWNT-ML | Mechanical: the molecular ring wraps around the nanotube | 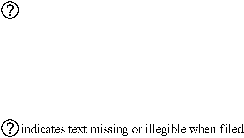 |

Step 1. Molecular sieves (3A, purchased from Across Organics) were activated in the oven at 120° C. for 48 h.

Step 2. After activation, molecular sieves were placed in a dried round bottom flask a mixture of acetone and dimethylacetamide (DMAc) (1:9). Mixture of solvents were kept on activated molecular sieves for 24 h.

Step 3. 1 mg of “SWNT-ML of Example B4” was suspended in the mixture of dry solvents using 10 mL of acetone and 90 mL of DMAc (1:9) and was sonicated at 20° C. for 4 h obtaining a stable suspension without aggregates.

Step 4. UV-Vis spectra of the stable suspension prepared in step 3 were collected in a Varian Cary 50 UV-Vis, and the absorbance at 1000 nm of the suspension was adjusted to 0.1 by the addition of the mixture of solvents acetone: DMAc (1:9).

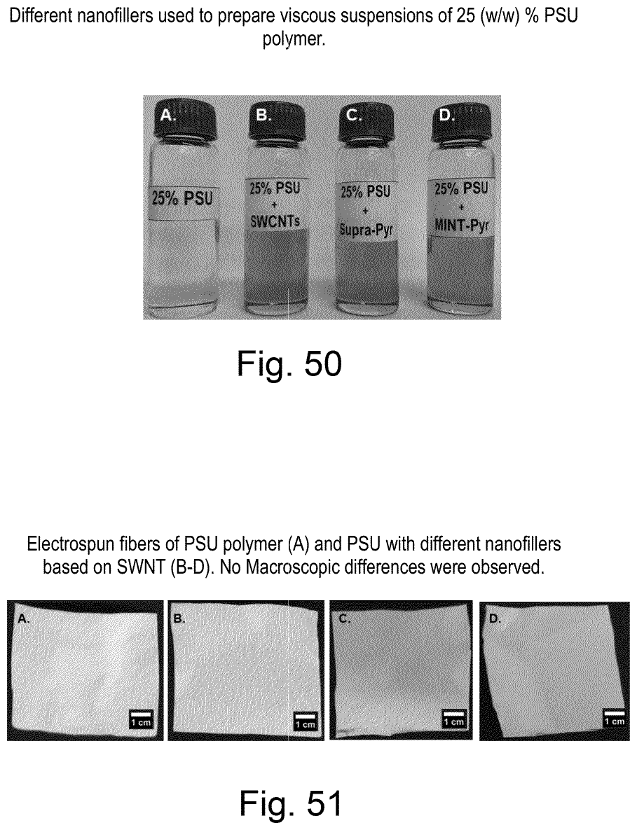

Step 5. 3.75 g of PSU polymer (Mw-35000 by LS purchased from Sigma-Aldrich) was added to 12.16 mL of the suspension prepared in the step 4 in order to obtain 25% w/w of PSU. The viscous solution was vigorously stirred at room temperature overnight until all the polymer was dissolved (FIG. 50).

Step 6. The polymeric suspension of step 5 was transferred to a syringe connected to tube (Tube E—0.8 mm tubing with male luer to female ¼″-28 adaptor and female luer to female ¼″-28 adaptor, purchased from Spraybase) that was placed in an electrospinning equipment. The viscous suspension was then pumped to a flow of 0.1 mL·h⁻¹ and a voltage of ˜8 Kv (Table H2-2). Polymer fibers were deposited on a collector previously covered with aluminum foil. The homogeneity of the collected fibers was checked by optical microscopy. The total polymer mass deposited on the collector was approximately 100 mg (FIG. 51).

TABLE H2-2
Electrospinning parameters for PSU polymer fibers

| | | Voltage | Flow |
|---|---|---|---|
| Polymer | Solvent | (kV) | (mL · h⁻¹) |
| 10% PSU | DMAc:Acetone | 7.55 | 0.1 |
| | (4:1) | | |
| 10% PSU + SWNT | DMAc:Acetone | 8.36 | 0.1 |
| | (4:1) | | |
| 10% PSU + SWNT-supra | DMAc:Acetone | 8.25 | 0.1 |
| complexes of example H1 | (4:1) | | |
| 10% PSU + SWNT-ring | DMAc:Aceton | 8.25 | 0.1 |
| complexes of example B4 | (4:1) | | |

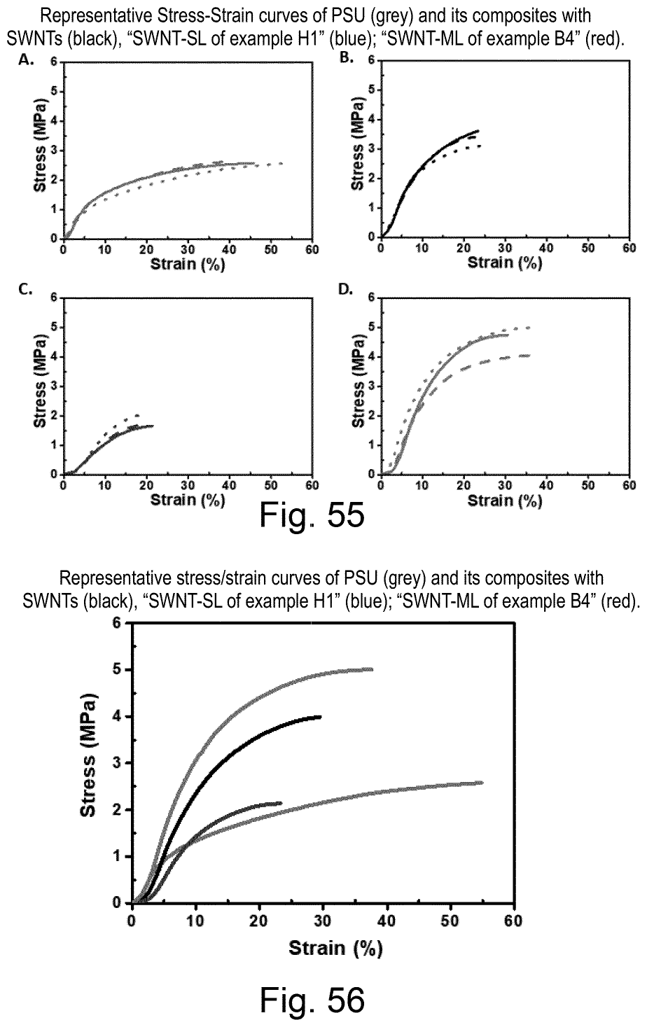

Step 7. From polymer fibers which were deposited on the collector with thicknesses between 0.08 and 0.10 mm, rectangular shaped samples were cut with dimensions of 1×4 cm. Mechanical properties were determined using a dynamic mechanical analyzer (DMA Q800, TA Instruments) and recorded stress-strain curves at a rate of 0.5 N·min⁻¹ (FIG. 55.).

TABLE H2-3
Young's Modulus and Tensile Strength of PSU polymer-
and PSU/SWNT composite electrospun fiber materials.

| | | | | Improvement | Improvement |
|---|---|---|---|---|---|
| | | | | of Young's | of Tensile |
| | | Young's | Tensile | Modulus | Strength |
| | | Modulus | Strength | with respect | with respect |
| Sample | Interaction | (MPa) | (MPa) | to PSU (%) | to PSU (%) |
| 25% PSU | — | 28.4 ± 1.2 | 2.4 ± 0.2 | — | — |
| 25% PSU + | — | 36.2 ± 1.3 | 3.2 ± 0.2 | +27 | +33 |
| SWNT | | | | | |
| 25% PSU + | Supramolecular | 21.3 ± 1.9 | 2.2 ± 0.2 | −25 | −8 |
| SWNT-SL | | | | | |
| (control) | | | | | |
| 25% PSU + | Mechanical | 42.2 ± 2.8 | 5.2 ± 0.3 | +49 | +117 |
| SWNT- | bond | | | | |
| ML | | | | | |

Step 8. For the preparation of the samples comprising PSU fibers loaded with SWNT, steps 1-7 were performed using the “SWNT of Example B3” instead of “SWNT-ML of Example B4”

Step 9. For the preparation of the control samples comprising PSU fibers loaded with SWNT-SL nanofillers, steps 1 to 7 were repeated using the “SWNT-SL of Example H1” instead of “SWNT-ML of Example B4”

Step 10. For the preparation of neat PSU polymer fiber materials, steps 1-7 were repeated, except that no nanofiller was added.

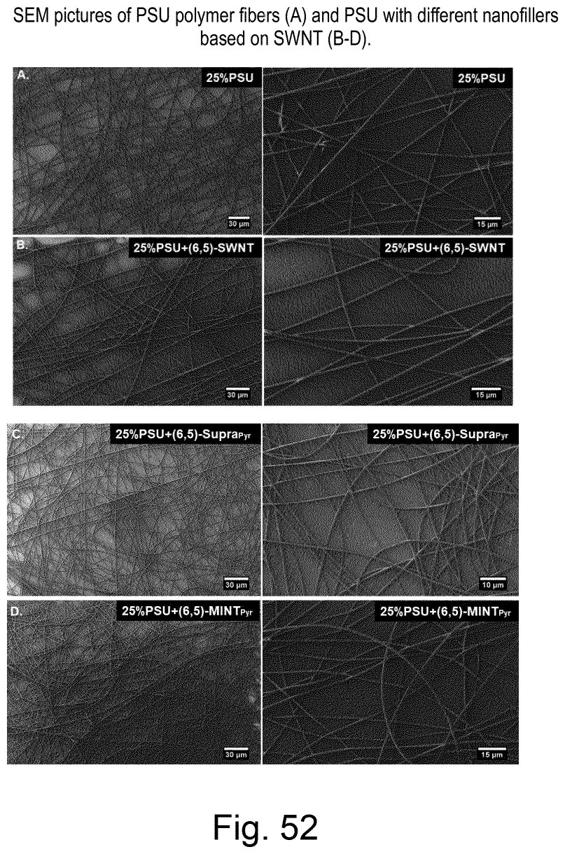

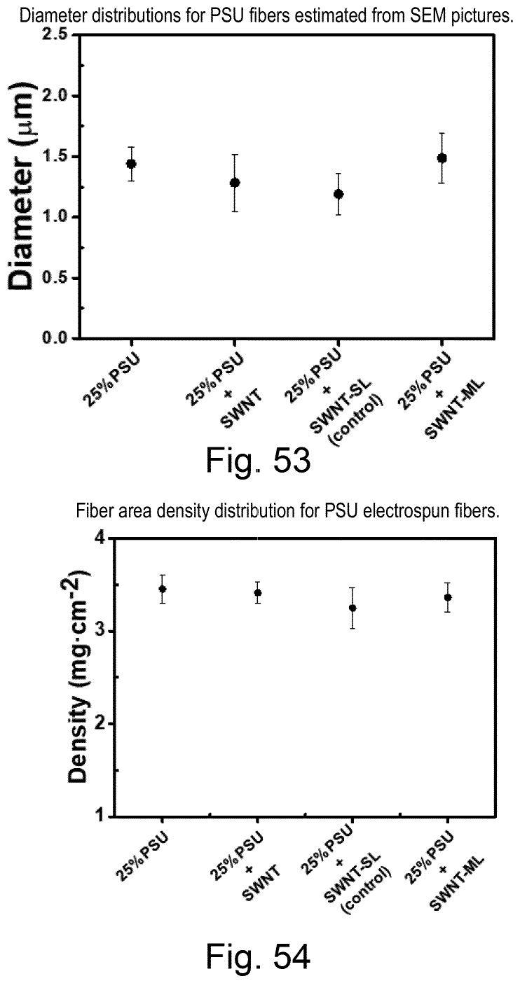

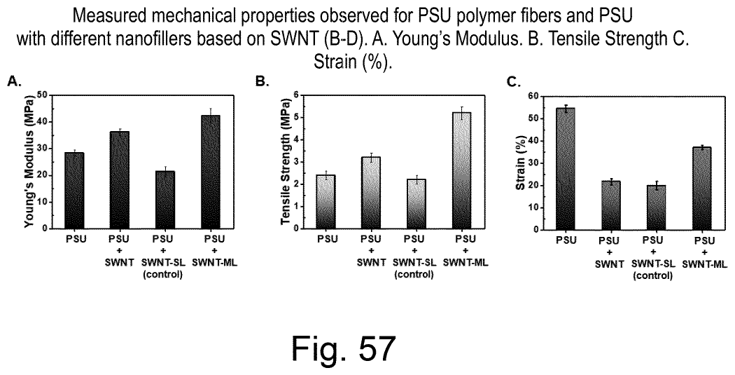

Scanning electron microscopy pictures, diameter distributions, area density, stress-strain curves, and determination of mechanical properties of the four different PSU polymer- or composite fibers are shown in FIGS. 52, 53 and 54, 55, 56, and 57, respectively.

### Example AA1. Synthesis of Pyrene U-Shape

Compound AA1 termed as “Pyrene U-Shape of the Example AA1” was synthesized by following the procedure described for “Pyrene U-Shape of the Example DD6”.

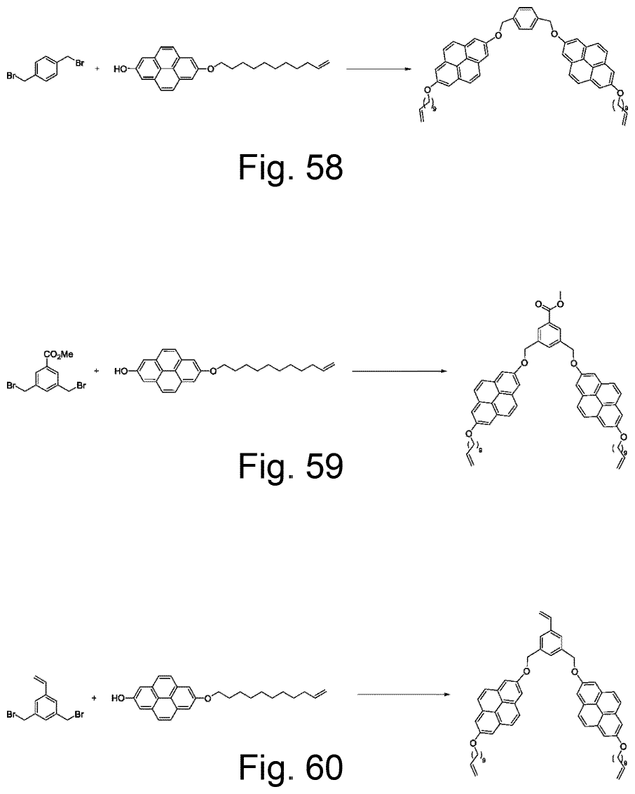

Synthetic scheme showed in FIG. 58.

### Example AA2. Synthesis of Alkene U-Shape

Compound AA2 termed as “Alkene U-Shape of the Example AA2” was synthesized by following the procedure described for “Alkene U-Shape of the Example EE1”.

Synthetic scheme showed in FIG. 59.

### Example AA3. Synthesis of Ester U-Shape

Compound AA3 termed as “Ester U-Shape of the Example AA3” was synthesized by following the procedure described for “Ester U-Shape of the Example EE2”.

Synthetic scheme showed in FIG. 60.

### Example AA4. Synthesis of Acid U-Shape

Compound AA4 termed as “Acid U-Shape of the Example AA4” was synthesized by following the procedure described for “Acid U-Shape of the Example EE3”.

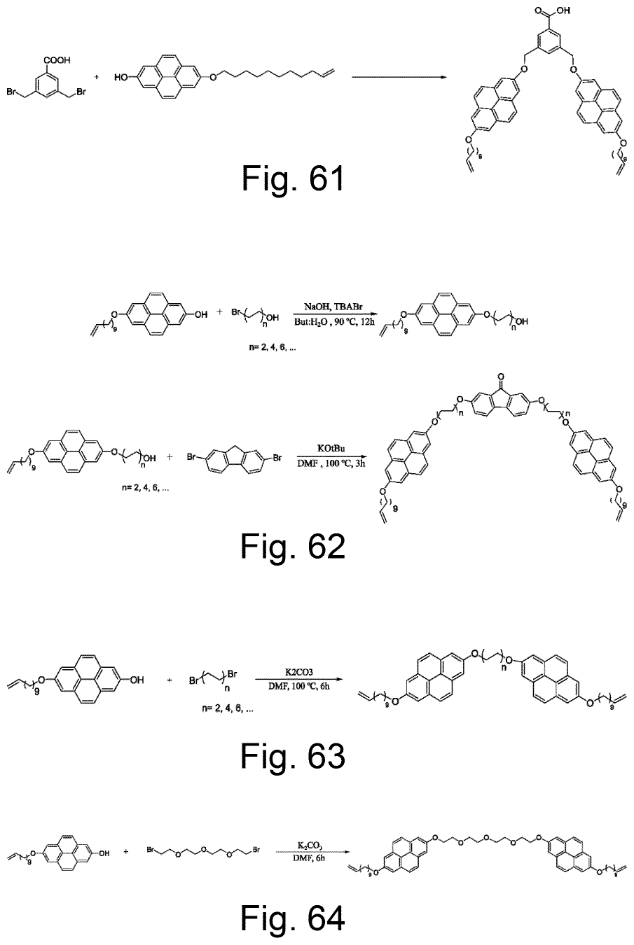

Synthetic scheme showed in FIG. 61.

### Example AA5. Synthesis of Fluorenone U-Shape

The procedure consists of a first synthesis of the pyrene leg and a second step, where the U-Shape is prepared by reaction between leg and commercial spacer.

Step 1: To a round bottom flask containing 7-(undec-10-en-1-yloxy)pyren-2-ol (2.59 mmol, 1 eq), sodium hydroxide (5.18 mmol, 2 eq) and tetrabutylammonium bromide (0.259 mmol, 0.1 eq) 200 mL of methyl ethyl ketone:H₂O (1:1) was added.

Step 2: The mixture was heated and stirred at 50° C. for 20 minutes.

Step 3: Then, 6-bromohexan-1-ol (12.95 mmol, 5 eq) was added.

Step 4: Reaction takes place at 90° C. and overnight.

Step 5: Methyl ethyl ketone was evaporated and precipitate was washed several times with hexane.

Compound AA5 was named as “pyr-60H of Example AA5”.

Step 6: “Pyr-60H of Example AA5”. (0.82 mmol, 2.2 eq) and potassium tect-butoxide (0.82 mmol, 2.2 eq) were dissolved in 20 mL of DMF while heating.

Step 7: 2,7-dibromo-9H-fluorene (0.37 mmol, 1 eq) was added, and mixture was stirred at 100° C.

Step 8: After 3 h, reaction was stopped and cold down to room temperature.

Step 9: Crude was precipitated in cold methanol, obtaining a yellow solid (87% of yield).

Final product (compound AA6) was termed as “Fluorenone U-Shape of the Example AA5”.
As a variation of the procedure, different lengths of the alkylation moieties for the synthesis of the pyrene leg could be used, for example, 2-bromoethan-1-ol instead of 6-bromohexan-1-ol.

Synthetic scheme showed in FIG. 62.

### Example AA6. Synthesis of Chain U-Shape

Step 1: In a round bottom flask set-up under anhydrous conditions, 7-(undec-10-en-1-yloxy)pyren-2-ol (5.18 mmol, 2.2 eq) and dried potassium carbonate, (20.71 mmol, 8.8 eq) were dissolved in 20 mL of anhydrous DMF and heated at 100° C. while stirring.

Step 2: After 30 minutes, 1, 6-dibromohexane was added slowly, (2.35 mmol, 1 eq).

Step 3: Reaction was cold down to room temperature after 6 hours.

Step 4: Solution was poured into cold 1M HCl and a brown precipitate was obtained.

Step 5: Precipitated was filtered and washed with methanol several times (64% yield).

Final product (compound AA7) was termed as “Chain U-Shape of Example AA6”.
As a variation of the procedure, different lengths of the alkylation moieties for the synthesis of the pyrene leg could be used, for example, 1, 2-dibromoethane instead of 1, 6-dibromohexane.

Synthetic scheme showed in FIG. 63.

### Example AA7. Synthesis of Glycol U-Shape

Step 1: In a round bottom flask set-up under anhydrous conditions, 7-(undec-10-en-1-yloxy)pyren-2-ol (5.18 mmol, 2.2 eq) and dried potassium carbonate, (20.71 mmol, 8.8 eq) were dissolved in 20 mL of anhydrous DMF and heated at 100° C. while stirring.

Step 2: After 30 minutes, was added dropwise, (2.35 mmol, 1 eq).

Step 3: Reaction was cold down to room temperature after 6 hours.

Step 4: Solution was poured into cold 1M HCl.

Step 5: Precipitated was filtered and washed with methanol several times (63% yield).

Final product (compound AA8) was termed as “Glycol U-Shape of the Example AA7”.

Synthetic scheme showed in FIG. 64.

### Example AA8. Synthesis of Fully Glycol U-Shape

The procedure consists of a first step of modification of the alkylated moiety, (step 1), which is used in the second step for the synthesis of polyethoxy pyrene leg, (step 2), and a third step, where the U-Shape was prepared by reaction between polyethoxy pyrene leg and commercial spacer, (step 3 to 9).

Step 1: “3-(2-(2-(2-chloroethoxy) ethoxy) ethoxy) prop-1-ene of Example DD3” was obtained following the procedure described in Example DD3, (compound AA9).

Step 2: “Polyethoxy monoalkylated of Example DD4” was obtained following the procedure described in Example DD4, (compound AA10).

Step 3: “Polyethoxy monoalkylated of Example DD4” (0.54 mmol, 2.2 eq) and potassium carbonate (2.16 mmol, 8.8 eq) were dissolved in dried DMF into a round bottom flask.

Step 4: The mixture was stirred at 100° C. for 2 h.

Step 5: Then, 1-Bromo-2-(2-(2-(2-bromoethoxy) ethoxy) ethoxy) ethane (0.25 mmol, 1 eq) and a catalytic amount of KI were also added to the round bottom flask.

Step 6: Reaction takes place for 3 h and 30 minutes.

Step 7: Reaction was cold down to room temperature and poured into 1M HCl (cold).

Step 8: Aqueous solutions was extracted with CHCl3, and solvent was evaporated.

Step 9: Product was columned in Hexane:Ethyl acetate 1:3.

Final product, (compound AA11) was termed as “Fully glycol U-Shape of the Example AA8”.

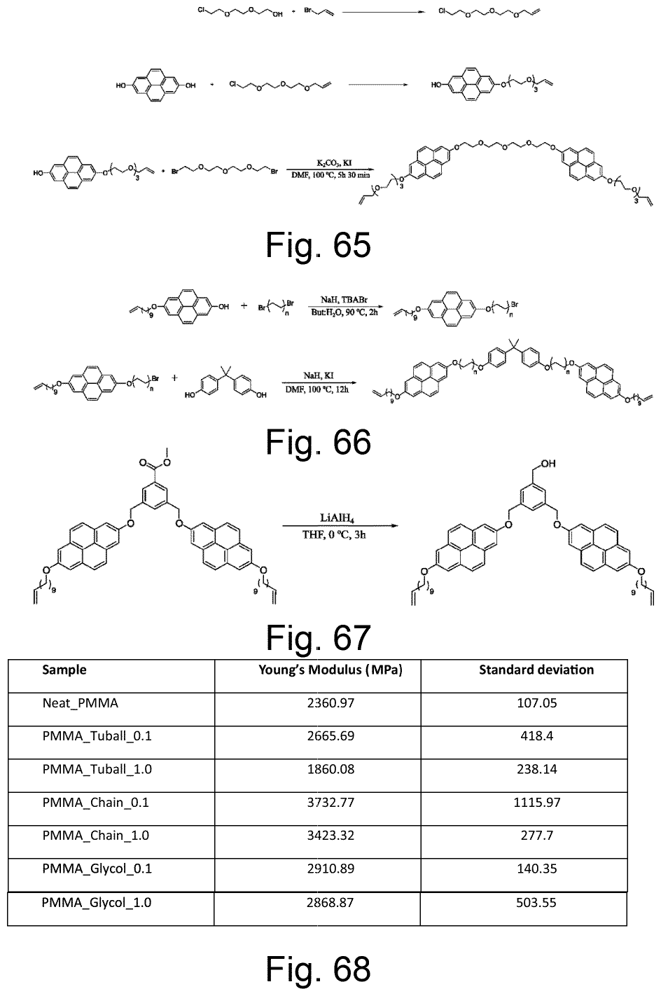

Synthetic scheme showed in FIG. 65.

### Example AA9. Synthesis of DER U-Shape

The procedure consists of a first synthesis of pyrene leg and a second step, where U-Shape was prepared by reaction between pyrene leg and commercial spacer.

Step 1: To a round bottom flask containing 7-(undec-10-en-1-yloxy)pyren-2-ol (2.59 mmol, 1 eq), sodium hydroxide (5.18 mmol, 2 eq) and tetrabutylammonium bromide (0.259 mmol, 0.1 eq) 200 mL of methyl ethyl ketone:H₂O (1:1) was added.

Step 2: The mixture is heated and stirring at 50° C. for 20 minutes.

Step 3: Solution is warm-up to 90° C. and then, 1, 6-dibromohexane (25.9 mmol, 5 eq) was added dropwise.

Step 4: Reaction takes place at 90° C. for 2 hours.

Step 5: Methyl ethyl ketone was evaporated and a brown precipitate appeared.

Step 6: Precipitated was filtrated and washed several times with hexane.

Compound AA12 was termed as “pyr-6Br of Example AA9”.

Step 7: Anhydrous conditions were fixed in a round bottom flask.

Step 8: Sodium hydride (1.94 mmol, 2.2 eq) was dissolved in anhydrous DMF while heating at 100° C. for 2 hours.

Step 9. 4, 4′-(propane-2, 2-diyl) diphenol (0.88 mmol, 1 eq) was added to the solution, and mixture was stirred for 2 h while heating at 100° C.

Step 10: “Pyr-6Br of Example AA9” (2.19 mmol, 2.5 eq) and a catalytic amount of potassium iodide were added, and mixture was stirred at 100° C., overnight.

Step 11: Reaction was stopped and cold down to room temperature.

Step 12: Crude was poured into 1M cold HCl and precipitate was filtered and columned: Hexane>Hex:AcOEt (8:2)>AcOEt.

Final product, (compound AA13) was termed as “DER U-Shape of Example AA9”.
As a variation of the procedure, different lengths of the alkylation moieties for the synthesis of the pyrene leg could be used, for example, 1, 2-dibromoethane instead of 1, 6-dibromohexane.

Synthetic scheme showed in FIG. 66.

### Example AA10. Synthesis of the Methyl Alcohol U-Shape

Step 1: In a round bottom flask “Ester U-Shape of Example AA3” (5.54 mmol, 1 eq) was dissolved in THF, at 0° C.

Step 2: Lithium aluminium hydride (11.09 mmol, 2 eq) was added dropwise.

Step 3: Reaction was stopped after 3 h at room temperature.

Step 4: H₂O was added and a brown precipitate appears.

Step 5: Precipitate was filtered and washed with water three times, and two times with hexane.

Final product, (compound AA14), was termed as “Methyl alcohol U-Shape of Example AA10”.

Synthetic scheme showed in FIG. 67.

[2] In these examples, the preparation of several MINTs is described through ring closing metathesis using 2^{nd} generation Grubbs catalyst.

The protocol described below can be used for final products synthesized in Examples AA1-AA10 examples.

### Example AA11. Preparation of MINTs

### Example AA11a. Wet Method

Step 1: In a round bottom flask containing 750 mL of TCE, SWNTs (0.75 g, Tuball from OCSiAl) were added.

Step 2: The SWNTs were dispersed by bath sonication for 10 min Step 3: “Pyrene U-Shape of Example AA1” (0.75 mmol, 1 eq) was added.

Step 4: The suspension was bubbled with nitrogen for 15 minutes

Step 5: 2^{nd} generation Grubbs catalyst (0.75 mmol, 1 eq, purchased from BLD) was added and the suspension was stirred for 72 h at room temperature.

Step 6: After this time, the reaction mixture was filtered through a 47 mm diameter PTFE membrane of 0.2 μm pore size.

Step 7: The filter cake was collected and was re-dispersed in 200 mL dichloromethane in a round-bottom flask by bath sonication for 3 min.

Step 8: The sample was filtered again through a 47 mm diameter PTFE membrane of 0.2 μm pore size.

Step 9: Steps 7 and 8 were repeated two times

Step 10: Approximately 50 mL Et₂O was added to the filter cake.

Step 11: The Ester MINTs were collected in a vial and dried overnight at room temperature.

Compound AA15 was termed “Pyrene MINT of Example AA11a”.

### Example AA11b. Mechanochemical Method

The method makes use of the mechanical energy generated in a ball mill to disperse the SWNTs, and/or bind the U-Shape molecule to SWNTs, and/or mediate the ring-closing metathesis.

Step 1: In a 80 mL-size stainless steel ball mill reactor, SWNTs (Tuball from OCSiAl, 2.5 g), Pyrene U-shape of Example AA1 (0.72 mmol, 1 eq) and 2^{nd} gen. Grubbs catalyst (0.07 mmol, 0.1 eq, purchased from BLD) were added.

Step 2: The reactor was charged with five 15 mm diameter stainless steel balls.

Step 3: The powders were milled for 10 min at 500 rpm in an air atmosphere.

Step 4: After this time, the reactor content was recovered. Dichloromethane (50 mL) was added and the reaction mixture was filtered through a 47 mm diameter PTFE membrane of 0.2 μm pore size.

Step 5: The filter cake was collected and was re-dispersed in 100 mL dichloromethane in a round-bottom flask by bath sonication for 3 min.

Step 6: The sample was filtered again through a 47 mm diameter PTFE membrane of 0.2 μm pore size.

Step 7: Steps 5 and 6 were repeated Step 8: Approximately 50 mL Et₂O was added to the filter cake.

Step 9: The Pyrene MINTs were collected in a vial and dried overnight at room temperature.

The product (compound AA16) was termed “Pyrene MINT of Example AA11b”.

The above mentioned protocol can be used for compounds AA1 to AA4, AA6 to AA8, AA11, AA13 and AA14. The products were termed:

“Alkene MINT of Example AA11b”, using compound AA2, Grubbs catalyst and SWNTs, (compound AA17).

“Ester MINT of Example AA11b”, using compound AA3, Grubbs catalyst and SWNTs, (compound AA18).

“Acid MINT of Example AA11b”, using compound AA4, Grubbs catalyst and SWNTs, (compound AA19).

“Fluorenone MINT of Example AA11 b”, using compound AA6, Grubbs catalyst and SWNTs, (compound AA20).

“Chain MINT of Example AA11b”, using compound AA7, Grubbs catalyst and SWNTs, (compound AA21).

“Glycol MINT of Example AA11b”, using compound AA8, Grubbs catalyst and SWNTs, (compound AA22).

“Fully glycol MINT of Example AA11b”, using compound AA11, Grubbs catalyst and SWNTs, (compound AA23).

“DER MINT of Example AA11b”, using compound AA13, Grubbs catalyst and SWNTs, (compound AA24).

“Methyl alcohol MINT of Example AA11b”, using compound AA14, Grubbs catalyst and SWNTs, (compound AA25).
As a variation of the procedure, step 1 to 4 can be replaced by mortar milling instead of ball mill.

[3] In these examples, the preparation of several composites is described.

### Example AA12. Preparation of PS—NH₂+Ester MINT

Step 1: PS—NH₂ (polystyrene amino terminated, purchased from Aldrich) was dried in the oven, at 80° C., for 2 h.

Step 2: In a 45 mL-size stainless steel ball mill reactor, dried PS—NH₂ (1 eq) and “Ester MINT of Example AA11b” (1 eq of Ester U-Shape involved in MINTs, in terms of functionalization) were added.

Step 3. The reactor was charged with five 15 mm diameter stainless steel balls.

Step 3: The powder were milled for 10 min at 500 rpm in an air atmosphere.

Step 4: After this time, the reactor content was recovered and dried at 200° C. during 2 h.

Step 5: The powder was then dissolved in CHCl3 and sonicated for 30 minutes at room temperature, being 0.5 mg/mL.

Step 6: Then, CHCl3 was evaporated. The resulting product was termed “PS—NH₂ ester MINT of Example AA12”, (compound AA26).

### Example AA13. PMMA Composites

AA13a. Neat Composite

Step 1: In a 100 mL round bottom flask, 10 g of PMMA polymer were dissolved in 40 mL of toluene and it was stirred vigorously overnight, at room temperature.

Step 2: After stirring, precipitation process was carried out by pouring the solution into 300 mL of methanol.

Step 3: Finally, Neat-Polymer sample was dried in the oven at 60° C. and overnight.

Final product was termed as “PMMA_Neat of Example AA13”, (compound AA27).

AA13b. MINT Composite

SWNTs (Tuball from OCSiAl), “Chain MINTs of Example AA11b” and “Glycol MINTs of Example AA11b” were used for preparing different PMMA composites.

Step 1: In a 100 mL round bottom flask, 13 mg of “Chain MINTs of Example AA11b” were dispersed in 40 mL of toluene, by 5 minutes of sonication.

Step 2: 10 g of PMMA polymer were added and mixture was stirred vigorously overnight, at room temperature.

Step 3: After stirring, precipitation process was carried out by pouring the solution into 300 mL of methanol.

Step 4: Finally, MINT-Polymer sample was dried in the oven at 60° C. and overnight.

Final product was termed as “PMMA_Chain_0.1 of Example AA13b”, (compound AA28).

Steps 1 to 4 were carried out this time with 137 mg of “Chain MINTs of Example AA11b” obtaining the sample termed as “PMMA_Chain_1.0 of Example AA13b”, (compound AA29).

Same procedure was followed using “Glycol MINTs of Example AA11b”. In that way, compounds AA30 and AA31 were obtained, termed as “PMMA_Glycol_0.1 of Example AA13b” and “PMMA_Glycol_1.0 of Example AA13b”, respectively.

Same procedure was followed using SWNTs (Tuball from OCSiAl). In that way, compounds AA32 and AA33 were obtained, termed as “PMMA_Tuball_0.1 of Example AA14b” and “PMMA_Tuball_1.0 of Example AA14b”, respectively.

### Example AA14. PVC Composites

AA14a. Neat Composite

Step 1: In a 100 mL round bottom flask, 10 g of PVC polymer were dissolved in 40 mL of tetrahydrofuran and it was stirred vigorously overnight, at 60° C.

Step 2: After stirring, precipitation process was carried out by pouring the solution into 300 mL of methanol.

Step 3: Finally, Neat-Polymer sample was dried in the oven at 60° C. and overnight.

Final product was termed as “PVC_Neat of Example AA14a”, (compound 34).

AA14b. MINT Composite

SWNTs (Tuball from OCSiAl), “Chain MINTs of Example AA11b” and “Glycol MINTs of Example AA11b” were used for preparing different PVC composites.

Step 1: In a 100 mL round bottom flask, 13 mg of “Chain MINTs of Example AA11b” were dispersed in 40 mL of tetrahydrofuran, by 5 minutes of sonication.

Step 2: 10 g of PVC polymer were added and mixture was stirred vigorously overnight, at 60° C.

Step 3: After stirring, precipitation process was carried out by pouring MINT-PVC solution into 300 mL of methanol.

Step 4: Finally, MINT-Polymer was dried in the oven at 60° C. and overnight.

Final product was named as “PVC_Chain_0.1 of Example AA14b”, (compound 35).

Steps 1 to 4 were carried out this time with 137 mg of “Chain MINTs of Example AA11b” obtaining the sample termed as “PVC_Chain_1.0 of Example AA14b”.

Same procedure was followed using “Glycol MINTs of Example AA11b”. In that way, compounds AA37 and AA38 were obtained, termed as “PVC_Glycol_0.1 of Example AA14b” and “PVC_Glycol_1.0 of Example AA14b”, respectively.

Same procedure was followed using SWNTs (Tuball from OCSiAl). In that way, compounds AA39 and AA40 were obtained, termed as “PVC_Tuball_0.1 of Example AA14b” and “PVC_Tuball_1.0 of Example AA14b”, respectively.

### Example AA15. LDPE Composites

AA15a. Neat Composite

Step 1: In a 100 mL round bottom flask, 10 g of LDPE polymer were dissolved in 40 mL of toluene and it was stirred vigorously overnight, at 110° C.

Step 2: After stirring, precipitation process was carried out by pouring the solution into 300 mL of methanol. Polymer powder-like was obtained.

Step 3: Polymer was filtered under vacuum.

Step 4: Finally, Neat-Polymer sample was dried in the oven at 60° C. and overnight.

Final product was named as “LDPE_Neat of Example AA15a”, (compound AA41).

AA15b. MINT Composite

SWNTs (Tuball from OCSiAl), “Chain MINTs of Example AA11b” and “Glycol MINTs of Example AA11b” were used for preparing different LDPE composites.

Step 1: In a 100 mL round bottom flask, 13 mg of “Chain MINTs of Example AA11b” were dispersed in 40 mL of toluene, by 5 minutes of sonication.

Step 2: 10 g of LDPE polymer were added and mixture was stirred vigorously overnight at 110° C.

Step 3: After stirring, precipitation process was carried out by pouring the solution into 300 mL of methanol. Polymer powder-like was obtained.

Step 4: Polymer was filtered under vacuum.

Step 5: Finally, MINT-Polymer was dried in the oven at 60° C. and overnight.

Final product was termed as “LDPE_Chain_0.1 of Example AA15b), (compound AA42).

Steps 1 to 4 were carried out this time with 137 mg of “Chain MINTs of Example AA11b” obtaining the sample termed as “LDPE_Chain_1.0 of Example AA14b”, (compound AA43).

Same procedure was followed using “Glycol MINTs of Example AA11b”. In that way, compounds AA44 and AA45 were obtained, termed as “LDPE_Glycol_0.1 of Example AA14b” and “LDPE_Glycol_1.0 of Example AA14b”, respectively.

Same procedure was followed using SWNTs (Tuball from OCSiAl). In that way, compounds AA46 and AA47 were obtained, termed as “LDPE_Tuball_0.1 of Example AA14b” and “LDPE_Tuball_1.0 of Example AA14b”, respectively.

### Example AA16. Nylon 6 Composites

AA16a. Neat Composite

Step 1: In a 100 mL round bottom flask, 10 g of PVC polymer were dissolved in 40 mL of toluene and it was stirred vigorously overnight, at 60° C.

Step 2: After stirring, precipitation process was carried out by pouring the solution into 300 mL of methanol.

Step 3: Finally, Neat-Polymer was dried in the oven at 60° C. and overnight.

Final product was named as “Nylon 6_Neat of Example AA16a”, (compound AA48).

AA16b. MINT Composite

SWNTs (Tuball from OCSiAl), “Chain MINTs of Example AA11b” and “Glycol MINTs of Example AA11b” were used for preparing different Nylon 6 composites.

Step 1: In a 100 mL round bottom flask, 13 mg of “Chain MINTs of Example AA11b” were dispersed in 40 mL of formic acid, by 5 minutes of sonication.

Step 2: 10 g of Nylon 6 polymer were added and mixture was stirred vigorously overnight at 110° C.

Step 3: After stirring, precipitation process was carried out by pouring the solution into 300 mL of water.

Step 4: Finally, MINT-Polymer was dried in the oven at 60° C. and overnight.

Final product was termed as “Nylon 6_Chain_0.1 of Example AA15b), (compound AA49).

Steps 1 to 4 were carried out this time with 137 mg of “Chain MINTs of Example AA11b” obtaining the sample termed as “Nylon 6_Chain_1.0 of Example AA14b”, (compound AA50).

Same procedure was followed using “Glycol MINTs of Example AA11b”. In that way, compounds AA51 and AA52 were obtained, termed as “Nylon 6_Glycol_0.1 of Example AA14b” and “Nylon 6_Glycol_1.0 of Example AA14b”, respectively.

Same procedure was followed using SWNTs (Tuball from OCSiAl). In that way, compounds AA53 and AA54 were obtained, termed as “Nylon 6_Tuball_0.1 of Example AA14b” and “Nylon 6_Tuball_1.0 of Example AA14b”, respectively.

### Example AA17. Dogbones

This example describes the procedure for the preparation of dogbone-shaped tensile testing specimen for the composites obtained in compound AA27 to AA46 were made following Example FF4_Matt.

For Tensile tests, an Instron 34-TM tensile testing machine was used with a 10 kN load cell, following the procedure described in Example FF5_Matt.

Results obtained in tensile test involving compounds AA27 to AA31 are labelled in FIG. 68.

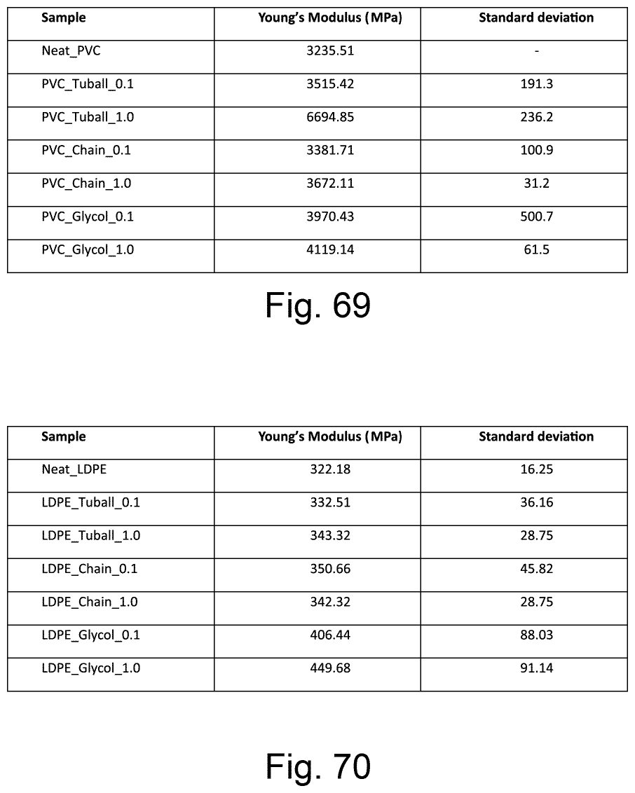

Results obtained in tensile test involving compounds AA32 to AA36 are labelled in FIG. 69.

Results obtained in tensile test involving compounds AA37 to AA41 are labelled in FIG. 70.

Dogbones for “Nylon 6_Composites” were too difficult to extract from the stainless molds.

Dispersions of the MINTs were good and polymer was precipitated and dried without problem.

### Example BB1. Preparation of 12 Different SWNT-ML Complexes Via Ball Milling

In this example, SWNTs were coated separately with pyrene U-shapes, diamine U-shapes, pyridine U-shapes, anthraflavic U-shapes, fluorenone U-shapes, amine U-shapes, acid U-shapes, methyl ester U-shapes, methyl alcohol U-shapes, polyethoxy U-shapes, chain U-shapes or glycol U-shapes to yield 12 different preparations of coated nanotubes.

### Preparation A: Pyrene MINT

Step 1: 250 mg of Tuball, 148 mg of pyrene U-shape (Pyrene U-shape of Example DD6) and 5 mg of Grubbs 2^{nd} generation catalyst were placed in a 20 mL ball milling reactor with 5 stainless steel balls (10 mm diameter).

Step 2: Ball milling was performed at 500 rpm for 10 minutes.

Step 3: The resultant mixture was placed in a round bottom flask containing about 50 mL of dichloromethane and bath sonicated for five minutes.

Step 4. The mixture was vacuum filtrated using a 0.2 μm pore size polytetrafluoroethylene (PFTE) membrane.

Step 5. The steps 3 and 4 were repeated three times. Diethyl ether was added in the final washing step and the sample was vacuum filtrated.

Step 6. The product was transferred to a glass vial and placed in the furnace at 150° C. for 3 hr.

Step 7. The final product of Step 6 was analysed by TGA. From the TGA the degree of functionalization (amount of U-shape relative to amount of SWNT) was determined to be 28%. Thus, the final product was called “Prep A: 28% pyrene MINT of Example BB1”.

### Preparation B: Diamine MINT

Step 1: 250 mg of Tuball, 148 mg of BOC-diamine U-shape (Diamino-boc U-shape of Example GG4a) and 5 mg of Grubbs 2^{nd} generation catalyst were placed in a 20 mL reactor with 5 stainless steel balls (10 mm diameter).

Step 2: Ball milling was performed at 500 rpm for 10 minutes.

Step 3: The resultant mixture was placed in a round bottom flask containing about 50 mL of dichloromethane and bath sonicated for five minutes.

Step 4. The mixture was vacuum filtrated using a 0.2 μm pore size polytetrafluoroethylene (PFTE) membrane.

Step 5. The steps 3 and 4 were repeated three times. Diethyl ether was added in the final washing step and the sample was vacuum filtrated.

Step 6. The product was placed in the furnace at 220° C. for 24 hr to remove tert-butyloxycarbonyl (BOC) protecting groups.

Step 7. The final product of Step 6 was analysed by TGA. From the TGA the degree of functionalization (amount of U-shape relative to amount of SWNT) was determined to be 28%. Thus, the final product was called “Prep B: 28% diamine MINT of Example BB1”.

### Preparation C: Pyridine MINT

Step 1: 140 mg of Tuball, 140 mg of pyridine U-shape (Pyridine U-shape of Example GG4a) and 73 mg of Grubbs 2^{nd} generation catalyst were placed in a 20 mL ball milling reactor with 5 stainless steel balls (10 mm diameter).

Step 2: Ball milling was performed at 500 rpm for 5 minutes.

Step 3: The resultant mixture was placed in a round bottom flask containing about 50 mL of dichloromethane and sonicated for five minutes.

Step 4. The mixture was vacuum filtrated using a 0.2 μm pore size polytetrafluoroethylene (PFTE) membrane.

Step 5. The steps 3 and 4 were repeated three times. Diethyl ether was added in the final washing step and the sample was vacuum filtrated.

Step 6. The product was placed in the furnace at 150° C. for 3 hr.

Step 7. The final product of Step 6 was analysed by TGA. From the TGA the degree of functionalization (amount of U-shape relative to amount of SWNT) was determined to be 28%. Thus, the final product was called “Prep C: 28% Pyridine MINT of Example BB1”.

### Preparation D: Anthraflavic MINT

Step 1: 500 mg of Tuball, 300 mg of anthraflavic U-shape (anthraflavic U-shape of Example EE5) and 250 mg of Grubbs 2^{nd} generation catalyst were placed in a 45 mL ball milling reactor with 5 stainless steel balls (10 mm diameter).

Step 2: Ball milling was performed at 500 rpm for 10 minutes.

Step 3: The resultant mixture was placed in a round bottom flask containing about 100 mL of dichloromethane and sonicated for five minutes.

Step 4. The mixture was vacuum filtrated using a 0.2 μm pore size polytetrafluoroethylene (PFTE) membrane.

Step 5. The steps 3 and 4 were repeated three times. Diethyl ether was added in the final washing step and the sample was vacuum filtrated.

Step 6. The product was placed in the furnace at 150° C. for 3 hr.

Step 7. The final product of Step 6 was analysed by TGA. From the TGA the degree of functionalization (amount of U-shape relative to amount of SWNT) was determined to be 23%. Thus, the final product was called “Prep D: 26% anthraflavic MINT of Example BB1”.

### Preparation E: Fluorenone MINT

Step 1: 250 mg of Tuball, 148 mg of fluorenone U-shape (fluorenone U-shape of Example AA4) and 5 mg of Grubbs 2^{nd} generation catalyst were placed in a 20 mL ball milling reactor with 5 stainless steel balls (10 mm diameter).

Step 2: Ball milling was performed at 500 rpm for 10 minutes.

Step 3: The resultant mixture was placed in a round bottom flask containing about 50 mL of dichloromethane and sonicated for five minutes.

Step 4. The mixture was vacuum filtrated using a 0.2 μm pore size polytetrafluoroethylene (PFTE) membrane.

Step 5. The steps 3 and 4 were repeated three times. Diethyl ether was added in the final washing step and the sample was vacuum filtrated.

Step 6. The product was placed in the furnace at 150° C. for 3 hr.

Step 7. The final product of Step 6 was analysed by TGA. From the TGA the degree of functionalization (amount of U-shape relative to amount of SWNT) was determined to be 28%. Thus, the final product was called “Prep E: 28% fluorenone MINT of Example BB1”.

### Preparation F: Amine MINT

Step 1: 85 mg of Tuball, 50 mg of amine U-shape (Pyreneamides Ushape of Example EE7) and 3.5 mg of Grubbs 2^{nd} generation catalyst were placed in a 20 mL ball milling reactor with 5 stainless steel balls (10 mm diameter).

Step 2: Ball milling was performed at 500 rpm for 10 minutes.

Step 3: The resultant mixture was placed in a round bottom flask containing about 50 mL of dichloromethane and sonicated for five minutes.

Step 4. The mixture was vacuum filtrated using a 0.2 μm pore size polytetrafluoroethylene (PFTE) membrane.

Step 5. The steps 3 and 4 were repeated three times. Diethyl ether was added in the final washing step and the sample was vacuum filtrated.

Step 6. The product was placed in the furnace at 150° C. for 3 hr.

Step 7. The final product of Step 6 was analysed by TGA. From the TGA the degree of functionalization (amount of U-shape relative to amount of SWNT) was determined to be 25%. Thus, the final product was called “Prep F: 25% amine MINT of Example BB1”.

### Preparation G: Acid MINT

Step 1: 1.5 g of Tuball, 662 mg of Acid U-shape (acid U-shape of Example EE3) and 61 mg of Grubbs 2^{nd} generation catalyst were placed in a 45 mL reactor with 5 stainless steel balls (10 mm diameter).

Step 2: Ball milling was performed at 500 rpm for 10 minutes.

Step 3: The resultant mixture was placed in a round bottom flask containing about 150 mL of dichloromethane and sonicated for five minutes.

Step 4. The mixture was vacuum filtrated using a 0.2 μm pore size polytetrafluoroethylene (PFTE) membrane.

Step 5. The steps 3 and 4 were repeated three times. Diethyl ether was added in the final washing step and the sample was vacuum filtrated.

Step 6. The product was placed in the furnace at 150° C. for 3 hr.

Step 7. The final product of Step 6 was analysed by TGA. From the TGA the degree of functionalization (amount of U-shape relative to amount of SWNT) was determined to be 15%. Thus, the final product was called “Prep G: 15% Acid MINT of Example BB1”.

### Preparation H: Ester MINT

Step 1: 1.1 g of Tuball, 500 mg of ester U-shape (ester U-shape of Example EE2) and 46 mg of Grubbs 2^{nd} generation catalyst were placed in a 80 mL reactor with 5 stainless steel balls (10 mm diameter).

Step 2: The ball miller was set to operate at 500 rpm for 10 minutes.

Step 3: The resultant mixture was placed in a round bottom flask containing about 150 mL of dichloromethane and sonicated for five minutes.

Step 4. The mixture was vacuum filtrated using a 0.2 μm pore size polytetrafluoroethylene (PFTE) membrane.

Step 5. The steps 3 and 4 were repeated three times. Diethyl ether was added in the final washing step and the sample was vacuum filtrated.

Step 6. The product was placed in the furnace at 150° C. for 3 hr.

Step 7. The final product of Step 6 was analysed by TGA. From the TGA the degree of functionalization (amount of U-shape relative to amount of SWNT) was determined to be 28%. Thus, the final product was called “Prep H: 28% ester MINT of Example BB1”.

### Preparation I: Methyl Alcohol MINT

Step 1: 920 mg g of Tuball, 400 mg of methyl alcohol U-shape (methyl alcohol U-shape of Example EE4) and 37.5 mg of Grubss 2^{nd} generation catalyst were placed in a 45 mL reactor with 5 stainless steel balls.

Step 2: The ball miller was set to operate at 500 rpm for 10 minutes.

Step 3: The resultant mixture was placed in a round bottom flask containing about 100 mL of dichloromethane and sonicated for five minutes.

Step 4. The mixture was vacuum filtrated using a 0.2 μm pore size polytetrafluoroethylene (PFTE) membrane.

Step 5. The steps 3 and 4 were repeated three times. Diethyl ether was added in the final washing step and the sample was vacuum filtrated.

Step 6. The product was placed in the furnace at 150° C. for 3 hr.

Step 7. The final product of Step 6 was analysed by TGA. From the TGA the degree of functionalization (amount of U-shape relative to amount of SWNT) was determined to be 22%. Thus, the final product was called “Prep I: 23% Methyl Alcohol MINT of Example BB1”.

### Preparation J: Polyethoxy MINT

Step 1: 304 g of Tuball, 133 mg of polyethoxy U-shape (Polyethoxy U-shape of Example DD5) and 6.2 mg of Grubss 2^{nd} generation catalyst were placed in a 45 mL ball milling reactor with 5 stainless steel balls (10 mm diameter).

Step 2: Ball milling was performed at 500 rpm for 10 minutes.

Step 3: The resultant mixture was placed in a round bottom flask containing about 50 mL of dichloromethane and sonicated for five minutes.

Step 4. The mixture was vacuum filtrated using a 0.2 μm pore size polytetrafluoroethylene (PFTE) membrane.

Step 5. The steps 3 and 4 were repeated three times. Diethyl ether was added in the final washing step and the sample was vacuum filtrated.

Step 6. The product was placed in the furnace at 150° C. for 3 hr.

Step 7. The final product of Step 6 was analysed by TGA. From the TGA the degree of functionalization (amount of U-shape relative to amount of SWNT) was determined to be 25%. Thus, the final product was called “Prep J: 25% polyethoxy MINT of Example BB1”.

### Preparation K: Chain MINT

Step 1: 1.25 g of Tuball, 600 mg of chain U-shape (chain U-shape of Example AA6) and 60 mg of Grubbs 2^{nd} generation catalyst were placed in a 45 mL reactor with 5 stainless steel balls (10 mm diameter).

Step 2: Ball milling was performed at 500 rpm for 10 minutes.

Step 3: The resultant mixture was placed in a round bottom flask containing about 150 mL of dichloromethane and sonicated for five minutes.

Step 4. The mixture was vacuum filtrated using a 0.2 μm pore size polytetrafluoroethylene (PFTE) membrane.

Step 5. The steps 3 and 4 were repeated three times. Diethyl ether was added in the final washing step and the sample was vacuum filtrated.

Step 6. The product was placed in the furnace at 150° C. for 3 hr.

Step 7. The final product of Step 6 was analysed by TGA. From the TGA the degree of functionalization (amount of U-shape relative to amount of SWNT) was determined to be 28%. Thus, the final product was called “Prep K: 28% chain MINT of Example BB1”.

### Preparation L: Glycol MINT

Step 1: 1.35 g of Tuball, 600 mg of glycol U-shape (glycol U-shape of Example AA7) and 55 mg of Grubbs 2^{nd} generation catalyst were placed in a 45 mL reactor with 5 stainless steel balls (10 mm diameter).

Step 2: The ball miller was set to operate at 500 rpm for 10 minutes.

Step 3: The resultant mixture was placed in a round bottom flask containing about 150 mL of dichloromethane and sonicated for five minutes.

Step 4. The mixture was vacuum filtrated using a 0.2 μm pore size polytetrafluoroethylene (PFTE) membrane.

Step 5. The steps 3 and 4 were repeated three times. Diethyl ether was added in the final washing step and the sample was vacuum filtrated.

Step 6. The product was placed in the furnace at 150° C. for 3 hr.

Step 7. The final product of Step 6 was analysed by TGA. From the TGA the degree of functionalization (amount of U-shape relative to amount of SWNT) was determined to be 24%. Thus, the final product was called “Prep L: 24% glycol MINT of Example BB1”.

### Example BB2. Protocol for Preparation of SWNT-ML/Polymer Composites, in the Shape of “Dog Bones” or Rectangles

This example provides the protocol for making the dog bone- and rectangle-shaped SWNT-ML/polymer composites by hot pressing.

The preparation of dog bone- and rectangle-shaped composites is conducted by the following steps.

Step 1. The SWNT-ML/polymer composite is placed onto polyimide foil and subsequently between two steel plates.

Step 2. The ‘sandwiched’ SWNT-ML composite is hot pressed at 180° C. with a load of 5 ton for 10 minutes using a hydraulic press with heating plates to yield composite films. Then, pressure is released and the composite film is cut into pieces and hot pressed again at the same conditions. This step is repeated five times to remove any remnant solvent in the composite.

Step 3. The SWNT-ML film is cut into small pieces. A mold in the form of a stainless steel plate with dog bone-shaped or rectangle-shaped orifices is coated with releasing agent. The mold is filled up with the SWNT-ML film pieces and subsequently hot pressed at 180° C. with a load of 10 ton.

Step 4. Dog bone- or rectangle-shaped SWNT-ML/polymer composite samples are retrieved by cooling down the hot press and demolding the samples manually.

### Example BB3. Composites Comprising Commercial PMMA and SWNT-ML Complexes Prepared Via Solvent Mixing

This example describes the preparation of PMMA-nanotube composites by solvent mixing employing different SWNT-ML complexes.

Commercial polymethylmethacrylate, abbreviated PMMA (Sigma-Aldrich, SKU 182265) was used as host polymer matrix.

10 different SWNT-ML/PMMA composites were prepared by the following steps.

Step 1. An appropriate amount (see specific amount hereunder) of SWNT-ML complexes were dispersed in 50 mL of toluene by mechanical stirring at 1500 rpm for 24 hrs.

Step 2. 19.7 g of commercial PMMA in powder form was added to the dispersion of Step 1 and the mixture was heated up at 60° C. with continuous mechanical stirring at 1500 rpm for 24 hr.

Step 3. The SWNT-ML/PMMA composite was retrieved by pouring out the mixture into a Teflon container, and subsequently the composite was placed in the oven at 80° C. overnight to evaporate the solvent.

Step 4. SWNT-ML/PMMA composites were shaped into dog bone form following the protocol described in Example BB2.

The 10 different SWNT-ML/PMMA composites (composites BB3.1-BB3.10) and the Neat PMMA control (Neat PMMA BB3.11) were prepared following the abovementioned protocol, with the following specifications:

Composite BB3.1 In Step 1, 347 mg of “Prep A: 28% pyrene MINT of Example B1” were added. The resulting composite material (dog bones) obtained from Step 4 were called “28% pyrene SWNT/PMMA of Example BB3”.

Composite BB3.2 In Step 1, 347 mg of “Prep B: 28% diamine MINT of Example B1” were added. The resulting composite material (dog bones) obtained from Step 4 were called “28% diamine SWNT/PMMA of Example BB3”.

Composite BB3.3 In Step 1, 333 mg of “Prep C: 25% pyridine MINT of Example B1” were added. The resulting composite material (dog bones) obtained from Step 4 were called “25% pyridine SWNT/PMMA of Example BB3”.

Composite BB3.4 In Step 1, 337 mg of “Prep D: 26% antraflavic acid MINT of Example EB1” were added. The resulting composite material (dog bones) obtained from Step 4 were called “26% anthraflavic SWNT/PMMA of Example BB3”.

Composite BB3.5 In Step 1, 173 mg of “Prep A: 28% pyrene MINT of Example BB1” and 173 mg of “Prep B: 28% diamine MINT of Example BB1” were added. The resulting composite material (dog bones) obtained from Step 4 were called “28% pyrene/25% diamine SWNT/PMMA of Example BB3”.

Composite BB3.6 In Step 1, 173 mg of “Prep A: 28% pyrene MINT of Example BB1” and 166 mg of Prep C: 25% pyridine MINT of Example BB1” were added. The resulting composite material (dog bones) obtained from Step 4 were called “28% pyrene/25% pyridine SWNT/PMMA of Example BB3”.

Composite BB3.7 In Step 1, 173 mg of “Prep B: 28% diamine MINT of Example BB1” and 166 mg of Prep C: 25% pyridine MINT of Example BB1” were added. The resulting composite material (dog bones) obtained from Step 4 were called “28% diamine/25% pyridine SWNT/PMMA of Example BB3”.

Composite BB3.8 In Step 1, 115.6 mg of “Prep A: 28% pyrene MINT of Example BB1”, 115.6 mg of Prep C: 28% diamine MINT of Example BB1” and 111 mg of “Prep C: 25% pyridine MINT of Example BB1” were added. The resulting composite material (dog bones) obtained from Step 4 were called “28% pyrene/28% diamine/25% pyridine SWNT/PMMA of Example BB3”.

Composite BB3.9 In Step 1, 115.6 mg of “Prep A: 28% pyrene MINT of Example BB1”, 115.6 mg of Prep C: 28% diamine MINT of Example BB1” and 112.3 mg of “Prep D: 26% antraflavic acid MINT of Example BB1” were added. The resulting composite material (dog bones) obtained from Step 4 were called “28% pyrene/28% diamine/26% anthraflavic SWNT/PMMA of Example BB3”.

Composite 1B13.10 In step 1, 250 mg of Tuball (from OCSiAl) was added as a control sample. The resulting composite material (dog bones) obtained from Step 4 were called “Tuball SWNT/PMMA of Example BB3”.

Neat PMMA 113.11 In step 1, no SWNT-ML complexes were added. The resulting material (dog bones) obtained from Step 4, was called “neat PMMA of Example BB3”.

Mechanical characterisation of SWNT-ML/PMMA was conducted by tensile test measurements. Summary of Young's modulus and tensile strength data and their respective calculated load transfer is shown in the Table below.

| | | Load | | Load |
|---|---|---|---|---|
| | | transfer | Maximum | transfer |
| | Young's | calculated | tensile | calculated |
| | Modulus | from | strength | from TS |
| Composite | (MPa) | YM (%) | (MPa) | (%) |
| neat PMMA | 2476 | — | 48.35 | — |
| 28% pyrene SWNT/PMMA | 3405.22 | 87.75 | 50.62 | 2.04 |
| 28% diamine SWNT/PMMA | 3364.84 | 83.99 | 46.59 | −1.16 |
| 25% pyridine SWNT/PMMA | 3871.69 | 131.19 | 50.61 | 2.04 |
| 26% anthraflavic | 3266.18 | 74.81 | 56 | 7.40 |
| SWNT/PMMA | | | | |
| 28% pyrene/25% diamine | 4107.72 | 153.16 | 43.118 | −3.91 |
| SWNT/PMMA | | | | |
| 28% pyrene/25% pyridine | 3530.88 | 99.45 | 62.28 | 11.30 |
| SWNT/PMMA | | | | |
| 28% diamine/25% pyridine | 3559 | 102.07 | 61.75 | 10.88 |
| SWNT/PMMA | | | | |
| 28% pyrene/28% diamine/25% | 3426.76 | 89.76 | 61.87 | 10.97 |
| pyridine SWNT/PMMA | | | | |
| 28% pyrene/28% diamine/26% | 3112.14 | 60.46 | 43.36 | −3.72 |
| anthraflavic SWNT/PMMA | | | | |
| Tuball SWNT/PMMA | 3419.89 | 89.2 | 56.57 | 6.77 |

The total concentration of the filler in all composites is 1%. The percentage shown corresponds to the functionalisation of the SWNT-ML.

PMMA composites prepared with the combination of pyrene, pyridine and diamine U-shapes exhibit higher tensile strength compared to the values when their respective single U-shapes are employed. On the other hand, the highest Young's modulus is observed for the composite prepared with the combination of pyrene and diamine U-shapes showing a moderate load transfer of 153%.

### Example BB4. Composites Comprising Commercial PMMA and SWNT-ML Complexes Prepared Via Shear Mixing

This example describes the preparation of PMMA-nanotubes composites with different SWNTs-ML via shear mixing employing the dispersing tool ULTRA-TURRAX T 25.

Commercial polymethylmethacrylate, abbreviated PMMA (Sigma-Aldrich, SKU 182265) was used as host polymer matrix.

Step 1. An appropriate amount (see specific amount hereunder) of SWNT-ML complex and 6.990 g of commercial PMMA were placed into a 50 mL glass jacketed cell.

Step 2. The glass jacketed cell was connected with tubing to water supply to cool the cell, in order to avoid the evaporation of the solvent in the cell.

Step 3. 50 mL of chloroform were added to the mixture and the dispersing tool was operated at 7,000 rpm for 7 hr.

Step 4. The SWNT-ML/PMMA composite was retrieved by pouring out the mixture into a 500 mL beaker containing 300 mL of isopropanol.

Step 5. The precipitated composite was placed in a Teflon container and dried in the oven at 80° C. overnight to evaporate the solvent.

Then the SWNT-ML/PMMA composites were shaped into dog bones following the procedure described in Example BB2.

Dog bones from 9 different SWNT-ML/PMMA composites (composites BB4.1-BB4.10) and a Neat PMMA control (neat PMMA BB4.10) were prepared following the abovementioned protocol, with the following specifications:

Composite BB4.1 In Step 1, 9 mg of “Prep F: 22% amine MINT of Example B1” were added. The resulting composite material (dog bones) obtained from Step 5 were called “22% amine SWNT/PMMA_ShMx of Example BB4”.

Composite BB4.2 In Step 1, 8.2 mg of “Prep G: 15% Acid MINT of Example B1” were added. The resulting composite material (dog bones) obtained from Step 5 were called “15% Acid SWNT/PMMA_ShMx of Example BB4”.

Composite BB4.3 In Step 1, 9.7 mg of “Prep H: 28% ester MINT of Example B1E” were added. The resulting composite material (dog bones) obtained from Step 5 were called “28% ester SWNT/PMMA_ShMx of Example BB4”.

Composite BB4.4 In Step 1, 9.3 mg of “Prep C: 25% pyridine MINT of Example B1” were added. The resulting composite material (dog bones) obtained from Step 5 were called “25% pyridine SWNT/PMMA_ShMx of Example BB4”.

Composite BB4.5 In Step 1, 9.1 mg of “Prep I: 23% methyl alcohol MINT of Example BB1” were added. The resulting composite material (dog bones) obtained from Step 5 were called “23% methyl alcohol SWNT/PMMA of Example BB4”.

Composite BB4.6 In Step 1, 9.3 mg of “Prep J: 25% polyethoxy MINT of Example B1E” were added. The resulting composite material (dog bones) obtained from Step 5 were called “25% polyethoxy SWNT/PMMA of Example BB4”.

Composite BB4.7 In Step 1, 9.7 mg of “Prep K: 28% chain MINT of Example B1E” were added. The resulting composite material (dog bones) obtained from Step 5 were called “28% chain SWNT/PMMA_ShMx of Example BB4”.

Composite BB4.8 In Step 1, 9.2 mg of “Prep L: 24% glycol MINT of Example BB1” added.

The resulting composite material (dog bones) obtained from Step 5 were called “24% glycol SWNT/PMMA_ShMx of Example BB4”.

Composite BB4.9 In step 1, 7 mg of Tuball (from OCSiAl) was added as a control sample. The resulting composite material (dog bones) obtained from Step 5 were called “Tuball SWNT/PMMA_ShMx of Example BB4”.

Neat PMMA BB 4.10. In step 1, no SWNT-ML complex was added. The resulting polymer material (dog bones) obtained from step 5 were called “Neat PMMA of Example BB4”.

Mechanical characterisation of SWNT-ML/PMMA was conducted by tensile test measurements. Summary of Young's modulus and tensile strength data and their respective calculated load transfer values is shown in the table below.

| | | Load | | Load |
|---|---|---|---|---|
| | | transfer | Maximum | transfer |
| | Young's | calculated | tensile | calculated |
| | Modulus | from YM | strength | from TS |
| Composite | (MPa) | (%) | (MPa) | (%) |
| neat PMMA_ShMx | 2476 | — | 48.35 | — |
| 22% amine SWNT/PMMA_ShMx | 3315.4 | 669.66 | 79.44 | 247.82 |
| 15% acid SWNT/PMMA_ShMx | 3247.38 | 615.50 | 80.85 | 259.04 |
| 28% ester SWNT/PMMA_ShMx | 3596.42 | 893.44 | 78.97 | 244.07 |
| 25% pyridine SWNT/PMMA_ShMx | 3256.15 | 622.48 | 68.21 | 158.39 |
| 23% methyl alcohol | 3586.63 | 885.65 | 66.04 | 141.11 |
| SWNT/PMMA_ShMx | | | | |
| 25% polyethoxy SWNT/PMMA_ShMx | 3330.77 | 681.90 | 69.41 | 167.95 |
| 28% chain SWNT/PMMA_ShMx | 3071.18 | 475.19 | 67.07 | 149.31 |
| 24% glycol SWNT/PMMA_ShMx | 3611.84 | 905.72 | 75.64 | 217.56 |
| Tuball SWNT/PMMA_ShMx | 3447.04 | 774.49 | 77.17 | 229.74 |

The total concentration of the filler in all composites is 0.1%. The percentage shown corresponds to the functionalisation of the SWNT-ML.

All of the U-shapes at 0.1% filler loading exhibit higher Young's modulus and tensile strength than the neat PMMA polymer and even higher than pristine SWNNT. For instance, Young's Modulus of composites prepared with ester, methyl alcohol and glycol U-shapes are higher than that of Tuball. On the other hand, the tensile strength data of such composites are close to that of Tuball with the exception of the methyl alcohol U-shape.

### Example BB5. Composites Comprising Commercial Polystyrene (PS) and SWNT-ML Complexes were Prepared Via Solution Mixing

This example describes the preparation of PS-nanotube composites via solvent mixing employing different SWNTs-ML.

Commercial polystyrene, abbreviated PS (average Mn-192,000 Sigma-Aldrich, SKU 430102) was used as host polymer matrix.

SWNT-ML/PS composites were prepared by the following protocol.

Step 1. An appropriate amount (see specific amount hereunder) of SWNT-ML complexes were dispersed in 50 mL of acetone via ultrasonication for 1 hr.

Step 2. 3 g of commercial PS in pellet form was added to the SWNT-ML dispersion from step 1 and the mixture was heated up at 60° C. with continuous mechanical stirring for 24 hr at 1500 rpm.

Step 3. The SWNT-ML/PS composite was retrieved by pouring out the mixture into a Teflon container, and subsequently the composite was placed in the oven at 80° C. overnight to evaporate the solvent.

Step 4. SWNT-ML/PS composites were shaped into rectangle form following the procedure described in Example BB2.

6 different SWNT-ML/PS composites (composites BB5.1-BB5.6) and a Neat PS control sample (Neat PS BB5.7) were prepared following the abovementioned protocol, with the following specifications:

Composite BB5.1 In Step 1, 41.6 mg of “Prep A: 28% pyrene MINT of Example B1” was added. The resulting composite material (rectangles) obtained from step 4 were called “28% pyrene SWNT/PS of Example BB5”.

Composite BB5.2 In Step 1, 41.6 mg of “Prep B: 28% diamine MINT of Example B1” was added. The resulting composite material (rectangles) obtained from step 4 were called “28% diamine SWNT/PS of Example BB5”.

Composite BB5.3 In Step 1, 40 mg of “Prep C: 25% pyridine MINT of Example BB1” was added. The resulting composite material (rectangles) obtained from step 4 were called “25% pyridine SWNT/PS of Example BB5.

Composite BB5.4 In Step 1, 20.8 mg of “Prep A: 28% pyrene MINT of Example BB1” and 20.8 mg of “Prep B: 28% diamine MINT of Example BB1” were added. The resulting composite material (rectangles) obtained from step 4 were called “28% pyrene/25% diamine SWNT/PS of Example BB5”.

Composite BB5.5 In Step 1, 20.8 mg of “Prep A: 28% pyrene MINT of Example BB1” and 20 mg of Prep C: 25% pyridine MINT of Example BB1” were added. The resulting composite material (rectangles) obtained from step 4 were called “28% pyrene/25% pyridine SWNT/PS of Example BB5.

Composite BB5.6 In Step 1, 20.8 mg of “Prep B: 28% diamine MINT of Example BB1” and 20 mg of Prep C: 25% pyridine MINT of Example BB1” were added. The resulting composite material (rectangles) obtained from step 4 were called “28% diamine/25% pyridine SWNT/PS of Example BB5”.

Neat PS BB5.7 In step 1, no SWNT-ML complex was added. The resulting composite material (rectangles) obtained from step 4 were called “Neat polystyrene of Example BB5”.

Mechanical characterisation of SWNT-ML/PS composites was conducted by dynamic mechanical analysis (DMA). Summary of storage moduli with their respective calculated load transfer and transition glass temperature, Tg, data is shown in the table below.

| | | Load | |
|---|---|---|---|
| | | transfer | Glass |
| | Storage | calculated | transition |
| | Modulus | from SM | temperature |
| Composite | (MPa) | (%) | (° C.) |
| neat PS | 2037 | — | 112 |
| 28% pyrene SWNT/PS | 2505.34 | 220.40 | 114 |
| 28% diamine SWNT/PS | 2550.11 | 241.50 | 113 |
| 25% pyridine SWNT/PS | 2589.17 | 259.78 | 115 |
| 28% pyrene/25% | 2736.36 | 328.69 | 114 |
| diamine SWNT/PS | | | |
| 28% pyrene/25% | 2534.76 | 234.35 | 121 |
| pyridine SWNT/PS | | | |
| 28% diamine/25% | 2800.25 | 358.81 | 119 |
| pyridine SWNT/PS | | | |

The total concentration of the filler in all composites is 1%. The percentage shown corresponds to the functionalisation of the SWNT-ML.

PS composites prepared by mixing pyrene/diamine and diamine/pyridine U-shapes show load transfer above 300% compared to the composites made with their respective single U-shapes. The combined pyrene/pyridine U-shapes composite exhibits an important increase of 9° C. in the glass transition temperature with respect to that of the neat polymer.

### Example BB6. Composites Comprising Commercial LDPE and SWNT-ML Complexes, Prepared Via Shear Mixing

This example describes the preparation of LDPE-nanotubes composites with different SWNTs-ML via shear mixing employing the dispersing tool ULTRA-TURRAX T 25.

Commercial low density polyethylene in powder form, abbreviated LDPE (Alfa Aesar, SKU A10239.36) was used as host polymer matrix.

SWNT-ML/LDPE composites were prepared by the following steps.

Step 1. An appropriate amount (see specific amount hereunder) of SWNT-ML complexes and 6.990 g of commercial LDPE were placed into a 50 mL glass jacketed cell.

Step 2. The glass jacketed cell was connected with tubing to water supply for its recirculation to avoid the evaporation of the solvent in the glass cell.

Step 3. 50 mL of chloroform were added to the mixture and the dispersing tool was operated at 14,000 rpm for 3 hr.

Step 4. The SWNT-ML/LDPE composite was retrieved by pouring out the mixture into a glass Petri dish container, and subsequently the composite was placed in the oven at 80° C. overnight to evaporate the solvent.

Step 5. SWNT-ML/LDPE_ShMx composites were shaped into dog bone shape following the procedure described in Example BB2.

8 different SWNT-ML/LDPE_ShMx composites (composites BB6.1-BB6.8) and a Neat LDPE control sample (Neat LDPE BB6.9) were prepared following the abovementioned protocol, and the below specifications:

Composite BB6.1 In Step 1, 9.7 mg of “Prep A: 28% pyrene MINT of Example B1” were added. The resulting composite material (dog bones) obtained from step 5 were called “28% pyrene SWNT/LDPE_ShMx of Example BB6”.

Composite BB6.2 In Step 1, 9.3 mg of “Prep C: 25% pyridine MINT of Example B1E” were added. The resulting composite material (dog bones) obtained from step 5 were called “25% pyridine SWNT/LDPE_ShMx of Example BB6”.

Composite BB6.3 In Step 1, 9.2 mg of “Prep L: 24% glycol MINT of Example BB1” added.

The resulting composite material (dog bones) obtained from step 5 were called “24% glycol SWNT/LDPE_ShMx of Example BB6”.

Composite EE6.4 In Step 1, 8.2 mg of “Prep G: 15% Acid MINT of Example BB1” were added. The resulting composite material (dog bones) obtained from step 5 were called “15% Acid SWNT/LDPE_ShMx of Example BB6”.

Composite BB6.5 In Step 1, 9.7 mg of “Prep K: 28% chain MINT of Example BB1” were added. The resulting composite material (dog bones) obtained from step 5 were called “28% chain SWNT/LDPE_ShMx of Example BB6”.

Composite BB6.6 In Step 1, 9.7 mg of “Prep E: 28% fluorenone MINT of Example BB1” were added. The resulting composite material (dog bones) obtained from step 5 were called “28% fluorenone SWNT/LDPE_ShMx of Example BB6”.

Composite BB6.7 In Step 1, 9.3 mg of “Prep J: 25% polyethoxy MINT of Example BB1” were added. The resulting composite material (dog bones) obtained from step 5 were called “25% polyethoxy SWNT/LDPE_ShMx of Example BB6”.

Composite BB6.8 In step 1.7 mg of Tuball (from OCSiAl) was added as a control sample.

The resulting composite material (dog bones) obtained from step 5 were called “Tuball SWNT/LDPE_ShMx of Example BB6”.

Neat LDPE BB6.9 In step 1, no SWNT-ML was added. The resulting polymer material (dog bones) obtained from step 5 were called “Neat LDPE_ShMx of Example BB6”.

Mechanical characterisation of SWNT-ML/LDPE was conducted by tensile test measurements. Summary of Young's modulus and tensile strength data with their respective calculated load transfer values is shown in the table below.

| | | Load | | Load |
|---|---|---|---|---|
| | | transfer | Maximum | transfer |
| | Young's | calculated | tensile | calculated |
| | Modulus | from YM | strength | from TS |
| Composite | (MPa) | (%) | (MPa) | (%) |
| neat LDPE_ShMx | 155.2 | — | 14.92 | — |
| 28% pyrene SWNT/LDPE_ShMx | 169.9 | 15.42 | 12.67 | −23.41 |
| 25% pyridine SWNT/LDPE_ShMx | 158.16 | 3.17 | 13.41 | −15.68 |
| 24% glycol SWNT/LDPE_ShMx | 156.01 | 0.92 | 11.55 | −35.10 |
| 15% Acid SWNT/LDPE_ShMx | 136.78 | −19.15 | 8.3 | −69.03 |
| 28% chain SWNT/LDPE_ShMx | 165.65 | 10.99 | 15.06 | 1.53 |
| 28% fluorenone SWNT/LDPE_ShMx | 148.31 | −7.11 | 16.29 | 14.37 |
| 25% polyethoxy SWNT/LDPE_ShMx | 154.63 | −0.52 | 16.35 | 15 |
| Tuball SWNT/LDPE_ShMx | 168.43 | 13.89 | 13.99 | −9.63 |

The total concentration of the filler in all composites is 0.1%. The percentage shown corresponds to the functionalisation of the SWNT-ML.

LDPE composites prepared with pristine Tuball, Pyrene and Chain U-shapes possess higher Young's Moduli, however, this is not the case for the tensile strength where the fluorine U-shape shows the highest values with a load transfer of 14%.

### Example BB7. Composites Comprising Commercial PVDF and SWNT-ML Complexes Prepared Via Shear Mixing

This example describes the preparation of PVDF-nanotube composites via solvent mixing employing different SWNT-ML complexes.

Commercial polyvinylidene fluoride, abbreviated PVDF (Alfa Aesar, SKU 44080.36) was used as host polymer matrix.

SWNT-ML/PVDF composites were prepared by the following steps.

Step 1. An appropriate amount (see specific amount hereunder) of SWNT-ML was added to 7 g of PVDF and mixed in 50 mL of acetone using a dispersing instrument T25 digital ULTRA-TURRAX at a speed of 7000 rpm for 3 hr.

Step 2. The composite was retrieved by pouring out the mixture in 300 mL deionized water under constant stirring leading to its precipitation.

Step 3. The precipitated composite was placed into a Teflon container and dried in isothermal oven at 80° C. overnight.

The 7 different nanotube composites (composites BB4.1-BB4.7) and a Neat PVDF control sample (Neat PVDF BB7.8) were prepared following the abovementioned general dog bone preparation protocol, with the following specifications:

Composite BB7.1 In Step 1, 9.7 mg of “Prep A: 28% pyrene MINT of Example B1” were added. The resulting composite material (dog bones) obtained from step 3 were called “28% pyrene SWNT/PVDF_ShMx of Example BB7”.

Composite BB7.2 In Step 1, 8.2 mg of “Prep G: 15% Acid MINT of Example B1E” were added. The resulting composite material (dog bones) obtained from step 3 were called “15% Acid SWNT/PVDF_ShMx of Example BB7”.

Composite BB7.3 In Step 1, 9.7 mg of “Prep E: 28% fluorenone MINT of Example BB1” were added. The resulting composite material (dog bones) obtained from step 3 were called “28% fluorenone SWNT/PVDF_ShMx of Example BB7”.

Composite BB7.4 In Step 1, 9.2 mg of “Prep L: 24% glycol MINT of Example BB1” added.

The resulting composite material (dog bones) obtained from step 3 were called “24% glycol SWNT/PVDF_ShMx of Example BB7”.

Composite EE7.5 In Step 1, 9.3 mg of “Prep C: 25% pyridine MINT of Example BB1” were added. The resulting composite material (dog bones) obtained from step 3 were called “25% pyridine SWNT/PVDF_ShMx of Example BB7”.

Composite EE7.6 In Step 1, 9.7 mg of “Prep K: 28% chain MINT of Example BB1” were added. The resulting composite material (dog bones) obtained from step 3 were called “28% chain SWNT/PVDF_ShMx of Example BB7”.

Composite EE7.7 In step 1, 7 mg of Tuball (from OCSiAl) was added as a control sample.

The resulting composite material (dog bones) obtained from step 3 were called “Tuball SWNT/PVDF_ShMx of Example BB7”.

Neat PVDF EE7.8 In step 1, no SWNT-ML complexes were added. The resulting polymer material (dog bones) obtained from step 3 were called “Neat PVDF_ShMx of Example BB7”.

Mechanical characterisation of SWNT-ML/PVDF was conducted by tensile test measurements. Summary of Young's modulus and tensile strength data with their respective calculated load transfer values is shown in the table below.

| | | Load | | Load |
|---|---|---|---|---|
| | | transfer | Maximum | transfer |
| | Young's | calculated | tensile | calculated |
| | Modulus | from YM | strength | from TS |
| Composite | (MPa) | (%) | (MPa) | (%) |
| neat PVDF_ShMx | 1206.12 | | 42.94 | |
| 28% pyrene SWNT/PVDF_ShMx | 1388.17 | 96.74 | 41.92 | −5.17 |
| 15% Acid SWNT/PVDF_ShMx | 1505.51 | 158.70 | 46.74 | 20.28 |
| 28% fluorenone SWNT/PVDF_ShMx | 1475.48 | 142.84 | 47.26 | 23.03 |
| 24% glycol SWNT/PVDF_ShMx | 1147.35 | −30.43 | 42.22 | −3.56 |
| 25% pyridine SWNT/PVDF_ShMx | 1473.66 | 141.88 | 47.28 | 23.13 |
| 28% chain SWNT/PVDF_ShMx | 1304.25 | 52.42 | 43.67 | 4.07 |
| Tuball SWNT/PVDF_ShMx | 1557.23 | 186.01 | 46.57 | 19.38 |

The total concentration of the filler in all composites is 0.1%. The percentage shown corresponds to the functionalisation of the SWNT-ML.

PVDF composite comprising Tuball exhibits the highest Young's Modulus compared to the neat polymer, this is followed by the acid U-shape, showing load transfers of 186% and 158%, respectively. On the other hand, the tensile strength is slightly improved by the incorporation of fluorenone and pyridine U-shapes achieving load transfers of 23% in both cases.

### Example BB8. Composites Comprising Commercial PS and SWNT-ML Complexes Prepared Via Shear Mixing

This example describes the preparation of PS-nanotube composites via solvent mixing employing different SWNTs-ML.

Commercial polystyrene, abbreviated PS (average Mₙ 192000 Sigma-Aldrich, SKU 430102) was used as host polymer matrix.

SWNT-ML/PS composites were prepared by the following steps.

Step 1. An appropriate amount (see specific amount hereunder) of SWNTs-ML complexes was added to 7 g of PS and mixed in 50 mL of chloroform using a dispersing instrument T25 digital ULTRA-TURRAX at a speed of 9000 rpm for 2 hr.

Step 2. The composite was retrieved by pouring out the mixture into a 500 mL beaker containing 300 mL of isopropanol.

Step 3. The precipitated composite was placed in a Teflon container and dried in isothermal oven at 80° C. overnight.

8 different nanotube composites (composites BB8.1-BB8.8) and a neat PS control sample (Neat PS BB8.9) were prepared following the abovementioned general dog bone preparation protocol, with the following specifications:

Composite BB8.1 In Step 1, 9.7 mg of “Prep A: 28% pyrene MINT of Example B1” were added. The resulting composite material (dog bones) were called “28% pyrene SWNT/PS_ShMx of Example BB8”.

Composite BB8.2 In Step 1, 9.3 mg of “Prep C: 25% pyridine MINT of Example B1E” were added. The resulting composite material (dog bones) obtained from step 3 were called “25% pyridine SWNT/PS_ShMx of Example BB8”.

Composite BB8.3 In Step 1, 9.2 mg of “Prep L: 24% glycol MINT of Example BB1” added. The resulting composite material (dog bones) obtained from step 3 were called “24% glycol SWNT/PS_ShMx of Example BB8”.

Composite BB8.4 In Step 1, 8.2 mg of “Prep G: 15% Acid MINT of Example B1” were added. The resulting composite material (dog bones) obtained from step 3 were called “15% Acid SWNT/PS_ShMx of Example BB8”.

Composite BB8.5 In Step 1, 9.7 mg of “Prep K: 28% chain MINT of Example B1E” were added. The resulting composite material (dog bones) obtained from step 3 were called “28% chain SWNT/PS_ShMx of Example BB8”.

Composite BB8.6 In Step 1, 9.3 mg of “Prep J: 25% polyethoxy MINT of Example BB1” were added. The resulting composite material (dog bones) obtained from step 3 were called “25% polyethoxy SWNT/PS_ShMx of Example BB8”.

Composite BB8.7 In Step 1, 9.3 mg of “Prep F: 22% amine MINT of Example BB1” were added. The resulting composite material (dog bones) obtained from step 3 were called “22% amine SWNT/PS_ShMx of Example BB8”.

Composite BB8.8 In step 1, 7 mg of Tuball was added as a control sample. The resulting composite material (dog bones) obtained from step 3 were called “Tuball SWNT/PS_ShMx of Example BB8”.

Neat PS BB8.9 In step 1, no SWNT-ML complex was added. The resulting composite material (dog bones) obtained from step 3 were called “Neat PS_ShMx of Example BB8”.

Mechanical characterisation of SWNT-ML/PMMA was conducted by tensile test measurements. Summary of Young's modulus and tensile strength data with their respective calculated load transfer values is shown in the table below.

| | | Load | | Load |
|---|---|---|---|---|
| | | transfer | Maximum | transfer |
| | Young's | calculated | tensile | calculated |
| | Modulus | from YM | strength | from TS |
| Composite | (MPa) | (%) | (MPa) | (%) |
| neat PS_ShMx | 2983 | — | 34.14 | |
| 28% pyrene SWNT/PS_ShMx | 3305.06 | 316.69 | 40.99 | 67.31 |
| 25% pyridine SWNT/PS_ShMx | 3263.65 | 276.16 | 43.61 | 92.95 |
| 24% glycol SWNT/PS_ShMx | 3410.4 | 419.78 | 26.3 | −76.46 |
| 15% Acid SWNT/PS_ShMx | 3243.74 | 256.67 | 50.94 | 164.69 |
| 28% chain SWNT/PS_ShMx | 2877.58 | −101.68 | 35.45 | 13.09 |
| 25% polyethoxy SWNT/PS_ShMx | 3288.54 | 300.52 | 47.47 | 130.73 |
| 22% amine SWNT/PS_ShMx | 2806.47 | −171.28 | 40.31 | 60.65 |
| Tuball/PS_ShMx | 3480.57 | 488.46 | 45.16 | 108.12 |

The total concentration of the filler in all composites is 0.1%. The percentage shown corresponds to the functionalisation of the SWNT-ML.

Tuball and glycol U-shape composites show load transfers, estimated from Young's Moduli, above 400%. However, an important increase in tensile strength of the composite is obtained with the incorporation of acid and polyethoxy U-shapes, superseding load transfer of Tuball by 56% and 22%, respectively.

### Example BB9. Composites Comprising Commercial PC and SWNT-ML Complexes Prepared Via Shear Mixing

This example describes the preparation of PC-nanotube composites via solvent mixing employing different SWNTs-ML.

Commercial polycarbonate, abbreviated PC (Good Fellow, SKU CT30-GL-000110) was used as host polymer matrix.

SWNT-ML/PC composites were prepared by the following steps.

Step 1. An appropriate amount (see specific amount hereunder) of SWNTs-ML complexes was added to 3.495 g of PC and mixed in 40 mL of chloroform using a dispersing instrument T25 digital ULTRA-TURRAX at a speed of 10000 rpm for 1 hr.

Step 2. The composite was retrieved by pouring out the mixture into a 500 mL beaker containing 150 mL of isopropanol.

Step 3. The precipitated composite was placed in a Teflon container and dried in isothermal oven at 80° C. overnight.

9 different nanotube composites (composites BB9.1-BB8.9) a neat PC control sample (Neat PC BB9.10) were prepared following the abovementioned general dog bone preparation protocol, with the following specifications:

Composite BB9.1 In Step 1, 4.86 mg of “Prep A: 28% pyrene MINT of Example B1” were added. The resulting composite material (dog bones) were called “28% pyrene SWNT/PC_ShMx of Example BB9”.

Composite BB9.2 In Step 1, 4.66 mg of “Prep C: 25% pyridine MINT of Example B1E” were added. The resulting composite material (dog bones) obtained from step 3 were called “25% pyridine SWNT/PC_ShMx of Example BB9”.

Composite BB9.3 In Step 1, 4.60 mg of “Prep L: 24% glycol MINT of Example BB1” added.

The resulting composite material (dog bones) obtained from step 3 were called “24% glycol SWNT/PC_ShMx of Example BB9”.

Composite EE9.4 In Step 1, 4.11 mg of “Prep G: 15% Acid MINT of Example BB1” were added. The resulting composite material (dog bones) obtained from step 3 were called “15% Acid SWNT/PC_ShMx of Example BB9”.

Composite EE9.5 In Step 1, 4.86 mg of “Prep K: 28% chain MINT of Example BB1” were added. The resulting composite material (dog bones) obtained from step 3 were called “28% chain SWNT/PC_ShMx of Example BB9”.

Composite BB9.6 In Step 1, 4.66 mg of “Prep J: 25% polyethoxy MINT of Example BB1” were added. The resulting composite material (dog bones) obtained from step 3 were called “25% polyethoxy SWNT/PC_ShMx of Example BB9”.

Composite BB9.7 In Step 1, 4.86 mg of “Prep E: 28% fluorenone MINT of Example BB1” were added. The resulting composite material (dog bones) obtained from step 3 were called “28% fluorenone SWNT/PC_ShMx of Example BB9”.

Composite BB9.8 In Step 1, 4.86 mg of “Prep H: 28% ester MINT of Example BB1” were added. The resulting composite material (dog bones) obtained from step 3 were called “28% ester SWNT/PC_ShMx of Example BB9”.

Composite BB9.9 In step 1, 3.5 mg of Tuball was added as a control sample. The resulting composite material (dog bones) obtained from step 3 were called “Tuball SWNT/PC_ShMx of Example BB9”.

Neat PC BB9.10 In step 1, no SWNT-ML complex was added. The resulting composite material (dog bones) obtained from step 3 were called “Neat PC_ShMx of Example BB9”.

Mechanical characterisation of SWNT-ML/PC was conducted by tensile test measurements. Summary of Young's modulus and tensile strength data with their respective calculated load transfer values is shown in the table below.

| | | Load | | Load |
|---|---|---|---|---|
| | | transfer | Maximum | transfer |
| | Young's | calculated | tensile | calculated |
| | Modulus | from YM | strength | from TS |
| Composite | (MPa) | (%) | (MPa) | (%) |
| neat PC | 2249 | — | 70.43 | — |
| 28% pyrene SWNT/PC_ShMx | 2298.92 | 40.14 | 76.9 | 51.01 |
| 25% pyridine SWNT/PC_ShMx | 2189.59 | −45.47 | 79.16 | 68.71 |
| 24% glycol SWNT/PC_ShMx | 2231.35 | −12.77 | 65.16 | −40.91 |
| 15% Acid SWNT/PC_ShMx | 2256.05 | 6.57 | 73.06 | 20.94 |
| 28% chain SWNT/PC_ShMx | 2233.01 | −11.47 | 75.83 | 42.63 |
| 25% polyethoxy SWNT/PC_ShMx | 2399.65 | 119.02 | 67.1 | −25.72 |
| 28% fluorenone SWNT/PC_ShMx | 2284.5 | 28.85 | 75.15 | 37.31 |
| 28% ester SWNT/PC_ShMx | 2227.37 | −15.88 | 73.4 | 23.6 |
| Tuball SWNT/PC_ShMx | 2332.02 | 66.06 | 78.71 | 65.18 |

The total concentration of the filler in all composites is 0.1%. The percentage shown corresponds to the functionalisation of the SWNT-ML.

The incorporation of polyethoxy U-shape results in the highest Young's Modulus giving an estimated load transfer of 119% which is almost a two-fold of that for Tuball. However, no improvement is observed in the tensile strength for this composite. A similar result is that for pyridine U-shape which exhibits the highest tensile strength but the Young's Modulus is well below the neat polymer.

### Example BB10. Composites Comprising Commercial HDPE and SWNT-ML Complexes Prepared Via Solvent Mixing

This example describes the preparation of HDPE-nanotube composites by solvent mixing employing pyrene SWNT-ML complexes.

Commercial high-density polyethylene, abbreviated HDPE (Sigma-Aldrich, SKU GF80517078-1EA) was used as host polymer matrix.

Two SWNT-ML/PMMA composites with different filler concentrations were prepared by the following steps.

Step 1. An appropriate amount (see specific amount hereunder) of SWNT-ML complexes were dispersed in a round bottom flask containing 80 mL of toluene by mechanical stirring at 500 rpm for 24 hrs.

Step 2. The SWNT-ML dispersion was heated up at 110° C. using a hot plate and a condenser was put in place.

Step 3. 19.7 g of commercial HDPE in pellet form was split in three portions (about 6.5 g) and added separately to the dispersion of Step 2 every hour to give sufficient time to dissolve the polymer. The mixture was kept under continuous mechanical stirring at 1500 rpm for 24 hr.

Step 3. The pyrene SWNT-ML/PMMA composite was retrieved by pouring out the mixture into a Teflon container, and subsequently the composite was placed in the oven at 80° C. overnight to evaporate the solvent.

Step 4. SWNT-ML/PMMA composites were shaped into rectangle form following the protocol described in Example BB2.

The 2 different pyrene SWNT-ML/PMMA composites (composites BB10.1-BB10.2) and the neat HDPE (Neat HDPE BB10.3) were prepared following the abovementioned protocol, with the following specifications:

Composite BB10.1 In Step 1, 278 mg of “Prep A: 28% pyrene MINT of Example BB1” were added. The resulting composite material (rectangles) obtained from Step 4 were called “28% pyrene SWNT/HDPE of Example BB10”.

Composite BB3.2 In Step 1, 556 mg of “Prep A: 28% pyrene MINT of Example BB1” were added. The resulting composite material (dog bones) obtained from Step 4 were called “28% pyrene SWNT/HDPE of Example BB10”.

Neat HDPE BB10.3 In step 1, no SWNT-ML complex was added. The resulting composite material (rectangles) obtained from step 4 were called “Neat HDPE of Example BB10”.

Mechanical characterisation of SWNT-ML/HDPE composites was conducted by dynamic mechanical analysis (DMA). Summary of storage moduli with their respective calculated load transfer is shown in the table below.

| | | Storage | |
|---|---|---|---|
| | Filler | Modulus | Load |
| | concentration | @−100° C. | transfer |
| Composite | (%) | (MPa) | (%) |
| neat HDPE | — | 2446 | — |
| 28% pyrene SWNT/HDPE | 1 | 3669 | 119.17 |
| 28% pyrene SWNT/HDPE | 2 | 5043 | 125.84 |

The incorporation of pyrene U-shape results in a 1.5-fold and 2-fold increase in storage modulus at cryogenic temperatures with 1% and 2% filler loading, respectively, achieving load transfers about 100% in both cases.

### Example BB11. Composites Comprising Commercial PMMA and SWNT-ML Complexes Prepared Via Extrusion

This example describes the preparation of PMMA-nanotube composites using a custom-made extruder employing different SWNT-ML complexes.

Commercial polymethylmethacrylate, abbreviated PMMA (Sigma-Aldrich, SKU 182265) was used as host polymer matrix.

Two different SWNT-ML/PMMA composites were prepared by the following steps.

Step 1. 7 g of commercial PMMA in powder form was dried in the oven at 80° C. overnight.

Step 2. An appropriate amount (see specific amount hereunder) of SWNT-ML complexes and the dried PMMA powder from Step 1 were placed in a 20 mL ball miller reactor with 5 stainless steel balls (10 mm diameter).

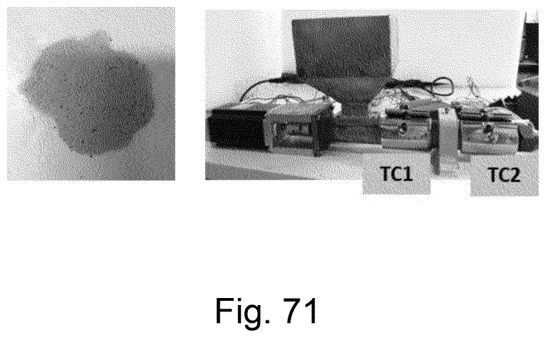

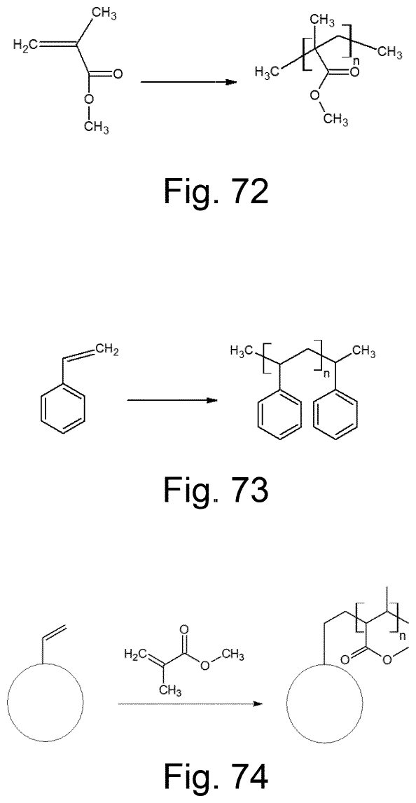

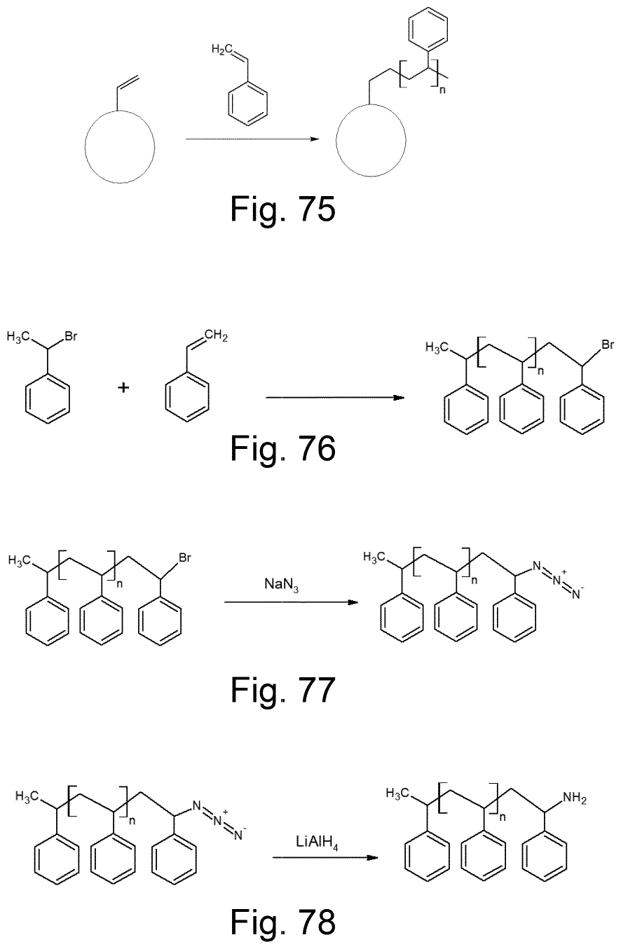

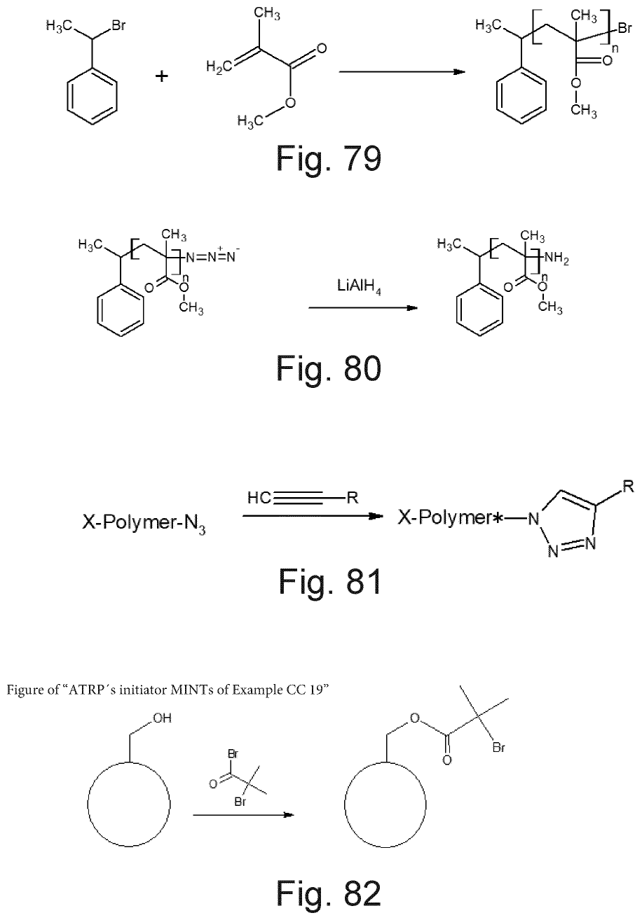

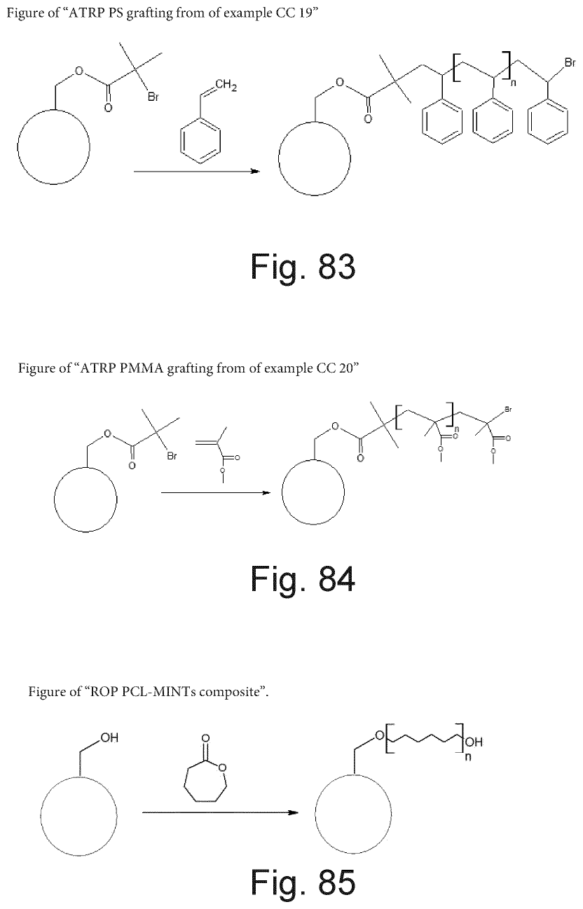

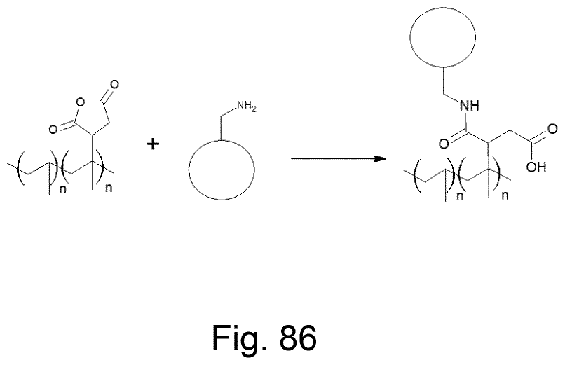

Step 3. The SWNT-ML and PMMA mixture was ball milled at 500 rpm for 10 minutes (FIG. 71—right).

Step 4. A custom-made single-screw extruder with two controlled heating zones was pre-heated at 190° C. for 1 hr (FIG. 71—left).

Step 5. The resultant mixture from step 3 was taken from the reactor as is and passed through the extruder at a screw speed of 8 rpm.

Step 6. The extruder SWNT-ML/PMMA composite filament was collected and shaped into dog bones form following the protocol described in Example BB2.

The 2 different SWNT-ML/PMMA composites (composites BB11.1-BB11.2) and the neat PMMA (Neat PMMA BB11.3) were prepared following the abovementioned protocol, with the following specifications:

Composite BB11.1 In Step 1, 9.7 mg of “Prep H: 28% ester MINT of Example BB1” were added. The resulting composite material (dog bones) obtained from Step 6 were called “28% ester SWNT/PMMA_Ext of Example BB11”.

Composite BB11.2 In step 1, 7 mg of Tuball was added as a control sample. The resulting composite material (dog bones) obtained from step 6 were called “Tuball SWNT/PC_Ext of Example BB11”.

Neat PMMA BB11.3 In step 1, no SWNT-ML complex was added. The resulting composite material (dog bones) obtained from step 6 were called “Neat PMMA of Example BB11”.

Mechanical characterisation of extruded SWNT-ML/PMMA composites was conducted by tensile test measurements. Summary of Young's modulus and tensile strength data with their respective calculated load transfer values is shown in the table below.

| | | Load | | Load |
|---|---|---|---|---|
| | | transfer | Maximum | transfer |
| | Young's | calculated | tensile | calculated |
| | Modulus | from YM | strength | from TS |
| Composite | (MPa) | (%) | (MPa) | (%) |
| neat PMMA_Ext | 3170 | — | 48.35 | — |
| 28% ester | 3266 | 78.14 | 69.59 | 199.80 |
| SWNT/PMMA_Ext | | | | |
| Tuball | 2729 | −349.59 | 58.91 | 99.46 |
| SWNT/PMMA_Ext | | | | |

The total concentration of the filler in the composites is 0.1%. The percentage shown corresponds to the functionalisation of the SWNT-ML.

An increase of almost 100 MPa in Young's modulus is obtained at very low loading for the ester SWNT/PMMA composite with respect to the neat polymer, whereas a detrimental effect is observed for Tuball. On the other hand, the load transfer calculated from tensile strength of the ester U-shape composite is twice of that for Tuball.

### Example CC 1. No Grafting. In Situ Polymerization. CNT Composites by Using Free Radical In Situ Polymerization of Polymethyl Methacrylate (PMMA)

This example describes the preparation of PMMA/CNT composites. The free radical polymerization takes place in a dispersion of either pristine CNT or coated CNT.

Methyl methacrylate, abbreviated MMA (Mw=100.12 g/mol, Sigma-Aldrich), was used as monomer. 2,2-Azobis(2-methylpropionitrile), abbreviated AIBN (Mw=164.21/mol, Sigma-Aldrich), was used as free radical initiator.

The composites were prepared by the following steps.

Step 1. For the preparation of the composites comprising ˜0%, ˜0.1%, ˜0.5%, ˜1%, ˜2%, ˜5%, ˜10%, and ˜20% of SWNT, 0 g, 0.02 g, 0.1 g, 0.2 g, 0.4 g, 1 g, 2 g, and 4 g, respectively, of either pristine SWNT (Tuballs, from OCSiAl) or MINTs (prepared by using EE8's protocol) were dispersed in 40 mL toluene, using bath sonicator (or magnetic stirrer) at 25° C. for 30 minutes.

The following CNT preparations were added to 40 mL toluene:

Suspension 1: No CNT.

Suspension 2: 0.02 g pristine SWNT (Tuballs)

Suspension 3: 0.1 g pristine SWNT (Tuballs)

Suspension 4: 0.2 g pristine SWNT (Tuballs)

Suspension 5: 0.4 g pristine SWNT (Tuballs)

Suspension 6: 1 g pristine SWNT (Tuballs)

Suspension 7: 2 g pristine SWNT (Tuballs)

Suspension 8: 4 g pristine SWNT (Tuballs)

Suspension 9: The corresponding amount of “pyrene MINTs of Example EE9” to have 0.02 g of SWNT.

Suspension 10: The corresponding amount of “pyrene MINTs of Example EE9” to have 0.1 g of SWNT.

Suspension 11: The corresponding amount of “pyrene MINTs of Example EE9” to have 0.2 g of SWNT.

Suspension 12: The corresponding amount of “pyrene MINTs of Example EE9” to have 0.4 g of SWNT.

Suspension 13: The corresponding amount of “pyrene MINTs of Example EE9” to have 1 g of SWNT.

Suspension 14: The corresponding amount of “pyrene MINTs of Example EE9” to have 2 g of SWNT.

Suspension 15: The corresponding amount of “pyrene MINTs of Example EE9” to have 4 g of SWNT.

Step 2. 20 g of MMA was added, and the mixture was stirred for 30 min more.

Step 3. 200 mg of AIBN was added to the mixture. The mixture was degassed for 25 min by bubbling nitrogen through it.

Step 4. The polymerization was carried out at 65° C. for 20 hours under stirring and nitrogen atmosphere.

Step 5. After the polymerization process, the final composite was precipitated by adding 400 mL isopropanol. After that, the composite was filtered on a cellulose filter, washed with isopropanol and dried.

The resulting composites of the reactions were termed:

“Neat PMMA of Example CC1” (product resulting from suspension 1)

“0.1% Tuballs/PMMA composite of Example CC1” (product resulting from suspension 2)

“0.5% Tuballs/PMMA composite of Example CC1” (product resulting from suspension 3)

“1% Tuballs/PMMA composite of Example CC1” (product resulting from suspension 4)

“2% Tuballs/PMMA composite of Example CC1” (product resulting from suspension 5)

“5% Tuballs/PMMA composite of Example CC1” (product resulting from suspension 6)

“10% Tuballs/PMMA composite of Example CC1” (product resulting from suspension 7)

“20% Tuballs/PMMA composite of Example CC1” (product resulting from suspension 8)

“0.1% pyrene MINT/PMMA composite of Example CC1” (product resulting from suspension 9)

“0.5% pyrene MINT/PMMA composite of Example CC1” (product resulting from suspension 10)

“1% pyrene MINT/PMMA composite of Example CC1” (product resulting from suspension 11)

“2% pyrene MINT/PMMA composite of Example CC1” (product resulting from suspension 12)

“5% pyrene MINT/PMMA composite of Example CC1” (product resulting from suspension 13)

“10% pyrene MINT/PMMA composite of Example CC1” (product resulting from suspension 14)

“20% pyrene MINT/PMMA composite of Example CC1” (product resulting from suspension 15)

The mechanical's data obtained are shown in the table immediately below.

TABLE

| | Young's | | Tensile | | Flexural | | Storage Modulus | |
|---|---|---|---|---|---|---|---|---|
| | Modulus, MPa | | Strength, MPa | | Modulus, MPa | | (25° C.), MPa | |
| | | Pyrene | | Pyrene | | Pyrene | | Pyrene |
| | Tuball | MINTs | Tuball | MINTs | Tuball | MINTs | Tuball | MINTs |
| 0% | 2551 MPa | | 34.2 MPa | | 2230.5 MPa | | 2170.8 MPa | |
| 0.1% | 2592.9 | 2902.7 | 34.0 | 37.3 | 2097.0 | 2596.0 | 2415.28 | 2470.84 |
| 0.5% | 2699.0 | 3190.4 | 38.1 | 51.6 | 2585.9 | 3078.4 | 2848.11 | 3158.47 |
| 1% | 3097.1 | 3355.2 | 40.0 | 49.6 | 2916.5 | 3924.4 | 3202.3 | 3777.48 |
| 2% | 3267.1 | 3870.4 | 28.1 | 47.1 | 3567.2 | 4561.6 | 3311.53 | 3510.50 |
| 5% | 5332.3 | 4878.8 | 40.1 | 38.7 | 4982.6 | 4824.6 | 4778.0 | 3712.5 |
| 10% | 7470.1 | 7276.4 | 44.0 | 31.1 | 5827.9 | 5261.9 | 5840.1 | 5722.7 |
| 20% | 9669.9 | 7608.4 | 54.5 | 33.3 | 6194.6 | 5964.5 | 7985.9 | 5446.4 |

### Example CC 2. No Grafting. In Situ Polymerization. MINTs Composites by Using Free Radical In Situ Polymerization of Polystyrene (PS)

This example describes the preparation of PS/CNT composites. The free radical polymerization takes place in a dispersion of either pristine CNT or coated CNT.

Styrene, abbreviated Sty (Mw=104.15 g/mol, Sigma-Aldrich), was used as monomer. 2,2-Azobis(2-methylpropionitrile), abbreviated AIBN (Mw=164.21/mol, Sigma-Aldrich), was used as free radical initiator.

The composites were prepared by the following steps.

Step 1. For the preparation of the composites comprising 0%, 0.1%, 0.5%, 1% and 2% of SWNT, 0 g, 0.02 g, 0.1 g, 0.2 g and 0.4 g of Alkene MINTs (prepared by Examples EE1 and EE8 protocols) were dispersed in 40 mL toluene, using bath sonicator (or magnetic stirrer) at 25° C. for 30 minutes.

Step 2. 20 g of Sty was added, and the mixture was stirred for 30 min more.

Step 3. 200 mg of AIBN was added to the mixture. The mixture was degassed for 25 min by bubbling nitrogen through it.

Step 4. The polymerization was carried out at 80° C. for 20 hours under stirring and nitrogen atmosphere.

Step 5. After the polymerization process, the final composite was precipitated by adding 400 mL isopropanol. After that, the composite was filtered on a cellulose filter, washed with isopropanol and dried.

### Example CC 3. Grafting from. Crosslinking. In Situ Polymerization. Alkene MINTs Composites by Using Free Radical In Situ Polymerization of Polymethyl Methacrylate (PMMA)

This example describes the preparation of PMMA/alkene MINTs composites. The free radical polymerization takes place in a dispersion of alkene Mints. The radical formation began at the alkene group of the U-shape, so the growth of polymer chains begins at the MINT.

Methyl methacrylate, abbreviated MMA (Mw=100.12 g/mol, Sigma-Aldrich), was used as monomer. 2,2-Azobis(2-methylpropionitrile), abbreviated AIBN (Mw=164.21/mol, Sigma-Aldrich), was used as free radical initiator.

The composites were prepared by the following steps.

Step 1. For the preparation of the composites comprising 0%, 1% and 2% of SWNT, 0 g, 0.101 g and 0.204 g of Alkene MINTs (prepared by Examples EE1 and EE8 protocols) were dispersed in 20 mL toluene, using bath sonicator (or magnetic stirrer) at 25° C. for 30 minutes.

Step 2. 200 mg of AIBN was added to the mixture. The temperature is set at 65° C.

Step 3. The mixture was magnetic stirred at 65° C. under N₂ atmosphere for 30 minutes.

Step 4. 10 g of MMA was added, and the mixture was stirred for 30 min more.

Step 5. The polymerization was carried out at 65° C. for 20 hours under stirring and nitrogen atmosphere.

Step 6. After the polymerization process, the final composite was precipitated by adding 200 mL isopropanol. After that, the composite was filtered on a cellulose filter, washed with isopropanol and dried.

### Example CC 4. Grafting from. Crosslinking. In Situ Polymerization. Alkene MINTs Composites by Using Free Radical In Situ Polymerization of Polystyrene (PS)

This example describes the preparation of PS/alkene MINTs composites. The free radical polymerization takes place in a dispersion of alkene Mints. The radical formation began at the alkene group of the U-shape, so the growth of polymer chains begins at the MINT.

Styrene, abbreviated Sty (Mw=104.15 g/mol, Sigma-Aldrich), was used as monomer. 2,2-Azobis(2-methylpropionitrile), abbreviated AIBN (Mw=164.21/mol, Sigma-Aldrich), was used as free radical initiator.

The composites were prepared by the following steps.

Step 1. For the preparation of the composites comprising 0%, 1% and 2% of SWNT, 0 g, 0.101 g and 0.204 g of Alkene MINTs (prepared by Examples EE1 and EE8) were dispersed in 20 mL toluene, using bath sonicator (or magnetic stirrer) at 25° C. for 30 minutes.

Step 2. 200 mg of AIBN was added to the mixture. The temperature is set at 65° C.

Step 3. The mixture was magnetic stirred at 65° C. under N₂ atmosphere for 30 minutes.

Step 4.10 g of Sty was added and the mixture was stirred for 30 min more.

Step 5. The polymerization was carried out at 65° C. for 20 hours under stirring and nitrogen atmosphere.

Step 6. After the polymerization process, the final composite was precipitated by adding 200 mL isopropanol. After that, the composite was filtered on a cellulose filter, washed with isopropanol and dried.

### Example CC 5. No Grafting. In Situ Polymerization. MINTs Composites by Using In Situ Polycondensation of Polyamide 6 (PA6)

This example describes the preparation of PA6/CNT composites. The polycondensation takes place in a dispersion of coated CNT.

ε-caprolactam, (Mw=113.16 g/mol, Sigma-Aldrich), was used as monomer. Aminocaproic acid (Mw=131.17 g/mol, Sigma-Aldrich), was used as initiator.

The composites were prepared by the following steps.

Step 1. 9 g of ε-caprolactam (80 mmol) was melted at 80° C. for one hour under magnetic stirring.

Step 2. For the preparation of the composites comprising 0%, 1% and 2% of SWNT, 0 g, 0.102 g and 0.204 g of “MINTs of Example EE8” were added to ε-caprolactam solution and the mixture was magnetic stirred at 80° C. for one hour.

Step 3. 1 g of aminocaproic acid was added to the previous mixture. The dispersion was purged with N₂ for 30 minutes under magnetic stirring.

Step 4. The flask was placed in an oil bath set at a temperature of 180° C. for one hour and, after that, 250° C. for 9 hours.

Step 5. The reaction was stopped by cooling the reaction down to room temperature and opening the flask to air.

Step 6. The resultant solid was washed in boiling water to remove monomer remains.

Step 7. The obtained composites were dried at 80° C. overnight in a vacuum oven.

### Example CC 6. Grafting to. Bromine End-Functional Polystyrene

This example describes the preparation of bromine end-functional polystyrene by Atom Transfer Radical Polymerization (ATRP). Styrene, abbreviated Sty (Mw=104.15 g/mol, Sigma-Aldrich), was used as monomer. 2,2′-Bipyridyl, abbreviated bipy (Mw=156.19 g/mol, TCI) was used as ligand. Copper (I) bromide, CuBr, (Mw=143.45 g/mol, Sigma-Aldrich), was used as catalyst. 1-phenyl ethylbromide, abbreviated 1-PEBr (Mw=185.06/mol, Sigma-Aldrich), was used as initiator.

The polymer was preparing by the following steps:

Step 1. 15 mL of commercial Sty was passed through basic alumina column to remove inhibitors.

Step 2. 0.144 g of CuBr (1 mmol) and 0.468 g of bipy (3 mmol) were added to a round bottom flask. The flask was sealed with a rubber septum, degassed and backfilled with N₂ 3 times.

Step 3. 11.5 mL of deoxygenated Sty (100 mmol) was added via syringe. The flask was degassed and backfilled with N₂ 3 times.

Step 4. The mixture was magnetic stirred for 20 minutes at room temperature, to form the catalyst complex.

Step 5. The flask was placed in an oil bath set at a temperature of 90° C.

Step 6. 0.14 mL of 1-PEBr was injected into the flask to start the reaction.

Step 7. The reaction was kept under magnetic stirring at 90° C. for 20 hours.

Step 8. The reaction was stopped by cooling the reaction down to room temperature and opening the flask to air.

Step 9. 50 mL of acetone was added to the mixture to dissolve the obtained polymer. The mixture was magnetically stirred for 20 minutes.

Step 10. The mixture was filtered to remove insoluble salts and catalyst remains.

Step 11. The polymer was precipitated by addition of the solution to a large amount (around 300 mL) of cold methanol.

Step 12. The precipitated polymer was filtered and washed with more methanol. Dissolution and precipitation (Steps 9 and 11) were repeated until a white powder was obtained.

Step 13. The precipitated polymer was dried in a vacuum oven at 40° C. until a constant weight was reached.

The conversion of the reaction was 63%. Gel Permeation Chromatography (GPC) results of the obtained polymer estimated that the polymer had a molecular weight in number (Mn) of 6785, and a polydispersity (Mw/Mn) of 1.6.

The resulting dried powder was called “PS—Br of Example CC 6”.

### Variations to the Protocol.

In the step 6 different initiators can be used depending on the final structure that is required.
1-PEBr is the most common initiator to obtain monofunctional polystyrene.
To obtain α,ω-difunctional polymers, the following initiators can be used (Coessens, Pintauer, & Matyjaszewski, 2001):
   2-Bromopropionitrile, abbreviated BrPN (Mw=133.97/mol, Sigma-Aldrich)
   ethyl 2-bromoisobutyrate, abbreviated BriB (Mw=195.05/mol, Sigma-Aldrich)
   ethyl 2-bromopropionate, abbreviated EBrP (Mw=181.03/mol, Sigma-Aldrich)

In another experiment, Step 7 was modified to obtain polymers with different molecular weights, by changing the polymerization time:
Polymerization time: 4 h
   (GPC results: Mw=2102 g/mol, Mn=1528 g/mol, Polydispersity=1.4; 1H NMR results: Mw=1832 g/mol). This product was termed “4 h polymerization ATPR polystyrene of Example CC6”
Polymerization time: 20 h
   (GPC results: Mw=10959 g/mol, Mn=6785 g/mol, Polydispersity=1.6; ¹H NMR results: Mw=8765 g/mol).

### Example CC 7. Grafting to. Azide End-Functional Polystyrene

This example describes the preparation of azide end-functional polystyrene by PS—Br of Example CC 11. Sodium azide, NaN₃ (Mw=65.01 g/mol, Sigma-Aldrich) was used as azidation agent. Dry dimethylformamide (DMF) was used as solvent.

Step 1. 1 g of “PS—Br of Example CC 6” (0.149 mmol) was dissolved in 10 mL of dry DMF under magnetic stirring until completely dissolved (around 15 minutes).

Step 2. 19.1 mg of NaN₃ (0.294 mmol) was added little by little.

Step 3. The reaction was maintained under magnetic stirring for 20 hours at room temperature.

Step 4. The resultant solution was poured into 300 mL of cold methanol under rapid magnetic stirring to precipitate the polymer.

Step 5. The obtained polymer was filtered and washed with more methanol to remove DMF remains.

Step 6. The precipitated polymer was dried in a vacuum oven at 40° C. until a constant weight was reached.

The yield of the reaction was close to 100%. FTIR and ¹H NMR confirmed the change of bromine by azide. The resulting dried powder was called “PS—N₃ of Example CC 7”.

### Example CC 8. Grafting to. Amine End-Functional Polystyrene

This example describes the preparation of amine end-functional polystyrene by PS—N₃ of Example CC 7. Lithium aluminum hydride (LiAlH₄) solution (1M, in THF) (Mw=37.95 g/mol, Sigma-Aldrich) was used as reduction agent. Dry tetrahydrofuran (THF) was used as solvent.

Step 1. 0.488 g of “PS—N₃ of Example CC 7” were dissolved in 5 mL of dry THF. The solution was purged with N₂ for 30 minutes.

Step 2. 0.74 mL of LiAlH₄ solution (0.72 mmol of LiALH₄) was added to a cold round bottom flask (ice bath).

Step 3. The resultant solution of Step 1 was added drop by drop to the prepared solution in the step 2.

Step 4. The reaction was magnetic stirred at 75° C. (reflux) for five hours under N₂ atmosphere.

Step 5. The solution was cooled to room temperature.

Step 6. The reaction was quenched with 10 mL of water and 1 mL of NaOH solution (1M). After that, the flask was opened to air.

Step 7. 50 mL of water was added to the solution under magnetic stirring to precipitate the polymer.

Step 8. The obtained polymer was filtered and washed with more water to remove salts remains.

Step 9. The precipitated polymer was dried in a vacuum oven at 40° C. until a constant weight was reached.

The yield of the reaction was close to 100%. FTIR and ¹H NMR confirmed the change of azide by amine. The resulting dried powder was called “PS—NH₂ of Example CC 8”.

### Example CC 9. Grafting to. Bromine End-Functional Polymethyl Methacrylate

This example describes the preparation of bromine end-functional polymethyl methacrylate by Atom Transfer Radical Polymerization (ATRP). Methyl methacrylate, abbreviated MMA (Mw=100.12 g/mol, Sigma-Aldrich), was used as monomer. 2,2′-Bipyridyl, abbreviated bipy (Mw=156.19 g/mol, TCI) was used as ligand. Copper (I) bromide, CuBr, (Mw=143.45 g/mol, Sigma-Aldrich), was used as catalyst. (1-Bromoethyl) benzene (Mw=185.06/mol, Sigma-Aldrich), was used as initiator.

The polymer was preparing by the following steps:

Step 1. 15 mL of commercial MMA was passed through basic alumina column to remove inhibitors.

Step 2. 0.144 g of CuBr (1 mmol) and 0.468 g of bipy (3 mmol) were added to a round bottom flask. The flask was sealed with a rubber septum, degassed and backfilled with N₂ 3 times.

Step 3. 10.6 g of deoxygenated MMA (100 mmol) was added via syringe. The flask was degassed and backfilled with N₂ 3 times.

Step 4. The mixture was magnetic stirred for 20 minutes at room temperature, to form the catalyst complex.

Step 5. The flask was placed in an oil bath set at a temperature of 90° C.

Step 6. 0.14 mL of deoxygenated (1-Bromoethyl)benzene was injected into the flask to start the reaction.

Step 7. The reaction was kept under magnetic stirring at 90° C. for 2 hours.

Step 8. The reaction was stopped by cooling the reaction down to room temperature and opening the flask to air.

Step 9. 50 mL of acetone was added to the mixture to dissolve the obtained polymer. The mixture was magnetically stirred for 1 hour.

Step 10. The mixture was filtered to remove insoluble salts and catalyst remains.

Step 11. The polymer was precipitated by addition of the solution to a large amount (around 300 mL) of cold methanol.

Step 12. The precipitated polymer was filtered and washed with more methanol. Dissolution and precipitation (Steps 9 and 11) were repeated until a white powder was obtained.

Step 13. The precipitated polymer was dried in a vacuum oven at 40° C. until a constant weight was reached.

The conversion of the reaction was 38%. Gel Permeation Chromatography (GPC) results of the obtained polymer estimated that the polymer had a molecular weight in number (Mn) of 22089, and a polydispersity (Mw/Mn) of 1.3.

The resulting dried powder was called “PMMA-Br of Example CC 9”.

### Example CC 10. Grafting to. Azide End-Functional PMMA

This example describes the preparation of azide end-functional polymethylmethacrylate by PMMA-Br of Example CC 9. Sodium azide, NaN₃ (Mw=65.01 g/mol, Sigma-Aldrich) was used as azidation agent. Dry dimethylformamide (DMF) was used as solvent.

Step 1. 0.149 mmol of “PMMA-Br of Example CC 9” was dissolved in 10 mL of dry DMF under magnetic stirring until completely dissolved (around 15 minutes).

Step 2. 191.0 mg of NaN₃ (2.94 mmol) was added little by little.

Step 3. The reaction was maintained under magnetic stirring for 120 hours at room temperature.

Step 4. The resultant solution was poured into 300 mL of cold methanol under rapid magnetic stirring to precipitate the polymer.

Step 5. The obtained polymer was filtered and washed with more methanol to remove DMF remains.

Step 6. The precipitated polymer was dried in a vacuum oven at 40° C. until a constant weight was reached.

The yield of the reaction was close to 100%. FTIR and ¹H NMR confirmed the change of bromine by azide. The resulting dried powder was called “PMMA-N₃ of Example CC 10”.

### Example CC 11. Grafting to. Amine End-Functional PMMA

This example describes the preparation of amine end-functional polystyrene by PMMA-N₃ of Example CC 10. Lithium aluminum hydride (LiAlH₄) solution (1M, in THF) (Mw=37.95 g/mol, Sigma-Aldrich) was used as reduction agent. Dry tetrahydrofuran (THF) was used as solvent.

Step 1. 0.488 g of “PMMA-N₃ of Example CC 10” were dissolved in 5 mL of dry THF. The solution was purged with N₂ for 30 minutes.

Step 2. 0.74 mL of LiAlH₄ solution (0.72 mmol of LiALH₄) was added to a cold round bottom flask (ice bath).

Step 3. The resultant solution of Step 1 was added drop by drop to the prepared solution in the step 2.

Step 4. The reaction was magnetic stirred at 75° C. (reflux) for five hours under N₂ atmosphere.

Step 5. The solution was cooled to room temperature.

Step 6. The reaction was quenched with 10 mL of water and 1 mL of NaOH solution (1M). After that, the flask was opened to air.

Step 7. 50 mL of water was added to the solution under magnetic stirring to precipitate the polymer.

Step 8. The obtained polymer was filtered and washed with more water to remove salts remains.

Step 9. The precipitated polymer was dried in a vacuum oven at 40° C. until a constant weight was reached.

The yield of the reaction was close to 100%. FTIR confirmed the change of azide by amine. The resulting dried powder was called “PMMA-NH₂ of Example CC 11”.

### Example CC 12. Grafting to. “Click” Chemistry Between Azide End-Functional Polystyrene and Alkyne U-Shapes

This example describes the reaction between the “PS—N₃ of Example CC 7” and the alkyne U-shapes (Mw=899.23 g/mol) using “Click chemistry”. N,N-Diisopropylethylamine, DIPEA, (Mw=129.24/mol, Sigma-Aldrich), was used as initiator. Copper (I) iodide, CuI, (Mw=190.45/mol, Sigma-Aldrich), was used as catalyst. DMF was used as solvent.

Step 1. 2 g of “PS—N₃ of Example CC 7” (0.22 mmol) and 197 mg of alkyne U-shapes were dissolved in 20 mL of DMF by magnetic stirring for 30 minutes. The flask was purged with N₂ for 15 minutes.

Step 2. 38 L of DIPEA (0.22 mmol) and 42 mg of CuI (0.22 mmol) were added to the solution.

The flask was degassed and backfilled with N₂ 3 times.

Step 3. The reaction was magnetic stirred at 60° C. for 20 hours under N₂ atmosphere.

Step 4. The reaction was stopped by cooling the reaction down to room temperature and opening the flask to air.

Step 5. 16 mL of dichloromethane, 10 mL of saturated NaCl deionized water and 1.66 mL of ammonia was added to the solution under magnetic stirring.

Step 6. The resultant product was precipitated in cold water under rapid magnetic stirring.

Step 7. The precipitated solid was filtered washed with water and dried at 60° C. for 24 hours.

Step 8. The dried solid was dissolved in 100 mL of acetone under magnetic stirring for 30 minutes.

Step 9. The solution was filtered to remove the insoluble free U-shapes.

Step 10. The purified product was precipitated by addition of the solution to a large amount (around 300 mL) of cold methanol.

Step 11. The precipitated polymer was filtered and washed with more methanol. Dissolution and precipitation (Steps 8 and 10) were repeated until a white powder was obtained.

Step 12. The precipitated polymer was dried in a vacuum oven at 60° C. until a constant weight was reached.

The resulting dried powder was called “Click PS_U-shape of Example CC 12”.

### Example CC 13. Grafting to. “Click” Chemistry Between Azide End-Functional PMMA and Alkyne U-Shapes

This example describes the reaction between the “PMMA-N₃ of Example CC 10” and the alkyne U-shapes (Mw=899.23 g/mol) using “Click chemistry”. N,N-Diisopropylethylamine, DIPEA, (Mw=129.24/mol, Sigma-Aldrich), was used as initiator. Copper (1) iodide, CuI, (Mw=190.45/mol, Sigma-Aldrich), was used as catalyst. DMF was used as solvent.

Step 1. 2 g of “PMMA-N₃ of Example CC 10” (0.22 mmol) and 197 mg of alkyne U-shapes were dissolved in 20 mL of DMF by magnetic stirring for 30 minutes. The flask was purged with N₂ for 15 minutes.

Step 2. 38 L of DIPEA (0.22 mmol) and 42 mg of CuI (0.22 mmol) were added to the solution.

The flask was degassed and backfilled with N₂ 3 times.

Step 3. The reaction was magnetic stirred at 60° C. for 20 hours under N₂ atmosphere.

Step 4. The reaction was stopped by cooling the reaction down to room temperature and opening the flask to air.

Step 5. 16 mL of dichloromethane, 10 mL of saturated NaCl deionized water and 1.66 mL of ammonia was added to the solution under magnetic stirring.

Step 6. The resultant product was precipitated in cold water under rapid magnetic stirring.

Step 7. The precipitated solid was filtered washed with water and dried at 60° C. for 24 hours.

Step 8. The dried solid was dissolved in 100 mL of acetone under magnetic stirring for 30 minutes.

Step 9. The solution was filtered to remove the insoluble free U-shapes.

Step 10. The purified product was precipitated by addition of the solution to a large amount (around 300 mL) of cold methanol.

Step 11. The precipitated polymer was filtered and washed with more methanol. Dissolution and precipitation (Steps 8 and 10) were repeated until a white powder was obtained.

Step 12. The precipitated polymer was dried in a vacuum oven at 60° C. until a constant weight was reached.

The resulting dried powder was called “Click PMMA_U-shape of Example CC 13”.

### Example CC 14. No Grafting. Solution Process. CNT Composites by Using Commercial Polymethyl Methacrylate (PMMA)

This example describes the formation of Mints composites by using commercial PMMA.

Polymethyl methacrylate, abbreviated PMMA was used as polymer.

Step 1. For the preparation of the composites comprising 0%, 0.1%, 0.5%, 1% and 2% of SWNT, 0 g, 0.02 g, 0.1 g, 0.2 g and 0.4 g of “MINTs of example EE8” were dispersed in 40 mL of Toluene under magnetic stirring for 30 minutes at room temperature.

Step 2. 20 g of PMMA were added to the previous dispersion.

Step 3. The mixture was stirred under magnetic stirring for 24 hours at room temperature.

Step 4. The mixture was poured into 300 mL of methanol under rapid stirring to precipitate the composite.

Step 5. The composite was dried at 80° C. for 24 hours.

### Example CC 15. No Grafting. Solution Process. CNT Composites by Using Commercial Polystyrene (PS)

This example describes the formation of MINTs composites by using commercial PS.

Polystyrene, abbreviated PS (M_{W}-192,000, Sigma-Aldrich) was used as polymer.

Step 1. 0.1%, 0.5%, 1% and 2% of MINTs of Example EE8 were dispersed in 40 mL of Toluene under magnetic stirring for 30 minutes at room temperature.

Step 2. 10 g of PS were added to the previous dispersion.

Step 3. The mixture was stirred under magnetic stirring for 24 hours at room temperature.

Step 4. The mixture was poured into 300 mL of methanol under rapid stirring to precipitate the composite.

Step 5. The composite was dried at 80° C. for 24 hours.

### Example CC 16. No Grafting. Solution Process. CNT Composites by Using Commercial Low-Density Polyethylene (LDPE)

This example describes the formation of Mints composites by using commercial LDPE.

Low density polyethylene, abbreviated LDPE (Sigma-Aldrich) was used as polymer.

Step 1. For the preparation of the composites comprising 0%, 0.1%, 0.5%, 1% and 2% of SWNT, 0 g, 0.02 g, 0.1 g, 0.2 g and 0.4 g of “MINTs of example EE8” were dispersed in 40 mL of Toluene under magnetic stirring for 30 minutes at room temperature.

Step 2. 20 g of LDPE were added to the previous dispersion.

Step 3. The mixture was stirred under magnetic stirring for 24 hours at 110° C. (reflux).

Step 4. The mixture was poured into 300 mL of methanol under rapid stirring to precipitate the composite.

Step 5. The composite was dried at 60° C. for 24 hours.

### Example CC 17. No Grafting. Solution Process. CNT Composites by Using Commercial Poly Vinyl Chloride (PVC)

This example describes the formation of MINTs composites by using commercial PVC.

Poly vinyl chloride, abbreviated PVC (Sigma-Aldrich) was used as polymer.

Step 1 For the preparation of the composites comprising 0%, 0.1%, 0.5%, 1% and 2% of SWNT, 0 g, 0.02 g, 0.1 g, 0.2 g and 0.4 g of “MINTs of example EE8” were dispersed in 30 mL of THF under magnetic stirring for 30 minutes at room temperature.

Step 2. 20 g of PVC were dissolved in 50 mL of THF under magnetic stirring for 1 hour at 55° C.

Step 3. The MINTs dispersion was poured into the PVC solution.

Step 3. The mixture was stirred under magnetic stirring for 24 hours at 55° C.

Step 4. The mixture was poured into 300 mL of water under rapid stirring to precipitate the composite.

Step 5. The composite was dried at 60° C. for 24 hours.

### Example CC 18. No Grafting. Solution Process. CNT Composites by Using Commercial Polyamide 6 (PA6)

This example describes the formation of MINTs composites by using commercial polyamide 6.

Polyamide 6, abbreviated PA6 (Sigma-Aldrich) was used as polymer.

Step 1. For the preparation of the composites comprising 0%, 0.1%, 0.5%, 1% and 2% of SWNT, 0 g, 0.02 g, 0.1 g, 0.2 g and 0.4 g of “MINTs of example EE8” were dispersed in 40 mL of formic acid under magnetic stirring for 30 minutes at room temperature.

Step 2. 10 g of PA were added to the previous dispersion.

Step 3. The mixture was stirred under magnetic stirring for 24 hours at room temperature.

Step 4. The mixture was poured into 300 mL of water under rapid stirring to precipitate the composite.

Step 5. The composite was dried at 60° C. for 24 hours.

### Example CC19. Grafting from. Polymers Prepared by ATRP Using MINTs as Initiators

This example describes the formation of MINTs-polymer composites using Atom transfer radical polymerization. The functional group of the macrocycle is used as initiator in the polymerization, so the polymers chains grow from the macrocycle.

α-Bromoisobutyryl bromide, abbreviated BIBB (Mw=229.90 g/mol, Sigma Aldrich) was used as initiator. 4-(Dimethylamino)pyridine, abbreviated DMAP (Mw=122.27 g/mol, Sigma Aldrich), tryethylamine (Mw=101.19/mol, Sigma Aldrich) and anhydrous chloroform (Mw=119.38/mol, Sigma Aldrich) were also used in the reaction.

Step 1. 0.4025 g of methyl-alcohol MINTs (prepared by examples EE4 and EE8), 0.0292 g (0.2390 mmol) of DMAP and 0.3031 g (1.667 mmol) of tryethylamine were placed in 10 mL of anhydrous CHCl₃ under nitrogen atmosphere.

Step 2. 0.3832 g (1.667 mmol) of BIBB were dissolved in 5 mL of anhydrous CHCl₃.

Step 3. the BIBB solution was added dropwise to the first solution (0° C.).

Step 4. The mixture was magnetically stirred for 3 hours at 0° C. followed by stirring at room temperature for 48 hours.

Step 5. The solid was filtrated and washed with 100 mL of CHCl₃ for 5 times.

Step 6. The solid was dried overnight under vacuum at 40° C.

The resulting dried powder was called “ATRP's initiator MINTs of Example CC 19”.

The composite was preparing by the following steps:

Step 1. 15 mL of commercial Sty/or MMA was passed through basic alumina column to remove inhibitors.

Step 2. 0.144 g of CuBr (1 mmol) and 0.468 g of bipy (3 mmol) were added to a round bottom flask. The flask was sealed with a rubber septum, degassed and backfilled with N₂ 3 times.

Step 3. 11.5 mL of deoxygenated Sty (100 mmol) was added via syringe. The flask was degassed and backfilled with N₂ 3 times.

Step 4. The mixture was magnetic stirred for 20 minutes at room temperature, to form the catalyst complex.

Step 5. The flask was placed in an oil bath set at a temperature of 90° C.

Step 6. 0.1898 g of “ATRP's initiator MINTs of Example CC 19” was added to the flask to start the reaction.

Step 7. The reaction was kept under magnetic stirring at 90° C. for 20 hours.

Step 8. The reaction was stopped by cooling the reaction down to room temperature and opening the flask to air.

Step 9. 50 mL of acetone was added to the mixture to dissolve the obtained polymer. The mixture was magnetically stirred for 20 minutes.

Step 10. The mixture was filtered to remove insoluble salts and catalyst remains.

Step 11. The polymer was precipitated by addition of the solution to a large amount (around 300 mL) of cold methanol.

Step 12. The precipitated polymer was filtered and washed with more methanol. Dissolution and precipitation (Steps 9 and 11) were repeated until a white powder was obtained.

Step 13. The precipitated polymer was dried in a vacuum oven at 40° C. until a constant weight was reached.

The composites obtained were called “ATRP PS grafting from of example CC 19” and “ATRP PMMA grafting from of example CC 19”

### Example CC20. Grafting from. Polymers Prepared by ATRP Using MINTs as Initiators (Baskaran, Mays, & Bratcher, 2004)

This example describes the formation of MINTs-polymer composites using Atom transfer radical polymerization. The functional group of the macrocycle is used as initiator in the polymerization, so the polymers chains grow from the macrocycle.

2-Hydroxyethyl 2-bromoisobutyrate, abbreviated HEBIB (Mw=211.05 g/mol, Sigma Aldrich) was used as initiator. Toluene was used as solvent.

Step 1. 200 mg of COCl-MINTs, 2.4 mL of HEBIB and 5 mL of toluene were introduced in a round bottom flask under N₂ atmosphere.

Step 2. The mixture was magnetically stirred for 24 hours at 100° C.

Step 3. The mixture was cooled to room temperature.

Step 4. The solvent was completely removed under vacuum.

Step 5. The solid was washed with ethanol and filtered. This step was repeated for 3 times.

Step 6. The solid was dried overnight under vacuum at 40° C.

The resulting dried powder was called “ATRP's initiator MINTs of Example CC 20”.

Step 1. 15 mL of commercial Sty/or MMA was passed through basic alumina column to remove inhibitors.

Step 2. 0.144 g of CuBr (1 mmol) and 0.468 g of bipy (3 mmol) were added to a round bottom flask. The flask was sealed with a rubber septum, degassed and backfilled with N₂ 3 times.

Step 3. 11.5 mL of deoxygenated Sty (100 mmol) was added via syringe. The flask was degassed and backfilled with N₂ 3 times.

Step 4. The mixture was magnetic stirred for 20 minutes at room temperature, to form the catalyst complex.

Step 5. The flask was placed in an oil bath set at a temperature of 90° C.

Step 6. 0.1898 g of “ATRP's initiator MINTs of Example CC 20” was added to the flask to start the reaction.

Step 7. The reaction was kept under magnetic stirring at 90° C. for 20 hours.

Step 8. The reaction was stopped by cooling the reaction down to room temperature and opening the flask to air.

Step 9. 50 mL of acetone was added to the mixture to dissolve the obtained polymer. The mixture was magnetically stirred for 20 minutes.

Step 10. The mixture was filtered to remove insoluble salts and catalyst remains.

Step 11. The polymer was precipitated by addition of the solution to a large amount (around 300 mL) of cold methanol.

Step 12. The precipitated polymer was filtered and washed with more methanol. Dissolution and precipitation (Steps 9 and 11) were repeated until a white powder was obtained.

Step 13. The precipitated polymer was dried in a vacuum oven at 40° C. until a constant weight was reached.

The composites obtained were called “ATRP PS grafting from of example CC 20” and “ATRP PMMA grafting from” of example CC 20.

### Example CC 21. Grafting from. Ring Opening Polymerization of ε-Caprolactone (Buffa, Hu, & Resasco, 2005)

This example describes the formation of methylalcohol MINTs-Polycaprolactone (PCL) composite using a grafting from method. The —OH group from the methoxyalcohol MINTs was used to start the ring opening polymerization (ROP) of ε-caprolactone.

ε-caprolactone (Mw=114.14 g/mol, Sigma-Aldrich) was used as monomer. tin(II) 2-ethylhexanoate, abbreviated Sn(Oct)₂ (Mw=405.12 g/mol, Sigma-Aldrich) was used as catalyst.

Step 1. 0.83 mmol of methylalcohol MINTs (prepared by examples EE4 and EE8) was suspended in 15 mL of o-dichlorobenzene by sonicating (tip, 35% amplitude) for 30 min.

Step 2. the suspension was transferred to a two-neck vessel (absolutely dry) and mixed with 2 mL (18.66 mmol) of ε-caprolactone.

Step 3. 0.1866 mmol of Sn(Oct)₂ was added into the mixture.

Step 4. The ROP reaction was carried out under nitrogen constantly bubbling, for 24 h at 130° C. (reflux).

Step 5. The hot liquid was transferred from the vessel into a beaker containing cold n-hexane, which caused the precipitation of the polymeric material.

Step 6. The solid was filtered through a PTFE membrane and abundantly washed with n-hexane.

Step 7. The solid was transferred to a glass containing 10 mL of chloroform. The mixture was magnetically stirred for 30 min at room temperature to eliminate the free polymer.

Step 8. The final solid was dried overnight under vacuum at room temperature.

The obtained composite was called “ROP PCL-MINTs composite” of Example CC21.

### Example CC22. Attachment Between Amino MINTs and Polypropylene-Graft-Maleic Anhydride

This example describes the formation of a covalent bond between the amino group of the amino MINTs and the maleic anhydride of the copolymer polypropylene-graft-maleic anhydride. The final concentration of nanotubes in the composite was 10 wt. %

Polypropylene-graft-maleic anhydride, abbreviated PP-g-MA (Mw=9100 g/mol, Sigma-Aldrich) was used as polymer. Methanesulfonic acid (Sigma-Aldrich) was used as ring opening reactant.

Step 1. 2.71 g of Amino MINTs (Example EE8.C1) (2.22 g of NTs assuming 25% functionalization) were dispersed in 200 of Toluene by magnetic stirring for 30 minutes at room temperature in a 500 mL round bottom flask.

Step 2. 20 g of PP-g-MA were added to the mixture ant the temperature was increased to 110° C. (reflux).

Step 3. Methanesulfonic acid was added slowly via syringe.

Step 4. The mixture was maintained to reflux for 2.5 h.

Step 5. The mixture was cooled to room temperature.

Step 6. The mixture was poured into 1000 mL of water under rapid stirring to precipitate the polymer.

Step 7. The final composite was filtered using cellulose filter, wash with water and dry in a vacuum oven (70° C., 12 h).

The obtained composite was called “Amino-PP-g-MA” of Example CC22.

### Variations on the Above-Mentioned Protocol:

Polyethylene-graft-maleic anhydride, abbreviated PE-g-MA (Sigma-Aldrich) can be used instead of PP-g-MA following the same experimental procedure.

Methyl Alcohol MINTS (Example EE4) can be used instead of Amino MINTs following the same experimental procedure.

The following examples explain the synthesis of monoalkylated and U-Shape pyrene derivatives with the polyethoxy chain.

### Example DD1. Synthesis of 2,7-diBpinpyrene

Step 1. Commercial pyrene (8 g, 1 eq.), bis (pinacolato) diboron (21,2 g, 2,11 eq.) and dtbpy (212.6 mg, 0.02 eq.) were poured into a 250 mL flask under inner atmosphere.

Step 2. Cyclohexane was added (1.66 mL/pyrene mmol).

Step 3. (1,5-Cyclooctadiene)(methoxy) iridium (1) dimer was added at reflux temperature (80° C.).

Step 4. After 20 hours of stirring, the reaction was cooled until room temperature.

Step 5. The mixture was filtered onto a filter pad with silica-celite and it was washed with DCM. Solvent was removed by vacuum and a brown solid appeared.

Step 6. The solid was washed with acetone and it turned white. The white product was termed “2,7-diBpinpyrene of Example DD1”.

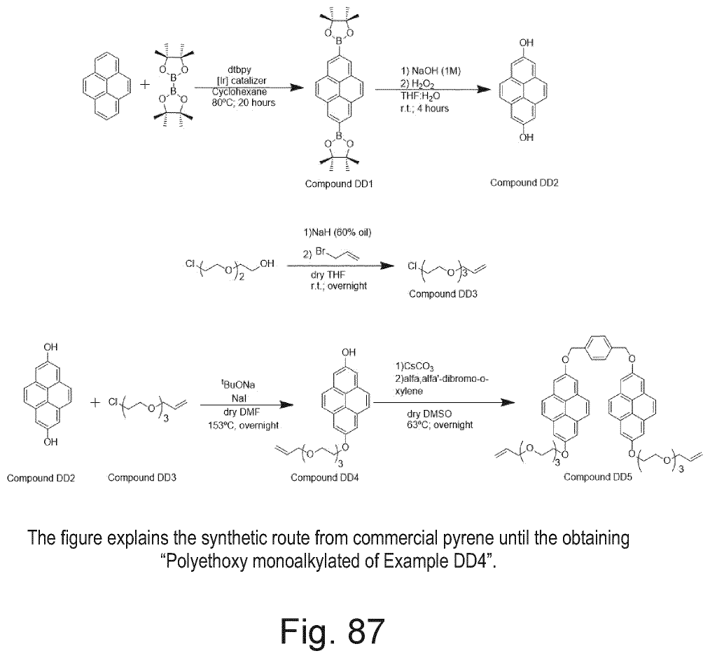

The scheme of this reaction could be consulted in FIG. 87.

### Example DD2. Synthesis of 2,7-Dihidroxypyrene

Step 1. “2,7-diBpinpyrene of Example DD1” (14,6 g, 1 eq.) was dissolved in THF:H₂O (10:1, 45.5 mL/mmol).

Step 2. NaOH 1M (6,6 g, 6 eq.) were added to the solution.

Step 3. H₂O₂ 30% (6,6 g; 6 eq.) were added dropwise.

Step 4. The mixture was stirred at room temperature for 4 hours.

Step 5. After completing Step 4, HCl 1M was added to the solution until pH≈1-2 and stirred 1 hour.

Step 6. Solvent was removed by vacuum and a brown solid appeared.

Step 7. The brown solid was isolated by filtration. The product was called “2,7-Dihidroxypyrene of Example DD2”.

The scheme of this reaction could be consulted in FIG. 87.

### Example DD3. Synthesis of 3-(2-(2-(2-chloroethoxy) ethoxy) ethoxy) prop-1-ene

Step 1. NaH (60% oil, 213.5 mg, 1,3 eq.) was suspended in THF (7 mL, 1 mL/mmol) under inner atmosphere at 0° C.

Step 2. After that, 2-(2-(2-chloroethoxy) ethoxy) ethanol (1,2 g, 1 eq.) was added dropwise at 0° C. This mixture was stirred at 0° C. for 10 minutes.

Step 3. Allyl bromide was added dropwise at 0° C.

Step 4. The reaction was stirred overnight at room temperature.

Step 5. After the reaction was completed, the pH was adjusted at 7.

Step 6. Then, the crude was washed three times DCM and once with brine.

Step 7. The organic phase was dried with MgSO₄ and the solvent was removed by vacuum.

Step 8. The product was purified by a chromatographic column (Silica, eluents: Hexane/Ethyl acetate 8/2). The product was termed “3-(2-(2-(2-chloroethoxy) ethoxy) ethoxy) prop-1-ene of Example DD3”.

The scheme of this reaction could be consulted in FIG. 87.

### Example DD4. Synthesis of Polyethoxy Monoalkylated

Step 1. “2,7-Dihidroxypyrene of Example DD2” (5 g, 1 eq.) and ^{t}BuONa (5,9 g, 3 eq.) were dissolved in dry DMF (12 mL, 12 mL/mmol) under inner atmosphere.

Step 2. Then, NaI (catalytic amount) was added, and the mixture was stirred 3 hours at room temperature.

Step 3. After the 3 hours, “3-(2-(2-(2-chloroethoxy) ethoxy) ethoxy) prop-1-ene of Example DD3” (4,2 g, 1 eq.) was added, and the reaction was stirred overnight at 153° C.

Step 4. The next day, pH of the crude was adjusted to 1-2 with HCl.

Step 5. The crude was extracted three times with Ethyl Acetate.

Step 6. The organic phase was dried with MgSO₄ and the solvent was removed by vacuum.

Step 7. The product was purified using a chromatographic column (silica, eluents: Eter/Hexane 7/3 to 9/1). The product was termed “Polyethoxy monoalkylated of Example DD4”.

The scheme of this reaction could be consulted in FIG. 87.

Variations of this reactions could be using K₂CO₃ instead of ^{t}BuONa in Step 1 and change the eluents of the Step 7 for Hexane/Ethyl Acetate from 8/2 to 7/3.

### Example DD5. Synthesis of Polyethoxy U-Shape

Step 1. “Polyethoxy monoalkylated of Example DD4” (353 mg, 2,2 eq.) and CsCO₃ (232 mg, 3 eq.) were dissolved in dry DMSO under inner atmosphere.

Step 2. This mixture was stirred 30 minutes at 63° C.

Step 3. α, α′-dibromo-o-xylene (106 mg, 1 eq.) was added and the reaction was stirred overnight at 63° C.

Step 4. After the night, a few drops of HCl 1M were added to the crude and a light brown solid appeared.

Step 5. The solid was filtrated and washed with water. The product was termed “Polyethoxy U-Shape of Example DD5”.

The scheme of this reaction could be consulted in FIG. 87.

### Example DD6. Synthesis of Pyrene U-Shape

Step 1. Pyrene monoalkylated (15 g, 2,2 eq.) and tetrabutylammonium bromide (TBA-Br; 567 mg, 0.1 eq.) were dissolved in Butanone/Water (1:1, 40 mL/mmol).

Step 2. NaOH (1,6 g, 2,2 eq.) was added. The mixture was heated at 50° C.

Step 3. Then, α, α′-dibromo-o-xylene (4,6 g, 1 eq.) was added and the reaction was set at 90° C. and stirred overnight.

Step 4. After the night, the reaction was cooled until room temperature.

Step 5. The butanone was removed by vacuum and a light brown solid appeared.

Step 6. The solid was filtrated and washed with cold acetone. The product was named “Pyrene U-Shape of Example DD6”.

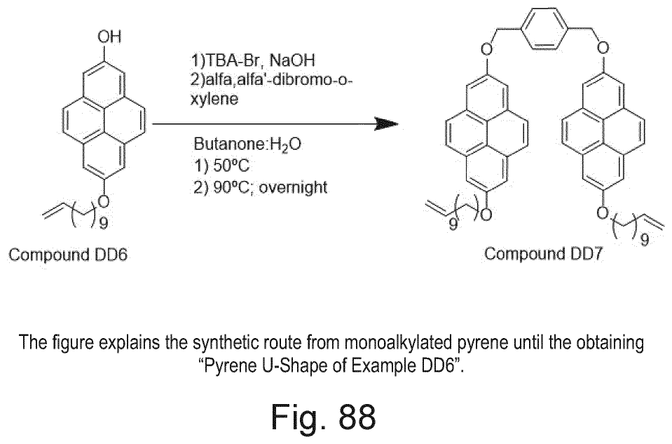

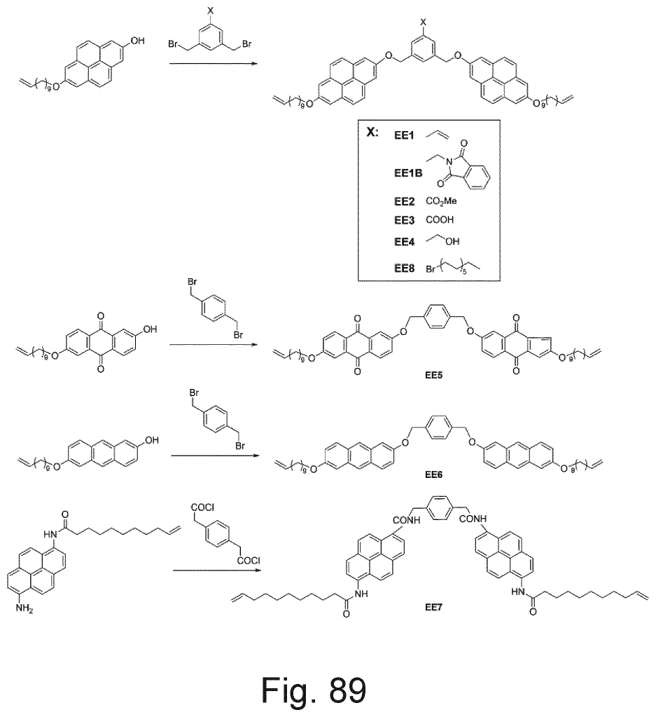

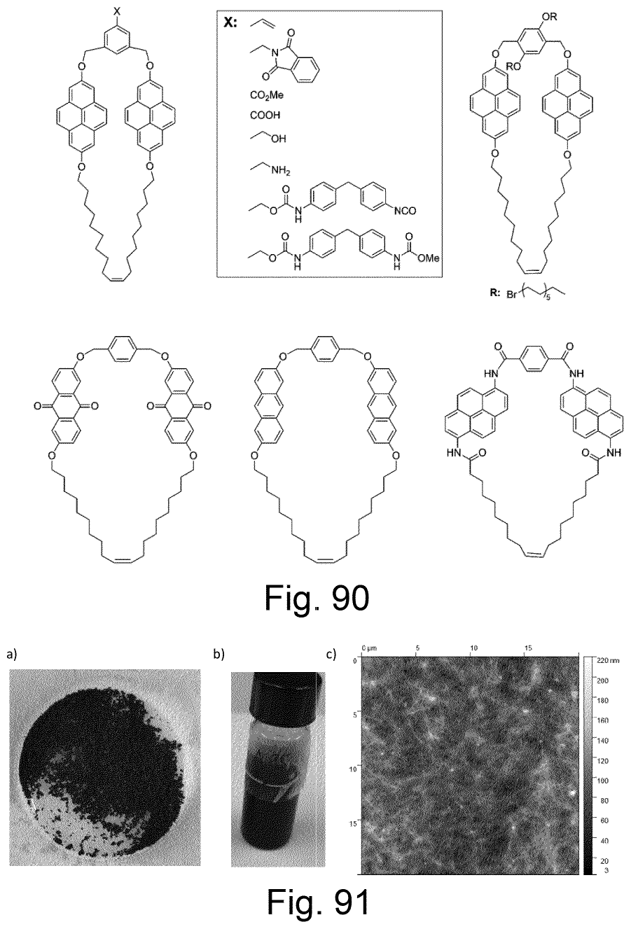

The scheme of this reaction could be consulted in FIG. 88.

The following examples show the different approaches for the synthesis of mechanical interlocked nanotubes (MINTs):

### Example DD7. Synthesis of Pyrene MINTs (Solvent Method)

Step 1. Single Wall Carbon Nanotubes from OCSiAl (SWNTs; 2 g) were dispersed in TCE (2 L, 1 mL/mg of SWNTs) using 15 minutes of sonication.

Step 2. After that, Pyrene U-Shape from “Pyrene U-Shape of Example DD6” (1,75 g, 1 μmol U-Shape/mg SWNTs) was added.

Step 3. N₂ was bubbled trough the sample for 20 minutes.

Step 4. Then, Grubbs catalyst 2^{nd} generation (1,7 g, 1 eq./eq. of U-Shape) was added.

Step 5. Stirring the reaction for 72 hours at room temperature.

Step 6. After Step 5, Dichloromethane (50 mL) was added and the reaction mixture was filtered through a PTFE membrane of 0.2 μm pore size.

Step 7. The filter cake was collected and was re-dispersed in 100 mL dichloromethane in a round-bottom flask by bath sonication for 3 min.

Step 8. The sample was filtered again through a PTFE membrane of 0.2 μm pore size.

Step 9. Steps 7 and 8 were repeated Step 10. Approximately 50 mL Et₂O was added to the filter cake.

Step 11. MINTs were collected in a vial and dried overnight at room temperature. The product was called “Pyrene MINTs of example DD7”.

This product was analysed by Thermogravimetric analysis (TGA) resulting with 22% of SWNTs were coated by Pyrene U-Shape from “Pyrene U-Shape of Example DD6”.

Pyrene U-Shape from “Pyrene U-Shape of Example DD6” used in this example could be changed by “Polyethoxy U-Shape of Example DD5”, keeping the relationship

### Example DD8. Synthesis of Pyrene MINTs (Mortar Method)

Step 1. SWNTs from OCSiAl (10 mg), pyrene U-Shape from “Pyrene U-Shape of Example DD6” (4.2 mg, 0.48 μmol U-Shape/mg SWNTs) and Grubbs catalyst 2^{nd} generation (4.1 mg, 1 eq. of Grubbs/eq. of pyrene U-Shape from “Pyrene U-Shape of Example DD6”) were poured into an agate mortar.

Step 2. Step 1 reactants were grinded 30 minutes. Then, Step 7, 8, 9 and 10 from “Pyrene MINTs of example DD7” were repeated.

The product obtained by this method was called “Pyrene MINTs of example DD8” and it was characterised by TGA with a 25% of functionalization.

“Pyrene MINTs of example DD8” conditions were optimised before the right conditions were found. Table DD8a shows a summary of all the test:

| U-Shape | Grubbs 2^{nd} generation | Functionalization |
|---|---|---|
| (μmol/SWNTs' mg) | (Grubbs' eq./U-Shape eq.′) | (%) |
| 1 | 1 | 34 |
| 0.48 | 1 | 30 |
| 0.24 | 1 | 24 |
| 0.12 | 1 | 14.5 |
| 0.48 | 0.5 | 25.5 |
| 0.48 | 0.25 | 25 |
| 0.48 | 0.05 | 21 |

Table DD8a: In this table it is presented the different conditions that were use in the Mortar method to the synthesis of MINTs. In the first column, it is represented the variation in the amount of the U-Shape. In the second column, it is the catalyst variation that is presented. In the final column, it is the degree of functionalization that the different tests achieve.

### Example DD9. Synthesis of Pyrene MINTs in the 20 mL Reactor (Ball Mill Method)

Step 1. SWNTs from OCSiAl (250 mg), “Pyrene U-Shape of Example DD6” (105 mg, 0.48 μmol U-Shape/mg SWNTs) and Grubbs 2^{nd} (10 mg, 0.1 eq. of Grubbs/eq. of “Pyrene U-Shape of Example DD6”) were poured into a 20 mL stainless steel reactor with 5 balls of stainless steel 10 mm of diameter.

Step 2. Reactants were grinded in the ball miller 10 minutes at 500 RPMs. Then, Steps 7, 8, 9 and 10 from “Pyrene MINTs of example DD7” were repeated.

The black powdery product obtained by this method was named “Pyrene MINTs of example DD9” and it was characterised by TGA with a functionalization of 26%.

“Pyrene MINTs of example DD9” conditions were optimised before the right conditions were found. Table DD9a shows a summary of all the test:

| | | | | | Grubbs 2^{nd} | |
|---|---|---|---|---|---|---|
| | | | | U-Shape | generation | |
| Time | | Balls | Balls | (μmol/ | (Grubbs' eq./ | Functionalization |
| (min) | RPMs | (number) | (diameter) | SWNTs' mg) | U-Shape's eq.) | (%) |
| 5 | 100 | 1 | 10 | 0.48 | 0.5 | 6.2 |
| 5 | 100 | 2 | 10 | 0.48 | 0.5 | 12.5 |
| 5 | 500 | 1 | 10 | 0.48 | 0.5 | 18.3 |
| 5 | 500 | 2 | 10 | 0.48 | 0.5 | 19.4 |
| 5 | 500 | 4 | 10 | 0.48 | 0.5 | 25 |
| 5 | 500 | 5 | 10 | 0.48 | 0.5 | 26 |
| 5 | 500 | 5 | 5 | 0.48 | 0.5 | 24 |
| | | 4 | 10 | | | |
| 5 | 500 | 5 | 5 | 0.48 | 0.5 | 26 |
| | | 5 | 10 | | | |
| 10 | 500 | 5 | 10 | 0.48 | 0.5 | 26 |
| 10 | 500 | 5 | 10 | 0.48 | 0.25 | 26 |
| 10 | 500 | 5 | 10 | 0.48 | 0.05 | 22 |

Table DD9a: In this table it is presented the different conditions that were used in the Ball Mill method with the 20 mL reactor to the synthesis of MINTs. In the first column, it is represented the variation in the time that it is used. In the second column, RPMs variations are presented. The next two columns are the variations in the number of the balls and/or the variation in the size of them. Then, the amount of the reagents is presented in the two following columns, there is not any variation in the U-Shape amount but there is some variation in the catalyst. Finally, the las t column tells the different percentage of functionalization that the MINTs reach.

### Example DD10. Synthesis of Pyrene MINTs in the 45 mL Reactor (Ball Mill Method)

Step 1. SWNTs from OCSiAl (1,5 g), “Pyrene U-Shape of Example DD6” (630 mg, 0.48 μmol U-Shape/mg SWNTs) and Grubbs 2^{nd} (61.1 mg, 0.1 eq. of Grubbs/eq. of “Pyrene U-Shape of Example DD6”) were poured into a 45 mL stainless steel reactor with 5 balls of stainless steel 15 mm of diameter.

Step 2. Reactants were grinded in the ball miller 10 minutes at 500 RPMs. Then, Steps 7, 8, 9 and 10 from “Pyrene MINTs of example DD7” were repeated.

The black powdery product obtained by this method was named “Pyrene MINTs of example DD10” and it was characterised by TGA with a functionalization of 28%.

### Example DD11. Synthesis of Pyrene MINTs in the 80 mL Reactor (Ball Mill Method)

Step 1. SWNTs from OCSiAl (2,75 g), “Pyrene U-Shape of Example DD6” (1,15 g, 0.48 μmol U-Shape/mg SWNTs) and Grubbs 2^{nd} (111.5 mg, 0.1 eq. of Grubbs/eq. of “Pyrene U-Shape of Example DD6”) were poured into a 80 mL stainless steel reactor with 5 balls of stainless steel 15 mm of diameter.

Step 2. Reactants were grinded in the ball miller 10 minutes at 500 RPMs. Then, Steps 7, 8, 9 and 10 from “Pyrene MINTs of example DD7” were repeated.

The black powdery product obtained by this method was named “Pyrene MINTs of example DD11” and it was characterised by TGA with a functionalization of 25%.

### Example DD12. Synthesis of Pyrene MINTs without Grubbs (Ball Mill Method)

Step 1. SWNTs from OCSiAl(1,5 g), “Pyrene U-Shape of Example DD6” (630 mg, 0.48 μmol U-Shape/mg SWNTs) and no Grubbs 2^{nd} (0 mg, 0 eq. of Grubbs/eq. of “Pyrene U-Shape of Example DD6”) were poured into a 45 mL stainless steel reactor with 5 balls of stainless steel 15 mm of diameter.

Step 2. Reactants were grinded in the ball miller 10 minutes at 500 RPMs.

Step 3. Then, the sample “Pyrene MINTs without Grubbs of example DD12” was split in half. On one half, Steps 7, 8, 9 and 10 from “Pyrene MINTs of example DD7” were repeated. On the second half, it was not apply any wash step.

Two black powdery products were obtained by this method: one was named “Pyrene MINTs without Grubbs wash of example DD12” and it was characterised by TGA with a functionalization of 9% and the other was called “Pyrene MINTs without Grubbs no wash of example DD12” and it was characterised by TGA with a functionalization of 8%

### Example DD13. Synthesis of Pyrene MINTs with 0.1 Equivalents of Grubbs (Ball Mill Method)

Step 1. SWNTs from OCsiAl (1,5 g), “Pyrene U-Shape of Example DD6” (630 mg, 0.48 μmol U-Shape/mg SWNTs) and Grubbs 2^{nd} (61.1 mg, 0.1 eq. of Grubbs/eq. of “Pyrene U-Shape of Example DD6”) were poured into a 45 mL stainless steel reactor with 5 balls of stainless steel 15 mm of diameter.

Step 2. Reactants were grinded in the ball miller 10 minutes at 500 RPMs.

Step 3. Then, the sample “Pyrene MINTs with 0.1 eq. Grubbs of example DD13” was split in half. On one half, Steps 7, 8, 9 and 10 from “Pyrene MINTs of example DD7” were repeated. On the second half, it was not apply any wash step.

Two black powdery products were obtained by this method: one was named “Pyrene MINTs with 0.1 eq. Grubbs wash of example DD13” and it was characterised by TGA with a functionalization of 22% and the other was called “Pyrene MINTs with 0.1 eq. Grubbs no wash of example DD13” and it was characterised by TGA with a functionalization of 35,5%.

### Example DD14. Synthesis of Pyrene MINTs with 1 Equivalent of Grubbs (Ball Mill Method)

Step 1. SWNTs from OCSiAl (1,5 g), “Pyrene U-Shape of Example DD6” (630 mg, 0.48 μmol U-Shape/mg SWNTs) and Grubbs 2^{nd} (611.3 mg, 1 eq. of Grubbs/eq. of “Pyrene U-Shape of Example DD6”) were poured into a 45 mL stainless steel reactor with 5 balls of stainless steel 15 mm of diameter.

Step 2. Reactants were grinded in the ball miller 10 minutes at 500 RPMs.

Step 3. Then, the sample “Pyrene MINTs with 1 eq. Grubbs of example DD12” was split in half. On one half, Steps 7, 8, 9 and 10 from “Pyrene MINTs of example DD7” were repeated. On the second half, it was not apply any wash step.

Two black powdery products were obtained by this method: one was named “Pyrene MINTs with 1 eq. Grubbs wash of example DD14” and it was characterised by TGA with a functionalization of 34% and the other was called “Pyrene MINTs with 1 eq. Grubbs no wash of example DD14” and it was characterised by TGA with a functionalization of 39%.

### Example DD15. Synthesis of Pyrene MINTs with 10 Equivalent of Grubbs (Ball Mill Method)

Step 1. SWNTs from OCSiAl (1,5 g), “Pyrene U-Shape of Example DD6” (630 mg, 0.48 μmol U-Shape/mg SWNTs) and Grubbs 2^{nd} (6,11 g, 10 eq. of Grubbs/eq. of “Pyrene U-Shape of Example DD6”) were poured into a 45 mL stainless steel reactor with 5 balls of stainless steel 15 mm of diameter.

Step 2. Reactants were grinded in the ball miller 10 minutes at 500 RPMs.

Step 3. Then, the sample “Pyrene MINTs with 10 eq. Grubbs of example DD15” was split in half. On one half, Steps 7, 8, 9 and 10 from “Pyrene MINTs of example DD7” were repeated. On the second half, it was not apply any wash step.

Two black powdery products were obtained by this method: one was named “Pyrene MINTs with 10 eq. Grubbs wash of example DD15” and it was characterised by TGA with a functionalization of 31% and the other was called “Pyrene MINTs with 10 eq. Grubbs no wash of example DD15” and it was characterised by TGA with a functionalization of 80%.

### Example DD16. Synthesis of Pyrene MINTs with 4 mL of Toluene (Ball Mill Method)

Step 1. SWNTs from OCSiAl (1,5 g), “Pyrene U-Shape of Example DD6” (630 mg, 0.48 μmol U-Shape/mg SWNTs), Grubbs 2^{nd} (61.1 mg, 0.1 eq. of Grubbs/eq. of “Pyrene U-Shape of Example DD6”) and 4 mL of toluene were poured into a 45 mL stainless steel reactor with 5 balls of stainless steel 15 mm of diameter.

Step 2. Reactants were grinded in the ball miller 10 minutes at 500 RPMs. Then, Steps 7, 8, 9 and 10 from “Pyrene MINTs of example DD7” were repeated.

The black product obtained by this method was named “Pyrene MINTs with 4 mL of toluene of example DD16” and it was characterised by TGA with a functionalization of 26%.

### Example DD17. Synthesis of Pyrene MINTs with 8 mL of Toluene (Ball Mill Method)

Step 1. SWNTs from OCSiAl (1,5 g), “Pyrene U-Shape of Example DD6” (630 mg, 0.48 μmol U-Shape/mg SWNTs), Grubbs 2^{nd} (61.1 mg, 0.1 eq. of Grubbs/eq. of “Pyrene U-Shape of Example DD6”) and 8 mL of toluene were poured into a 45 mL stainless steel reactor with 5 balls of stainless steel 15 mm of diameter.

Step 2. Reactants were grinded in the ball miller 10 minutes at 500 RPMs. Then, Steps 7, 8, 9 and 10 from “Pyrene MINTs of example DD7” were repeated.

The black product obtained by this method was named “Pyrene MINTs with 8 mL of toluene of example DD17” and it was characterised by TGA with a functionalization of 28%.

### Example DD18. Synthesis of Pyrene MINTs with 16 mL of Toluene (Ball Mill Method)

Step 1. SWNTs from OCSiAl (1,5 g), “Pyrene U-Shape of Example DD6” (630 mg, 0.48 μmol U-Shape/mg SWNTs), Grubbs 2^{nd} (61.1 mg, 0.1 eq. of Grubbs/eq. of “Pyrene U-Shape of Example DD6”) and 16 mL of toluene were poured into a 45 mL stainless steel reactor with 5 balls of stainless steel 15 mm of diameter.

Step 2. Reactants were grinded in the ball miller 10 minutes at 500 RPMs. Then, Steps 7, 8, 9 and 10 from “Pyrene MINTs of example DD7” were repeated.

The black product obtained by this method was named “Pyrene MINTs with 4 mL of toluene of example DD18” and it was characterised by TGA with a functionalization of 27%.

### Example DD19. Synthesis of Pyrene MINTs with 4 mL of Tetrachloroethane (TCE) (Ball Mill Method)

Step 1. SWNTs from OCSiAl (1,5 g), “Pyrene U-Shape of Example DD6” (630 mg, 0.48 μmol U-Shape/mg SWNTs), Grubbs 2^{nd} (61.1 mg, 0.1 eq. of Grubbs/eq. of “Pyrene U-Shape of Example DD6”) and 4 mL of tetrachloroethane (TCE) were poured into a 45 mL stainless steel reactor with 5 balls of stainless steel 15 mm of diameter.

Step 2. Reactants were grinded in the ball miller 10 minutes at 500 RPMs. Then, Steps 7, 8, 9 and 10 from “Pyrene MINTs of example DD7” were repeated.

The black product obtained by this method was named “Pyrene MINTs with 4 mL of tetrachloroethane (TCE) of example DD19” and it was characterised by TGA with a functionalization of 20%.

### Example DD20. Synthesis of Pyrene MINTs with 8 mL of Tetrachloroethane (TCE) (Ball Mill Method)

Step 1. SWNTs from OCSiAl (1,5 g), “Pyrene U-Shape of Example DD6” (630 mg, 0.48 μmol U-Shape/mg SWNTs), Grubbs 2^{nd} (61.1 mg, 0.1 eq. of Grubbs/eq. of “Pyrene U-Shape of Example DD6”) and 8 mL of tetrachloroethane (TCE) were poured into a 45 mL stainless steel reactor with 5 balls of stainless steel 15 mm of diameter.

Step 2. Reactants were grinded in the ball miller 10 minutes at 500 RPMs. Then, Steps 7, 8, 9 and 10 from “Pyrene MINTs of example DD7” were repeated.

The black product obtained by this method was named “Pyrene MINTs with 4 mL of tetrachloroethane (TCE) of example DD20” and it was characterised by TGA with a functionalization of 22%.

### Example DD21. Synthesis of Pyrene MINTs with 16 mL of Tetrachloroethane (TCE) (Ball Mill Method)

Step 1. SWNTs from OCSiAl (1,5 g), “Pyrene U-Shape of Example DD6” (630 mg, 0.48 μmol U-Shape/mg SWNTs), Grubbs 2^{nd} (61.1 mg, 0.1 eq. of Grubbs/eq. of “Pyrene U-Shape of Example DD6”) and 4 mL of tetrachloroethane (TCE) were poured into a 45 mL stainless steel reactor with 5 balls of stainless steel 15 mm of diameter.

Step 2. Reactants were grinded in the ball miller 10 minutes at 500 RPMs. Then, Steps 7, 8, 9 and 10 from “Pyrene MINTs of example DD7” were repeated.

The black product obtained by this method was named “Pyrene MINTs with 4 mL of tetrachloroethane (TCE) of example DD21” and it was characterised by TGA with a functionalization of 22%.

These examples describe the formation of MINTs composites by using commercial polymethyl methacrylate, abbreviated PMMA was used as polymer.

### Example DD22. No Grafting. Solution Process. CNT Composites by Using Commercial Polymethyl Methacrylate (PMMA)

Step 1. For the preparation of the composites of 0.1%, 1% and 2% of SWNTs from “Pyrene MINTs without Grubbs of example DD12” functionalization was used. They were dispersed in 30 mL of Toluene under sonication for 30 minutes at room temperature.

Amounts of “Pyrene MINTs without Grubbs wash of example DD12” and “Pyrene MINTs without Grubbs no wash of example DD12” were detail in the table DD22-1:

| SWNTs | | Amount of | |
|---|---|---|---|
| amount (%) | MINTs sample | MINTs | |
| 0.1% | “Pyrene MINTs without | 10.8 | mg |
| | Grubbs wash of example DD12” | | |
| | “Pyrene MINTs without | 11 | mg |
| | Grubbs no wash of example DD12” | | |
| 1% | “Pyrene MINTs without | 111 | mg |
| | Grubbs wash of example DD12” | | |
| | “Pyrene MINTs without | 109.8 | mg |
| | Grubbs no wash of example DD12” | | |
| 2% | “Pyrene MINTs without | 224.3 | mg |
| | Grubbs wash of example DD12” | | |
| | “Pyrene MINTs without | 221.8 | mg |
| | Grubbs no wash of example DD12” | | |

Step 2. 10 g of PMMA were added to the previous dispersion.

Step 3. The mixture was stirred under magnetic stirring for 24 hours at room temperature.

Step 4. The mixture was poured into 300 mL of methanol under rapid stirring to precipitate the composite.

Step 5. The composite was dried at 8000 for 24 hours.

The final composites “Pyrene MINTs without Grubbs and PMMA of Example DD22” were summarize in the Table DD22-2:

| | | Young's | | Tensile | |
|---|---|---|---|---|---|
| | SWNTs | Modulus | Standard | Stress | Standard |
| MINT sample | loading | (MPa) | Deviation | (MPa) | Deviation |
| “Pyrene MINTs without Grubbs | 0.1% | 2953.13 | 231.68 | 67.05 | 10.19 |
| wash of example DD12” | | | | | |
| “Pyrene MINTs without Grubbs | 0.1% | 2751.38 | 234.19 | 53.85 | 1.95 |
| no wash of example DD12” | | | | | |
| “Pyrene MINTs without Grubbs | 1% | 3106.88 | 136.82 | 50.07 | 5.61 |
| wash of example DD12” | | | | | |
| “Pyrene MINTs without Grubbs | 1% | 3209.89 | 300.38 | 50.01 | 11.73 |
| no wash of example DD12” | | | | | |
| “Pyrene MINTs without Grubbs | 2% | 3567.01 | 52.75 | 51.78 | 2.05 |
| wash of example DD12” | | | | | |
| “Pyrene MINTs without Grubbs | 2% | 3143.44 | 274.93 | 54.56 | 4.31 |
| no wash of example DD12” | | | | | |

The data shows that there is not any big difference between the samples wash and no wash.

Neither in the Young Modulus either in the Tensile Stress.

### Example DD23. No Grafting. Solution Process. CNT Composites by Using Commercial Polymethyl Methacrylate (PMMA)

Step 1. For the preparation of the composites of 0.1%, 1% and 2% of SWNTs from “Pyrene MINTs with 0.1 eq. Grubbs of example DD13” functionalization was used. They were dispersed in 30 mL of Toluene under sonication for 30 minutes at room temperature.

Amounts of “Pyrene MINTs with 0.1 eq. Grubbs wash of example DD13” and “Pyrene MINTs with 0.1 eq. Grubbs no wash of example DD13” were detail in the table DD23-1:

| SWNTs | | Amount of | |
|---|---|---|---|
| amount (%) | MINTs sample | MINTs | |
| 0.1% | “Pyrene MINTs with 0.1 eq. | 12.83 | mg |
| | Grubbs wash of example DD13” | | |
| | “Pyrene MINTs with 0.1 eq. | 15.52 | mg |
| | Grubbs no wash of example DD13” | | |
| 1% | “Pyrene MINTs with 0.1 eq. | 129.5 | mg |
| | Grubbs wash of example DD13” | | |
| | “Pyrene MINTs with 0.1 eq. | 156.6 | mg |
| | Grubbs no wash of example DD13” | | |
| 2% | “Pyrene MINTs with 0.1 eq. | 261.6 | mg |
| | Grubbs wash of example DD13” | | |
| | “Pyrene MINTs with 0.1 eq. | 316.4 | mg |
| | Grubbs no wash of example DD13” | | |

Step 2. 10 g of PMMA were added to the previous dispersion.

Step 3. The mixture was stirred under magnetic stirring for 24 hours at room temperature.

Step 4. The mixture was poured into 300 mL of methanol under rapid stirring to precipitate the composite.

Step 5. The composite was dried at 80° C. for 24 hours.

The final composites “Pyrene MINTs with 0.1 eq. Grubbs and PMMA of Example DD23” were summarize in the Table DD23-2:

| | | Young's | | Tensile | |
|---|---|---|---|---|---|
| | SWNTs | Modulus | Standard | Stress | Standard |
| MINT sample | loading | (MPa) | Deviation | (MPa) | Deviation |
| “Pyrene MINTs with 0.1 eq. | 0.1% | 2957.88 | 255.80 | 52.42 | 6.80 |
| Grubbs wash of example DD13” | | | | | |
| “Pyrene MINTs with 0.1 eq. | 0.1% | 3163.07 | 274.83 | 39.88 | 0.50 |
| Grubbs no wash of example DD13” | | | | | |
| “Pyrene MINTs with 0.1 eq. | 1% | 3824.75 | — | 37.88 | 2.05 |
| Grubbs wash of example DD13” | | | | | |
| “Pyrene MINTs with 0.1 eq. | 1% | 3162.42 | 236.22 | 42.01 | 2.48 |
| Grubbs no wash of example DD13” | | | | | |
| “Pyrene MINTs with 0.1 eq. | 2% | 3915.55 | 94.43 | 42.43 | 5.15 |
| Grubbs wash of example DD13” | | | | | |
| “Pyrene MINTs with 0.1 eq. | 2% | 3758.81 | 351.22 | 55.67 | 4.35 |
| Grubbs no wash of example DD13” | | | | | |

The data shows that there is not any big difference between the samples wash and no wash. Neither in the Young Modulus either in the Tensile Stress.

### Example DD24. No Grafting. Solution Process. CNT Composites by Using Commercial Polymethyl Methacrylate (PMMA)

Step 1. For the preparation of the composites of 0.1%, 1% and 2% of SWNTs from “Pyrene MINTs with G eq. Grubbs of example DD14” functionalization was used. They were dispersed in 30 mL of Toluene under sonication for 30 minutes at room temperature.

Amounts of “Pyrene MINTs with 1 eq. Grubbs wash of example DD14” and “Pyrene MINTs with 1 eq. Grubbs no wash of example DD14” were detail in the table DD24-1:

| SWNTs | | Amount of | |
|---|---|---|---|
| amount (%) | MINTs sample | MINTs | |
| 0.1% | “Pyrene MINTs with 1 eq. | 15.2 | mg |
| | Grubbs wash of example DD14” | | |
| | “Pyrene MINTs with 1 eq. | 16.41 | mg |
| | Grubbs no wash of example DD14” | | |
| 1% | “Pyrene MINTs with 1 eq. | 151.5 | mg |
| | Grubbs wash of example DD14” | | |
| | “Pyrene MINTs with 1 eq. | 164.1 | mg |
| | Grubbs no wash of example DD14” | | |
| 2% | “Pyrene MINTs with 1 eq. | 303.3 | mg |
| | Grubbs wash of example DD14” | | |
| | “Pyrene MINTs with 1 eq. | 328.2 | mg |
| | Grubbs no wash of example DD14” | | |

Step 2. 10 g of PMMA were added to the previous dispersion.

Step 3. The mixture was stirred under magnetic stirring for 24 hours at room temperature.

Step 4. The mixture was poured into 300 mL of methanol under rapid stirring to precipitate the composite.

Step 5. The composite was dried at 8000 for 24 hours.

The final composites “Pyrene MINTs with 1 eq. Grubbs and PMMA of Example DD24” were summarize in the Table DD24-2:

| | | Young's | | Tensile | |
|---|---|---|---|---|---|
| | SWNTs | Modulus | Standard | Stress | Standard |
| MINT sample | loading | (MPa) | Deviation | (MPa) | Deviation |
| “Pyrene MINTs with 1 eq. | 0.1% | 2731.52 | 328.02 | 52.15 | 5.24 |
| Grubbs wash of example DD14” | | | | | |
| “Pyrene MINTs with 1 eq. | 0.1% | 3259.51 | 124.74 | 59.47 | 1.73 |
| Grubbs no wash of example DD14” | | | | | |
| “Pyrene MINTs with 1 eq. | 1% | 3069.13 | 128.49 | 32.36 | 1.53 |
| Grubbs wash of example DD14” | | | | | |
| “Pyrene MINTs with 1 eq. | 1% | 3033.34 | 151.20 | 32.45 | 2.64 |
| Grubbs no wash of example DD14” | | | | | |
| “Pyrene MINTs with 1 eq. | 2% | 3475.41 | 426.14 | 54.08 | 5.79 |
| Grubbs wash of example DD14” | | | | | |
| “Pyrene MINTs with 1 eq. | 2% | 3911.31 | 352.55 | 41.34 | 9.37 |
| Grubbs no wash of example DD14” | | | | | |

The data shows that there is not any big difference between the samples wash and no wash. Neither in the Young Modulus either in the Tensile Stress.

### Example DD25. No Grafting. Solution Process. CNT Composites by Using Commercial Polymethyl Methacrylate (PMMA)

Step 1. For the preparation of the composites of 0.1%, 1% and 2% of SWNTs from “Pyrene MINTs with 10 eq. Grubbs of example DD15” functionalization was used. They were dispersed in 30 mL of Toluene under sonication for 30 minutes at room temperature.

Amounts of “Pyrene MINTs with 10 eq. Grubbs wash of example DD15” and “Pyrene MINTs with 10 eq. Grubbs no wash of example DD15” were detail in the table DD25-1:

| SWNTs | | Amount of | |
|---|---|---|---|
| amount (%) | MINTs sample | MINTs | |
| 0.1% | “Pyrene MINTs with 10 eq. | 14.51 | mg |
| | Grubbs wash of example DD15” | | |
| | “Pyrene MINTs with 10 eq. | 50 | mg |
| | Grubbs no wash of example DD15” | | |
| 1% | “Pyrene MINTs with10 eq. | 146.4 | mg |
| | Grubbs wash of example DD15” | | |
| | “Pyrene MINTs with10 eq. | 505 | mg |
| | Grubbs no wash of example DD15” | | |
| 2% | “Pyrene MINTs with10 eq. | 295.8 | mg |
| | Grubbs wash of example DD15” | | |
| | “Pyrene MINTs with10 eq. | 1.02 | g |
| | Grubbs no wash of example DD15” | | |

Step 2. 10 g of PMMA were added to the previous dispersion.

Step 3. The mixture was stirred under magnetic stirring for 24 hours at room temperature.

Step 4. The mixture was poured into 300 mL of methanol under rapid stirring to precipitate the composite.

Step 5. The composite was dried at 80° C. for 24 hours.

The final composites “Pyrene MINTs with 10 eq. Grubbs and PMMA of Example DD25” were summarize in the Table DD25-2:

| | | Young's | | Tensile | |
|---|---|---|---|---|---|
| | SWNTs | Modulus | Standard | Stress | Standard |
| MINT sample | loading | (MPa) | Deviation | (MPa) | Deviation |
| “Pyrene MINTs with 10 eq. | 0.1% | 3346.11 | 4.76 | 65.77 | 3.55 |
| Grubbs wash of example DD15” | | | | | |
| “Pyrene MINTs with 10 eq. | 0.1% | 2968.64 | 324.54 | 42.31 | 4.25 |
| Grubbs no wash of example DD15” | | | | | |
| “Pyrene MINTs with 10 eq. | 1% | 3920.80 | 196.48 | 56.62 | 1.40 |
| Grubbs wash of example DD15” | | | | | |
| “Pyrene MINTs with 10 eq. | 1% | 2952.50 | 403.92 | 40.52 | 3.86 |
| Grubbs no wash of example DD15” | | | | | |
| “Pyrene MINTs with 10 eq. | 2% | 3425.97 | 150.36 | 48.45 | 3.82 |
| Grubbs wash of example DD15” | | | | | |
| “Pyrene MINTs with 10 eq. | 2% | 3404.27 | — | 51.13 | — |
| Grubbs no wash of example DD15” | | | | | |

The data shows that there is not any big difference between the samples wash and no wash. Neither in the Young Modulus either in the Tensile Stress.

### Example DD26. No Grafting. Solution Process. Grubbs 2^{nd} Generation Composites by Using Commercial Polymethyl Methacrylate (PMMA)

Step 1. For the preparation of the composites of 0%, 0.1%, 1% and 2% of Grubbs 2^{nd} generation 0 mg, 122.2 mg, 1,223 g and 12,225 were used. They were dispersed in 30 mL of Toluene under sonication for 30 minutes at room temperature.

Step 2. 10 g of PMMA were added to the previous dispersion.

Step 3. The mixture was stirred under magnetic stirring for 24 hours at room temperature.

Step 4. The mixture was poured into 300 mL of methanol under rapid stirring to precipitate the composite.

Step 5. The composite was dried at 80° C. for 24 hours.

The final composites “Grubbs and PMMA composites of Example DD22” were summarize in the Table DD27-1:

| | Young's | | Tensile | |
|---|---|---|---|---|
| Grubbs | Modulus | Standard | Stress | Standard |
| percentage | (MPa) | Deviation | (MPa) | Deviation |
| 0% | 2639.57 | 203.85 | 45.96 | 7.40 |
| 0.1% | 3247.60 | 185.44 | 64.23 | 0.03 |
| 1% | 3075.19 | 321.85 | 52.22 | 1.73 |
| 2% | — | — | — | — |

The data shows that there is a big difference between the samples. More amount of Grubbs 2^{nd} generation means a higher Young Modulus and a lower Tensile Stress. In the case of the sample with 2% of Grubbs 2^{nd} generation, it was more difficult than usual to take it out of the mould.

### Example DD27. Synthesis of Pyrene MINTs with PMMA in the 20 mL Reactor

Step 1. SWNTs (300 mg), “Pyrene U-Shape of Example DD6” (126 mg, 0.48 μmol U-Shape/mg SWNTs), Grubbs 2^{nd} (12.2 mg, 0.1 eq. of Grubbs/eq. of “Pyrene U-Shape of Example DD6”) and 6 g of commercial PMMA were poured into a 20 mL stainless steel reactor with 5 balls of stainless steel 10 mm of diameter.

Step 2. Reactants were grinded in the ball miller 10 minutes at 500 RPMs.

The black powdery product obtained by this method was named “Pyrene MINTs with PMMA of example DD27” and it was characterised by TGA with a functionalization of 26%.

These examples describe the formation of MINTs composites by using commercial low density polyethylene, abbreviated LDPE was used as polymer.

### Example DD28. No Grafting. Solution Process. Grubbs 2^{nd} Generation Composites by Using Commercial Low Density Polyethylene (LDPE)

Step 1. For the preparation of the composites of 0%, 0.1%, 1% and 2% of Grubbs 2^{nd} generation 0 mg, 122.2 mg, 1,223 g and 12,225 were used. They were dispersed in 50 mL of Toluene under sonication for 30 minutes at room temperature.

Step 2. 10 g of LDPE were added to the previous dispersion.

Step 3. The mixture was stirred under magnetic stirring for 24 hours at room temperature.

Step 4. The mixture was poured into 300 mL of methanol under rapid stirring to precipitate the composite.

Step 5. The composite was dried at 6000 for 24 hours.

The final composites “Grubbs and LOPE composites of Example DD28” were summarize in the Table DD28-1:

| | Young's | | Tensile | |
|---|---|---|---|---|
| Grubbs | Modulus | Standard | Stress | Standard |
| percentage | (MPa) | Deviation | (MPa) | Deviation |
| 0% | 196.42 | 20.43 | 13.63 | 0.72 |
| 0.1% | 203.91 | 11.43 | 13.42 | 0.55 |
| 1% | 190.12 | 3.14 | 12.79 | 0.31 |
| 2% | 251.77 | 23.43 | 11.09 | 1.69 |

The data shows that there is not any big difference between the Young Modulus of the samples. Meanwhile, more amount of Grubbs 2^{nd} generation means lower Tensile Stress.

### Example DD29. No Grafting. Solution Process. CNT Composites by Using Commercial Low Density Polyethylene (LOPE)

Step 1. For the preparation of the composites of 0.1%, 1% and 2% of SWNTs from “Pyrene MINTs without Grubbs of example DD12” functionalization was used. They were dispersed in 50 mL of Toluene under sonication for 30 minutes at room temperature.

Amounts of “Pyrene MINTs without Grubbs wash of example DD12” and “Pyrene MINTs without Grubbs no wash of example DD12” were detail in the table DD29-1:

| SWNTs | | Amount of | |
|---|---|---|---|
| amount (%) | MINTs sample | MINTs | |
| 0.1% | “Pyrene MINTs without | 10.8 | mg |
| | Grubbs wash of example DD12” | | |
| | “Pyrene MINTs without | 11 | mg |
| | Grubbs no wash of example DD12” | | |
| 1% | “Pyrene MINTs without | 111 | mg |
| | Grubbs wash of example DD12” | | |
| | “Pyrene MINTs without | 109.8 | mg |
| | Grubbs no wash of example DD12” | | |
| 2% | “Pyrene MINTs without | 224.3 | mg |
| | Grubbs wash of example DD12” | | |
| | “Pyrene MINTs without | 221.8 | mg |
| | Grubbs no wash of example DD12” | | |

Step 2. 10 g of PMMA were added to the previous dispersion.

Step 3. The mixture was stirred under magnetic stirring for 24 hours at room temperature.

Step 4. The mixture was poured into 300 mL of methanol under rapid stirring to precipitate the composite.

Step 5. The composite was dried at 6000 for 24 hours.

The final composites “Pyrene MINTs without Grubbs and PMMA of Example DD29” were summarize in the Table DD29-2:

| | | Young's | | Tensile | |
|---|---|---|---|---|---|
| | SWNTs | Modulus | Standard | Stress | Standard |
| MINT sample | loading | (MPa) | Deviation | (MPa) | Deviation |
| “Pyrene MINTs without Grubbs | 0.1% | 153.78 | 6.87 | 12.56 | 0.78 |
| wash of example DD12” | | | | | |
| “Pyrene MINTs without Grubbs | 0.1% | 157.84 | 21.35 | 12.46 | 0.25 |
| no wash of example DD12” | | | | | |
| “Pyrene MINTs without Grubbs | 1% | 176.53 | 13.17 | 13.15 | 0.54 |
| wash of example DD12” | | | | | |
| “Pyrene MINTs without Grubbs | 1% | 189.02 | 15.30 | 8.50 | 2.06 |
| no wash of example DD12” | | | | | |
| “Pyrene MINTs without Grubbs | 2% | 212.77 | 12.08 | 13.38 | 0.14 |
| wash of example DD12” | | | | | |
| “Pyrene MINTs without Grubbs | 2% | 226.98 | 25.21 | 13.15 | 0.37 |
| no wash of example DD12” | | | | | |

The data shows that there is not any big difference between the samples wash and no wash for the Tensile Stress. Meanwhile, the Young Modulus increases with the percentage of SWNTs and Grubbs 2^{nd} generation in the sample.

### Example DD30. No Grafting. Solution Process. CNT Composites by Using Commercial Low Density Polyethylene (LOPE)

Step 1. For the preparation of the composites of 0.1%, 1% and 2% of SWNTs from “Pyrene MINTs with 0.1 eq. Grubbs of example DD13” functionalization was used. They were dispersed in 50 mL of Toluene under sonication for 30 minutes at room temperature.

Amounts of “Pyrene MINTs with 0.1 eq. Grubbs wash of example DD13” and “Pyrene MINTs with 0.1 eq. Grubbs no wash of example DD13” were detail in the table DD30-1:

| SWNTs | | Amount of | |
|---|---|---|---|
| amount (%) | MINTs sample | MINTs | |
| 0.1% | “Pyrene MINTs with 0.1 | 10.8 | mg |
| | eq. Grubbs wash of example DD13” | | |
| | “Pyrene MINTs with 0.1 | 11 | mg |
| | eq. Grubbs no wash of example DD13” | | |
| 1% | “Pyrene MINTs with 0.1 | 111 | mg |
| | eq. Grubbs wash of example DD13” | | |
| | “Pyrene MINTs with 0.1 | 109.8 | mg |
| | eq. Grubbs no wash of example DD13” | | |
| 2% | “Pyrene MINTs with 0.1 | 224.3 | mg |
| | eq. Grubbs wash of example DD13” | | |
| | “Pyrene MINTs with 0.1 | 221.8 | mg |
| | eq. Grubbs no wash of example DD13” | | |

Step 2. 10 g of PMMA were added to the previous dispersion.

Step 3. The mixture was stirred under magnetic stirring for 24 hours at room temperature.

Step 4. The mixture was poured into 300 mL of methanol under rapid stirring to precipitate the composite.

Step 5. The composite was dried at 60° C. for 24 hours.

The final composites “Pyrene MINTs with 0.1 eq. Grubbs and PMMA of Example DD30” were summarize in the Table DD30-2:

| | | Young's | | Tensile | |
|---|---|---|---|---|---|
| | SWNTs | Modulus | Standard | Stress | Standard |
| MINT sample | loading | (MPa) | Deviation | (MPa) | Deviation |
| “Pyrene MINTs with 0.1 eq. | 0.1% | 151.95 | 1.80 | 11.26 | 0.04 |
| Grubbs wash of example DD13” | | | | | |
| “Pyrene MINTs with 0.1 eq. | 0.1% | 155.13 | 5.94 | 11.26 | 0.39 |
| Grubbs no wash of example DD13” | | | | | |
| “Pyrene MINTs with 0.1 eq. | 1% | 153.45 | 2.81 | 12.31 | 0.17 |
| Grubbs wash of example DD13” | | | | | |
| “Pyrene MINTs with 0.1 eq. | 1% | 206.55 | 19.72 | 12.74 | 0.11 |
| Grubbs no wash of example DD13” | | | | | |
| “Pyrene MINTs with 0.1 eq. | 2% | 201.12 | 16.48 | 12.69 | 0.42 |
| Grubbs wash of example DD13” | | | | | |
| “Pyrene MINTs with 0,1 eq. | 2% | 206.98 | 8.83 | 12.92 | 0.86 |
| Grubbs no wash of example DD13” | | | | | |

The data shows no big difference in the Tensile Stress values but there is a slightly increase in the Young Modulus between the wash and no washes samples.

### Example DD31. No Grafting. Solution Process. CNT Composites by Using Commercial Low Density Polyethylene (LDPE)

Step 1. For the preparation of the composites of 0.1%, 1% and 2% of SWNTs from “Pyrene MINTs with 1 eq. Grubbs of example DD14” functionalization was used. They were dispersed in 30 mL of Toluene under sonication for 30 minutes at room temperature.

Amounts of “Pyrene MINTs with 1 eq. Grubbs wash of example DD14” and “Pyrene MINTs with 1 eq. Grubbs no wash of example DD14” were detail in the table DD31-1:

| SWNTs | | Amount of | |
|---|---|---|---|
| amount (%) | MINTs sample | MINTs | |
| 0.1% | “Pyrene MINTs with 1 eq. | 12.83 | mg |
| | Grubbs wash of example DD14” | | |
| | “Pyrene MINTs with 1 eq. | 15.52 | mg |
| | Grubbs no wash of example DD14” | | |
| 1% | “Pyrene MINTs with 1 eq. | 129.5 | mg |
| | Grubbs wash of example DD14” | | |
| | “Pyrene MINTs with 1 eq. | 156.6 | mg |
| | Grubbs no wash of example DD14” | | |
| 2% | “Pyrene MINTs with 1 eq. | 261.6 | mg |
| | Grubbs wash of example DD14” | | |
| | “Pyrene MINTs with 1 eq. | 316.4 | mg |
| | Grubbs no wash of example DD14” | | |

Step 2. 10 g of PMMA were added to the previous dispersion.

Step 3. The mixture was stirred under magnetic stirring for 24 hours at room temperature.

Step 4. The mixture was poured into 300 ml of methanol under rapid stirring to precipitate the composite.

Step 5. The composite was dried at 8000 for 24 hours.

The final composites “Pyrene MINTs with eq. Grubbs and PMMA of Example DD31” were summarize in the Table DD31-2:

| | | Young's | | Tensile | |
|---|---|---|---|---|---|
| | SWNTs | Modulus | Standard | Stress | Standard |
| MINT sample | loading | (MPa) | Deviation | (MPa) | Deviation |
| “Pyrene MINTs with 1 eq. | 0.1% | 167.46 | 11.70 | 12.25 | 0.85 |
| Grubbs wash of example DD14” | | | | | |
| “Pyrene MINTs with 1 eq. | 0.1% | 158.20 | 25.17 | 12.23 | 0.58 |
| Grubbs no wash of example DD14” | | | | | |
| “Pyrene MINTs with 1 eq. | 1% | 182.30 | 26.49 | 9.25 | 1.38 |
| Grubbs wash of example DD14” | | | | | |
| “Pyrene MINTs with 1 eq. | 1% | 194.26 | 25.93 | 12.26 | 0.23 |
| Grubbs no wash of example DD14” | | | | | |
| “Pyrene MINTs with 1 eq. | 2% | 197.35 | 15.58 | 12.38 | 0.19 |
| Grubbs wash of example DD14” | | | | | |
| “Pyrene MINTs with 1 eq. | 2% | 208.45 | 23.42 | 13.01 | 0.41 |
| Grubbs no wash of example DD14” | | | | | |

The data shows a slightly increase in the values both for Young Modulus and Tensile Stress as you increase the percentage of the SWNTs in the samples. There is, also, an increase in the values between wash and no wash samples.

### Example DD32. No Grafting. Solution Process. CNT Composites by Using Commercial Low Density Polyethylene (LOPE)

Step 1. For the preparation of the composites of 0.1%, 1% and 2% of SWNTs from “Pyrene MINTs with 10 eq. Grubbs of example DD15” functionalization was used. They were dispersed in 30 mL of Toluene under sonication for 30 minutes at room temperature.

Amounts of “Pyrene MINTs with 10 eq. Grubbs wash of example DD15” and “Pyrene MINTs with 10 eq. Grubbs no wash of example DD15” were detail in the table DD32-1:

| SWNTs | | Amount of | |
|---|---|---|---|
| amount (%) | MINTs sample | MINTs | |
| 0.1% | “Pyrene MINTs with 10 eq. | 15.2 | mg |
| | Grubbs wash of example DD15” | | |
| | “Pyrene MINTs with 10 eq. | 16.41 | mg |
| | Grubbs no wash of example DD15” | | |
| 1% | “Pyrene MINTs with 10 eq. | 151.5 | mg |
| | Grubbs wash of example DD15” | | |
| | “Pyrene MINTs with 10 eq. | 164.1 | mg |
| | Grubbs no wash of example DD15” | | |
| 2% | “Pyrene MINTs with 10 eq. | 303.3 | mg |
| | Grubbs wash of example DD15” | | |
| | “Pyrene MINTs with10 eq. | 328.2 | mg |
| | Grubbs no wash of example DD15” | | |

Step 2. 10 g of PMMA were added to the previous dispersion.

Step 3. The mixture was stirred under magnetic stirring for 24 hours at room temperature.

Step 4. The mixture was poured into 300 mL of methanol under rapid stirring to precipitate the composite.

Step 5. The composite was dried at 60° C. for 24 hours.

The final composites “Pyrene MINTs with 10 eq. Grubbs and PMMA of Example DD32” were summarize in the Table DD32-2:

| | | Young's | | Tensile | |
|---|---|---|---|---|---|
| | SWNTs | Modulus | Standard | Stress | Standard |
| MINT sample | loading | (MPa) | Deviation | (MPa) | Deviation |
| “Pyrene MINTs with 10 eq. | 0.1% | 142.16 | 12.67 | 12.02 | 0.11 |
| Grubbs wash of example DD15” | | | | | |
| “Pyrene MINTs with 10 eq. | 0.1% | 170.40 | 20.79 | 9.39 | 1.46 |
| Grubbs no wash of example DD15” | | | | | |
| “Pyrene MINTs with 10 eq. | 1% | 178.21 | 21.24 | 11.82 | 0.91 |
| Grubbs wash of example DD15” | | | | | |
| “Pyrene MINTs with 10 eq. | 1% | 168.89 | 18.34 | 12.47 | 0.43 |
| Grubbs no wash of example DD15” | | | | | |
| “Pyrene MINTs with 10 eq. | 2% | 214.81 | 2.57 | 12.75 | 0.16 |
| Grubbs wash of example DD15” | | | | | |
| “Pyrene MINTs with 10 eq. | 2% | 212.48 | 17.30 | 12.51 | 0.89 |
| Grubbs no wash of example DD15” | | | | | |

The data shows that in the case of “Pyrene MINTs with 10 eq. Grubbs and PMMA of Example DD32” there is not difference between the wash and no wash samples. Meanwhile, the Young Modulus increase as there are more SWNTs in the sample. Tensile Stress remains stable among the changes

### Example EE1. Synthesis of Alkene U-Shape

The procedure consists of a first synthesis of the spacer and a second step, where the Ushape is prepared by reaction between the monoalkylated pyrene and the spacer.

Step 1: To a flask containing 1,3,5-tris(bromomethyl)benzene (1 g, 2.8 mmol, 1 eq) was added tetrahydrofuran (14 mL).

Step 2: PPh3 (844 mg, 3.2 mmol, 1.15 eq) was added to the flask.

Step 3: The mixture was stirred at 60° C. for 12 h.

Step 4: After cooling at room temperature, the precipitate was recovered by filtration and washed with THF.

Step 5: The solid was dissolved in dichloromethane.

Step 6: Paraformaldehyde (168 mg, 5.6 mmol, 2 eq) and KOH aqueous solution (50%, 3 mL) were then added.

Step 7: Reaction was stirred at room temperature for 1 h.

Step 8: The target product was extracted three times with dichloromethane and then solvent was evaporated.

Step 9: Alkene spacer was obtained after purification by chromatographic column (Hexane: Dichloromethane 9:1) in a 65% yield (520 mg). The product was termed “alkene spacer of

### Example EE1

Step 10: The synthetized spacer was added to a flask containing 15 mL of N,N′-dimethylformamide.

Step 11: Monoalkylated pyrene (1.5 g, 3.9 mmol, 2.2 eq), K2CO3 (1.1 g, 7.8 mmol, 4.4 eq) and catalytic amount of KI were added to the flask.

Step 12: The mixture was stirred at 80° C. for 6 h.

Step 13: Mixture was cooled and poured over 200 mL of 1M HCl solution at 0° C.

Step 14: Alkene U-shape was recovered by filtration and washed with cold methanol (1.6 g, 99% yield). The product was termed “alkene Ushape of Example EE1”.

### Variations on the Above Mentioned Protocol:

In step 2, instead of PPh3, potassium phthalimide (520 mg, 2.8 mmol, 1 eq) was used for the preparation of Phthalimide-spacer. After heating at 80° C. for 12 h, water (200 mL) was added and the product was extracted with ethyl acetate. After chromatographic column in hexane:ethyl acetate 4:1 phthalimide spacer was obtained in a 40% yield (470 mg). The product was termed “Phthalimide spacer of Example EE1B” Phthalimide Ushape was synthetized following Steps 11-14. The product was termed “Phthalimide Ushape of Example EE1B”

### Example EE2. Synthesis of Ester U-Shape

The Ushape is prepared by reaction between the monoalkylated pyrene and the commercial ester spacer.

Step 1: Methyl 2-(3,5-bis(bromomethyl)phenyl)acetate (5 g, 15.5 mmol, 1 eq) was added to a flask containing 150 mL of N,N′-dimethylformamide

Step 2: Monoalkylated pyrene (12 g, 31 mmol, 2.2 eq), K2CO3 (9.5 g, 68.2 mmol, 4.4 eq) and catalytic amount of KI were added to the flask.

Step 3: The mixture was stirred at 80° C. for 6 h.

Step 4: Mixture was cooled and poured over 500 mL of 1M HCl solution at 0° C.

Step 5: Ester U-shape was recovered by filtration and washed with cold methanol (14 g, 97%).

The product was termed “ester Ushape of Example EE2”.

### Variations on the Above Mentioned Protocol:

In step 3, instead heating at 80° C. the mixture can be refluxed to obtain acid U-shape in a quantitative yield. The product was termed “acid Ushape of Example EE2”.

### Example EE3. Synthesis of Acid U-Shape

The acid Ushape is prepared from ester Ushape (example EE2).

Step 1: ester Ushape of Example EE2 (1.3 g, 1.4 mmol, 1 eq) was added to a flask containing 25 mL of tetrahydrofuran

Step 2: Potassium tertbutoxide (430 mg, 3.8 mmol, 2.7 eq) was added to the solution.

Step 3: The mixture was stirred at for 24 h at room temperature

Step 4. 1M HCl solution (100 mL) was added.

Step 5: Acid U-shape was recovered by filtration and washed with methanol (1.25 g, 97%).

The product was termed “acid Ushape of Example EE3”.

### Example EE4. Synthesis of Methylalcohol U-Shape

The methylalcohol Ushape is prepared from ester Ushape (example EE2).

Step 1: ester Ushape of Example EE2 (500 mg, 0.57 mmol, 1 eq) was added to a flask containing 10 mL of tetrahydrofuran at 0° C.

Step 2: 1M solution of Lithium Aluminium Hydride in THF (1.14 mL, 1.14 mmol, 2 eq) was added dropwise to the solution.

Step 3: The mixture was stirred at room temperature for 12 h.

Step 4. Water (30 mL) was added.

Step 5: Methylalcohol U-shape was recovered by filtration (500 mg, 99%). The product was termed “methylalcohol Ushape of Example EE4”.

### Example EE5. Synthesis of Anthraflavic U-Shape

The anthraflavic Ushape is prepared from commercial anthraflavic acid

Step 1: Anthraflavic acid (1.6 g, 6.67 mmol, 1 eq) was added to a flask containing 93 mL of N,N′-dimethylformamide.

Step 2: Bromoundecene (1.55 g, 6.67 mmol, 1 eq), K2CO3 (926 mg, 6.67 mmol, 1 eq) and catalytic amount of KI were added to the solution.

Step 3: The mixture was refluxed for 24 h.

Step 4: After cooling, the reaction was poured over 300 mL of 1M HCl solution

Step 5: The solid recovered by filtration was purified by chromatographic column in dichloromethane to obtain Monoalkylated anthraflavic acid (500 mg, 30%). The product was termed “Monoalkylated anthraflavic acid of Example EE5”.

Step 6: Monoalkylated anthraflavic acid (1.47 g, 3.75 mmol, 1 eq) was dissolved in 50 mL of N,N′-dimethylformamide.

Step 7: p-dibromoxylene (489 mg, 1.88 mmol, 0.5 eq), K2CO3 (563 mg, 4.05 mmol, 1.08 eq) and catalytic amount of NaI were added to the flask.

Step 8: Reaction was stirred at 60° C. for 6 h

Step 9: 100 mL of 1M HCl solution was added

Step 10: anthraflavic ushape was recovered by filtration and washed with methanol (1 g, 60%).

The product was termed “anthraflavic Ushape of Example EE5”.

### Variations on the Above Mentioned Protocol:

In step 2, instead of bromoundecene, bromotriethyleneglycol can be used for the preparation of Glycol derivated of anthraflavic ushape. The product was termed “Glycol derivated of anthraflavic Ushape of Example EE5”

### Example EE6. Synthesis of Anthracene U-Shape

The anthracene Ushape is prepared from commercial anthraflavic acid

Step 1: Anthraflavic acid (3 g, 12.5 mmol, 1 eq) was added to a flask containing of Sodium borohydride (7.13 g, 187.5 mmol, 15 eq) in 1M Na2CO3 aqueous solution (150 mL)

Step 2: The mixture was stirred at room temperature until gas evolution stopped

Step 3: Then, the mixture was stirred 30 min at 80° C.

Step 4: The reaction was acidified with 3M HCl solution

Step 5: Anthracenediol was recovered by filtration and dried (2.5 g, 96%). The product was termed “anthracenediol of Example EE6”.

Step 6: anthracene diol (2.5 g, 11.9 mmol, 1 eq) was added to a flask containing 50 mL of acetone

Step 7: Bromoundecene (3.1 g, 13.1 mmol, 1.1 eq), K2CO3 (2.3 g, 16.6 mmol, 1.4 eq) were added to the solution.

Step 8: The mixture was stirred at 60° C. for 16 h.

Step 9: 200 mL of 1M HCl solution was added

Step 10: The solid recovered by filtration was purified by chromatographic column in dichloromethane to obtain Monoalkylated anthracene (500 mg, 32%). The product was termed “Monoalkylated anthracene of Example EE6”.

Step 11: Monoalkylated anthracene (500 mg, 1.38 mmol, 2.1 eq) was dissolved in 18 mL of N,N′-dimethylformamide.

Step 12: p-dibromoxylene (175 mg, 0.65 mmol, 1 eq), K2CO3 (200 mg, 1.44 mmol, 2.2 eq) and catalytic amount of NaI were added to the flask.

Step 13: Reaction was stirred at 60° C. for 6 h

Step 14: 100 mL of 1M HCl solution was added

Step 15: Anthracene ushape was recovered by filtration and washed with methanol (230 mg, 44%). The product was termed “anthracene Ushape of Example EE6”.

### Example EE7. Synthesis of Pyreneamides U-Shape

The pyreneamides Ushape is prepared from commercial pyrene

Step 1: pyrene (4 g, 20 mmol, 1 eq) was added to a flask containing 40 mL of acetic acid

Step 2: The mixture was heated to 90° C.

Step 3: Concentrated Nitric acid 3.54 mL) was added to the solution dropwise

Step 4: The mixture was stirred 30 min at 90° C.

Step 5: Reaction was cooled to room temperature

Step 6: Mixture of nitropyrenes was recovered by filtration (5.29 g)

Step 7: Mixture of nitropyrenes (5.29 g) were added to a flask containing 31 mL of ethanol and 15 mL of tetrahydrofuran

Step 8: Palladium on carbon (110 mg) was added to the mixture and refluxed.

Step 9: Hydrazine monohydrate (7.5 mL) was then added and refluxed for 12 h.

Step 10: After this time, reaction was filtered through paper to remove Palladium

Step 11: The solvent from filtrates was removed and the 1,6-diaminopyrene was obtained by chromatographic column (Dichloromethane: Ethyl acetate 9:1) in a 25% yield (1.2 g). The product was termed “1,6-diaminopyrene of Example EE7”.

Step 12: 1,6-diaminopyrene (232 mg, 1 mmol, 1 eq) and triethylamine (131 mg, 1.3 mmol, 1.3 eq) were dissolved in 25 mL of anhydrous tetrahydrofuran Step 13: undec-10-enoyl chloride (183 mg, 0.9 mmol, 0.9 eq) in 5 mL of tetrahydrofuran was added over the solution at 0° C.

Step 14: The reaction was stirred for 12 h at room temperature

Step 15: Water (100 mL) was added to the reaction

Step 16: The product was extracted with dichloromethane and purified by chromatographic column in dichloromethane (150 mg, 39%). The product was termed “Monoamide pyrene of Example EE7”.

Step 17: Monoamide pyrene (150 mg, 0.39 mmol, 2.1 eq) and pyridine (40 mg, 0.19 mmol, 1 eq) were dissolved in 10 mL of tetrahydrofuran.

Step 18: terephthaloyl chloride (38 mg, 0.19 mmol, 1 eq) was added to the mixture.

Step 19: The reaction was stirred for 8 h at room temperature

Step 20: Water (50 mL) was added

Step 21: pyreneamides Ushape was recovered by filtration and washed with acetone (100 mg, 70%). The product was termed “Pyreneamides Ushape of Example EE7”.

### Example EE8. Synthesis of Alkyl Substituted Spacer U-Shape

The alkyl substituted spacer U-shape is prepared from commercial hydroquinone

Step 1: hydroquinone (1 g, 9.1 mmol, 1 eq) was added to a flask containing 8 mL of DMSO

Step 2: 1-Bromododecane (4.98 g, 20 mmol, 2.2 eq) was added to the solution.

Step 3: The mixture was stirred at 80° C. for 15 minutes.

Step 4: KOH (2.55 g, 45.5 mmol, 5 eq) was added to the flask Step 5: Reaction was stirred at 90° C. for 12 hours.

Step 6: After this time, reaction was poured in water and extracted with DCM.

Step 7: Solvent was removed under vacuum obtaining 3 g of product.

Step 8: The product was dissolved in glacial acetic acid (15 mL) at 90° C.

Step 9: Formaldehyde (1 g, 33.5 mmol, 5 eq) and 4.5 mL of HBr in acetic acid (48%) were added to the solution.

Step 10: The mixture was stirred at 80° C. for 8 h.

Step 11: Reaction was poured in water and extracted with DCM.

Step 12: After removing the solvent, the solid was washed with methanol, obtaining pure product (4.1 g, 99%). The product was termed “alkyl substituted spacer of Example EE8”.

Step 13: 1.5 g (2.5 mmol, 1 eq) of dibromo spacer was added to a flask containing dry DMF (30 mL)

Step 14: Monoalkylated pyrene (2.02 g, 5.23 mmol, 2.1 eq), K2CO3 (1.45 g, 10.4 mmol, 4.2 eq) and catalytic amount of KI were added to the solution

Step 15: The mixture was stirred at 80° C. for 12 h.

Step 16: Reaction was poured in HCl 1M and filtered.

Step 17: The solid was washed with methanol and dried

Step 18: Dodecane substituted spacer Ushape was obtained. (2.5 g, 82%).

The product was termed “alkyl substituted spacer U-shape of Example EE8”.

### Variations on the Above Mentioned Protocol:

In step 2, instead of bromododecane, any linear or ramified bromo alkyl chain can be used following the same procedure.

### Example EE9. Preparation of MINTs

In this example, different procedures for the preparation of MINTs through ring closing methathesis using 2^{nd} generation Grubbs catalyst

### Example EE9, A. Wet Method

Step 1: In a round bottom flask containing 1000 mL of TCE, SWNTs (1 g) were added.

Step 2: The SWNTs were dispersed by bath sonication for 5 min Step 3: 2^{nd} gen. Grubbs catalyst (100 mg, 10 mol %) was added.

Step 4: The suspension was bubbled with argon for 15 minutes

Step 5: Ester U-shape of Example EE2 (1 g, 1.07 mmol) was added and the suspension was stirred for 72 h at room temperature.

Step 6: After this time, the reaction mixture was filtered through a PTFE membrane of 0.2 μm pore size.

Step 7: The filter cake was collected and was re-dispersed in 250 mL dichloromethane in a round-bottom flask by bath sonication for 3 min.

Step 8: The sample was filtered again through a PTFE membrane of 0.2 μm pore size.

Step 9: Steps 7 and 8 were repeated two times

Step 10: Approximately 50 mL Et₂O was added to the filter cake.

Step 11: The Ester MINTs were collected in a vial and dried overnight at room temperature.

The product was termed “ester MINT of Example EE9A”.

The above mentioned protocol can be used for EE1-EE8 products.

The products were termed “alkene MINT of Example EE9A”, “Phthalimide MINT of Example EE9A”, “acid MINT of Example EE9A”, “methylalcohol MINT of Example EE9A”, “anthraflavic acid MINT of Example EE9A”, “anthracene MINT of Example EE9A”, “pyreneamides MINT of Example EE9A” and “alkyl substituted spacer MINT of Example EE9A”

### Example EE9, B. Mechanochemical Method

The method makes use of the mechanical energy generated in a ball mill to disperse the CNTs, and/or bind the Ushape molecule to SWNTs, and/or mediate the ring-closing metathesis.

Step 1: In a 80 mL-size stainless steel ball mill reactor, SWNTs (2.5 g), Ester U-shape of Example EE2 (1.2 g, 1.23 mmol) and 2^{nd} gen. Grubbs catalyst (110 mg, 10 mol %) were added.

Step 2: The reactor was charged with five 15 mm diameter stainless steel balls.

Step 3: The powders were milled for 10 min at 500 rpm in an air atmosphere.

Step 4: After this time, the reactor content was recovered. Dichloromethane (50 mL) was added and the reaction mixture was filtered through a PTFE membrane of 0.2 μm pore size.

Step 5: The filter cake was collected and was re-dispersed in 100 mL dichloromethane in a round-bottom flask by bath sonication for 3 min.

Step 6: The sample was filtered again through a PTFE membrane of 0.2 μm pore size.

Step 7: Steps 5 and 6 were repeated

Step 8: Approximately 50 mL Et₂O was added to the filter cake.

Step 9: The Ester MINTs were collected in a vial and dried overnight at room temperature.

The product was termed “ester MINTs of Example EE9B”.

The above mentioned protocol can be used for EE1-EE8 products.

The products were termed “alkene MINT of Example EE9B”, “Phthalimide MINT of Example EE9B”, “acid MINT of Example EE9B”, “methylalcohol MINT of Example EE9B”, “anthraflavic acid MINT of Example EE9B”, “anthracene MINT of Example EE9B”, “pyreneamides MINT of Example EE9B” and “alkyl substituted spacer MINT of Example EE9B”

### Variations on the Above Mentioned Protocol:

In step 1-4, ball mill can be replaced by mortar milling.

### Example EE9, C. Chemical Modification of MINTs

### Example EE10. Methylamine MINTs

Step 1: Phthalimide MINTs of Example EE9B or Example EE9A (650 mg) prepared by mechanochemical or wet method were placed in a flask containing 130 mL of ethanol.

Step 2: The MINTs were dispersed by bath sonication for 5 min.

Step 3: Hydrazine monohydrate (6.5 mL) was added to the suspension.

Step 4: The suspension was then magnetically stirred for 1 h at 80° C.

Step 5: The reaction mixture was filtered through a PTFE membrane of 0.2 μm pore size.

Step 6: The filter cake was collected and was re-dispersed in 100 mL of 1M NaOH solution in a round-bottom flask by bath sonication for 3 min.

Step 7: The sample was filtered again through a PTFE membrane of 0.2 μm pore size.

Step 8: The filter cake was collected and was re-dispersed in 100 mL of dichloromethane in a round-bottom flask by bath sonication for 3 min.

Step 9: The sample was filtered again through a PTFE membrane of 0.2 μm pore size.

Step 10: Steps 9 and 10 were repeated

Step 11: The Methylamine MINTs were collected in a vial and dried overnight at room temperature. The product was termed “Methylamine MINTs of Example EE10”.

### Example EE11. Acid Chloride MINTs

Step 1: Acid MINTs of Example EE9B or Example EE9A (250 mg) prepared by mechanochemical or wet method were placed in a flask containing 50 mL of dichloromethane

Step 2: The MINTs were dispersed by bath sonication for 5 min.

Step 3: Oxalyl chloride (100 μL) was added to the suspension at 0° C.

Step 4: The suspension was then magnetically stirred for 3 h at room temperature.

Step 5: The reaction mixture was filtered through a PTFE membrane of 0.2 μm pore size.

Step 6: The filter cake was washed with 50 mL of dichloromethane

Step 7: The acid chloride MINTs were collected in a vial. The product was termed “Acid chloride MINTs of Example EE11”.

### Example EE12. MDI (NCO) MINTs

Step 1: Methylalcohol MINTs of Example EE9B or Example EE9A (250 mg) prepared by mechanochemical or wet method were placed in a flask containing 50 mL of toluene Step 2: The MINTs were dispersed by bath sonication for 5 min.

Step 3: 1,1′-Methylenebis(4-isocyanatobenzene) (150 mg) was added to the suspension.

Step 4: The suspension was then magnetically stirred for 2 h at 80° C.

Step 5: The reaction mixture was filtered through a PTFE membrane of 0.2 μm pore size.

Step 6: The filter cake was washed with 100 mL of toluene

Step 7: The MDI(NCO) MINTs were collected in a vial. The product was termed “MDI(NCO) MINTs of Example EE12”.

### Example EE13. MDI (OMe) MINTs

Step 1: Methylalcohol MINTs of Example EE9B or Example EE9A (250 mg) prepared by mechanochemical or wet method were placed in a flask containing 50 mL of toluene

Step 2: The MINTs were dispersed by bath sonication for 5 min.

Step 3: 1,1′-Methylenebis(4-isocyanatobenzene) (150 mg) was added to the suspension.

Step 4: The suspension was then magnetically stirred for 2 h at 80° C.

Step 5: Methanol (50 mL) was added to the mixture and refluxed for 2 h.

Step 6: The reaction mixture was filtered through a PTFE membrane of 0.2 μm pore size.

Step 7: The filter cake was washed with 50 mL of toluene and 50 mL of methanol.

Step 8: The MDI(OMe) MINTs were collected in a vial. The product was termed “MDI(OMe) MINTs of Example EE13”.

In this examples, the preparation of covalent bonded MINTs to functionalized polymers is described.

### Example EE14. Synthesis of Ester-MINT

The method makes use of the mechanical energy generated in a ball mill to disperse the CNTs, and/or bind the Ushape molecule to SWNTs, and/or mediate the ring-closing metathesis.

Step 1: In a 80 mL-size stainless steel ball mill reactor, SWNTs (2.5 g), ester Ushape of Example EE2 (1.2 g, 1.23 mmol) and 2^{nd} gen. Grubbs catalyst (110 mg, 10 mol %) were added.

Step 2: The reactor was charged with five 15 mm diameter stainless steel balls.

Step 3: The powders were milled for 10 min at 500 rpm in an air atmosphere.

Step 4: After this time, the reactor content was recovered. Dichloromethane (50 mL) was added and the reaction mixture was filtered through a PTFE membrane of 0.2 μm pore size.

Step 5: The filter cake was collected and was re-dispersed in 100 mL dichloromethane in a round-bottom flask by bath sonication for 3 min.

Step 6: The sample was filtered again through a PTFE membrane of 0.2 μm pore size.

Step 7: Steps 5 and 6 were repeated

Step 8: Approximately 50 mL Et₂O was added to the filter cake.

Step 9: The Ester MINTs were collected in a vial and dried overnight at room temperature.

The product was termed “Ester MINTs of Example EE14”.

### Variations on the Above Mentioned Protocol:

In step 1-4, ball milling can be replaced by mortar milling,

In step 5 sonication can be omitted,

### Example EE15. Synthesis of Polystyrene Amide-MINT (a)

The procedure consists of a mechanochemical reaction between ester MINTs and amine terminated polystyrene

Step 1: In a 20 mL-size stainless steel ball mill reactor, Ester MINTs of Example EE14 (500 mg), and amine-terminated polystyrene (Mw 5000, 800 mg) were added.

Step 2: The reactor was charged with five 5 mm diameter stainless steel balls.

Step 3: The powders were milled for 15 min at 500 rpm in an air atmosphere.

Step 4: After this time, the reactor content was recovered.

Step 5: The blackish solid was placed in an oven at 200° C. for 2 hours.

Step 6: The black solid (5 mg) was placed in a vial containing 20 mL of chloroform.

Step 7: The mixture was bath sonicated for 30 min

Step 8: The suspension was centrifuged for 5 min at 14000 g.

Step 9: The precipitated was removed and the supernatant was concentrated under vacuum.

Step 10: A black solid was obtained containing 15% of carbon nanotubes, approximately. The product was termed “PS-AMIDE-MINTs of Example EE15A”.

### Example EE15. Synthesis of Polystyrene Amide-MINT (B)

Step 1: In a 20 mL-size stainless steel ball mill reactor, Ester MINTs of Example EE14 (500 mg), and amine-terminated polystyrene (Mw 5000, 800 mg) were added.

Step 2: The reactor was charged with five 5 mm diameter stainless steel balls.

Step 3: The powders were milled for 15 min at 500 rpm in an air atmosphere.

Step 4: After this time, the reactor content was recovered.

Step 5: The blackish solid was placed in an oven at 200° C. for 2 hours.

Step 6: The black solid was placed in a 20 mL-size stainless steel ball mill reactor, SWNTs (500 mg), and 2^{nd} gen. Grubbs catalyst (50 mg, 10 mol %)

Step 7: The reactor was charged with five 5 mm diameter stainless steel balls.

Step 8: The powders were milled for 15 min at 500 rpm in an air atmosphere.

Step 9: After this time, the reactor content was recovered.

Step 10: The black solid (5 mg) was placed in a vial containing 20 mL of chloroform.

Step 11: The mixture was bath sonicated for 30 min

Step 12: The suspension was centrifuged for 5 min at 14000 g.

Step 13: The precipitated was removed and the supernatant was concentrated under vacuum.

Step 14: A black solid was obtained containing 15% of carbon nanotubes, approximately. The product was termed “PS-AMIDE-MINTs of Example EE15B”.

### Example EE15. Synthesis of Polystyrene Amide-MINT (C)

Step 1: In a 40 mL-size stainless steel ball mill reactor, Ester Ushape of Example EE2 (500 mg), amine-terminated polystyrene (Mw 5000, 800 mg), SWNTs (500 mg), and 2^{nd} gen. Grubbs catalyst (50 mg, 10 mol %) were added.

Step 2: The reactor was charged with five 10 mm diameter stainless steel balls.

Step 3: The powders were milled for 15 min at 500 rpm in an air atmosphere.

Step 4: After this time, the reactor content was recovered.

Step 5: The blackish solid was placed in an oven at 200° C. for 2 hours.

Step 6: After this time, the reactor content was recovered.

Step 7: The black solid (5 mg) was placed in a vial containing 20 mL of chloroform.

Step 8: The mixture was bath sonicated for 30 min

Step 9: The suspension was centrifuged for 5 min at 14000 g.

Step 10: The precipitated was removed and the supernatant was concentrated under vacuum.

Step 11: A black solid was obtained containing 15% of carbon nanotubes, approximately. The product was termed “PS-AMIDE-MINTs of Example EE15C”.

### Variations on the Above Mentioned Protocol:

Instead of amine terminated polystyrene, any polymer containing a terminal amino group can be used (PMMA-NH₂, PEG-NH₂, Poly(N-isopropyl acrylamide)—NH₂, etc)

Instead of ester mints, acid mints can be used for the reaction with amine terminated polymers.

Instead of ester Mints, methyl alcohol MINTs can be used for the reaction with isocyanate, bromo or carboxylic acid terminated polymers.

In these examples, the preparation of several composites samples using 3D printing is described. Depending on the type of polymer and their properties, the 3D printing technique should be selected for optimum results.

### Example EE16. Fused Deposition Modeling (FDM)

The procedure consists of a first mixing of polymer with the filler, a later extrusion of a filament that will be used for 3D printing using the FDM technology.

Step 1: To a flask containing 200 mL of acetone were added 50 g of ABS.

Step 2: 500 mg of “pyrene MINT of Example AA11a” were added to the mixture.

Step 3: The mixture was stirred at room temperature for 12 h.

Step 4: After that time solvent was evaporated.

Step 5: The solid was cut in small pieces

Step 6: A filament of composite was obtained using an extruder heating at 230° C.

Step 7: The extruded filament was used as obtained in a FDM 3D printed

### Variations on the Above Mentioned Protocol:

In Step 1, ABS can be replaced by PLA and chloroform as solvent.

In Step 2, amount of MINTs can be change to prepare 0.1-to 20 wt % composite

### Example EE17. Stereolithography (SLA)

The procedure consists of a first mixing of filler with a photopolymer resin to be used in SLA or DLP 3D printers.

Step 1: 10 wt % of “pyrene MINT of Example AA11a” is added to the resin.

Step 2: The mixture is mechanically stirred for 12 h.

Step 3: After this time, the mixture is sonicated three times for 1 hour at temperature below 20° C.

Step 4: After that time, the mixture is poured into the SL vat for use.

Step 5: The peristaltic pump is set to run at 6 ml/min to maintain a constant resin level and to provide means for constant mechanical mixing and steady recirculation of the nanocomposite.

Step 5: SLA 3D printed pieces is recovered.

### Variations on the Above Mentioned Protocol:

In Step 1, commercial acrylate or epoxy-based resins can be used

In Step 1, the amount of MINT can be changed to obtain composites with 0.1-20% MINT content.

### Example EE18. PolyJet

The procedure consists of a first mixing of elastomer with the filler user an extruder. The mixture will be used in a Polyjet 3D printer.

Step 1: Tri-block copolymer styrene-butadiene-styrene (SBS) is milled to reduce its original size to 1 mm in average in order to guarantee a continuous feeding of the twin-screw extruder.

Step 2: 50 g of polymer is placed in a flask

Step 3: 500 mg of “pyrene MINT of Example AA11a” are added to the polymer.

Step 4: The mixture is extruded with a temperature of 150° C. at the feed zone and 190° C. at the end of the extruder

Step 5: The extruder composite is collected and cooled to room temperature.

Step 6: The composite is cut in small pieces.

Step 7: Composite is used in a PolyJet 3D printer.

### Variations on the Above Mentioned Protocol:

In Step 1 the elastomer can be styrene-butadiene block copolymers, polyisoprene, polybutadiene, ethylene propylene rubber, ethylene propylene diene rubber.

In Step 2, amount of MINTs can be change to prepare 0.1-to 20 wt % composite

In step 4, extrusion temperature must be optimized for each composite.

### Example EE19. Multi Jet Fusion (MJF) and Selective Laser Sintering (SLS)

The procedure consists of a first mixing of nylon with the filler, a later extrusion of a filament that will be used for 3D printing using the MJF or SLS technology.

Step 1: To a flask containing 100 mL of formic acid are added 50 g of polyamide 12.

Step 2: 500 mg of “pyrene MINT of Example AA11a” are added to the mixture.

Step 3: The mixture is stirred at room temperature for 12 h.

Step 4: After that time solvent is evaporated.

Step 5: The solid is pulverised and used in the MJF or SLS systems.

### Variations on the Above Mentioned Protocol:

In Step 1, polyamide 12 can be replaced by thermoplastic polyurethane and acetone or acetone/methylethylketone as solvent.

In Step 1, polyamide 12 can be replaced by Polypropylene if the SLS system is going to be used.

In Step 2, amount of MINTs can be change to prepare 0.1-to 20 wt % composite Composite can be prepared using an alternative method:

Step 1: 50 g of polyamide 12 are placed in a flask.

Step 2: The polyamide is heated to 190° C. to be melted

Step 3: 500 mg of “pyrene MINT of Example AA11a” are added to the melted polyamide

Step 4: The mixture is shear mixed at 190° C. for 10 min.

Step 5: After cooling, the resulting composite is cryogenically fractured.

Step 6: The pulverised composite is used in the MJF or SLS systems.

### Example FF1. Preparation of Single Walled Carbon Nanotube-Mechanical Ligand Complexes for their Use in Thermoplastic Polymer Reinforcement

In this example, the preparation of single walled carbon nanotube-mechanical ligand complexes (SWNT-ML) is described. The mechanical ligand contains pyrene units as recognition motifs for SWNT.

The obtained SWNT-ML complexes were used in subsequent examples to make polypropylene-SWNT-ML composites using twin-screw microcompounding.

Step 1. 1 g Tuball CNTs (from OCSiAl; diameters ranging from 1.3-2.3 nm) were dispersed in tetrachloroethane (TCE, 1 L, 1 g/L) by sonication in a bath sonicator (10 min).

Step 2. To this dispersion, the Pyrene U-Shape of Example AA1. (0.55 g, 0.65 mmol) was added.

Step 3. The mixture was degassed with N₂ for 20 min and Grubbs' second-generation catalyst was added (0.55 g, 0.65 mmol, 1 equiv. with respect to Pyrene U-Shape of Example AA1).

Step 4. The reaction was maintained for 72 h at room temperature, allowing the ring-closing metathesis reaction to take place.

Step 5. After this time, the suspension was filtered through a 0.2 μm-pore size polytetrafluoroethylene (PTFE) membrane. The solid obtained was removed from the filter and washed with 300 mL dichloromethane employing 10 min sonication. This cleaning procedure was repeated three times, until the filtration solvent was completely colorless. A final wash with Et₂O was performed and the product was dried at 100° C. for 15 min. Approximately, 1.39 g of solid was collected.

Step 6. Steps 1-5 were repeated 9 more times, until approximately 13.89 g of dry product were collected.

Step 7. TGA indicated that the mass fraction of CNTs was 72%, and 28% of the weight being due to the mechanical ligand.

The resulting product, SWNTs with covalently closed ring structures around them was termed “Pyrene SWNT-ML of Example FF1.”

### Variations to the Above Protocol:

The pyrene Ushape added in Step 1 may be replaced by any other Ushape mentioned in this patent application.

### Example FF2. Preparing a “Master Batch” of 5 wt % Pyrene SWNT-ML—Polypropylene Composite

In this and subsequent examples, two different shear mixers were used.

For small quantities, an Xplore MC 15 twin screw microcompounder was used to mix the composites. It has a base capacity of 15 mL. and a maximum torque value is 9000 N-m. It is equipped with co-rotating and counter-rotating screws and the chamber can be closed to control mixing time, in addition to temperature (up to 450° C.) and mixing speed. However, the raw materials can only be mixed in batches of about 10-15 g at a time. For larger quantities (>400 g), a larger, Brabender KETSE 20/40 EC co-rotating twin screw extruder can be used. It has an integrated drive with a power of 11 kW and reaches speed up to max. 1200 rpm. Output is 0.5-9 kg/h. This allows for continuous mixing of large amount of composite at once. However, the chamber cannot be closed, leaving the only controllable parameters as temperature and screw rotational speed.

In some of the examples below, a ‘master batch’ with a high concentration of CNT is first made, and then diluted with neat polymer to make composites with lower concentrations of CNT.

The size of the Xplore MC 15 twin screw microcompounder chamber limits the amount of composite made at one time to 15 mL. As such, the polypropylene and coated tubes can only be mixed in quantities of about 10 g-15 g.

Step 1: In each of 12 containers, 11.167 g of PP and 0.833 g of “Pyrene SWNT-ML of Example FF1” were weighed out and collected.

Step 2: The microcompounder was prepared for mixing at 210° C. with a twin screw rotational speed of 100 rpm. One of the 12 g batches prepared in step 1 was introduced into the chamber, and left to mix for 5 min.

Step 3. The chamber was opened and the PP-Pyrene SWNT-ML composite was extruded from the nozzle and collected.

Step 4. Steps 2-3 were repeated for the remaining 11 containers.

Step 5. The extruded material of the 12 containers was combined and cut up into pellets using a pelletizer for subsequent processing. The resulting composite is hereby referred to as “5% Pyrene SWNT-ML Composite of Example FF2”

### Variations to the Above Protocol:

In step 1, different thermoplastic polymers, or SWNT-MLs using different Ushape chemistries can be used in place of polypropylene and the Pyrene SWNT-ML to make different polymer-SWNT-ML composites.
Different amounts of SWNT-ML can be used to make composites of different CNT content.
In step 2, different temperatures and twins screw rotational speeds, and mixing times can be employed which may improve the dispersion of the MINTs in the polymer matrix. Additionally, the temperature used will always be dependent on the choice of the polymer matrix.

### Example FF3. Diluting a “Master Batch” to make Lower Concentration Composites with the Brabender KETSE 20/40 EC

For quantities of material greater than 400 g, the Brabender KETSE 20/40 EC can be used to mix the material much faster and continuously, instead of separating the mixture into smaller batches. We will describe how to dilute the 5% Pyrene SWNT-ML Composite of Example FF2 into 600 g of 1 wt %, 0.1 wt %, and 0.01 wt % Pyrene SWNT-ML-PP composites using the Brabender KETSE 20/40 EC.

Step 1: 120 g of the “5% Pyrene SWNT-ML Composite of Example FF2” and 480 g of PP were thoroughly mixed in a bag to evenly spread out the “5% Pyrene SWNT-ML Composite of Example FF2” pellets among the neat PP polymer.

Step 2: The extruder was prepared for mixing at 180° C. with a twin screw rotational speed of 50 rpm. Lower temperature was used compared to Example FF2 since the concentration of CNTs was lower and overall viscosity of the mixture was also lower. Neat PP was passed through the extruder. As the polymer was poured, careful attention was paid to the torque as to not overload the system (80 Nm torque limit). The polymer was poured into the extruder at a rate that kept the torque at around 50 Nm.

Step 3: The neat PP was extruded from the extruder. Careful attention was made to make sure it came out clear to make sure that there were no contaminates in the extruder. Once it was certain that the polymer was coming out clear, the extruder was allowed to empty as much as it could. Once it stopped extruding, Step 4 was performed

Step 4. The “5% Pyrene SWNT-ML Composite of Example FF2”/PP mixture prepared in step 1 was slowly added to the extruder at a rate that kept the torque around 50 Nm. The residual neat PP is allowed to exit the extruder. Once there was a noticeable color change to black of the filament, the filament was placed on a cooling conveyor belt where it cooled down and then entered the pelletizer to cut into pellets.

Step 5. Once the batch was finished, the end of the filament was cut from the extruder and allowed to cool and pelletize. The pelletized composite was collected and saved. The resulting composite was named “1% Diluted Pyrene SWNT-ML Composite of Example FF3.”

Step 6: Neat polymer was then passed through the extruder until the color of the filament was completely clear again.

Comment: If the next sample is the same polymer and filler, but at a higher concentration of filler, the extruded material does not have to be completely clear, only light enough to notice the change in color when the new composite mixture is added and mixed. However, if the next composite to be mixed is of lower concentration or a different filler, it must be completely clear before mixing the composite.

Step 7: Steps 1-6 were repeated using 12.0 g of the “5% Pyrene SWNT-ML Composite of Example FF2” and 588 g of neat PP to create a 0.1 wt % composite hereby referred to as “0.1% Diluted Pyrene SWNT-ML Composite of Example FF3.”

Step 8: Steps 1-6 were repeated using 1.20 g of the “5% Pyrene SWNT-ML Composite of Example FF2 and 598.8 g of neat PP to create a 0.01 wt % composite hereby referred to as “0.01% Diluted Pyrene SWNT-ML Composite of Example FF3.”

### Variations to the Above Protocol:

In step 2, different temperatures and twins screw rotational speeds can be employed to help improve the dispersion of the MINTs in the polymer matrix.
In step 5, the extruded composite can be mixed for a second time to improve dispersion and concentration uniformity. Since the chamber cannot be closed, the mixing time can only be controlled by slowing the screw rotational speed. But a second mixing will increase the total mixing time.

### Example FF4. Sample Preparation of Dogbones for Tensile Mechanical Testing Analysis

This example describes the procedure for the preparation of dogbone-shaped tensile testing specimen for the “Diluted Pyrene SWNT-ML Composites of Example FF3.”

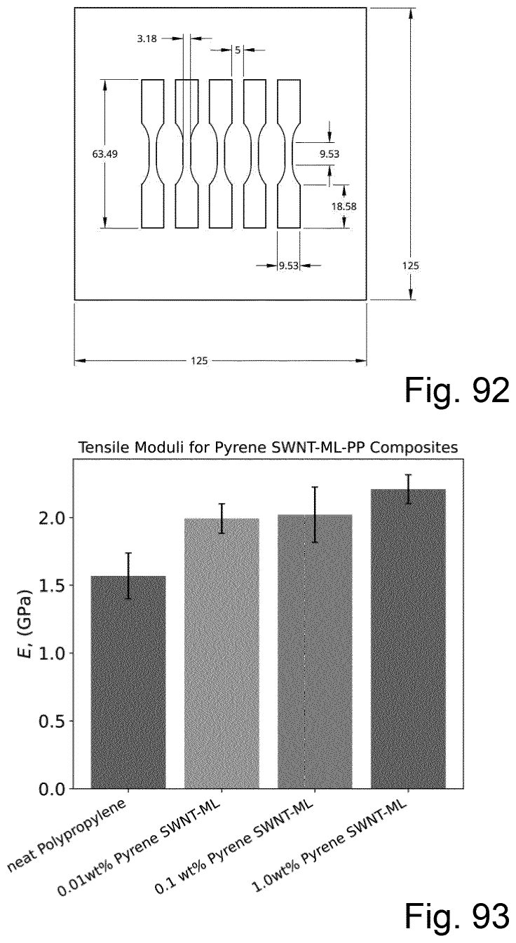

A mold of five dogbones was prepared from a 3 mm thick sheet of aluminum, shown in FIG. 92. The shape of the dogbone was taken as the Type V dogbone as described by ASTM D638.

For sample preparation, Atlas™ Series Heated Platens with the 4000 Series High Stability Temperature Controller were used together with the Atlas™ Manual 15 Ton (15T) Hydraulic Press, all from Specac, Ltd.

Step 1. On top of a 3 mm thick 125 mm×125 mm square of stainless steel, a 125 mm×125 mm sheet of Kapton film was placed. The mold (FIG. 92) was placed on top of the Kapton film.

Step 2. The mold was filled with pellets of “1% Diluted Pyrene SWNT-ML Composite of Example FF3.” Another 125 mm×125 mm of Kapton film was placed on top, and then another 125 mm×125 mm stainless steel plate.

Step 3. The heated platens were preheated to 180° C. Then the steel-Kapton-mold-Kapton-steel sandwich from step 2 was placed between the two platens. Then allowed to sit for about 5 minutes without adding pressure.

Step 4. Pressure between the platens was increased pressure to 10 ton by 2.5 ton increments with the pressure released between each increment to allow the mold to “breathe.” (2.5 tons, release, 5 tons, release, 7.5 tons, release, 10 tons, release. Then to 10 tons again).

Step 5. Temperature was held at 180° C. at 10 tons for 10 minutes.

Step 6. Temperature controller was set to 60° C. Pressure was kept at 10 tons as sample cooled. Once at 60° C., pressure was released.

Step 7. Samples were removed from mold. These samples were known as 1% Diluted Pyrene SWNT-ML Composite Dogbones of Example FF4.

Step 8. Steps 1-7 were repeated with both 0.1% Diluted Pyrene SWNT-ML Composite of Example FF3 and 0.01% Diluted Pyrene SWNT-ML Composite of Example FF3 to make 0.1% Diluted Pyrene SWNT-ML Composite Dogbones of Example FF4 and 0.01% Diluted Pyrene SWNT-ML Composite Dogbones of Example FF4, respectively. Additionally, dogbones were also prepared for neat polypropylene using the same process as a control, to make neat polypropylene dogbones of Example FF4.

### Example FF5. Tensile Mechanical Testing of Pyrene SWNT-ML-Polypropylene Composite Dogbones

For Tensile tests, an Instron 34-TM tensile testing machine was used with a 10 kN load cell.

Step. 1. The mechanical wedge tensile testing grips of the Instron 34-TM tensile testing machine were separated at a distance of 25 mm. A dogbone of 1% Diluted Pyrene SWNT-ML Composite Dogbones of Example FF4 was place between the grips and the grips were tightened. A tensile strain gauge extensometer with a 10 mm gauge length was then placed around the narrow region of the dogbone.

Step 2. The dogbone was strained at a rate of 1 mm/min until the sample broke.

Step 3. The Young's Modulus of the sample was calculated based on ASTM D638 from the slope of the stress strain curve, listed in the table below and plotted in FIG. 93

Young's modulus data as measured from tensile testing experiments for Pyrene SWNT-ML-PP dogbones prepared in Example FF4. Also shows relative increase in modulus for each composite compared to the neat polymer.

| | Young's Modulus | Relative |
|---|---|---|
| Sample | (GPa) | Modulus Increase |
| neat polypropylene | 1.57 ± 0.17 | — |
| 0.01 wt % Pyrene SWNT-ML-PP | 1.99 ± 0.11 | 27.1 ± 6.9% |
| 0.1 wt % Pyrene SWNT-ML-PP | 2.02 ± 0.20 | 28.9 ± 13.0% |
| 1.0 wt % Pyrene SWNT-ML-PP | 2.21 ± 0.11 | 40.9% ± 6.8% |

### Example FF 6. Preparation of SWNT-ML by Mechanical Grinding for Thermoplastic Polymer Composite Using Twin Screw Microcompounding

This example employs manual grinding, to produce SWNT-ML complexes, which are then used to make high-density polyethylene (HDPE)-SWNT-ML composites. We use a twin screw microcompounder to produce carbon nanotube thermoplastic nanocomposite.

Step 1: 1.0 g Tuball CNTs (OCSiAl S.a.r.I.) were mixed with 0.420 mg pyrene Ushape, 0.48 μmol Ushape/mg CNT) and 203.8 mg of Grubb's catalyst (2 mol Ushape/1 mol Grubb's Catalyst) and placed in a mortar.

Step 2: CNTs, Ushape, and Grubbs catalyst were grinded with mortar and pestle for 30 min, creating coated SWNT-ML complexes.

Step 3: The coated CNTs were placed in about −300 mL of chloroform and vacuum filtrated using a 0.2 μm pore filter

Step 4: The filter cake (approximately 1.4 g) was placed in another 300 mL of chloroform and bath sonicated 10 min, and then filtered again via vacuum filtration

Step 5: Step 4 was repeated 2 more times

Step 6: Step 4 was repeated once using 300 mL of diethyl ether instead of chloroform

Step 7: The filter cake was dried for 24 hr at 150° C. The resulting product was called “Mechano synthesized pyrene SWNT-ML of Example FF6.”

### Step 8:

The final product of Step 7 was analyzed by TGA. From the TGA the degree of functionalization (amount of Ushape relative to amount of SWNT) was determined to be 27.5%.

### Variations to the Above Protocol:

The pyrene Ushape added in Step 1 may be replaced by any of the U shapes mentioned in this patent application.

### Example FF7. Preparing 1% Concentration High Density Polyethylene Composites with the Xplore MC 15 Twin Screw Microcompounder

We will describe how to make 1 wt % Pyrene SWNT-ML-high density polyethylene (HDPE) using the Mechano synthesized pyrene SWNT-ML of Example FF6. Additionally, we will make 1% pyrene SWNT-ML composites using solution processed pyrene SWNT-ML as made via the procedure in Example FF1 for comparison.

Step 1: In each of 5 containers, 14.79 g of HDPE (Sigma-Aldrich, melt index 12 g/10 min, 90° C./2.16 kg) and 0.206 g of Mechano synthesized pyrene SWNT-ML of Example FF6 were weighed out and collected.

Step 2: The microcompounder was prepared for mixing at 190° C. with a twin screw rotational speed of 100 rpm. The 12 g batch prepared in step 1 was introduced into the chamber, and left to mix for 5 min.

Step 3. The chamber was opened and the HDPE-Pyrene SWNT-ML composite was extruded from the nozzle and collected.

Step 4. Steps 2-3 were repeated for the remaining 4 containers.

Step 5. The extruded material of the 5 containers was combined and cut up into pellets using a pelletizer for subsequent processing. The resulting composite is hereby referred to as 1% Mechano Pyrene SWNT-ML HDPE Composite of Example FF7.

Step 6. After cleaning, Steps 1-5 were repeated with 14.8 g HDPE and 0.1974 g of solution synthesized pyrene SWNT-ML that were made following the procedure outlined in Example FF1. These SWNT-ML had a functionalization of 24%. The resulting composite is hereby referred to as 1% Mechano Pyrene SWNT-ML HDPE Composite of Example FF7

Step 7. After cleaning, Steps 1-5 were also repeated with 15 g HDPE for a neat control sample.

This produces neat extruded HDPE of Example FF7.

### Variations to the Above Protocol:

In step 1, different thermoplastic polymers, or SWNT-MLs using different Ushape chemistries can be used in place of polypropylene and the Pyrene SWNT-ML to make different polymer-SWNT-ML composites.
Different amounts of SWNT-ML can be used to make composites of different CNT content.
In step 2, different temperatures and twins screw rotational speeds, and mixing times can be employed which may improve the dispersion of the MINTs in the polymer matrix. Additionally, the temperature used will always be dependent on the choice of the polymer matrix.

### Example FF8. Sample Preparation of HDPE Composite Dogbones for Tensile Mechanical Testing Analysis

Step 1. The procedure outlined in Example FF4 is followed to prepared dogbone tensile testing samples for 1) 1% Mechano Pyrene SWNT-ML HDPE Composite of Example FF7, 1% Mechano Pyrene SWNT-ML HDPE Composite of Example FF7, and neat extruded HDPE of Example FF7. Only changes are to Step 3 and Step 5, where the temperature used is 150° C.

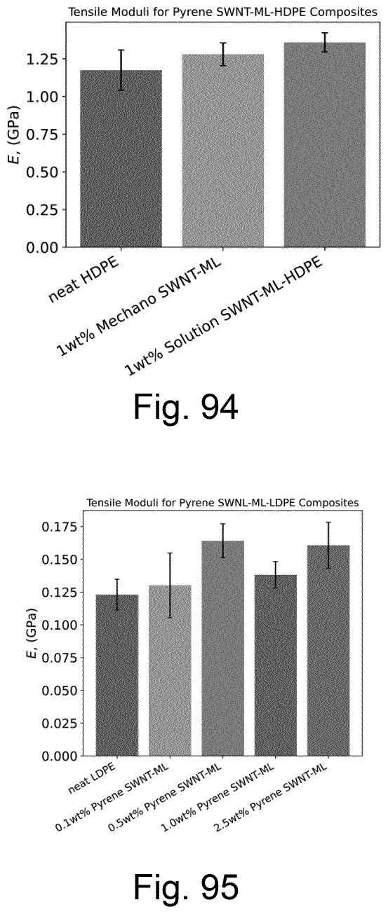

Step 2. The procedure outlined in Example FF5 was followed for mechanical property testing of the dogbones. The resulting measurements are shown in FIG. 94 and listed in the table below.

Young's modulus data as measured from tensile testing experiments for Pyrene SWNT-ML-PP dogbones prepared in Example FF4. Also shows relative increase in modulus for each composite compared to the neat polymer.

| | Young's Modulus | Relative |
|---|---|---|
| Sample | (GPa) | Modulus Increase |
| neat HDPE | 1.17 ± 0.13 | — |
| 1 wt % Mechano Pyrene | 1.28 ± 0.08 | 9.02 ± 6.40% |
| SWNT-ML-HDPE | | |
| 1 wt % Solution Pyrene | 1.36 ± 0.06 | 15.7 ± 5.41% |
| SWNT-ML-HDPE | | |

### Example FF9. Preparing Low Density Polyethylene Composites by Melt Mixing

Low density polyethylene (LDPE, Sigma Aldrich, melt index 25 g/10 min (190° C./2.16 kg))-SWNT-ML composites made using previously described methods are described.

Step 1. The procedure outlined in Example FF2 was adapted with the following changes:
1) SWNT-ML were prepared using mechanosynthesized SWNT-ML as described in Example FF6. They had a functionalization of 23.5%
2) The desired concentration of the master batch was 2.5 wt % SWNT-ML. 7 batches of 13 g per batch were prepared with 12.58 g LDPE and 424 mg SWNT-ML.
3) Each batch was mixed at 190° C. at 125 rpm for 5 min

This produced “2.5% Pyrene SWNT-ML LDPE Composite of Example FF9.”

Step 2. The procedure outlined in Example FF2 was adapted to the following changes.
Using batches of 11 g, consisting of 0.44 g 2.5% Pyrene SWNT-ML LDPE Composite of Example FF9 and 10.56 g neat LDPE were mixed together at 190° C. at 125 rpm for 5 min. 4 batches in total were mixed. The collected composite was called “0.1 wt % Diluted Pyrene SWNT-ML LDPE Composite of Example FF9”

Step 3. Step 2 was repeated with batches of 2.2 g of 2.5% Pyrene SWNT-ML LDPE Composite of Example FF9 and 8.80 g of neat LDPE. 4 batches in total were mixed. The collected composite was called “0.5 wt % Diluted Pyrene SWNT-ML LDPE Composite of Example FF9”

Step 4. Step 2 was repeated with batches of 4.4 g of 2.5% Pyrene SWNT-ML LDPE Composite of Example FF9 and 6.60 g of neat LDPE. 4 batches in total were mixed. The collected composite was called “1.0 wt % Diluted Pyrene SWNT-ML LDPE Composite of Example FF9”

Step 5. After cleaning, The procedure outlined in Example FF2 was also also repeated with 4 batches of 11 g/batch LDPE for a neat control sample. This produces neat extruded LDPE of Example FF9.

Step 6. The procedure outlined in Example FF4 is followed to prepared dogbone tensile testing samples for 1) 2.5% Pyrene SWNT-ML LDPE Composite of Example FF9, 0.1 wt % Diluted Pyrene SWNT-ML LDPE Composite of Example FF9, 0.5 wt % Diluted Pyrene SWNT-ML LDPE Composite of Example FF9, 1.0 wt % Diluted Pyrene SWNT-ML LDPE Composite of Example FF9, and neat extruded LDPE of Example FF9. Only changes are to Step 3 and Step 5, where the temperature used is 150° C.

Step 7. The procedure outlined in Example FF5 was followed for mechanical property testing of the dogbones. The resulting measurements are shown in FIG. 95 and listed in the table below.

| | Young's Modulus | Relative |
|---|---|---|
| Sample | (MPa) | Modulus Increase |
| neat LDPE | 122.99 ± 11.79 | |
| 0.1 wt % Diluted Pyrene | 130.08 ± 24.65 | 5.76 ± 20.04% |
| SWNT-ML-LDPE | | |
| 0.5 wt % Diluted Pyrene | 164.07 ± 12.94 | 33.33 ± 10.52% |
| SWNT-ML-LDPE | | |
| 1.0 wt % Diluted Pyrene | 138.08 ± 10.04 | 12.27 ± 8.16% |
| SWNT-ML-LDPE | | |
| 2.5 wt % Pyrene | 160.64 ± 17.53 | 30.61 ± 14.25% |
| SWNT-ML-LDPE | | |

### Example FF10. Preparation of Single Walled SWNT-ML-PVA Complexes

The preparation of water water-dispersible polyvinyl alcohol (PVA)-SWNT-ML complexes comprising 50 wt % CNT are described in this example.

Step 1. Example EE9, B was followed using “Acid Ushape of Example EE3” to make “Carboxylic Acid SWNT-ML complexes of Example FF10”,

Step 2: In a glass vial 164 mg of PVA (Sigma-Aldrich, M_{w}: 89,000-98,000, 99+% hydrolyzed) was mixed with 336 mg “Carboxylic Acid SWNT-ML complexes of Example FF10”, 88.7 mg 4-(dimethylamino)pyridine (DMAP, Sigma-Aldrich), 171 mg 1-hydroxybenzotriazole hydrate (HOBT, Sigma-Aldrich) and 517 mg N,N′-Dicyclohexylcarbodiimide (DCC) with 15 mL of dimethyl sulfoxide (DMSO). They displayed a functionalization of 25.6%, when tested by TGA.

Step 3. Heat vial to 120° C. under magnetic stirring for 1 hr.

Step 4. Let stir overnight at 60° C.

Step 5. Bath sonicated for 2 hr

Step 6. The next day, sample was precipitated in an acetone bath under magnetic stirring.

Step 7. Precipitate was collected, filtered using vacuum filtration, and washed twice with about 300 mL of acetone per wash.

Step 8. Washed precipitate was dried at 100° C. overnight. The resulting material is referred to as “50% Carboxylic Acid SWNT-ML-PVA Composite of Example FF10.”

Step 9. For comparison, Steps 1-8 was repeated in parallel using 250 mg of as-purchased carbon nanotubes (Tuball, OCSiAl) and 250 mg of PVA (for 50 wt % CNTs). Same amounts of DMAP, HOBT, and DCC were used. Note, at steps 5-6, resulting precipitate was more gel like and more difficult to filter than the sample made with carboxylic acid SWNT-ML. The resulting material is referred to as “50% SWNT-PVA Composite of Example FF10.”

### Variations to the Above Protocol:

In step 2, Different amounts of Carboxylic Acid SWNT-ML can be used to make composites of different CNT content.
In step 2, may be desirable to use smaller amounts or larger amounts of DCC, HOBT, and DMAP.
Different amounts of heating and sonication times in steps 2-4 may be used to help improve tube dispersion.
In step 2, more DMSO may be used to help facilitate tube dispersion as well.

### Example FF11. Preparation of Single Walled Carbon Nanotube—Mechanical Ligand-PVA Films from Aqueous Dispersions

Step 1. 50 mg of “50% Carboxylic Acid SWNT-ML-PVA Composite of Example FF10” was mixed with 5 mL of deionized water. The mixture was stirred overnight at 90° C.

Step 2. Mixture was bath sonicated for 1 hr.

Step 3. Mixture was poured into a 3 cm diameter glass petri dish. Film was dried at 80° C. overnight. The resulting film is referred to as “50% Carboxylic Acid SWNT-ML-PVA Film of Example FF11.”

Step 4. Steps 1-3 were repeated in parallel with 50% SWNT-PVA Composite of Example FF10 to make “50% SWNT-PVA Film of Example FF11.”

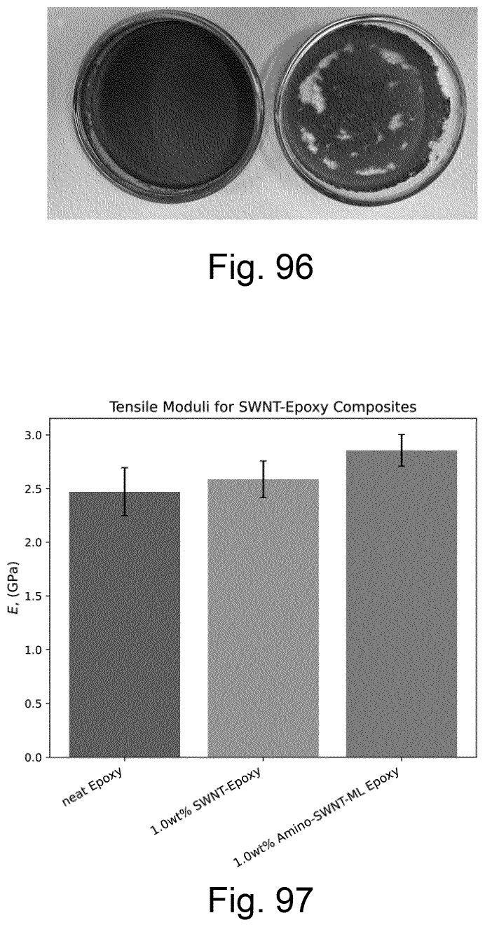

Step 5. The thickness of each of the films is measured using a Dektak Profilometer and the sheet resistance was measured using the Van der Pauw method on a four-probe station. The results are listed in Table. FIG. 96. Given the quality of the films shown in FIG. 96 it is no surprise the

50% Carboxylic Acid SWNT-ML-PVA film of Example FF11 is much thicker and much more conductive than the 50% SWNT-PVA film.

TABLE FF11.1
Thickness and Conductivity data for the SWNT-PVA Films

| | | 50% Carboxylic Acid |
|---|---|---|
| | 50% SWNT-PVA | SWNT-ML-PVA |
| Thickness (μm) | 6.41 ± 1.57 | 91.33 ± 2.56 |
| Conductivity (S/cm) | 0.031 ± 0.008 | 0.514 ± 0.052 |

### Variations to the Above Protocol:

In step 1, different amounts of water or PVA composite can be used to try different CNT concentrations.
In steps 1-2 different mixing times, temperature of mixing, and sonication times can be used to help improve dispersion
In step 4, different size substrates can be used to cast the film onto. Additionally, other casting methods, such as spin coating, can also be explored.

### Example FF12. Protocol for SWNL-ML Carbon Nanotube—Epoxy Nanotube Composite Sample Preparation Using Shear Mixing

In this example, we use a combination of shear mixing and compression molding to produce a high carbon nanotube content epoxy nanocomposite using mechanically interlocked carbon nanotubes (MINTs).

The experiment describes the making of a lwt % carbon-nanotube epoxy composite, but concentration and chemical composition can be adjusted accordingly. In the example, the mechanical ligands (rings) of the sized CNT becomes covalently linked to the epoxy polymer.

Step 1: 20.0 g diglycidyl ether of bisphenol A (DGEBA, Sigma-Aldrich), monomer is heated in an oven to ˜60° C. to reduce the monomer viscosity and the desired amount is weighed in a glass beaker. 392.67 mg “Methylamine MINTs of Example EE10” were added to the glass beaker.

Step 2: The DGEBA-Mint mixture was placed under the IKA T 25 digital ULTRA-TURRAX with S 25 N—18 G mixer and shear mixed at the maximum 10,000 rpm for 3 hr.

Step 3: The rotation speed of the mixture was reduced to 100 rpm for 5 min to promote degassing.

Step 4: After the mixing, the DGEBA-MINT mixture was placed in a vacuum oven at 80 C. A vacuum is pulled for 30 min to remove trapped gases as much as possible.

Step 5: The stoichiometric amount of hardener, Poly(propylene glycol) bis(2-aminopropyl ether) (MW: 230 g/mol, Sigma-Aldrich, also known as Jeffamine D-230) is added to the DGEBA-MINT mixture (with about 5% excess). For Jeffamine-D230 in the system described in step 3, that was 7.09 g. This mixture was then mixed by hand for approximately 1 min to avoid introducing more bubbles.

Step 6: After mixing, the mixture was then brought to the hot press, which was heated to 80° C. A 2 mm thick steel mold of a 70 mm×70 mm rectangle was placed on top of a Teflon sheet and another steel plate. The uncured mixed resin was then poured in the mold in slight excess. Another Teflon sheet and steel plate was then placed on top.

Step 7: 5,000 kg of Pressure was placed on the sample. This pressure was then released to help remove trapped gas. Repeat 3-4 more cycles of 5,000 kg of pressure and release.

Step 8: After cycling, 10,000 kg of pressure was applied on the sample. The sample was then cured at 80° C. for overnight.

Step 9: The sample was removed from press and mold. Fourier transform infrared spectroscopy was used to check the cure by monitoring epoxide peaks at 770 cm⁻¹ and 914 cm⁻¹. If these peaks are still present, place sample back in hot press, add 10,000 kg press, increase cure to 200° C. and check cure with FTIR every hour until fully cured. The resulting composite is from here referred to as the “1.0 wt % Amino SWNT-ML-Epoxy Composite of Example FF12.”

Step 10. Steps 1-9 were repeated twice, once without any fillers (no SWNT-MT) to produce a “neat Epoxy Composite of Example FF12” control sample, and again with 273.68 mg of as-purchased carbon nanotubes (Tuball, OCSiAl) to make “1.0 wt % SWNT-Epoxy Composite of Example FF12.”

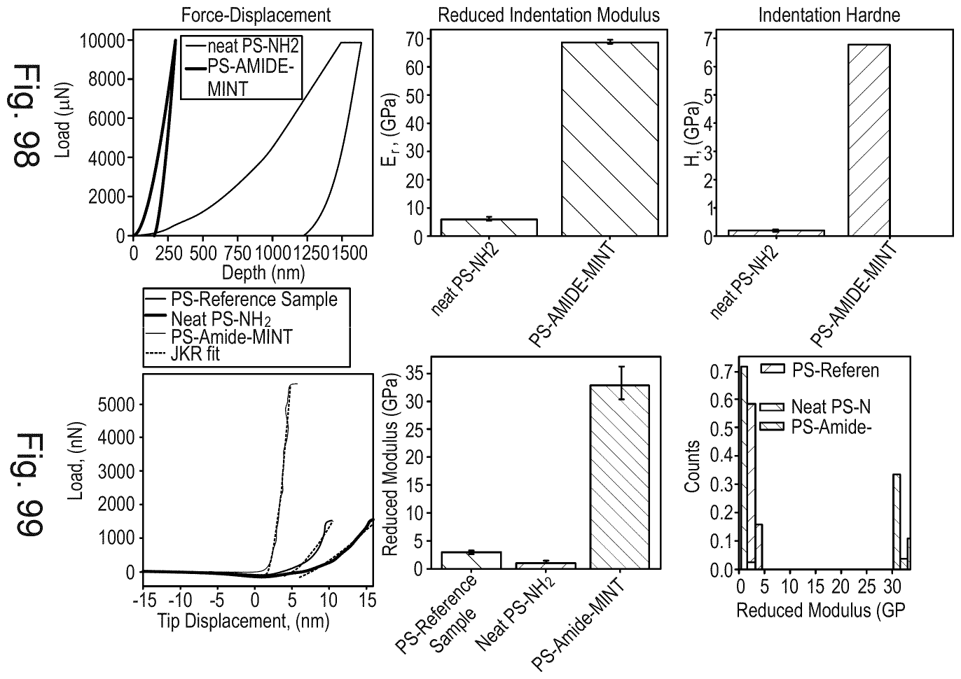

Step 11: The cured epoxy rectangles were then cut into dogbone shapes (see FIG. 92.) using a high-velocity water jet cutter. These samples are measured on a tensile tester per Example FF5. The resulting tensile moduli are reported in FIG. 97 and the table below, showing an increase in modulus for the Amino SWNT-ML-Epoxy that is outside the standard deviation, and larger in magnitude than that of the SWNT-ML-Epoxy.

Young's modulus data as measured from tensile testing experiments for Amino SWNT-ML-Epoxy dogbones prepared in Example FF12. Also shows relative increase in modulus for each composite compared to the neat polymer.

| | Young's Modulus | Relative |
|---|---|---|
| Sample | (GPa) | Modulus Increase |
| neat polypropylene | 2.47 ± 0.22 | — |
| 1.0 wt % SWNT-Epoxy | 2.59 ± 0.17 | 4.7 ± 6.9% |
| 1.0 wt % Pyrene SWNT-ML-PP | 2.86 ± 0.15 | 15.6% ± 5.9% |

### Variations to the Above Protocol:

In step 1. The chemistry of the mechanically interlocked ring around the CNTs can be modified to experiment with the effect of this functionalization on the dispersion and mechanical dispersion. Namely, amine derivatives of the ring can react with the epoxy backbone to covalently bond the MINTs to the epoxy matrix. However, the quantity of hardener needs to be reduced ensure stoichiometry.
In step 1, the chemistry of the epoxy can be modified to experiment with the effect different hardeners and epoxy backbones to see the effect on MINT dispersion and mechanical reinforcement
In step 2, the speed and mixing time can be modified to improve dispersion.
Before shear mixing, probe sonication can be used for a short amount of time to help break up large initial MINT agglomeration. However, as MINTs increase the viscosity of the mixture, sonication will become less effective.
Before step 1, the MINTs, which can start out as large agglomerated chunks, and be mechanically broken up to help reduce the initial size of the MINTs. Using a blade mixer/blender to start out with smaller mints could help.
Different cure temperatures and times can be experimented in Step 9.

### Example FF13. Nanoindentation of PS-AMIDE-MINTs

In this example, we test the mechanical properties of PS-AMIDE-MINTs of Example EE15C using nanoindentation.

Step 1. PS-AMIDE-MINTs of Example EE15C was dried on a flat surface to create a smooth flat film of approximately 200 μm in thickness. This sample was glued to a magnetic disc

Step 2. Using a diamond Berkovich tip on a Bruker Hysitron TS 77 Select, 9 indents were performed on the surface of the composite in a 3×3 array. The maximum force was set to 10 mN. The surface was indented at an indentation displacement rate of 0.1 s⁻¹ until reaching the max force of 10 mN where the maximum force was held for 30 sec. The force was then unloaded over the course of 2 seconds.

Step 3. The slope of the unloading curve was used to calculate the reduced elastic modulus and indentation hardness using the Oliver-Pharr model. The results are shown in FIG. 98 and listed in the table below.

Step 4. Steps 1-3 were repeated with neat amine-terminated polystyrene (neat PS—NH₂) (Mw 5000) as a control, prepared the same way as PS-AMIDE-MINTs of Example EE15C, except without any MINTs. We will refer to this sample as neat PS—NH₂ of Example FF13.

| | Reduced Modulus | |
|---|---|---|
| Sample | (GPa) | Hardness (GPa) |
| neat PS-NH₂ | 6.06 ± 0.70 | 0.182 ± 0.005 |
| PS-AMIDE-MINT | 68.67 ± 0.77 | 6.79 ± 0.16 |

### Example FF14. AFM Nanoindentation of PS-AMIDE-MINTs

In this example, we test the mechanical properties of PS-AMIDE-MINTs of Example EE15C using Atomic force microscopy (AFM) nanoindentation. The AFM used in this example was a JPK Nanowizard II AFM.

Step 1. Hemispherical cone shape tips (HSC60-250, Nano-tec, Inc.) with a nominal spring constant of 250 N/m were calibrated using the Sader Method to measure a real cantilever stiffness of 128 N/m.

Step 2. The deflection sensitivity of the AFM tip was measured using a sapphire reference sample and measured to be 28.3 nm/V.

Step 3. A reference polystyrene sample (PS-Film, Bruker) with a measured modulus of 2.7 GPa was then indented at maximum applied force of 4V at 64 different points in an 8×8 array. 10 indentations were taken at every point for a total 640 force displacement curves.

Step 4. Step 3 was repeated for neat PS—NH₂ of Example FF13

Step 5. Step 3 was repeated for PS-AMIDE-MINTs of Example EE15C. Except the applied force was increased to 1.5V.

Step 6. Using the Johnson-Kendall-Roberts Contact mechanical model, and the fact that the nominal modulus of the PS-reference sample was 2.7 GPa, the tip radius was determined to be 609 nm

Step 7. Using the Johnson-Kendall-Roberts Contact mechanical model and a tip radius of 609 nm, the reduced elastic modulus (Eᵣ) was measured for each force-displacement curve for each sample. Fitted curves with R² values below 0.95 were remove from the average calculation. The data is presented in FIG. 99 and shown in the table below. The fact that the reference PS sample gives a value close to 2.7 GPa tells us we can have good confidence in the other modulus measurements.

| | Reduced Modulus |
|---|---|
| Sample | (GPa) |
| Reference PS | 3.02 ± 0.307 |
| neat PS-NH₂ | 1.27 ± 0.23 |
| PS-AMIDE-MINT | 33.28 ± 2.88 |

### Example GG1. Synthesis of Mono- and Dialkylated Pyrene

This example describes the synthesis of pyrene derivatives, compounds (GG1c, GG1b), which are used as recognition motifs towards SWNTs and have terminal alkene functionalities that can be used in derivatives structures to react closing around a SWNT.

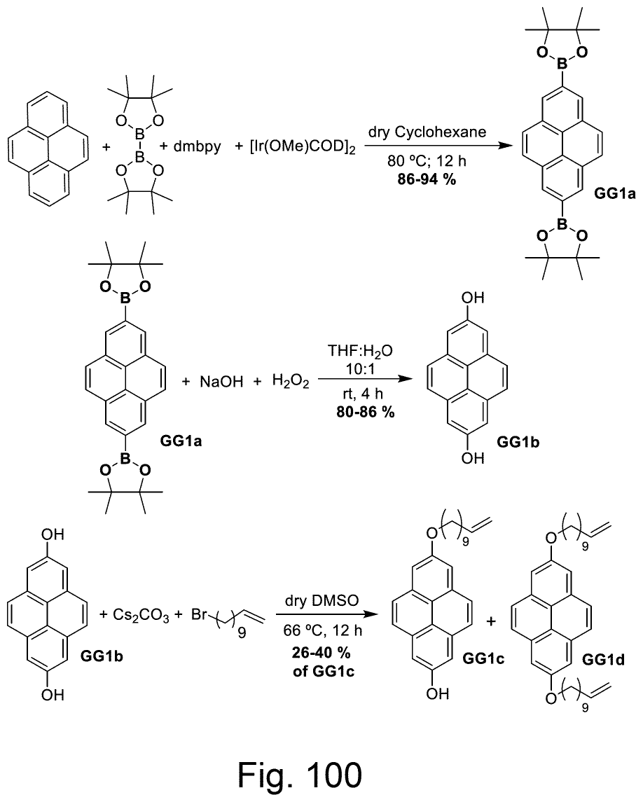

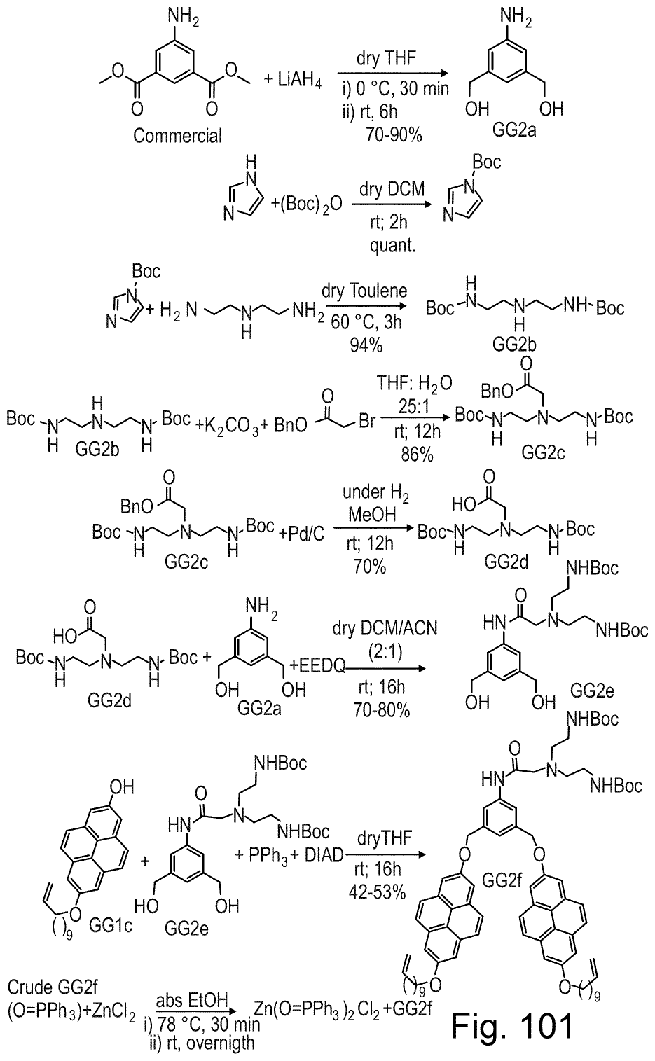

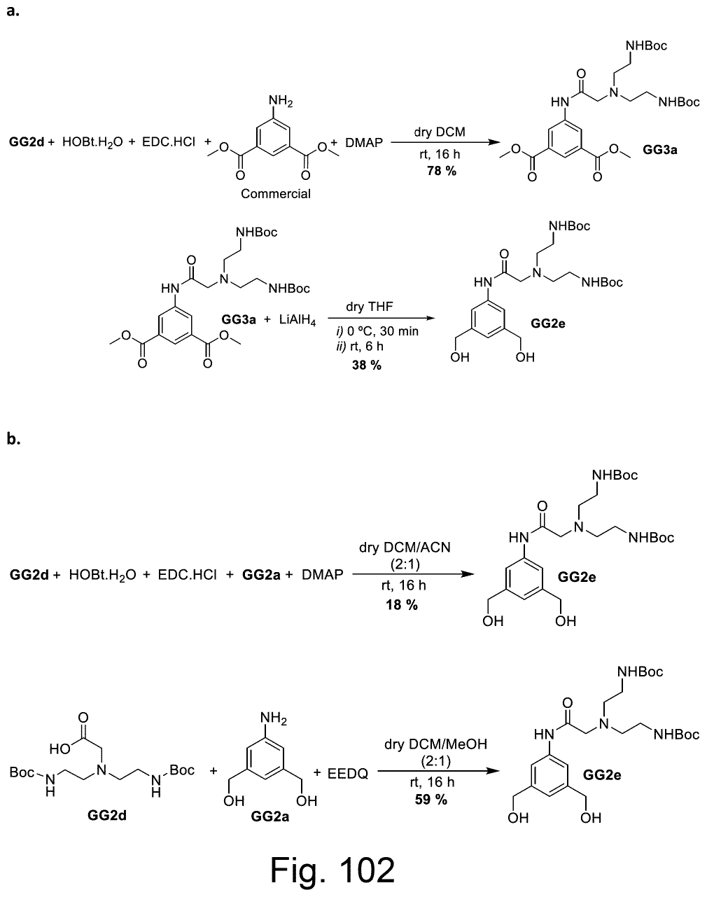

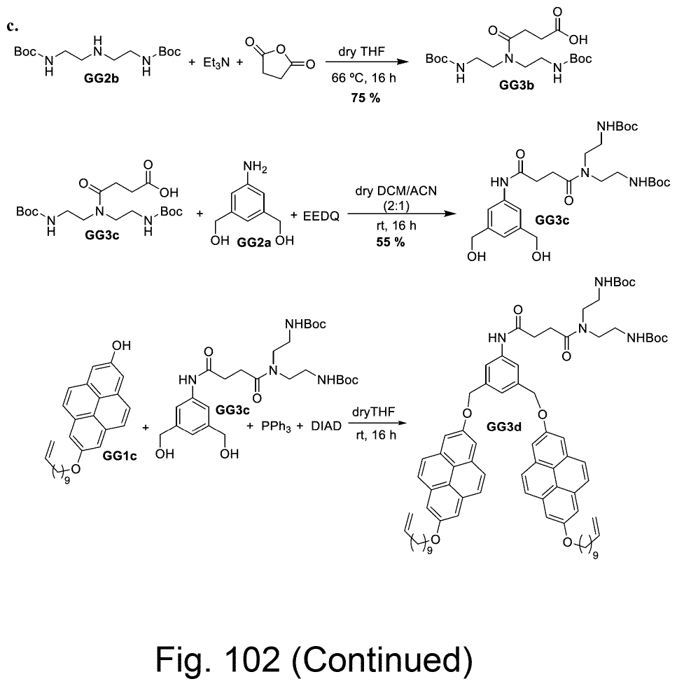

The synthesis consists of 3 reaction steps, as depicted in (FIG. 100). The synthesis is similar to the one described in Chem. Commun. 2015, 51, 5421, DOI: 10.1039/C40008970G.

### Example GG1a. Synthesis of 2, 7-diBpinpyrene (GG1a)

Step 1: Commercial Pyrene (4.0 g, 19.8 mmol, 1 equiv), bis(pinacolato)diboron (11.1 g, 43.6 mmol, 2.2 equiv) and dmbpy (106 mg, 0.396 mmol, 0.02 equiv) were added to the flask.

Step 2: three vacuum-Ar cycles were done.

Step 3: Anhydrous Cyclohexane (32.9 ml, 1.66 mL/mmol) was added.

Step 4: [Ir(OMe)COD]₂ (131 mg, 0.198 mmol, 0.01 equiv) was added.

Step 5: the mixture was refluxed (80° C.) for 16 h under argon.

Step 6: After the reaction had finished, the crude was filtered on silica-celite and washed with DCM.

Step 7: The solution was evaporated in vacuum.

Step 8: The brown solid was purified by washing with a little cold acetone and a white solid was obtained (8.45 g, 94%). This product was called “2, 7-diBpinpyrene of Example GGia” (Compound GG1a).

As an alternative, flash column chromatography with silica gel can be applied, using as eluents Hex/DCM to 6:4.

With cyclohexane, the reaction is slower but cleaner than THF. This alternative helps avoiding formation of the TriBpin-pyrene.

### Example GG1b. Synthesis of 2,7-dihydroxipyrene (GG1b)

Step 1: pure 2,7-diBpinpyrene (2 g, 4.4 mmol, 1 equiv) and NaOH (1 g, 26.4 mmol, 6 equiv) were dissolved in a mixture solvents THF/H₂O (10:1) (200 mL, 45.5 mL/mmol).

Step 2: H₂O₂ (2.7 mL, 30 w/w, 26.4 mmol, 6 equiv) was added dropwise to this solution.

Step 3: This mixture was stirred at room temperature for 4 h.

Step 4: When the reaction had finished, HCl (1 M, to pH acid) was added into the reaction.

Step 5: the mixture was stirred at room temperature for one hour.

Step 6: THF was removed under reduced pressure.

Step 7: A light brown solid was formed which was isolated by filtration Step 8: A brown solid was obtained with 86% Yield. The brown solid was called “2,7-dihydroxipyrene of Example GG1b” (Compound GG1b).

Alternative of purification:

In Step 6: the crude may be extracted with Et₂O (×3).

In Step 7: The organic phase may be dried with MgSO₄ anh

In Step 8: the solvent may be evaporated in vacuum to obtain dark solid.

In Step 9: This solid may be re-dissolved in minimum volume of Et₂O and the resulting product may be precipitated by addition of hexane (200 mL/mmol Bpin).

### Example GG1c. Synthesis of Monoalkylated Pyrene (GG1c) and Dialkylated Pyrene (GG1d)

Step 1: pure 2,7-dihydroxipyrene (1.65 g, 7.04 mmol, 1 equiv) and Cs₂CO₃ (1.15 g, 3.52 mmol, 0.5 equiv) were introduced into a 25 mL seal tube/schlenk flask.

Step 2: The system was flashed with argon.

Step 3: anhydrous DMSO (13.8 mL, 1.96 mL/mmoL) was added.

Step 4: The mixture was vigorously stirred until most of the reagents were dissolved, i.e about 3 hours at 40° C. (The color changed from brown to yellow-brown).

Step 5: Then, 11-Bromoundecene (1.75 mL, 7.04 mmol, 1 equiv) was added into the reaction.

Step 6: The reaction mixture was stirred at 66° C. overnight.

Step 7: the reaction mixture was cooled to room temperature.

Step 8: the crude was filtered and the dialkylated pyrene was isolated

Step 9: The dialkylated pyrene was washed with cold acetone.

Step 10: water (50 ml/g dihydroxy) was added to the liquid phase until the liquid starts to become turbid because the monoalkylated pyrene begins to precipitate.

Step 11: The monoalkylated pyrene was isolated by filtration.

Step 12: The desired product was obtained as a light Brown solid (32-42%). The product was termed “Monoalkylated pyrene of Example GG1c” (Compound GG1c).

In Alternative for the work-up:

In Step 8: Instead add HCl (1 M, to pH acid) to neutralize and stir 1 hr, then add water.

In Step 9: Instead extract with EtOAc (3×).

In Step 10: Instead wash the organic phase with brine, and dry over anhydrous MgSO₄.

In Step 11: Remove solvent under reduced pressure.

In Step 12: Instead subject the crude product to flash column chromatography: with silica gel and as eluents Hex/EtOAc from 99:1 to 6:4.

In Step 13: Then, the desired product will be obtained as a light Brown solid (yield 26-36%).

A possible purification method for mono/di mixtures could be recrystallization with acetone.

### Example GG2. Synthesis of Diamino-Boc U-Shape

In this example, we describe the synthesis of compound (GG2f) which is a linear molecule comprising two recognition motifs towards SWNTs with two terminal alkene functionalities that can react to convert the linear molecule into a closed ring structure around a SWNT. The recognition motifs employed are cores of pyrene (compound GG1c) which were described above. This structure contains two urethane groups for hydrogen bonding or, in its unprotected form, two amine groups for covalent bonding that can interact with different polymers to prepare composites.

The synthesis consists of 7 reaction steps, as depicted in (FIG. 101). Second and Third reactions were described in Bioorg. and Medicinal Chem. Lett., 2016, 26 (17), 4318-4321. The fourth reaction can be found in Inorganica Chimica Acta 2010, 363, 1796-1804.

### Example GG2a. Synthesis of (5-amino-1, 3-phenylene)dimethanol GG2a

Step 1: 5-aminoisophathalic acid dimethyl ester (1 equiv) in dry THF (5 mL/mmol) was slowly added into a THF (2.5 mL/mmol) slurry of LiAlH₄ (3 equiv) at 0° C. with vigorous stirring.

Step 2: After stirring at 0° C. for 30 minutes, the mixture was allowed to room temperature for 6 hours.

Step 3: it was cooled at 0° C., ethyl ether was then added into the grey mixture under vigorous stirring to quench excess LiAlH₄.

Step 4: H₂O (1 mL/g LiAlH₄) was slowly added to hydrolyze the alumina salt. A color change from grey to green and then yellow were observed.

Step 5: 15% NaOH (1 mL/g LiAlH₄) was added

Step 6: H₂O (3 mL/g LiAlH₄) was added

Step 7: the mixture was warmed to room temperature and stirred for 1 hr.

Step 8: The liquid phase was dried over anhydrous MgSO₄ Step 9: the mixture was stirred for 15 min and filtered to remove salts.

Step 10: Solvent was removed under reduced pressure Step 11: the desired product “(5-amino-1, 3-phenylene)dimethanol of Example GG2a” (compound GG2a) was obtained as yellow solid with 96% Yield.

### Example GG2b. Synthesis of imidazole-Boc

Step 1: (Boc)₂O (1 equiv) was added over the imidazole (1.1 equiv) solution in dry DCM (0.36 mL/mmol).

Step 2: The reaction mixture was stirred at room temperature for 2 hours.

Step 3: Then, the crude was washed with water.

Step 4: The organic phase was dried over anhydrous Na₂SO₄

Step 5: The solvent was removed under reduced pressure

Step 6: imidazole-Boc was obtained as white solid, with 99% yield.

### Synthesis of Di-Boc-Diethylenetriamine GG2b:

Step 7: Diethylenetriamine (1 equiv) was added over the imidazole-Boc (2 equiv) solution in dry toluene (0.98 mL/mmol).

Step 8: The crude was stirred at (60-65) ° C. for 3 hours.

Step 9: The solvent was removed under reduced pressure.

Step 10: water was added and the crude was extracted with DCM (3×).

Step 11: The organic phase was dried over anhydrous Na₂SO₄.

Step 12: DCM was removed in vacuum to give the desired product “Di-Boc-Diethylenetriamine of Example GG2b” (Compound GG2b) as brown sirup. Yield: 94%

### Example GG2c. Synthesis of Intermediate GG2c

Step 1: A solution of compound GG1b (1 equiv) and K₂CO₃ (0.63 equiv) in 3 ml/mmol of THF—H₂O (25:1) was treated with a solution of Benzyl bromoacetate (1.45 equiv) in 1.5 ml/mmol of THF—H₂O (25: 1).

Step 2: the reaction mixture was stirred at rt for 12 h.

Step 3: The solution was concentrated to 5 ml by rotary evaporation.

Step 4: the product was purified by silica gel chromatography column.

Step 5: hexane-ethyl acetate (98:2) was used until all Benzyl bromoacetate was removed.

Step 6: The product was then eluted with 100% ethyl acetate.

Step 7: All solvent was removed by rotary evaporation left the desired product (Compound GG2c) as colorless sirup. Yield (86%).

### Example GG2d. Synthesis of Carboxylic Acid Intermediate GG2d

Step 1: Compound GG2c (1 equiv) was dissolved in dry MeOH (7.8 mL/mmol) under N₂ atmosphere.

Step 2: Pd/C (15% w/w) was added carefully.

Step 3: H₂ gas was carefully introduced into the system.

Step 4: The mixture was stirred at room temperature for 12 h under H₂.

Step 5: The crude was filtered through Silica.

Step 6: which was washed with methanol/CHCl₃.

Step 7: The solvent was removed by rotary evaporation to yield an off-white solid.

Step 8: The solid was dissolved in a small volume of methanol and was crystallized by addition of diethyl ether.

Step 9: The white solid obtained was washed with diethyl ether and air dried to give the Carboxylic acid (Compound GG2d) with 70-89% yield.

### Example GG2e. Synthesis of Diamino-Boc Spacer GG2e

Step 1: Carboxylic acid GG2d (209 mg, 0.578 mmol, 1 equiv) and (5-amino-1, 3-phenylene)dimethanol GG2a (93 mg, 0.607 mmol, 1.05 equiv) were suspended in anhydrous DCM/CH₃CN (2:1) (11.2 ml/mmol acid) under Ar atmosphere.

Step 2: EEDQ (143 mg, 0.578 mmol, 1 equiv) was added into the mixture Step 3: The reaction was stirred at room temperature overnight.

Step 4: The solvent was evaporated in vacuum.

Step 5: The crude product was purification by column chromatography (DCM/MeOH as eluent, from 98/2 to 96/4).

Step 6: The desired product “Diamino-Boc spacer” (Compound GG2e) was obtained with (220 mg) 76% yield as white sirup.

### Example GG2f. Synthesis of Diamino-Boc U-Shape GG2f

Step 1: DIAD (1.02 g, 5.04 mmol, 2.12 equiv) was slowly added to a stirred solution of Compound GG2e (1.17 g, 2.35 mmol, 1 equiv), monoalkylated pyrene GG1c (1.96 g, 5.04 mmol, 2.15 equiv) and Ph₃P (1.27 g, 4.84 mmol, 2.06 equiv) in dry THF (12 mL, 5 mL/mmol) at 0° C.

Step 2: the mixture was left stirring at 0° C. for 30 min.

Step 3: Then, the reaction was warmed at room temperature and left stirring overnight.

Step 4: THF was removed under reduced pressure.

Step 5: Et₂O (25 mL/mmol) and NaOH 10% (50 mL/mmol) were added.

Step 6: The mixture was stirred at room temperature for 1 hr.

Step 7: the aqueous phase was extracted three times with Et₂O (25 mL/mmol).

Step 8: the organic phase was washed with water and then with brine.

Step 9: The organic phase was dried with Na₂SO₄ anh.

Step 10: the solvent was evaporated in vacuum.

Step 11: The brown crude was recrystallized with diethyl ether/Hexane.

Step 12: A cream solid obtained was washed with a little amount of cool diethyl ether and air dried to give the desired product with 40-53% yield. This cream solid was called “Diamino-Boc U-Shape of Example GG2f” (Compound GG2f).

Reaction with ZnCl₂:

This reaction step is used as an alternative to help remove triphenylphosphine oxide when Step 11 does not work well. This method was described in J. Org. chemistry 2017, 82, 9931-9936.

Step 13: Compound GG2f crude was suspended in absolute EtOH (2.78 mL/mmol O═PPh₃) at refluxing.

Step 14: Ar was burbled for 30 min.

Step 15: The solution of ZnCl₂ in Warm abs EtOH (1.38 mL/mmol O═PPh₃) was added.

Step 16: Then, the reaction was warmed at rt and left stirring overnight.

Step 17: A cream precipitate was separated by filtration

Step 18: A cream solid obtained was washed with cool EtOH and water and air dried to give the desired Diamino-Boc U-Shape (Compound GG2f) with 36% yield.

### Example GG3. Several Alternatives for Diamino-Boc U-Shape Synthesis

These examples describes different routes to synthesize the Diamino-Boc spacer of Example GG2e (Compound GG2e) employing two different approaches and the synthesis of a new Diamino-Boc U-Shape GG3c similar to “Diamino-Boc U-Shape of Example GG2e” using succinic anhydride.

### Example GG3a: Another Synthetic Route to Synthesis of Diamino-Boc Spacer GG2e

In this example is described an alternative synthesis in which the Diamino-Boc spacer GG3a is first formed and then the ester groups are reduced to give the desired Diamino-Boc spacer (Compound GG2e).

### Synthesis of Diamino-Boc Spacer GG3a:

Step 1: Compound GG2d (227 mg, 0.63 mmol, 1 equiv.), HOBt (188 mg, 1.4 mmol, 2.2 equiv.) and EDC (266 mg, 1.4 mmol, 2.2 equiv.) was dissolved in dichloromethane (10 mL, 15.9 mL/mmol) and cooled to 0° C.

Step 2: dimethyl 5-aminoisophthalate (144 mg, 0.69 mmol, 1.1 equiv.) and 4-dimethylaminopyridine (462 mg, 3.8 mmol, 6 equiv.) were added.

Step 3: The reaction mixture was warmed to room temperature by stirring overnight.

Step 4: The reaction was extracted with HCl 0.5 M

Step 5: The crude obtained was purified by column chromatography in CH₂Cl₂/MeOH (95:5) to afford 263 mg of the diamino-Boc spacer (compound GG3a) as a white solid with 78% Yield.

Synthesis of Diamino-Boc spacer GG2e from Diamine-Boc spacer GG3a:

Step 6: To a solution of compound GG3a (133 mg, 0.24 mmol, 1 equiv.) in THF (10 mL, 41.7 mL/mmol) at −78° C. was added dropwise LiBH₄ (2M in THF, 0.5 mL, 1.0 mmol, 4.2 equiv.).

Step 7: The reaction mixture was stirred at −78° C. for 10 min

Step 8: The reaction mixture was stirred at room temperature overnight.

Step 9: After this time, excess reactants were consumed by the addition of saturated NH₄Cl.

Step 10: The organic phase was extracted with CH₂Cl₂.

Step 11: The combined organic phases were washed with brine, dried and concentrated under vacuum.

Step 12: The crude obtained was purified by column chromatography using a CH₂Cl₂/MeOH (9:1) mixture as eluent to afford 45 mg of the desired Diamine-Boc (compound GG2e) as a white solid with 28% of yield.

### Example GG3b: Different Amidation Conditions to Obtain Diamino-Boc Spacer GG2e

### Synthesis Alternative I of Diamino-Boc Spacer GG2e:

The synthesis step from 1 to 5 of Example GG3a were repeated; except that the starting material in the step 2 dimethyl 5-aminoisophthalate was replaced by (5-amino-1, 3-phenylene)dimethanol (Compound GG2a). The resulting compound GG2e was obtained with 28% yield.

### Synthesis Alternative II of Diamino-Boc Spacer GG2e:

To produce compound GG2e, the protocol of Example GG2 was repeated, except that in Step 1 of Example GG2e the solvent mixture was changed from DCM/ACN to DCM/MeOH. The diamino-Boc spacer (compound GG2e) was isolated in 59% yield.

### Example GG3c: Synthesis of a Similar Diamino-Boc U-Shape Using Succinic Anhydride

In this section we present a new synthesis to prepare a Diamino-Boc U-shape similar to “Diamino-Boc U-Shape GG2f of Example GG2”. In this case, succinic anhydride is used to introduce the acid functionalization in one step from the Di-Boc-Diethylenetriamine (Compound GG2b), eliminating the hydrogenolysis reaction of Example GG2d.

### Synthesis of Carboxylic Acid GG3b:

Step 1: To a solution of Di-Boc-Diethylenetriamine GG2d (217 mg, 0.715 mmol, 1 equiv.) in dry THF (3.6 mL, 5 mL/mmol) was added Et₃N (116 L, 0.834 mmol, 1.16 equiv).

Step 2: The mixture was left stirring at room temperature for 30 min.

Step 3: Succinic anhydride (71.6 mg, 0.715 mmol, 1 equiv) was added.

Step 4: The reaction mixture was refluxed for overnight.

Step 5: THF was removed by rotavapor.

Step 6: A saturated NH₄Cl solution (5.3 mL/mmol) was added to the crude.

Step 7: The aqueous phase was extracted three times with EtOAc (6.3 mL/mmol).

Step 8: The organic phase was dried under MgSO₄ anhydride.

Step 9: The carboxylic acid (Compound GG3b) was obtained as brown sirup in 75% yield.

### Synthesis of Diamino-Boc Spacer GG3c:

Step 1: Carboxylic acid GG3b (1 equiv) and (5-amino-1, 3-phenylene)dimethanol GG2a (1.05 equiv) were suspended in anhydrous DCM/CH₃CN (2:1) (11.2 ml/mmol acid) under Ar atmosphere.

Step 2: EEDQ (1 equiv) was added into the mixture Step 3: the reaction was stirred at room temperature overnight.

Step 4: After, the solvent was evaporated in vacuum.

Step 5: The crude product was purification by column chromatography (Hex/EtOAc as eluent, from 4/6 to 2/8).

Step 6: The desired product called “Diamino-Boc spacer of Example GG3c” (Compound GG3c) was obtained with 55% yield as light brown sirup.

### Example GG4. Synthesis of Pyridine U-Shape GG4a

In this case, we describe the synthesis of compound (GG4a) which is a linear molecule comprising two recognition motifs towards SWNTs with two terminal alkene functionalities that can react to convert the linear molecule into a closed ring structure around a SWNT. The recognition motifs employed are cores of pyrene (GG1c) which were described above. This structure contains a nitrogen atom in the aromatic ring of the spacer, generating possible modifications in the interaction between the aromatic ring and SWNTs since it is known that pyridine scaffolds can help in the dispersion of SWNTs. Moreover, the nitrogen atom can generate additional interaction through hydrogen bonds with different polymers in the preparation of the composites.

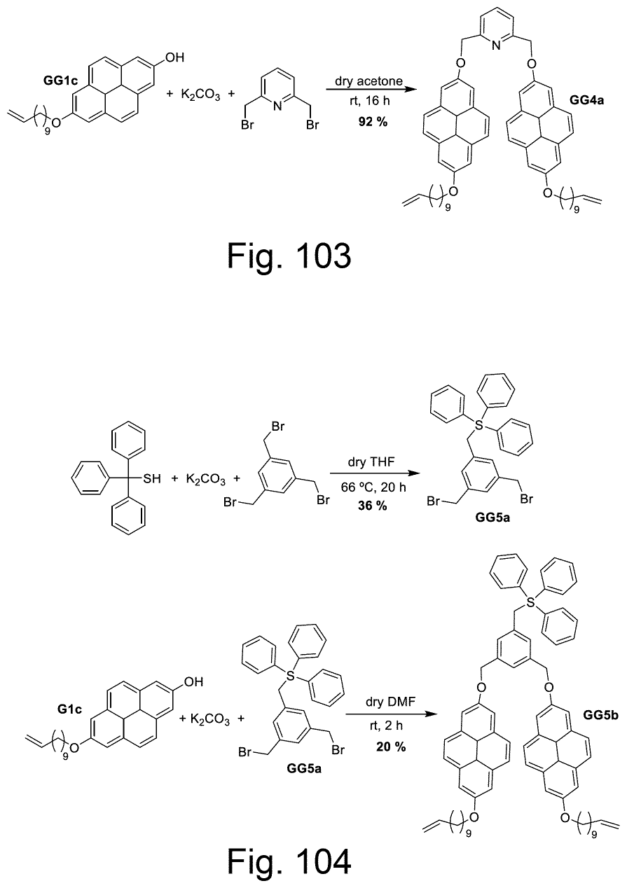

The synthesis is a single reaction, as shown in FIG. 103.

### Synthesis of Pyridine U-Shape GG4a:

Step 1: monoalquilated (GG1c) (3.2 g, 8.30 mmol, 2.2 equiv) and K₂CO₃ (5.2 g, 37.7 mmol, 10 equiv) were dissolved in dry acetone (47 mL, 12.5 mL/mmol)

Step 2: The reaction mixture was stirred at 38° C. for 40 min under argon.

Step 3: 2,6-Bromomethylpyridine (1 g, 3.77 mmol, 1 equiv) was added.

Step 4: The reaction was left stirring at 56° C. overnight.

Step 5: A cream solid was appeared.

Step 6: The cream solid was isolated by filtration.

Step 7: The cream solid was washed with cool acetone and water.

Step 8: The cream solid was dried under vacuum, obtaining 3.03 g of desired Product was called “pyridine U-Shape of Example GG4” (Compound GG4a) with a 92% of yield.

### Example GG5. Synthesis of Thiol U-Shape GG5c

In this case, we describe the synthesis of compound (GG5c) which is a linear molecule comprising two recognition motifs towards SWNTs with two terminal alkene functionalities that can react to convert the linear molecule into a closed ring structure around a SWNT. The recognition motifs employed are cores of pyrene (GG1c) which were described above. The thiol group contained in this structure is a soft nucleophile like the amine group, and can interact with different electrophilic appendages within the polymers to form covalent bonds with them.

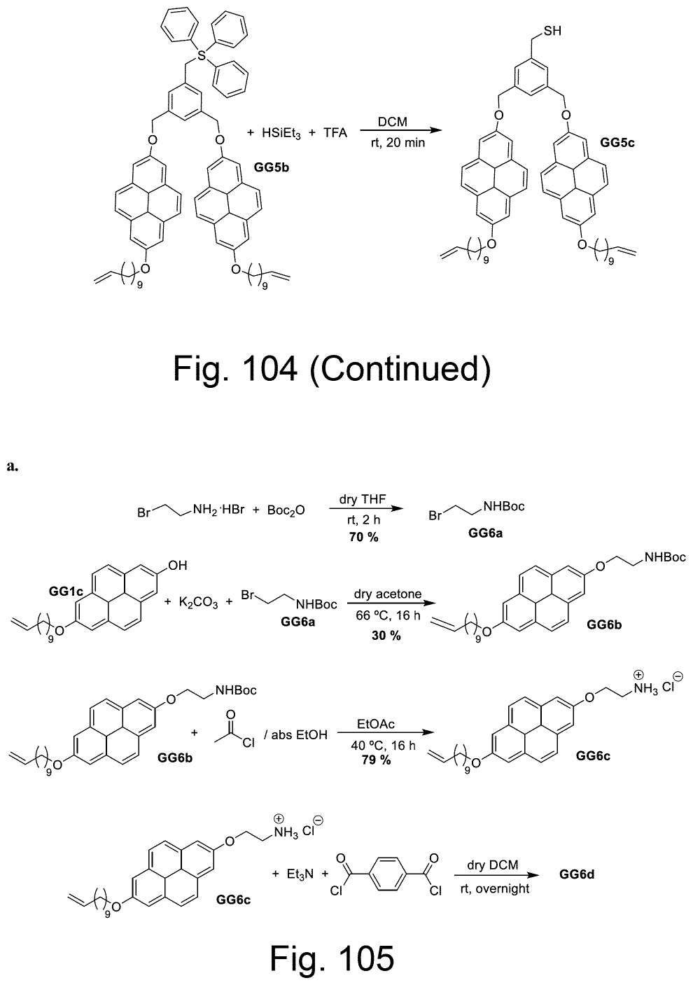

This example consists of 4 reaction steps as shown in FIG. 104. The first reaction was published in Eur. J. Org. Chem. 2011, 4823-4833.

### Synthesis of (3,5-bis(bromomethyl)benzyl)triphenyl-γ4-sulfane GG5a

Step 1: 1,3,5-tris(bromomethyl)benzene (1 g, 2.8 mmol, 1 equiv) and Triphenylmethanethiol (775 mg, 2.8 mmol, 1 equiv) were dissolved in dry THF (8 mL, 2.86 mL/mmol) under an atmosphere of argon.

Step 2: K₂CO₃ (581 mg, 4.2 mmol, 1.5 equiv) was added.

Step 3: The reaction mixture was heated at reflux for 20 hours.

Step 4: Water was added.

Step 5: The mixture was extracted with ether.

Step 6: The combine layer were washed with brine.

Step 7: The organic phase was dried over MgSO₄.

Step 8: The solvent was evaporated to dryness.

Step 9: the crude was subjected to flash column chromatography: with silica gel and as eluents Hex/DCM 95/5.

Step 10: The desired product (Compound GG5a) was obtained as a white solid (550 mg, 36% yield)

### Synthesis of Triphenyl-Thioether U-Shape GG5b:

Step 1: monoalquilated (GG1c) (91 mg, 0.235 mmol, 2.2 equiv), KI (1.8 mg, 0.0107 mmol, 0.1 equiv) and K₂CO₃ (119 mg, 0.856 mmol, 8 equiv) were dissolved in dry aDMF (1 mL, 7.7 mL/mmol) under argon.

Step 2: The reaction mixture was stirred at 38° C. for 40 min.

Step 3: (3,5-bis(bromomethyl)benzyl)triphenyl-γ4-sulfane GG5a (59 mg, 0.107 mmol, 1 equiv) was added.

Step 4: The reaction was left stirring at 80° C. for 2 h.

Step 5: Water was added until turbidity.

Step 6: The brown solid was isolated by filtration.

Step 7: Product was purified by column chromatography with silica gel and as eluent Hex/EtOAc from 95/5 to 8/2.

Step 8: 25 mg of the desired Thiol-protected U-Shape GG5b was obtained as a cream solid in 20% yield.

### Synthesis of Thiol U-Shape GG5c:

This reaction has not yet been carried out, but was describe in Eur. J. Org. Chem. 2011, 4823-4833 with a good yield (72-77%) and previously in Chem. Commun., 2008, 3438-3440. Our protocol is presented below.

Step 1: Compound GG5b (1.0 equiv.) and triethylsilane (1.5 equiv.) were dissolved in dry CH₂Cl₂ (71.4 mL/mmol).

Step 2: Trifluoroacetic acid (2.86 mL/mmol) was added dropwise at 0° C.

Step 3: The reaction mixture was stirred for 20 min at room temperature.

Step 4: The reaction was quenched by the addition of a saturated aqueous solution of sodium hydrogen carbonate.

Step 5: After completion of the gas formation, the phases were separate.

Step 6: the aqueous phase was extracted with CH₂Cl₂.

Step 7: The combined organic fractions were dried over magnesium sulfate, filtered and concentrated to dryness.

Step 8: The crude was purified by column chromatography (silica gel; hexane/CH₂Cl₂, 2:1).

Step 9: The desired product was obtained with 72-77% yield. This product was called “Thiol U-Shape of Example GG5” (Compound GG5c)

### Example GG6. Synthesis of Amide U-Shape GG6d

We describe the synthesis of compound (GG6d) which is a linear molecule comprising two recognition motifs towards SWNTs with two terminal alkene functionalities that can react to convert the linear molecule into a closed ring structure around a SWNT. The recognition motifs employed are cores of pyrene (GG1c) which were described above. The main change in the structure is the presence of two amide groups and a greater separation between the recognition motifs and the spacer. These amide groups are proton acceptors and donors, which can generate hydrogen bonds with the polymers.

To obtain the Amide U-Shape GG6d was employed two synthetic routes. The first is explained below and the second will be described later.

### Example GG6a

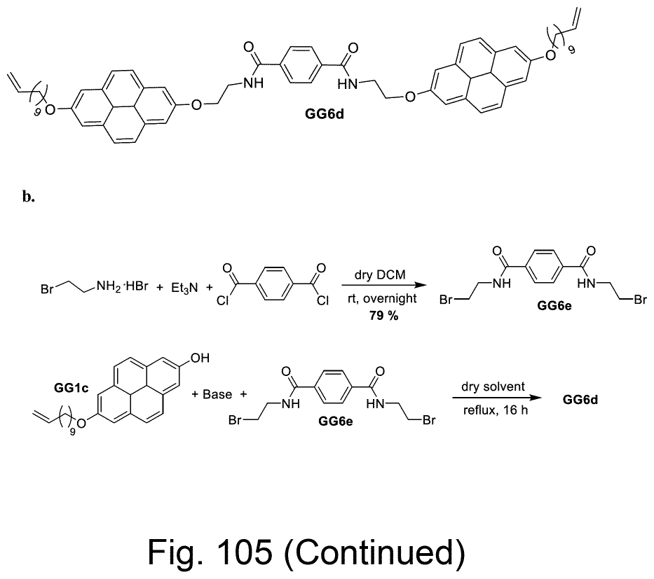

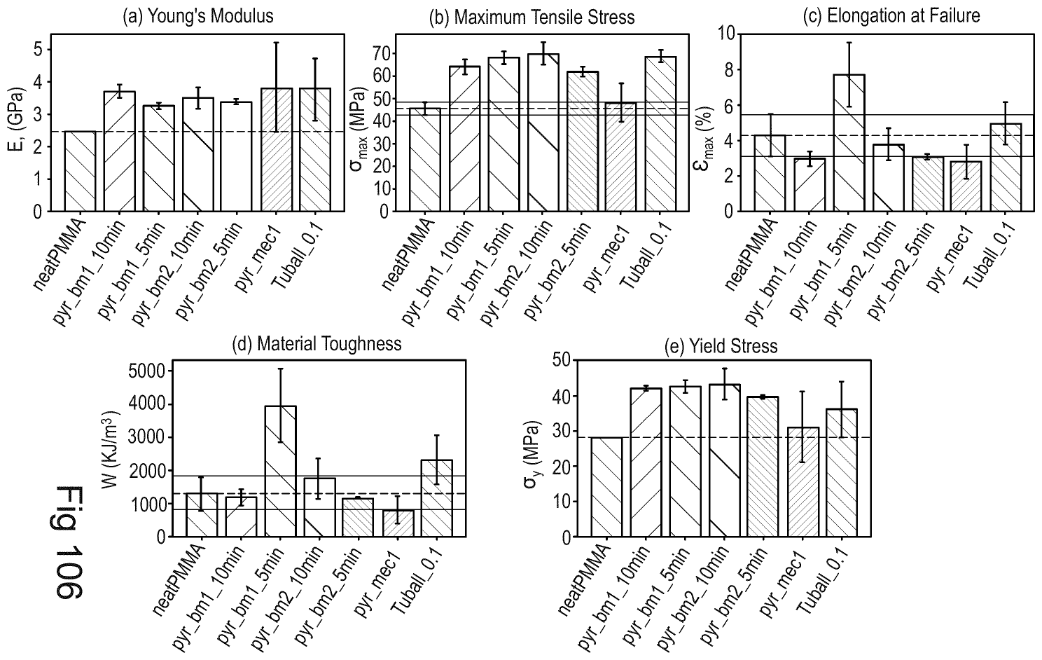

The first route in this example consists of 4 reaction steps, which can be seen in FIG. 105, section a.

### Synthesis of Tert-butyl (2-bromoethyl) carbamate GG6a

STEP 1: 2-BROMOETHYLAMINE HYDROBROMIDE (500 MG, 2.44 MMOL, 1.0 EQUIV.) AND SATURATED NAHCO₃ SOLUTION (0.3 ML, 0.18 ML/MMOL) WERE SUSPENDED IN DRY THF (0.9 ML, 0.36 ML/MMOL).

STEP 2: BOC ANHYDRIDE (0.56 ML, 2.44 MMOL, 1 EQUIV) WAS ADDED DROPWISE AT 0° C.

Step 3: The reaction mixture was stirred at room temperature for 2 h.

Step 4: The reaction was quenched by the addition of water.

Step 5: the aqueous phase was extracted with CH₂Cl₂ three times.

Step 6: The combined organic fractions were dried over magnesium sulfate, filtered and concentrated to dryness.

Step 7: 380 mg of tert-butyl (2-bromoethyl) carbamate GG6a was obtained as brown sirup (70% Yield).

### Synthesis of Core Intermediate GG6b:

Step 1: monoalquilated (GG1c) (81 mg, 0.208 mmol, 1 equiv) and K₂CO₃ (115 mg, 0.833 mmol, 4 equiv) were dissolved in dry acetone (2.6 mL, 12.5 mL/mmol).

Step 2: The reaction mixture was stirred at 38° C. for 3 hours under argon.

Step 3: Tert-butyl (2-bromoethyl)carbamate GG6a (140 mg, 0.625, 3 equiv) was added dissolve in dry acetone.

Step 4: The reaction was left stirring at 56° C. overnight.

Step 5: A yellow solid was isolated by filtration and washed with cool acetone.

Step 6: The yellow solid was dried under vacuum, obtaining 35 mg of desired intermediate GG6b with a 30% of yield.

### Synthesis of Unprotected-Amine Intermediate GG6c:

Step 1: To a solution of amine-Boc GG6b (63 mg, 0.1086 mmol, 1 equiv) in EtOAc (12.7 mL, 50 mL/mmol), acethyl chloride (77 L, 1.086 mmol, 10 equiv) in abs EtOH (0.1 M) was added dropwise at 0° C.

Step 2: The reaction mixture was stirred at 40° C. overnight.

Step 3: A white solid was appeared and isolated by filtration.

Step 4: The white solid was washed with CHCl₃ and dried under vacuum.

Step 6: obtaining 40 mg of the desired intermediate GG6c, unprotected amine, in 79% yield.

### Synthesis of Amide U-Shape GG6d:

This reaction has not yet been carried out; it will be performed under conditions similar to the synthesis of the Amide spacer (Compound GG6e) described in detail below.

Step 1: The amine GG6c (2.2 equiv) and Et₃N (2.2 equiv) in dry DCM (1.82 mL/mmol) were stirred at 0° C. into a round bottom flask.

Step 2: Terephthaloyl Chloride (1 equiv) dissolve in dry DCM (0.78 mL/mmol) was added dropwise at 0° C.

Step 3: the reaction mixture was allowed to warm to room temperature.

Step 4: the reaction was stirred overnight at room temperature.

Step 5: the solvent was removed under reduced pressure.

Step 6: the solid was washed with water and a little EtOH.

Step 7: The pure solid was termed “Amide U-Shape of Example GG6a” (Compound GG6d).

Such as commented previously, to obtain the desired Amide U-shape GG6d, we have employed two synthetic routes. The first one had been explained above and the other one will be described below.

### Example GG6b

The second approach is two reaction steps (in FIG. 105 as well, section b).

### Synthesis of Amide-Spacer GG6e:

Step 1: 2-Bromoethylamine hydrobromide (2.5 g, 12.3 mmol, 2.5 equiv.) and Et₃N (2.47 mL, 12.3 mmol, 2.5 equiv) in dry DCM (9.9 mL, 1.82 mL/mmol) were stirred at 0° C. into a round bottom flask.

Step 2: Terephthaloyl Chloride (1 g, 4.93 mmol, 1 equiv) dissolve in dry DCM (2.9 mL, 0.78 mL/mmol) was added dropwise at 0° C.

Step 3: the reaction mixture was allowed to warm to room temperature.

Step 4: the reaction was stirred overnight at room temperature.

Step 5: the solvent was removed under reduced pressure.

Step 6: the white solid was washed with water and a little EtOH.

Step 7: 1.28 g of Amide-spacer GG6e was obtained with 79% of yield.

### Synthesis of Amide U-Shape GG6d Via a SNu (Another Route):

This step of the reaction has not worked; several dry solvents such as acetone, THF, DMF, DMSO with different bases (K₂CO₃, Cs₂CO₃, NaOH, ^{t}BuOLi, ^{t}BuONa . . . among others) have been used. Either condition has generated the “Amide U-Shape of Example GG6a” (Compound GG6d).

### Examples GG7. Preparation of Mints

In this example, several procedures are described for the preparation of MINTs, which are molecular interlocked around SWCNTs via ring-closing metathesis using the second-generation Grubbs catalyst. For this purpose, different linear molecules U-shape were used to due to present of two recognition motifs towards SWNTs with two terminal alkene functionalities in their structure that can react to convert the linear molecule into a ring-closed structure around a SWNT. The recognition motifs used in this example are cores of pyrene (GG1c, GG1d).

### Example GG7a: Wet Method

The mentioned protocol below was used for “Diamino-Boc U-Shape of Example GG2f” and “Pyridine U-Shape of Example GG4”

Step 1: In a round bottom flask containing 1000 mL of TCE (1 mL per mg CNTs), SWNTs (Tuballs de OCSIAI)(1 g) were added.

Step 2: The SWNTs were dispersed by bath sonication at 20° C. for 15 min

Step 3: The U-shape (1 g, 1 mg/l mg CNTsl) was added

Step 4: The suspension was bubbled with argon/N₂ for 20 minutes

Step 5: 2^{nd} gen. Grubbs catalyst (1 equiv/U-Shape) was added and the suspension was stirred for 72 h at room temperature.

Step 6: After this time, the reaction mixture was filtered through a PTFE membrane of 0.2 μm pore size.

Step 7: The filter cake was collected and was re-dispersed in 250 mL dichloromethane in a round-bottom flask by bath sonication for 10 min.

Step 8: The sample was filtered again through a PTFE membrane of 0.2 μm pore size.

Step 9: Steps 5 and 6 were repeated two times

Step 10: Approximately 50 mL Et₂O was added to the filter cake.

Step 11: The MINTs were collected in a vial and dried in oven at 135° C. overnight.

Step 12: The Mints from Diamine-Boc U-shape GG2f were called “Diamine-Boc Mints of Example GG7a” (Compound GG7a1) and from Pyridine U-shape GG2f were termed “Pyridine Mints of Example GG7a” (Compound GG7b1).

When “Dialkylated-pyrene of Example GG1c” (Compound GG1d) was employed like U-Shape to make Mints, this protocol was followed with little modifications. In the Step 3: Dialkylated-pyrene GG1d was added in 6, 12, 18, 24 and 200 mol/mg SWNTs and in Step 5: the amount of Grubbs catalyst was 0.5 equiv/dialkylated-pyrene. Thus, five several mints were prepared with different amounts of “Dialkylated-pyrene of Example GG1c” (Compound GG1d), as depicted in the following table

| | | | |
|---|---|---|---|
| Dialkylated GG1c | Grubbs^{b} | Tga | Mints |

| μmol/mg NTs | mmol | mmol | % Func. | Called |
|---|---|---|---|---|
| 6 | 0.6 | 0.3 | 21 | GG7c1 |
| 12 | 1.2 | 0.6 | 30 | GG7c2 |
| 18 | 1.8 | 1.2 | 40 | GG7c3 |
| 24 | 2.4 | 1.8 | / | GG7c4 |
| 200 | 20 | 10 | / | GG7c5 |

^{a}All Dialkylated-Mints GG7c were prepared with 100 mL of TCE and 100 mg of SWNTs;
^{b}0.5 equiv of Grubbs with respect to Dialylated GG1c.

### Example GG7b: Mechanochemical Method

These methods use the mechanical energy generated in a ball mill or by hand in a mortar to disperse the CNTs, binds the U-shape molecule to the CNTs and makes the ring-closing metathesis.

Step 1: In a 20 mL-size stainless steel ball mill reactor, SWNTs (150 mg), U-shape (150 mg, 1 mg/l mg NTs) and 2^{nd} gen. Grubbs catalyst (0.5 mol %) were added.

Step 2: The reactor was charged with five stainless steel balls.

Step 3: The powders were milled for 10 min at 500 rpm in an air atmosphere.

Step 4: After this time, the reactor content was recovered. Dichloromethane was added and the reaction mixture was filtered through a PTFE membrane of 0.2 μm pore size.

Step 5: The filter cake was collected and was re-dispersed in dichloromethane in a round-bottom flask by bath sonication for 10 min.

Step 6: The sample was filtered again through a PTFE membrane of 0.2 μm pore size.

Step 7: Steps 5 and 6 were repeated

Step 8: Et₂O was added to the filter cake.

Step 9: The MINTs were collected in a vial and dried in oven at 135° C. for 3 hours.

The above protocol was used for GG2f and GG4a products. In the case of GG4a, step 3 was also carried out in 5 min. On the other hand, step 1 was modified by using GG4a (0.48 mol/mg Tuball) and Grubbs catalyst (0.05 mol %) for 5 and 10 min in step 3.

Steps 2 and 3 can be done by hand in an agate mortar for 30 minutes and the other steps are the same. In summary, two batches of GG2f, as shown in Tables GG7c (FIG. 106b) and five batches of GG4a, as depicted in Tables GG7d (FIG. 106b), were prepared.

The above protocol was used for GG2f and GG4a products. In the case of GG4a, step 3 was also carried out in 5 min. On the other hand, step 1 was modified by using GG4a (0.48 mol/mg Tuball) and Grubbs catalyst (0.05 mol %) for 5 and 10 min in step 3.

Steps 2 and 3 can be performed by hand in an agate mortar for 30 min and the other steps are the same. In summary, five different batches of GG4a were prepared as shown in the following tables.

| | Pyridine | | Time | Tga | Mints |
|---|---|---|---|---|---|
| Method | U-Shape | Grubbs^{d} | (min) | (% Funt.) | Called |
| By hand | 1^{b} | 0.5 | 30 | 23 | GG7b2 |
| Ball Miller | 0.48^{c} | 0.05 | 5 | 23 | GG7b3 |
| Ball Miller | 0.48^{c} | 0.05 | 10 | 28.5 | GG7b4 |
| Ball Miller | 1^{b} | 0.5 | 5 | 36 | GG7b5 |
| Ball Miller | 1^{b} | 0.5 | 10 | 45 | GG7b6 |

^{a}In all the case 1 equiv of tuball;
^{b}1 w/w mg/mg NT;
^{c}0.48 μmol/mg NT;
^{d}equiv of Grubbs with respect to Pyridine U-Shape GG4a.

And two batches of GG2f, as shown in the tables below

| | Diamino- | | | | |
|---|---|---|---|---|---|
| | Boc U- | | Time | Tga | Mints |
| Method | Shape^{b} | Grubbs^{c} | (min) | (% Funt.) | Called |
| By hand | 1 | 1 | 30 | 23 | GG7a2 |
| Ball Miller | 1 | 1 | 10 | 23 | GG7a3 |

^{a}In all the case 1 equiv of tuball;
^{b}1 w/w mg/mg NT;
^{c}1 equiv of Grubbs with respect to Diamino-Boc U-Shape GG2f.

### Examples GG8. PMMA Composite Via Solvent Mixing

In this section, PMMA composites were prepared for 0.1% filler for the five batches of “Pyridine Mints of Example GG7b” and 1% for the four batches of “Dialkylated-Mints of Example GG7a” and commercial PMMA via solvent mixing. (similar to Example BB3)

Step 1: The Mints were dispersed in toluene by stirring at room temperature for 24 hours.

Step 2: PMMA was added and the reaction mixture was heated at 60° C. for another 24 hours.

Step 3: The crude was poured into a Teflon petri dish.

Step 4: It was allowed to dry in the oven at 80° C. overnight.

| | Total | | | | | |
|---|---|---|---|---|---|---|
| | weight | Polimer | | | Mints | |
| Batch | (g) | (g) | Filler % | Funt. | (mg) | Composite |
| GG7c1 | 10.13 | 9.992 | 1 | 0.21 | 128 | GG8a1 |
| GG7c2 | 10.15 | 10.005 | 1 | 0.3 | 145 | GG8a2 |
| GG7c3 | 8 | 7.866 | 1 | 0.4 | 133 | GG8a3 |
| GG7c4 | 11 | 10.725 | 1 | 0.6 | 275 | GG8a4 |

In the table immediately above the data about the 1% “Dialkilated-Mint of Example GG7c”-PMMA composite of Example GG8 is shown.

The next table shows that the amount of components and 0.1% “Pyridine-Mints of Example GG7b”-PMMA-Composite were named

| | Total | | | | | |
|---|---|---|---|---|---|---|
| | weight | Polimer | | | Mints | Composite |
| Batch | (g) | (g) | Filler % | Funt. | (mg) | Called |
| GG7b2 | 6 | 5.992 | 0.1 | 0.23 | 7.79 | GG8b1 |
| GG7b3 | 6 | 5.992 | 0.1 | 0.23 | 7.79 | GG8b2 |
| GG7b4 | 6 | 5.994 | 0.1 | 0.285 | 7.716 | GG8b3 |
| GG7b5 | 6 | 5.99 | 0.1 | 0.36 | 9.37 | GG8b4 |
| GG7b6 | 6 | 5.989 | 0.1 | 0.45 | 10.9 | GG8b5 |

### Examples GG9. Preparation of Composites in the Shape of Dogbones

The PMMA composites of Example GG8 were molded in shape of dogbones with the same protocol of Example BB2.

Mechanical characterization of “Composite GG8b of Example GG8” was conducted by tensile test measurements. Summary of Young's modulus data and their respective calculated load transfer values is shown in the table below.

| | | | Young's | |
|---|---|---|---|---|
| | Filler | | modulus | Load transfer |
| Composite | % | Func | (MPa) | % |
| neat PMMA | — | — | 2464.41 | — |
| Tuball-PMMA | 0.1 | — | 3782.97 | 1228.9 |
| GG8b1 | 0.1 | 23 | 3836.04 | 1278.4 |
| GG8b2 | 0.1 | 23 | 3269.24 | 750.61 |
| GG8b3 | 0.1 | 28.5 | 3717 | 1167.5 |
| GG8b4 | 0.1 | 36 | 3399.08 | 871.5 |
| GG8b5 | 0.1 | 45 | 3512.89 | 977.5 |

All PMMA-composite at 0.1% filler loading exhibit higher Young's modulus than the neat PMMA polymer and only the GG8b1 composite is higher than pristine SWNNT. All graphs of these measurements are depicted in FIG. 106.

### Example HH1. Alternative Method for the Synthesis of ROMP Polymer-Coated Carbon Nanotubes

In this example, the preparation of polymer-coated nanotubes is described. The procedure consists of a first nanotube individualization step, where a nanotube/polyUshape complex is generated and a second step, where the U shapes of the polyUshape polymer are closed around the nanotubes in a ring-closing metathesis reaction. Due to the size of the SWNTs (diameters ranging from 1.2 to 1.7 nm) and the polyUshape molecules, two U shapes react to form one macrocycle that encloses the SWNT. In the nanotube/polyUshape complex, two polyUshape molecules are required in order to wrap an entire SWNT section.

Step 1: To a vial, ROMP-U-shape (compound A6, 18 mg, 7.5-104 mmol) and SWNTs (Tuball SWNTs 01RW03, 1.2 mg) were added.

Step 2: Toluene (15 mL) was added to the vial.

Step 3: The mixture was sonicated in a bath sonicator for 3 h.

Step 4: The vial content was distributed in Eppendorfs and centrifuged at 18600 g for 15 min.

Step 5: The supernatant was recovered. The supernatant obtained was called “supramolecular ROMP polymer-coated SWNTs of Example HH1”

Step 6: The supernatant obtained was bubbled with N₂ for 20 min.

Step 7: Grubbs 2^{nd} generation catalyst (2.1 mg, 0.5 equiv/U-shape unit) was added.

Step 8: The mixture was left without stirring overnight.

The final mixture obtained was called “ROMP polymer-coated SWNTs of Example HH1”

### Variations on the Abovementioned Protocol:

In step 2, instead of toluene, different solvents can be employed for the formation of supramolecular ROMP-U-shape-SWNT complexes such as DMF, CHCl₃ or THF.

In step 4, instead of 18600 g, higher or lower centrifugation speeds can be used if appropriate time of centrifugation is used.

In step 7, Grubbs 2^{nd} generation catalyst can be employed in smaller or higher concentrations such as e.g. between 0.01 and 1 equivalents (relative to molar concentration of U shapes of the polyUshape).

### Example HH2. Removal of Grubbs 2^{nd} Generation Catalyst and ROMP-U-Shape from Preparations of Coated Nanotubes

In this example, different procedures for the removal of uncomplexed and/or non-ring-closed ROMP-polymer and Grubbs 2^{nd} generation catalyst in SWNT-ROMP polymer composites is described.

### Example HH2, A. Cleaning by Filtration

Step 1: The final product obtained in Example HH1, “ROMP polymer-coated SWNTs of Example HH1” was poured into a round bottom flask containing 100 mL toluene.

Step 2: The mixture was homogenised by brief sonication (2 min in a bath sonicator).

Step 3: The sample was filtered through a PTFE membrane of 0.2 μm pore size.

Step 4: The composite was collected from the filter and was re-dispersed in 100 mL toluene in a round-bottom flask by bath sonication for 3 min.

Step 5: The sample was filtered again through a PTFE membrane of 0.2 μm pore size.

Step 6: Steps 4 and 5 were repeated until the residual washes obtained were completely colorless.

Step 7: Steps 4 and 5 were repeated using CH₂Cl₂ as solvent.

Step 8: Some Et₂O was added to the filter cake.

Step 9: The composite was collected in a vial and dried overnight at room temperature.

The final composite was called “Filtered ROMP polymer-coated SWNT of Example HH2, A”

### Example HH2, B. Cleaning by Toluene Precipitation and Centrifugation

Step 1: The final product obtained in Example HH1, “ROMP polymer-coated SWNTs of Example HH1” was centrifuged in a vial at 998 g for 15 min.

Step 2: The supernatant obtained was removed carefully.

Step 3: Toluene was added to the precipitate and the vial was hand-shaken for one minute.

Step 4: The mixture was centrifuged again at 998 g for 10 min.

Step 5: Steps 3 and 4 were repeated until the supernatant obtained was completely colorless.

Step 6: The supernatant was removed and the precipitate obtained was called “Wet toluene-precipitated ROMP polymer-coated SWNTs of Example HH2, B”

Step 7: The precipitate obtained was dried overnight in an oven at 120° C.

The final composite was termed “Toluene-precipitated ROMP polymer-coated SWNTs of Example HH2, B”

### Example HH2, C. Cleaning by Dialysis

Step 1: The final product obtained in Example HH1, called “ROMP polymer-coated SWNTs of Example HH1” was transferred to a dialysis tubing cellulose membrane

Step 2: The closed cellulose tube was introduced in a 1 L beaker containing 500 mL toluene.

Step 3: A magnetic stirrer was added and the mixture was slowly stirred for 3 days. Every day, the toluene contained in the beaker was replaced with clean toluene.

Step 4: The cellulose tube was opened and the content was filtered through a PTFE membrane of 0.2 μm pore size.

Step 6: The precipitate obtained was dried overnight in an oven at 120° C.

The final composite was termed “Dialyzed ROMP polymer-coated SWNTs of Example HH2, C”

### Example HH2, D. Cleaning by Dialysis not Involving Filtering

This example is a variation of Example HH2, C.

Step 1: The final product obtained in Example HH1, called “ROMP polymer-coated SWNTs of Example HH1” was transferred to a dialysis tubing cellulose membrane

Step 2: The closed cellulose tube was introduced in a 1 L beaker containing 500 mL toluene.

Step 3: A magnetic stirrer was added and the mixture was slowly stirred for 3 days. Every day, the toluene contained in the beaker was replaced with clean toluene.

Step 4: The cellulose tube was opened and the content was poured in a round-bottom flask.

Step 6: The solvent was evaporated in air or using a rotary evaporator.

The final composite was termed “Dialyzed ROMP polymer-coated SWNTs of Example HH2, D”

### Example HH2, E. Cleaning by Extraction

Step 1: To the final product obtained in Example HH1 a solution of mercaptonicotinic acid (MNA) was added (1.2 equiv. with respect to Grubbs catalyst). MNA serves as both a ruthenium scavenger and catalyst deactivator.

Step 2: The mixture obtained in Step 1 was stirred for 15 min.

Step 3: The organic phase was washed four times with NaHCO₃ and MNA.

Step 4: After the washes, the organic solvent was evaporated under reduced pressure.

The final composite was termed “Extracted ROMP polymer-coated SWNTs of Example HH2, E”

### Example HH2, F. Cleaning by Precipitation and Solvent Removal

Step 1: To the final product obtained in Example HH1 methanol was added (aprox. 2 mL) in order to precipitate the final product.

Step 2: The solvent was carefully poured and discarded.

Step 3: THF (15 mL) was added in order to dissolve the residual ROMP-U-shape and Grubbs 2^{nd} generation catalyst.

Step 4: The mixture was hand-shaked, left for five minutes to precipitate and the upper solvent containing the ROMP-U-shape and Grubbs was carefully poured and discarded.

Step 5: Steps 3 and 4 were repeated until the upper solvent obtained was completely colorless.

Step 6: The product obtained was dried in air.

The final composite was termed “Methanol-precipitated ROMP polymer-coated SWNTs of Example HH2, G”

### Example HH2, H. Cleaning by Filtration that does not Involve Sonication

Step 1: The final product obtained in Example HH1, “ROMP polymer-coated SWNTs of Example HH1” was poured into a PTFE membrane of 0.2 μm pore size.

Step 2: Toluene was added in order to remove the remaining ROMP-U-shape and Grubbs 2^{nd} generation catalyst. The addition was stopped when no color could be observed in the residual toluene.

Step 3: The filter cake was collected in a vial and dried overnight at room temperature.

The final composite was called “Filtered ROMP polymer-coated SWNT of Example HH2, H”

### Example HH3. A Dogbone Made from Shear Mixed PS/0.1% SWNT

In this example, coated SWNT is added to PS as reinforcing agent.

Step 1: To 12 g polystyrene was added 150 mL of a freshly prepared “ROMP polymer-coated SWNTs of Example HH1” comprising 12 mg SWNT.

Step 2: The sample was poured into a 250 mL beaker and was stirred with an overhead stirrer for 2 h at 9000 rpm.

Step 3: The mixture was further stirred at 2000 rpm for 2 h. During this time, part of the toluene was evaporated.

Step 4: The wet composite obtained was poured in a glass petri dish and solvent was eliminated by heating the sample in an oven at 120° C. overnight.

Step 5: The composite obtained was hot pressed at 175° C. and a 2 mm-thick plate was prepared.

Step 6: Dogbones were cut from the plate using a waterjet cutter. The obtained samples were called “0.1% SWNT/PS composite of Example HH3”.

### Variations on the Abovementioned Protocol:

In step 1, the quantity of the freshly prepared “ROMP polymer-coated SWNTs of Example HH1” added was increased in order to increase the SWNT content in the final composite. 12 g polystyrene were mixed with 1.5 L of a freshly prepared “ROMP polymer-coated SWNTs of Example HH1”, and Steps 1-6 were otherwise performed as described above, to obtain “1% SWNT/PS composite of Example HH3”.

### Example HH4. A Dogbone Made from Shear Mixed 0.1% SWNT/PMMA Composite

Step 1: 12 g PMMA were dissolved in 1 L CHCl₃.

Step 2: 150 mL of a freshly prepared “ROMP polymer-coated SWNTs of Example HH1” were added to the dissolved PMMA (the final SWNT in the composite is 0.1%).

Step 3: The sample was stirred with an overhead stirrer for 2 h at 9000 rpm.

Step 4: The mixture was further stirred at 2000 rpm for 2 h. During this time, part of the toluene/CHCl₃ mixture was evaporated.

Step 5: The wet composite obtained was poured in a glass petri dish and solvent was eliminated by heating the sample in an oven at 120° C. overnight.

Step 6: The composite obtained is hot pressed at 160° C. and a 2 mm-thick plate is prepared.

Step 7: Dogbones were cut from the plate using a waterjet cutter. The obtained dog bone samples were called “PMMA reinforced with SWNT-ROMP polymer composite having a 0.1% SWNT content from Example HH4”.

Tensile strength and Reduced Modulus was finally determined and showed improvement relative to neat polymer.

### Example HH5. A Dogbone Made from Shear Mixed 0.1% SWNT/PVC

In this example, SWNT-ROMP polymer composite is added to PVC as reinforcing agent.

Step 1: 12 g PVC were dissolved in 1 LTHF

Step 2: 150 mL of a freshly prepared “dispersed SWNT-ROMP polymer composite of Example HH1” were added to the dissolved PVC (the final SWNT in the composite is 0.1%).

Step 3: The sample was stirred with an overhead stirrer for 2 h at 9000 rpm.

Step 4: The mixture was further stirred at 2000 rpm for 2 h. During this time, part of the toluene/THF mixture was evaporated.

Step 5: The wet composite obtained was poured in a glass petri dish and solvent was eliminated by heating the sample in an oven at 120° C. overnight.

Step 6: The composite obtained was hot pressed at 150° C. and a 2 mm-thick plate is prepared.

Step 7: Dogbones were cut from the plate using a waterjet cutter. The obtained samples were called “PVC reinforced with SWNT-ROMP polymer composite having a 0.1% SWNT content from Example HH5”.

Tensile strength and Reduced Modulus was finally determined and showed improvement relative to neat polymer.

### Example HH6. Mechanochemical polyMINT Synthesis

The method makes use of the mechanical energy generated in a ball mill to disperse the CNTs, and/or bind the ROMP polymer to SWNTs, and/or mediate the ring-closing metathesis.

Step 1: In a 20 mL-size stainless steel ball mill reactor, SWNTs (250 mg), ROMP-U-shape (compound A3, 205 mg, ratio SWNT/ROMP-U-shape 1:0.82) and Grubbs 2^{nd} gen. catalyst (7.6 mg, 5 mol %) were added.

Step 2: The reactor was charged with five 10 mm diameter stainless steel balls.

Step 3: The powders were ball milled for 10 min at 500 rpm in an air atmosphere.

Step 4: After this time, the reactor content was recovered. THF was added and the reaction mixture was filtered through a PTFE membrane of 0.2 μm pore size.

Step 5: The filter cake was collected and was re-dispersed in 100 mL THF in a round-bottom flask by bath sonication for 3 min.

Step 6: The sample was filtered again through a PTFE membrane of 0.2 μm pore size.

Step 7: Steps 5 and 6 were repeated until the residual washes obtained were relatively colorless.

Step 8: Steps 5 and 6 were repeated using CH₂Cl₂ as solvent.

Step 9: Approximately 20 mL Et₂O was added to the filter cake.

Step 10: The ROMP polymer-coated SWNTs were collected in a vial and dried overnight at room temperature.

The powder obtained was called “Mechanochemical ROMP polymer-coated SWNTs of Example HH6”

### Example HH7. Large-Scale Solution Synthesis of ROMP Polymer-Coated Carbon Nanotubes

This example is a variation of Example HH1. Here, the preparation of polymer-coated nanotubes in high amounts is described. The procedure consists of a first nanotube individualization step, where a nanotube/polyUshape complex is generated and a second step, where the U shapes of the polyUshape polymer are closed around the nanotubes in a ring-closing metathesis reaction.

Step 1: To a round-bottom flask, ROMP-U-shape (compound A3, 15 g, 0.63 mmol) and SWNTs (1 g) were added.

Step 2: Toluene (1 L) was added to the flask.

Step 3: The mixture was sonicated in a bath sonicator for 3 h.

Step 4: The flask content was distributed in conical centrifuged tubes and centrifuged at 8000 g for 30 min.

Step 5: The supernatant was recovered.

Step 6: The supernatant obtained was bubbled with N₂ for 20 min.

Step 7: Grubbs 2^{nd} generation catalyst (1.75 g, 0.5 equiv/U-shape unit) was added.

Step 8: The mixture was left without stirring overnight.

The final mixture obtained was called “ROMP polymer-coated SWNTs of Example HH7”

### Variations on the Abovementioned Protocol:

In step 4, higher or lower centrifugation speeds and longer or shorter times can be used in order to increase the final concentration of ROMP polymer-coated SWNTs. Reducing the centrifugation times and speeds may lead to an increase in SWNTs that have not been completely individualized.

### Example HH8. Method for the Synthesis of ROMP Polymer-Coated Carbon Nanotubes Having Free Terminal Double Bonds

In this example, the preparation of polymer-coated nanotubes containing free terminal double bonds is described. The procedure consists of a first nanotube individualization step, where a nanotube/polyUshape complex is generated and a second step, where the U shapes of the polyUshape polymer are closed around the nanotubes in a ring-closing metathesis reaction. The difference with Example HH1 is that a terminating agent is added in the ring-closing metathesis step in order to avoid the reaction of all double bonds.

Step 1: To a vial, ROMP-U-shape (compound A3, 18 mg, 7.5·10⁻⁴ mmol) and SWNTs (1.2 mg) were added.

Step 2: Toluene (15 mL) is added to the vial.

Step 3: The mixture is sonicated in a bath sonicator for 3 h.

Step 4: The vial content is distributed in Eppendorfs and centrifuged at 18600 g for 15 min.

Step 5: The supernatant is recovered.

Step 6: The supernatant obtained is bubbled with N₂ for 20 min.

Step 7: Grubbs 2^{nd} generation catalyst (2.1 mg, 0.5 equiv/U-shape unit) is added.

Step 8: The mixture was left without stirring for 15 min.

Step 9: Ethyl vinyl ether (0.1 mL) is added in order to deactivate the ROMP catalyst. The mixture obtained is called “ROMP polymer-coated SWNTs solution containing free terminal double bonds of Example HH8”.

Step 10: Methanol is added in order to precipitate the formed product.

Step 11: The mixture is centrifuged at 998 g for 10 min.

Step 12: Toluene is added to the precipitate and the vial is hand-shaken for one minute.

Step 13: The mixture is centrifuged again at 998 g for 10 min.

Step 14: Steps 12 and 13 are repeated until the supernatant obtained is completely colourless.

Step 15: The supernatant is removed and the precipitate is recovered.

Step 16: The precipitate obtained is dried overnight in an oven at 120° C.

The dried powder obtained is called “Cleaned ROMP polymer-coated SWNTs containing free terminal double bonds of Example HH8”

### Variations on the Abovementioned Protocol:

In step 9, a different terminating agent may be employed such as di(ethylene glycol) vinyl ether.

Instead of steps 10-16 a different cleaning protocol may be employed such as

### Example HH9. In Situ Polymerization of Polystyrene (PS) in the Presence of ROMP Polymer-Coated Carbon Nanotubes Having Free Terminal Double Bonds

In this example, the preparation of composites containing PS covalently attached to ROMP-polymer coated carbon nanotubes is described. The free radical polymerization takes place in the “ROMP polymer-coated SWNTs solution containing free terminal double bonds of Example HH8”. During the PS polymerization, the free terminal double bonds in the ROMP polymer-coated SWNTs react forming a crosslinked structure where PS grafts from the ROMP polymer-coated SWNTs.

Styrene, abbreviated Sty (Mw=104.15 g/mol, Sigma-Aldrich), is used as monomer. 2,2-Azobis(2-methylpropionitrile), abbreviated AIBN (Mw=164.21 g/mol, Sigma-Aldrich), is used as free radical initiator.

The starting point in this example is an 1000× up-scaled version of “ROMP polymer-coated SWNTs solution containing free terminal double bonds of Example HH8”. Such up-scaling may be done by e.g., performing an appropriate number of parallel experiments identical to the one that generated “ROMP polymer-coated SWNTs solution containing free terminal double bonds of Example HH8”, or doing all reactions at higher volumes but same concentrations.

Step 1: 12 g of Sty is added to the 1000× up-scaled “ROMP polymer-coated SWNTs solution containing free terminal double bonds of Example HH8” and the mixture is stirred for 30 min.

Step 2: 200 mg of AIBN are added to the mixture. The temperature is set at 65° C.

Step 3: The mixture is stirred at 65° C. under N₂ for 20 h.

Step 4: After polymerization, the final composite is precipitated by adding 200 mL isopropanol.

Step 5: The composite is filtered on a cellulose filter, washed with isopropanol and dried.

The composite obtained is called “PS/ROMP-polymer coated carbon nanotubes of Example HH9”.

### Variations on the Abovementioned Protocol:

In step 1, different monomers, suitable for radical polymerization might be employed such as methyl methacrylate or styrene.

### Example HH10. Preparation of a Polycarbonate (PC) Composite Reinforced with Aligned ROMP Polymer-Coated SWNTs

In this example, the preparation of composites containing PC/ROMP-polymer coated carbon nanotubes is described. Here, no covalent bonds are formed between PC and ROMP polymer-coated SWNTs. For the composite preparation, first, a solution of ROMP polymer-coated SWNTs in DMF is prepared. Then, the PC is dissolved in the DMF solution at the desired concentration and the mixture is electrospun in order to obtain polycarbonate (PC) fibers reinforced with aligned ROMP polymer-coated SWNTs.

In this example, the starting solution is obtained from the repetition of steps 1 to 8 from Example HH1 but in step 2 instead of toluene, DMF is added.

Step 1: To 15 mL of “ROMP polymer-coated SWNTs of Example HH1”, PC is added (1.2 g)

Step 2: The solution obtained in Step 1 is stirred at room temperature until the PC is completely dissolved.

Step 3: The solution is transferred to a syringe and pumped at 1 mL/h with a voltage of 14 kV and constant temperature and humidity.

Step 4: The solution is electrospun over a rotating drum collector and the PC fibers formed are deposited onto the collector.

The polymeric fibers obtained are called “Polycarbonate (PC) fibers reinforced with aligned ROMP polymer-coated SWNTs of Example HH10”

### Example HH11. Synthesis of a ROMP-U-Shape Derivative Containing Less U-Shape Units

This example is a variation of Examples A1. Here, norbornene is copolymerized with N-(4-Tosylatebutyl)]-cis-5-norbornene-exo-2,3-dicarboximide in the Ring-Opening-Metathesis-Polymerization (ROMP).

Step 1: In a round-bottom flask, pre-dried in an oven at 120° C. for 1 h, N-(4-Tosylatebutyl)]-cis-5-norbornene-exo-2,3-dicarboximide (93.5 mg, 0.25 mmol, 1 equiv.) and 2-norbornene (CAS: 498-66-8, 70.6 mg, 0.75 mmol, 4 equiv.) are introduced and solubilized in dry dichloromethane (2.5 mL) under Argon.

Step 2: In a second round-bottom flask, pre-dried in an oven at 120° C. for 1 h, Grubbs-III (3rd generation, 50.6 mg, 0.057 mmol) catalyst was solubilized in dry dichloromethane (1 mL), under Argon.

Step 3: Then, the solution obtained in step 2 is added quickly (in 2-3 seconds) to the solution of step 1 under vigorous stirring and Argon atmosphere.

Step 4: The solution of step 3 is stirred for 3 h and ethyl vinyl ether (1.7 mL) is added in order to quench the reaction.

Step 5: The resultant polymer solution is dried under reduced pressure using a rotary evaporator with the bath at 35° C.

Step 6: The polymer is solubilized in dichloromethane (1 mL) and added with a 1 mL syringe quickly in diethyl ether (200 mL) under vigorous stirring. The clean polymer precipitates in the solution. This procedure was repeated twice.

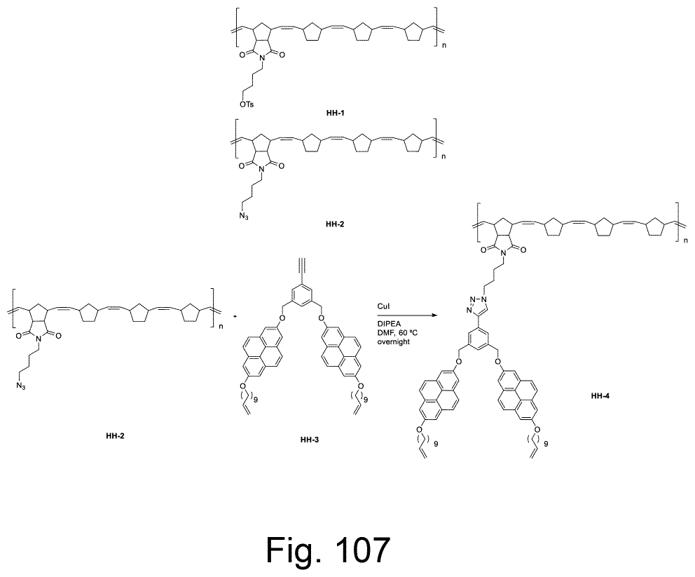

Step 7: The precipitate is dried in vacuo and termed “ROMP-OTs derivate of Example HH11” (Compound HH-1, depicted in FIG. 107).

Step 8: In a round bottom 15 mL flask, pre-dried in an oven at 120° C., “ROMP-OTs derivate of Example HH11” (Compound HH-1, 100 mg) is added and solubilized in dry DMF (4 mL).

Step 9: The solution is deoxygenated with Argon for 20 min.

Step 10: NaN₃ (25 mg, 0.38 mmol) is added under Argon.

Step 11: The reaction is stirred for 12 h at 80° C. under argon atmosphere.

Step 12: NaCl in deionized water (5 mL) is added. DMF is partially removed under reduced pressure.

Step 13: The precipitate obtained is isolated by filtration and washed with water to give “ROMP-N₃ derivate of Example HH11” (Compound HH-2, depicted in FIG. 107).

Step 14: In a dry round bottom flask, pre-dried in an oven at 120° C. for 1 h, alkyne U-shape (Compound HH-3, 400 mg, 0.45 mmol) in deoxygenated and dry DMF (15 mL) is introduced together with “ROMP-N₃ derivate of Example HH11” (Compound HH-2, 100 mg).

Step 15: N,N-diisopropylethylamine (DIPEA) (0.06 mL, 0.36 mmol) and CuI (69 mg, 0.36 mmol) are added in the solution and the mixture is stirred at 60° C. overnight.

Step 16: Next day, CH₂Cl₂ (20 mL) and saturated NaCl deionized water (15 mL) are added together with aq. NH₃ (2 mL).

Step 17: The crude mixture is left for 15 min under vigorous stirring.

Step 18: The organic phase is washed three times with deionized water, dried with Na₂SO₄ and the organic solvent is removed by rotary evaporation.

Step 19: The solid obtained is solubilized in a small amount of CH₂Cl₂ and added quickly using a syringe into diethyl ether. The precipitate formed is collected by paper filtration and dried under vacuum. The final product is termed “ROMP-U-shape derivate of Example HH11” (Compound HH-4, depicted in FIG. 107).

### Variations on the Abovementioned Protocol:

In step 1, different ratios N-(4-Tosylatebutyl)]-cis-5-norbornene-exo-2,3-dicarboximide: 2-norbornene may be employed in order to synthesize ROMP-U-shape derivatives having more or less U-shape units.

### Example HH12. Solution Synthesis of ROMP Polymer-Coated Carbon Nanotubes Having Less U-Shape Units

This example is a variation of Example HH7. Here, polymer-coated nanotubes are prepared using the ROMP-U-shape derivative synthesized in Example HH11. In this example, the anchor points between ROMP-U-shape derivative and SWNTs are fewer since the ROMP-U-shape derivative has less U-shape units per polymer chain.

Step 1: To a round-bottom flask, “ROMP-U-shape derivate of Example HH11” (Compound HH-4, 15 g) and SWNTs (1 g) are added.

Step 2: Toluene (1 L) is added to the flask.

Step 3: The mixture is sonicated in a bath sonicator for 3 h.

Step 4: The flask content is distributed in conical centrifuged tubes and centrifuged at 998 g for 30 min.

Step 5: The supernatant is recovered.

Step 6: The supernatant obtained is bubbled with N₂ for 20 min.

Step 7: Grubbs 2^{nd} generation catalyst (0.44 g, 0.5 equiv/U-shape unit) is added.

Step 8: The mixture is left without stirring overnight.

The final mixture obtained is called “ROMP polymer derivative-coated SWNTs of Example HH12”

### Variations on the Abovementioned Protocol:

Optionally, the removal of uncomplexed and/or non-ring-closed ROMP-polymer derivative and Grubbs 2^{nd} generation catalyst in SWNT-ROMP polymer composites may be performed by following one or various of the cleaning procedures described in Example HH2, A to Example HH2, F.

### Example HH13. Synthesis of a ROMP-U-Shape Derivative Containing Free Acid Groups

In this example, a ROMP-U-shape derivative containing free acid groups is prepared. The acid groups may be later transformed into acid chloride groups and employed in the reaction with different monomers in order to graft polymers from the ROMP-U-shape structure (i.e., reaction with hexamethylenediamine for the synthesis of nylon).

Step 1: In a round-bottom flask, pre-dried in an oven at 120° C. for 1 h, N-(4-Tosylatebutyl)]-cis-5-norbornene-exo-2,3-dicarboximide (187 mg, 0.5 mmol, 1 equiv.) and 5-Norbornene-2-carboxylic acid (CAS: 120-74-1, 61 μL, 0.5 mmol, 1 equiv.) are introduced and solubilized in dry dichloromethane (2.5 mL) under Argon.

Step 2: In a second round-bottom flask, pre-dried in an oven at 120° C. for 1 h, Grubbs-III (3rd generation, 50.6 mg, 0.057 mmol) catalyst was solubilized in dry dichloromethane (1 mL), under Argon.

Step 3: Then, the solution obtained in step 2 is added quickly (in 2-3 seconds) to the solution of step 1 under vigorous stirring and Argon atmosphere.

Step 4: The solution of step 3 is stirred for 3 h and ethyl vinyl ether (1.7 mL) is added in order to quench the reaction.

Step 5: The resultant polymer solution is dried under reduced pressure using a rotary evaporator with the bath at 35° C.

Step 6: The polymer is solubilized in dichloromethane (1 mL) and added with a 1 mL syringe quickly in diethyl ether (200 mL) under vigorous stirring. The clean polymer precipitates in the solution. This procedure was repeated twice.

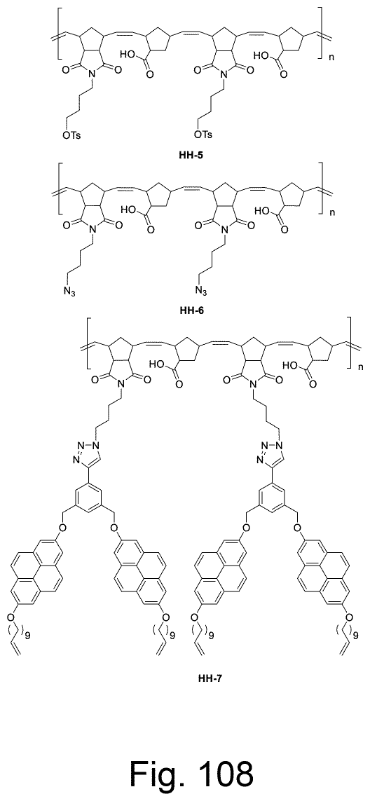

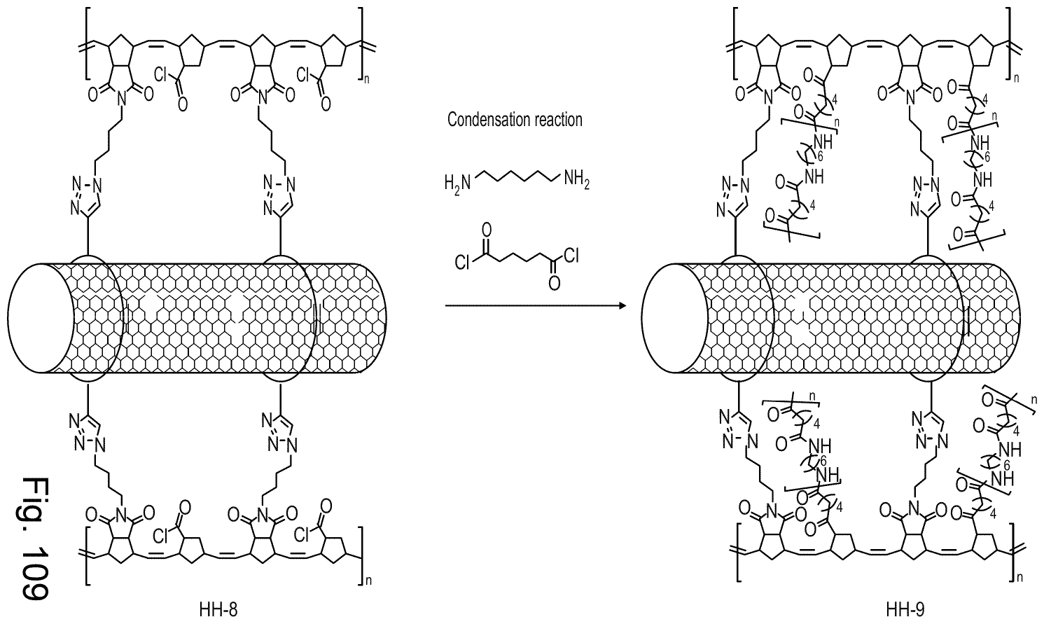

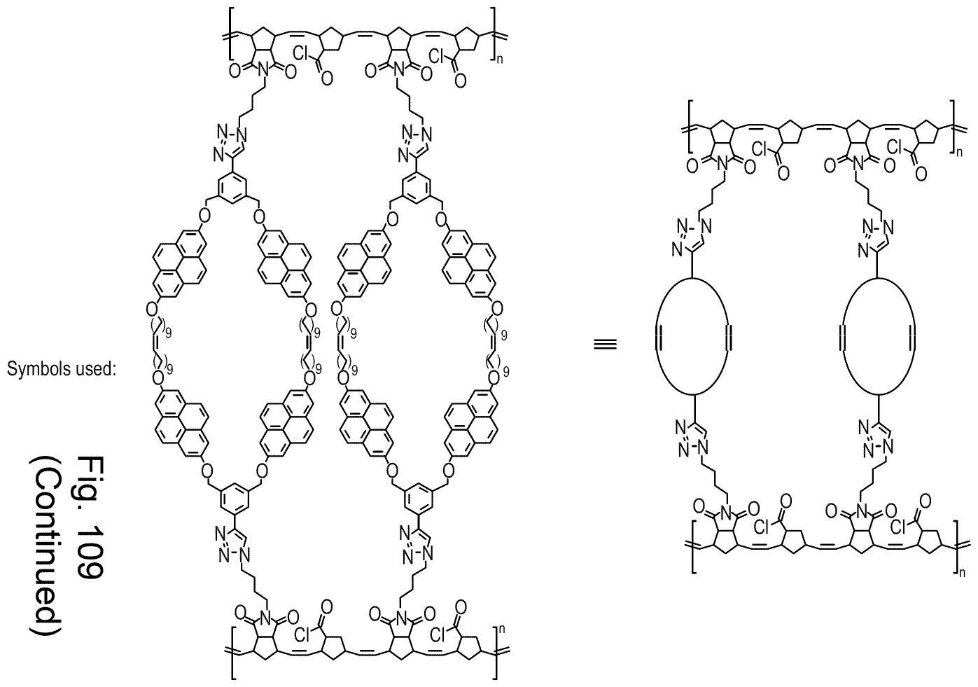

Step 7: The precipitate is dried in vacuo and termed “ROMP-OTs-acid derivate of Example HH13” (Compound HH-5, depicted in FIG. 108).

Step 8: In a round bottom 15 mL flask, pre-dried in an oven at 120° C., “ROMP-OTs-acid derivate of Example HH13” (Compound HH-5, 100 mg) is added and solubilized in dry DMF (4 mL).

Step 9: The solution is deoxygenated with Argon for 20 min.

Step 10: NaN₃ (50 mg, 0.76 mmol) is added under Argon.

Step 11: The reaction is stirred for 12 h at 80° C. under argon atmosphere.

Step 12: NaCl in deionized water (5 mL) is added. DMF is partially removed under reduced pressure.

Step 13: The precipitate obtained is isolated by filtration and washed with water to give “ROMP-N₃-acid derivate of Example HH13” (Compound HH-6, depicted in FIG. 108).

Step 14: In a dry round bottom flask, pre-dried in an oven at 120° C. for 1 h, alkyne U-shape (compound J8, 808 mg, 0.90 mmol) in deoxygenated and dry DMF (15 mL) is introduced together with “ROMP-N₃-acid derivate of Example HH13” (Compound HH-6, 100 mg).

Step 15: N,N-diisopropylethylamine (DIPEA) (0.15 mL, 0.90 mmol) and CuI (173 mg, 0.90 mmol) are added in the solution and the mixture is stirred at 60° C. overnight.

Step 16: Next day, CH₂Cl₂ (20 mL) and saturated NaCl deionized water (15 mL) are added together with aq. NH₃ (2 mL).

Step 17: The crude mixture is left for 15 min under vigorous stirring.

Step 18: The organic phase is washed three times with deionized water, dried with Na₂SO₄ and the organic solvent is removed by rotary evaporation.

Step 19: The solid obtained is solubilized in a small amount of CH₂Cl₂ and added quickly using a syringe into diethyl ether. The precipitate formed is collected by paper filtration and dried under vacuum. The final product is termed “ROMP-U-shape-acid derivate of Example HH13” (Compound HH-7, depicted in FIG. 108).

### Example HH14. Solution Synthesis of ROMP Polymer-Coated Carbon Nanotubes Having Free Terminal Acid Groups

This is a variation of Example HH12. In this case, instead of the “ROMP-U-shape derivate of Example HH11”, the “ROMP-U-shape-acid derivate of Example HH13” is employed in the preparation of ROMP polymer-coated carbon nanotubes. The free acid terminal groups present in the as-prepared ROMP polymer-coated carbon nanotubes will be employed as starting monomers in the polymerization of polymers (i.e., nylon).

Steps 1 to 8 from Example 12 are followed but in Step 1, instead of “ROMP-U-shape derivate of Example HH11”, “ROMP-U-shape-acid derivate of Example HH13” (Compound HH-7, 15 g) is added. In Step 7, the amount of Grubbs 2^{nd} generation catalyst added is determined by the quantity of U-shape units present in the ROMP-U-shape-acid derivative, in this example, 0.44 g are added (0.5 equiv/U-shape unit).

The final mixture obtained is called “ROMP polymer-coated SWNTs having free terminal acid groups of Example HH14”

### Variations on the Abovementioned Protocol:

Optionally, the removal of uncomplexed and/or non-ring-closed ROMP-polymer derivative and Grubbs 2^{nd} generation catalyst in SWNT-ROMP polymer composites may be performed by following one or various of the cleaning procedures described in Example HH2, A to Example HH2, F.

i.e.:

Step 9: The final product obtained in Step 8, “ROMP polymer-coated SWNTs having free terminal acid groups of Example HH14” is centrifuged at 998 g for 30 min.

Step 10: The supernatant obtained is removed carefully.

Step 11: Toluene is added to the precipitate and the vial is hand-shaken for one minute.

Step 12: The mixture is centrifuged again at 998 g for 30 min.

Step 13: Steps 10 and 11 are repeated until the supernatant obtained is completely colorless.

Step 14: The supernatant is removed

Step 15: The precipitate obtained is dried overnight in an oven at 120° C.

The final composite is termed “Toluene-precipitated ROMP polymer-coated SWNTs having free terminal acid groups of Example HH14”

### Example HH15. Preparation of ROMP Polymer-Coated Carbon Nanotubes Having Free Terminal Acyl Chloride Groups

In this example, the terminal acid groups in the “Toluene-precipitated ROMP polymer-coated SWNTs having free terminal acid groups of Example HH14” are transformed into acyl chloride groups.

Step 1: 1 g “Toluene-precipitated ROMP polymer-coated SWNTs having free terminal acid groups of Example HH14” are added to a round-bottom flask.

Step 2: 10 mL SOCl₂ (thionyl chloride) are added to the flask.

Step 3: The mixture is stirred at 70° C. during 24 h under a nitrogen atmosphere.

Step 4: After this time, the unreacted SOCl₂ is eliminated by evaporation in a rotary evaporator.

The product obtained is termed “ROMP polymer-coated SWNTs having free terminal acyl chloride groups of Example HH15” (Compound HH-8, depicted in FIG. 109).

### Example HH16. In Situ Polymerization of Nylon in the Presence of ROMP Polymer-Coated Carbon Nanotubes Having Free Terminal Acyl Chloride Groups

In this example, nylon 6,6 is polymerized from the free terminal acyl chloride groups present in the “ROMP polymer-coated SWNTs having free terminal acyl chloride groups of Example HH15”. The synthesis involves the condensation between hexamethylenediamine, adipoyl chloride and the acyl groups in the ROMP polymer-coated SWNTs.

Step 1: Hexamethylenediamine (300 mg) and NaOH (100 mg) are dissolved in 5 mL distilled water.

Step 2: “ROMP polymer-coated SWNTs having free terminal acyl chloride groups of Example HH15” (Compound HH-8, 7.7 mg) and adipoyl chloride (0.37 mL) are dispersed in hexane (5 mL) using bath sonication (15 min).

Step 3: The solution obtained in step 2 is slowly poured onto the solution obtained in step 1.

The hexamethylenediamine, adipoyl chloride and the acyl chloride groups present in the ROMP polymer-coated SWNTs polymerize in the interphase water/hexane.

Step 4: The fibre formed is winded onto a glass rod.

Step 5: The fibre is rinsed with water and dried in air.

The obtained composite is termed “Nylon 6,6 reinforced with ROMP polymer-coated SWNTs of Example HH16” (Compound HH-9, depicted in FIG. 109).

### Example HH17. Mechanochemical Synthesis of Nanotube-ML Complexes Using a Mortar

In this example, a general procedure for the mechanochemical synthesis of nanotube-ML complexes using a mortar (e.g., agate or porcelain mortar) is described. The precursor-ML binds first to the nanotube and its two ends are reacted to form a closed ring around the nanotube. The nanotube is a single-wall carbon nanotube (SWNT), the precursor-ML is a linear molecule and the mechanical ligand (ML) is a covalently closed ring structure.

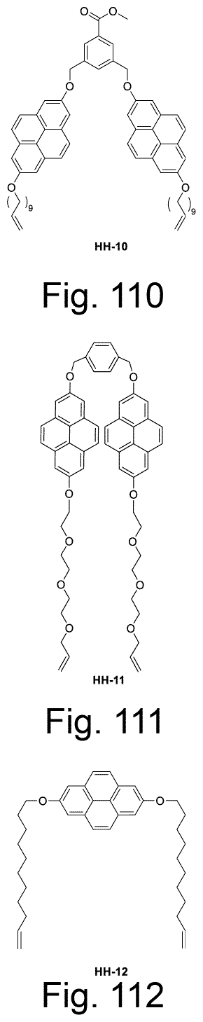

Step 1. SWNTs (100 mg), ester precursor-ML (Compound HH-10 (depicted in FIG. 110), 42 mg, 0.48 μmol/mg NT) and Grubbs 2^{nd} generation catalyst (20 mg, 0.5 equiv./pyrene precursor-ML) were added to an agate mortar.

Step 2. The mixture was hand-grinded for 30 min. During this time, the heterogeneous mixture became a fine black powder as a consequence of the ring-closing metathesis taking place.

Step 3. After this time, the powder was recovered using a spatula.

The resulting product, SWNTs with covalently closed ring structures around them and with low moisture content was termed “Mechanochemical SWNT-ML of Example 0”.

Step 4. Optionally, the residual Grubbs catalyst was removed by washing the final “Mechanochemical SWNT-ML of Example 0” powder with dichloromethane. The cleaned product was recovered by filtering through a 0.2 μm-pore size polytetrafluoroethylene (PTFE) membrane.

The resulting product, cleaned SWNTs with covalently closed ring structures around them and with low moisture content was termed “Washed mechanochemical SWNT-ML of Example HH17”.

### Example HH18. Mechanochemical Synthesis of Nanotube-ML Complexes Using a Ball Mill

This example is a modification of Example HH17. This example describes de synthesis of nanotube-ML complexes using a planetary ball mill. As in Example HH17, the precursor-ML is a linear molecule composed of two recognition motifs towards SWNTs and two terminal alkene functionalities that are reacted in a ring-closing metathesis forming a closed ring around the SWNT.

Step 1. SWNTs (1.5 g), ethylene glycol pyrene precursor-ML (Compound HH-11, 659 mg, 0.48 μmol/mg NT) and Grubbs 2^{nd} generation catalyst (31 mg, 0.05 equiv./pyrene precursor-ML) were added to a 45 mL stainless steel planetary ball mill reactor.

Step 2. The reactor was filled with 5 stainless steel 15 mm diameter grinding balls.

Step 3. The reactor was placed in the planetary ball mill and the reaction was carried out for 10 min at 500 rpm.

Step 4. After this time, the reactor was carefully opened and the powder obtained was recovered with a spatula.

The resulting product, SWNTs with covalently closed ring structures around them and with low moisture content was termed “Mechanochemical SWNT-ML of Example HH18”.

Step 5. Optionally, the residual Grubbs catalyst was removed by washing the final “Mechanochemical SWNT-ML of Example HH18” powder with dichloromethane. The cleaned product was recovered by filtering through a 0.2 μm-pore size polytetrafluoroethylene (PTFE) membrane.

The resulting product, cleaned SWNTs with covalently closed ring structures around them and with low moisture content was termed “Washed mechanochemical SWNT-ML of Example HH18”.

### Example HH19. Sequential Mechanochemical Synthesis of Nanotube-ML Complexes Using a Ball Mill

This example is a modification of Example HH17. This example describes de synthesis of nanotube-ML complexes using a planetary ball mill. In this example, a first homogenization step is performed before the addition of Grubbs 2^{nd} gen. catalyst.

Step 1. SWNTs (1.5 g) and dialkylated pyrene precursor-ML (Compound HH-12 (depicted in FIG. 112), 689 mg, 0.48 μmol/mg NT) and added to a 45 mL stainless steel planetary ball mill reactor.

Step 2. The reactor was filled with 5 stainless steel 15 mm diameter grinding balls.

Step 3. The reactor was placed in the planetary ball mill and the mixing was carried out for 2 min at 500 rpm.

Step 4. The reactor was carefully opened and Grubbs 2^{nd} generation catalyst (31 mg, 0.05 equiv./pyrene precursor-ML) was added.

Step 5. The reactor was placed in the planetary ball mill and the reaction was carried out for 10 min at 500 rpm.

Step 6. After this time, the reactor was carefully opened and the powder obtained was recovered with a spatula.

The resulting product, SWNTs with covalently closed ring structures around them and with low moisture content was termed “Mechanochemical SWNT-ML of Example HH19”.

Step 7. Optionally, the residual Grubbs catalyst was removed by washing the final “Mechanochemical SWNT-ML of Example HH18” powder with dichloromethane. The cleaned product was recovered by filtering through a 0.2 μm-pore size polytetrafluoroethylene (PTFE) membrane.

The resulting product, cleaned SWNTs with covalently closed ring structures around them and with low moisture content was termed “Washed mechanochemical SWNT-ML of Example HH19”.

### Example HH2O. Flow Mechanochemical Synthesis of Nanotube-ML Complexes

This is a modification of Example 17. In this example, mechanochemistry is employed to produce nanotube-ML complexes but the synthesis is scaled-up from batch milling experiments to continuous processing using extrusion. Here, the precursor-ML binds to the nanotube and both shear and compressive forces trigger the olefin ring-closing metathesis reaction that produces nanotube-ML complexes. The equipment employed is an extruder carrying two solid twin-screw volumetric feeders (1 and 2), each equipped with an agitator.

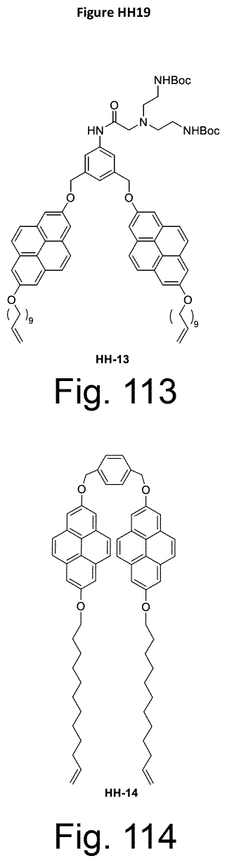

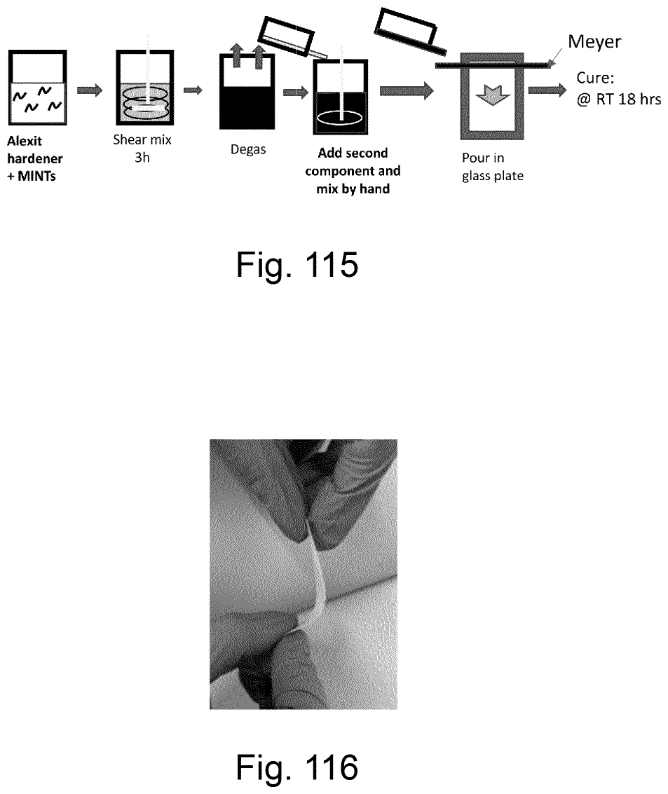

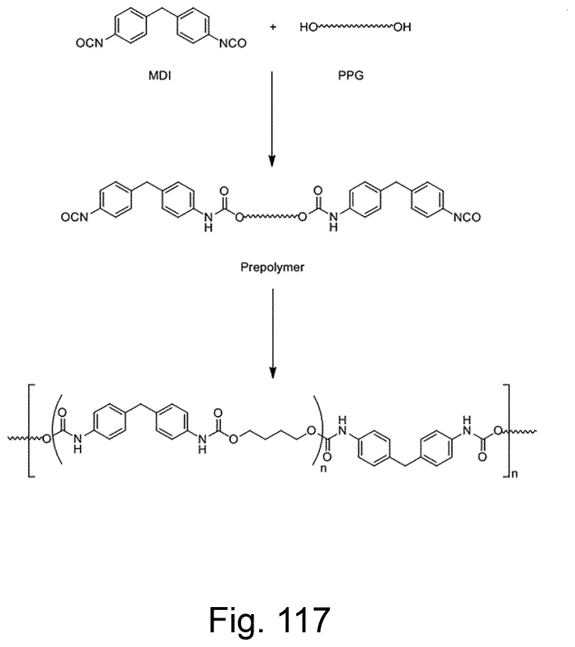

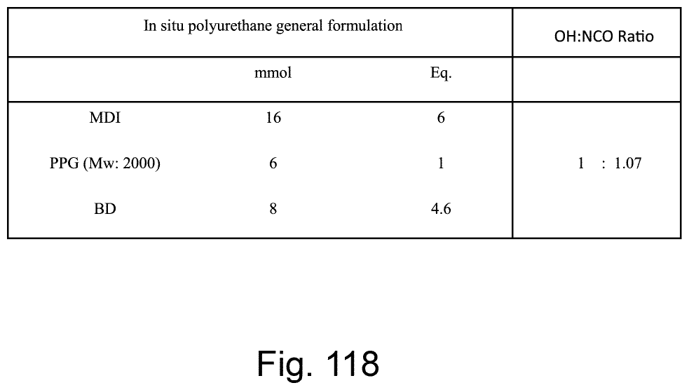

Step 1: A 1:0.4 w/w mixture of Tuball SWNTs (from OCSiAl; diameters ranging from 1.3-2.3 nm) and diamino precursor-ML (Compound HH-13, depicted in FIG. 113) is charged to the solid feeder 1, that is connected to the first part of the extruder at a rate of 200 g/h.

Step 2: The mixture is homogenized inside the extruder barrel at a screw speed of 55 rpm and room temperature.

Step 3: Grubbs 2^{nd} generation catalyst (1:0.4:0.02 w/w/w SWNTs/amino precursor-ML/Grubbs) is added through feeder 2 at a rate of 2.9 g/h.

Step 4: The mixture is homogenized inside the extruder barrel at a screw speed of 55 rpm and room temperature. During this step, the ring-closing metathesis takes place inside the barrel.

Step 5: The mixture is isolated at the end of the barrel in the form of powder. The powder obtained is called “Flow chemistry SWNT-ML-diamino of Example HH20”.

This methodology can be modified as follows:
If the residual Grubbs 2^{nd} generation catalyst wants to be removed, step 6 can be added:

Step 6: The powder obtained in Step 5, Flow chemistry SWNT-ML-diamino of Example HH2O, is added to a 0.2 μm-pore size polytetrafluoroethylene (PTFE) membrane and CH₂Cl₂ is added. The residual Grubbs 2^{nd} generation catalyst is able to cross the membrane while the purified SWNT-ML-diamino remains in the PTFE membrane. The powder obtained is recovered and termed “Washed flow chemistry SWNT-ML-diamino of Example HH20”.

### Example HH21. Protocol for the Flow Production of PP-SWNT-ML Composites

This example is a variation of Example 19. In this case, the extruder is equipped with three solid twin-screw volumetric feeders. In the first part of the extruder the nanotube-ML are produced through mechanochemistry. In the second part of the extruder, the produced SWNT-ML contained inside the extruder are mixed with polypropylene that is added through the third feeder.

Step 1: A 1:0.4 w/w mixture of Tuball SWNTs (from OCSiAl; diameters ranging from 1.3-2.3 nm) and pyrene precursor-ML (Compound HH-14, depicted in FIG. 114) is charged to the solid feeder 1, that is connected to the first part of the extruder at a rate of 20 g/h.

Step 2: The mixture is homogenized inside the extruder barrel at a screw speed of 55 rpm and room temperature.

Step 3: Grubbs 2^{nd} generation catalyst (1:0.4:0.02 w/w/w SWNTs/precursor-ML/Grubbs) is added through feeder 2 at a rate of 0.3 g/h.

Step 4: The mixture is homogenized inside the extruder barrel at a screw speed of 55 rpm and room temperature. During this step, the ring-closing metathesis takes place inside the barrel.

Step 5: Polypropylene pellets (LyondellBasell, Moplen HP400R) (99:1 w/w Polypropylene/SWNTs) are added through feeder 3 at a rate of 1386 g/h.

Step 6: The temperature of the barrel is heated to 210° C.

Step 7: After mixing, the material is obtained at the extruder in the form of a single strand.

Step 8: The obtained strand is cooled down and pelletized giving “PP-SWNT-ML pellets of Example HH21”

This methodology can be modified as follows:
In step 5, the quantity of polypropylene can be modified to produce composites with different SWNT content.
In step 5, a different thermoplastic can be added instead of polypropylene (e.g., PVC, polystyrene or acrylonitrile butadiene styrene (ABS))
The pellets obtained can be reintroduced in the extruder as many times as desired, e.g., 1, 2, 3, 4, 5, 6, 7 or more times.

### Example HH22. Mechanochemical Preparation of LDPE Composites Reinforced with SWNT-ML

This example describes the simultaneous preparation of SWNT-ML and LDPE composites. The SWNT-ML forming reaction and the homogenization between LDPE and SWNT-ML are performed in a planetary ball mill. The LDPE present in the reaction medium during the ring-closing reaction to form SWNT-ML prevents the SWNTs to adhere to each other. No covalent bond is formed during the process between LDPE and SWNT-ML.

Step 1. SWNTs (0.25 g), pyrene precursor-ML (Compound HH-14, 108 mg, 0.48 μmol/mg NT) and Grubbs 2^{nd} generation catalyst (5 mg, 0.05 equiv./pyrene precursor-ML) were added to a 20 mL stainless steel planetary ball mill reactor.

Step 2. LDPE (10 g) was fed into the reactor.

Step 3. The reactor was filled with 5 stainless steel 15 mm diameter grinding balls.

Step 4. The reactor was placed in the planetary ball mill and the reaction was carried out for 10 min at 500 rpm.

Step 5. After this time, the reactor was carefully opened and the powder obtained was recovered with a spatula.

The resulting product, LDPE composite containing a 2.5% SWNT-ML was termed “LDPE/SWNT composite of Example HH22”.

Step 6. The composite obtained in step 5 (“LDPE composite reinforced with SWNT-ML of Example HH21”) was subjected to injection molding at 180° C. and introduced in a mould having several plastic-cap shapes.

The resulting product, SWNT-ML reinforced LDPE plastic-caps for use in pipes protection is termed “SWNT-ML reinforced LDPE plastic-caps of Example HH22”.

### Example II1. Commercial Thermoset Polyurethane (ALEXIT® BladeRep LEP 9) Composites with Diamino-Boc MINTs

In this example a nanocomposite diamino-boc MINTs and commercial thermoset polyurethane is produced through in situ polymerization.

ALEXIT® BladeRep LEP 9 is two-component, solvent free polyurethane. In the most viscous component (here called Component 1, or hardener), the MINTs are dispersed for subsequent application of the polyurethane paint on the surface to be protected. Then at a later stage Component 2 is added.

The composite of ALEXIT® BladeRep LEP 9 and diamino-boc MINTs was produced following these steps:

Step 1: 57.7 mg and 289.9 mg, respectively, of diamino-boc MINTs of Example GG7, were added to each of two different 15 g batches of hardener, to make a 0.1% wt composite and a 0.5% wt. composites, respectively.

Step 2: Each of the two batches were mixed in a high-speed shear mixer for 3 hours at 10,000 RPM.

Step 3: The gases generated by the shear mixer were removed in the vacuum oven at 50° C. for one hour. To help make this process more effective, the mixture was transferred to a one-liter beaker in order to make the degassing surface larger.

Step 4: 30 g of Component 2 was added and mixed by hand until a homogeneous gray color is obtained. The resulting two materials are called “0.1% CNT/Polyurethane coating of Example II1” and “0.5% CNT/Polyurethane coating of Example II1”

Step 5: The material was applied to anti-adherent coated glass plates by a Meyer bar instrument.

Step 6: The material was allowed to cure for 18 hours. Films of an approximate thickness of 100 μm were obtained.

The films were tested for mechanical characteristics using the Instron instrument. The Young's Modulus are shown in the table immediately below.
YM (GPa)
0.1% CNT/Polyurethane 3.73±0.2
0.5% CNT/Polyurethane 5.46±0.2

### Example II2. Thermoplastic Polyurethane (TPU) Composites with Diamino-Boc MINTs by In Situ Polymerization

In this example a nanocomposite of diboc MINTs and thermoplastic polyurethane is produced through in situ polymerization.

Polypropylene glycol, abbreviated as PPG and with a molecular weight of 2000 g/mol, Methylene diphenyl diisocyanate, abbreviated as MDI and 1,4-butanediol abbreviated as BDO were used to form the polymeric matrix.

The composite of TPU and MINTs was produced by the following these steps:

Step 1: PPG and BDO were placed in a flask under vacuum to stir at 100 RPM while heating to 80° C. to eliminate traces of moisture that may have alcohols.

Step 2: 4 g of MDI and 21.6 mg of “diamino-boc MINTs of Example GG7” were placed in a mortar and ground for 20 minutes to achieve a first dispersion in the monomer.

Step 3: 12 grams of the PPG and the mixture of Step 2 were added in a round bottom flask and purged with N2 for 5 minutes. The reaction was then started by heating the flask at 80° C. under stirring at 350 RPM for 20 hrs to form the prepolymer.

Step 4: The prepolymer was degassed for 1 hrs at 80° C. with a vacuum pump connected to the flask for 0.5 h at 100° C.

Step 5: The BDO was mixed with the prepolymer and the mixture was poured into the teflon mold. The resulting material was named “Thermoplastic polyurethane/diaminoboc MINTs of Example II2”.

Step 6: The material was cured for 18 hours in the vacuum oven.

The procedure described in this example was applied to the generation of a number of TPU composites with different MINTs, as described in the following examples.

The films were tested for mechanical characteristics using the Instron instrument. The Young's Modulus abbreviated as YM, tensile strength (abbreviated as TS), material toughness (abbreviated as MT) are shown in the table immediately below.

| | YM (MPa) | TS (MPa) | MT (KJ/m³) |
|---|---|---|---|
| 0.1% CNT/Polyurethane | 2.74 ± 0.45 | 1.15 ± 0.3 | 2715.3 ± 1000 |

These values cannot be compared with the composites described in the following examples because the PPG used is older and therefore the properties are worse due to the moisture in the sample that is difficult to remove despite step 1.

### Example II3. Thermoplastic Polyurethane (TPU) Composites with Diamino MINTs by In Situ Polymerization

In this example a nanocomposite of diamino MINTs and thermoplastic polyurethane is produced through in situ polymerization.

For this the “diamino-boc MINTs of Example GG7” were deprotected from the boc to free two secondary amines (explained in the first step)

PPG with a molecular weight of 2000 g/mol, MDI and BDO were used to form the polymeric matrix.

The composite of TPU and MINTs was produced by the following these steps:

Step 1: “Diamino-boc MINTs of Example GG7” were deprotected in the furnace at 220° C. overnight, to obtain diamino MINTs.

Step 2: PPG and BDO were placed in a flask under vacuum to stir at 100 RPM while heating to 80° C. to eliminate traces of moisture that may have alcohols.

Step 3: 4 g of MDI and 20.81 mg of diamino MINTs were placed in a mortar and ground for 20 minutes to achieve a first dispersion in the monomer.

Step 4: 12 grams of the PPG and the mixture of Step 3 were added in a round bottom flask and purged with N2 for 5 minutes. The reaction was then started by heating the flask at 80° C. under stirring at 350 RPM for 20 hrs to form the prepolymer.

Step 5: The prepolymer was degassed for 1 hrs at 80° C. with a vacuum pump connected to the flask for 0.5 h at 100° C.

Step 6: The BDO was mixed with the prepolymer and the mixture was poured into the teflon mold. The resulting material was named “Thermoplastic polyurethane/diamino MINTs of Example II3”.

Step 7: The material was cured for 18 hours in the vacuum oven.

### Example II4. Thermoplastic Polyurethane (TPU) Composites with Amino MINTs MINTs by In Situ Polymerization

In this example a nanocomposite of amino MINTs and thermoplastic polyurethane is produced through in situ polymerization.

For this the amine of the macrocycle of “Phthalimide MINTs of Example EE9B” was deprotected as explained in example EE10.

PPG with a molecular weight of 2000 g/mol, MDI and BDO were used to form the polymeric matrix.

The composite of TPU and MINTs was produced by the following these steps:

Step 1: PPG and BDO were placed in a flask under vacuum to stir at 100 RPM while heating to 80° C. to eliminate traces of moisture that may have alcohols.

Step 2: 4 g of MDI and 21.8 mg of “Methylamine MINTs of Example EE10” were placed in a mortar and ground for 20 minutes to achieve a first dispersion in the monomer.

Step 3: 12 grams of the PPG and the mixture of Step 2 were added in a round bottom flask and purged with N2 for 5 minutes. The reaction was then started by heating the flask at 80° C. under stirring at 350 RPM for 20 hrs to form the prepolymer.

Step 4: The prepolymer was degassed for 1 hrs at 80° C. with a vacuum pump connected to the flask for 0.5 h at 100° C.

Step 5: The BDO was mixed with the prepolymer and the mixture was poured into the teflon mold. The resulting material was named “Thermoplastic polyurethane/amino MINTs of Example II4”.

Step 10: The material was cured for 18 hours in the vacuum oven.

The films were tested for mechanical characteristics using the Instron instrument. The Young's Modulus abbreviated as YM, tensile strength (abbreviated as TS), material toughness (abbreviated as MT) are shown in the table immediately below.

| | YM (MPa) | TS (MPa) | MT (KJ/m³) |
|---|---|---|---|
| 0.1% | 6.6 ± 0.5 | 3.14 ± 0.46 | 4758.6718 ± 1114 |
| CNT/Polyurethane | | | |

### Example II5. Thermoplastic Polyurethane (TPU) Composites with Methylalcohol MINTs by In Situ Polymerization

In this example a nanocomposite of methylalcohol MINTs and thermoplastic polyurethane is produced through in situ polymerization.

PPG with a molecular weight of 2000 g/mol, MDI and BDO were used to form the polymeric matrix.

The composite of TPU and MINTs was produced by the following these steps:

Step 1: PPG and BDO were placed in a flask under vacuum to stir at 100 RPM while heating to 80° C. to eliminate traces of moisture that may have alcohols.

Step 2: 4 g of MDI and 22.3 mg of “Methylalcohol MINTs of Example EE9B” were placed in a mortar and ground for 20 minutes to achieve a first dispersion in the monomer.

Step 3: 12 grams of the PPG and the mixture of Step 2 were added in a round bottom flask and purged with N2 for 5 minutes. The reaction was then started by heating the flask at 80° C. under stirring at 350 RPM for 20 hrs to form the prepolymer.

Step 4: The prepolymer was degassed for 1 hrs at 80° C. with a vacuum pump connected to the flask for 0.5 h at 100° C.

Step 5: The BDO was mixed with the prepolymer and the mixture was poured into the teflon mold. The resulting material was named “Thermoplastic polyurethane/methylalcohol MINTs of Example II5”.

Step 6: The material was cured for 18 hours in the vacuum oven.

The films were tested for mechanical characteristics using the Instron instrument. The Young's Modulus abbreviated as YM, tensile strength (abbreviated as TS), material toughness (abbreviated as MT) are shown in the table immediately below.

| | YM (MPa) | TS (MPa) | MT (KJ/m³) |
|---|---|---|---|
| 0.1% CNT/Polyurethane | 4.17 ± 0.54 | 2.6 ± 0.3 | 5180 ± 2457 |

### Example II6. Thermoplastic Polyurethane (TPU) Composites with MDI (OMe) MINTs by In Situ Polymerization

In this example a nanocomposite of MDI (OMe) MINTs and thermoplastic polyurethane is produced through in situ polymerization.

PPG with a molecular weight of 2000 g/mol, MDI and BDO were used to form the polymeric matrix.

The composite of TPU and MINTs was produced by the following these steps:

Step 1: PPG and BDO were placed in a flask under vacuum to stir at 100 RPM while heating to 80° C. to eliminate traces of moisture that may have alcohols.

Step 2: 4 g of MDI and 25.8 mg of “MDI(OMe)MINTs of Example EE13” were placed in a mortar and ground for 20 minutes to achieve a first dispersion in the monomer.

Step 3: 12 grams of the PPG and the mixture of Step 2 were added in a round bottom flask and purged with N2 for 5 minutes. The reaction was then started by heating the flask at 80° C. under stirring at 350 RPM for 20 hrs to form the prepolymer.

Step 4: The prepolymer was degassed for 1 hrs at 80° C. with a vacuum pump connected to the flask for 0.5 h at 100° C.

Step 5: The BDO was mixed with the prepolymer and the mixture was poured into the teflon mold. The resulting material was named “Thermoplastic polyurethane/MDI(OMe) MINTs of Example II6”.

Step 6: The material was cured for 18 hours in the vacuum oven.

The films were tested for mechanical characteristics using the Instron instrument. The Young's Modulus abbreviated as YM, tensile strength (abbreviated as TS), material toughness (abbreviated as MT) are shown in the table immediately below.

| | YM (MPa) | TS (MPa) | MT (KJ/m³) |
|---|---|---|---|
| 0.1% CNT/Polyurethane | 6.06 ± 0.2 | 3.67 ± 0.3 | 11100 ± 1709 |

### Example II7. Thermoplastic Polyurethane (TPU) Composites with MDI (NCO) MINTs by In Situ Polymerization

In this example a nanocomposite of MDI (NCO) MINTs and thermoplastic polyurethane is produced through in situ polymerization.

PPG with a molecular weight of 2000 g/mol, MDI and BDO were used to form the polymeric matrix.

The composite of TPU and MINTs was produced by the following these steps:

Step 1: PPG and BDO were placed in a flask under vacuum to stir at 100 RPM while heating to 80° C. to eliminate traces of moisture that may have alcohols.

Step 2: 4 g of MDI and 26 mg of “MDI(OMe)MINTs of Example EE12” were placed in a mortar and ground for 20 minutes to achieve a first dispersion in the monomer.

Step 3: 12 grams of the PPG and the mixture of Step 2 were added in a round bottom flask and purged with N2 for 5 minutes. The reaction was then started by heating the flask at 80° C. under stirring at 350 RPM for 20 hrs to form the prepolymer.

Step 4: The prepolymer was degassed for 1 hrs at 80° C. with a vacuum pump connected to the flask for 0.5 h at 100° C.

Step 5: The BDO was mixed with the prepolymer and the mixture was poured into the teflon mold. The resulting material was named “Thermoplastic polyurethane/MDI(NCO) MINTs of Example II7”.

Step 6: The material was cured for 18 hours in the vacuum oven.

The films were tested for mechanical characteristics using the Instron instrument. The Young's Modulus abbreviated as YM, tensile strength (abbreviated as TS), material toughness (abbreviated as MT) are shown in the table immediately below.

### Example JJ21. Different Sequences of Events Leading to Polymer Composites

The different sequences of events leading to polymer-nanotube composites, described at the general level in Example 0, are exemplified using ring-opening metathesis polymerization (ROMP), to form the ROMP polymer. Thus, Sequence 1 and Sequence 3, C are exemplified using ROMP polymer in Example JJ21, A. Sequence 2 is exemplified using ROMP polymer in Examples A1-A32. Sequence 4 is enabled in Example JJ28-A.

In Example JJ21, B, the different sequences of events are further exemplified using PVC, PP, PE, PU, polyamide, PS, and epoxy for the coating of nanotubes.

### Example JJ21, A. Different Sequences of Events Leading to ROMP Polymer-Carbon Nanotube Composite Materials

Three different sequences of events (Sequence 1, 2, and 3C) leading to carbon nanotube-ROMP polymer composite, also called ROMP polymer-coated carbon nanotubes, are depicted in FIG. 119B:

Sequence 1 is exemplified using the ROMP polymer and involves first mixing of nanotubes and U shapes (precursor-MLs) carrying reactive groups (Y). A ring-closing reaction is performed and then a pre-formed ROMP polymer carrying reactive groups (X) is added, and upon formation of XY bonds a ROMP polymer-coated nanotube is formed:

Step 1: First, an appropriate amount of carbon nanotubes is dispersed in tetrachloroethane (TCE, 1 mL/mg nanotube) through bath sonication (10 min).

Step 2: To this dispersion, the precursor-ML carrying a reactive group Y (e.g. an alkyne) and two terminal alkene functionalities is added.

Step 3: The mixture is bubbled with nitrogen for 20 min.

Step 4: Grubbs catalyst 2^{nd} generation (1 equiv. with respect to the precursor-ML) is added.

Step 5: The mixture is stirred at room temperature under inert atmosphere for 72 h allowing the precursor-ML to bind to a SWNT and form a macrocycle around it through ring-closing metathesis.

Step 6: After this time, the suspension is filtered through a 0.2 μm-pore size polytetrafluoroethylene (PTFE) membrane. The solid obtained is removed from the filter and washed with TCE employing 5 min sonication, and filtered again. This cleaning procedure is repeated three times, until the filtration solvent is colourless, indicating that the unreacted precursor-ML and Grubbs 2^{nd} generation catalyst have been removed. The product is dried at 100° C. for 1 h to produce “Nanotubes-ML-Y of Example JJ21, A, sequence 1”.

Step 7: In a flask pre-dried in an oven at 120° C. for 1 h, the obtained “Nanotubes-ML-Y of Example JJ21, A, sequence 1” are dispersed in dry tetrachloroethane (1 mL/mg nanotube) employing bath sonication (10 min).

Step 8: To this mixture, a ROMP polymer carrying terminal reactive groups X (e.g. azide groups) previously dissolved in dry TCE is added.

Step 9: N,N-diisopropylethylamine (DIPEA) is added to the solution.

Step 10: Copper iodide (CuI) is added.

Step 11: The solution mixture is stirred at 60° C. for 12 hours, and optionally sonicated 1-5 times of each 5-10 minutes.

Step 12: After this time, dichloromethane and saturated sodium chloride (NaCl) deionized water solutions are added to the solution mixture resulting from step 11.

Step 13: Then, the addition of aqueous ammonia (NH₃) solution (25%) follows and the mixture is left under vigorous stirring for 15 min.

Step 14: The suspension is then filtered through a 0.2 μm-pore size polytetrafluoroethylene (PTFE) membrane and the filter cake is washed with water. The solid obtained is removed from the filter and washed with water employing 5 min sonication. This cleaning procedure is repeated three times, until the filtration solvent is colourless, indicating that the unreacted ROMP polymer, DIPEA and CuI have been removed. The product is dried at 150° C. for 1 h to produce “ROMP polymer-coated nanotubes of Example JJ21, A, sequence 1”.

Sequence 2 is exemplified using the ROMP polymer and involves first the linking of U shapes (precursor-MLs) to a preformed ROMP polymer, to form a poly-Ushape (multiple precursor-MLs covalently linked together), and then addition of nanotubes, to allow ring-closing on the nanotube, to form the ROMP polymer-coated nanotube. Examples A1-A32 describes the practical enablement of the Sequence 2 approach, as well as its analysis.

Sequence 3C is exemplified using the ROMP polymer and involves first mixing of Ushape carrying a reactive group (Y) with a ROMP monomer carrying a reactive group (X), leading to the reaction of reactive groups (X) and (Y), to form a compound that comprises both a Ushape and a monomer for polymer formation. Then nanotubes are added, to allow simultaneous ring-closing around the nanotube and ROMP polymer formation from the ROMP monomers, to yield ROMP polymer-coated nanotubes. In this set-up, both the ring-closing reaction and polymer formation is a Grubb's 2^{nd} generation catalyst-catalysed reaction that forms double bonds, wherefore polymer formation and ring-closing happens simultaneously, i.e. in one common step. Thus, the protocol is as follows:

Step 1: In a flask pre-dried in an oven at 120° C. for 1 h, a precursor carrying a reactive group Y (e.g. terminal alkyne) is dissolved in dry dimethylformamide (DMF) and a norbornene carrying a terminal reactive group X (e.g. an azide group) dissolved in dry DMF is added.

Step 2: N,N-diisopropylethylamine (DIPEA) is added to the solution.

Step 3: Copper iodide (CuI) is added.

Step 4: The solution mixture is stirred at 60° C. for 12 hours.

Step 5: After this time, dichloromethane and saturated sodium chloride (NaCl) deionized water solutions are added to the solution mixture resulting from step 4.

Step 6: Then, the addition of aqueous ammonia (NH₃) solution (25%) follows and the mixture is left under vigorous stirring for 15 min.

Step 7: Using a separatory funnel, the organic phase is extracted and washed three times with deionized water.

Step 8: The solvent is eliminated under reduced pressure to give the “precursor-ML-ROMP monomer”.

Step 9: In a flask pre-dried in an oven at 120° C. for 1 h, an appropriate amount of carbon nanotubes are dispersed in dry tetrachloroethane (1 mL/mg nanotube) employing bath sonication (10 min).

Step 10: To this mixture, the “precursor-ML-ROMP monomer” obtained in step 9 previously dissolved in dry TCE is added.

Step 11: The mixture is bubbled with nitrogen for 20 min.

Step 12: Grubbs catalyst (2^{nd} or 3^{rd} generation, 1.05 equiv. with respect to the precursor-ML-ROMP monomer) is added.

Step 13: The mixture is stirred at room temperature under inert atmosphere for 72 h with regular pulses of sonication allowing the precursor-ML-ROMP monomer to form a macrocycle around it through ring-closing metathesis and polymerize through ring-opening metathesis polymerization.

Step 14: After this time, the suspension is filtered through a 0.2 μm-pore size polytetrafluoroethylene (PTFE) membrane. The solid obtained is removed from the filter and washed with TCE employing 5 min sonication, and filtered again. This cleaning procedure is repeated three times, until the filtration solvent is colourless, indicating that the unreacted precursor-ML-ROMP monomer and Grubbs catalyst have been removed. The product is dried at 100° C. for 1 h to produce “ROMP polymer-coated nanotubes of Example JJ21, A, sequence 3C”.

Sequence 4 is exemplified using the ROMP polymer and involves first forming the SWNT-ML where the ML carries a polymerization termination functionality. The growing polymer is added and it attaches to the rings through the polymerization termination functionality, such as a single terminal double bond. The final result is a nanotube with rings around it, where the rings are each attached to different polymer chains. Thus, the protocol is as follows:

Step 1: In a flask pre-dried in an oven at 120° C. for 1 h, an appropriate amount of carbon nanotubes are dispersed in dry tetrachloroethane (1 mL/mg nanotube) employing bath sonication (10 min).

Step 2: To this mixture, a “precursor-ML-ROMP polymer terminator” dissolved in dry TCE is added.

Step 3: The mixture is bubbled with nitrogen for 20 min.

Step 4: Grubbs catalyst (2^{nd} or 3^{rd} generation, 1.05 equiv. with respect to the precursor-ML-ROMP terminator) is added.

Step 5: The mixture is stirred at room temperature under inert atmosphere for 72 h with regular sonication allowing the precursor-ML-ROMP terminator to form a macrocycle around the nanotube through ring-closing metathesis.

Step 6: After this time, the suspension is filtered through a 0.2 μm-pore size polytetrafluoroethylene (PTFE) membrane. The solid obtained is removed from the filter and washed with TCE employing 5 min sonication, and filtered again. This cleaning procedure is repeated three times, until the filtration solvent is colourless, indicating that the unreacted precursor-ML-ROMP monomer and Grubbs 2^{nd} generation catalyst have been removed. The product is dried at 100° C. for 1 h to obtain “ROMP polymer-coated nanotubes of Example JJ21, A, sequence 4”.

Step 7: In a flask pre-dried in an oven at 120° C. for 1 h, the obtained “ROMP polymer-coated nanotubes of Example JJ21, A, sequence 4” are dispersed in dry tetrachloroethane (1 mL/mg nanotube) employing bath sonication (10 min).

Step 8: To this mixture, a solution of norbornene monomer in dry TCE is added.

Step 9: Ethyl vinyl ether is added in order to quench the reaction.

Step 10: The resultant suspension is filtered through a 0.2 μm-pore size polytetrafluoroethylene (PTFE) membrane. The solid obtained is removed from the filter and washed with TCE employing 5 min sonication, and filtered again. This cleaning procedure is repeated three times, until the filtration solvent is colourless, indicating that the Grubbs 3^{rd} generation catalyst has been removed.

Step 11: The product is dried at 100° C. for 1 h to produce “ROMP polymer-coated nanotubes of Example JJ21, A, sequence 4”.

Other substituted or unsubstituted 4-membered (e.g. cyclobutene), 5-membered (e.g. cyclopentene), 6-membered (e.g. cyclohexene), 7-membered (e.g. cycloheptene), 8-membered (e.g. cis-cyclooctene (COE) or cis,cis-1,5-cyclooctadiene) and polymembered (e.g. cyclotetradeca-1,8-diene) cyclic hydrocarbons can be used as well as bi- and tri-cyclic unsaturated rings such as dicyclopentadiene (DCPD) in place of the norbornene employed in Step 8, under the same or similar reaction conditions, to provide similar polymer-coated nanotubes. Also, different ruthenium, molybdenum and tungsten-based ROMP catalysts can be employed (e.g. RuCl₃/HCl in combination with a promoting agent such as EtOH or PhOH, Schrock catalyst).

### Example JJ21, B. Different Sequences of Events Leading to Various Polymer-Coated Nanotubes

The six different sequences of events (Sequences 1, 2, 3A, 3B, 3C, and 4) leading to composites, described in Example 0 and depicted in FIG. 119A is in the following exemplified for various polymers and polymerisation reactions, various kind of fillers, various types of ring-closing reactions and various types of polymer-linking reactions.

These processes are depicted in FIGS. 119c to 119H.

Example JJ21, B1: Sequence 4B, reaction is here used to generate polystyrene-coated Tuball SWNTs (from OCSiAl). In this example, we use Sequence 4B of Example 0 (see FIG. 119A), involving a ML carrying a polymerization initiator, to obtain polystyrene-coated Tuball SWNTs. See FIG. 119c.

Step 1: 1 g Tuball SWNTs (from OCSiAl; diameters ranging from 1.3-2.3 nm) are dispersed in dry dimethylformamide (DMF, 1 L, 1 g/L SWNTs/DMF) by sonication in a bath sonicator (10 mins).

Step 2: The dispersion is degassed with N₂ for 30 mins.

Step 3: To this dispersion, a precursor-ML (JJ21.1) (carrying two pyrenes, terminal thiol groups and an AIBN-like polymerization initiator (abbreviated “PI” or “I” in FIG. 119c) (600 mg, 0.7 mmol), triethylamine (TEA, 4.0 equiv. with respect to compound (JJ21.1)) and iodine (0.55 equiv. with respect to compound (JJ21.1)) are added.

Step 4: The mixture is stirred at room temperature for 72 h under inert atmosphere, allowing two precursor-MLs to bind to one SWNT and react to generate two disulfide-bonds, thereby forming a ring structure around a SWNT, resulting in the SWNT-ML complex. Thus, the ring-structure (the ML) is generated by the fusion of two precursor-MLs, thereby forming a circular structure with a diameter large enough to reach around the Tuball tubes with diameters of ˜1.3 nm. For nanotubes of diameter larger than 1.3 nm three or four or more precursor-MLs may react to form rings that are large enough to reach around the nanotube.

Step 5: The suspension is filtered through a 0.2 μm-pore size polytetrafluoroethylene (PTFE) membrane. The solid obtained is removed from the filter and washed with DMF employing 10 min sonication, and filtered again. This cleaning procedure is repeated three times, until the filtration solvent is colourless, indicating that the unreacted precursor-ML, triethylamine and iodine have been removed. A final wash with acetone, dichloromethane and Et₂O is performed and the product is dried at 100° C. for 15 min.

The resulting product is termed “Tuball-ML of Example JJ21, B1”.

Step 6: 1 g “Tuball-ML of Example JJ21, 1” is dispersed in toluene (1 L, 1 g/L) by sonication in a bath sonicator (10 mins.).

Step 7: To this dispersion, an appropriate amount of styrene (such as 1 mM, 10 mM, or 100 mM) is added.

Step 8: The suspension is incubated at 50-70° C. for 6 h or irradiated with 350 nm light for 45 min. to form polystyrene attached to the Tuball-ML of Example JJ21, 1 through reaction with the AIBN-like polymerization initiator.

Step 9: Optionally, an appropriate concentration of a chain-terminating agent such as cupferron is added.

Step 10: The final suspensions are poured into methanol under stirring, to obtain polystyrene-coated Tuball SWNT. The polystyrene-coated Tuball SWNT are filtered off and dried at 50° C.

The obtained product is called “Polystyrene-coated Tuball SWNT of Example JJ21, B1”.

If longer or shorter polymers, or polymers of different kinds are desired, these may be obtained by changing the conditions in specific steps, as follows.
If in step 7 propylene, ethylene, or vinylchloride is added instead of styrene, then polypropylene, polyethylene or polyvinylchloride, respectively, will be formed instead of polystyrene.
If in step 9 a chain terminator is added the polymers will become shorter; the earlier the chain terminator is added, and the larger the amount of chain terminator that is added, the shorter the polymers will become.
If in step 9 a chain terminator is not added, the polymer may terminate via: a) consumption of all monomer units, b) combination of the radical in a polymer chain with a radical from another polymer attached to another macrocycle attached to the same nanotube, or c) combination of the radical in a polymer chain with a radical from a polymer attached to another macrocycle on a different nanotube. See FIG. 119c.
If in step 3 the amount of precursor-ML (carrying a polymerization initiator) added is changed, the average length of the polymers will change. Thus, the average length of the polymer can be controlled to give polymers of approximately 10, 100, 1.000, 10.000, or 100.000 units, by varying the amount of precursor-ML added. A smaller number of MLs (and thus a smaller number of polymerization initiators) results in longer polymers.
If in step 7 the concentration of monomer is changed, the average polymer length may change. Thus, a higher monomer concentration in step 7 may lead to longer polymers; lower concentration of monomer may result in shorter polymers.
If in step 8 the polymerization temperature is changed, the polymerization rate will change and therefore the average length of the polymers may change.

Example JJ21, B2: Sequence 2, reaction used to generate polyamide-coated SWNTs. In this example, we use sequence 2 from Example 0 (see FIG. 119A) to obtain polyamide-coated SWNTs generated by the attachment of a preformed poly-Ushape around the nanotube to form rings. See FIG. 119D.

Step 1: Poly(alanine-alanine-hydroxyproline) (500 mg, 0.05 mmol, aprox. MW=10.000) is dissolved in dry dimethylformamide (DMF, 75 mL). To this solution, K₂CO₃ (262 mg, 3.8 mmol) and a catalytic amount of KI is added.

Step 2: The precursor-ML (compound JJ21.2, carrying two naphthalenediimide units and a terminal OTs group) (2.0 g, 1.9 mmol) dissolved in dry DMF (75 mL) is added.

Step 3: The solution is stirred at 80° C. overnight.

Step 4: After this time, the crude reaction is poured into ice-cold 1 M HCl and filtrated. The filtered product is washed with MeOH and Et₂O to afford the corresponding polyU-Shape (compound JJ21.3).

Step 5: 1 g SWNTs is dispersed in tetrachloroethane (TCE, 1 L, 1 g/L SWNTs/TCE) by sonication in a bath sonicator (10 mins).

Step 6: The dispersion is degassed with N₂ for 30 mins.

Step 7: To this dispersion, the polyU-shape JJ21.3 (500 mg, 0.01 mmol) and Grubbs 2^{nd} generation catalyst (314 mg, 0.37 mmol) are added.

Step 8: The mixture is stirred under N₂ at room temperature for 72 h, optionally with regular sonication.

Step 9: After this time, the suspension is filtered through a 0.2 μm-pore size polytetrafluoroethylene (PTFE) membrane. The solid obtained is removed from the filter and washed with TCE and dichloromethane employing 10 min sonication, and filtered again. This cleaning procedure is repeated three times, until the filtration solvent is nearly colourless. A final wash with Et₂O is performed and the product is dried at 100° C. for 15 min. The product is termed “Polyamide-coated SWNTs of Example JJ21, B2”.

Polyamides of different kinds can be employed by changing the conditions in specific steps, as follows.
In step 1, any polyamide amino acid derivative, capable of reacting with the OTs group of JJ21.3, can be added instead of Poly(alanine-alanine-hydroxyproline) (e.g. poly(phenylalanine-leucine-hydroxyproline)).
A precursor-ML with a different recognition motif for CNT (e.g. pyrene, anthraquinone, extended tetrathiafulvalene) may be used.
If in step 2 the amount of precursor-ML is reduced the corresponding polyU-Shape may have less precursor-MLs per unit and therefore the final polyamide-coated SWNTs may have fewer mechanical bonds between polymer and SWNT.
In step 5 a different nanotube may be employed (e.g. boron nitride nanotubes or metallic nanotubes).

Example JJ21, B3: Sequence 3A, reaction used to generate polyurethane-coated Tuball SWNTs: In this example, we use sequence 3A from Example 0 (see FIG. 119A) to obtain polyurethane-coated Tuball SWNTs, generated by first the adsorption of a preformed Ushape-monomer molecule to the Tuball SWNTs, second the closing of the U shapes to form rings and third the final polymerization of the monomer units. See FIG. 119E.

Step 1: 1 g Tuball SWNTs (diameters ranging from 1.3-2.3 nm) are dispersed in tetrachloroethane (TCE, 1 L, 1 g/L SWNTs/TCE) by sonication in a bath sonicator (10 mins).

Step 2: To this dispersion, the Ushape-monomer JJ21.4 (905 mg, 0.7 mmol) is added.

Step 3: The dispersion is degassed with N₂ for 30 mins.

Step 4: Then, Grubbs 2^{nd} generation catalyst (594 mg, 0.7 mmol) is added.

Step 5: The mixture is stirred under N₂ at room temperature for 72 h, optionally with regular pulses of sonication, to mediate formation of a ring-structure around the nanotube from the fusion of 1, 2, 3, 4, 5 or more precursor-MLs.

Step 6: After this time, the suspension is filtered through a 0.2 μm-pore size polytetrafluoroethylene (PTFE) membrane. The solid obtained is removed from the filter and washed with TCE and dichloromethane employing 10 min sonication, and filtered again. This cleaning procedure is repeated three times, until the filtration solvent is nearly colourless. A final wash with Et₂O is performed and the product is dried in air for three days to afford the Tuball-ML-monomer.

Step 7: 1 g Tuball-ML-monomer is dispersed in anhydrous chlorobenzene (500 mL, 2 g/L SWNTs/chlorobenzene) by sonication in a bath sonicator (10 mins).

Step 8: Butanediol (1 equiv. with respect to the ML-monomer) is added to the mixture.

Step 9: Optionally, dibutyltin dilaurate (DBTDL, catalyst, 0.03 wt %) is added to the mixture.

Step 10: The flask is fitted with stirrer, thermometer, reflux condenser with drying tube and nitrogen inlet.

Step 11: The air is removed and replaced for nitrogen, and optionally sonication performed regularly.

Step 12: The mixture is heated carefully at 95° C. under a slow stream of nitrogen.

Step 13: The reaction is stirred for several hours until no —NCO signals are observed in infrared spectroscopy.

Step 14: After cooling, the polyurethane-coated tuball SWNTs are isolated by vacuum filtration. The product is called “Polyurethane-coated nanotubes of Example JJ21-B3”.

This methodology can be modified as follows.
In step 7, different solvents can be employed (e.g: N-methyl-2-pyrrolidone (NMP), dimethylformamide (DMF) and mixtures of NMP with DMF, toluene, and ethyl acetate).
In step 8, different diols, triols (e.g. natural castor oil) and polyols can be added, therefore obtaining different final polyurethanes. Some examples are polybutadiene diols for the obtention of elastomers, polyester polyols (e.g. polyethylene adipate) or polyether polyols (e.g. polyethylene glycol).
In step 9, different catalysts can be added (e.g. DABCO) or the reaction can proceed in the absence of catalyst.

Example JJ21, B4: Sequence 3B, reaction used to generate polyvinylchloride-coated boron nitride nanotubes: In this example, we use sequence 3B from Example 0 to obtain polyvinylchloride-coated boron nitride nanotubes generated by first the adsorption of a preformed Ushape-monomer molecule to the boron nitride nanotubes, second the polymerization of the monomer units while immobilized on the nanotube and third the closing of the U shapes to form rings. See FIG. 119F.

Step 1: 1 g boron nitride nanotubes (BNNTs) are dispersed in tetrahydrofurane (THF, 1 L, 1 g/L BNNTs/THF) by 10 minutes sonication in a bath sonicator.

Step 2: To this dispersion, a precursor-ML-monomer (JJ21.5, 1 g, 0.9 mmol) is added.

Step 3: The dispersion is degassed with N₂ for 30 mins.

Step 4: The suspension is left stirring for a few hours.

Step 5: An initiator, such as azobis(isobutyronitrile) (0.015-0.1% with respect to the precursor-ML-monomer) is added to the mixture.

Step 6: Reaction is stirred at 60° C. for 3 h, with optional pulses of sonication.

Step 7: The residual vinyl chloride monomers and initiator are removed under vacuum employing a rotary evaporator.

Step 8: The obtained solid is redispersed in THF employing a bath sonicator (10 mins).

Step 9: The dispersion is degassed with N₂ for 30 mins.

Step 10: TiCl₄ (1.5 equiv. with respect to the precursor-ML-monomer JJ21.5) is added and the mixture cooled down to −10° C.

Step 11: To this dispersion, a suspension of zinc powder (2 equiv. with respect to TiCl₄) in THF is added.

Step 12: The reaction is stirred for 2 h at 0° C. and a 10% solution of potassium carbonate is added.

Step 13: After this time, the suspension is filtered through a 0.2 μm-pore size polytetrafluoroethylene (PTFE) membrane. The solid obtained is removed from the filter and washed with THF employing 10 min sonication, and filtered again. This cleaning procedure is repeated three times, until the filtration solvent is nearly colourless. A final wash with Et₂O is performed and the product is dried in air for three days to afford the polyvinylchloride-coated boron nitride nanotubes. The final product is called “PVC-coated SWNTs of Example JJ21-B4”.

This methodology can be modified as follows.
In step 5, different initiators can be employed (e.g: t-butyl peroctoate, diisopropyl peroxydicarbonate or dibenzoyl peroxide).
The double bond formed upon ring-closing can be reduced to a single bond by e.g. hydrogenation.

Example JJ21, B5: Sequence 3C, reaction used to generate epoxy-coated DWNTs: In this example, we use sequence 3C from Example 0 (see FIG. 119A) to obtain epoxy-coated double-walled carbon nanotubes. For this, first a U-shape (mechanical ligand) carrying two epoxy moieties is mixed with the nanotubes and second the ring-closing around the nanotube and epoxy polymer formation is simultaneously performed. In this set-up, both the ring-closing reaction and polymer formation are triggered by the addition of an amine (curing agent) that acts as crosslinker. Ring formation involves the covalent linkage of several U shapes, e.g. 3, 4, 5, 6, 7, or 8 U shapes, in order to reach around the DWNT. See FIG. 119G.

Step 1: 1 g double-wall carbon nanotubes (DWNTs) with approximate diameter of approximately 5 nm is dispersed in dimethylformamide (DMF, 1 L, 1 g/L DWNTs/DMF) by sonication in a bath sonicator (10 mins).

Step 2: To this dispersion, the precursor-ML-monomer (JJ21.6, 1 g, 0.7 mmol) is added.

Step 3: The dispersion is degassed with N₂ for 30 mins.

Step 4: A curing agent, such as p-xylylenediamine (95 mg, 0.7 mmol) is added to the mixture.

Step 5: Reaction is stirred at 50° C. for 16 h, optionally with regular pulses of sonication.

Step 6: After this time, the suspension is filtered through a 0.2 μm-pore size polytetrafluoroethylene (PTFE) membrane. The solid obtained is removed from the filter and washed with DMF employing 10 min sonication, and filtered again. This cleaning procedure is repeated three times, until the filtration solvent is nearly colourless. A final wash with Et₂O is performed and the product is dried in an oven at 150° C. for 2 h to afford the epoxy-coated double-wall carbon nanotubes. The product is called “Epoxy-coated DWNTs of Example JJ21, B5”.

This methodology can be modified as follows.
In step 4, different curing agents can be employed (e.g: aliphatic polyamines such as diehylenetriamine and isophoronediamine or aromatic amines such as diaminodiphenylmethane).
In step 5, depending on the curing agent employed, the reaction temperature can be varied from less than room temperature to more than 200° C.

Example JJ21, B6: Sequence 4A, reaction used to generate polypropylene-coated SWNTs: In this example, we use sequence 4A from Example 0 to obtain polypropylene-coated SWNTs. Polypropylene is generated in suspension and the SWNT-ML carrying a polymerization terminator fragment is added when the length of the polymer is adequate. See FIG. 119H.

Step 1: A 250 mL flask equipped with a mixing blade, a gas inlet and a thermometer is flushed with argon.

Step 2: 90 ml of highly dried toluene are added through the thermometer inlet.

Step 3: 5 ml of a 10% methylalumoxane (MAO) solution are added followed by 5 mL of a solution of rac-ethylene-bis(4,4,5,5′,6,6′,7,7-tetrahydro-1,1′-indenyl)zirconium dichloride (CAS Number 100163-29-9).

Step 4: The setup is evacuated until the vapor pressure of toluene is reached.

Step 5: Dry propylene is passed until normal pressure.

Step 6: The mixture is stirred for 1 h.

Step 7: 100 mL of a JJ21.7 (SWNT-ML-Polymerization Terminator)-dispersion in toluene (1 g/L JJ21.7/Toluene) is added though the thermometer inlet. (JJ21.7 is synthesised by reacting the precursor-ML JJ21.8 and SWNT, following steps 1-6 of Example JJ21, B3, where JJ21.4 has been replaced by JJ21.8 but all other conditions are kept the same).

Step 8: The mixture is stirred for 30 min.

Step 9: 10 mL ethanol is slowly added.

Step 10: The crude is added over ethanol.

Step 11: The MAO and zirconium residues are removed by the addition of 10% HCl solution and 1 h stirring.

Step 12: The polypropylene-coated SWNTs are obtained through filtration over a Buchner funnel, washing with ethanol and drying in vacuum at 50° C. The final product is called “Polypropylene-coated SWNTs of Example JJ21, B6”

Modifications to this Example:
By adding ethylene instead of propylene in Step 5, polyethylene may be generated instead in this step. The final product of step 12 is then called “Polyethylene-coated SWNTs of Example JJ21, B6”.

### Example JJ22. Different Reactions for Anchoring SWNTs-ML Complexes in the Matrix

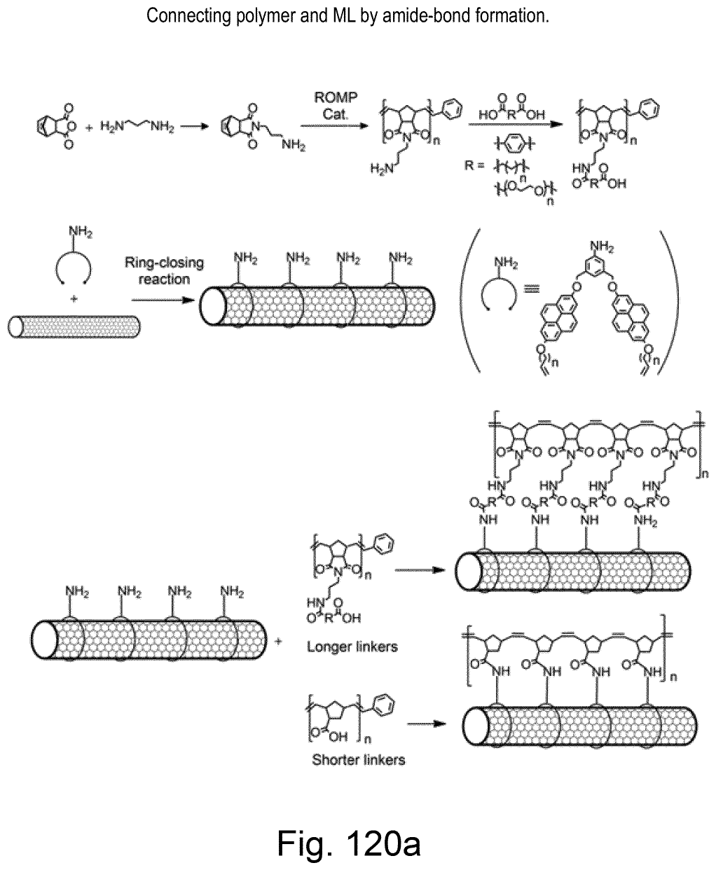

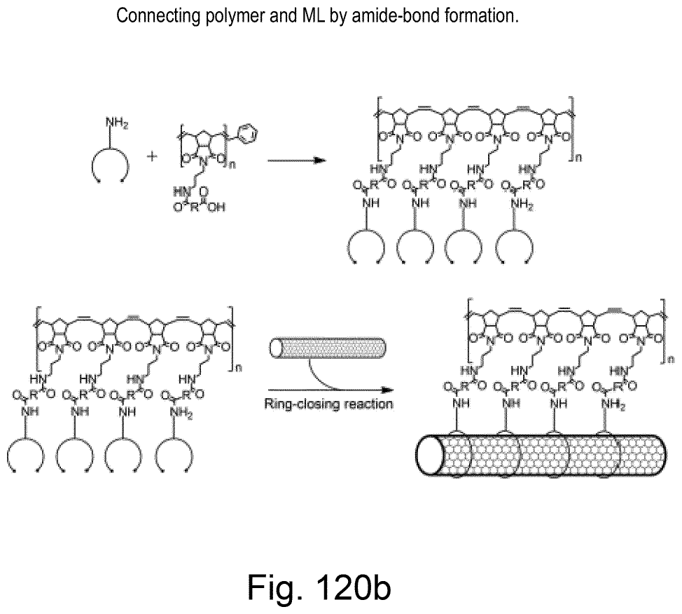

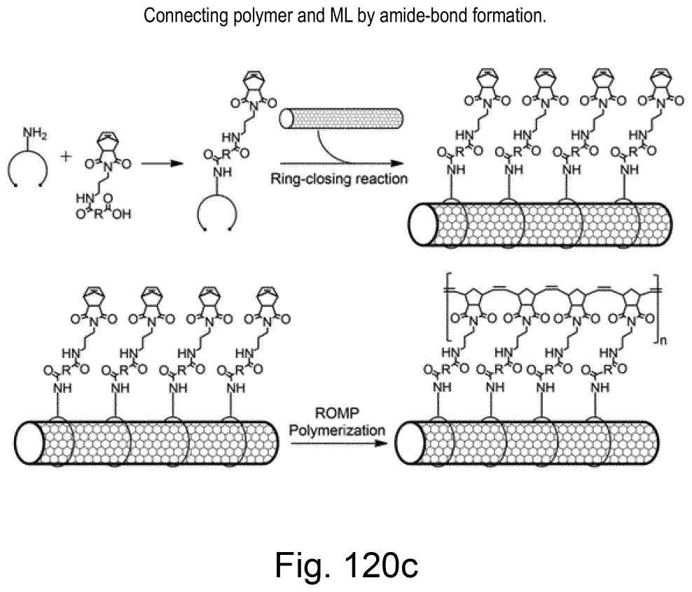

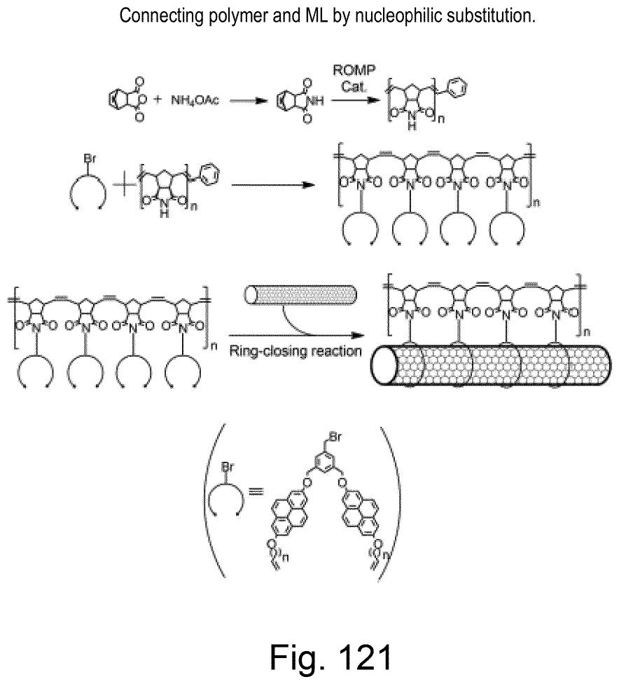

In this example, different chemical reactions for the connection of the polymer or the monomeric unit to the ML-precursor or the ML are described. See FIGS. 120A, 120B, 120C, and 121.

### A. Connecting Polymer and ML by Amide-Bond Formation.

Here, the final link between SWNT-ML and the polymer is obtained through amide-bond forming reactions. These reactions can take place preferentially between an activated carboxylic acid or derivates (e.g. esters, anhydrides) and an amine. In the following examples ROMP polymer is used, but any polymer or other matrix molecule may be used.

The ROMP-monomer can be derivatized in different ways to comprise carboxylic acids that will later react with an amine located in the precursor-ML or ML. Employing simple chemical transformations, the length of the linker connecting ROMP Polymer and SWNT-ML can be made longer or shorter, as desired. One example is shown in FIGS. 120a-c.

For example, if the SWNT-ML complex and the ROMP polymer is generated separately first, then they can be coupled through an amide-bond forming reaction, as shown in FIG. 120A. Here, the monomer that will later polymerize to form the ROMP polymer, is modified to comprise a carboxylic acid, and the precursor-ML is modified to comprise an amino group. Upon reaction of the amine and the carboxylic acid, an amide bond is formed now linking the precursor-ML and the ROMP polymer. Also shown in the FIGS. 120A to 120C is different types of linker length inserted between the ROMP polymer and the ML attached to the SWNT.

### B. Connecting Polymer and ML by Nucleophilic Substitution.

If ROMP Polymer is modified to comprise a succinimide group, as depicted in FIG. 121, these succinimide-derived ROMP Polymers can directly react with precursor-MLs through nucleophilic substitution, thereby connecting the polymer and the ML, as depicted in FIG. 121.

### Example JJ23: Has been Deleted

### Example JJ24. Modification or Crosslinking of ROMP Polymer-Coated Nanotubes

In this example, different strategies for the modification or crosslinking of ROMP polymer-coated nanotubes are described. The ROMP polymer-coated nanotubes comprise double bonds, and these double bonds can be used for modification or crosslinking of ROMP polymer-coated nanotubes. The final products are nanocomposites with high loadings of nanotubes. When desired, the modification or crosslinking can be effectuated, by e.g. UV-irradiation, heating, or other activation or hardening, after the material has been placed in a mold. In some cases this is beneficial because the solution is too viscous to be brought efficiently into the mold. This is a general principle that may be applied to solutions with high viscosity.

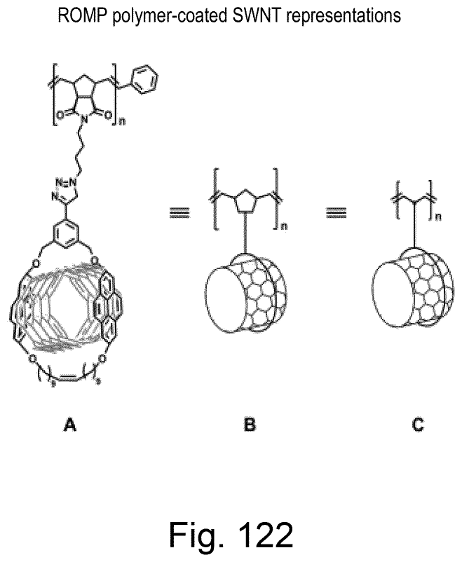

In FIG. 122 the structure of the ROMP polymer-coated SWNT is shown. In (A), most of the atoms in the polymer and ring structures are shown; (B) and (C) represent simplified representations of the same structure.

The starting point in all of the reactions of this example is “Solution of ROMP polymer-coated SWNT of Example A20”, or an up-scaled version of this solution. Such up-scaling may be done by e.g. performing an appropriate number of parallel experiments identical to the one that generated “Solution of ROMP polymer-coated SWNT of Example A20”, or doing all reactions at higher volumes but same concentrations. The solution comprises approximately 60% SWNT and approximately 40% ROMP polymer and closed rings (closed around the SWNTs) in TCE (see Example A20). The analyses performed on the solution and the process generating it (see Examples A1-A32) showed that the majority of SWNTs were heavily coated with ROMP polymer, and also, little or no aggregates of SWNT without polymer were detected.

Because of the abundance of rings on the SWNTs in this Example, and because of the short length of the ROMP polymer that was attached to the rings (average length of ROMP polymer was 21 monomer units, see Example A5), the ROMP polymer coating of the SWNTs may be considered a sizing layer, and the sized nanotube may as a whole be considered a filler, prepared for polymer attachment or crosslinking to other fillers.

By exploiting the double bonds of the ROMP polymer that is coated on the surface of the SWNTs, the ROMP-coated SWNTs can be modified (by linking a molecule or polymer to one such double bond), or can be crosslinked to other SWNTs (by attaching a linker molecule or a polymer to at least two such double bonds, carried by separate SWNTs). The attachment of each of the molecules or polymers to one double bond results in ROMP Polymer-coated SWNTs further carrying multiple molecules or polymers, similar to thermoplastics, whereas the attachment of each of the (linker) molecules or polymers to two double bonds on two separate nanotubes results in an extensive network of efficiently crosslinked SWNTs, thus similar to a thermoset.

A 100-fold up-scaling of the preparation of “Solution of ROMP polymer-coated SWNT of Example A20” is done e.g. by performing the same reactions in 100-fold larger volumes, or by performing the same reactions in 100 parallel experiments, and finally pooling the resulting 100 resulting solutions. The 100-fold up-scaled product is termed “100× upscaled solution of ROMP Polymer-coated SWNTs of Example JJ24”.

A 1000-fold up-scaling of the preparation of “Solution of ROMP polymer-coated SWNT of Example A20” is done e.g. by performing the same reactions in 1000-fold larger volumes, or by performing the same reactions in 1000 parallel experiments, and finally pooling the resulting 1000 resulting solutions. The 1000-fold up-scaled product is termed “1000× upscaled solution of ROMP Polymer-coated SWNTs of Example JJ24”.

Several different strategies for the attachment of a polymer molecule to a double bond of the ROMP polymer-coated nanotubes, or for the crosslinking of two or more nanotubes via a linker comprising two reactive groups capable of reacting with double bonds, are described below, including coordination polymerization (including metathesis and Ziegler-Natta catalytic polymerization), radical polymerization and ionic polymerization, all of which lead to either thermoplastic-like composite materials or thermoset-like composite materials.

### Example JJ24, A: Coordination Polymerization as a Means for Attaching a Polymer or a Crosslinker to the Double Bond(s) of the ROMP Polymer-Coated Nanotubes

Coordination polymerization, in the form of metathesis of double bonds (Example JJ24, A-1), or Ziegler-Natta catalytic polymerization (Example JJ24, A-2), is described below.

### Example JJ24, A-1: Metathesis of Double Bonds, Leading to Attachment of Polymers to the ROMP Polymer-Coated Nanotubes or Leading to Crosslinking of the ROMP Polymer-Coated Nanotubes

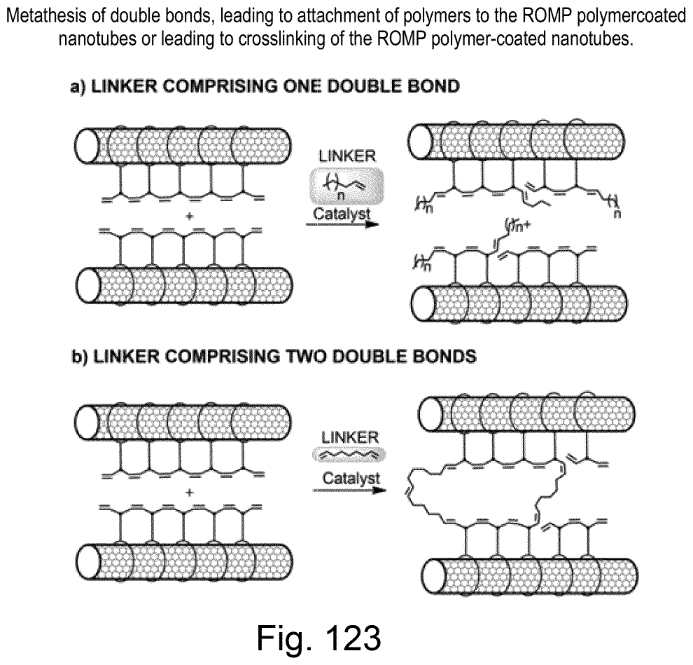

In this example, compounds comprising one or more double bonds are added to the solution comprising ROMP Polymer-coated SWNTs. By way of a metathesis reaction between the double bond(s) of the ROMP polymer-coated SWNTs and the double bond(s) of the linker, or polymer, a modification or crosslinking of the ROMP polymer-coated SWNT will be effectuated. See FIG. 123.

If the linker comprises one double bond and a long polymeric entity, the metathesis reaction will attach said long polymeric entity to the closed ring around the nanotube, but it will not crosslink two rings complexed with two separate nanotubes.

If the linker comprises two or more double bonds, the metathesis reactions may lead to the crosslinking of two or more rings. The rings may be closed around the same nanotube, in which case the reactions will not lead to crosslinking of two separate nanotubes; or the rings may be on separate nanotubes, in which case two separate nanotubes will be crosslinked. A long linker will typically have a higher likelihood of crosslinking separate nanotubes than a short linker, but a long linker will lead to a less rigid crosslinking network. By varying the length, composition, and concentration of the added linker, the structure and characteristics of the composite material can be tuned.

In FIG. 123, a) a general example of metathesis with a linker comprising one double bond is shown.

In FIG. 123, b) a general example of the crosslinking of two ROMP polymer-coated nanotubes is shown. A linker comprising two double bonds is added to ROMP polymer-coated nanotubes, and by way of metathesis reaction, the ROMP-backbone attached to one nanotube is connected to another ROMP-backbone attached to a different nanotube, thereby crosslinking the two separate nanotubes.

In order to create a denser crosslinking network, the linker that is added to the sized nanotubes may comprise more than two double bonds, such as 3, 4, 5, 6, 7, 8, 9, 10 or more double bonds.

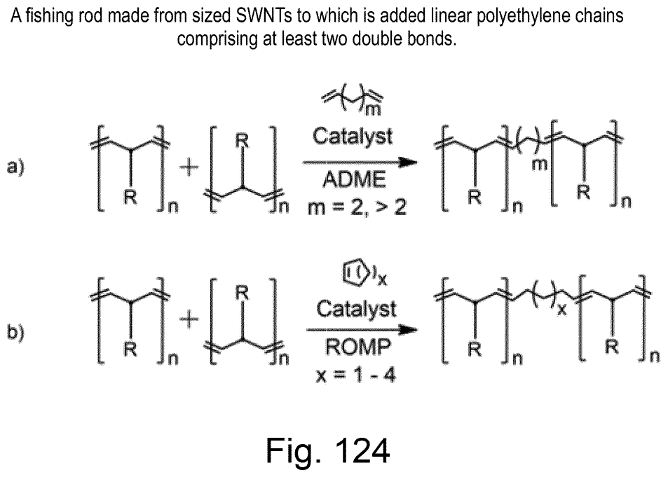

### Example JJ24, A-1.1: A Fishing Rod Made from Sized SWNTs to which is Added Linear Polyethylene Chains Comprising at Least Two Double Bonds. See FIG. 124

Step 1. 1 litre of “1000× upscaled solution of ROMP Polymer-coated SWNTs of Example JJ24” is mixed with 10⁻⁵ mM butadiene.

Step 2: The mixture is sonicated in a bath sonicator for 10 mins.

Step 3: The dispersion is degassed with N₂ for 30 mins.

Step 4: To this dispersion, Grubbs 2^{nd} generation catalyst (10⁻⁶ mM) is added.

Step 5: The reaction is stirred for 2 h.

Step 6: The mixture is transferred to a dialysis tubing cellulose membrane (2-500 mL) and Grubbs 2^{nd} generation catalyst is removed by dialysis employing tetrachloroethane as solvent. The resulting material is called “Butadiene-crosslinked ROMP polymer-coated SWNTs”.

Step 7: The “Butadiene-crosslinked ROMP polymer-coated SWNTs” contained in the cellulose membrane is poured into a mould with the shape of a fishing rod and solvent is evaporated.

Step 8: After cooling, the fishing rod is released from the mould.

See FIG. 124 for a description of general reactions that lead to the crosslinking of two separate nanotubes.

In FIG. 124, ADME stands for acyclic diene metathesis and ROMP for ring opening metathesis reaction. Ruthenium-based and molybdenum-based catalysts can be employed for both types of metathesis reactions (e.g. Grubbs 1^{st}, 2^{nd}, 3^{rd} generation catalysts, Schrock catalyst or the Hoveyda-Grubbs catalyst).

Other linear linkers, carrying two or more carbon bonds, and that could have been used in the acyclic diene metathesis reaction as well, include 1,5-hexadiene, 1,6-heptadiene, 1,7-octadiene, 1,8-nonadiene, 1,9-decadiene, longer dienes or even polymers such as unsaturated polyethylene. Other cyclic linker reagents, used in the ring-opening metathesis reaction, include substituted or unsubstituted 4-membered (e.g. cyclobutene), 5-membered (e.g. cyclopentene), 6-membered (e.g. cyclohexene), 7-membered (e.g. cycloheptene), 8-membered (e.g. cis-cyclooctene (COE) or cis,cis-1,5-cyclooctadiene) and polymembered (e.g. cyclotetradeca-1,8-diene) cyclic hydrocarbons as well as bi- and tri-cyclic unsaturated rings such as norbornene or dicyclopentadiene (DCPD).

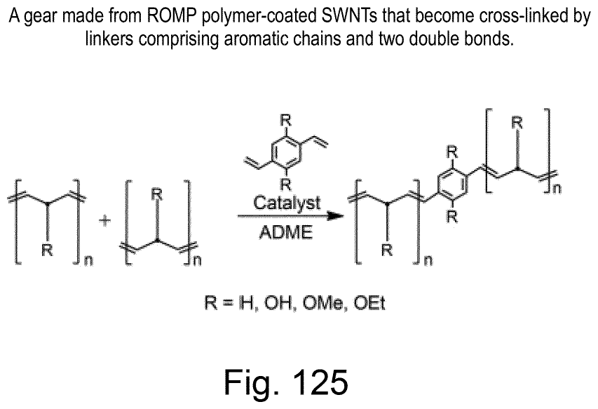

JJ24, A-1.2. A Gear Made from ROMP Polymer-Coated SWNTs that Become Cross-Linked by Linkers Comprising Aromatic Chains and Two Double Bonds. See FIG. 125.

Step 1: 5 litres of “100× upscaled solution of ROMP Polymer-coated SWNTs of Example JJ24” are mixed with 10⁻⁵ mM 1,4-diethenylbenzene, which carries an aromatic ring and two double bonds.

Step 2: The mixture is sonicated in a bath sonicator for 10 mins.

Step 3: The dispersion is degassed with N₂ for 30 mins.

Step 4: To this dispersion, Grubbs 2^{nd} generation catalyst (10⁻⁶ mM) is added.

Step 5: The reaction is stirred for 2 h.

Step 6: The mixture is transferred to a dialysis tubing cellulose membrane (10-500 mL) and Grubbs 2^{nd} generation catalyst is removed by dialysis employing toluene as solvent. The resulting material is called “1,4-diethenylbenzene-crosslinked ROMP polymer-coated SWNTs”.

Step 7: The “1,4-diethenylbenzene-crosslinked ROMP polymer-coated SWNTs” contained in the cellulose membrane is poured into a mould with the shape of a gear and solvent is evaporated.

Step 8: After cooling, the gear is released from the mould.

See FIG. 125 for a description of the general reaction that leads to the crosslinking of separate nanotubes.

ADME stands for acyclic diene metathesis. Ruthenium-based and molybdenum-based catalysts can be employed (e.g. Grubbs 1^{st}, 2^{nd}, 3^{rd} generation catalysts, Schrock catalyst or the Hoveyda-Grubbs catalyst).

The two double bonds of 1,4-diethenylbenzene are placed on each side of the relatively rigid aromatic scaffold, wherefore the two double bonds are more likely to react with double bonds on separate nanotubes than if they were separated by a less rigid structure.

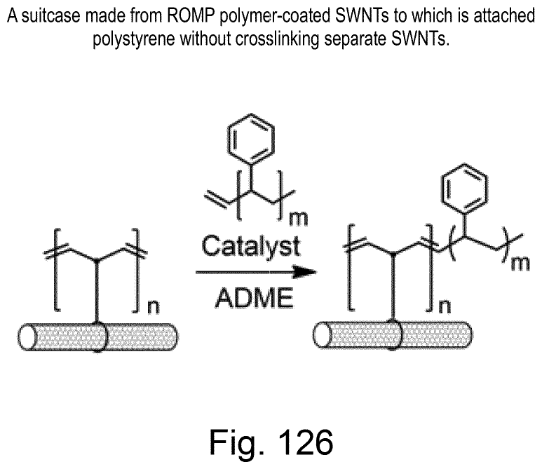

JJ24, A-1.3. A Suitcase Made from ROMP Polymer-Coated SWNTs to which is Attached Polystyrene without Crosslinking Separate SWNTs. See FIG. 126

For this example, polystyrene with only one terminal double bond is employed.

Step 1: 1 litre of “100× upscaled solution of ROMP Polymer-coated SWNTs of Example JJ24” is mixed with polystyrene with one terminal double bond (average molecular weight 5.000 D).

Step 2: The mixture is sonicated in a bath sonicator for 10 mins.

Step 3: The dispersion is degassed with N₂ for 30 mins.

Step 4: To this dispersion, Grubbs 2^{nd} generation catalyst (10⁻⁶ mM) is added.

Step 5: The reaction is stirred for 2 h.

Step 6: Solvent is evaporated using a rotary evaporator.

Step 7: Tetrahydrofuran is added and the suspension is sonicated for 5 min.

Step 8: The dispersion is centrifuged and the supernatant is removed. The final product is called “Polystyrene-ROMP polymer-coated SWNTs”.

Step 9: The obtained polystyrene-ROMP polymer-coated SWNTs are dispersed in dimethylformamide.

Step 10: The dispersion is poured into a mould with the shape of a suitcase.

Step 11: Solvent is removed upon heating.

Step 12: After cooling, the final product is released from the mould.

See FIG. 126 for a description of the general reaction for the obtention of polystyrene-ROMP polymer-coated SWNTs.

### JJ24, A-1.4. Introduction of Functional Groups, by Using Linkers Carrying the Desired Functionalities.

Any of the linkers employed in this Example JJ24 can be designed to further include various functionalities, carried in the main chain of the linker or as pendant groups. Two examples of such linker-introduced modifications are shown below, where ethyleneglycol or amino acids are introduced.

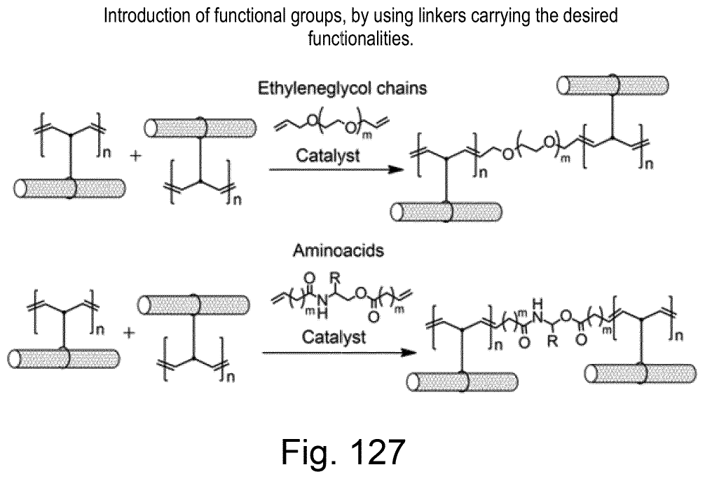

For the introduction of ethyleneglycol chains, linkers carrying terminal double bonds and a central polyethyleneglycol unit (see FIG. 127) may be used to crosslink ROMP polymer-coated SWNT. The procedure will be similar as in Example JJ24, A-1.1 but in Step 1 a polyethylene glycol chain carrying two terminal double bonds (e.g., 1,2-Di(allyloxy)ethane) will be employed instead of butadiene.

Likewise, for the introduction of an amino acid, linkers carrying terminal double bonds and a central amino acid (see FIG. 127) may be used to crosslink ROMP polymer-coated SWNT.

The procedure will be similar as in Example JJ24, A-1.1 but in Step 1 an amino acid carrying two terminal double bonds will be employed instead of butadiene.

Also, norbornene derivatives can be used to introduce any functionality. For example, the 5-norbornene-2-acetic acid succinimidyl ester, carrying a terminal succinimide, can react with the ROMP Polymer-coated SWNTs through an ADME reaction.

See FIG. 127.

### Example JJ24, A-2: A Roofing Membrane Made from ROMP Polymer-Coated SWNTs to which is Added Polypropylene by a Ziegler-Natta Catalytic Polymerization

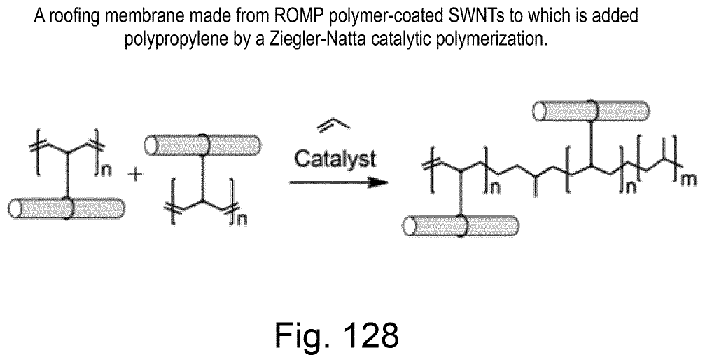

In this example, propylene is added to the solution comprising ROMP Polymer-coated SWNTs. By way of a Ziegler-Natta catalytic polymerization, the propylene units will polymerize and attach to the edges of the ROMP Polymer-coated SWNTs, containing double bonds. In this case, due to the nature of the Ziegler-Natta polymerization mechanism, only the terminal alkenes of the ROMP Polymer-coated SWNTs will be functionalized. See FIG. 128.

Step 1: A 1 L flask equipped with a mixing blade, a gas inlet and a thermometer is flushed with argon.

Step 2: 480 mL of dry “100× upscaled solution of ROMP Polymer-coated SWNTs of Example JJ24” are added.

Step 3: The flask is heated to 60° C. and the solution is saturated with propylene while stirring.

Step 4: 1.3 mL of diethylaluminum chloride solution and 1 g of TiCl₃-1/3 AlCl₃ are added through the thermometer neck.

Step 5: The flow of propylene is adjusted.

Step 6: The mixture is stirred for 2 h at 60° C.

Step 7: 20 mL 2-propanol are added and the mixture is stirred for 30 min at 60° C.

Step 8: The polypropylene-ROMP polymer-coated SWNTs are obtained through filtration over a Büchner funnel, washing with warm petroleum ether and drying in vacuum at 70° C.

Step 9: The obtained polypropylene-ROMP polymer-coated SWNTs is melt-extruded to give roofing membranes of different thickness.

### Modifications:

In step 9, different additives, such as fire retardants may be added.

See FIG. 128 for a description of the general reaction for obtaining polypropylene-ROMP polymer-coated SWNTs.

### Example JJ24, B: Radical Reactions as a Means for Attaching a Polymer or a Crosslinker to the Double Bond of the ROMP Polymer in the Sized Nanotubes

### Example JJ24, B-1.1: A Fishing Line Made from Sized SWNTs to which is Added Polystyrene Chains Comprising One Thiol, as Well as Polystyrene Chains not Carrying any Thiols that can React with Double Bonds, and where the Majority of the Polystyrene Chains do not Become Covalently Linked to the Sized SWNT Until after Processing (Here Extrusion)

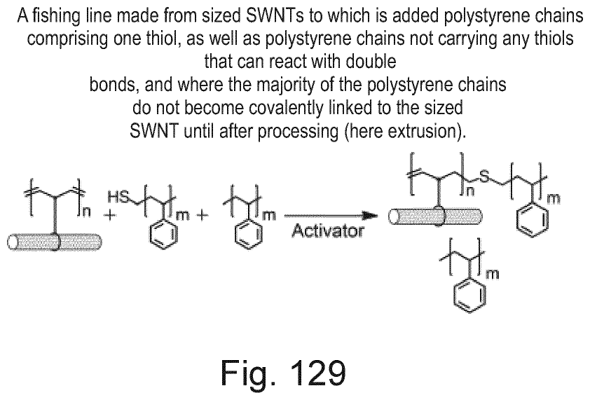

In this example, the sized SWNTs are employed as fillers in polystyrene composites. Several situations are contemplated depending on whether or not the polystyrene chains are covalently linked to the sized SWNTs. For the covalent attachment, a radical reaction takes place between the sized SWNTs and the polystyrene bearing thiol groups. This attachment is produced in the last step of the fishing line processing. See FIG. 129.

Step 1: 500 mL of “100× upscaled solution of ROMP Polymer-coated SWNTs of Example JJ24” is added to each of 5 flasks (Flask 1-5) to which is added polystyrene molecules of on average 1000 monomer units and carrying one thiol group capable of reacting with double bonds, and polystyrene molecules of on average 1000 monomer units not carrying any thiol groups capable of reacting with double bonds, to reach the final concentrations of the final fishing line shown in the table below.

Step 2: AIBN or benzoyl peroxide are added (0.01 equiv. with respect to the polystyrene carrying one thiol group).

Step 3: Solvent is removed by filtration.

Step 4: The “Polystyrene-ROMP polymer-coated SWNTs” is melted and extruded to make a fishing line of 0.1 mm. During the extrusion process, the radical initiators are activated and promote the reaction between the thiols from the polystyrene molecules and the double bonds in the sized SWNTs.

Step 5: The fishing line is cooled down.

Step 6: Optionally, the fishing line is coated with a silicone copolymer.

Step 7: The fishing line is finally spun into spools.

See FIG. 129.

The following table lists the final concentration in the fishing line of polystyrene carrying a reactive group and polystyrene not carrying any reactive group:

| | PS with one | PS without |
|---|---|---|
| | terminal thiol group | terminal thiol groups |
| Flask 1 | 0% | 80% |
| Flask 2 | 20% | 60% |
| Flask 3 | 40% | 40% |
| Flask 4 | 60% | 20% |
| Flask 5 | 80% | 0% |

Three other preparations of a fishing line are also carried out using, respectively, 1000-fold less, 100 fold less, and 10 fold less of “100× upscaled solution of ROMP Polymer-coated SWNTs of Example JJ24” in Step 1, but all other conditions and concentrations being the same as immediately above. Thus, 4×5=20 different fishing lines are produced.

The polystyrene molecules used in the above production of a fishing line could be shorter, e.g. 200, 50 or 10 units long, in order to lower their effect on viscosity, and thereby allowing the use of higher concentrations of nanotubes during the extrusion process. Also, the polystyrene molecules used could comprise a larger number of reactive groups per polymer, thereby leading to more crosslinking. Further, the polystyrene carrying reactive group(s) could be exchanged with any polymer, including polyethylene, polyurethane, LDPE, HDPE, Polypropylene, PVC, PS, EPS, PPS, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber, and the reactive group (thiol group) could be replaced by other reactive groups capable of reacting with double bonds, such as triple or double bonds, alcohols or halogens.

### Example JJ24, B-1.2. Solid Balls Made from Sized SWNTs to which is Added Linear Polyethylene Chains Comprising a Reactive Group Capable of Reacting with Double Bonds, as Well as Polyethylene Chains without Reactive Groups

This is a variation of Example JJ24,B-1.1. Balls with different contents of nanotubes and polymers are produced. Example JJ24,B-1.1, steps 1-3 are performed, and then the material is injection molded into a mold with the shape of a ball. The resulting products are therefore 32 balls, comprising varying amounts of SWNT and polyethylene crosslinks.

### Example JJ24, C: Ionic Polymerization as a Means for Attaching a Polymer or a Crosslinker to the Double Bond of the ROMP Polymer in the Sized Nanotubes

Ionic polymerization, in the form of cationic polymerization (Example JJ24, C-1.1), is described below.

Example JJ24, C-1.1. A tire made from ROMP polymer-coated SWNTs to which is covalently linked polyisobutylene.

In this example, the cationic polymerization of isobutylene is carried out in the presence of ROMP polymer-coated SWNTs at temperatures below 0° C. with a Friedel-Crafts/ether complex co-initiator (e.g., AlCl₃·Bu₂O). In the reaction flask three different processes occur simultaneously: the polymerization of isobutylene, the attachment of the new polyisobutylene chains to the sized SWNTs and the crosslinking of the sized SWNTs.

Step 1: To a 500 mL reactor, 250 mL of “100× upscaled solution of ROMP Polymer-coated SWNTs of Example JJ24” and 100 mL of dry hexanes are added.

Step 2: Isobutylene gas is condensed and added to the polymerization reactor (0.2 M) at −40° C.

Step 3: AlCl₃/ether complex is added (0.005 M).

Step 4: The reaction is stirred under nitrogen atmosphere at −40° C. for 30 min.

Step 5: NH₄OH is added in order to terminate the reaction.

Step 6: The composite is recovered from the organic layer.

Step 7: The “Polyisobutylene-ROMP polymer-coated SWNTs” is poured into a mould with the shape of a tire and solvent is evaporated.

Step 8: After cooling, the tire is released from the mould.

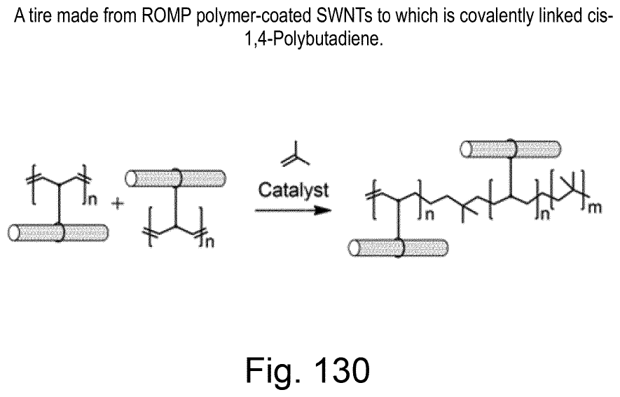

See FIG. 130.

### Example JJ25. Modifications to Nanotube Composites Comprising Double Bonds

In this example, it is described how ROMP polymer-coated SWNTs, crosslinked ROMP polymer-coated SWNTs, ROMP polymer-coated SWNTs linked to polymer, and any other nanotube composite comprising double bonds may be modified.

Nanotubes functionalized with double bonds, as described in the Examples above and below, are added to flasks labelled A, B, C, etc., as indicated:
Flask A: 100 mL “Solution of ROMP polymer-coated SWNT of Example A20”
Flask B: **
Flask C: **

Then the content of each of flasks A, B, C etc. are split into flasks labelled i, ii, iii, etc. and treated as described below for each of the modifications i), ii), iii), etc. The final products are thus contained in flasks Ai, Aii, . . . , Bi, Bii, . . . .

### Treatment (i): Addition to Double Bonds by Hydrogenation.

Step 1: The nanotube composites dispersed in toluene are added to a high-pressure reactor equipped with a magnetic stirrer.

Step 2: A convenient homogeneous catalyst (e.g., (PPh₃)₃RhCl) and PPh₃ are added to the reactor under a nitrogen stream.

Step 3: The reactor is purged with hydrogen.

Step 4: The reactor is pressurized to 50 bar with hydrogen.

Step 5: The reaction is stirred at 100° C. overnight.

Step 6: Methanol is added and the final product is isolated employing filtration. It is washed several times with methanol and dried under vacuum.

The final products are termed “Ai of Example JJ25”, “Bi of Example JJ25”, [** . . . etc. etc. . . . **]

Treatment (ii): Addition to Double Bonds with Halogens Such as HCl.

The alkene can act as a nucleophile towards different acid protons resulting in the formation of a carbocation that is attacked by a nucleophile. Employing this mechanism, different halogens can be added.

Step 1: The mixture in flasks (ii) is stirred under a hydrogen chloride pressure (e.g., 760 kPa) in the presence of a catalyst (e.g., 5 mol % hexanoic acid).

Step 2: The crude is cooled down after stirring for 3 h at 383 K.

Step 3: The final product is separated by filtration.

The obtained products are called “Aii of Example JJ25”, “Bii of Example JJ25”, [** . . . etc.**]

Treatment (iii): Addition of Halides Such as Br₂/I₂/Cl₂ to Double Bonds

The alkene can act as a nucleophile towards different acid protons resulting in the formation of a carbocation that is attacked by a nucleophile. Employing this mechanism, different halogens can be added. These reactions proceed through the formation of 3-membered ring cations and lead to the addition of two halogens to the opposite faces of the alkene.

It is here exemplified with Br₂.

Step 1: The polymers in flasks (iii) are exposed to saturated bromine vapor.

Step 2: After half an hour stirring, the product is isolated through filtration.

The obtained products are called “Aiii of Example JJ25”, “Biii of Example JJ25”, [** . . . etc.**]

### Treatment (iv): Halohydrins Formation

The alkene can act as a nucleophile towards different acid protons resulting in the formation of a carbocation that is attacked by a nucleophile. Employing this mechanism, different halogens can be added. These reactions proceed through the formation of 3-membered ring cations and lead to the addition of one halogen plus one hydroxyl group to the opposite faces of the alkene.

Step 1: To the polymers in flasks (iv) dispersed in THF (with a small water content) N-Bromosuccinimide is slowly added at 0° C. under argon.

Step 2: The reaction is stirred for 30 min.

Step 3: H₂O is added and the final products are isolated employing filtration.

The obtained products are called “Aiv of Example JJ25”, “Biv of Example JJ25”, [** . . . etc. . . . **]

### Treatment (v): Hydration of Double Bonds

The alkene can act as a nucleophile towards different acid protons resulting in the formation of a carbocation that is attacked by a nucleophile. Employing this mechanism, an hydroxyl group can be added.

Step 1: The polymers in flasks (v) are dispersed in 60% H₂SO₄.

Step 2: The mixture is vigorously stirred at 50° C. for 6 h.

Step 3: After this time, the crude is filtered and the final product is washed with water until neutral pH.

The obtained products are called “Av of Example JJ25”, “Bv of Example JJ25”, [** . . . etc. . . . **]

### Treatment (vi): Hydroamination:

Step 1: To the polymers in flasks (vi) dispersed in toluene aniline is added.

Step 2: A palladium catalyst (e.g., 2% [Pd(PPh₃)4]) and a cocatalyst (e.g., TfOH) are added.

Step 3: The reaction mixture is stirred at 100° C. for 6 h.

Step 4: After this time, the final product is isolated employing filtration.

The obtained products are called “Avi of Example JJ25”, “Bvi of Example JJ25”, [** . . . etc. . . . **]

Treatment (vii): Transformations Involving Transition-Metals Catalysis.

Here exemplified by use of the Heck reaction.

Step 1: To the polymers in flasks (vii) dispersed in NMP 4-iodoanisol, a palladium catalyst (e.g., Pd(OAc)₂), and a base (e.g., N, N-diisopropylethylamine (DIPEA)) are added.

Step 2: The reaction was stirred under inert atmosphere for 6 h at 80° C.

Step 3: The mixture is transferred to a dialysis tubing cellulose membrane (2-500 mL) and the palladium catalyst is removed by dialysis employing tetrachloroethane as solvent. Alternatively, a ligand can be added in order to favour the solubilization of the palladium particles.

The obtained products are called “Avii of Example JJ25”, “Bvii of Example JJ25”, [** . . . etc. . . . **]

Treatment (viii): Transformation of Double Bonds into Triple Bonds

After the addition of halogen species to the double bonds, as described in treatment (ii) or (iii), double elimination of the halogen atoms can lead to the formation of triple bonds. This reaction can be performed employing strong bases such as NaNH₂.

It is here exemplified using first treatment (iii), as described above, and then performing the following steps:

Step 1: A solution of sodium amide is prepared by adding sodium to liquid ammonia at −40° C. in the presence of a catalytic amount of FeNO₃.

Step 2: To this solution, a dispersion of the polymer in THF is slowly added at −50° C.

Step 3: After 0.5 h stirring, ether is added and the mixture is warmed to 0° C.

Step 4: Water is added and the final product is obtained employing filtration and water washes.

The obtained products are called “Aviii of Example JJ25”, “Bviii of Example JJ25”, [** . . . etc.**]

### Treatment (ix): Epoxidation:

Compounds comprising double bonds can be treated with an epoxidation agent (e.g. meta-Chloroperbenzoic acid (m-CPBA)) to transform the double bonds to epoxides.

Step 1: m-CPBA is added to a stirred dispersion of the polymer in TCE at 0° C.

Step 2: The reaction mixture is allowed to warm to rt over 24 h Step 3: Saturated aqueous Na₂SO₃ is added until starch-iodide paper indicates no remaining oxidant.

Step 4: 5% aqueous NaOH is added.

Step 5: The final product is isolated employing centrifugation.

The obtained products are called “Aix of Example JJ25”, “Bix of Example JJ25”, [** . . . etc.**]

### Treatment (x): Cyclopropanation:

Compounds comprising double bonds can be treated with a carbene-type reagent, such as iodomethylzinc iodide (formed in situ by the reaction between diiodomethane and a zinc-copper couple) which will lead to the addition of carbenes to the alkenes with the consequent formation of various cyclopropanes.

Step 1: A stirred solution of Et₂Zn in dry, degassed dichloroethane was cooled to 0° C. and ClCH₂I is added.

Step 2: The mixture is stirred at 0° C. for 5 min and a dispersion of the polymer in dry, degassed dichloroethane is added.

Step 3: A 1:1 mixture of sat. aq Na₂S2O₃ and sat. aq NH₄Cl is added and the mixture is allowed to warm to r.t.

Step 4: The final product is isolated employing filtration through a 0.2 μm-pore size PTFE membrane.

The obtained products are called “Ax of Example JJ25”, “Bx of Example JJ25”, [** . . . etc. . . . **]

### Example JJ26. Vulcanization of Modified SWNTs Carrying Double Bonds

The vulcanization process has been employed for the cross-linking of different polydiene elastomers. It is a process especially suited for the crosslinking of rubber. Sulfur is employed as vulcanizing agent. Different accelerants can be employed (e.g. benzothiazoles such as mercaptobenzothiazole (MBT), benzothiazolesulfenamides such as 2-morpholinothiobenzothialoze (MBS), dithiocarbamates such as tetramethylthiuram monosulfide (TMTM) and amines such as diphenylguanidine (DPG), among others) and activators such as metal salts (e.g. zinc oxide), fatty acids or nitrogen-containing bases. Also, a sulfur-free system, where the sulfur needed is supplied by the accelerator, can be employed.

For the vulcanization of nanotube composites, it is here exemplified using mercaptobenzothiazole as the accelerant, zinc oxide as activator, and a co-activator such as stearic acid (StH) but any such accelerants and/or activators can be used.

The following preparations containing compounds with double bonds are added to flasks labelled A, B and C:
Flask A: 100 g of [**Amalia's final composite flake**]
Flask B: 100 g of “Butadiene-crosslinked ROMP polymer-coated SWNTs of Example JJ24-A1.1”
Flask C: 100 g of “Polystyrene-ROMP polymer-coated SWNTs of Example 126”

Each of the flasks are now carried through the following steps:

Step 1: Zinc oxide (5 wt %), stearic acid (2 wt %) and sulfur (2 wt %) are added.

Step 2: The mixtures are thoroughly mixed.

Step 3: The mixture is transferred to an open two-roll mixing mill at 65° C.

Step 4: The obtained composites are cured in a compression molding machine for 10 min at 160° C.

The products are called “Vulcanized A of Example JJ26”, “Vulcanized B of Example JJ26” and “Vulcanized C of Example JJ26”.

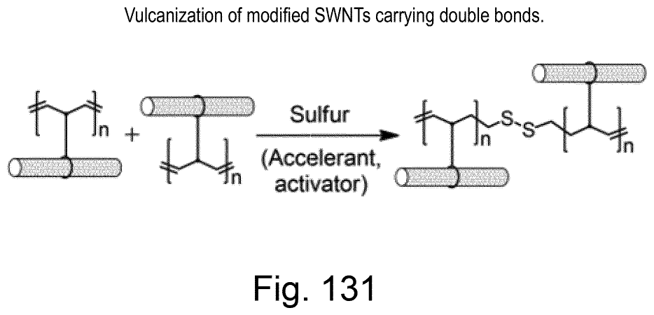

See FIG. 131 for a general description of the vulcanization process.

This methodology can be modified as follows.
In step 1, several additives can be added to modulate the final properties of the “rubber-like” composite obtained (e.g., anti-aging agents, antioxidants, flame retardants, plasticizers or reinforcing agents)

### Example JJ27. Edges-Functionalization of ROMP Polymer-Coated SWNTs

In this example, the reactivity of the terminal alkenes in the ROMP Polymer-coated SWNTs are employed for the attachment of various groups. A number of reactions specifically react with terminal double bonds, as an example, many transformations involving transition-metals catalysis can be performed preferentially at the terminal double bonds in the ROMP Polymer-coated SWNTs by choosing the correct catalyst.

In this example, the Wacker process, for the transformation of an alkene to a methyl ketone is employed using a catalyst/oxidant combination that reacts with terminal double bonds.

Step 1: A solution of palladium (II) chloride and copper (II) chloride in DMF/water is prepared.

Step 2: A dispersion of ROMP Polymer-coated SWNTs in DMF/water is slowly added at 60-80° C. while oxygen is bubbled in the reaction.

Step 3: The mixture is stirred for 5 h.

The resulting solution is called “Edges-functionalized ROMP polymer-coated SWNT solution of Example JJ27”.

Step 4: The final product is isolated employing filtration.

The resulting composite is called “Edges-functionalized ROMP polymer-coated SWNT composite of Example JJ27”.

### Example JJ28. In Situ Polymerization Leading to Materials with Thermoplastic or Thermoset Characteristics

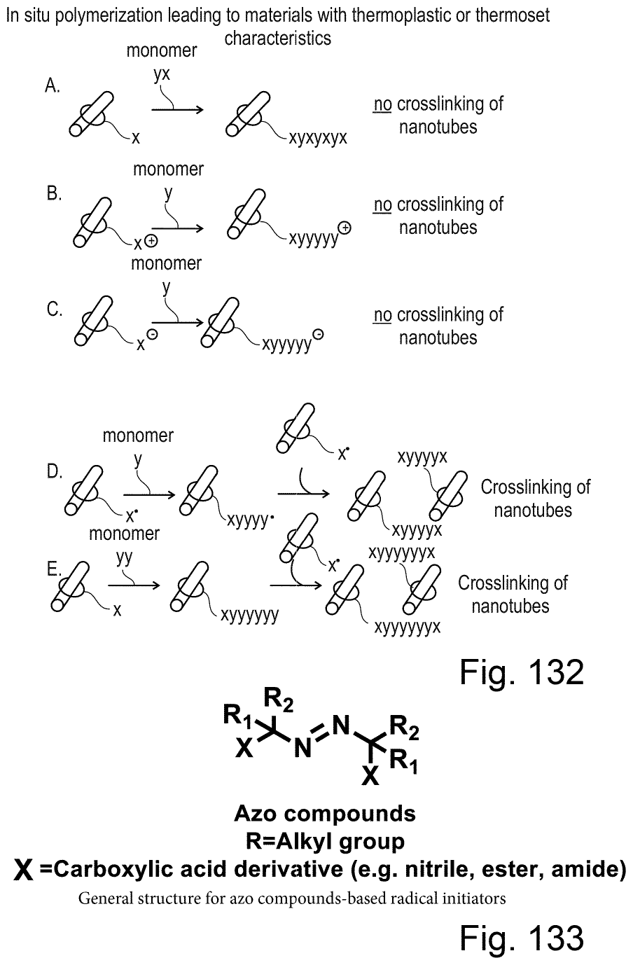

Approaches for in situ polymerisation that does or does not result in crosslinking of separate nanotubes are shown in (FIG. 132). All of the procedures depicted in (FIG. 132) involve polymerisation reactions where the polymerisation is initiated by an initiator molecule attached to the ML bound to the nanotube. (FIG. 132, A-C) describe procedures of in situ polymerization that do not lead to crosslinking of separate nanotubes; (FIG. 132, D-E) depict polymerisation reactions that can lead to crosslinking of separate nanotubes.

FIG. 132, A depicts a ML bound to a nanotube, where the ML carries a functional group X (e.g., an amine) capable of reacting with another functional group Y (e.g., a carboxylic acid chloride), but not capable of reacting with X. An asymmetric monomer YX (e.g., an activated amino acid, e.g., a compound comprising an amine and a carboxylic acid chloride) is added under appropriate conditions, leading to reaction between the X (e.g., amine) and the Y (e.g., carboxylic acid chloride), to form an amide bond. Upon reaction of several YX monomer units a polymer XYXYXYX is formed. If X is an amine and Y is a carboxylic acid chloride, the formed polymer is a polyamide. This polymer thus carries the X functionality at the growing terminus of the polymer and can therefore not react with an X functionality carried by a ML carried by a separate nanotube. Thus, the polymerisation does not lead to crosslinking of separate nanotubes.

FIG. 132, B depicts a ML bound to a nanotube, where the ML carries a cation. Upon addition of a monomer Y for cationic polymerization, the polymer XYYYY+ is formed. This polymer carries a cation on the growing terminus and does not react with a separate nanotube carrying a ML that carries a cation. Thus, the polymerisation does not lead to crosslinking of separate nanotubes.

FIG. 132, C depicts a ML bound to a nanotube, where the ML carries an anion. Upon addition of a monomer Y for anionic polymerization, the polymer XYYYY+ is formed. This polymer carries an anion on the growing terminus and does not react with a separate nanotube carrying a ML that carries an anion. Thus, the polymerisation does not lead to crosslinking of separate nanotubes.

FIG. 132, D depicts a ML bound to a nanotube where the ML carries a radical. Upon addition of a monomer Y for radical polymerization, a polymer XYYYY* carrying a radical at its terminus (where the asterisk (*) denotes a radical) is formed. If another nanotube bound to a ML carrying a radical is encountered, the two radicals may react to form the XYYYYX polymer which thus links two MLs on separate nanotubes. Thus, crosslinking of separate nanotubes may occur.

FIG. 132, E depicts a ML bound to a nanotube, where the ML carries a functional group X (e.g., an amine) capable of reacting with another functional group Y (e.g., a carboxylic acid chloride), but not capable of reacting with X. A symmetric monomer YY (e.g., a dicarboxylic acid chloride) is added under appropriate conditions, leading to reaction between the X (e.g., amine) and the YY monomer (e.g., dicarboxylic acid chloride), to form an amide bond. Upon reaction of several YY monomer units a polymer XYYYYYY is formed. If X is an amine and YY is a dicarboxylic acid chloride, the formed polymer is a polyamide. This polymer thus carries the Y functionality at the growing terminus of the polymer and can therefore react with an X functionality carried by a ML carried by a separate nanotube. Thus, the polymerisation may lead to crosslinking of separate nanotubes.

Below various in situ polymerization reactions are described, i.e., reactions where polymer formation is carried out in the presence of the nanotube, and optionally where the polymerization reaction is initiated at an initiator molecule carried by the ML that is bound to the nanotube.

Alternatively, as described in Example ** . . . ** and in (Figure ** . . . **), the initiator may be in solution, i.e. not carried by a ML. In this case, if the ML does not carry a polymerization terminator (i.e., a functional group that can react with the nascent polymer), no linking of the polymer to that nanotube will occur. However, if the ML bound to the nanotube carries a polymerization terminator, the formed polymer may become linked to the ML bound to a nanotube; crosslinking will not occur, though. See (Figure ** . . . **)

Initiators for the polymerisation described in (FIG. 132, A and E) include nucleophiles such as amines, hydroxyls and thiols, and include electrophiles such as carboxylic acid derivatives and carbonyls in general.

Initiators for the cationic polymerisation described in (FIG. 132, B) include BF₃ or AlCl₃.

Initiators for the anionic polymerisation described in (FIG. 132, C) include Butyl lithium or NaNH₂.

Initiators for the radical polymerization described in (FIG. 132, D) include the following:
Initiators for free radical polymerization:
   Azo compounds (e.g., AIBN).
   Organic peroxides (e.g., benzoyl peroxide).
   Others such as organic photoinitiators (e.g., acetophenone, benzyl/benzoin compounds, benzophenone).
Initiators for living radical polymerization:
   Nitroxide-mediated radical polymerization initiators such as alkoxyamines (e.g., TEMPO)
   Atom transfer radical polymerization (ATRP) initiators such as alkyl halides
   Reversible addition-fragmentation chain transfer polymerization (RAFT) initiators (e.g., trithiocarbonates).

The starting point for the reactions may be nanotubes carrying double bonds, or MLs bound to nanotubes where the MLs carry double bonds, such as the solution of polymer-coated SWNTs of Example A-20, or can be any other kind of chemical moiety to which such initiators may be attached, where the chemical moiety is attached to a nanotube.

In the following sub-examples of this Example JJ28, the starting point for the reactions is a 100-fold up-scaled solution of “Solution of ROMP polymer-coated SWNT of Example A20”. The 100-fold up-scaling is either carried out by performing the procedure described in Example A-20, Steps 1-11 as 100 parallel experiments and pooling the 100 resulting solutions into one, or by performing the procedure in 100-fold increased amounts of solvent, reactants, etc. The resulting solution is called “100-fold upscaled ROMP polymer-coated SWNTs of Example JJ28”.

### Example JJ28-A. In Situ Polymerisation Involving Azo Compounds as Initiators, to Produce e.g., Polystyrene-SWNT Composite

Initiators based in azo compounds (the general formula is shown in FIG. 133) are thermally or photo decomposed in order to start the polymerization process. A representative initiator is azobisisobutyronitrile (AIBN), although a wide variety of azo compounds are employed in the polymer industry such as AMBN (CAS Number: 13472-08-7), ADVN (CAS Number: 4419-11-8) or ACVA (CAS Number: 2638-94-0). These compounds can be easily derivatized to incorporate a terminal double bond in the structure, able to react with the nanotubes carrying double bonds. An example of an AIBN-like initiator carrying a terminal double bond is described in Bain et al. (Macromolecules, 2012, 45, 3809, DOI: 10.1021/ma300491e).

Step 1. Synthesis of the initiator, compound (J-8). The synthesis is described in FIG. 138. First, acetone hydrazone is prepared by condensation of hydrazine and acetone in two consecutive steps. Then, condensation with a ketone (5-hexen-2-one) leads to the formation of the corresponding azine. Addition of commercial trimethylsilyl cyanide and final oxidation with Pb(OAc)₄ leads to the final azo compound carrying a terminal double bond (J-8).

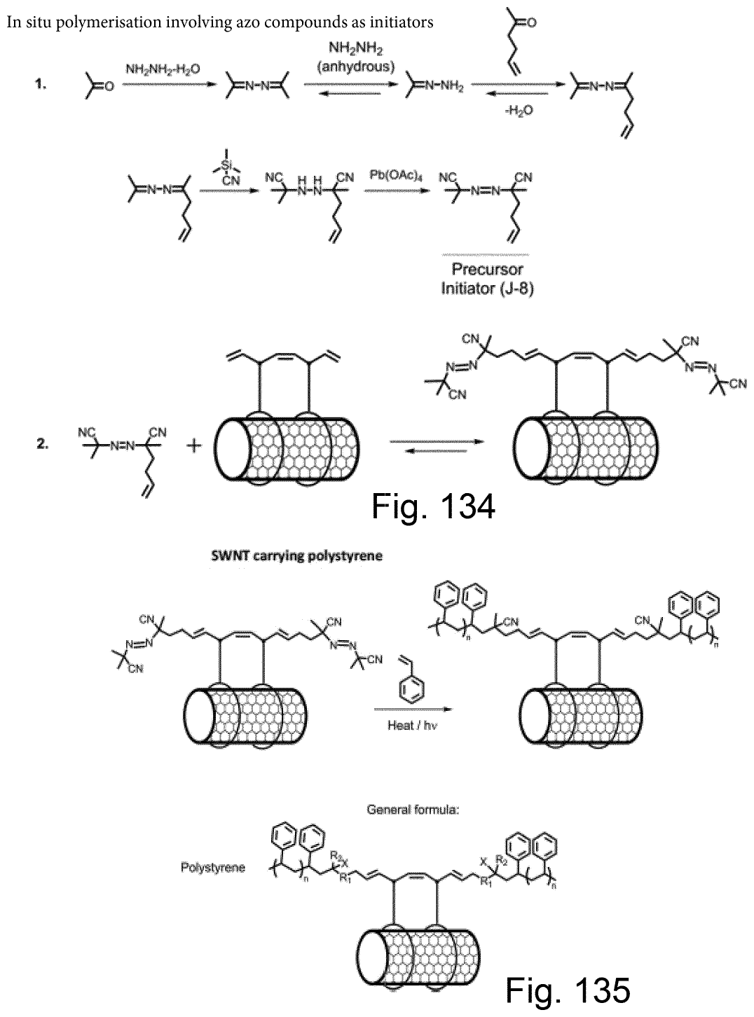

Step 2. Attachment of AIBN-like initiators to the nanotube. The procedure is described in FIG. 134. The AIBN-like polymerisation initiator carrying a terminal double bond is reacted with an alkene of the “100-upscaled ROMP polymer-coated SWNTs of Example JJ28” through metathesis of double bonds. Thus, 100 mL of “100-upscaled ROMP polymer-coated SWNTs of Example JJ28” is mixed with 10⁻⁵ mM initiator (compound (J-8)), and a metathesis catalyst (e.g., Grubbs catalyst, 1^{st} generation, 10⁻⁶ mM). This mixture is stirred at room temperature under inert atmosphere for 2 to 24 h. After this time, filtration through a polytetrafluoroethylene (PTFE) pored membrane is employed to remove the catalyst and unreacted initiator. The resulting product is termed “AIBN-like initiator-functionalised SWNT of Example JJ28-A”. Optionally, the remaining double bonds of this product may be removed with H₂, to give “Hydrogenated, AIBN-like initiator-functionalised SWNT of Example JJ28-A”.

Step 3. In situ polymerization out from initiator molecule, to produce SWNT carrying polystyrene (the final structure is shown in FIG. 135).

### Option A. Solution Polymerization

Substep 3A.1. 500 mL toluene is added to 500 mg (1 mg/mL) of each “AIBN-like initiator-functionalised SWNT of Example JJ28-A” and “Hydrogenated, AIBN-like initiator-functionalised SWNT of Example JJ28-A”.

Substep 3A.2. 100 mL (26 mmol) styrene is added to each of the two solutions Substep 3A.3. Optionally, regulators (e.g. 1-butanethiol) can be added to each of the two solutions.

Substep 3A.4. The two suspensions are incubated at 50-70° C. for 6 h or the two suspensions are irradiated with light of 350 nm for 45 min. to form polystyrene attached to the SWNT through the AIBN-like initiator molecule.

The two resulting suspensions are called “Polystyrene-SWNT suspension of Example JJ28-A” and “pre-hydrogenated, Polystyrene-SWNT suspension of Example JJ28-A”, where the latter suspension had its double bonds hydrogenated before polystyrene formation.

Substep 3A.5. The final suspensions can alternatively be poured into stirred methanol to obtain Polystyrene-SWNT flakes. The flakes obtained are filtered off and dried at 50° C. The obtained flakes are called “solution polymerized Polystyrene-SWNT granulates of Example JJ28-A” and “solution polymerized pre-hydrogenated, Polystyrene-SWNT granulates of Example JJ28-A”.

### Option B. Bulk Polymerization

Substep 3B.1. 500 mg of each “AIBN-like initiator-functionalised SWNT of Example JJ28, A” and “Hydrogenated, AIBN-like initiator-functionalised SWNT of Example JJ28-A” are mixed directly with 100 mL styrene.

Substep 3B.2. The two mixtures are stirred in a tank reactor at 50-70° C. for 1-6 h or the two suspensions are irradiated with light of 350 nm for 45 min. to form polystyrene attached to the SWNT through the AIBN-like initiator molecule.

Substep 3B.3. Granulate preparation of the two polystyrene-SWNT composites. The mixtures are then each transferred to a tubular thin-film reactor. The obtained molten polystyrene is pumped through spinnerets or an extruder to produce granulates (2-5 mm pellets). Alternatively, a blowing agent such as pentane can be added to the granulates. The two final granulate preparations are called “bulk polymerized Polystyrene-SWNT granulates of Example JJ28-A” and “bulk polymerized pre-hydrogenated, Polystyrene-SWNT granulates of Example JJ28-A”, respectively.

### Option C. Suspension Polymerization

Substep 3C.1. The polymerization is performed in aqueous suspension using a suspending agent, e.g. 88% hydrolyzed poly(vinyl alcohol) or methyl cellulose. 500 mg of each “AIBN-like initiator-functionalised SWNT of Example JJ28, A” and “Hydrogenated, AIBN-like initiator-functionalised SWNT of Example JJ28-A” are mixed directly with 100 mL styrene.

Substep 3C.2. This mixture is poured into 200 mL deionized water containing 4 g poly(vinyl alcohol).

Substep 3C.3. The two mixtures are stirred in a tank reactor at 50-70° C. for 1-6 h or the two suspensions are irradiated with light of 350 nm for 45 min. to form polystyrene attached to the SWNT through the AIBN-like initiator molecule.

Substep 3C.4. The obtained granular beads are isolated by filtration. The two final preparations are called “Suspension polymerized Polystyrene-SWNT granulates of Example JJ28-A” and “Suspension polymerized pre-hydrogenated, Polystyrene-SWNT granulates of Example JJ28-A”, respectively.

### Variations on the Abovementioned Protocol for Polystyrene-Nanotube Composites:

Instead of polystyrene, different polymers can be synthesized from the “AIBN-like initiator-functionalised SWNTs of Example JJ28-A” and “Hydrogenated, AIBN-like initiator-functionalised SWNTs of Example JJ28-A”.

In the table JJ28-1 below, different monomers that react with the “AIBN-like initiator-functionalised SWNTs of Example JJ28-A” and “Hydrogenated, AIBN-like initiator-functionalised SWNTs of Example JJ28-A” for the synthesis of various Polymer-SWNTs are shown.

TABLE JJ28-1
Different polymers that can be synthesized employing azo compounds as initiators.

| | Polymer | Monomer | Optional reaction conditions |
|---|---|---|---|
| Chain growth | | Employed instead of | |
| polymerization | | styrene in Substep | |
| | | 3A.2/3B.1/3C.1 | |
| | Polyvinylchloride | Vinylchloride | For solution polymerization, in |
| | | | Substep 3A.1, acetone can be |
| | | | added instead of toluene. |
| | | | Bulk and suspension |
| | | | polymerization are also |
| | | | possible. |
| | Polyvylidenechloride | Vinylidenechloride | |
| | Polyethylene, poly- | Ethylene, 1-buthylene, | For solution polymerization, in |
| | (1-butylene), | propylene | Substep 3A.1, acetone can be |
| | isotactic | | added instead of toluene. |
| | polypropylene | | Bulk and suspension |
| | | | polymerization are also |
| | | | possible. |
| | Polymethyl | Methyl methacrylate | For solution polymerization, in |
| | methacrylate | | Substep 3A.1, acetone can be |
| | | | added instead of toluene. |
| | | | Bulk and suspension |
| | | | polymerization are also |
| | | | possible. For suspension |
| | | | polymerization, different |
| | | | solvents such as DMF can be |
| | | | added. |
| | Polyacrylonitrile | Acrylonitrile | For solution polymerization, in |
| | | | Substep 3A.1, ethanol can be |
| | | | added instead of toluene. |
| | | | Bulk and suspension |
| | | | polymerization are also |
| | | | possible. For suspension |
| | | | polymerization, different |
| | | | solvents such as DMF can be |
| | | | added. |
| | Polyacrylamide | Acrylamide | For solution polymerization, in |
| | | | Substep 3A.1, acetone can be |
| | | | added instead of toluene. |
| | | | Bulk polymerization is also |
| | | | possible. |

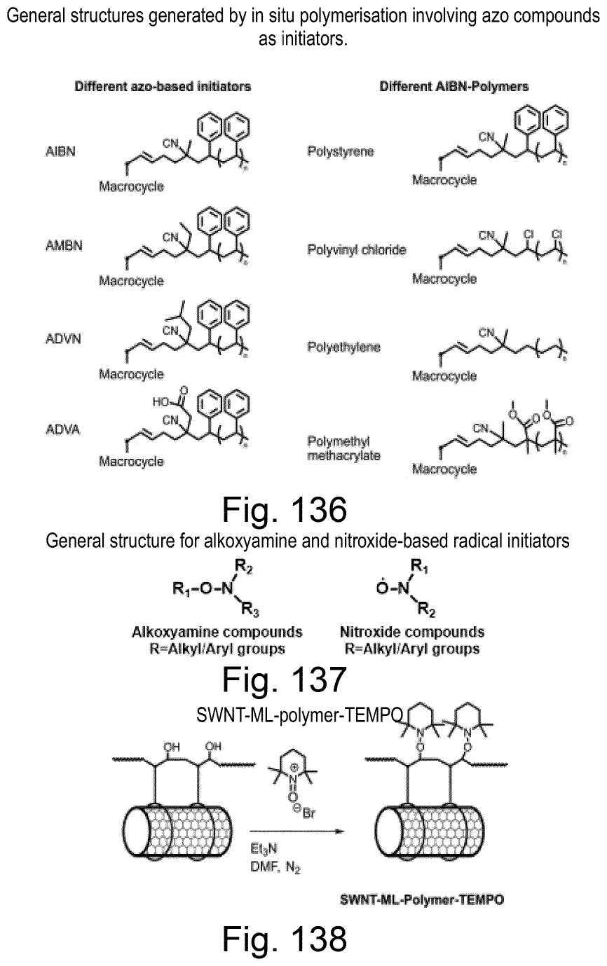

The resulting composite materials of this example JJ28-A thus comprises reacted initiator moieties, covalently linked to the polymer as well as the ML. The reacted initiator moieties contain a tetrasubstituted carbon that carries a carboxylic acid derivative (e.g., a nitrile, an ester or an amide) and an extra alkyl group, and are of the general structure shown in FIG. 136.

### Example JJ28-1B. In Situ Polymerisation Involving Nitroxide-Mediated Radical Polymerization (NMRP) Initiators to Produce e.g., Polystyrene-SWNT Composite

In this example, the attachment of nitroxide-mediated radical polymerization (NMRP) initiators and the in-situ polymerization of different monomers is described. A general formula for NMRP initiators is shown in FIG. 137. The 2,2,6,6-tetramethyl-1-piperidinyloxy (TEMPO, CAS Number: 2564-83-2) is one of the most popular initiators, although a wide variety of nitroxides and alkoxyamines have been synthesized such as 2,2,5-trimethyl-3-(1-phenylethoxy)-4-phenyl-3-azahexane (TIPNO, NMP universal alkoxyamine nitroxide, CAS Number: 61015-94-9) or di-tert-butyl nitroxide (DBNO, CAS Number: 2406-25-9).

Step 1. Attachment of TEMPO-based NMRP initiator to the nanotube: As in Garcia-Valdez et al. (Polymer, 2014, 55, 2347, DOI: 10.1016/j.polymer.2014.03.042), the application of an oxoammonium salt (TEMPO-Br) to the structure obtained in “Av of Example JJ25” modifies the surface to include reactive TEMPO groups.

The starting “Av of Example JJ25” is dispersed in DMF. Then, a solution of Br-TEMPO in DMF is added drop wise in the presence of triethylamine. The reaction is stirred 48 h under inert atmosphere. The final “SWNT-ML-polymer-TEMPO” (structure shown in FIG. 138) is purified employing centrifugation or filtration and DMF washes to remove residual Br-TEMPO.

Step 2. In situ Polymerization out from initiator molecule, to produce SWNT carrying Polystyrene or polyisoprene. Different polymers can be grafted to the interlinked SWNT-ML-polymer structure via nitroxide mediated radical polymerization. Some examples are polystyrene or polyisoprene.

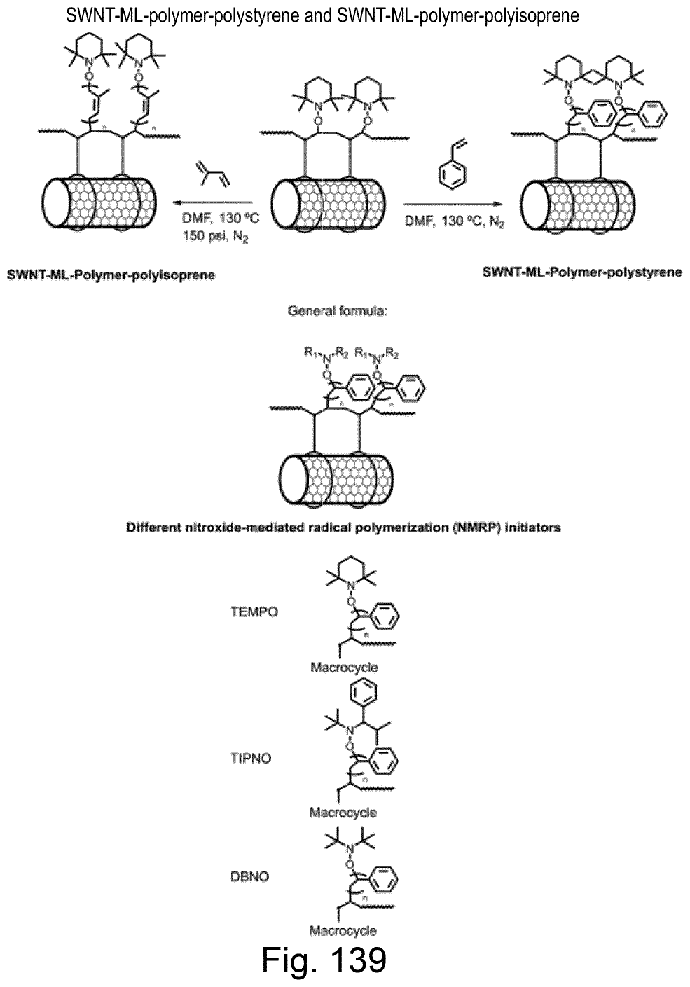

Option A. For the preparation of “SWNT-ML-polymer-polystyrene” (structure is shown in FIG. 139).

Substep 2A.1. The previously synthesized interlinked SWNT-ML-polymer-TEMPO are dispersed in DMF employing ultrasonication.

Substep 2A.2. Styrene is added to the mixture. The system is deoxygenated.

Substep 2A.3. The mixture is stirred at 130° C. for 7 h.

Substep 2A.4. The free polystyrene is separated by centrifugation and DMF washes.

Option B. For the preparation of “SWNT-ML-polymer-polyisoprene” (structure is shown in FIG. 139) Substep 2B.1. The previously synthesized interlinked SWNT-ML-polymer-TEMPO are dispersed in DMF employing ultrasonication.

Substep 2B.2. Isoprene is added to the mixture. The system is deoxygenated and pressurized at 150 psi absolute.

Substep 2B.3. The reaction mixture is stirred at 130° C. for 144 h.

Substep 2B.4. The free polyisoprene is removed employing centrifugation or filtration and DMF washes.

A different approach for obtaining SWNT-ML-polymer-polystyrene involves the employment of the hydroxyl groups present in the SWNT-ML-polymer-OH of Example JJ25 as radical specie for the attachment of styrene/TEMPO groups. The resulting SWNT-ML-polymer-TEMPO can be used again to graft the polystyrene as in Prakanrat et al. (Appl. Spectrosc. 2009, 63, 233, DOI: 10.1366/000370209787391978.)

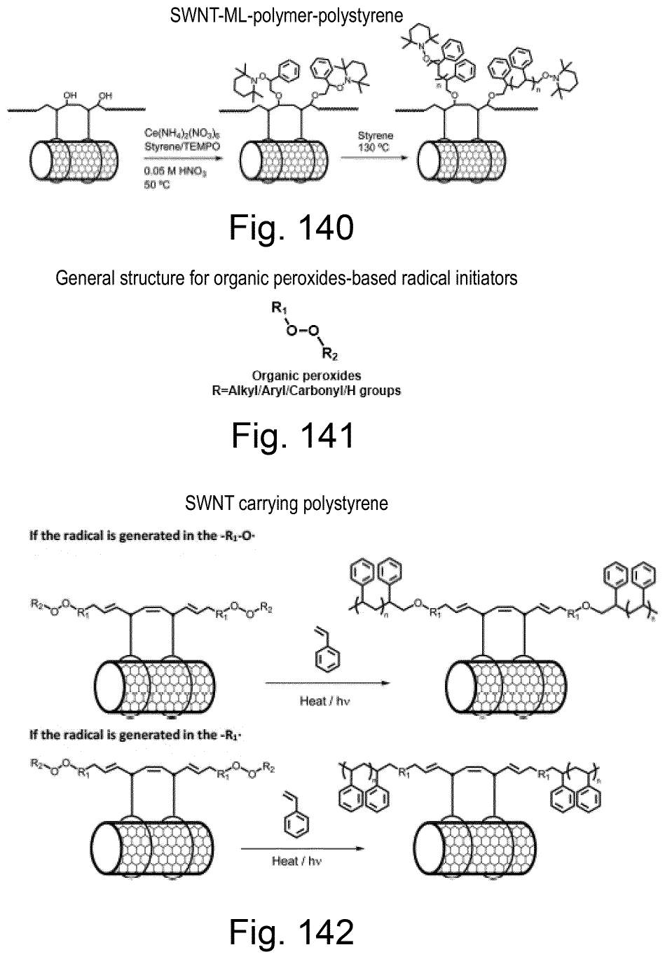

The synthesis is shown in FIG. 140. The starting SWNT-ML-polymer-OH is dispersed in 0.05 M HNO₃ through sonication. To this dispersion, ceric ammonium nitrate, TEMPO and styrene in 0.05 M HNO₃ are added. The reaction is maintained for 2 h at 50° C. After this time, the synthesized SWNT-ML-polymer-TEMPO is washed employing centrifugation and dichloromethane washes. The polystyrene is grafted to the surface employing a previously dispersed solution of SWNT-ML-polymer-TEMPO and a desired amount of styrene. The mixture is heated at 130° C. under inert atmosphere. The final product, SWNT-ML-polymer-polystyrene, is purified employing a Soxhlet extractor with dichloromethane in order to eliminate any residual monomer and homopolymer.

### Example JJ28-C. In Situ Polymerisation Involving Organic Peroxides as Initiators, to Produce e.g. Polystyrene-SWNT Composite

The example JJ28-A can be modified if instead of an azo compound, an organic peroxide is employed as initiator (the general formula is shown in FIG. 141). Organic peroxides are thermally or photo decomposed in order to start the polymerization process. A representative initiator is benzoyl peroxide (BPO, CAS Number: 94-36-0), although a wide variety of organic peroxides are employed in the polymer industry such as tert-Butyl hydroperoxide (TBHP, CAS Number: 75-91-2) or dicumyl peroxide (CAS Number: 80-43-3). These compounds can be derivatized to incorporate a terminal double bond in the structure, able to react with the nanotubes carrying double bonds.

The “100-fold upscaled ROMP polymer-coated SWNTs of Example JJ28” is derivatized to incorporate a terminal peroxide at the edges. This structure is called “SWNT-ML-polymer-peroxide”. In the presence of a vinyl monomer (e.g., styrene) and a radical generator source (heat or light), the peroxide edge decomposes into a radical that reacts with the monomer starting its polymerization. The resulting composite materials of this example JJ28-C thus comprises reacted initiator moieties, covalently linked to the polymer as well as the ML. The reacted initiator moieties contain an ether functionality or an alkyl chain as shown in FIG. 142.

### Example JJ28-D. In Situ Polymerisation Involving ATRP Initiators Such as Alkyl Halides, to Produce e.g., Polystyrene-SWNT Composite

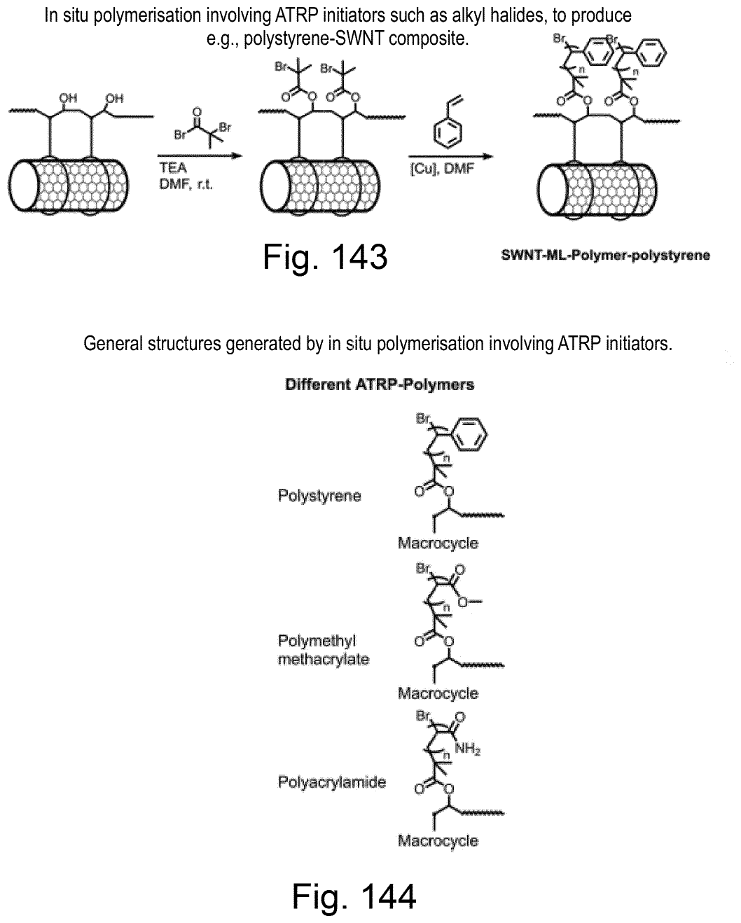

The example JJ28-B can be modified if instead of a nitroxide-mediated radical polymerization (NMRP) initiator, an ATRP such as an alkyl halide is employed as initiator. ATRP initiators are thermally or photo decomposed in order to start the polymerization process. A representative initiator is α-bromoisobutyryl bromide (CAS Number: 20769-85-1). In order to connect the initiators to the ROMP-ML structure, the ROMP-ML structure must be first derivatized to include terminal hydroxyl groups as in Example JJ25, treatment v. The procedure for obtaining polystyrene-SWNT composites is shown in FIG. 143:

Step 1. Attachment of ATRP initiator to the nanotube: As in Lee, et al. (Macromol. Rapid Commun. 2010, 31, 281-288. CAS: 10.1002/marc.200900641), the compound “Av of Example JJ25” that carries terminal hydroxyl groups can be modified by the addition of an ATRP initiator.

The starting “Av of Example JJ25” are dispersed in DMF. Then, it is treated with excess isobutyryl bromide in the presence of triethylamine (TEA) and N,N-dimethylformamide (DMF) in an ice bath for 24 h. The product is collected via filtration, and then vigorously washed with chloroform and deionized water to remove residual reactants. In this reaction, the pendant hydroxyl groups on the surface of graphene oxide undergo esterification with the acid bromide initiator.

Step 2. In situ polymerization out from initiator molecule, to produce SWNT carrying Polystyrene or polyisoprene. Different polymers can be grafted to the interlinked SWNT-ML-polymer structure via nitroxide mediated radical polymerization. Some examples are polystyrene or polyisoprene.

The polymerizations are initiated by adding monomer (e.g., styrene), tris(2-aminoethyl)amine (TREN), and copper(0) to a DMF suspension of the material obtained in step 1. The resulting mixtures are stirred at 80° C. for 18 h. After cooling to ambient temperature, the SWNT-ML-Polymer-polystyrene product is washed with excess DMF and then dried under vacuum.

The resulting composite materials of this example JJ28-D thus comprises reacted initiator moieties, covalently linked to the polymer as well as the ML. The reacted initiator moieties contain an ester functionality from which the synthesized polymer hangs and are of the general structure shown in FIG. 144.

### Example JJ28-E. In Situ Polymerisation Involving RAFT Initiators Such as Trithiocarbonates, to Produce e.g., Poly(N-Vinylcarbazole)-SWNT Composite

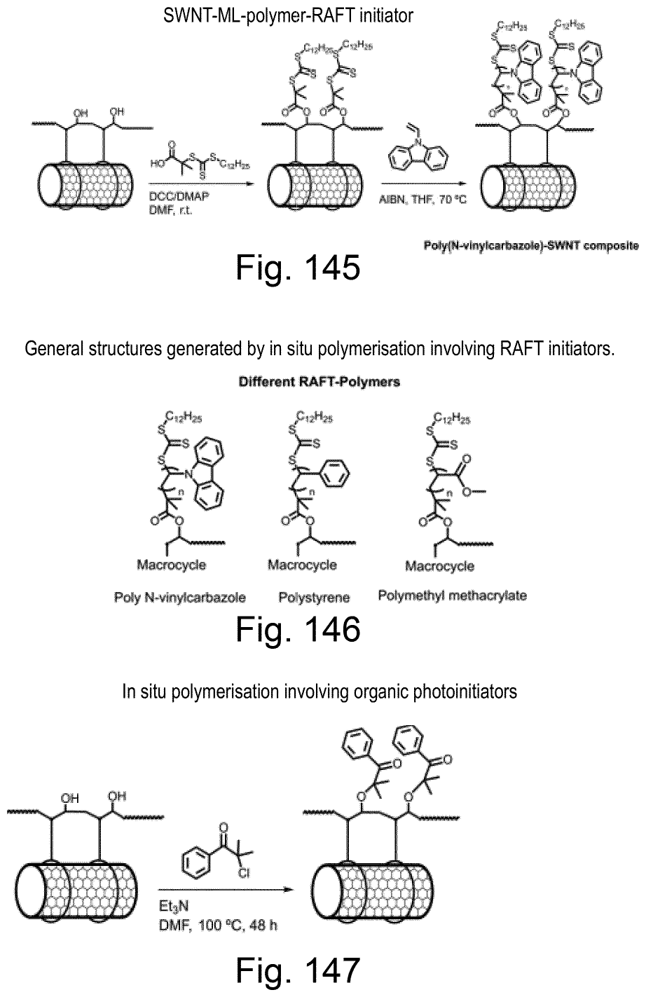

The example JJ28-B can be modified if instead of a nitroxide-mediated radical polymerization (NMRP) initiator, a RAFT initiator such as a thiocarbonylthio compound is employed. In RAFT polymerization, the reaction is started by a free-radical source which may be a decomposing radical initiator such as AIBN. In order to connect the RAFT initiators to the ROMP-ML structure, the ROMP-ML structure must be first derivatized to include terminal hydroxyl groups as in Example JJ25, treatment v. The procedure for the obtention of Poly(N-vinylcarbazole)-SWNT composites is shown in FIG. 145:

Step 1. Attachment of RAFT initiator to the nanotube: As in Zhang et al. (J. Polym. Sci. A Polym. Chem. 2011, 49, 2043-2050. DOI: 10.1002/pola.24633), the structure obtained in “Av of Example JJ25” that carries terminal hydroxyl groups can be modified by the addition of a RAFT initiator.

The starting “Av of Example JJ25” is dispersed in DMF. Then, they are treated with S-1-Dodecyl-S′-(α, α′-dimethyl-α″-aceticacid)trithiocarbonate (DDAT) and N,N′-dimethylaminopyridine and the mixture is ultrasonicated for 20 min and stirred at 0° C. for 1 h. Then, 1,3-dicyclohexylcarbodiimide is added and the reaction is dried for 48 h at room temperature. After this time, the reaction is filtered through aa PTFE membrane and washed with deionized water and THF. In this reaction, the pendant hydroxyl groups on the surface of graphene oxide undergo esterification with the acid group present in the DDAT initiator.

Step 2. In Situ Polymerization Out from Initiator Molecule, to Produce SWNT Carrying Poly(N-Vinylcarbazole).

The polymerizations are initiated by adding monomer (e.g., N-vinylcarbazole) and AIBN, and stirring the reactions in THF at 70° C. for 12 h in an innert atmosphere. After cooling to ambient temperature, the SWNT-ML-Polymer-Poly(N-vinylcarbazole) product is washed with excess THF and then dried under vacuum.

The resulting composite materials of this example JJ28-E thus comprises reacted initiator moieties, covalently linked to the polymer as well as the ML. The reacted initiator moieties contain an ester functionality from which the synthesized polymer hangs and are of the general structure shown in FIG. 146.

### Example JJ28-F. In Situ Polymerisation Involving Organic Photoinitiators Such as Acetophenone, to Produce e.g., Poly(Methylmetacrylate)-SWNT Composite

The example JJ28-A can be modified if instead of an azo compound, a photoinitiator is employed. A representative photoinitiator is acetophenone (CAS Number: 98-86-2). These compounds can be derivatized to incorporate functional groups able to react with the SWNT-ML structures. As in

Step 1. Attachment of photoinitiators to the nanotube: As in Song et al. (J. Mat. Sci. 2013, 48, 5750-5755. DOI: 10.1007/s10853-013-7367-9), the compound “Av of Example JJ25” that carries terminal hydroxyl groups can be modified by the addition of a photoinitiator carrying a terminal chloride as in FIG. 147 in the presence of triethylamine under inert atmosphere.

Step 2. In situ polymerization out from initiator molecule, to produce SWNT carrying Poly(N-vinylcarbazole): Once the photoinitiator is covalently linked to the SWNT-ML-Polymer structure, the polymerizations is initiated in the presence of a monomer (e.g., methyl metacrylate) and a radical-forming source such as heat or light.

### Example JJ28-G. In Situ Polymerisation Involving Initiators that Only React with One Reactive Group of a Monomer that is Asymmetric in the Sense that it Comprises Two Different Reactive Groups, Both of which are Involved in the Polymerization Process

In this Example “asymmetric monomer” shall mean a monomer building block for polymerisation where the monomer comprises two reactive groups X and Y, where X of one monomer and Y of another monomer can react to form a covalent bond between the two monomers, but where two Xs or two Ys cannot react to form a covalent bond between two monomers. Thus, the general structure of such asymmetric monomers is XY.

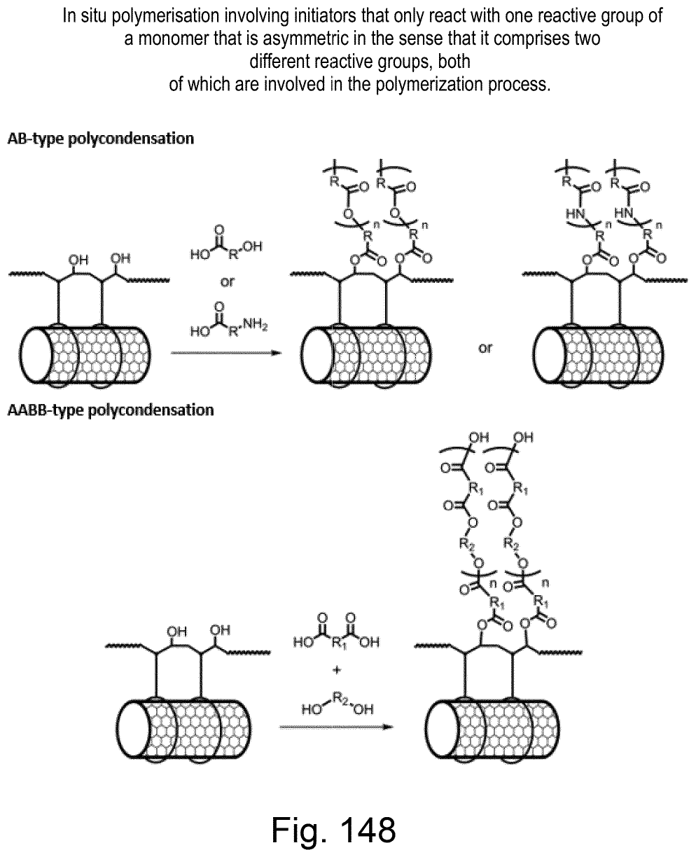

FIG. 148 describes two examples of in situ polymerisation reactions involving asymmetric monomer building blocks.

Below different example types of monomers and the corresponding polymers formed during (in situ) polymerisation are described.
i) S_{N}2 reaction. In situ polymerization from monomers each comprising both a nucleophile and electrophile, where both the electrophile and the nucleophile react during polymerization. Specific polymerization reactions include:
   a. In situ polymerisation of polyamides. The initiator can be either a nucleophile (e.g. hydroxy, amine, thiol) or electrophile (e.g. carboxylic ester, anhydride, carbonyl). If e.g. the initiator is a nucleophile such as e.g. an amine, the asymmetric monomer may be e.g. an amino acid derivative comprising an amine and a carboxylic acid derivative. Upon reaction of multiple amino acid derivatives a polyamide is formed, where the nascent polymer will comprise an amine at its terminus. As a consequence, if the initiator (in this example an amine) is carried by a ML bound to a nanotube, the nascent polymer will (in this example where the asymmetric monomer is an amino acid derivative) at its terminus carry an amine functionality and will therefore not crosslink separate nanotubes.
   b. In situ polymerisation of polyesters. The initiator can be either a nucleophile (e.g. hydroxy, thiol) or electrophile (e.g. carboxylic ester, anhydride). If e.g. the initiator is a nucleophile such as e.g. an hydroxy, the asymmetric monomer may comprise e.g. a hydroxyl and an anhydride. Upon reaction of multiple monomers a polyester is formed, where the nascent polymer will comprise a hydroxyl group at its terminus. As a consequence, if the initiator (in this example a hydroxyl) is carried by a ML bound to a nanotube, the nascent polymer will (in this example where the asymmetric monomer comprises one hydroxyl and one anhydride) at its terminus carry an —OH functionality and will therefore not be able to react with another hydroxyl (under those conditions) and therefore not crosslink separate nanotubes.
ii) Suzuki Reaction. In situ polymerisation from monomers that comprise either a boronic acid or a boronic ester, and either an aryl or alkenyl halide, where both the boronic acid/boronic ester and the aryl/alkenyl halide react during the polymerisation. Specific polymerisation reactions include:
   a. In situ polymerization using Suzuki coupling, to form C—C bonds between the monomers. The initiator can be e.g. a boronic acid or a boronic ester, or it can be an aryl or alkenyl halide. If e.g. the initiator is a boronic ester, the asymmetric monomer may comprise a boronic acid or a boronic ester, as well as an aryl or alkenyl halide. Upon reaction of multiple asymmetric monomers a polymer is formed carrying C—C bonds between the individual monomer building blocks, where the nascent polymer will comprise a boronic ester or boronic acid at its growing terminus. As a consequence, if the initiator (in this example a boronic ester) is carried by a ML bound to a nanotube, the nascent polymer will (in this example where the asymmetric monomer comprises a boronic acid or a boronic ester, as well as an aryl or alkenyl halide) at its terminus carry a boronic acid or a boronic ester and will therefore not be able to react with another ML carrying a boronic acid or boronic ester, and will therefore not crosslink separate nanotubes.
iii) Many other general types of in situ polymerization using asymmetric monomers exist. Common to all is that the polymer resulting from polymerisation of asymmetric monomers, initiated at an initiator attached to the ML (or nanotube) will become attached at one of its ends to a nanotube.

### Example JJ29. In Situ Polymerisation Using ML-Nanotube Complexes as Starting Point

In Example JJ28, the starting point for polymerization is the “100-upscaled ROMP polymer-coated SWNTs of Example JJ28” or its derivatives, such as the hydroxylated derivative described in Example JJ25: “Av of Example JJ25”. However, the polymerization can start from the simplified structure SWNT-ML if the mechanical ligand (ML) carries an appropriate initiator (e.g., a benzophenone, a peroxide or an amine). In this case, the final composites will be of the form: SWNT-ML-Polymer.

### Example JJ30. In Situ Polymerisation Using Nanotubes, to which have been Attached Polymers that do not Crosslink Nanotubes, and that Carry an Appropriate Reactive Group, as Starting Point

In Example JJ28, the starting point for polymerization is the “100-fold upscaled ROMP polymer-coated SWNTs of Example JJ28” or its derivatives, such as the hydroxylated derivative described in Example JJ25: “Av of Example JJ25”. In this example (JJ30), the starting material consists on a SWNT-ML, where ML is covalently attached to a polymer that does no crosslink with the rest of the SWNTs. The polymer carries appropriate reactive groups that can be reacted with other polymers that carry complementary reactive groups (e.g., the first polymer carries amines, the second polymer carries esters). The final composites are in the form: SWNT-ML-Polymer-Polymer.

### Example JJ31: In Situ Polymerization Resulting in Crosslinking Using Amalias Solution as Starting Points

In this Example, the starting material is the “100-fold upscaled ROMP polymer-coated SWNTs of Example JJ28” in which the ROMP-Polymer carries a functional group that attaches to the new polymer while it is forming. Due to the nature of the functional group, the final composites are fully cross-linked.

Briefly, a proper amount of “100-fold upscaled ROMP polymer-coated SWNTs of Example JJ28” derivatized with terminal triamines is dispersed in the epoxy monomer (e.g., bisphenol A) using shear mixing. The mixture is poured in a mold and heat is applied in order to start the curing or polymerization process. The final composite is in the form SWNT-ML-Epoxy.

### Example JJ32: In Situ Polymerization Resulting in Crosslinking Using ML-Nanotubes as Starting Points

This example is similar to JJ31. Here, instead of the “100-fold upscaled ROMP polymer-coated SWNTs of Example JJ28”, the starting material is a SWNT-ML in which the ML carries a functional group that attaches to the new polymer while it is forming. Due to the nature of the functional group, the final composites are fully cross-linked.

### Example JJ33: In Situ Polymerization Resulting in Crosslinking Using Polymer-Coated Nanotubes as Starting Points

This example is similar to JJ31 and JJ32. Here, instead of the “100-fold upscaled ROMP polymer-coated SWNTs of Example JJ28”, the starting material is a polymer-coated nanotube in which the polymer carries a functional group that attaches to the new polymer while it is forming. Due to the nature of the functional group, the final composites are fully cross-linked.

JJ34. Modification or Crosslinking of Nanotubes Coated with Various Types of Polymers.

This is a modification of Example JJ24. In this example, the starting point is a nanotube coated with another polymer than the ROMP polymer (that was used for coating in Example JJ24). In this Example JJ34 the nanotube is first coated with a given type of polymer (e.g. polyurethane), then the same polymer type (polyurethane) is attached to the coated nanotubes, or is used as a crosslinking reagent, thereby generating a “clean” polyurethane-nanotube composite. This way, the materials manufacturer can produce two types of granulates, one type consisting of polymer-coated nanotubes, the other type comprising polymers carrying a reactive group, capable of attaching said polymer to the polymer-coated nanotubes. And the final product manufacturer can then mix the two types of granulates in any ratio, and thereby easily control the concentration of nanotube and polymer in the final material.

### JJ34-1. PVC-Coated Nanotubes (“Polyvinylchloride-Coated Boron Nitride Nanotubes of Example JJ21”) Modified by Covalent Attachment of Polyvinylchloride.

Step 1: 500 gram “Polyvinylchloride-coated boron nitride nanotubes of Example JJ21” are extruded using a Brabender extruder.

Step 2: The obtained filaments are pelletized to produce “PVC-coated nanotube granulates of Example JJ34”

Step 3: Standard PVC granulates are mixed with the “PVC-coated nanotube granulates of Example JJ34” and the mixture is again introduced in the extruder.

Step 4: A crosslinking agent (e.g., isophoron diamine) is added through feeder 2 into the extruder barrel.

Step 5: The filaments obtained are pelletized to give the product “PVC-nanotube composite of Example JJ34”.

### JJ34-2. Polypropylene-Coated Nanotubes (“Polypropylene-Coated SWNTs of Example JJ21, B6”) Modified by Covalent Attachment of Polypropylene.

Step 1: 1000 g gram “Polypropylene-coated SWNTs of Example JJ21, B6” are extruded using an extruder.

Step 2: The obtained filaments are pelletized to produce “Polypropylene-coated SWNT granulates of Example JJ34”

Step 3: Standard PP granulates are mixed with the “Polypropylene-coated SWNT granulates of Example JJ34”

Step 4: The granulate mixture is heated at 180° C. in the presence of a peroxide crosslinking agent (e.g., dicumyl peroxide or tert-butyl perbenzoate).

Step 5: The obtained mixture is dried to give the product “Polypropylene-CNT composite of Example JJ34”.

### JJ34-3. Polystyrene-Coated Nanotubes (“Polystyrene-Coated Tuball SWNT of Example JJ21, B1”) Modified by Covalent Attachment of Polystyrene.

Step 1: 200 gram “Polystyrene-coated Tuball SWNT of Example JJ21, 1” are dispersed in THF employing bath sonication.

Step 2: To this dispersion, and appropriate amount of styrene is added.

Step 3: AIBN is added as polymerization initiator.

Step 4: The suspension is incubated at 50-70° C. for 6 h or irradiated with 350 nm light for 45 min and the newly formed polystyrene is attached to the remaining terminal bonds present in “Polystyrene-coated Tuball SWNT of Example JJ21, 1”.

Step 5: The final suspension is poured into methanol under stirring to give the product “Polystyrene-CNT composite of Example JJ34”.

### JJ34-4. Polyurethane-Coated Nanotubes (“Polyurethane-Coated Nanotubes of Example JJ21-B3”) Modified by Covalent Attachment of Polyurethane.

In this example, the “Polyurethane-coated nanotubes of Example JJ21-B3” are recovered before completion of the reaction. For this, in Example JJ21, B3, Step 13, the reaction is stirred for several hours and is stopped while some —NCO signals are still observed in infrared spectroscopy. We call this composite “NCO-terminated Polyurethane-coated nanotubes of Example JJ21-B3”

Step 1: 500 g “NCO-terminated Polyurethane-coated nanotubes of Example JJ21-B3” is dispersed in DMF using bath sonication.

Step 2: To this dispersion, methylene diphenyl diisocyanate (MDI) and butanediol (1 equiv. with respect to the MDI) are added.

Step 3: Optionally, dibutyltin dilaurate (DBTDL) is added to the mixture.

Step 4: The mixture is heated carefully at 95° C. under a slow stream of nitrogen.

Step 5: The reaction is stirred for several hours until no —NCO signals are observed in infrared spectroscopy.

Step 6: The mixture is cooled down and isolated by vacuum filtration to give the product “Polyurethane-CNT composite of Example JJ34”.

### JJ34-5. Epoxy Polymer-Coated Nanotubes (“Epoxy-Coated DWNTs of Example JJ21, B5”) Modified by Covalent Attachment of Epoxy Polymer.

Step 1: 1 kg “Epoxy-coated DWNTs of Example JJ21, B5” is dispersed in an epoxy resin (e.g., DER332) using shear mixing.

Step 2: To this mixture, a curing agent (e.g., 1,3-phenylenediamine) is added.

Step 3: The mixture is poured into a mold and heat is applied (100° C.) for an appropriate time. During this time, DER332 epoxy resin and the remaining hydroxyl groups in “Epoxy-coated DWNTs of Example JJ21, B5” are reacted to produce a crosslinked structure.

Step 4: The final product is cooled down to room temperature to give the product “Epoxy-CNT composite of Example JJ34”.

### JJ34-6. Polyamide-Coated Nanotubes (“Polyamide-Coated SWNTs of Example JJ21, B2”) Modified by Covalent Attachment of Nylon.

Step 1: 100 gram “Polyamide-coated SWNTs of Example JJ21, B2” and 500 g Nylon-6,6 are fed together with succinic anhydride to a twin-screw extruder at 200° C.

Step 2: The residence time of the mixture inside the extruder barrel is 10 min. During this time, the succinic anhydride is able to crosslink the terminal acid and amine groups present in Nylon-6,6 and in “Polyamide-coated SWNTs of Example JJ21, B2” (some groups remain at the ends of the polyamides in “Polyamide-coated SWNTs of Example JJ21, B2”).

Step 3: After this time, a fiber is obtained and pelletized to give the product “Polyamide-CNT composite of Example JJ34”.

In Examples JJ34-1 to JJ34-6, the polymer types that are used for coating are also used to make the final composite. However, one polymer may be used for the coating and another polymer may be used for the preparation of the final composite, as was exemplified for ROMP-coating followed by attachment of various polymers in the final composite prepared in Example JJ24.

### Example JJ35. How to Produce Polymers Carrying Only One Reactive Group for Linking to ML on Nanotube

Approaches for linking premade polymers to nanotubes, that does not or does result in crosslinking of separate nanotubes require the preparation of polymers that carry only one reactive group. Here follows a number of approaches for making polymers that carry just one reactive group for linking to the ML attached to the nanotube:
1. The formation of double bonds through β-H elimination
2. Polymerization with designed-initiators (end-capping method) (e.g., the polymerization initiator can be derivatized with different functionalities that will remain in the polymer after the polymerization process finishes. In addition to performing the initiating function, the functional initiator must form a stable bond with the polymer chain).
3. Employing chain transfer agents (e.g., in the RAFT polymerization, the functional group present on the chain transfer agent is retained at the end of the polymerization, allowing for the incorporation of different functional groups that can be further transformed into double bonds.
4. Employing different terminating agents
5. By copolymerization with dienes

### Example JJ36. Ring-Closing of a Macrocycle Around Tuball SWNTs

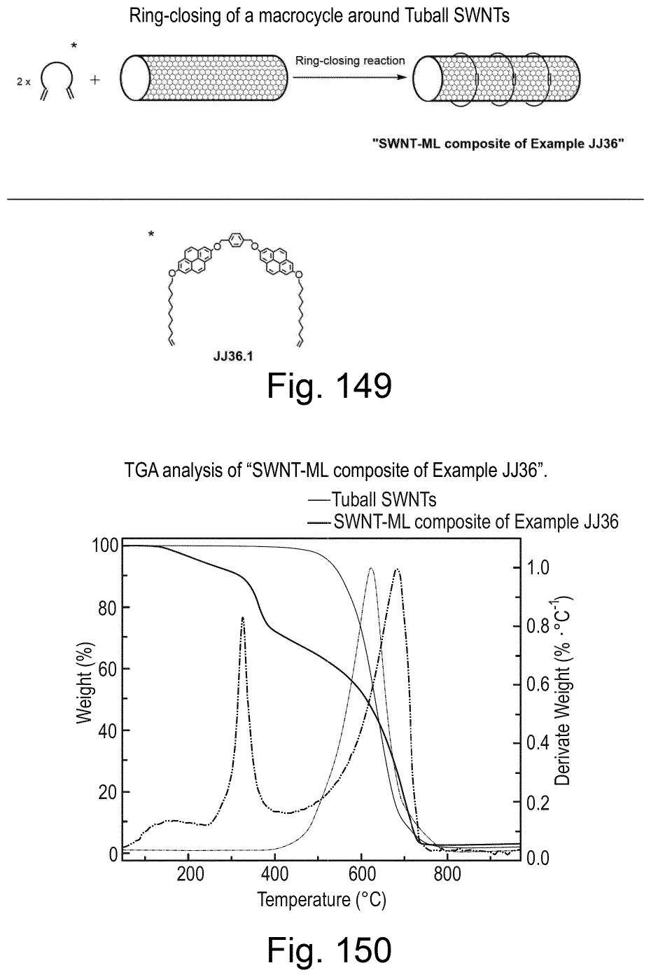

In this example, a nanotube-ML complex is formed. Two precursor-MLs bind first to the nanotube and the ends of each precursor-ML are reacted with the ends of the opposite precursor-ML leading to a macrocycle. The nanotube is a Tuball single-wall carbon nanotube (SWNT), with diameters ranging from 1.0 to 2.0 nm. The precursor-ML (compound JJ36.1) is a linear molecule with structure shown in FIG. 149 and the mechanical ligand (ML) is a covalently closed ring structure comprising two precursor-ML units.

The procedure is reproduced from López-Moreno et al. Chem. Commun. 2015, 51, 5421, DOI: 10.1039/C40008970G and can be divided in 6 steps:

Step 1. 6.00 g Tuball single-walled carbon nanotubes were dispersed in tetrachloroethane (TCE, 6 L, 1 mg/mL) by sonication in a bath sonicator (10 min).

Step 2. To this dispersion, the precursor-ML (compound (JJ36-1)) (5.25 g, 6.00 mmol) was added.

Step 3. The mixture was degassed with N₂ and Grubbs second-generation catalyst was added (5.00 g, 6.00 mmol, 1 equiv. with respect to compound (JJ36-1)).

Step 4. The reaction was maintained for 72 h at room temperature, allowing the full completion of the ring-closing metathesis reaction.

Step 5. After this time, the suspension was filtered through a 0.45 μm-pore size polytetrafluoroethylene (PTFE) membrane. The solid obtained was removed from the filter and washed with dichloromethane employing 10 min sonication. This cleaning procedure was repeated three times, until the filtration solvent was nearly colorless. A final wash with Et₂O was performed and the solvent traces were removed by drying at 100° C. for 15 min.

The resulting composite material contains SWNTs with covalently closed ring structures mechanically linked around them and is termed “SWNT-ML composite of Example JJ36”.

The composition of “SWNT-ML composite of Example JJ36” was studied by TGA and aberration corrected high resolution transmission electron microscopy (AC-HRTEM). Both techniques confirm that the composite consists of single-walled carbon nanotubes (SWNT) with cyclic molecules closed around them.

### Example JJ37. TGA Analysis of “SWNT-ML Composite of Example JJ36”

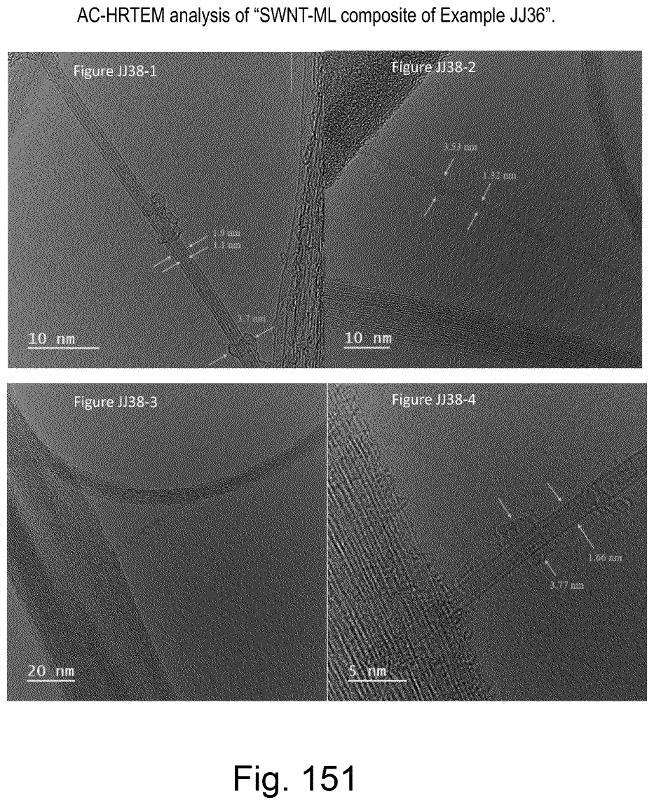

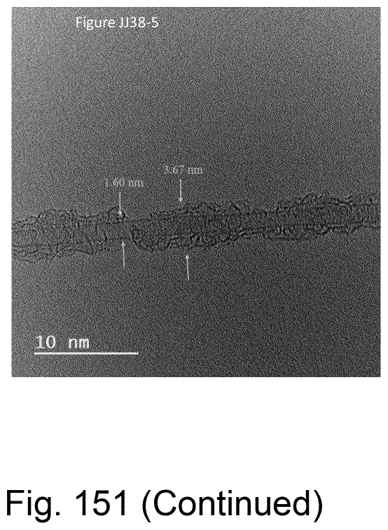

Thermogravimetric analysis of “SWNT-ML composite of Example JJ36” was performed in the powder sample obtained in Step 5 from Example JJ36, see (FIG. 150). The sample was heated in Air at a rate of 10° C./min. For comparison, a sample of Tuball SWNTs was analyzed under the same conditions.

The Tuball SWNT sample decomposes at around 550° C. due to the SWNT degradation under Air. In “SWNT-ML composite of Example JJ36”, a new loss in weight appears at earlier temperatures (around 300° C.). This weight is ascribed to the degradation of the cyclic molecules around the SWNTs and corresponds to a total weight loss of 28%. The “SWNT-ML composite of Example JJ36” therefore consists of 72% SWNTs and 28% macrocycles.

### Example JJ38. AC-HRTEM Analysis of “SWNT-ML Composite of Example JJ36”

In this example, it is shown that carbon nanotubes of at least 3 different diameters and carrying macrocycles are detected in the same carbon nanotube preparation. Both SWNT and DWNTs carrying macrocycles are detected.

For the AC-HRTEM analysis of “SWNT-ML composite of Example JJ36” the sample was prepared following the next steps:

Step 1: 0.1 mg “SWNT-ML composite of Example JJ36” were dispersed in 10 mL iPrOH using bath sonication (15 mins).

Step 2: 5 mL extra iPrOH were added to the dispersion obtained in Step 1 and it was bath sonicated again for 15 min.

Step 3: Sonication was stopped when the fragments of “SWNT-ML composite of Example JJ36” could not be spotted in the dispersion.

Step 4: Several drops (around 40) of the dispersion obtained in Step 3 were drop casted on the surface of the HRTEM grid (holey carbon, cu 300 mesh).

Step 5: The grids were dried under vacuum and studied in AC-HRTEM.

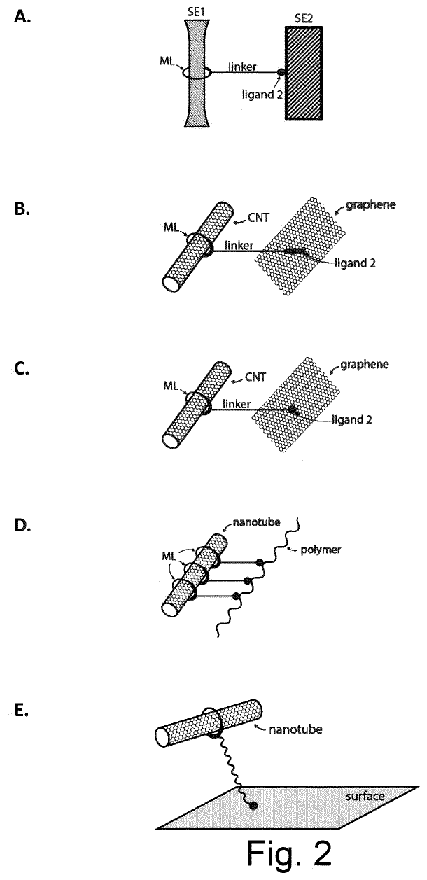

The images obtained by AC-HRTEM confirmed the presence of SWNTs with different diameters carrying macrocycles (e.g., FIG. 151-2 (1.32 nm-wide SWNT), FIGS. 151-3 and 151-4 (1.66 nm-wide SWNT) and FIG. 151-5 (1.60 nm-wide SWNT) carrying all of them macrocycles of 3.53-3.77 nm-diameter).

Also, the reaction was effective in the functionalization of DWNTs (FIG. 151-1, 1.1 nm-wide internal SNWT and 1.9 nm-wide external SWNT carrying a 3.7 nm-diameter macrocycle).

### Examples ZZ1

Preparation of precursor-MLs (i.e. precursor mechanical ligands) that can ring-close around nanotubes is described.

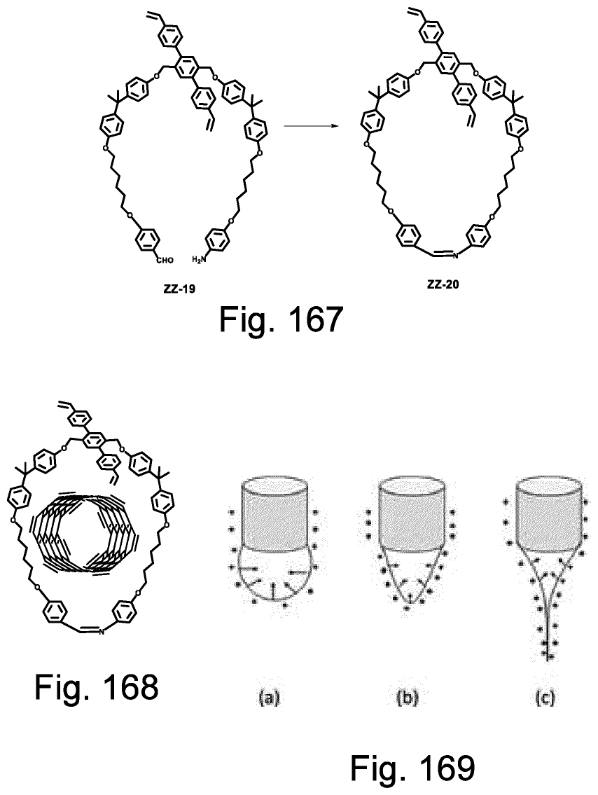

Preparation of compound ZZ-3, as shown in (FIG. 167, scheme 1).

Step 1, compound ZZ-1 is obtained by Williamson's etherifications from 1,6-dibromohexane and 4-bromophenol.

Step 2, compound ZZ-2 is obtained by similar Williamson's etherifications from compound ZZ-1 and bisphenol A.

Step 3, compound ZZ-3 is obtained by similar Williamson's etherifications from compound ZZ-2 and 1,4-bis-bromomethyl-benzene.

### Examples ZZ2

Formation of macrocyclic molecule around a single-walled carbon nanotube by ring-closing of a linear molecule comprising bisphenol A (BPA) motifs through Yamamoto coupling is described.

In this example, nanotube-ML complex is formed, by first binding a precursor-ML to the nanotube, and then reacting to the two ends of the precursor-ML to form a closed ring around the nanotube. The nanotube is a single-wall carbon nanotube (SWNT), the precursor-ML is a linear molecule, and the mechanical ligand (ML) is a covalently closed ring structure comprising bisphenol A (BPA) motifs.

Step 1, 10 mg purified single-walled carbon nanotubes (according to example B**.*, purchased from Sigma-Aldrich ((6,5) chirality, ≥95% carbon basis (≥95% as carbon nanotubes), 0.78 nm average diameter) are dispersed in toluene (5 mL) and DMF (5 mL) by sonication in a bath sonicator.

Step 2. The suspension of step 1 is mixed with 0.01 mmol compound ZZ-3 (a linear molecule), shown in (FIG. 158).

Step 3. A mixture of bis(cyclooctadiene)nickel(0) (Ni(cod)₂), 2,2′-bipyridine and 1,5-cyclooctadiene in toluene and N, N-Dimethylformamide (DMF) are heated at 80° cfor 30 minteus under nitrogen (N₂).

Step 4. The suspension of step 3 is added to the suspension of step 2. The mixture is refluxed for 18 h under nitrogen (N₂).

Step 5. The suspension is filtered through a 0.2 μm pore-size polytetrafluoroethylene (PTFE) membrane and washed profusely with dichloromethane (DCM).

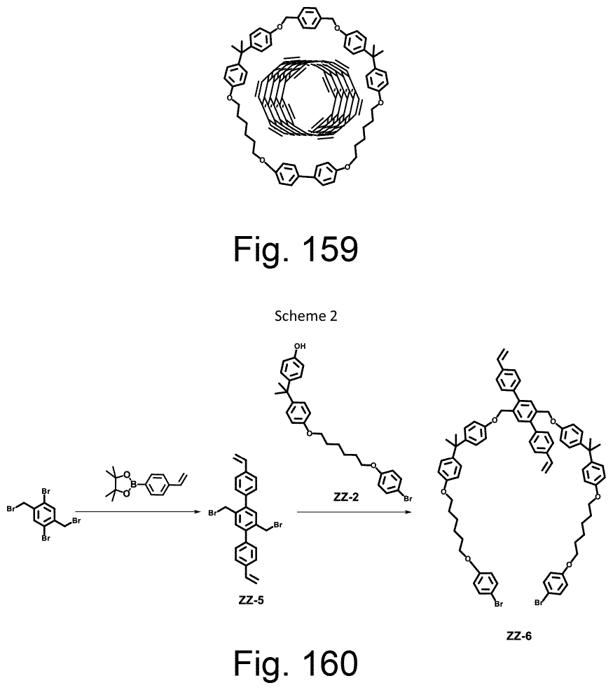

Step 6. The solid is removed from the filter, sonicated for 10 minutes in 10 mL DCM and filtered through a 0.2 μm PTFE membrane. This washing procedure is repeated three times. The resulting single-walled carbon nanotubes (SWNTs) with cyclic molecules close around them as depicted in (FIG. 159). Thus, the cyclic molecule, compound ZZ-4 have formed around the SWNTs, respectively. The resulting SWNTs with cyclic molecules closed around them are named “SWNT-compound ZZ-4 complexes of Example ZZ2”.

### Examples ZZ3

Preparation of precursor-MLs (i.e. precursor mechanical ligands) that can ring-close around nanotubes is described.

Preparation of compound ZZ-6, as shown in (FIG. 160, scheme 2).

Step 1, compound ZZ-5 is obtained by transition metal catalyzed Suzuki coupling from 2-(4-ethenylphenyl)-4,4,5,5-tetramethyl-1,3,2-dioxaborolane and 1,4-Dibromo-2,5-bis(bromomethyl)benzene in the presence of cesium carbonate (Cs₂CO₃) and tetrakis(triphenylphosphine)palladium (Pd(PPh₃)4) in a mixture of toluene, ethanol, and water.

Step 2, compound ZZ-6 is obtained by Williamson's etherifications from compound ZZ-5 and ZZ-2 from example ZZ1.

### Examples ZZ4

Formation of macrocyclic molecule around a single-walled carbon nanotube by ring-closing of a linear molecule comprising styrene motifs through Yamamoto coupling is described.

In this example, nanotube-ML complex is formed, by first binding a precursor-ML to the nanotube, and then reacting to the two ends of the precursor-ML to form a closed ring around the nanotube. The nanotube is a single-wall carbon nanotube (SWNT), the precursor-ML is a linear molecule, and the mechanical ligand (ML) is a covalently closed ring structure comprising styrene motifs.

Step 1, 10 mg purified single-walled carbon nanotubes (according to example B**.*, purchased from Sigma-Aldrich ((6,5) chirality, ≥95% carbon basis (≥95% as carbon nanotubes), 0.78 nm average diameter) are dispersed in toluene (5 mL) and DMF (5 mL) by sonication in a bath sonicator.

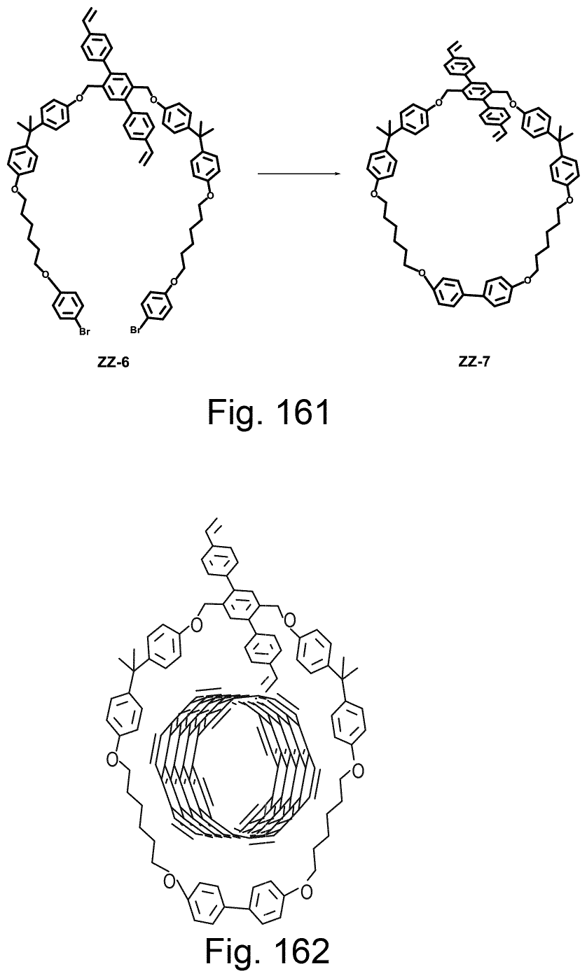

Step 2. The suspension of step 1 is mixed with 0.01 mmol compound ZZ-6 (a linear molecule), shown in (FIG. 161).

Step 3. A mixture of bis(cyclooctadiene)nickel(0) (Ni(cod)₂), 2,2′-bipyridine and 1,5-cyclooctadiene in toluene and N, N-Dimethylformamide (DMF) are heated at 80° C. for 30 minutes under nitrogen (N₂).

Step 4. The suspension of step 3 is added to the suspension of step 2. The mixture is refluxed for 18 h under nitrogen (N₂).

Step 5. The suspension is filtered through a 0.2 μm pore-size polytetrafluoroethylene (PTFE) membrane and washed profusely with dichloromethane (DCM).

Step 6. The solid is removed from the filter, sonicated for 10 minutes in 10 mL DCM and filtered through a 0.2 μm PTFE membrane. This washing procedure is repeated three times. The resulting single-walled carbon nanotubes (SWNTs) with cyclic molecules close around them as depicted in (FIG. 162). Thus, the cyclic molecule, compound ZZ-7 have formed around the SWNTs, respectively. The resulting SWNTs with cyclic molecules closed around them are named “SWNT-compound ZZ-7 complexes of Example ZZ4”.

The terminal vinyl group can be used for linking to e.g. a polymer, by the formation of the covalent bond. Modification of the terminal amino group with different functional groups can also control the dispersibility of these SE-ML-Linker complex in different solvents, such as water, methanol, ethanol, acetonitrile, benzene, and so on.

### Examples ZZ5

Preparation of precursor-MLs (i.e. precursor mechanical ligands) that can ring-close around nanotubes is described.

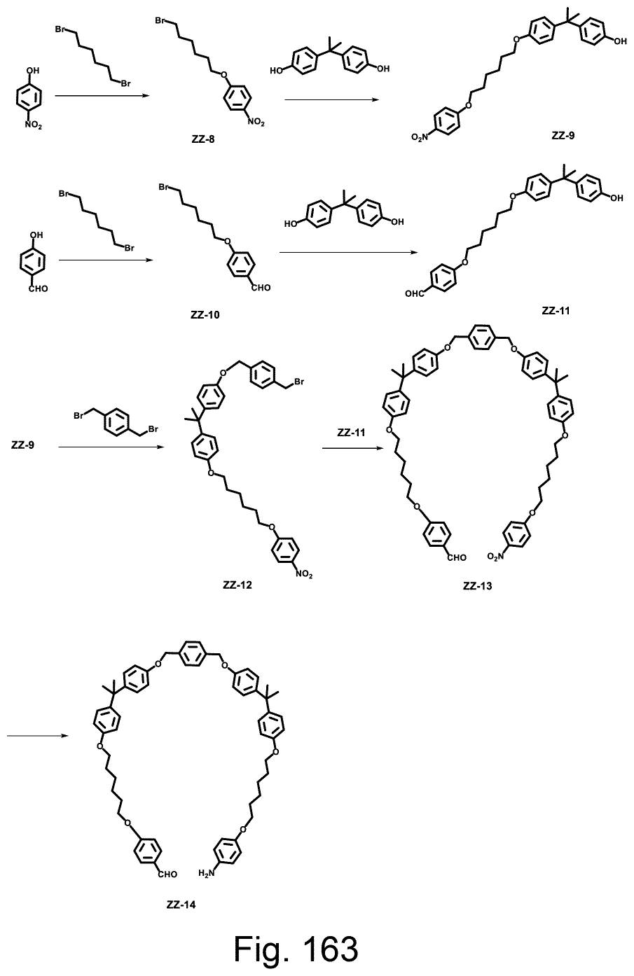

Preparation of compound ZZ-14, as shown in (FIG. 163, scheme 3).

Step 1, compound ZZ-8 is obtained by Williamson's etherifications from 1,6-dibromohexane and 4-nitrophenol.

Step 2, compound ZZ-9 is obtained by Williamson's etherifications from compound ZZ-8 and bisphenol A.

Step 3, compound ZZ-10 is obtained by Williamson's etherifications from 1,6-dibromohexane and 4-hydroxybenzaldehyde.

Step 4, compound ZZ-11 is obtained by Williamson's etherifications from compound ZZ-10 and bisphenol A.

Step 5, compound ZZ-12 is obtained by Williamson's etherifications from compound ZZ-9 and 1,4-bis-bromomethyl-benzene.

Step 6, compound ZZ-13 is obtained by Williamson's etherifications from compound ZZ-11 and ZZ-12.

Step 7, compound ZZ-14 is obtained by reduction of the nitro group of compound ZZ-13.

### Example ZZ6

Formation of macrocyclic molecule around a single-walled carbon nanotube by ring-closing of a linear molecule comprising imines motifs is described.

In this example, nanotube-ML complex is formed, by first binding a precursor-ML to the nanotube, and then reacting to the two ends of the precursor-ML to form a closed ring around the nanotube. The nanotube is a single-wall carbon nanotube (SWNT), the precursor-ML is a linear molecule, and the mechanical ligand (ML) is a covalently closed ring structure comprising imines motifs.

Step 1, 10 mg purified single-walled carbon nanotubes (according to example B**.*, purchased from Sigma-Aldrich ((6,5) chirality, ≥95% carbon basis (≥95% as carbon nanotubes), 0.78 nm average diameter) are dispersed in 10 mL tetrachloroethane (TCE) by sonication in a bath sonicator.

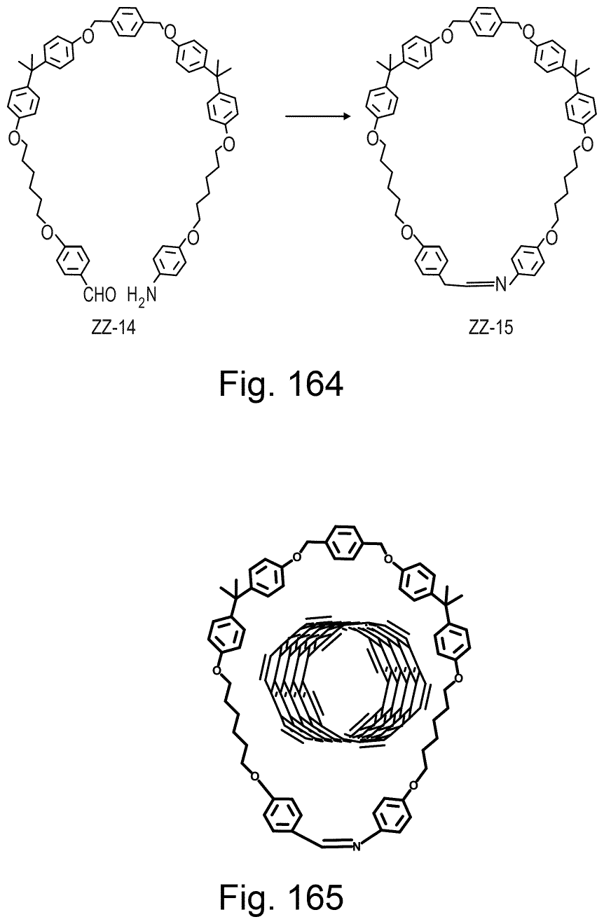

Step 2. The suspension of step 1 is mixed with 0.01 mmol compound ZZ-14 (a linear molecule), shown in (FIG. 164).

Step 3. The mixture is bubbled with nitrogen (N₂) for 10 minutes.

Step 4. The reaction is stirred for 72 hours at 80° C. under nitrogen (N₂).

Step 5. The suspension is filtered through a 0.2 μm pore-size polytetrafluoroethylene (PTFE) membrane and washes profusely with dichloromethane (DCM).

Step 6. The solid is removed from the filter, sonicated for 10 minutes in 10 mL DCM and filtered through a 0.2 μm PTFE membrane. This washing procedure is repeated three times. The resulting single-walled carbon nanotubes (SWNTs) with cyclic molecules close around them as depicted in (FIG. 165). Thus, the cyclic molecule, compound ZZ-15 have formed around the SWNTs, respectively. The resulting SWNTs with cyclic molecules close around them were named “SWNT-compound ZZ15 complexes of Example ZZ6”.

### Examples ZZ7

Preparation of precursor-MLs (i.e. precursor mechanical ligands) that can ring-close around nanotubes is described.

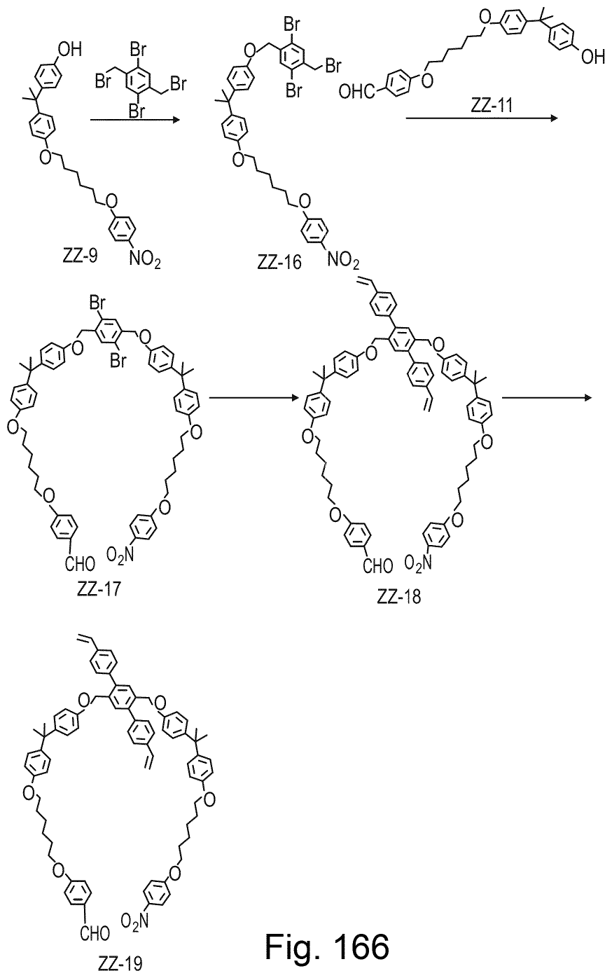

Preparation of compound ZZ-19, as shown in (FIG. 166, scheme 4).

Step 1, compound ZZ-16 is obtained by Williamson's etherifications from ZZ-9 (from example ZZ5) and 1,4-Dibromo-2,5-bis(bromomethyl)benzene.

Step 2, compound ZZ-17 is obtained by Williamson's etherifications from compound ZZ-16 and ZZ-11 (from example ZZ5).

Step 3, compound ZZ-18 is obtained by transition metal catalyzed Suzuki coupling from 2-(4-ethenylphenyl)-4,4,5,5-tetramethyl-1,3,2-dioxaborolane and compound ZZ17 in the presence of cesium carbonate (Cs₂CO₃) and tetrakis(triphenylphosphine)palladium (Pd(PPh₃)4) in a mixture of toluene, ethanol and water.

Step 4, compound ZZ-19 is obtained by reduction of the nitro group of compound ZZ-18.

### Examples ZZ8

Formation of macrocyclic molecule around a single-walled carbon nanotube by ring-closing of a linear molecule comprising imines motifs is described.

In this example, nanotube-ML complex is formed, by first binding a precursor-ML to the nanotube, and then reacting to the two ends of the precursor-ML to form a closed ring around the nanotube. The nanotube is a single-wall carbon nanotube (SWNT), the precursor-ML is a linear molecule, and the mechanical ligand (ML) is a covalently closed ring structure comprising styrene motifs.

Step 1, 10 mg purified single-walled carbon nanotubes (according to example B**.*, purchased from Sigma-Aldrich ((6,5) chirality, ≥95% carbon basis (≥95% as carbon nanotubes), 0.78 nm average diameter) are dispersed in 10 mL tetrachloroethane (TCE) by sonication in a bath sonicator.

Step 2. The suspension of step 1 is mixed with 0.01 mmol compound Z-19 (a linear molecule), shown in (FIG. 167).

Step 3. The mixture is bubbled with nitrogen (N₂) for 10 minutes.

Step 4. The reaction is stirred for 72 hours at 80° C. under nitrogen (N₂).

Step 5. The suspension is filtered through a 0.2 μm pore-size polytetrafluoroethylene (PTFE) membrane and washes profusely with dichloromethane (DCM).

Step 6. The solid is removed from the filter, sonicated for 10 minutes in 10 mL DCM and filtered through a 0.2 μm PTFE membrane. This washing procedure is repeated three times. The resulting single-walled carbon nanotubes (SWNTs) with cyclic molecules close around them as depicted in FIG. 168. Thus, the cyclic molecule, compound ZZ-20 have formed around the SWNTs, respectively. The resulting SWNTs with cyclic molecules close around them are named “SWNT-compound ZZ20 complexes of Example ZZ8”.

| | precursor- | | | |
|---|---|---|---|---|
| | MLs for | Ring-closing through | | Ring-closing through |
| | Yamamoto | Yamamoto coupling for | | the formation of |
| | coupling | MINTs | precursor-MLs for imine | imine for MINTs |
| Example | Example | Example ZZ2, 4 | Example ZZ5, 7 | Example ZZ6, 8 |
| | ZZ1, 3 | | | |
| Synthetic | Feasible | Little complicated. | Less feasible: | Feasible. |
| scheme | | The reaction needs to | 1, morn than 5 steps for | |
| | | be performed in inert | the target molecular. | |
| | | atmospheres. | 2, reduction of the nitro | |
| | | | group need to try | |
| | | | different reaction | |
| | | | conditions. | |
| Efficiency | | Good | | Good |
| Chemical | | Very good | | Good |
| stability | | | | |
| Further | | 1, Br group could be | | Similar to Example |
| functional- | | functionalized with | | ZZ2, 4. |
| ization | | different groups. | | |
| | | 2, compared with MINTs | | |
| | | prepared through ring- | | |
| | | closing metathesis, the | | |
| | | vinyl group can also be | | |
| | | functionalized. | | |

| | | |
|---|---|---|
| Further | Bisphenol A (BPA) motifs can be | More synthetic steps are needed to use pyrene, |
| variation | substituted by pyrene, exTTF, NDI | exTTF, or NDI to replace bisphenol A (BPA) motifs. |

### Example SS9. Protocol to Prepare PC/CNT Composite Materials by Electrospinning

This is an example of Polycarbonate (PC) electrospun polymer fibers reinforced with carbon nanotubes as nanofillers. PC (Polycarbonate resin, ˜Mw 45,000, pellets) can be purchased from ACROS Organics (Thermo Fisher Scientific Company). In order to dissolve the polymer as well as dispersed CNTs, dimethylformamide (DMF) and solvent mixtures such as dimethylformamide:tetrahydrofuran (50:50) or dimethylformamide: chloroform (65:35) are preferred to prepare this type of composites. All the solvents used should be dried. Dry DMF and THF can be directly used from a Solvent Purification System (SPS) or can be purchased by Across Organics. Likewise, both solvent can be distillate as is described in the “Example SS2. Protocol to distillate tetrahydrofuran (THF)”. DMF distillation is not recommended because high temperatures are required. Chloroform can be effectively dried following protocol guidelines of “Example SS3. Protocol to dry through activated alumina or silica column”.

Step 1. To optimize the electrospinning equipment, 20% PC solution is prepared. The viscosity of the solution should be higher than water viscosity obtaining a solution with syrup-like texture that be able to flow through the walls of the flask. In case of obtaining a slightly viscous solution, the polymer concentration can be increased to 22%, 25%, etc.

Step 2. The solution prepared in the step 1 is tested on the equipment in order to know if the electrospinning process can be carried out. The viscosity of the polymeric solution is adequate when a cone shape, known as Taylor Cone, is achieved at the capillary tip, see (c) immediately below.

Taylor cone formation at the capillary tip of a solution-filled syringe subjected to an electric field. The arrows depict the surface tension and the charge depicts the electrostatic charge. (a) Solution held by high surface tension, (b) increased electrostatic charge aids to overcome the surface tension, (c) at critical voltage the solution overcomes the surface tension and the electric charge causes the solution to elongate and accelerate toward a grounded collector.

Step 3. Voltage, flow rate and distance of the capillary tip to the collector are parameters that can be modulated in the course of the experiment. To find out which parameters are appropriate, the fibers deposited in a collector previously covered by aluminum foil are checked by optical microscopy. If the fibers observed under the optical microscope have similar diameters and a homogeneous surface without defects then, the parameters for the processing PC fibers would be optimized.

Step 4. Scanning Electron Microscopy (SEM) micrographs can be taken to ensure that fibers present seamless and uniform surfaces without discernible beads (spherical defects).

Step 5. Once the electrospinning parameters for the pure polymer are optimized, fibers loaded with different CNTs-nanofillers are tested. To fabricate polymer/CNT fiber composites, a suspension of CNTs (i.e. 1 mg of SWNTs in 100 mL, 10 mg of CVD in 100 mL, . . . ) in the selected solvent or solvent mixture of the step 1 is sonicated at 20° C. obtaining a stable suspension without visible aggregates. Note that the more nanotubes quantity is used, the more difficult it is to disperse the sample.

Step 6. UV-Vis spectra of the stable suspension prepared in step 5 are collected and the absorbance of the suspension is adjusted to 0.1 by the addition of the selected solvent or solvent mixture of the step 1.

Step 7. A solution of PC polymer at the adjusted concentration with the electrospinning equipment (from step 1 to step 3) is prepared from the stable suspension of the Step 6. The viscous solution is vigorously stirred at room temperature overnight until all the polymer is dissolved.

Step 8. The polymeric suspension of CNTs is transferred to a syringe connected to tube (Tube E—0.8 mm tubing with male luer to female ¼″-28 adaptor and female luer to female ¼″-28 adaptor, purchased from Spraybase) that is placed in an electrospinning equipment. The viscous suspension is then pumped to a specific flow and voltage. Again, flow rate, voltage and distance can be modulated in the course of the experiment as is described in the step 3.

The selected parameters should ensure the cone shape of the polymeric injected solution at the capillary tip.

Step 9. Polymer fibers are deposited on a collector previously covered with aluminum foil and the homogeneity of the collected fibers is checked by optical microscopy and later by SEM microscopy.

Step 10. From polymer fibers which are deposited on the collector, rectangular shaped samples are cut with thicknesses between 0.08 and 0.10 mm and dimensions of 1×4 cm.

Mechanical properties are determined using a dynamic mechanical analyzer (DMA Q800, TA Instruments) and stress-strain curves can be recorded at selected rate measured in N/min.

### REFERENCES

J. Mat. Sci., 2004, 19, 4605-4613
Polymer., 2005, 46, 7346-7351.
Adv. Mat. Lett. 2010, 1(3), 200-204

### Example WW1. Composites of PEA Cured Epoxy-Carbon Nanotubes, Employing Different Type of SWNTs-ML

This example adapts from the Example B24.6 and describes the PEA cured epoxy-carbon nanotubes composites using SWNTs-ML carrying anhydride groups.

The used epoxy monomer (D.E.R.™ 332), curing agent (PEA (D-230)), and purified (6,5)-SWNTs remain the same with those in Example B24.6.

The purified (6,5)-SWNTs are functionalized by the formation of the pyrene-based cyclic molecules with anhydride groups (compound W-4) around the carbon nanotubes, which is named as “SWNTs-ML-anhydride-1 of Example B24.x”, as described in Example B24.x. Another functionalized (6,5)-SWNTs, named as “SWNTs-ML-anhydride-2 of Example B24.x” are prepared by the formation of the bisphenol A-based cyclic molecules with anhydride groups (compound W-5) around the carbon nanotubes, following the protocol described in Example B24.x.

Composites are prepared by separately dispersing CNTs, comprising “SWNTs-ML-anhydride-1 of Example B24.x” and “SWNTs-ML-anhydride-2 of Example B24.x”, into epoxy monomer (D.E.R.™ 332) using sonicator to get the CNTs suspensions according to the same sonification process in “Step 1 of Example B24.6”. Curing agent PEA (D-230) is mixed into each CNTs suspensions by stirring manually for 1 min. Each mixture is poured into the Teflon molds for vacuum degas and curing at 80° C. for 2 hr, followed by post-cure at 130° C. for 4 hr. SWNT loadings with respect to total weight of cured epoxy specimen is 0.1% (w/w).

The curing process and the crosslinking degree of the cured epoxy resin can be modified by using different ratios of D.E.R.™ 332 and PEA (D-230). For example, the molar ratio of epoxy groups to reactive hydrogen in amide group could be 1:1; 1.5:2; 1.75:2; 2:1.5; 2:1.75; or any other ratio, as desired.

If desired, other SWNT loadings can be applied. For example, SWNT loadings with respect to total weight of cured epoxy specimen can be lower (e.g. 0.01%), or higher (e.g. 1%, 5%, 20%), or any other loading Mechanical properties of the obtained composite samples can be tested in different ways.

For example, tensile strength and Young's modulus etc. can be determined using a universal tensile machine (INSTRON XXX) based on the same process in step 4 of Example B24.4. Many other types of strength, as well as many characteristics other than strength, can be measured.

In conclusion, this example describes the generation of epoxy-CNTs composite employing the epoxy monomer (D.E.R.™ 332), curing agent (MDA), and SWNTs-ML carrying anhydride groups.

### Example WW2. Composites of Epoxy-Carbon Nanotube, Employing Different Type of Epoxy Resin Based on Alternative Amine Curing Agent

This example describes the use of a different amine curing agent, namely 4,4′-Methylenedianiline (MDA), to get the epoxy-carbon nanotubes composite.

The used epoxy monomer (D.E.R.™ 332) and purified (6,5)-SWNT remain the same with those in Example B24.6. An amine curing agent, 4,4′-Methylenedianiline (MDA), was used and purchased from Sigma-Aldrich. “SWNTs-ML-amide-1 of Example B24.6.”, “SWNTs-ML-amide-2 of Example B24.6”, “SWNTs-ML-anhydride-1 of Example B24.x” and “SWNTs-ML-anhydride-2 of Example B24.x” are prepared by the functionalization of SWNTs as described in Example B24.X, Example B24.X, Example B24.X, and Example B24.X, respectively.

Composites are prepared by separately dispersing each SWNTs-ML into epoxy monomer by the sonication. The sonification process prefers following the “Step 1 of Example B24.6” to get the CNTs suspensions. Each CNT suspension is separately mixed with MDA curing agent by stirring, and then is poured into the Teflon molds for vacuum degas and curing at the initial temperature of 80° C. for 2 hr, followed by the post-cure at 100° C. and 140° C. for 1 hr each. SWNT loadings with respect to total weight of cured epoxy specimen is 0.1% (w/w).

The curing process and the crosslinking degree of the cured epoxy resin can be modified by using different ratios of D.E.R.™ 332 and MDA. For example, the molar ratio of epoxy groups to reactive hydrogen in amide group could be 1:1; 1.5:2; 1.75:2; 2:1.5; 2:1.75; or any other ratio, as desired.

If desired, any other epoxy monomers, such as the type of glycidyl ether, glycidyl ester, glycidyl amine resins, alicyclic epoxy, aliphatic epoxy etc., can be used in a similar process instead of the D.E.R.™ 332 described in the process above.

If desired, other amine curing agents can be used to replace the MDA. The curing process temperature can be adjusted based on the characteristic of curing agent. For example, for the curing agent DETA, the curing process could start from 60° C., followed the multistep curing until 145° C. While for diaminodiphenyl-methane (DDM), the curing may be finally conducted at above 200° C.

If desired, other SWNT loadings can be applied. For example, SWNT loadings with respect to total weight of cured epoxy specimen can be lower (e.g. 0.01%), or higher (e.g. 1%, 5%, 20%,), or any other loading, as desired.

If desired, SWNTs-ML based on other kind of SWNTs (e.g. (6,6)-SWNTs, (6,7)-SWNTs or any other CNTs as desired) can be used and functionalized.

In conclusion, this example describes the generation of epoxy-CNTs composite employing the epoxy monomer, amine curing agent, and SWNT-ML carrying amino and anhydride groups.

### Example WW3. Composites of Epoxy-Carbon Nanotube, Employing Different Type of Epoxy Resin Based on Catalytic Curing Agent

This example describes the use of catalytic curing agent, namely 2-Ethyl-4-methylimidazole (2E4MZ), to get the epoxy-carbon nanotubes composite.

The used epoxy monomer (D.E.R.™ 332) and purified (6,5)-SWNT remain the same with those in Example B24.6. A catalytic curing agent, 2-Ethyl-4-methylimidazole (2E4MZ), is used and purchased from Sigma-Aldrich. “SWNTs-ML-amide-1 of Example B24.6.”, “SWNTs-ML-amide-2 of Example B24.6”, “SWNTs-ML-anhydride-1 of Example B24.x” and “SWNTs-ML-anhydride-2 of Example B24.x” are prepared by the functionalization of SWNTs as described in Example B24.X, Example B24.X, Example B24.X, and Example B24.X, respectively.

Composites can be prepared by separately dispersing each SWNTs-ML into epoxy monomer by the sonication. The sonification process prefers following the “Step 1 of Example B24.6” to get CNTs suspensions. The 2E4MZ curing agent is separately mixed with CNTs suspensions by stirring, and then is poured into the Teflon molds for vacuum degas and curing at 70° C. for 2 hr, followed by the post-cure at 120° C. for 1 hr each. SWNT loadings with respect to total weight of cured epoxy specimen is 0.1% (w/w).

The curing process and the crosslinking degree of the cured epoxy resin can be modified by using different addition amount of 2E4MZ. For example, the concentration of 2E4MZ with respect to total weight of cured epoxy specimen is suggested to range in 1%-8% (w/w) or any other amount, as desired.

If desired, other epoxy monomers, such as the type of glycidyl ether, glycidyl ester, glycidyl amine resins, alicyclic epoxy, aliphatic epoxy etc., can be used in a similar process instead of the D.E.R.™ 332 described in the process above.

If desired, other catalytic curing agent for epoxy, such as N,N-Dimethylbenzylamine (BDMA), boron trifluoride ethylamine complex, 2-Phenylimidazole (2PZ), 2,4,6-tris(dimethylaminomethyl)phenol (DMP-30) etc., can be used to replace the 2E4MZ. The curing condition can be adjusted based on the characteristic of each curing agent.

If desired, other SWNT loadings can be applied. For example, SWNT loadings with respect to total weight of cured epoxy specimen can be lower (e.g. 0.01%), or higher (e.g. 1%, 5%, 20%,), or any other loading, as desired.

If desired, SWNTs-ML based on other kind of SWNTs (e.g. (6,6)-SWNTs, (6,7)-SWNTs or any other CNTs as desired) can be used and functionalized.

In conclusion, this example describes the generation of epoxy-CNTs composite employing the epoxy monomer, catalytic curing agent, and SWNTs-ML.

### Example WW4. Composites of Epoxy-Carbon Nanotube, Employing Different Type of Epoxy Resin Based on Anhydride Curing Agent

This example describes the use of anhydride curing agent, namely Methylcyclohexene-1,2-dicarboxylic Anhydride (Me-THPA), to get the epoxy-carbon nanotube composite.

The used epoxy monomer (D.E.R.™ 332) and purified (6,5)-SWNT remain the same with those in Example B24.6. Anhydride curing agent Methylcyclohexene-1,2-dicarboxylic Anhydride (Me-THPA) and curing accelerant 2,4,6-tris(dimethylaminomethyl)phenol (DMP-30) are purchased from Sigma-Aldrich. SWNTs-ML (e.g. “SWNTs-ML-amide-1 of Example B24.6.”, “SWNTs-ML-amide-2 of Example B24.6”, “SWNTs-ML-anhydride-1 of Example B24.x”, “SWNTs-ML-anhydride-2 of Example B24.x”) remain the same with those in Example WW-2.

Composites can be prepared by separately dispersing each CNTs into epoxy monomer D.E.R.™ 332 by the sonication to get CNTs suspensions. The sonification process prefers following the “Step 1 of Example B24.6”. Curing accelerant DMP-30 and curing agent Me-THPA are successively mixed with each CNT suspensions by stirring for 2 min, and then the mixture is poured into the Teflon molds for vacuum degas and curing at 100° C. for 2 hr, followed by the post-cure at 150° C. for 5 hr each. SWNTs loadings with respect to total weight of cured epoxy specimen is 0.1% (w/w).

The curing process and the crosslinking degree of the cured epoxy resin can be modified by using different ratios of D.E.R.™ 332 and Me-THPA. For example, the molar ratio of epoxy groups to anhydride group could be 1:07; 1:0.85; 1:1; 1.2:1; or any other ratio, as desired.

The concentration of curing accelerant with respect to total weight of cured epoxy specimen is suggested to be in range of 0.5%-5% (w/w) or any other concentration.

If desired, any other epoxy monomers, such as the type of glycidyl ether, glycidyl ester, glycidyl amine resins, alicyclic epoxy, aliphatic epoxy etc., can be used in a similar process instead of the D.E.R.™ 332 described in the process above. The epoxy monomers should be used above their melt temperature.

If desired, any other anhydride curing agents can be used to replace the Me-THPA. The curing conditions can be adjusted based on the characteristic of each curing agent. For example, for the curing agent phthalic anhydride, the curing process could be 150° C. for 6 hr.

If desired, other curing accelerant, including the type of tertiary amine, tertiary ammonium salt, imidazole, imidazole salt, boron trifluoride complex etc., can be used to replace DMP-30 described in the process above.

If desired, other SWNT loadings can be applied. For example, SWNT loadings with respect to total weight of cured epoxy specimen can be lower (e.g. 0.01%), or higher (e.g. 1%, 5%, 20%,), or any other loading, as desired.

If desired, SWNTs-ML based on other kind of SWNTs (e.g. (6,6)-SWNTs, (6,7)-SWNTs or any other CNTs as desired) can be used and functionalized.

In conclusion, this example describes the generation of epoxy-CNTs composites employing epoxy monomer, anhydride curing agent, and SWNTs-ML.

### Example WW5. Composites of Epoxy-Carbon Nanotube, Employing Different Type of Epoxy Resin Based on Alternative Other Curing Agents

This example describes the use pentaerythritol tetrakis(3-mercaptopropionate) (PETMP) curing agent to get the epoxy-carbon nanotube composite.

The used epoxy monomer (D.E.R.™ 332) and purified (6,5)-SWNT remain the same with those in Example B24.6. PETMP curing agent and curing accelerant 2,4,6-tris(dimethylaminomethyl)phenol (DMP-30), are purchased from Sigma-Aldrich. SWNTs-ML (e.g. “SWNTs-ML-amide-1 of Example B24.6.”, “SWNTs-ML-amide-2 of Example B24.6”, “SWNTs-ML-anhydride-1 of Example B24.x”, “SWNTs-ML-anhydride-2 of Example B24.x”) remain the same with those in Example WW-2.

The composites can be prepared by separately dispersing each CNTs into epoxy monomer D.E.R.™ 332 by the sonication to get CNTs suspensions. The sonification process prefers following the “Step 1 of Example B24.6”. Curing agent PETMP and curing accelerant DMP-30 are successively mixed with each CNT suspensions by stirring for 1 min, and the mixture is poured into the Teflon molds for vacuum degas and curing at the initial temperature of 10° C. for 1 hr, followed by the post-cure at 60° C. for 2 hr each. SWNTs loadings with respect to total weight of cured epoxy specimen is 0.1% (w/w).

The curing process and the crosslinking degree of the cured epoxy resin can be modified by using different ratios of D.E.R.™ 332 and PETMP. For example, the molar ratio of epoxy groups to reactive hydrogen in curing agent could be 1:1; 1.5:2; 1.75:2; 2:1.5; 2:1.75; or any other ratio, as desired. The concentration of curing accelerant with respect to total weight of cured epoxy specimen is suggested to be in range of 0.1%-1% (w/w), or any other concentration, as desired.

If desired, any other epoxy monomers, such as the type of glycidyl ether, glycidyl ester, glycidyl amine resins, alicyclic epoxy, aliphatic epoxy etc., can be used in a similar process instead of the D.E.R.™ 332 described in the process above. The epoxy monomers should be used above their melt temperature.

If desired, other polymercaptan and any curing agent carrying reactive hydrogen, such as linear phenolic resin, alkyd resin etc., can be used to replace the PETMP. The curing conditions can be adjusted based on the characteristic of each curing agent.

If desired, other curing accelerant, including the type of tertiary amine, tertiary ammonium salt, imidazole, imidazole salt, boron trifluoride complex etc., can be used to replace DMP-30 described in the process above.

If desired, other SWNT loadings can be applied. For example, SWNT loadings with respect to total weight of cured epoxy specimen can be lower (e.g. 0.01%), or higher (e.g. 1%, 5%, 20%,), or any other loading, as desired.

If desired, SWNTs-ML based on other kind of SWNTs (e.g. (6,6)-SWNTs, (6,7)-SWNTs or any other CNTs as desired) can be used and functionalized.

In conclusion, this example describes the generation of epoxy-CNTs composites employing the epoxy monomer, alternative other curing agent, and SWNTs-ML.

In the following Examples AL1-AL3, the design of an efficient protocol to include a high content of individualized carbon nanotubes requires not only an efficient mixing process but also the optimal molecule design to ensure the maximum integration of MINT and polymer.

The design is based on the reported pyrene-based linear molecule described in López-Moreno et al. Chem. Commun. 2015, 51, 5421, DOI: 10.1039/C40008970G, comprising two recognition motifs towards SWNTs, one aromatic spacer and two terminal alkene functionalities that can react to turn the linear molecule into a closed ring structure around a SWNT.

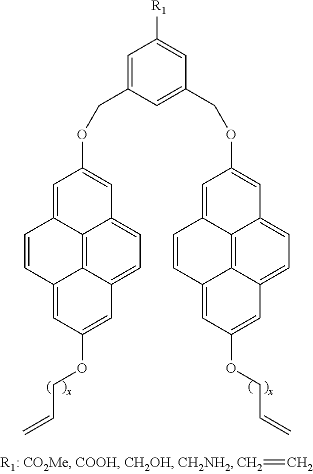

### Example AL1. Attachment of Nanotubes to a Polymer

In this example, new MINTs are used for their reaction with end-substituted polymer. Substitution on the spacer (the central aromatic cycle carrying R1 in the figure above) of the U-shape led to a substituted MINT which will be covalently attached to the polymer. The spacer-substituted U-shape binds to the single-wall nanotube and its two ends are reacted using an olefin ring-closing metathesis reaction. Then this MINT will react with the polymer

Step 1: 5 g of amine-terminated polystyrene (5000-10000 Mw) are placed in a 12 mL inox. steel jar.

Step 2: To this jar 3.2 g of 30% ester-functionalized MINTs were added.

Step 3: 1 steel ball (15 mm diameter) is added to the jar.

Step 4: The jar is closed and connected to a planetary ball mill.

Step 5: The grinding is maintained at 500 rpm for 5 min.

Step 6: After this time solid is recovered from the jar and placed in a flask.

Step 7: Dry chloroform (100 mL/g of nanotube) is added to the flask

Step 8: The obtained mixture is sonicated in a bath (40 kHz, 30 min)

Step 9: The suspension is centrifuged (15000 g, 10 min) and supernatant is separated.

Step 10: Suspension containing individualized nanotubes attached to polymer is stored in solution ready to be used.

This methodology can be modified as follows:
In step 1, a different polymer can be used (e.g., polystyrene thiol terminated, poly(methyl methacrylate), α-amino-terminated)
In step 2, different spacer-functionalized MINTs can be used (e.g., carboxylic acid, methyl hydroxil).
In step 10, the MINT-polymer solution can be dried to obtain a solid that can be redissolved.

### Example AL 2. In Situ Polymerization Including MINTs

This example is a variation of Example 1. In this example, double bond substituted MINTs are employed to produce nanotube-polymer systems by in situ polymerization.

Step 1: A suspension of double-bond MINT in toluene (100 mg/L) is placed in a flask.

Step 2: Polystyrene (MW 800-5,000, 1 g per MINT mg) is added to the flask.

Step 3: AIBN (2 wt %) is added to the mixture.

Step 4: The mixture is mechanically stirred for 30 min.

Step 5: The mixture is sonicated (probe sonicator, 500 W) for 5 min immersed in an ice bath to avoid overheating.

Step 6: The mixture is mechanically stirred for 3 h.

Step 7: The mixture is centrifuged (15000 g) to remove nonattached MINT.

This methodology can be modified as follows:
In step 1, functionalised MINT change with the polymer (e.g. isocyanate, methyl hydroxyl)
In step 2, different polymers can be used (e.g. PMMA, polyethylene, polyurethane, PET)

### Example AL 3. Shear Mixing of Nanotubes-Polymers

This example is a variation of Example 1. In this example, double bond substituted MINTs are employed to produce nanotube-polymer systems by in situ polymerization.

Step 1: Polystyrene is dissolved in toluene (0.5 g/L).

Step 2: SWNTs or MINTs (0.3 g/L) are added to the solution.

Step 3: Shear force mixer (Silverson L5M-A mixer) is used for 96 hours at 10000 rpm.

Step 4: The mixture is centrifuged (21000 g) for 30 min.

Step 5: The supernatant including individualized nanotubes and polymer is recovered

Step 6: Films or fibers are prepared from the suspension containing high amount of tubes

This methodology can be modified as follows:
In step 1, different polymers can be used (e.g. poly(propylene) acrylonitrile-butadiene-styrene)
In step 1, different solvents can be used.
In step 2, different amount of carbon nanotubes can be used (e.g. 0.5, 1, 2.5, 5, 10, 15% wt)

As an alternative procedure the shear mixing could be done as follows:

This protocol requires the use of a Haake Polylab Rheomix shear mixer.

Step 1: Polystyrene is added to the mixer in form of pellets.

Step 2: After operating temperature is reached SWNTs or MINTs (25% wt) are added to the mixer.

Step 3: After the completion of the mixing cycle, the nanotube-polymer sample is recovered.

Step 4: The samples obtained are converted into films or fibers.

This methodology can be modified as follows:
In step 1, different polymers can be used (e.g. poly(propylene) acrylonitrile-butadiene-styrene)
In step 2, different amount of carbon nanotubes can be used (e.g. 0.5, 1, 2.5, 5, 10, 15% wt)
In step 3, from a concentrated mixture (25% wt) sample can be diluted by adding more polymer and repeating a mixing cycle.

### Example ME 1. Protocol for Mechanically Interlocked Carbon Nanotube—Epoxy Nanotube Composite Sample Preparation Using a Shear Mixing

In this example, we use a combination of shear mixing and compression molding to produce a high carbon nanotube content epoxy nanocomposite using mechanically interlocked carbon nanotubes (MINTs).

### Materials:

Epoxy matrix: epoxy resins typically consist of two parts, the epoxy backbone (part A), consisting of a molecule with two epoxide groups, and a hardener (part B), typically an amine, that reacts with the epoxide groups of part A to form a rigid polymer. The most commonly used epoxy backbone is diglycidyl ether of bisphenol A (DGEBA), but other diepoxides could be used.

If an amine base hardener is used, it is important to note that each primary amine group can react with two epoxide molecules, so there needs to be about two epoxide groups per amine group for complete stoichiometric reaction (with about 5% excess amine to ensure full reaction). If a diamine is used as the hardener, the epoxy (i.e., DGEBA) is mixed at a stoichiometric ratio of 2:1.05 A:B, and the cured epoxy is crosslinked, resulting in a thermoset epoxy that cannot be melted/post-processed. Consequently, a single amine hardener is mixed in a stoichiometric ratio of 1:1.05 A:B, and the result is a linear, thermoplastic epoxy that can be melting/post processed.

A hardener should be selected that is not too volatile (so doesn't evaporate during mixing), not too reactive, so the epoxy does not begin to cure when mixing with the epoxy and carbon nanotubes, and not too viscous so gases can be removed and mixture can be poured into molds.

This protocol is written with the thermoset, crosslinked epoxy in mind, but process could be extended to thermoplastic resins as well. For the crosslinked epoxy system, the most investigated hardener was the diamine, Poly(propylene glycol) bis(2-aminopropyl ether) with molecular weight 230 g/mol, also known as Jeffamine-D230, was used.

Filler material: Carbon nanotubes complexed to MLs. Although the chemistry of the ring can be adjusted, this protocol is designed with the standard, pyrene-Ushape in mind. Typically, a target concentration of carbon nanotubes is desired. However, MINTs consist of both the macrocycle and carbon nanotubes, the functionalization of CNTs needs to be determined by thermogravimetric analysis.

Mixing equipment: Currently, an IKA Eurostart 20 digital mixer motor with a 40 mm diameter R1303 dissolver stirrer used for MINT dispersion in epoxy material. This has a maximum rotation of 2000 rpm. However, there are other models that can go up to 20,000+ rpms.

Hot Press: Samples are cured using a 15-ton hydraulic press with Atlas™ Series Heated Platens from Specac.

To help better understand the process, a 1 wt % carbon-nanotube content MINT-crosslinked epoxy starting with 20 g of DGEBA is described, but concentration and chemical composition can be adjusted accordingly. MINTs are assumed to have a functionalization of ˜30%, but exact number needs to be verified by TGA.

Step 1: DGEBA monomer is heated in an oven to −60° C. to reduce the monomer viscosity and the desired amount is weighed in a glass beaker. An excess amount of MINTs are added to the DGEBA monomer in order to make a master batch that will be diluted to the desired concentration. *Currently the maximum baster batch that has been made is about 37 mg MINT/g, but the future work can try to increase this as seen fit.

Step 2: The DGEBA-Mint mixture is placed under the IKA Eurostart 20 digital shear mixer* with a 40 mm diameter R1303 dissolver stirrer** and shear mixed at the maximum 2000 rpm overnight (at least 12 hr). Mixture must be mixed in a container 1.5-3×the diameter of mixing blade for efficient

Step 3: Taking into account the functionalization of the MINTs, the desired amount of MINTs are determined from eq. (1), where m_{MINTs}, m_{DGEBA}, m_{hard} are the masses of MINTs, DGEBA, and hardener in the epoxy, C_{CNTs} is the desired carbon nanotube content in the epoxy, and f is the functionalization (macrocycle fraction) of the MINTs.
If C_{CNTs}=1%, f=30%, and m_{DGEBA} is selected to be 20.0 g, and the hardener is Jeffamine-D230, then m_{hard}=7.09 g, and m_{MINT}=392.67 mg.

$${m}_{MINTs} = \frac{{c}_{CNTs} ( {m}_{DGEBA} + {m}_{hard} )}{( 1 - f ) - {c}_{CNTs}} \qquad ( 1 )$$

If the desired amount of m_{MINTs} in the final composite is 392.67 mg as calculated above, the amount of the master batch, mₘₐₛₜₑᵣ, with concentration, C_{MINT}_{ₘₐₛₜₑᵣ}, to dilute is determined by eq. (2). If C_{MINT}_{ₘₐₛₜₑᵣ}=37 mg MINT/g, then mₘₐₛₜₑᵣ=10.6 g

$${m}_{master} = \frac{{m}_{MINTs}}{{c}_{{MINT}_{masteτ}}} . \qquad ( 2 )$$

The selected amount of the master batch, mₘₐₛₜₑᵣ, is then diluted with neat DGEBA (warmed to 60° C. to reduce viscosity). The amount of neat epoxy to add m_{DGEBA}_{_{dii}} is calculated from the desired amount of total DGEBA wanted in the epoxy m_{DGEBA} selected in the first bullet via eq. (3). With m_{DGEBA}=20.0 g, m_{MINTs}=392.67 mg and mₘₐₛₜₑᵣ=10.6 g, m_{DGEBAdii} is 9.79 g.

$${m}_{{DGEBA}_{dil}} = {m}_{DGEBA} + {m}_{MINTs} - {m}_{master} \qquad ( 3 )$$

Step 4: m_{DGEBA}_{_{dii}} and mₘₐₛₜₑᵣ are mixed in 100 mL beaker, then shear mixed with the IKA Eurostart 20 digital shear mixer* and at the maximum 2000 rpm for approximately 3 hr*.

Step 5: A small amount of the mixture is taken out with a pipette and smeared on a white piece of paper. If large CNT agglomerations are seen, the mixture is allowed to mix for longer.

Step 6: The rotation speed of the mixture is reduced to 100 rpm for 5 min to promote degassing.

Step 7: After the mixing, the DGEBA-MINT mixture is placed in a vacuum oven at 80 C. A vacuum is pulled for 30 min to remove trapped gases as much as possible.

Step 8: The stoichiometric amount of hardener is added to the DGEBA-MINT mixture (with 5% excess). For Jeffamine-D230 in the system described in step 3, that is m_{hard}=7.09 g.

This mixture is then shear mixed for approximately 10 min.* Step 9: Before the mixture is done mixing, an aluminum or steel mold of the desired sample shape is coated with an anti-stick PTFE spray to prevent epoxy from sticking to the mold.

Step 10: After mixing, the mixture is then brought to the hot press, which is heated to 80° C. The mold of the desired shape is placed on top of a Teflon sheet and another steel plate. The uncured mixed resin is then poured in the mold in slight excess. Another Teflon sheet and steel plate is then placed on top.

Step 11: 5,000 kg of Pressure is placed on the sample. This pressure is then released to help remove trapped gas. Repeat 3-4 more cycles of 5,000 kg of pressure and release.

Step 12: After cycling, apply 10,000 kg of pressure on the sample. Let cure at 80° C. for two hours, then raise the temperature to 140° C. for 4 hrs, followed by another 2 hr at 180° C.

Step 13: Remove sample from press and mold. Check cure of epoxy using FTIR to monitor epoxide peaks at 770 cm⁻¹ and 914 cm⁻¹. If these peaks are still present, place sample back in hot press, add 10,000 kg press, increase cure to 200° C. and check cure with FTIR every hour until fully cured.

Note: The two major issues in the epoxy-nanocomposite preparation is: dispersion and viscosity.

Dispersion: Fillers more effectively reinforce the matrix when they are individualized and well dispersed. However, CNTs and MINTs start out as agglomerates that need to be broken up and dispersed. Agglomerations in the final material will reduce reinforcement. So, special attention must be given to the size of these agglomerations.

Viscosity: The more filler in the resin, the more viscous it becomes. High viscosity makes the uncured resin not only difficult to mix (effecting dispersion), but also difficult to fill molds or impregnate surfaces for application. Additionally, high viscosity makes degassing the material before curing difficult, and can lead to bubbles in the final cured resin that reduce properties. The addition of pressure from the hot press helps reduce the size and effect of these bubbles.

To help improve the dispersion and processing this methodology can be modified as follows:
Epoxy matrix, the chemistry of the epoxy can be modified to experiment with the effect different hardeners and epoxy backbones to see the effect on MINT dispersion and mechanical reinforcement
Filler materials. The chemistry of the mechanically interlocked ring around the CNTs can be modified to experiment with the effect of this functionalization on the dispersion and mechanical dispersion. Namely, amine derivatives of the ring can react with the epoxy backbone to covalently bond the MINTs to the epoxy matrix. However, the quantity of hardener needs to be reduced ensure stoichiometry.
In step 2, a different shear mixer with higher possible rpm can be used to test the effects of higher velocity shear mixing. Such as the IKA T 25 digital ULTRA-TURRAX with S 25 N-18 G which allows to up to 25,000 rpm. Changing the speed will result in the need to optimize the mixing time.
The dilution step of the DGEBA-MINT concentrate can be skipped, and the Epoxy can be made directly from the initial mixing of DGEBA-MINTs. This may be necessary for high MINT content epoxies.
Before shear mixing, probe sonication can be used for a short amount of time to help break up large initial MINT agglomeration. However, as MINTs increase the viscosity of the mixture, sonication will become less effective.
Before step 1, the MINTs, which can start out as large, agglomerated chunks, and be mechanically broken up to help reduce the initial size of the MINTs. Using a blade mixer/blender to start out with smaller mints could help.

### Example ME 2. ROMP-CNT Film Epoxy Impregnation

This protocol aims to get very high CNT content composites by impregnating a ROMP-CNT ‘Poly-MINT’ film as described in Examples A1-A32 with an epoxy resin, to produce epoxy resins with more than 40 wt % CNT content. Similar types of CNT-epoxy composites have been previously investigated with CNT buckypapers, such as by Wang, et al., Lopes, et al., and Spitalsky, et al¹. ¹ Wang et al, 2004, Compos Part Appl Sci Manuf 35: 1225-32; Spitalsky et al, 2009, Nanotechnology 20: 405702; Lopes et al, 2010, Compos Struct 92: 1291-98.

Step 1: CNT-ROMP ‘poly-MINT’ film is placed at the top of a vacuum filtration flask using a release film/membrane as support.

Step 2: In order to infiltrate the poly-MINT film, the resin mixture must fully pass through all the wholes in the film. To determine the amount of time needed to do this, the permeability of the film in the z-direction, K_{z}, must be measured by measuring the time it takes for a known quantity of water to pass through the filter and using eq. (4) where η_{w} is the viscosity of water, L, is the thickness of the poly-MINT film, A, is the area of the film, P is the vacuum pressure used to pull the liquid through the film, and Q is the measured flow rate through the film.

$${K}_{z} = \frac{Q {η}_{w} L}{AP} \qquad ( 4 )$$

Step 2: A stoichiometric mixture of epoxy resin is mixed (see epoxy matrix in example 1), such as a 2:1.05 molar ratio of DGEBA: Jeffamine D230.

Step 3: In order to infiltrate the poly-MINT film, the resin mixture must fully coat every surface in the interior of the film. To calculate the time, t, needed to infiltrate the film, eq. (5) is used, where ηᵣ is the viscosity of the resin.

$$t = \frac{{η}_{r} {L}^{2}}{{K}_{z} P} \qquad ( 5 )$$

Step 4: Given the typical viscosity of uncured epoxy resins, eq. (5) will likely show that it could take hours or days to fully infiltrate the resin. As such, the resin should be diluted with acetone* or some other solvent to reduce ηᵣ to below 100 mPa·s to make the infiltration more feasible. This should allow a film of 40 μm thickness to fully infiltrate in about 2 h.

Step 5: After infiltrating the film, the film is placed under vacuum to help remove excess acetone

Step 6: Several films can be made and place on top of each other to make a thicker film.

Step 7: Using hot press and minimal pressure, film can then be cured with normal curing cycle. Typically, 2 hr 80° C. and 4 hr 140° C., but cure cycle can very based on epoxy system.

Step 8: Sample can be machined into desired geometry

This methodology can be modified as follows:
In step 2, Different epoxy formulations can be experimented with, as we are not limited to just the DGEBA-Jeffamine D230 formulation. Different resins will have different viscosities that may flow better. However, the resin must have a relatively long pot life to prevent curing during the infiltration process.
In step 4, different solvents can be explored to find best solvent system for infiltration.

### Example XX1. Preparing Nanotube Composites with Varying Number of Rings Per Unit Length of the Nanotube, Using Different Nanotube Types

In this example, a number of different nanotube composites are prepared that vary in the content of MLs per nanotube, kind of nanotube used, and type and length of polymer used.

In a first step, 50 mg nanotubes (of approximate length 100 nm) of each of the nanotubes indicated in the table below is added to 1000 equivalents of precursor-ML (carrying appropriate recognition motifs for the nanotube and reactive groups for the covalent ring-closing of the precursor-ML around the nanotube to form the ML closed around the nanotube), and 100 mL of an appropriate solvent is mixed and sonicated in a tip sonicator for 30 minutes. Then appropriate reagent(s) and/or catalyst is added to mediate the ring-closing of the precursor-ML around the nanotube, and sonication is continued in a bath sonicator for 5 hrs. Then polymer (according to the table below) is added to each of flasks 1-11 at a concentration corresponding to 90% in the final composite, and the solution is placed in a mold and the solvent removed by e.g. evaporation, to yield the final nanotube-polymer composite product.

| Flask | | |
|---|---|---|
| number | Nanotube | Polymer |
| 1 | Tungsten(IV) sulfide (WS2) nanotube | Polyisobutylene |
| 2 | Molybdenum disulfide (MoS₂) nanotube | ethylene propylene |
| | | rubber |
| 3 | Tin(IV) sulfide (SnS₂) nanotube | vinyl ester |
| 4 | Titanium dioxide (TiO₂) nanotube | Polyphenylene sulfide |
| 5 | Zirconium dioxide (ZrO₂) nanotube | polyetherimide |
| 6 | Zinc oxide (ZnO) nanotube | |
| | polyetheretherketone | |
| 7 | TMCH (transition metal/ | cyanate ester |
| | chalcogen/halogenides) nanotube | |
| 8 | Copper nanotube | polyimide |
| 9 | Bismuth nanotube | PBAT |
| 10 | SWNT (carbon nanotube) | UPR |
| 11 | MWNT (carbon nanotube) | PET |

In ten separate sets of 11 flasks the same reactions and processes are performed, except that now the amount of precursor-ML is adjusted to 500, 200, 100, 50, 20, 10, 5, 3, 2, and 1 equivalents for the ten separate sets of 11 flasks, respectively. Thus, in total 110 different composites are produced, representing 11 different kind of nanotubes and 10 different relative amounts of nanotube and added precursor-ML.

### Example XX2. Different Types of Composite Processing and Alignment of Nanotube in Final Product

### Example XX2, A: Reinforced UHMWPE for Fishing Lines

In this example, a nanotube-reinforced polyethylene fishing line is prepared using a gel-spinning process.

Step 1: A suspension of ultra-high molecular weight polyethylene (e.g Mw of at least 10⁶ g mol⁻¹ and “SWNT-ML of Example B4” in a UHMWPE/SWNT-ML of Example B4” with a w/w ratio range of 99% is prepared in an adequate solvent to ensure solution of the UHMWPE at high temperatures (typically >100° C.) but facilitate crystallization at low-temperatures (typically <80° C.). The w/w ratio of UHMWPE/SWNT-ML of Example B4 to solvent is approximately 5-10 wt %, and the appropriate solvent is e.g. paraffin oil, or decahydronaphthalene.

Step 2: The suspension is heated and mechanically mixed.

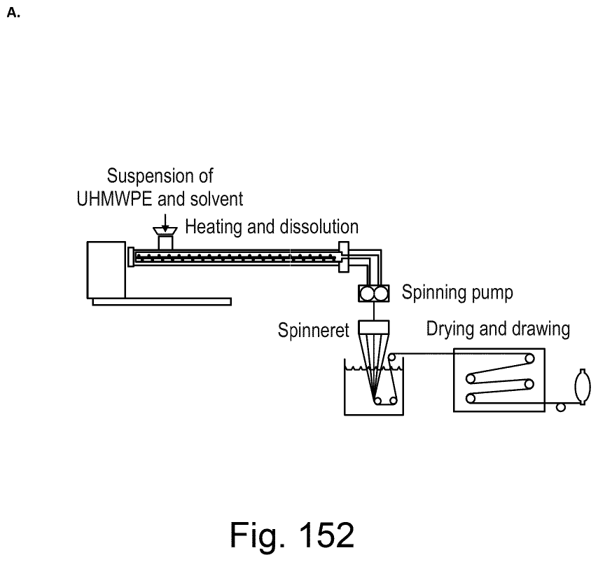

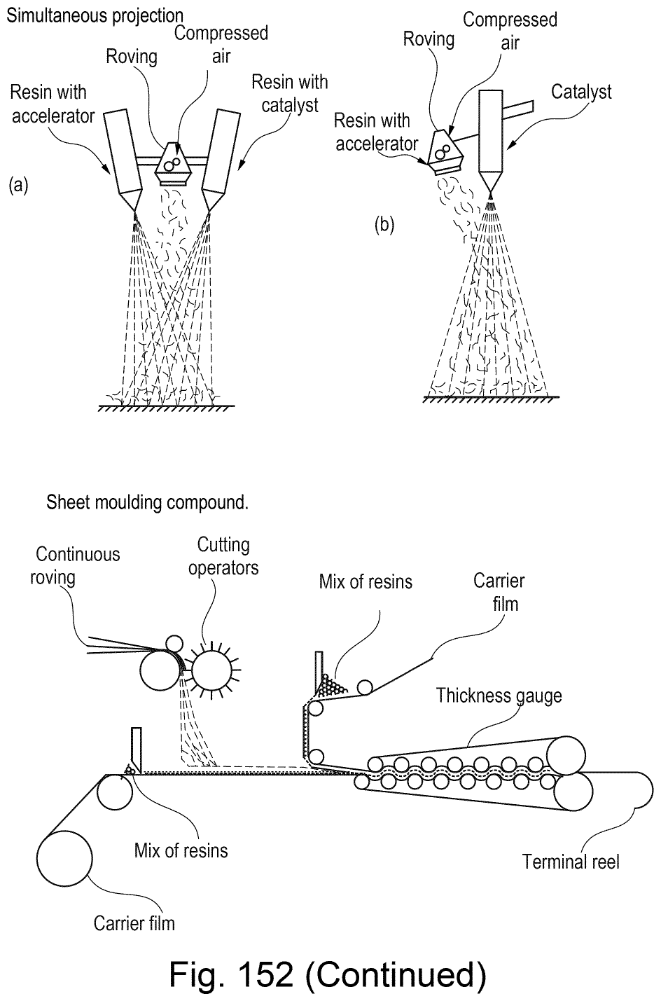

Step 3: The suspension is subjected to a standard gel-spinning process, as depicted in FIG. 152. Thus:

Step 3a: The UHMWPE/SWNT-ML of Example B4/solvent suspension is pushed through a spinneret by a spinning pump and the resulting gel fibers are pulled through a bath containing an adequate volatile solvent to extract the nonvolatile solvent in the suspension, if necessary. The volatile solvent can be e.g. n-hexane, diethyl ether, n-pentane, methylene chloride, trichlorotrifluoroethane (TCTFE), dioxane, and toluene, or other volatile solvent.

Step 3b: The resulting fibers are drawn and dried, preferably at a draw ratio optimized to achieve optimal enhancement of the mechanical properties of the final fibers while keeping the processing industrially feasible. Draw ratios can be varied between 1 and 100, with collection speeds between 1 and 50 m/min. The final fibers are collected and mechanically braided/rolled for their use as fishing lines.

Alternative solvents that may be used include dodecane, naphthalene, p-xylene, 1,2,4-trichlorobenzene, kerosene, camphene and paraffin oil.

### Example XX2, B: Alternative Processes for the Preparation of Nanotube-Polymer Composites

A vast number of processing methods are applicable to nanotube-polymer composites. Lines and cables, as well as non-linear/non-string-like products (compact products) may be produced using various processes, some of which are listed below:
Product made by in solution molding
Product made by injection molding
   Injection molding of thermoplast/ML-nanotube granulates, where the thermoplast (e.g. linear epoxy polymer) may optionally be covalently linked to e.g. the ML complexed to the nanotube
   Injection molding of thermoplast granulates, shear-mixed with ML/nanotube complexes where the ML carries a reactive group capable of covalently linking ML and the polymer before, during, or after injection molding.
   Injection molding of CNT-polymer composites, where the polymer is attached at (only) one end of the polymer to the ML.
   Injection molding of epoxy resin mixed with amine, and immediately injection molded before curing occurs, and curing in the mold.
   Reaction Injection Molding (RIM)
   RRIM (Reinforced RIM)
   SRIM (Structural RIM)
Resin transfer moulding
Product made by pultrusion
Product made by infusion molding
Melting the composite and pouring into mold
   Centrifugal molding
   Vacuum-assisted molding
Polymerization in mold (thermoplast)
Curing in mold (thermoset)
Electrospinning
Solid-state mechano-chemical pulverization
   Pan milling
   Twin-screw pulverization
Simultaneous projection, particularly relevant for fiber-glass reinforced composites in industrial processes. See (FIG. 152, B1)
Filament winding
   Wet filament winding
   Dry filament winding
Sheet moulding compound. See (FIG. 152, B2)
   High moulding compound
   X moulding compound
   Thick moulding compound
   Low-pressure moulding compound
   Ink moulding compound
Glass mat thermoplastics

### Example XX3. Modification of CNT Veils, CNT Mats, CNT Forests, CNT Foils, CNT Fibers, CNT Films, Individual CNT, CNT Grown-On-Mats or CNT Grown-On-Wafers, Individualized CNTs, CNT Threads, and Short, Long and Extremely Long CNT Molecule Preparations

The strength, the optical characteristics, the electrical conductivity, the heat conductivity, and/or other features of CNT veils, CNT mats, CNT forests, CNT foils, CNT fibers, CNT films, individual CNT, CNT grown-on-mats or CNT grown-on-wafers, individualized CNTs, CNT threads, and short, long and extremely long CNT molecule preparations, may be modified using precursor-MLs and MLs of the present invention. Here follows examples of how these different CNT formats may be modified, and in that way modify the characteristics of the CNT format, in particular its strength characteristics.

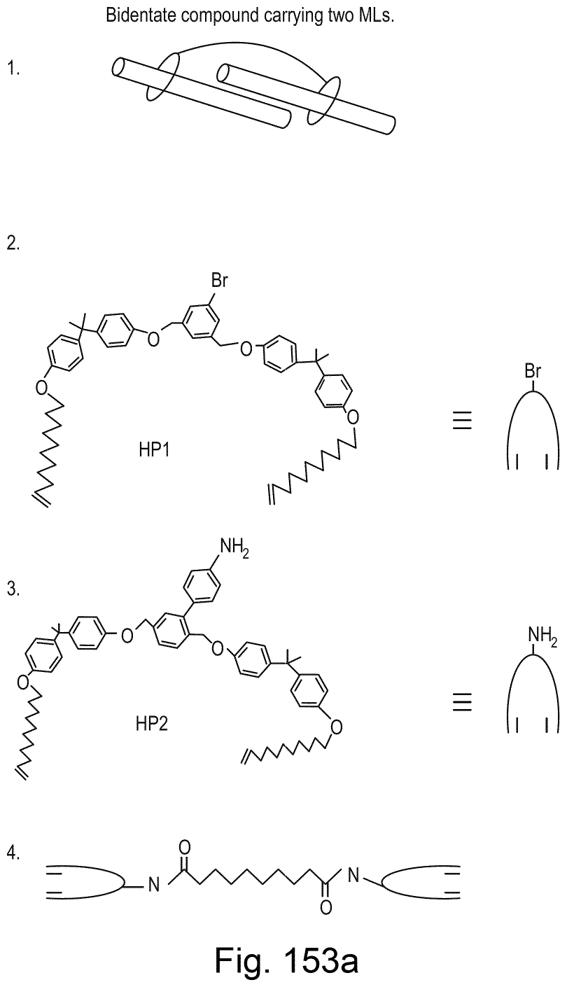

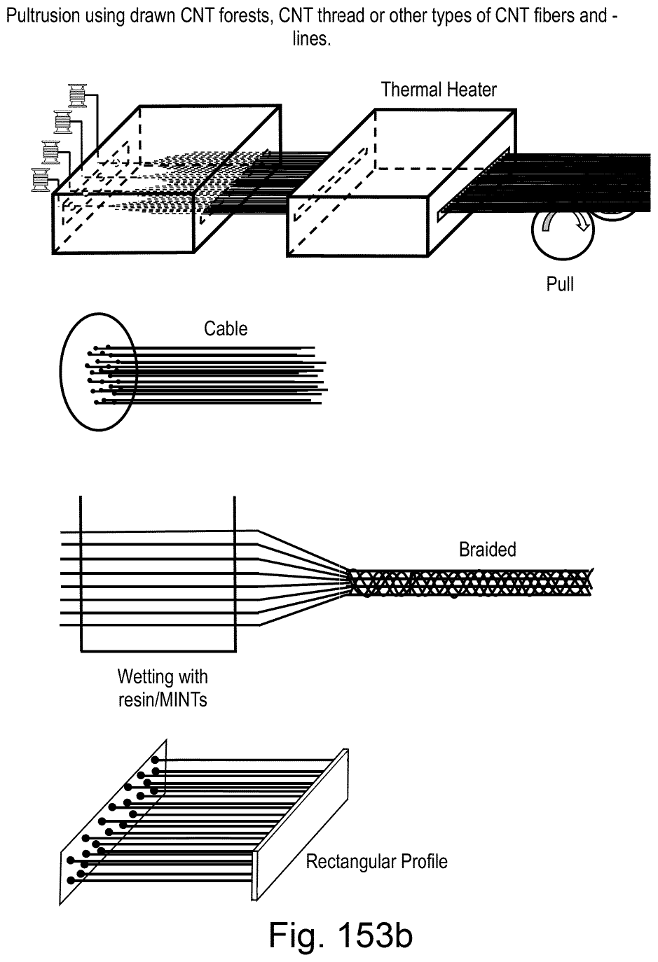

The bidentate compound shown in (FIG. 153A, 4) comprising two precursor-MLs, connected by a flexible linker is useful to covalently link two MLs, each complexed to a nanotube. In (FIG. 153A, 1) the two precursor-MLs of the bidentate compound has ring-closed around two nanotubes, to form a bidentate compound carrying two MLs, each of which forms a mechanical bond to a nanotube.

The bidentate compound of (FIG. 153A, 4) is prepared by the reaction of the amine of each of two molecules of compound HP2 (see FIG. 153A, 3) with a dicarboxylic acid chloride, thereby forming an amide bond that covalently links the two precursor-MLs.

The bidentate compound of (FIG. 153A, 4), carrying two precursor-MLs, is used in several of the following example modifications of CNT formats.
A CNT film from Dexmat (e.g. Galvorn CNT Tape/Film, with thickness of approximately 20 μm) is placed in a solution of TCE comprising an appropriate amount (e.g. 10 μM) of the bidentate compound of (FIG. 153A, 4), and 10 μM Grubb's second generation catalyst is added as well. Incubation is carried out for 5 hours, and sonicated in bath sonicator for 2 min every 15 min. The CNT film is then rinsed with TCE, to produce the final modified film, in which some of its carbon nanotubes have complexed to an ML and in this way have been linked to another carbon nanotube. As a result, the CNT film has been reinforced.
Using the same reagents and conditions, a CNT thread (e.g. from DexMat) may be reinforced to obtain e.g. a higher tensile strength of the thread.
In the defense industry, mats of CNT forests are used to coat the outside of airplanes, in order to minimize reflection of radar signals. Such mats of CNT forests may be reinforced by the same treatment as was done for the CNT film and the CNT thread above, in this way reinforcing the CNT forest and making it less susceptible to wear and abrasion, while maintaining its electromagnetic shielding effect.
Using similar approaches as described in this example (above), CNT veils and CNT foils may be reinforced and/or coated with polymer and/or MLs. Following this modification, the coated veil or foil may be further functionalized or cross-linked by adding reagents that react with e.g. functional groups carried by the MLs attached to the nanotubes. Such further coating could be epoxy polymer, and this would allow the incorporation of glass fiber or carbon fiber in the composite, and would covalently link the ML with the epoxy, i.e. serve to anchor the glass fiber or carbon fiber to the ML-CNT component, i.e. the CNT veil or CNT foil.
Using the pultrusion technique, e.g. CNT threads and CNT fibers may be used to produce high-strength polymer profiles. The CNT thread or -fiber is drawn through a bath containing precursor-MLs (e.g. compounds HP1 and/or HP2), polymer (e.g polystyrene or PMMA), appropriate catalysts and/or reagents for ring-closing of the precursor MLs around the individual carbon nanotube, and solvent, see (FIG. 153B). In the bath the ML-nanotube complexes form, optionally at the same time polymer may become covalently linked to e.g. the ML. Then the CNT thread or -fiber is drawn into a thermal heater which makes the polymer evaporate. The resulting product is a polymer-CNT composite where the CNT threads and -fibers extend from end to the other of the product. Depending on the geometry of the holders of the CNT threads or -fiber, the final product may be a flat plate (see FIG. 153B, top), a cable (see FIG. 153B, center-top), a braided cable or line (see FIG. 153B, center-bottom), or a rectangular plate (thick plate) (see FIG. 153B, bottom).
Using a similar but optionally smaller set-up, CNT forests may be drawn and optionally combed and then drawn through the bath and heater in the same way as described immediately above, to produce reinforced polymers where the CNT component was generated by drawing CNT fibers from a CNT forest.

All of the above modifications may also be performed with other types of nanotubes (e.g. the nanotubes listed in Example XX1), nanowires, nanorods, nanofibers, and other types of cylindrical molecules with high aspect ratio, as well as threads, veils, mats, forests, films, etc. made from these alternative nanotubes.

### Example XX4. Granulate Formation

In this example it is described how one may make granulates of nanotube-ML complexes or nanotube-ML complexes non-covalently or covalently linked to polymer (typically, the polymer would only be linked to the nanotube through one covalent bond, to ensure the thermoplastic characteristics are maintained in the composite).

Here follows a number of alternatives for making such granulates.
Granulates of “pre-composite structure”. Here a few (e.g. 10) relatively long polymers, or a medium number (e.g. 50) of medium length polymers, or a large number (e.g. 200) short polymers are attached to each nanotube, and granulates prepared from this composite. Then, these granulates can be mixed with neat polymer granulates at the production plant, so that appropriate mixtures of the two granulates can be made, in that way controlling the nanotube loading of the final composite. If the target product is a polymer-nanotube composite, one might first make granulates of pre-composite structure from polyethylene, and then later mix with neat polyethylene granulates.
The granulates of pre-composite structure can be made i) without functional groups on the MLs (of the ML-nanotube complex), in this way producing nanotubes coated with a “chemically inert” surface; or ii) the MLs may carry functional groups allowing for the covalent linkage of polymer to the ML.
The granulates of pre-composite structure may be made by complexing with U shapes or polyUshapes, i.e. a number of U shapes connected by a “backbone structure”.

### Example XX5. Industrial Production of Polymer Nanotube Composite Products

Different processes and types of products are described in this example, with a focus on industrial materials and industrial processing. All products are made using the present invention, including the generation of nanotube-ML complexes for dispersion and anchoring of the nanotube in the matrix and during the fabrication process. The materials and products are recyclable, meaning that the products can be melted and reused for new products.
Production of nylon line or -cable, using an industrial and cost-efficient method. The CNTs are aligned in the nylon line or -cable, in order to achieve highest possible tensile strength.
Production of nylon line or cable, using industrial and cost-efficient method. The CNTs are not aligned, to ensure highest possible wear resistance.
Production of a car bumper made of CNT polyethylene composite, using injection molding.
Production of a car bumper made of CNT polystyrene composite, using an industrial, commonly used method.
Production of a car bumper made of CNT polyurethane composite, with the focus of making a car bumper that has high impact strength
Production of a plate (30×40 cm) to be used in a bulletproof vest. Sole criteria: must be as resistant to a rifle bullet as possible, but must only be 5 mm thick.

### Example XX6. Design of Precursor-MLs and MLs where the Binding to the Nanotube is Primarily Driven by an Entropic Effect

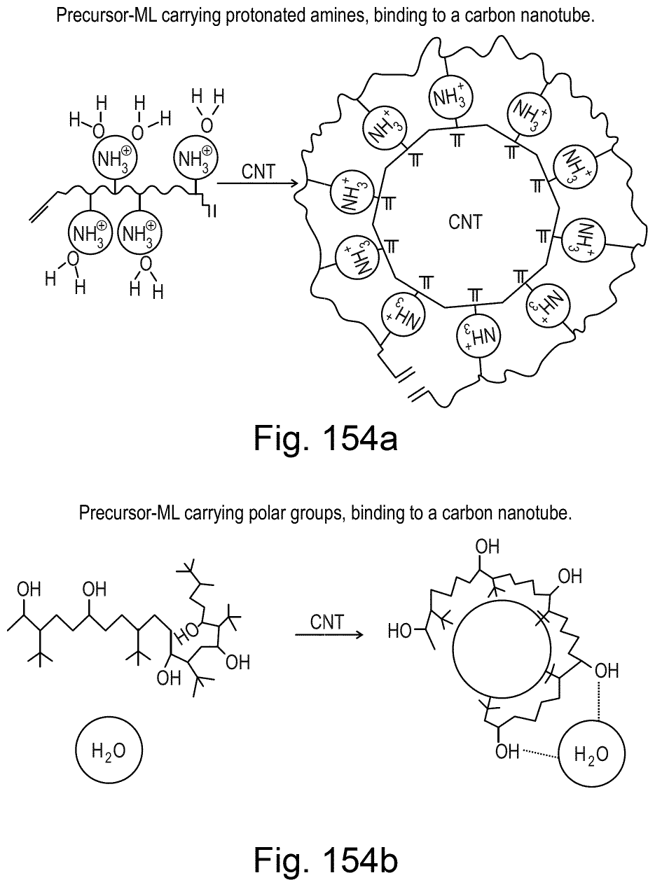

In this example, precursor-MLs (and MLs) are designed so as to promote the binding to the nanotube and the wrapping around the nanotube, by entropic rather than enthalpic effects. Different designs are exemplified below.
The precursor-ML carries charged groups (e.g. protonated amine) and ring-formation is performed in preferably nonpolar solvent. The binding event to CNT, however, also involves significant thermal energy, through cation-pi interaction (e.g. NH3⁺ interaction with the aromatic ring). See (FIG. 154A).
The precursor-ML carries polar groups (e.g. OH, COMe) as well as bulky hydrophobic groups, and ring-formation on CNT is performed in preferably polar solvent. See (FIG. 154B)
The precursor-ML carries non-polar groups (e.g. phenyl) and ring-formation on CNT is performed in preferably polar solvent
The precursor-ML carrying hydrophobic groups and ring-formation around CNT is performed in preferably polar solvents, e.g. aqueous buffer.
The precursor-ML carries moieties with little or no thermal energy of interaction but because of their size have a large entropic effect (e.g. moieties like halogens (Br, Cl, I) because they are big and are inert towards the CNT—can we think of other moieties—preferably cheap to buy or with (expectably) no effect on composite integrity).
The precursor-ML is “polarized”, i.e. the inner surface of the closed ring is hydrophobic, the outer surface is polar or charged.

### Example XX7. Nanotube-Polymer Composites for 3-D Printing

Nanotube-polymer composites may be used to make filaments for 3D-printing.

### Example XX8: Nanotube-ML Complexes in Nanosensor Design

The ML-nanotube complex formation effectuates the effective dispersion of the nanotubes and may also serve as a handle for efficiently positioning the nanotube on a nanosensor device.

### Example XX9. Nanotube-Composites for Use in Battery Electrodes

Because of its high strength and low weight, as well as the high electrical conductivity, CNT-polymer composites are an obvious choice for the development of higher performance- and longer-lasting batteries.

### Example XX10. Nanotube-Composites for Use in Solar Cells

Because of its high strength, attractive optical characteristics, and electrical conductivity, CNTs are an attractive component to explore for solar cell development.

### Example XX11. Nanotube-Composites for Efficient Transfer of Heat in Coolers

The heat conductivity of CNT is among the highest existing, and is therefore attractive to use in e.g. coolant systems, to help transfer heat from heat generating device (e.g. CPU) to cooling system.

In order for heat transfer to happen between two carbon nanotubes they must productively interact—this involves a preferred surface area and orientation. The present invention involves an aspect of complexation by multiple MLs with a nanotube; this complexation and “coating” of the nanotube surface results in strongly improved dispersion and anchoring of the nanotube in the matrix. However, such a coating may also function as an insulating layer, and in this way impede heat transfer. It is thus possible that a composite comprising a large number of MLs complexed to each nanotube is not optimal for heat transfer. Rather, if a heat conductive composite is sought, it may be desirable to remove some or all of the MLs from the nanotubes after the nanotubes have been efficiently dispersed by complexing with the MLs, as this may improve heat conductivity. This may be done by e.g. cleaving the ML with UV light, hydrolysis, reduction, or any other means that will strip the nanotube for its complexed MLs.

In this example, CNTs are resuspended in an appropriate solvent (e.g. DMF) by the formation of ML-nanotube complexes as described elsewhere in this patent application. Once the ML-nanotube complexes have formed and the nanotubes have been dispersed, a paste is added. Then the MLs are cleaved, and the solvent immediately evaporated to avoid reaggregation of the nanotubes. The resulting paste can now be used as a heat transferring paste in the interphase between the heat generator and the cooling system.

### Example XX12. Wind Turbine Leading Edge Coating with High Impact Fatigue Resistance

This is an example of a carbon nanotube composite, where the advantageous parameter is the high concentration of filler in the composite, but where the possible reinforcement is not attractive.

In most cases a strong interaction between the nanotube-ML complex and the polymer is desired. A strong interaction between polymer and nanotube-ML complex may improve the quality of the composite material in several ways: i) it may help disperse the nanotube-ML complexes more efficiently during e.g. shear mixing, because the polymer will function as a handle that pulls one nanotube-ML complex from another nanotube-ML complex, ii) it may increase the anchoring efficiency in the matrix, thereby iii) increasing e.g. the tensile strength of the final product.

For wind turbine leading edge coatings, produced from polyurethane-CNT composite, a weak interaction between the nanotube-ML complex and the matrix (polymer) and hence low strength (e.g. high Young's modulus) is desired. Coatings for leading edge protection are typically based on elastomers, as a soft (flexible) outer coating of the wind turbine blade is desired. A major issue for such leading edge coatings is the impact fatigue generated by the continuous impact of rain drops on the leading edge during rainfall, particularly with big wind turbines where the wing tip speed approaches 300 km/h. Impact by rain drops generates very small cracks that may propagate and eventually lead to major damage of the leading edge of the blade. It is desirable to limit crack propagation by inclusion of a high concentration of (well-dispersed) nanotubes, as the numerous nanotubes would then serve as stopping blocks for crack propagation.

Thus, ideally, to make a good leading edge coating one would want to add a high concentration of nanotubes to the commercial polyurethane coating (in order to limit crack propagation) but at the same time ensure a very weak interaction between the nanotube-ML complexes and the polymer, so that the anchoring of the nanotubes would be poor and hence the strength (particularly Young's Modulus) would not increase much relative to the commercially available PU coating.

Thus, in this case a low Young's Modulus is desired. Poor anchoring of the nanotube in the matrix and hence an insignificant improvement in Young's Modulus may be reached by designing weak or repulsive non-covalent bonds between the nanotube/ML complex and the polymer.

Here, a precursor-ML (and hence a ML) is designed with a negative charge (e.g. carries multiple glutamates). A polymer, e.g. a polypeptide, that also carries multiple negative charges, e.g. carries multiple aspartates, is chosen for the composite. These two negatively charged groups (e.g. glutamate and aspartate) will repel each other.

Thus, the precursor-ML and nanotubes are mixed in an appropriate solvent, sonicated and appropriate catalyst and/or reagents are added to mediate ring-closing of the ML around the nanotube. Then polyamide is added and the solvent evaporated, resulting in a polyamide-CNT composite of low Young's Modulus but with high impact fatigue resistance.

### Example XX13. Recycling of Nanotube Composites

Nanotube-polymer composites that contain polymers non-covalently linked to the ML and/or nanotube, or covalently linked through only one reactive group of the polymer, may be recycled. Recycling may be done e.g. by melting and re-applying to a mold.

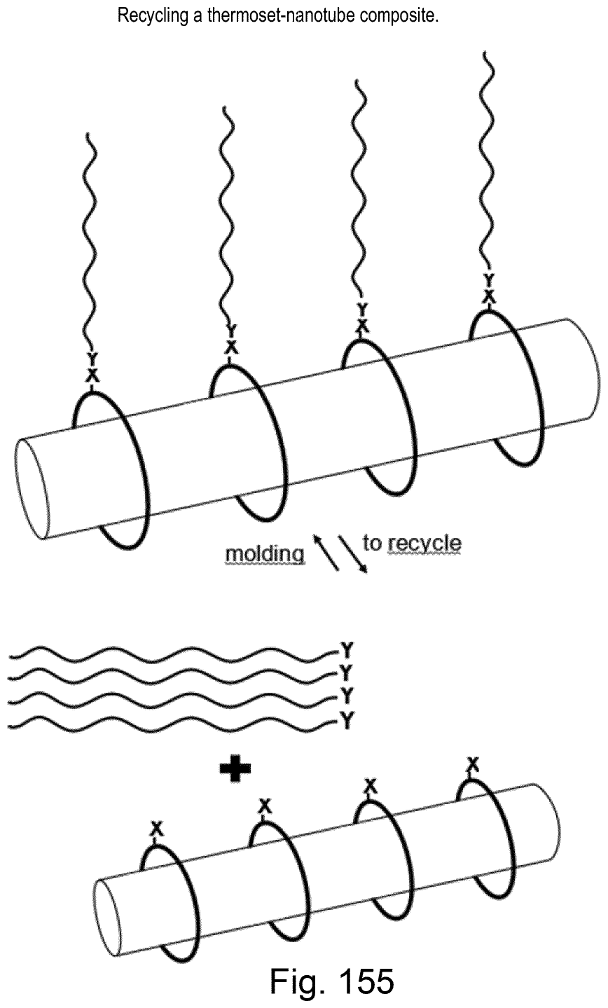

Nanotube-composites that comprise polymers that are each bound to several nanotubes will behave as thermosets, and hence cannot be easily recycled. However, if the covalent bond that links the polymer to e.g. the ML wrapped around the nanotube is a dynamic covalent bond (e.g. a double bond that can undergo metathesis mediated by a catalyst such as Grubb's second generation catalyst, or a disulfide that may be reversibly cleaved or fused by a reduction/oxidation buffer), then the polymer-crosslinks between nanotubes may be reversibly broken, allowing for the breakdown of the thermoset crosslinks, and hence, resulting in non-linked polymers and ML-nanotube complexes. See (FIG. 155).

### Example XX14. Kevlar, Internally Reinforced with CNT

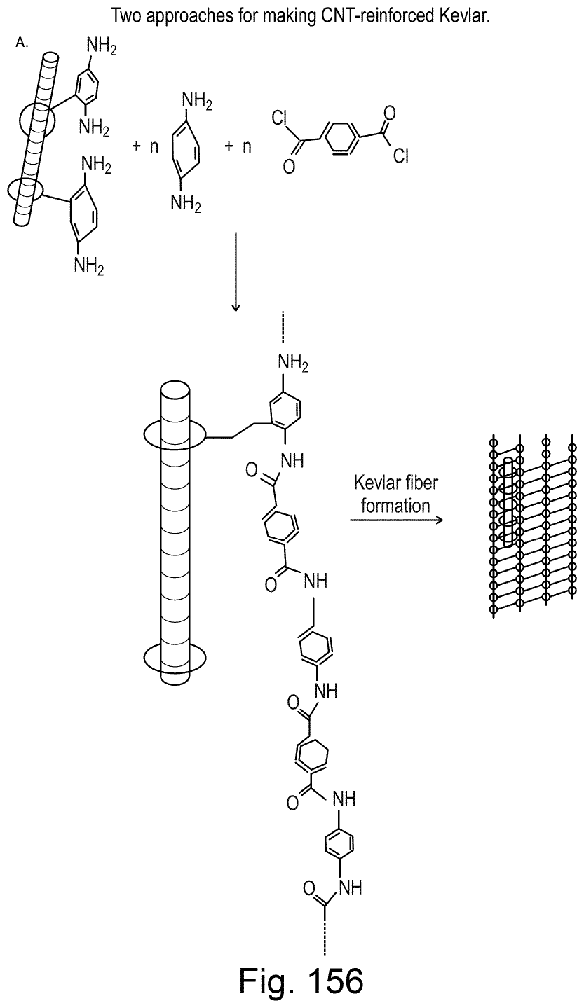

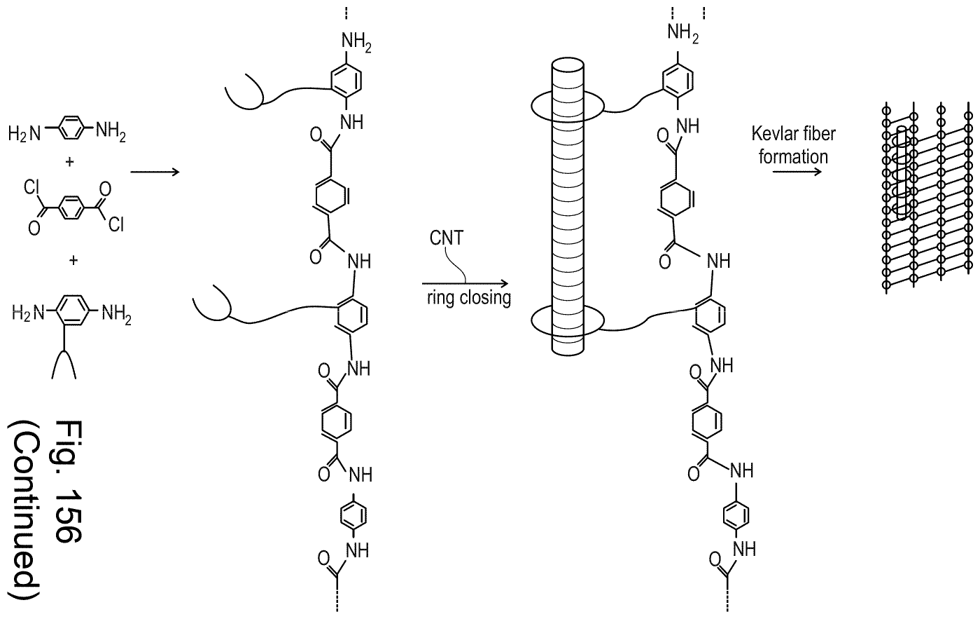

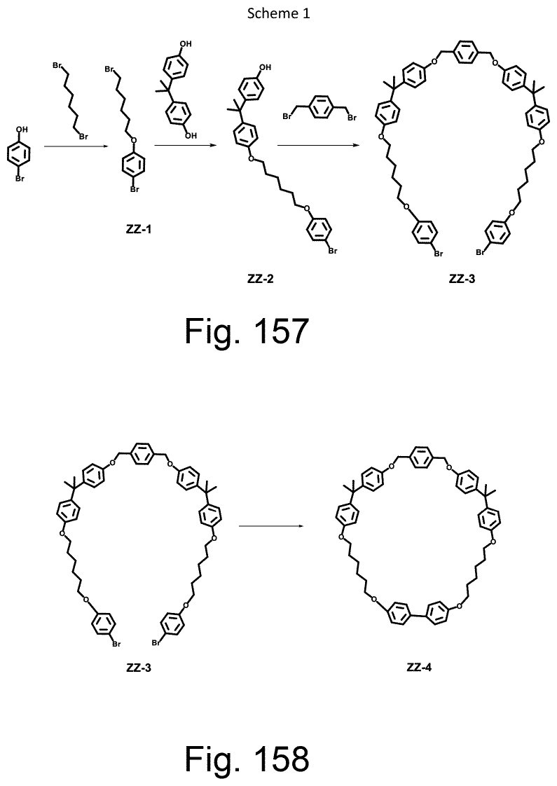

In this example an aramid (Kevlar) is reinforced with CNT. See (FIG. 156, A and B).

### Approach 1:

Covalently link benzene-1,4-diamine to a precursor-ML, add this compound to CNT in an appropriate solvent and sonicate, then add appropriate reagents and catalyst to close the ring around the CNT, to form benzene-1,4diamino-ML-nanotube complex. Mix this with a large excess of both dicarboxylic acid chloride and benzene-1,4 diamine, and allow polyamide formation, to form polyamides doped with mechanically bound CNTs. Allow Kevlar fibers to form. These are reinforced by CNT. See (FIG. 156, A).

### Approach 2:

Covalently link benzene-1,4-diamine to a precursor-ML, mix this with a large excess of both dicarboxylic acid chloride and benzene-1,4 diamine, and allow polyamide formation, to form polyamides doped with precursor-MLs. Then add CNT and perform ring-closing reaction, to attach the CNT through a mechanical bond to the polyamide. Allow Kevlar fibers to form. These are reinforced by CNT. See (FIG. 156, B).

### Example XX15. Recycling Back to Monomers and CNT

This example describes how to recycle CNT-polymer composites, by breaking the composite down to its parts, i.e. monomer and CNT.
Recycle back to monomers: Make CNT composites using “high-performance pan-tactic polythioesters”, then use the material to produce a product (e.g. a wheel), then recycle the item back to a solution of CNT and monomers, and make a new item (e.g. a blade for a floorball hockey stick), using the CNT and monomer solution as raw material.

### Example XX16. Reinforcing Biomaterials

In this example it is described how biopolymers such as silk, spiderweb, collagen, etc. can be reinforced with nanotubes.

1. A composite material comprising more than 2 wt/wt % nanotubes, wherein said composite material does not comprise any nanotube aggregates having a smallest dimension larger than 0.1 mm.

2. The composite material according to claim 1, wherein said composite material does not comprise any nanotube aggregates having a smallest dimension larger than 0.01 mm, such as larger than 1 μm, such as larger than 0.1 μm, such as larger than 0.01 μm, such as larger than 2 nm.

3. The composite material according to claim 1, having a volume of more than 50 nm³.

4. The composite material according to claim 1, having a volume of more than 50 nm³ and comprising 2-3 w/w %, or 4-5 w/w %, or 5-10 w/w %, or 10-15 w/w %, or 15-20 w/w %, or 20-25 w/w %, or 25-30 w/w %, or 30-35 w/w %, or 35-40 w/w %, or 40-50 w/w %, or 50-60 w/w %, or 60-70 w/w %, or 60-80 w/w %, or 80-99.99 w/w %.

5. The composite material according to claim 1, wherein the composite material has a mass of more than 10⁻¹⁵ g, such as more than 10⁻¹⁴ g, such as more than 10⁻¹³ g, such as more than 10⁻¹¹ g, such as more than 10⁻¹⁰ g, such as more than 10⁻⁹ g, such as more than 10⁻⁸ g, such as more than 10⁻⁷ g, such as more than 10⁻⁶ g, such as more than 10⁻⁵ g, such as more than 10⁻⁴ g, such as more than 10⁻³ g, such as more than 10⁻² g, such as more than 0.1 g, such as more than 1 g, such as more than 10 g, such as more than 100 g, such as more than 1 kg, such as more than 10 kg, such as more than 100 kg, such as more than 1000 kg, such as more than 10,000 kg; and/or
wherein the nanotube concentration is 0.01-0.1 w/w %, or 0.1-1 w/w %, or 2-3 w/w %, or 4-5 w/w %, or 5-10 w/w %, or 10-15 w/w %, or 15-20 w/w %, or 20-25 w/w %, or 25-30 w/w %, or 30-35 w/w %, or 35-40 w/w %, or 40-50 w/w %, or 50-60 w/w %, or 60-70 w/w %, or 60-80 w/w %, or 80-99.99 w/w %; and/or
where the nanotubes have an average length of at least 10 nm, such as at least 20 nm, such as at least 50 nm, such as at least 100 nm, such as at least 300 nm, such as at least 500 nm, such as at least 1 μm, or such as at least 20 μm.

6. The composite material according to claim 1, having a volume of at least 100 nm³, such as at least 300 nm³, such as at least 1000 nm³, such as at least 10000 nm³, such as at least 100000 nm³, such as at least 100000 nm³, such as at least 1000000 nm³, such as at least 10000000 nm³, such as at least 100000000 nm³, such as at least 1000000000 nm³, such as at least 10 μm³, such as at least 100 μm³, such as at least 1000 μm³, such as at least 10000 μm³, such as at least 100000 μm³, such as at least 1000000 μm³, such as at least 10000000 μm³, such as at least 100000000 μm³, such as at least 1 mm³, or such as at least 10 mm³.

7. The composite material according to claim 1, said composite material comprising at least a first and at least a second carbon nanotube,
where the outer diameter of the second nanotube is more than 0.1 nm greater than the outer diameter of the first nanotube,
and wherein said first and said second nanotubes are each complexed with mechanical ligands.

8. The composite material according to claim 7, said composite material further comprising at least a third carbon nanotube,
where the outer diameter of the third nanotube is more than 0.1 nm greater than the outer diameter of the second nanotube,
and wherein said first, second and said third nanotubes are each complexed with mechanical ligands.

9. The composite material according to claim 8, said composite material further comprising at least a fourth carbon nanotube,
where the outer diameter of the fourth nanotube is more than 0.1 nm greater than the outer diameter of the third nanotube,
and wherein said first, second, third and fourth nanotubes are complexed with mechanical ligands.

10. The composite material according to claim 9, said composite material further comprising at least a fifth carbon nanotube,
where the outer diameter of the fifth nanotube is more than 0.1 nm greater than the outer diameter of the fourth nanotube,
and wherein said first, second, third, fourth and fifth nanotubes are complexed with mechanical ligands.

11. The composite material according to claim 10, said composite material further comprising at least a sixth carbon nanotube,
where the outer diameter of the sixth nanotube is more than 0.1 nm greater than the outer diameter of the fifth nanotube,
and wherein said first, second, third, fourth, fifth and sixth nanotubes are complexed with mechanical ligands.

12. The composite material according to claim 11, said composite material further comprising at least a seventh carbon nanotube,
where the outer diameter of the seventh nanotube is more than 0.1 nm greater than the outer diameter of the sixth nanotube,
and wherein said first, second, third, fourth, fifth, sixth and seventh nanotubes are complexed with mechanical ligands.

13. The composite material according to claim 12, said composite material further comprising at least a eighth carbon nanotube,
where the outer diameter of the eighth nanotube is more than 0.1 nm greater than the outer diameter of the seventh nanotube,
and wherein said first, second, third, fourth, fifth, sixth, seventh and eighth nanotubes are complexed with mechanical ligands.

14. The composite material according to claim 13, said composite material further comprising at least a ninth carbon nanotube,
where the outer diameter of the ninth nanotube is more than 0.1 nm greater than the outer diameter of the eighth nanotube,
and wherein said first, second, third, fourth, fifth, sixth, seventh, eighth and ninth nanotubes are complexed with mechanical ligands.

15. The composite material according to claim 14, said composite material further comprising at least a tenth carbon nanotube,
where the outer diameter of the tenth nanotube is more than 0.1 nm greater than the outer diameter of the ninth nanotube,
and wherein said first, second, third, fourth, fifth, sixth, seventh, eighth, ninth and tenth nanotubes are complexed with mechanical ligands.

16. The composite material according to claim 1, wherein a nanotube that has an aspect ratio of more than 100 is complexed to a mechanical ligand that is a closed ring structure, and where the mechanical ligand is covalently linked to any of the following chemical moieties: hydroxyl, thiol, phenyl or other aromatic moiety, and wherein the mechanical ligand is a chemical entity that is capable of forming a mechanical bond with nanotube, or is forming a mechanical bond with the nanotube, where the mechanical bond is a bond between a mechanical ligand and the nanotube where at least one intramolecular covalent bond in the nanotube or in the mechanical ligand must be broken in order to bring the nanotube and the mechanical ligand apart in a direction other than the direction of the largest dimension of said nanotube.

17. The composite material according to claim 1, comprising a nanotube and a closed ring molecule where the outer diameter of the nanotube is between 0.3 and 0.6 nm, and the closed ring molecule comprises 10-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 0.6 and 0.7 nm, and the closed ring molecule comprises 15-20 atoms, or 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 0.7 and 0.8 nm, and the closed ring molecule comprises 21-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 0.8 and 0.9 nm, and the closed ring molecule comprises 25-30 atoms, or 31-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 1.0 and 1.2 nm, and the closed ring molecule comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 1.2 and 1.4 nm, and the closed ring molecule comprises 30-40 atoms, or 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 1.4 and 1.7 nm, and the closed ring molecule comprises 41-50 atoms, or 51-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 1.7 and 2.0 nm, and the closed ring molecule comprises 50-60 atoms, or 61-70 atoms, or 71-80 atoms, or 81-90 atoms, or 91-100 atoms, 101-150 atoms, or 151-500 atoms, or 501-5000 atoms; or
where the outer diameter of the nanotube is between 2.0 and 2.5 nm, and the closed ring molecule comprises 60-70 atoms, or 71-80 atoms, or 81-90 atoms, or 91-100 atoms, 101-150 atoms, or 151-500 atoms, or 501-5000 atoms.

18. The composite material according to claim 1, wherein the composite material additionally comprises a polymer chosen from: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

19. The composite material according to claim 18, wherein at least one of said one or more mechanical ligands is covalently bonded to a polymer chain, preferably a polymer chosen from: PE, LDPE, HDPE, Polypropylene, PVC, PS, EPS, PPS, PU, PUR, Polyamide, Nylon, Epoxy, Polyester, ABS, ASA, SAN, PBS, PBT, PET, PA, Polycarbonate, PU, PUR, UPR, Polymethylpentene (PMP), Polybutene-1 (PB-1), polyisobutylene (PIB), Ethylene propylene rubber (EPR), Vinyl ester, PMMA, Phenolic (PH), Polyphenylene sulfide (PPS), Polyetherimide (PEI), Polyetheretherketone (PEEK), Polyetherketoneketone (PEKK), CA, Cyanate ester (CE), Bismaleimide (BMI), Polyimide (PI), TPE, PBAT, PTT, PHA, PEF, EPDM, PLA, or Ethylene propylene diene monomer (M-class) rubber.

20. The composite material according to claim 1, wherein the nanotubes are selected from carbon nanotube, multiwall, single-wall, or double-wall nanotubes, or mixtures thereof.

21. The composite material according to claim 1, wherein said composite material does not comprise any nanotube aggregates having a smallest dimension larger than 0.1 μm, wherein the nanotube concentration is 10-15 w/w %; and wherein the composite material has a volume of at least 1 μm³.

22. The composite material according to claim 1, wherein said composite material does not comprise any nanotube aggregates having a smallest dimension larger than 0.1 μm, wherein the nanotube concentration is 15-25 w/w %; and wherein the composite material has a volume of at least 1 μm³.

23. The composite material according to claim 1, wherein said composite material does not comprise any nanotube aggregates having a smallest dimension larger than 0.1 μm, wherein the nanotube concentration is 25-40 w/w %; and wherein the composite material has a volume of at least 1 μm³.

24. The composite material according to claim 1, wherein said composite material does not comprise any nanotube aggregates having a smallest dimension larger than 0.1 μm, wherein the nanotube concentration is 40-70 w/w %; and wherein the composite material has a volume of at least 1 μm³.

25. The composite material according to claim 1, wherein said composite material does not comprise any nanotube aggregates having a smallest dimension larger than 0.1 μm, wherein the nanotube concentration is 70-99,99 w/w %; and wherein the composite material has a volume of at least 1 μm³.

26. The composite material according to claim 1, wherein said composite material does not comprise any nanotube aggregates having a smallest dimension larger than 0.1 μm, wherein the nanotube concentration is 10-25 w/w %; and wherein the composite material has a volume of at least 1 μm³.

27. The composite material according to claim 1, wherein said composite material does not comprise any nanotube aggregates having a smallest dimension larger than 0.1 μm, wherein the nanotube concentration is 10-25 w/w %; and wherein the composite material has a volume of at least 10 μm³.

28. The composite material according to claim 1, wherein said composite material does not comprise any nanotube aggregates having a smallest dimension larger than 0.1 μm, wherein the nanotube concentration is 10-25 w/w %; and wherein the composite material has a volume of at least 100 μm³.

29. The composite material according to claim 1, wherein said composite material does not comprise any nanotube aggregates having a smallest dimension larger than 0.01 μm, wherein the nanotube concentration is 10-25 w/w %; and wherein the composite material has a volume of at least 10 μm³.

30-47. (canceled)
